(19) United States
(12) Patent Application Publication
(10) Pub. No.: US 2025/0315154 A1
(43) Pub. Date: Oct. 9, 2025

(54) USER INTERFACES FOR EDITING MEDIA

(71) Applicant: Apple Inc., Cupertino, CA (US)

(72) Inventors: Andre SOUZA DOS SANTOS, Curitiba (BR); Johnnie B. MANZARI, San Francisco, CA (US); Adrian ZUMBRUNNEN, San Francisco, CA (US); Etienne DESCLIDES, San Francisco, CA (US); James J. OWEN, San Francisco, CA (US)

(21) Appl. No.: 18/896,872

(22) Filed: Sep. 25, 2024

Related U.S. Application Data
(60) Provisional application No. 63/631,392, filed on Apr. 8, 2024.
(60) Provisional application No. 63/645,834, filed on May 10, 2024.
(60) Provisional application No. 63/657,810, filed on Jun. 8, 2024.
(60) Provisional application No. 63/692,153, filed on Sep. 8, 2024.

(51) Int. Cl. G06F 3/0484

(52) U.S. Cl. CPC G06F 3/0484; G06F 2203/04806

(57) ABSTRACT

The present disclosure generally relates to editing media items.

### CROSS-REFERENCE TO RELATED APPLICATIONS

This application claims priority to U.S. Provisional Patent Application Ser. No. 63/631,392, entitled “USER INTERFACES FOR EDITING MEDIA,” filed Apr. 8, 2024, U.S. Provisional Patent Application Ser. No. 63/645,834, entitled “USER INTERFACES FOR EDITING MEDIA,” filed May 10, 2024, U.S. Provisional Patent Application Ser. No. 63/657,810, entitled “USER INTERFACES FOR EDITING MEDIA,” filed Jun. 8, 2024, and U.S. Provisional Patent Application Ser. No. 63/692,153, entitled “USER INTERFACES FOR EDITING MEDIA,” filed Sep. 8, 2024, the entire contents of each of which are hereby incorporated by reference.

### FIELD

The present disclosure relates generally to computer user interfaces, and more specifically to techniques for editing media.

### BACKGROUND

Computer systems display user interfaces to edit media, such as photos and/or videos.

### BRIEF SUMMARY

Some techniques for editing media using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for editing media. Such methods and interfaces optionally complement or replace other methods for editing media. Such methods and interfaces reduce the cognitive burden on a user and produce a more efficient human-machine interface. For battery-operated computing devices, such methods and interfaces conserve power and increase the time between battery charges.

A method is described, in accordance with some embodiments. The method is performed at a computer system that is in communication with one or more display generation components and one or more input devices. The method comprises: displaying, via the one or more display generation components, a media editing user interface, wherein the media editing user interface includes a media editing control user interface object, and wherein: the media editing control user interface object includes a two-dimensional region that is configured to concurrently adjust a current value of a first parameter of a media item and a current value of a second parameter of the media item; the current value of the first parameter of the media item is adjusted based on user input that includes a change in position of a parameter index point relative to a first axis of the two-dimensional region; and the current value of the second parameter of the media item is adjusted based on user input that includes a change in position of the parameter index point relative to a second axis of the two-dimensional region that is perpendicular to the first axis of the two-dimensional region; while displaying the media editing user interface, detecting, via the one or more input devices, user input corresponding to the media editing control user interface object; and in response to detecting the user input corresponding to the media editing control user interface object: in accordance with a determination that the user input includes a change in position of the parameter index point relative to the first axis of the media editing control user interface object, adjusting the first parameter of the media item based on a magnitude of the change in position of the parameter index point relative to the first axis; and in accordance with a determination that the user input includes a change in position of the parameter index point relative to the second axis of the media editing control user interface object, adjusting the second parameter of the media item based on a magnitude of the change in position of the parameter index point relative to the second axis.

A non-transitory computer-readable storage medium is described, in accordance with some embodiments. The non-transitory computer-readable storage medium stores one or more programs configured to be executed by one or more processors of a computer system that is in communication with one or more display generation components and one or more input devices, the one or more programs including instructions for: displaying, via the one or more display generation components, a media editing user interface, wherein the media editing user interface includes a media editing control user interface object, and wherein: the media editing control user interface object includes a two-dimensional region that is configured to concurrently adjust a current value of a first parameter of a media item and a current value of a second parameter of the media item; the current value of the first parameter of the media item is adjusted based on user input that includes a change in position of a parameter index point relative to a first axis of the two-dimensional region; and the current value of the second parameter of the media item is adjusted based on user input that includes a change in position of the parameter index point relative to a second axis of the two-dimensional region that is perpendicular to the first axis of the two-dimensional region; while displaying the media editing user interface, detecting, via the one or more input devices, user input corresponding to the media editing control user interface object; and in response to detecting the user input corresponding to the media editing control user interface object: in accordance with a determination that the user input includes a change in position of the parameter index point relative to the first axis of the media editing control user interface object, adjusting the first parameter of the media item based on a magnitude of the change in position of the parameter index point relative to the first axis; and in accordance with a determination that the user input includes a change in position of the parameter index point relative to the second axis of the media editing control user interface object, adjusting the second parameter of the media item based on a magnitude of the change in position of the parameter index point relative to the second axis.

A transitory computer-readable storage medium is described, in accordance with some embodiments. The transitory computer-readable storage medium stores one or more programs configured to be executed by one or more processors of a computer system that is in communication with one or more display generation components and one or more input devices, the one or more programs including instructions for: displaying, via the one or more display generation components, a media editing user interface, wherein the media editing user interface includes a media editing control user interface object, and wherein: the media editing control user interface object includes a two-dimensional region that is configured to concurrently adjust a current value of a first parameter of a media item and a current value of a second parameter of the media item; the current value of the first parameter of the media item is adjusted based on user input that includes a change in position of a parameter index point relative to a first axis of the two-dimensional region; and the current value of the second parameter of the media item is adjusted based on user input that includes a change in position of the parameter index point relative to a second axis of the two-dimensional region that is perpendicular to the first axis of the two-dimensional region; while displaying the media editing user interface, detecting, via the one or more input devices, user input corresponding to the media editing control user interface object; and in response to detecting the user input corresponding to the media editing control user interface object: in accordance with a determination that the user input includes a change in position of the parameter index point relative to the first axis of the media editing control user interface object, adjusting the first parameter of the media item based on a magnitude of the change in position of the parameter index point relative to the first axis; and in accordance with a determination that the user input includes a change in position of the parameter index point relative to the second axis of the media editing control user interface object, adjusting the second parameter of the media item based on a magnitude of the change in position of the parameter index point relative to the second axis.

A computer system is described, in accordance with some embodiments. The computer system is configured to communicate with one or more display generation components and one or more input devices and comprises: one or more processors; and memory storing one or more programs configured to be executed by the one or more processors, the one or more programs including instructions for: displaying, via the one or more display generation components, a media editing user interface, wherein the media editing user interface includes a media editing control user interface object, and wherein: the media editing control user interface object includes a two-dimensional region that is configured to concurrently adjust a current value of a first parameter of a media item and a current value of a second parameter of the media item; the current value of the first parameter of the media item is adjusted based on user input that includes a change in position of a parameter index point relative to a first axis of the two-dimensional region; and the current value of the second parameter of the media item is adjusted based on user input that includes a change in position of the parameter index point relative to a second axis of the two-dimensional region that is perpendicular to the first axis of the two-dimensional region; while displaying the media editing user interface, detecting, via the one or more input devices, user input corresponding to the media editing control user interface object; and in response to detecting the user input corresponding to the media editing control user interface object: in accordance with a determination that the user input includes a change in position of the parameter index point relative to the first axis of the media editing control user interface object, adjusting the first parameter of the media item based on a magnitude of the change in position of the parameter index point relative to the first axis; and in accordance with a determination that the user input includes a change in position of the parameter index point relative to the second axis of the media editing control user interface object, adjusting the second parameter of the media item based on a magnitude of the change in position of the parameter index point relative to the second axis.

A computer system is described, in accordance with some embodiments. The computer system is configured to communicate with one or more display generation components and one or more input devices and comprises: means for displaying, via the one or more display generation components, a media editing user interface, wherein the media editing user interface includes a media editing control user interface object, and wherein: the media editing control user interface object includes a two-dimensional region that is configured to concurrently adjust a current value of a first parameter of a media item and a current value of a second parameter of the media item; the current value of the first parameter of the media item is adjusted based on user input that includes a change in position of a parameter index point relative to a first axis of the two-dimensional region; and the current value of the second parameter of the media item is adjusted based on user input that includes a change in position of the parameter index point relative to a second axis of the two-dimensional region that is perpendicular to the first axis of the two-dimensional region; means for, while displaying the media editing user interface, detecting, via the one or more input devices, user input corresponding to the media editing control user interface object; and means for, in response to detecting the user input corresponding to the media editing control user interface object: in accordance with a determination that the user input includes a change in position of the parameter index point relative to the first axis of the media editing control user interface object, adjusting the first parameter of the media item based on a magnitude of the change in position of the parameter index point relative to the first axis; and in accordance with a determination that the user input includes a change in position of the parameter index point relative to the second axis of the media editing control user interface object, adjusting the second parameter of the media item based on a magnitude of the change in position of the parameter index point relative to the second axis.

A computer program product is described, in accordance with some embodiments. The computer program product comprises one or more programs configured to be executed by one or more processors of a computer system that is in communication with one or more display generation components and one or more input devices, the one or more programs including instructions for: displaying, via the one or more display generation components, a media editing user interface, wherein the media editing user interface includes a media editing control user interface object, and wherein: the media editing control user interface object includes a two-dimensional region that is configured to concurrently adjust a current value of a first parameter of a media item and a current value of a second parameter of the media item; the current value of the first parameter of the media item is adjusted based on user input that includes a change in position of a parameter index point relative to a first axis of the two-dimensional region; and the current value of the second parameter of the media item is adjusted based on user input that includes a change in position of the parameter index point relative to a second axis of the two-dimensional region that is perpendicular to the first axis of the two-dimensional region; while displaying the media editing user interface, detecting, via the one or more input devices, user input corresponding to the media editing control user interface object; and in response to detecting the user input corresponding to the media editing control user interface object: in accordance with a determination that the user input includes a change in position of the parameter index point relative to the first axis of the media editing control user interface object, adjusting the first parameter of the media item based on a magnitude of the change in position of the parameter index point relative to the first axis; and in accordance with a determination that the user input includes a change in position of the parameter index point relative to the second axis of the media editing control user interface object, adjusting the second parameter of the media item based on a magnitude of the change in position of the parameter index point relative to the second axis.

A method is described, in accordance with some embodiments. The method is performed at a computer system that is in communication with one or more display generation components and one or more input devices. The method comprises: while displaying, via the one or more display generation components, a first media item in a media library at a first position of a media user interface, detecting, via the one or more input devices, a request to display a next media item in the media library; in response to detecting the request to display the next media item in the media library: ceasing display of the first media item at the first position of the media user interface; and concurrently displaying, via the one or more display generation components: a second media item at the first position of the media user interface, wherein the second media item is a video media item; and one or more playback parameter controls, wherein the one or more playback parameter controls include a first control that controls a first playback parameter that has multiple states; while displaying the second media item at the first position of the media user interface, detecting a sequence of one or more inputs that includes selection of the first control and selection of a respective state associated with the first control; in response to detecting the sequence of one or more inputs, selecting the respective state associated with the first control; and while the respective state associated with the first control is selected for the first playback parameter, playing the second media item, including: in accordance with a determination that a first state is selected for the first playback parameter, playing back the second media item including outputting content of a type that is adjusted by the first playback parameter in accordance with the first state of the first playback parameter; and in accordance with a determination that a second state is selected for the first playback parameter, playing back the second media item including outputting content of the type that is adjusted by the first playback parameter in accordance with the second state of the first playback parameter.

A non-transitory computer-readable storage medium is described, in accordance with some embodiments. The non-transitory computer-readable storage medium stores one or more programs configured to be executed by one or more processors of a computer system that is in communication with one or more display generation components and one or more input devices, the one or more programs including instructions for: while displaying, via the one or more display generation components, a first media item in a media library at a first position of a media user interface, detecting, via the one or more input devices, a request to display a next media item in the media library; in response to detecting the request to display the next media item in the media library: ceasing display of the first media item at the first position of the media user interface; and concurrently displaying, via the one or more display generation components: a second media item at the first position of the media user interface, wherein the second media item is a video media item; and one or more playback parameter controls, wherein the one or more playback parameter controls include a first control that controls a first playback parameter that has multiple states; while displaying the second media item at the first position of the media user interface, detecting a sequence of one or more inputs that includes selection of the first control and selection of a respective state associated with the first control; in response to detecting the sequence of one or more inputs, selecting the respective state associated with the first control; and while the respective state associated with the first control is selected for the first playback parameter, playing the second media item, including: in accordance with a determination that a first state is selected for the first playback parameter, playing back the second media item including outputting content of a type that is adjusted by the first playback parameter in accordance with the first state of the first playback parameter; and in accordance with a determination that a second state is selected for the first playback parameter, playing back the second media item including outputting content of the type that is adjusted by the first playback parameter in accordance with the second state of the first playback parameter.

A transitory computer-readable storage medium is described, in accordance with some embodiments. The transitory computer-readable storage medium stores one or more programs configured to be executed by one or more processors of a computer system that is in communication with one or more display generation components and one or more input devices, the one or more programs including instructions for: while displaying, via the one or more display generation components, a first media item in a media library at a first position of a media user interface, detecting, via the one or more input devices, a request to display a next media item in the media library; in response to detecting the request to display the next media item in the media library: ceasing display of the first media item at the first position of the media user interface; and concurrently displaying, via the one or more display generation components: a second media item at the first position of the media user interface, wherein the second media item is a video media item; and one or more playback parameter controls, wherein the one or more playback parameter controls include a first control that controls a first playback parameter that has multiple states; while displaying the second media item at the first position of the media user interface, detecting a sequence of one or more inputs that includes selection of the first control and selection of a respective state associated with the first control; in response to detecting the sequence of one or more inputs, selecting the respective state associated with the first control; and while the respective state associated with the first control is selected for the first playback parameter, playing the second media item, including: in accordance with a determination that a first state is selected for the first playback parameter, playing back the second media item including outputting content of a type that is adjusted by the first playback parameter in accordance with the first state of the first playback parameter; and in accordance with a determination that a second state is selected for the first playback parameter, playing back the second media item including outputting content of the type that is adjusted by the first playback parameter in accordance with the second state of the first playback parameter.

A computer system is described, in accordance with some embodiments. The computer system is configured to communicate with one or more display generation components and one or more input devices and comprises: one or more processors; and memory storing one or more programs configured to be executed by the one or more processors, the one or more programs including instructions for: while displaying, via the one or more display generation components, a first media item in a media library at a first position of a media user interface, detecting, via the one or more input devices, a request to display a next media item in the media library; in response to detecting the request to display the next media item in the media library: ceasing display of the first media item at the first position of the media user interface; and concurrently displaying, via the one or more display generation components: a second media item at the first position of the media user interface, wherein the second media item is a video media item; and one or more playback parameter controls, wherein the one or more playback parameter controls include a first control that controls a first playback parameter that has multiple states; while displaying the second media item at the first position of the media user interface, detecting a sequence of one or more inputs that includes selection of the first control and selection of a respective state associated with the first control; in response to detecting the sequence of one or more inputs, selecting the respective state associated with the first control; and while the respective state associated with the first control is selected for the first playback parameter, playing the second media item, including: in accordance with a determination that a first state is selected for the first playback parameter, playing back the second media item including outputting content of a type that is adjusted by the first playback parameter in accordance with the first state of the first playback parameter; and in accordance with a determination that a second state is selected for the first playback parameter, playing back the second media item including outputting content of the type that is adjusted by the first playback parameter in accordance with the second state of the first playback parameter.

A computer system is described, in accordance with some embodiments. The computer system is configured to communicate with one or more display generation components and one or more input devices and comprises: means for, while displaying, via the one or more display generation components, a first media item in a media library at a first position of a media user interface, detecting, via the one or more input devices, a request to display a next media item in the media library; means for, in response to detecting the request to display the next media item in the media library: ceasing display of the first media item at the first position of the media user interface; and concurrently displaying, via the one or more display generation components: a second media item at the first position of the media user interface, wherein the second media item is a video media item; and one or more playback parameter controls, wherein the one or more playback parameter controls include a first control that controls a first playback parameter that has multiple states; means for, while displaying the second media item at the first position of the media user interface, detecting a sequence of one or more inputs that includes selection of the first control and selection of a respective state associated with the first control; means for, in response to detecting the sequence of one or more inputs, selecting the respective state associated with the first control; and means for, while the respective state associated with the first control is selected for the first playback parameter, playing the second media item, including: in accordance with a determination that a first state is selected for the first playback parameter, playing back the second media item including outputting content of a type that is adjusted by the first playback parameter in accordance with the first state of the first playback parameter; and in accordance with a determination that a second state is selected for the first playback parameter, playing back the second media item including outputting content of the type that is adjusted by the first playback parameter in accordance with the second state of the first playback parameter.

A computer program product is described, in accordance with some embodiments. The computer program product comprises one or more programs configured to be executed by one or more processors of a computer system that is in communication with one or more display generation components and one or more input devices, the one or more programs including instructions for: while displaying, via the one or more display generation components, a first media item in a media library at a first position of a media user interface, detecting, via the one or more input devices, a request to display a next media item in the media library; in response to detecting the request to display the next media item in the media library: ceasing display of the first media item at the first position of the media user interface; and concurrently displaying, via the one or more display generation components: a second media item at the first position of the media user interface, wherein the second media item is a video media item; and one or more playback parameter controls, wherein the one or more playback parameter controls include a first control that controls a first playback parameter that has multiple states; while displaying the second media item at the first position of the media user interface, detecting a sequence of one or more inputs that includes selection of the first control and selection of a respective state associated with the first control; in response to detecting the sequence of one or more inputs, selecting the respective state associated with the first control; and while the respective state associated with the first control is selected for the first playback parameter, playing the second media item, including: in accordance with a determination that a first state is selected for the first playback parameter, playing back the second media item including outputting content of a type that is adjusted by the first playback parameter in accordance with the first state of the first playback parameter; and in accordance with a determination that a second state is selected for the first playback parameter, playing back the second media item including outputting content of the type that is adjusted by the first playback parameter in accordance with the second state of the first playback parameter.

In accordance with some embodiments, a method performed at a computer system that is in communication with one or more display generations components and one or more input devices is described. The method comprises: subsequent to a first media item having been edited using a set of edits, detecting, via the one or more input devices, a request to modify a set of one or more media items based on a respective subset of the set of edits that were made to the first media item, wherein: the respective subset of one or more edits includes one or more edits from the set of edits that were made to the first media item; and the set of one or more media items includes a second media item that is different from the first media item; and in response to detecting the request to modify the set of one or more media items based on the respective subset of the set of edits that were made to the first media item: in accordance with a determination that a first subset of one or more edits of the set of edits is selected, modifying the set of one or more media items by applying the first subset of one or more edits to the set of one or more media items, wherein the first subset of one or more edits does not include at least one edit included in the set of edits; and in accordance with a determination that a second subset of one or more edits of the set of edits is selected, modifying the set of one or more media items by applying the second subset of one or more edits to the set of one or more media items, wherein the second subset of one or more edits is different from the first subset of one or more edits.

In accordance with some embodiments, a non-transitory computer-readable storage medium is described. The non-transitory computer-readable storage medium stores one or more programs configured to be executed by one or more processors of a computer system that is in communication with one or more display generations components and one or more input devices, the one or more programs including instructions for: subsequent to a first media item having been edited using a set of edits, detecting, via the one or more input devices, a request to modify a set of one or more media items based on a respective subset of the set of edits that were made to the first media item, wherein: the respective subset of one or more edits includes one or more edits from the set of edits that were made to the first media item; and the set of one or more media items includes a second media item that is different from the first media item; and in response to detecting the request to modify the set of one or more media items based on the respective subset of the set of edits that were made to the first media item: in accordance with a determination that a first subset of one or more edits of the set of edits is selected, modifying the set of one or more media items by applying the first subset of one or more edits to the set of one or more media items, wherein the first subset of one or more edits does not include at least one edit included in the set of edits; and in accordance with a determination that a second subset of one or more edits of the set of edits is selected, modifying the set of one or more media items by applying the second subset of one or more edits to the set of one or more media items, wherein the second subset of one or more edits is different from the first subset of one or more edits.

In accordance with some embodiments, a transitory computer-readable storage medium is described. The transitory computer-readable storage medium stores one or more programs configured to be executed by one or more processors of a computer system that is configured to communicate with one or more display generations components and one or more input devices, the one or more programs including instructions for: subsequent to a first media item having been edited using a set of edits, detecting, via the one or more input devices, a request to modify a set of one or more media items based on a respective subset of the set of edits that were made to the first media item, wherein: the respective subset of one or more edits includes one or more edits from the set of edits that were made to the first media item; and the set of one or more media items includes a second media item that is different from the first media item; and in response to detecting the request to modify the set of one or more media items based on the respective subset of the set of edits that were made to the first media item: in accordance with a determination that a first subset of one or more edits of the set of edits is selected, modifying the set of one or more media items by applying the first subset of one or more edits to the set of one or more media items, wherein the first subset of one or more edits does not include at least one edit included in the set of edits; and in accordance with a determination that a second subset of one or more edits of the set of edits is selected, modifying the set of one or more media items by applying the second subset of one or more edits to the set of one or more media items, wherein the second subset of one or more edits is different from the first subset of one or more edits.

In accordance with some embodiments, a computer system that is configured to communicate with one or more display generations components and one or more input devices is described. The computer system comprises: one or more processors; and memory storing one or more programs configured to be executed by the one or more processors, the one or more programs including instructions for: subsequent to a first media item having been edited using a set of edits, detecting, via the one or more input devices, a request to modify a set of one or more media items based on a respective subset of the set of edits that were made to the first media item, wherein: the respective subset of one or more edits includes one or more edits from the set of edits that were made to the first media item; and the set of one or more media items includes a second media item that is different from the first media item; and in response to detecting the request to modify the set of one or more media items based on the respective subset of the set of edits that were made to the first media item: in accordance with a determination that a first subset of one or more edits of the set of edits is selected, modifying the set of one or more media items by applying the first subset of one or more edits to the set of one or more media items, wherein the first subset of one or more edits does not include at least one edit included in the set of edits; and in accordance with a determination that a second subset of one or more edits of the set of edits is selected, modifying the set of one or more media items by applying the second subset of one or more edits to the set of one or more media items, wherein the second subset of one or more edits is different from the first subset of one or more edits.

In accordance with some embodiments, a computer system that is configured to communicate with one or more display generations components and one or more input devices is described. The computer system comprises: means for, subsequent to a first media item having been edited using a set of edits, detecting, via the one or more input devices, a request to modify a set of one or more media items based on a respective subset of the set of edits that were made to the first media item, wherein: the respective subset of one or more edits includes one or more edits from the set of edits that were made to the first media item; and the set of one or more media items includes a second media item that is different from the first media item; and means for, in response to detecting the request to modify the set of one or more media items based on the respective subset of the set of edits that were made to the first media item: in accordance with a determination that a first subset of one or more edits of the set of edits is selected, modifying the set of one or more media items by applying the first subset of one or more edits to the set of one or more media items, wherein the first subset of one or more edits does not include at least one edit included in the set of edits; and in accordance with a determination that a second subset of one or more edits of the set of edits is selected, modifying the set of one or more media items by applying the second subset of one or more edits to the set of one or more media items, wherein the second subset of one or more edits is different from the first subset of one or more edits.

In accordance with some embodiments, a computer program product is described. The computer program product comprises one or more programs configured to be executed by one or more processors of a computer system that is that is in communication with one or more display generations components and one or more input devices. The one or more programs include instructions for: subsequent to a first media item having been edited using a set of edits, detecting, via the one or more input devices, a request to modify a set of one or more media items based on a respective subset of the set of edits that were made to the first media item, wherein: the respective subset of one or more edits includes one or more edits from the set of edits that were made to the first media item; and the set of one or more media items includes a second media item that is different from the first media item; and in response to detecting the request to modify the set of one or more media items based on the respective subset of the set of edits that were made to the first media item: in accordance with a determination that a first subset of one or more edits of the set of edits is selected, modifying the set of one or more media items by applying the first subset of one or more edits to the set of one or more media items, wherein the first subset of one or more edits does not include at least one edit included in the set of edits; and in accordance with a determination that a second subset of one or more edits of the set of edits is selected, modifying the set of one or more media items by applying the second subset of one or more edits to the set of one or more media items, wherein the second subset of one or more edits is different from the first subset of one or more edits.

In accordance with some embodiments, a method performed at a computer system that is in communication with one or more display generation components and one or more input devices is described. The method comprises: while displaying, via the one or more display generation components, a media item including a foreground element and a first background element, detecting, via the one or more input devices, an input corresponding to a request to modify the media item, including: detecting at least a portion of the input is directed to a location of the foreground element and a location of the first background element; and in response to detecting the input corresponding to the request to modify the media item: in accordance with a determination that an initial location of the input is directed to the location of the first background element, modifying the media item, that is displayed via the one or more display generation components, by modifying at least a portion of the first background element without modifying the foreground element to which the input was directed.

In accordance with some embodiments, a non-transitory computer-readable storage medium is described. The non-transitory computer-readable storage medium stores one or more programs configured to be executed by one or more processors of a computer system that is in communication with one or more display generation components and one or more input devices, the one or more programs including instructions for: while displaying, via the one or more display generation components, a media item including a foreground element and a first background element, detecting, via the one or more input devices, an input corresponding to a request to modify the media item, including: detecting at least a portion of the input is directed to a location of the foreground element and a location of the first background element; and in response to detecting the input corresponding to the request to modify the media item: in accordance with a determination that an initial location of the input is directed to the location of the first background element, modifying the media item, that is displayed via the one or more display generation components, by modifying at least a portion of the first background element without modifying the foreground element to which the input was directed.

In accordance with some embodiments, a transitory computer-readable storage medium is described. The transitory computer-readable storage medium stores one or more programs configured to be executed by one or more processors of a computer system that is configured to communicate with one or more display generation components and one or more input devices, the one or more programs including instructions for: while displaying, via the one or more display generation components, a media item including a foreground element and a first background element, detecting, via the one or more input devices, an input corresponding to a request to modify the media item, including: detecting at least a portion of the input is directed to a location of the foreground element and a location of the first background element; and in response to detecting the input corresponding to the request to modify the media item: in accordance with a determination that an initial location of the input is directed to the location of the first background element, modifying the media item, that is displayed via the one or more display generation components, by modifying at least a portion of the first background element without modifying the foreground element to which the input was directed.

In accordance with some embodiments, a computer system that is configured to communicate with one or more display generation components and one or more input devices is described. The computer system comprises: one or more processors; and memory storing one or more programs configured to be executed by the one or more processors, the one or more programs including instructions for: while displaying, via the one or more display generation components, a media item including a foreground element and a first background element, detecting, via the one or more input devices, an input corresponding to a request to modify the media item, including: detecting at least a portion of the input is directed to a location of the foreground element and a location of the first background element; and in response to detecting the input corresponding to the request to modify the media item: in accordance with a determination that an initial location of the input is directed to the location of the first background element, modifying the media item, that is displayed via the one or more display generation components, by modifying at least a portion of the first background element without modifying the foreground element to which the input was directed.

In accordance with some embodiments, a computer system that is configured to communicate with a display generation component and one or more input devices is described. The computer system comprises: means for, while displaying, via the one or more display generation components, a media item including a foreground element and a first background element, detecting, via the one or more input devices, an input corresponding to a request to modify the media item, including: detecting at least a portion of the input is directed to a location of the foreground element and a location of the first background element; and means for, in response to detecting the input corresponding to the request to modify the media item: in accordance with a determination that an initial location of the input is directed to the location of the first background element, modifying the media item, that is displayed via the one or more display generation components, by modifying at least a portion of the first background element without modifying the foreground element to which the input was directed.

In accordance with some embodiments, a computer program product is described. The computer program product comprises one or more programs configured to be executed by one or more processors of a computer system that is that is in communication with one or more display generation components and one or more input devices. The one or more programs include instructions for: while displaying, via the one or more display generation components, a media item including a foreground element and a first background element, detecting, via the one or more input devices, an input corresponding to a request to modify the media item, including: detecting at least a portion of the input is directed to a location of the foreground element and a location of the first background element; and in response to detecting the input corresponding to the request to modify the media item: in accordance with a determination that an initial location of the input is directed to the location of the first background element, modifying the media item, that is displayed via the one or more display generation components, by modifying at least a portion of the first background element without modifying the foreground element to which the input was directed.

A method is described, in accordance with some embodiments. The method is performed at a computer system that is in communication with one or more display generation components and one or more input devices. The method comprises: while displaying, via the one or more display generation components, a representation of a video media item, detecting, via the one or more input devices, one or more inputs corresponding to a request to edit the video media item; and in response to detecting the one or more inputs corresponding to the request to edit the video media item, displaying, via the one or more display generation components, a media editing user interface, wherein displaying the media editing user interface includes: in accordance with a determination that the video media item is configured to play with a playback speed that is below a threshold playback speed, displaying, via the one or more display generation components, one or more slow motion editing control user interface objects in the media editing user interface, wherein the one or more slow motion editing control user interface objects enable one or more slow motion playback parameters of the video media item to be adjusted; and in accordance with a determination that the video media item is configured to play with a playback speed that is not below the threshold playback speed, forgoing display of the one or more slow motion editing control user interface objects in the media editing user interface.

A non-transitory computer-readable storage medium is described, in accordance with some embodiments. The non-transitory computer-readable storage medium stores one or more programs configured to be executed by one or more processors of a computer system that is in communication with one or more display generation components and one or more input devices, the one or more programs including instructions for: while displaying, via the one or more display generation components, a representation of a video media item, detecting, via the one or more input devices, one or more inputs corresponding to a request to edit the video media item; and in response to detecting the one or more inputs corresponding to the request to edit the video media item, displaying, via the one or more display generation components, a media editing user interface, wherein displaying the media editing user interface includes: in accordance with a determination that the video media item is configured to play with a playback speed that is below a threshold playback speed, displaying, via the one or more display generation components, one or more slow motion editing control user interface objects in the media editing user interface, wherein the one or more slow motion editing control user interface objects enable one or more slow motion playback parameters of the video media item to be adjusted; and in accordance with a determination that the video media item is configured to play with a playback speed that is not below the threshold playback speed, forgoing display of the one or more slow motion editing control user interface objects in the media editing user interface.

A transitory computer-readable storage medium is described, in accordance with some embodiments. The transitory computer-readable storage medium stores one or more programs configured to be executed by one or more processors of a computer system that is in communication with one or more display generation components and one or more input devices, the one or more programs including instructions for: while displaying, via the one or more display generation components, a representation of a video media item, detecting, via the one or more input devices, one or more inputs corresponding to a request to edit the video media item; and in response to detecting the one or more inputs corresponding to the request to edit the video media item, displaying, via the one or more display generation components, a media editing user interface, wherein displaying the media editing user interface includes: in accordance with a determination that the video media item is configured to play with a playback speed that is below a threshold playback speed, displaying, via the one or more display generation components, one or more slow motion editing control user interface objects in the media editing user interface, wherein the one or more slow motion editing control user interface objects enable one or more slow motion playback parameters of the video media item to be adjusted; and in accordance with a determination that the video media item is configured to play with a playback speed that is not below the threshold playback speed, forgoing display of the one or more slow motion editing control user interface objects in the media editing user interface.

A computer system is described, in accordance with some embodiments. The computer system is configured to communicate with one or more display generation components and one or more input devices and comprises: one or more processors; and memory storing one or more programs configured to be executed by the one or more processors, the one or more programs including instructions for: while displaying, via the one or more display generation components, a representation of a video media item, detecting, via the one or more input devices, one or more inputs corresponding to a request to edit the video media item; and in response to detecting the one or more inputs corresponding to the request to edit the video media item, displaying, via the one or more display generation components, a media editing user interface, wherein displaying the media editing user interface includes: in accordance with a determination that the video media item is configured to play with a playback speed that is below a threshold playback speed, displaying, via the one or more display generation components, one or more slow motion editing control user interface objects in the media editing user interface, wherein the one or more slow motion editing control user interface objects enable one or more slow motion playback parameters of the video media item to be adjusted; and in accordance with a determination that the video media item is configured to play with a playback speed that is not below the threshold playback speed, forgoing display of the one or more slow motion editing control user interface objects in the media editing user interface.

A computer system is described, in accordance with some embodiments. The computer system is configured to communicate with one or more display generation components and one or more input devices and comprises: means for, while displaying, via the one or more display generation components, a representation of a video media item, detecting, via the one or more input devices, one or more inputs corresponding to a request to edit the video media item; and means for, in response to detecting the one or more inputs corresponding to the request to edit the video media item, displaying, via the one or more display generation components, a media editing user interface, wherein displaying the media editing user interface includes: in accordance with a determination that the video media item is configured to play with a playback speed that is below a threshold playback speed, displaying, via the one or more display generation components, one or more slow motion editing control user interface objects in the media editing user interface, wherein the one or more slow motion editing control user interface objects enable one or more slow motion playback parameters of the video media item to be adjusted; and in accordance with a determination that the video media item is configured to play with a playback speed that is not below the threshold playback speed, forgoing display of the one or more slow motion editing control user interface objects in the media editing user interface.

A computer program product is described, in accordance with some embodiments. The computer program product comprises one or more programs configured to be executed by one or more processors of a computer system that is in communication with one or more display generation components and one or more input devices, the one or more programs including instructions for: while displaying, via the one or more display generation components, a representation of a video media item, detecting, via the one or more input devices, one or more inputs corresponding to a request to edit the video media item; and in response to detecting the one or more inputs corresponding to the request to edit the video media item, displaying, via the one or more display generation components, a media editing user interface, wherein displaying the media editing user interface includes: in accordance with a determination that the video media item is configured to play with a playback speed that is below a threshold playback speed, displaying, via the one or more display generation components, one or more slow motion editing control user interface objects in the media editing user interface, wherein the one or more slow motion editing control user interface objects enable one or more slow motion playback parameters of the video media item to be adjusted; and in accordance with a determination that the video media item is configured to play with a playback speed that is not below the threshold playback speed, forgoing display of the one or more slow motion editing control user interface objects in the media editing user interface.

A method is described, in accordance with some embodiments. The method is performed at a computer system that is in communication with one or more display generation components and one or more input devices. The method comprises: while displaying, via the one or more display generation components, a media editing user interface of a media item that includes audio, wherein the media editing user interface includes an audio control user interface object, detecting, via the one or more input devices, one or more inputs directed to the audio control user interface object; and in response to detecting the one or more inputs corresponding to the audio control user interface object: in accordance with a determination that the one or more inputs corresponding to the audio control user interface object include a request to adjust a current value of a first audio mix effect to a first value of a plurality of values for the first audio mix effect, adjusting a magnitude of the first audio mix effect to the first value for the first audio mix effect; and in accordance with a determination that the one or more inputs corresponding to the audio control user interface object include a request to adjust the current value of the first audio mix effect to a second value of the plurality of values for the first audio mix effect that is different from the first value of the plurality of values, adjusting the magnitude of the first audio mix effect to the second value that is different from the first value for the first audio mix effect.

A non-transitory computer-readable storage medium is described, in accordance with some embodiments. The non-transitory computer-readable storage medium stores one or more programs configured to be executed by one or more processors of a computer system that is in communication with one or more display generation components and one or more input devices, the one or more programs including instructions for: while displaying, via the one or more display generation components, a media editing user interface of a media item that includes audio, wherein the media editing user interface includes an audio control user interface object, detecting, via the one or more input devices, one or more inputs directed to the audio control user interface object; and in response to detecting the one or more inputs corresponding to the audio control user interface object: in accordance with a determination that the one or more inputs corresponding to the audio control user interface object include a request to adjust a current value of a first audio mix effect to a first value of a plurality of values for the first audio mix effect, adjusting a magnitude of the first audio mix effect to the first value for the first audio mix effect; and in accordance with a determination that the one or more inputs corresponding to the audio control user interface object include a request to adjust the current value of the first audio mix effect to a second value of the plurality of values for the first audio mix effect that is different from the first value of the plurality of values, adjusting the magnitude of the first audio mix effect to the second value that is different from the first value for the first audio mix effect.

A transitory computer-readable storage medium is described, in accordance with some embodiments. The transitory computer-readable storage medium stores one or more programs configured to be executed by one or more processors of a computer system that is in communication with one or more display generation components and one or more input devices, the one or more programs including instructions for: while displaying, via the one or more display generation components, a media editing user interface of a media item that includes audio, wherein the media editing user interface includes an audio control user interface object, detecting, via the one or more input devices, one or more inputs directed to the audio control user interface object; and in response to detecting the one or more inputs corresponding to the audio control user interface object: in accordance with a determination that the one or more inputs corresponding to the audio control user interface object include a request to adjust a current value of a first audio mix effect to a first value of a plurality of values for the first audio mix effect, adjusting a magnitude of the first audio mix effect to the first value for the first audio mix effect; and in accordance with a determination that the one or more inputs corresponding to the audio control user interface object include a request to adjust the current value of the first audio mix effect to a second value of the plurality of values for the first audio mix effect that is different from the first value of the plurality of values, adjusting the magnitude of the first audio mix effect to the second value that is different from the first value for the first audio mix effect.

A computer system is described, in accordance with some embodiments. The computer system is configured to communicate with one or more display generation components and one or more input devices and comprises: one or more processors; and memory storing one or more programs configured to be executed by the one or more processors, the one or more programs including instructions for: while displaying, via the one or more display generation components, a media editing user interface of a media item that includes audio, wherein the media editing user interface includes an audio control user interface object, detecting, via the one or more input devices, one or more inputs directed to the audio control user interface object; and in response to detecting the one or more inputs corresponding to the audio control user interface object: in accordance with a determination that the one or more inputs corresponding to the audio control user interface object include a request to adjust a current value of a first audio mix effect to a first value of a plurality of values for the first audio mix effect, adjusting a magnitude of the first audio mix effect to the first value for the first audio mix effect; and in accordance with a determination that the one or more inputs corresponding to the audio control user interface object include a request to adjust the current value of the first audio mix effect to a second value of the plurality of values for the first audio mix effect that is different from the first value of the plurality of values, adjusting the magnitude of the first audio mix effect to the second value that is different from the first value for the first audio mix effect.

A computer system is described, in accordance with some embodiments. The computer system is configured to communicate with one or more display generation components and one or more input devices and comprises: means for, while displaying, via the one or more display generation components, a media editing user interface of a media item that includes audio, wherein the media editing user interface includes an audio control user interface object, detecting, via the one or more input devices, one or more inputs directed to the audio control user interface object; and means for, in response to detecting the one or more inputs corresponding to the audio control user interface object: in accordance with a determination that the one or more inputs corresponding to the audio control user interface object include a request to adjust a current value of a first audio mix effect to a first value of a plurality of values for the first audio mix effect, adjusting a magnitude of the first audio mix effect to the first value for the first audio mix effect; and in accordance with a determination that the one or more inputs corresponding to the audio control user interface object include a request to adjust the current value of the first audio mix effect to a second value of the plurality of values for the first audio mix effect that is different from the first value of the plurality of values, adjusting the magnitude of the first audio mix effect to the second value that is different from the first value for the first audio mix effect.

A computer program product is described, in accordance with some embodiments. The computer program product comprises one or more programs configured to be executed by one or more processors of a computer system that is in communication with one or more display generation components and one or more input devices, the one or more programs including instructions for: while displaying, via the one or more display generation components, a media editing user interface of a media item that includes audio, wherein the media editing user interface includes an audio control user interface object, detecting, via the one or more input devices, one or more inputs directed to the audio control user interface object; and in response to detecting the one or more inputs corresponding to the audio control user interface object: in accordance with a determination that the one or more inputs corresponding to the audio control user interface object include a request to adjust a current value of a first audio mix effect to a first value of a plurality of values for the first audio mix effect, adjusting a magnitude of the first audio mix effect to the first value for the first audio mix effect; and in accordance with a determination that the one or more inputs corresponding to the audio control user interface object include a request to adjust the current value of the first audio mix effect to a second value of the plurality of values for the first audio mix effect that is different from the first value of the plurality of values, adjusting the magnitude of the first audio mix effect to the second value that is different from the first value for the first audio mix effect.

A method is described, in accordance with some embodiments. The method is performed at a computer system that is in communication with one or more display generation components and one or more input devices. The method comprises: while displaying, via the one or more display generation components, a media user interface including a media item, detecting, via the one or more input devices, one or more user inputs corresponding to a request to apply a respective media style to the media item; and in response to detecting the one or more user inputs corresponding to the request to apply the respective media style to the media item: in accordance with a determination that the one or more user inputs include a first input in a first direction, applying a first media style to the media item, wherein the first media style corresponds to a first category of media styles; and in accordance with a determination that the one or more inputs include a second input in a second direction that is different from the first direction, applying a second media style to the media item, wherein the second media style is different from the first media style, and wherein the second media style corresponds to a second category of media styles that is different from the first category of media styles.

A non-transitory computer-readable storage medium is described, in accordance with some embodiments. The non-transitory computer-readable storage medium stores one or more programs configured to be executed by one or more processors of a computer system that is in communication with one or more display generation components and one or more input devices, the one or more programs including instructions for: while displaying, via the one or more display generation components, a media user interface including a media item, detecting, via the one or more input devices, one or more user inputs corresponding to a request to apply a respective media style to the media item; and in response to detecting the one or more user inputs corresponding to the request to apply the respective media style to the media item: in accordance with a determination that the one or more user inputs include a first input in a first direction, applying a first media style to the media item, wherein the first media style corresponds to a first category of media styles; and in accordance with a determination that the one or more inputs include a second input in a second direction that is different from the first direction, applying a second media style to the media item, wherein the second media style is different from the first media style, and wherein the second media style corresponds to a second category of media styles that is different from the first category of media styles.

A transitory computer-readable storage medium is described, in accordance with some embodiments. The transitory computer-readable storage medium stores one or more programs configured to be executed by one or more processors of a computer system that is in communication with one or more display generation components and one or more input devices, the one or more programs including instructions for: while displaying, via the one or more display generation components, a media user interface including a media item, detecting, via the one or more input devices, one or more user inputs corresponding to a request to apply a respective media style to the media item; and in response to detecting the one or more user inputs corresponding to the request to apply the respective media style to the media item: in accordance with a determination that the one or more user inputs include a first input in a first direction, applying a first media style to the media item, wherein the first media style corresponds to a first category of media styles; and in accordance with a determination that the one or more inputs include a second input in a second direction that is different from the first direction, applying a second media style to the media item, wherein the second media style is different from the first media style, and wherein the second media style corresponds to a second category of media styles that is different from the first category of media styles.

A computer system is described, in accordance with some embodiments. The computer system is configured to communicate with one or more display generation components and one or more input devices and comprises: one or more processors; and memory storing one or more programs configured to be executed by the one or more processors, the one or more programs including instructions for: while displaying, via the one or more display generation components, a media user interface including a media item, detecting, via the one or more input devices, one or more user inputs corresponding to a request to apply a respective media style to the media item; and in response to detecting the one or more user inputs corresponding to the request to apply the respective media style to the media item: in accordance with a determination that the one or more user inputs include a first input in a first direction, applying a first media style to the media item, wherein the first media style corresponds to a first category of media styles; and in accordance with a determination that the one or more inputs include a second input in a second direction that is different from the first direction, applying a second media style to the media item, wherein the second media style is different from the first media style, and wherein the second media style corresponds to a second category of media styles that is different from the first category of media styles.

A computer system is described, in accordance with some embodiments. The computer system is configured to communicate with one or more display generation components and one or more input devices and comprises: means for, while displaying, via the one or more display generation components, a media user interface including a media item, detecting, via the one or more input devices, one or more user inputs corresponding to a request to apply a respective media style to the media item; and means for, in response to detecting the one or more user inputs corresponding to the request to apply the respective media style to the media item: in accordance with a determination that the one or more user inputs include a first input in a first direction, applying a first media style to the media item, wherein the first media style corresponds to a first category of media styles; and in accordance with a determination that the one or more inputs include a second input in a second direction that is different from the first direction, applying a second media style to the media item, wherein the second media style is different from the first media style, and wherein the second media style corresponds to a second category of media styles that is different from the first category of media styles.

A computer program product is described, in accordance with some embodiments. The computer program product comprises one or more programs configured to be executed by one or more processors of a computer system that is in communication with one or more display generation components and one or more input devices, the one or more programs including instructions for: while displaying, via the one or more display generation components, a media user interface including a media item, detecting, via the one or more input devices, one or more user inputs corresponding to a request to apply a respective media style to the media item; and in response to detecting the one or more user inputs corresponding to the request to apply the respective media style to the media item: in accordance with a determination that the one or more user inputs include a first input in a first direction, applying a first media style to the media item, wherein the first media style corresponds to a first category of media styles; and in accordance with a determination that the one or more inputs include a second input in a second direction that is different from the first direction, applying a second media style to the media item, wherein the second media style is different from the first media style, and wherein the second media style corresponds to a second category of media styles that is different from the first category of media styles.

A method is described, in accordance with some embodiments. The method is performed at a computer system that is in communication with one or more input devices. The method comprises: detecting, via the one or more input devices, one or more user inputs corresponding to a request to configure a media style for a camera that is in communication with the computer system; and in response to detecting the one or more user inputs corresponding to the request to configure the media style for the camera that is in communication with the computer system, prompting a user to select one or more media items to preview the media style, wherein the one or more media items correspond to an account of the user.

A non-transitory computer-readable storage medium is described, in accordance with some embodiments. The non-transitory computer-readable storage medium stores one or more programs configured to be executed by one or more processors of a computer system that is in communication with one or more input devices, the one or more programs including instructions for: detecting, via the one or more input devices, one or more user inputs corresponding to a request to configure a media style for a camera that is in communication with the computer system; and in response to detecting the one or more user inputs corresponding to the request to configure the media style for the camera that is in communication with the computer system, prompting a user to select one or more media items to preview the media style, wherein the one or more media items correspond to an account of the user.

A transitory computer-readable storage medium is described, in accordance with some embodiments. The transitory computer-readable storage medium stores one or more programs configured to be executed by one or more processors of a computer system that is in communication with one or more input devices, the one or more programs including instructions for: detecting, via the one or more input devices, one or more user inputs corresponding to a request to configure a media style for a camera that is in communication with the computer system; and in response to detecting the one or more user inputs corresponding to the request to configure the media style for the camera that is in communication with the computer system, prompting a user to select one or more media items to preview the media style, wherein the one or more media items correspond to an account of the user.

A computer system is described, in accordance with some embodiments. The computer system is configured to communicate with one or more input devices and comprises: one or more processors; and memory storing one or more programs configured to be executed by the one or more processors, the one or more programs including instructions for: detecting, via the one or more input devices, one or more user inputs corresponding to a request to configure a media style for a camera that is in communication with the computer system; and in response to detecting the one or more user inputs corresponding to the request to configure the media style for the camera that is in communication with the computer system, prompting a user to select one or more media items to preview the media style, wherein the one or more media items correspond to an account of the user.

A computer system is described, in accordance with some embodiments. The computer system is configured to communicate with one or more input devices and comprises: means for detecting, via the one or more input devices, one or more user inputs corresponding to a request to configure a media style for a camera that is in communication with the computer system; and means for, in response to detecting the one or more user inputs corresponding to the request to configure the media style for the camera that is in communication with the computer system, prompting a user to select one or more media items to preview the media style, wherein the one or more media items correspond to an account of the user.

A computer program product is described, in accordance with some embodiments. The computer program product comprises one or more programs configured to be executed by one or more processors of a computer system that is in communication with one or more input devices, the one or more programs including instructions for: detecting, via the one or more input devices, one or more user inputs corresponding to a request to configure a media style for a camera that is in communication with the computer system; and in response to detecting the one or more user inputs corresponding to the request to configure the media style for the camera that is in communication with the computer system, prompting a user to select one or more media items to preview the media style, wherein the one or more media items correspond to an account of the user.

A method is described, in accordance with some embodiments. The method is performed at a computer system that is in communication with one or more display generation components and one or more input devices. The method comprises: while displaying, via the one or more display generation components, a media user interface including a media item, detecting, via the one or more input devices, one or more user inputs corresponding to a request to edit content of the media item; and in response to detecting the one or more user inputs corresponding to the request to edit the content of the media item: in accordance with a determination that the request to edit the content of the media item satisfies a first set of content-based criteria, wherein the first set of content-based criteria is based on an evaluation of content of the media item, replacing a respective portion of the content of the media item with content of a first type; and in accordance with a determination that the request to edit the content of the media item does not satisfy the first set of content-based criteria, replacing the respective portion of the content of the media item with content of a second type that is different from the content of the first type.

A non-transitory computer-readable storage medium is described, in accordance with some embodiments. The non-transitory computer-readable storage medium stores one or more programs configured to be executed by one or more processors of a computer system that is in communication with one or more display generation components and one or more input devices, the one or more programs including instructions for: while displaying, via the one or more display generation components, a media user interface including a media item, detecting, via the one or more input devices, one or more user inputs corresponding to a request to edit content of the media item; and in response to detecting the one or more user inputs corresponding to the request to edit the content of the media item: in accordance with a determination that the request to edit the content of the media item satisfies a first set of content-based criteria, wherein the first set of content-based criteria is based on an evaluation of content of the media item, replacing a respective portion of the content of the media item with content of a first type; and in accordance with a determination that the request to edit the content of the media item does not satisfy the first set of content-based criteria, replacing the respective portion of the content of the media item with content of a second type that is different from the content of the first type.

A transitory computer-readable storage medium is described, in accordance with some embodiments. The transitory computer-readable storage medium stores one or more programs configured to be executed by one or more processors of a computer system that is in communication with one or more display generation components and one or more input devices, the one or more programs including instructions for: while displaying, via the one or more display generation components, a media user interface including a media item, detecting, via the one or more input devices, one or more user inputs corresponding to a request to edit content of the media item; and in response to detecting the one or more user inputs corresponding to the request to edit the content of the media item: in accordance with a determination that the request to edit the content of the media item satisfies a first set of content-based criteria, wherein the first set of content-based criteria is based on an evaluation of content of the media item, replacing a respective portion of the content of the media item with content of a first type; and in accordance with a determination that the request to edit the content of the media item does not satisfy the first set of content-based criteria, replacing the respective portion of the content of the media item with content of a second type that is different from the content of the first type.

A computer system is described, in accordance with some embodiments. The computer system is configured to communicate with one or more display generation components and one or more input devices and comprises: one or more processors; and memory storing one or more programs configured to be executed by the one or more processors, the one or more programs including instructions for: while displaying, via the one or more display generation components, a media user interface including a media item, detecting, via the one or more input devices, one or more user inputs corresponding to a request to edit content of the media item; and in response to detecting the one or more user inputs corresponding to the request to edit the content of the media item: in accordance with a determination that the request to edit the content of the media item satisfies a first set of content-based criteria, wherein the first set of content-based criteria is based on an evaluation of content of the media item, replacing a respective portion of the content of the media item with content of a first type; and in accordance with a determination that the request to edit the content of the media item does not satisfy the first set of content-based criteria, replacing the respective portion of the content of the media item with content of a second type that is different from the content of the first type.

A computer system is described, in accordance with some embodiments. The computer system is configured to communicate with one or more display generation components and one or more input devices and comprises: means for, while displaying, via the one or more display generation components, a media user interface including a media item, detecting, via the one or more input devices, one or more user inputs corresponding to a request to edit content of the media item; and means for, in response to detecting the one or more user inputs corresponding to the request to edit the content of the media item: in accordance with a determination that the request to edit the content of the media item satisfies a first set of content-based criteria, wherein the first set of content-based criteria is based on an evaluation of content of the media item, replacing a respective portion of the content of the media item with content of a first type; and in accordance with a determination that the request to edit the content of the media item does not satisfy the first set of content-based criteria, replacing the respective portion of the content of the media item with content of a second type that is different from the content of the first type.

A computer program product is described, in accordance with some embodiments. The computer program product comprises one or more programs configured to be executed by one or more processors of a computer system that is in communication with one or more display generation components and one or more input devices, the one or more programs including instructions for: while displaying, via the one or more display generation components, a media user interface including a media item, detecting, via the one or more input devices, one or more user inputs corresponding to a request to edit content of the media item; and in response to detecting the one or more user inputs corresponding to the request to edit the content of the media item: in accordance with a determination that the request to edit the content of the media item satisfies a first set of content-based criteria, wherein the first set of content-based criteria is based on an evaluation of content of the media item, replacing a respective portion of the content of the media item with content of a first type; and in accordance with a determination that the request to edit the content of the media item does not satisfy the first set of content-based criteria, replacing the respective portion of the content of the media item with content of a second type that is different from the content of the first type.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for editing media, thereby increasing the effectiveness, efficiency, and user satisfaction with such devices. Such methods and interfaces may complement or replace other methods for editing media.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 6A-6AG illustrate exemplary user interfaces for managing photographic styles, in accordance with some embodiments.

FIGS. 7A and 7B are flow diagrams illustrating a method for managing photographic styles, in accordance with some embodiments.

FIGS. 8A-8Z illustrate exemplary user interfaces for editing video media items, in accordance with some embodiments.

FIGS. 9A and 9B are flow diagrams illustrating a method for editing video media items, in accordance with some embodiments.

FIGS. 10A-10R illustrate exemplary user interfaces for selectively applying edits from one image to another image, in accordance with some embodiments.

FIG. 11 is a flow diagram illustrating a method for selectively applying edits from one image to another image, in accordance with some embodiments.

FIGS. 12A-12AK illustrate exemplary user interfaces for editing media based on a location of an input, in accordance with some embodiments.

FIG. 13 is a flow diagram illustrating a method for editing media based on a location of an input, in accordance with some embodiments.

FIGS. 14A-14L illustrate exemplary user interfaces for editing audio of a media item, in accordance with some embodiments.

FIG. 15 is a flow diagram illustrating a method for managing slow motion controls, in accordance with some embodiments.

FIG. 16 is a flow diagram illustrating a method for editing audio of a media item, in accordance with some embodiments.

FIGS. 17A-17AP illustrate exemplary user interfaces for managing media styles, in accordance with some embodiments.

FIG. 18 is a flow diagram illustrating a method for selecting media styles, in accordance with some embodiments.

FIG. 19 is a flow diagram illustrating a method for previewing a media style, in accordance with some embodiments.

FIGS. 20A-20W illustrate exemplary user interfaces for editing a media item, in accordance with some embodiments.

FIG. 21 is a flow diagram illustrating a method for editing a media item, in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for editing media. Electronic devices optionally edit media by modifying objects of the media. There is a need for electronic devices to edit media based on a location of where an input begins (e.g., whether the input begins in the foreground and/or background of the media). Such techniques can reduce the cognitive burden on a user who edits media, thereby enhancing productivity. Further, such techniques can reduce processor and battery power otherwise wasted on redundant user inputs.

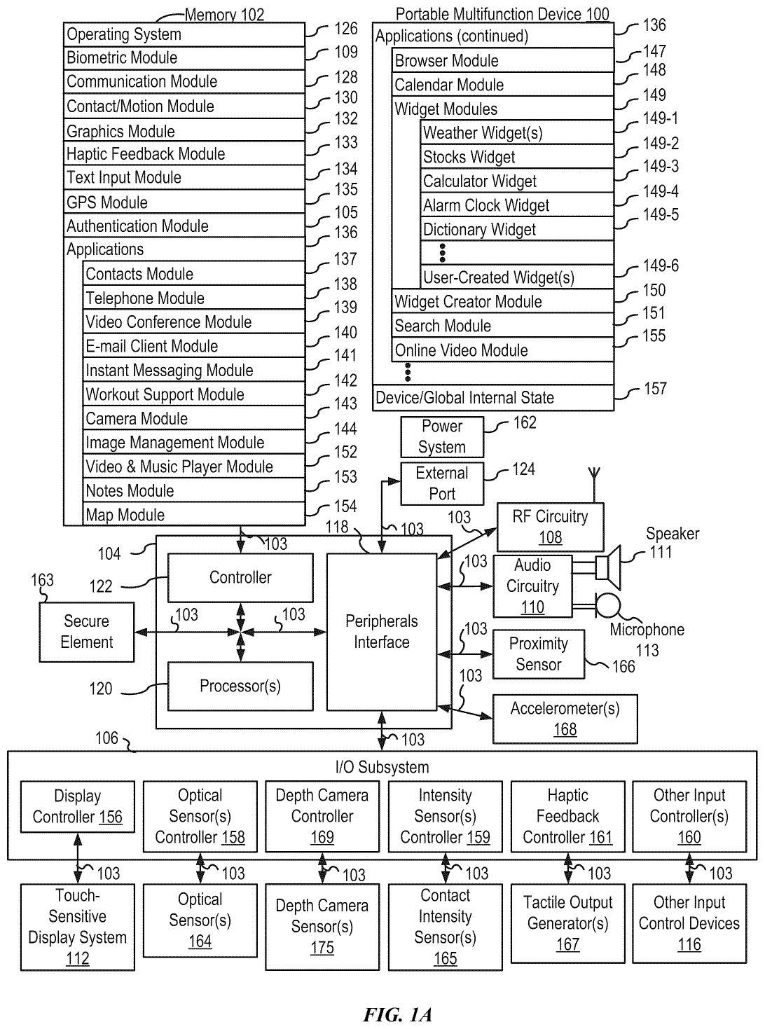

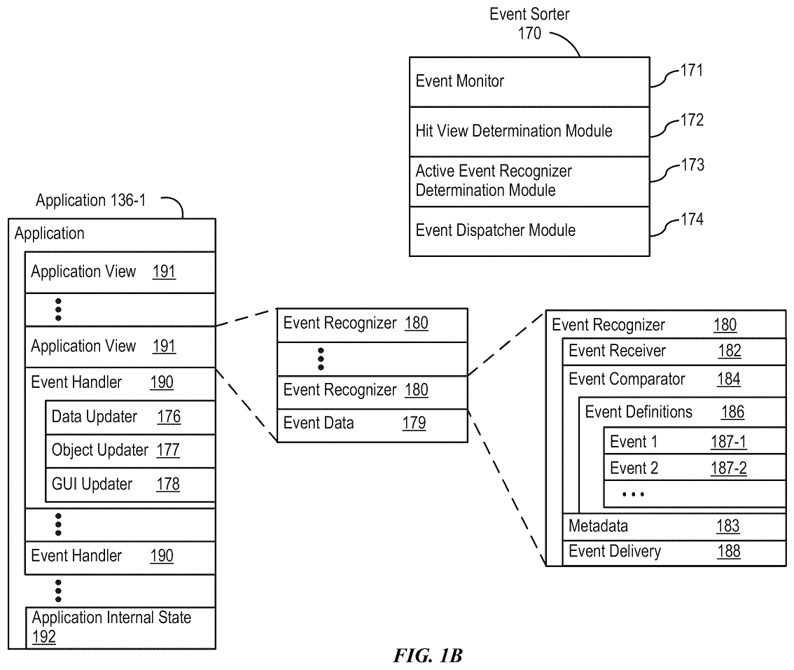

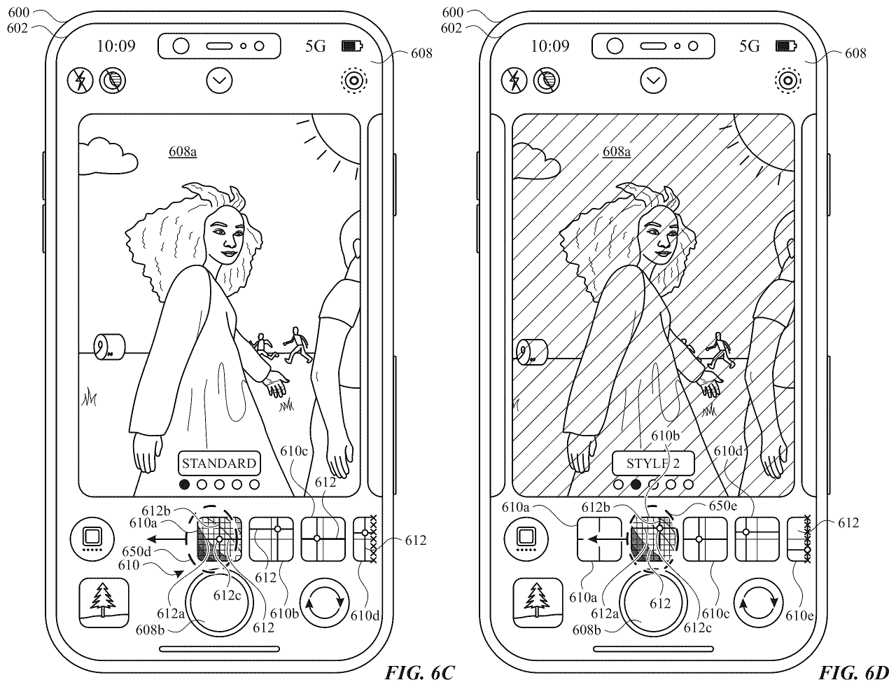

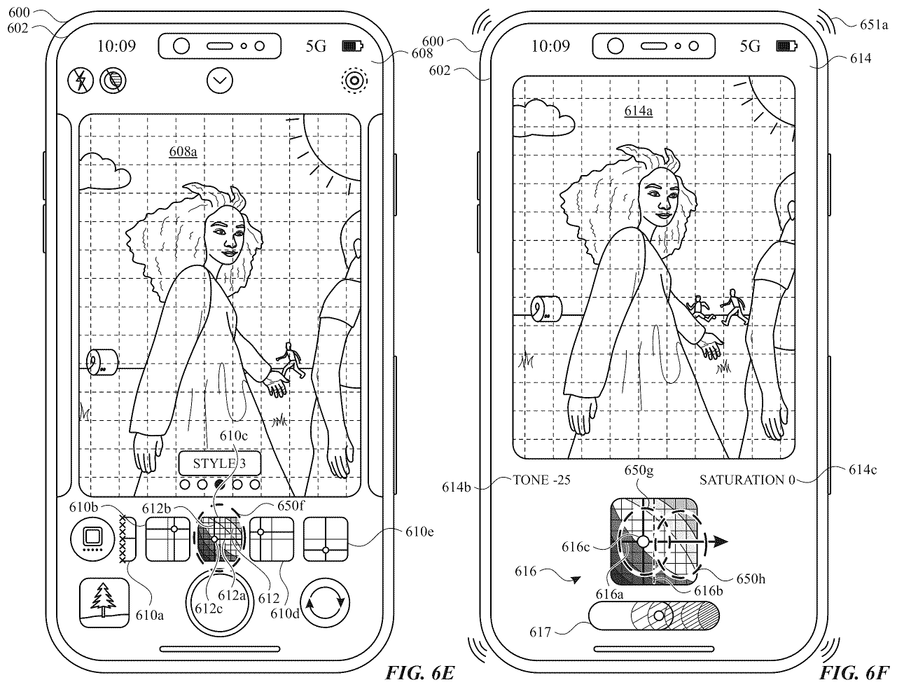

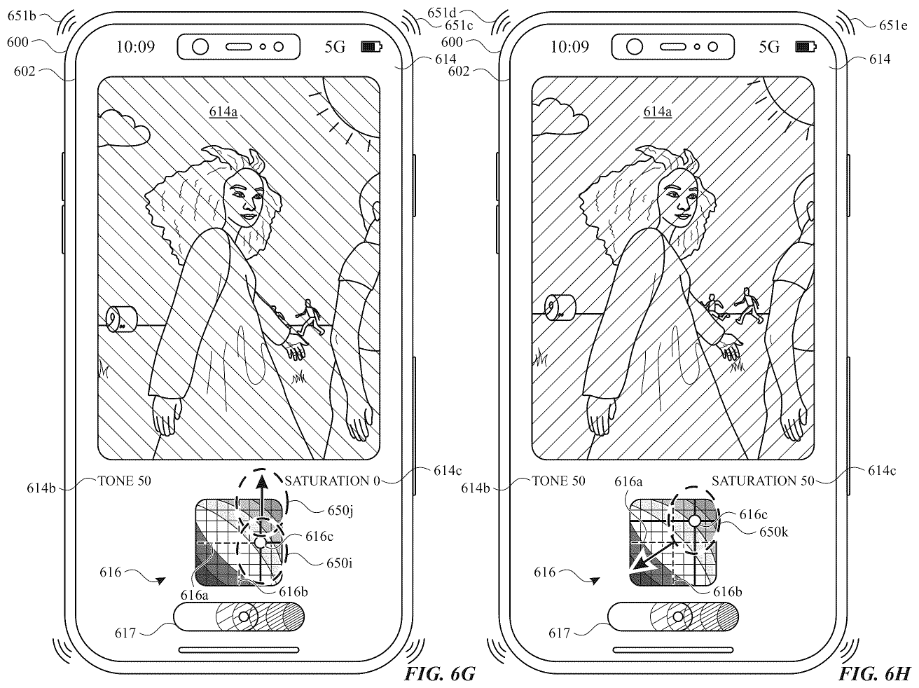

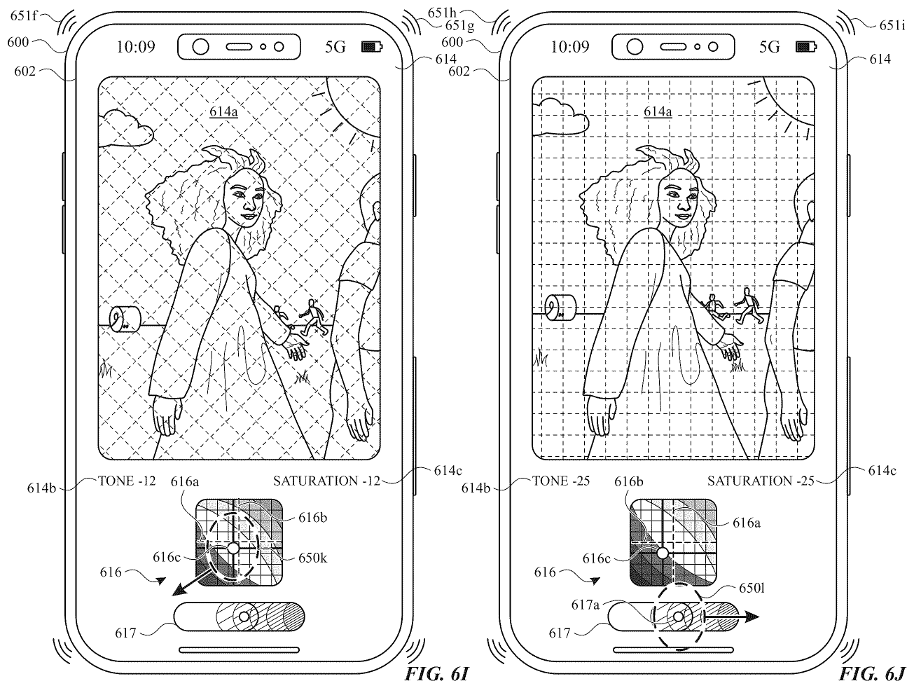

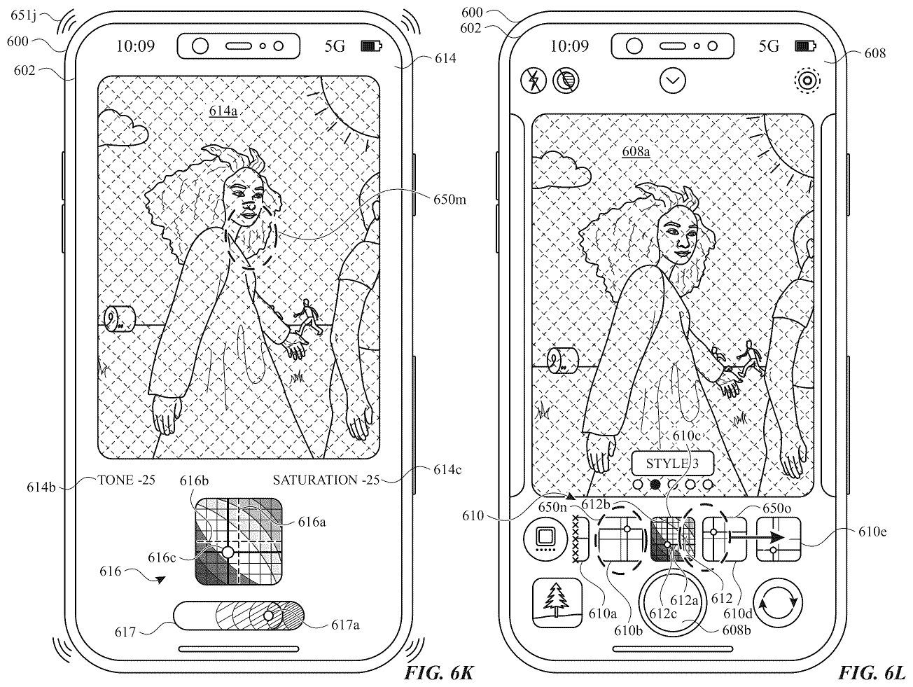

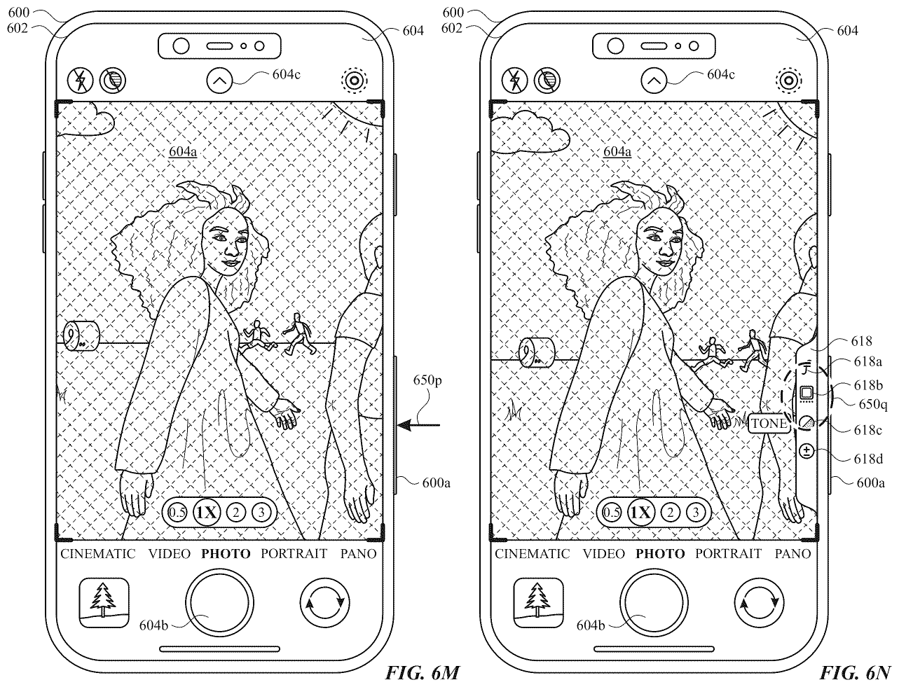

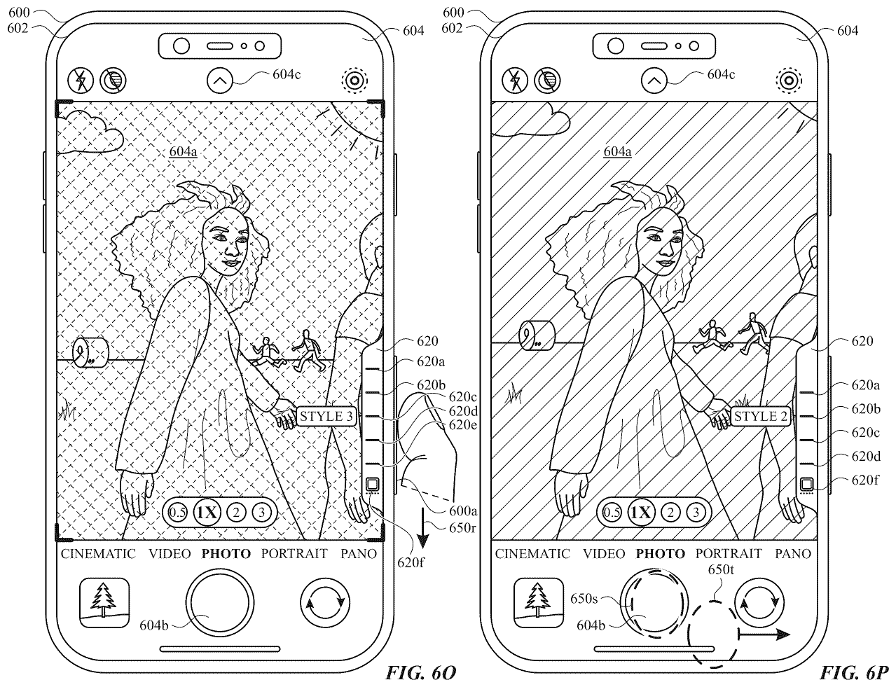

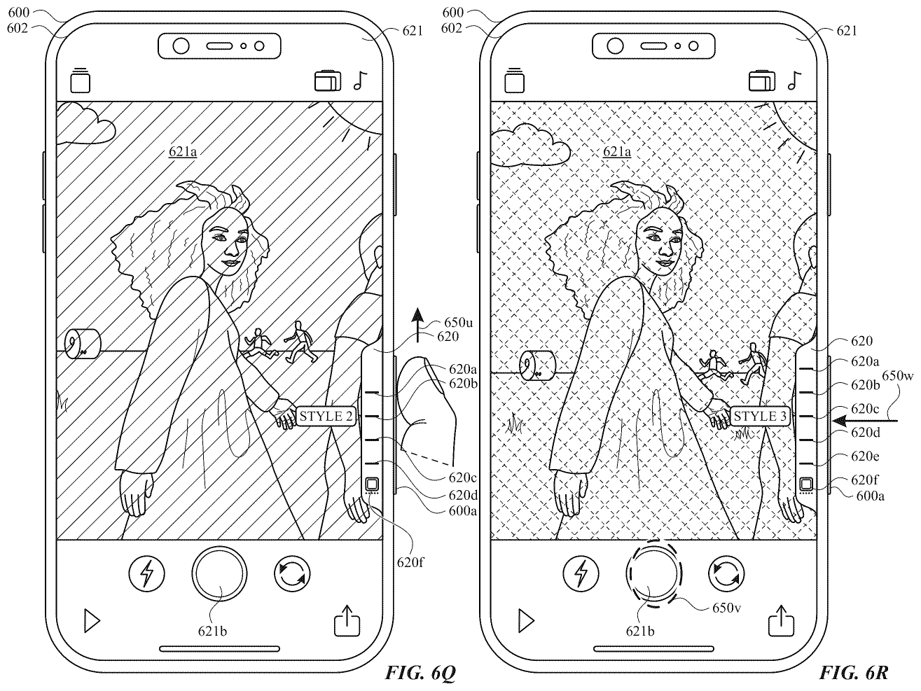

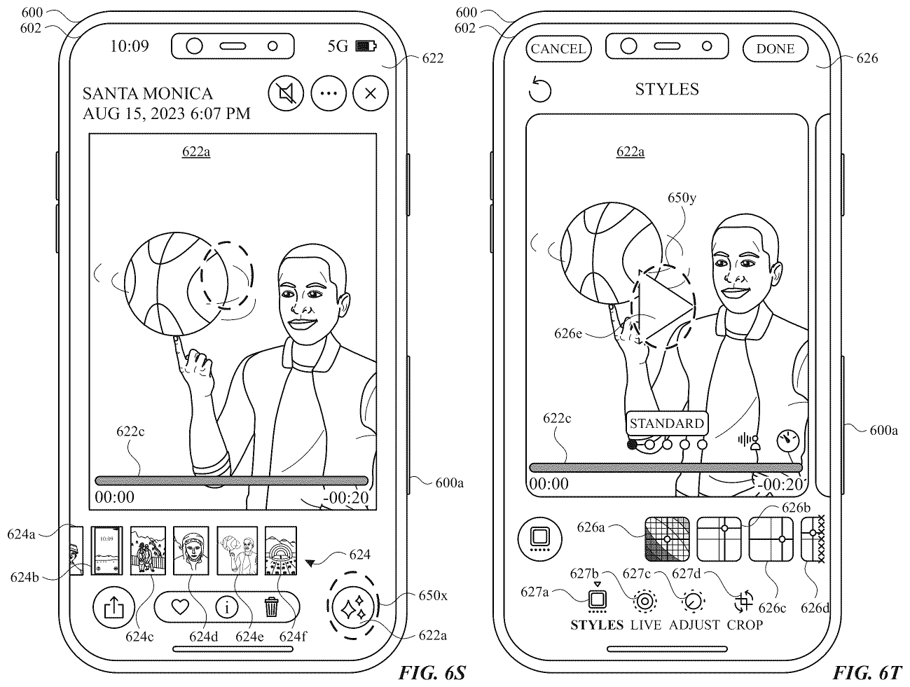

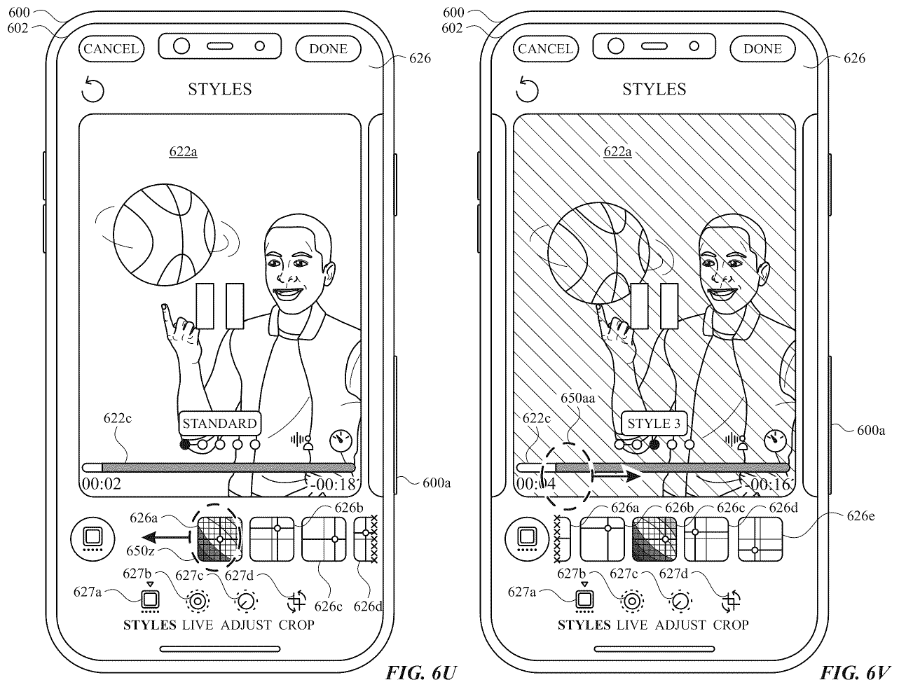

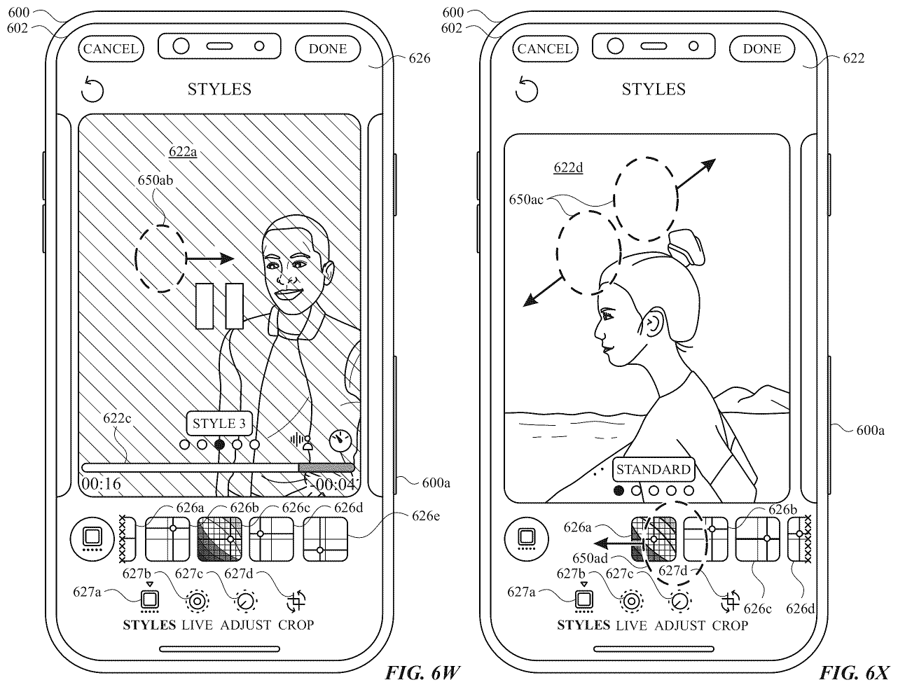

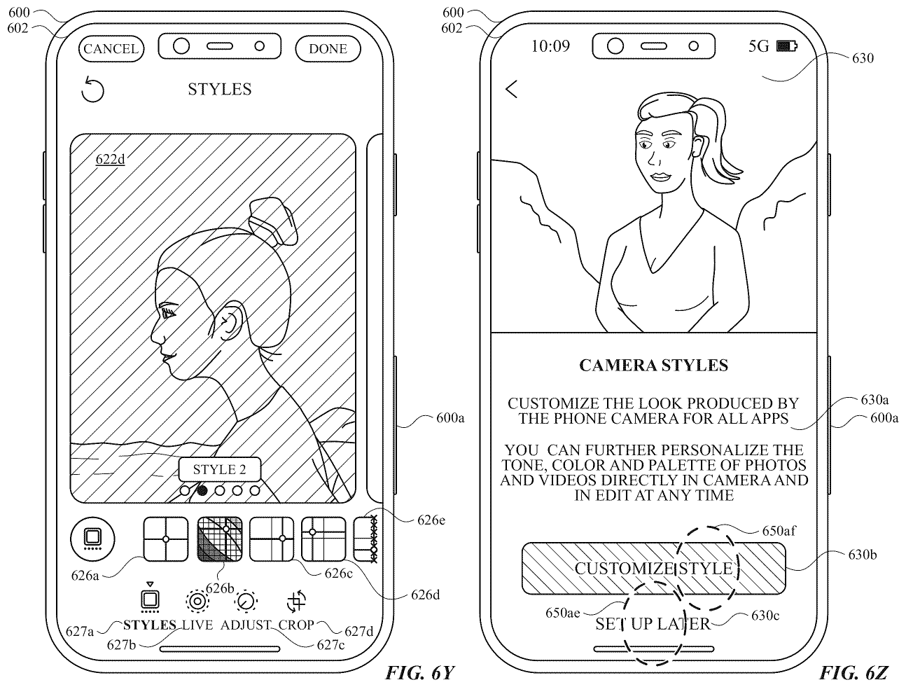

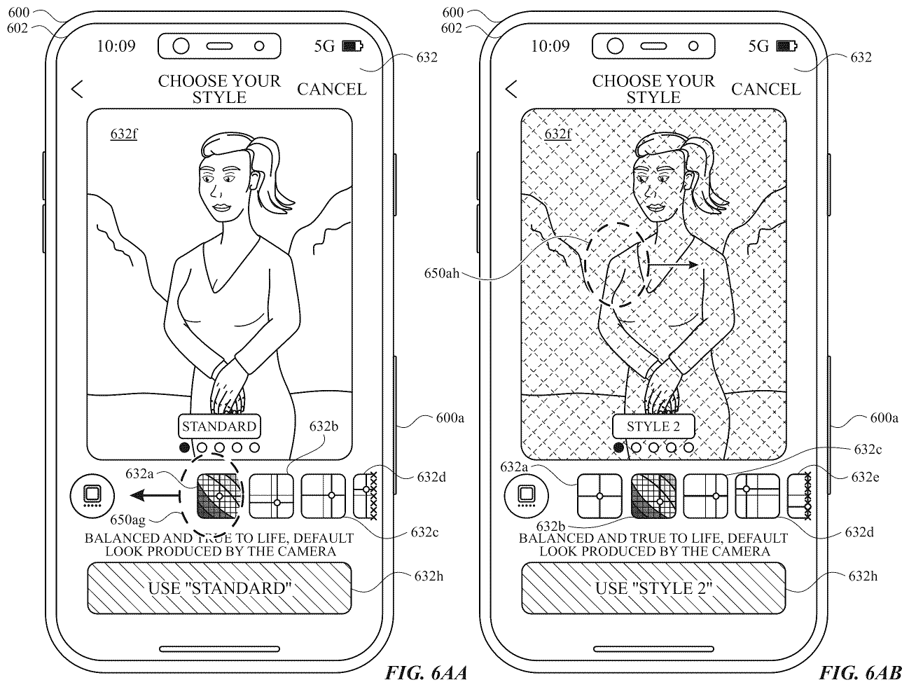

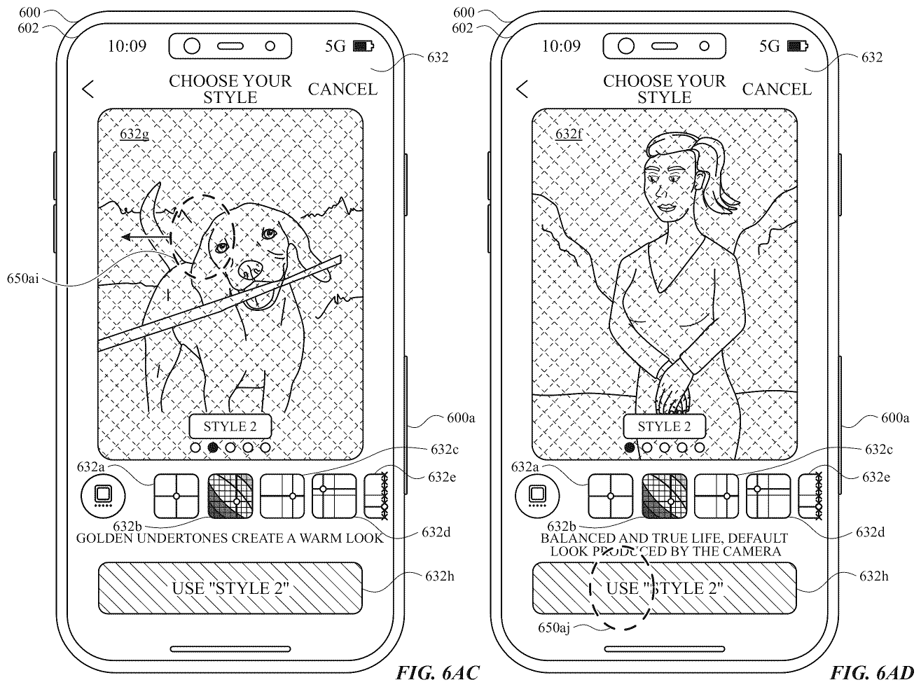

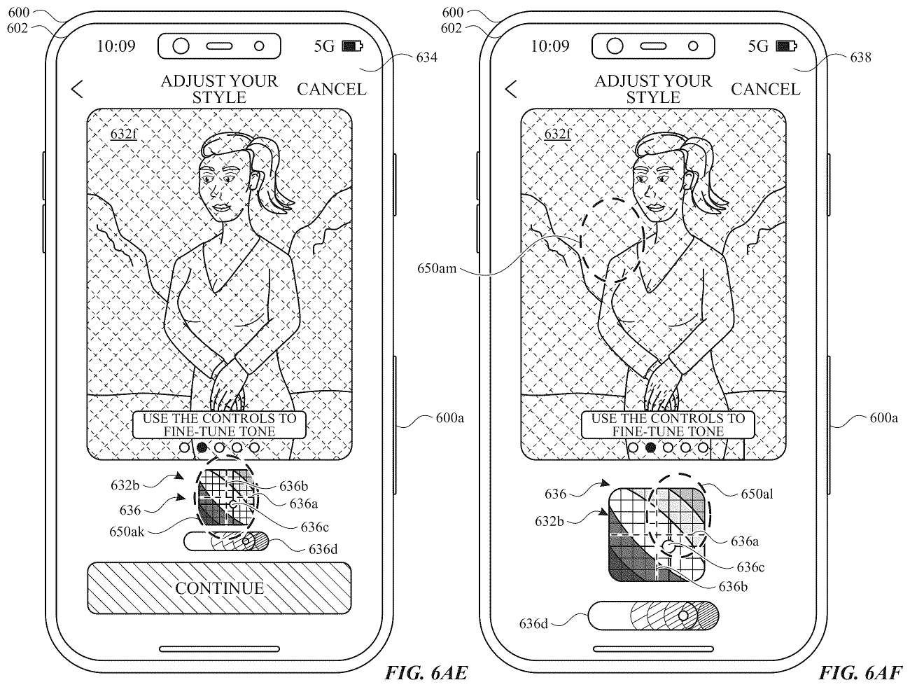

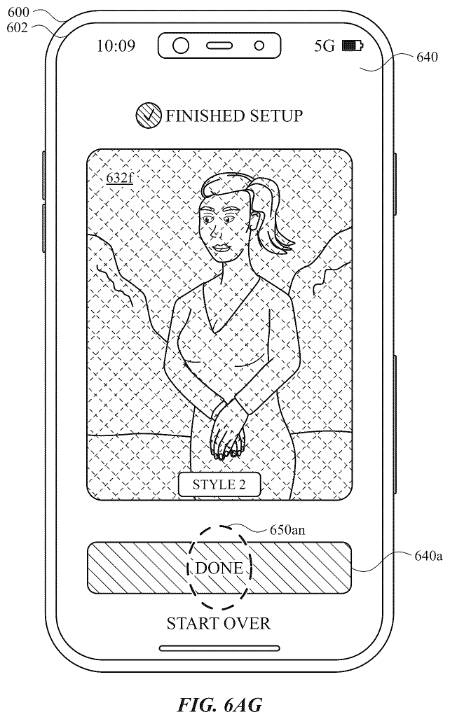

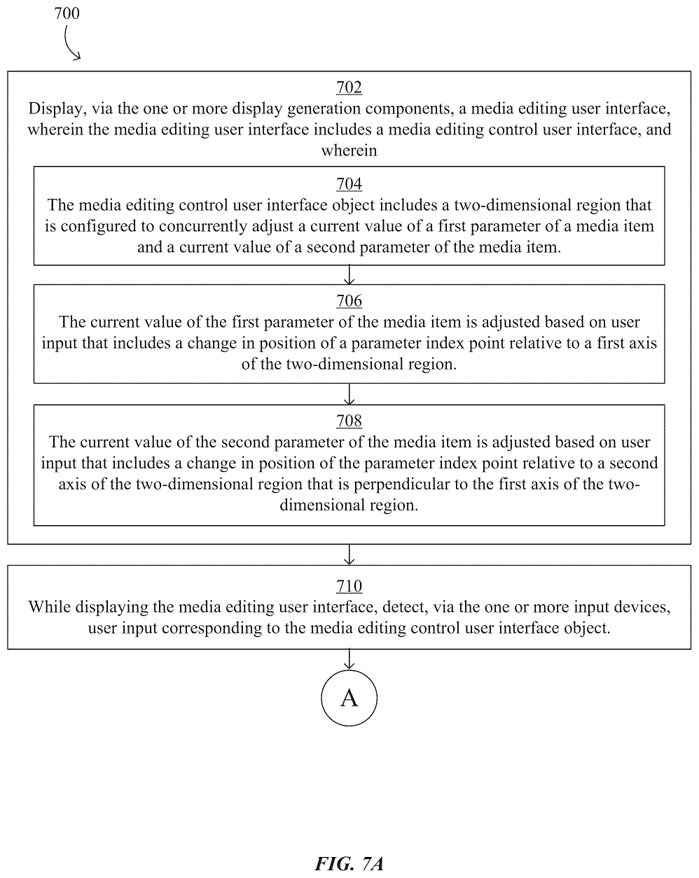

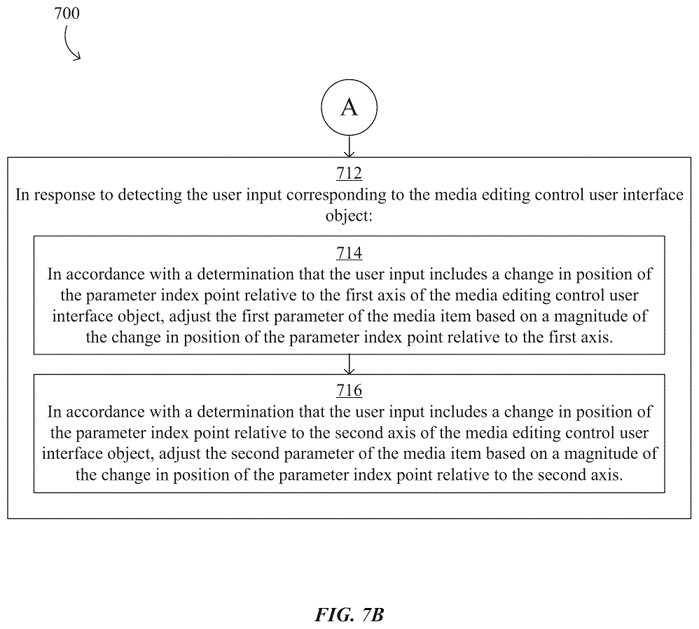

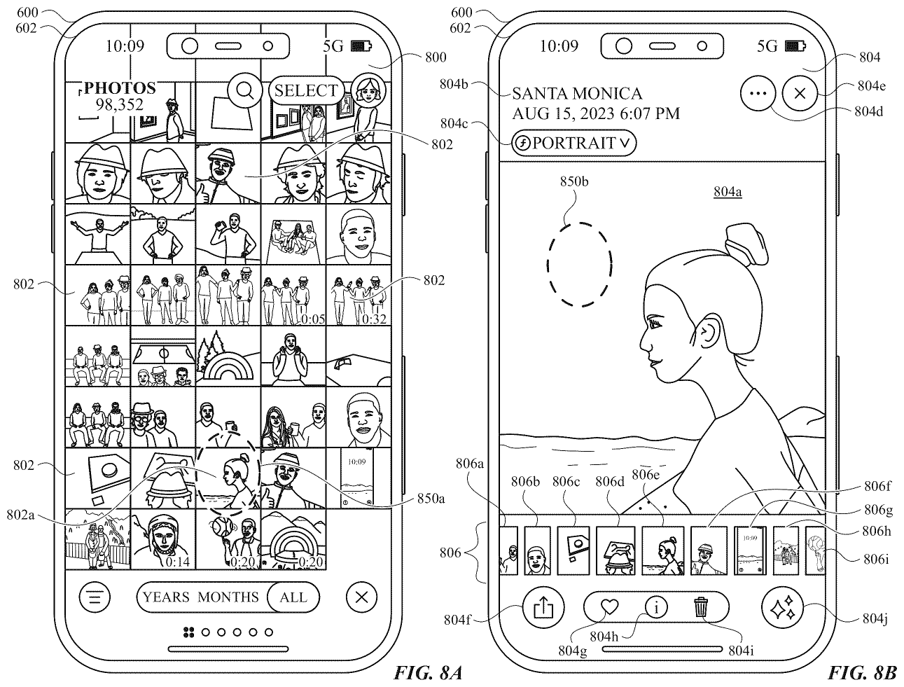

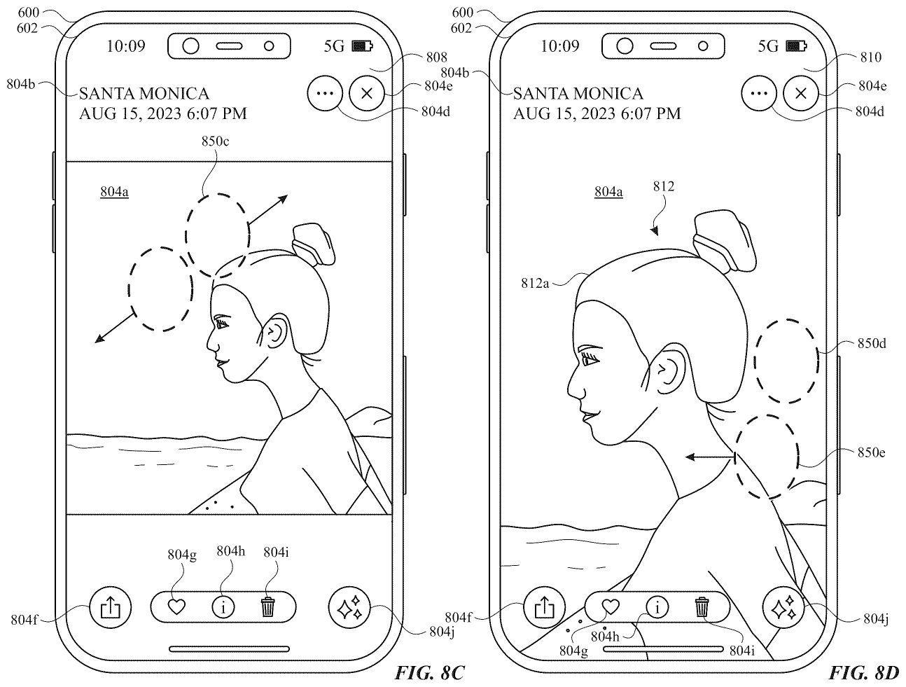

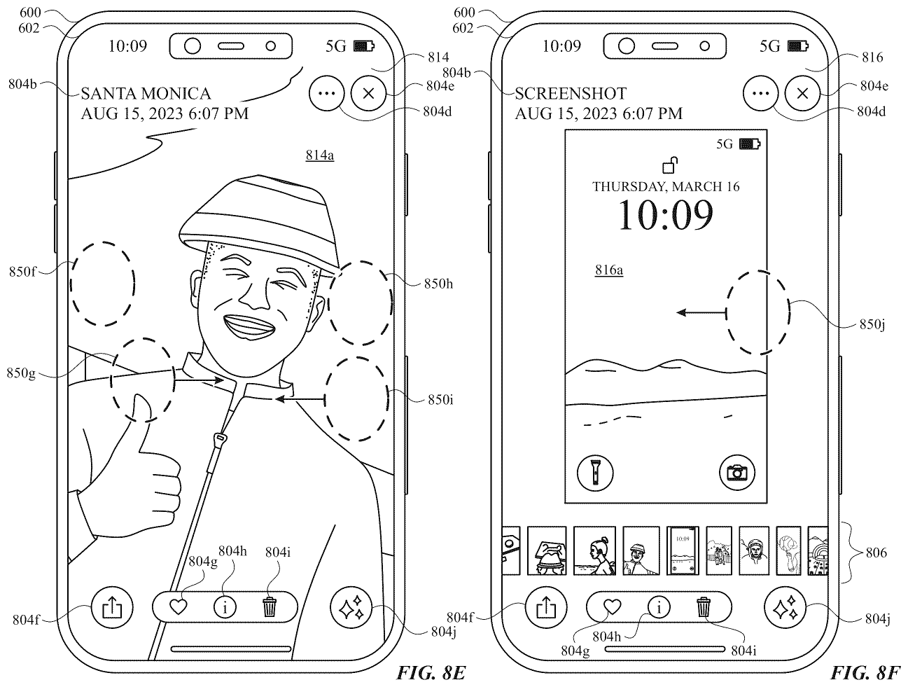

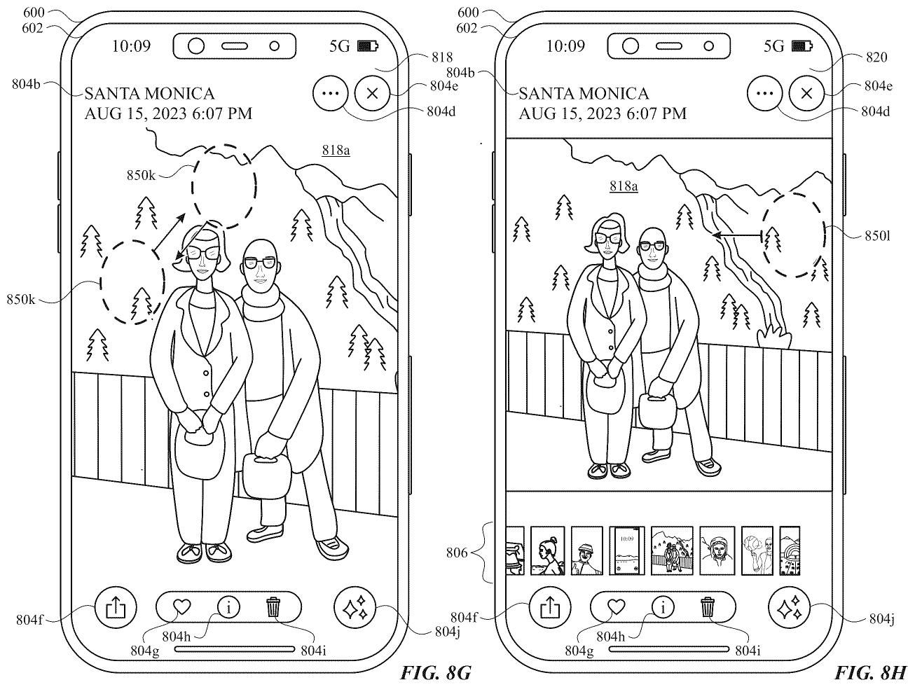

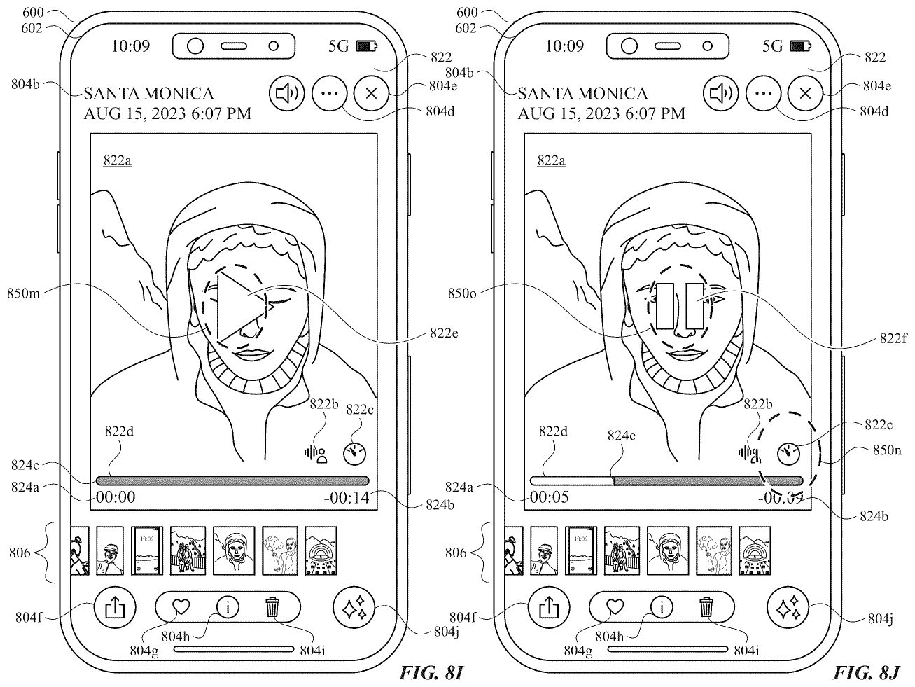

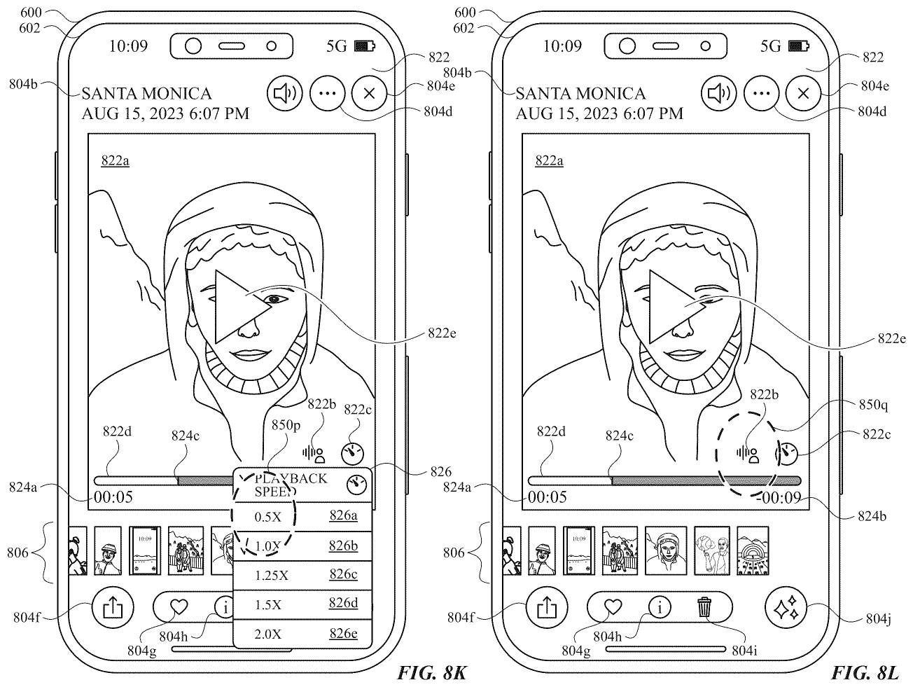

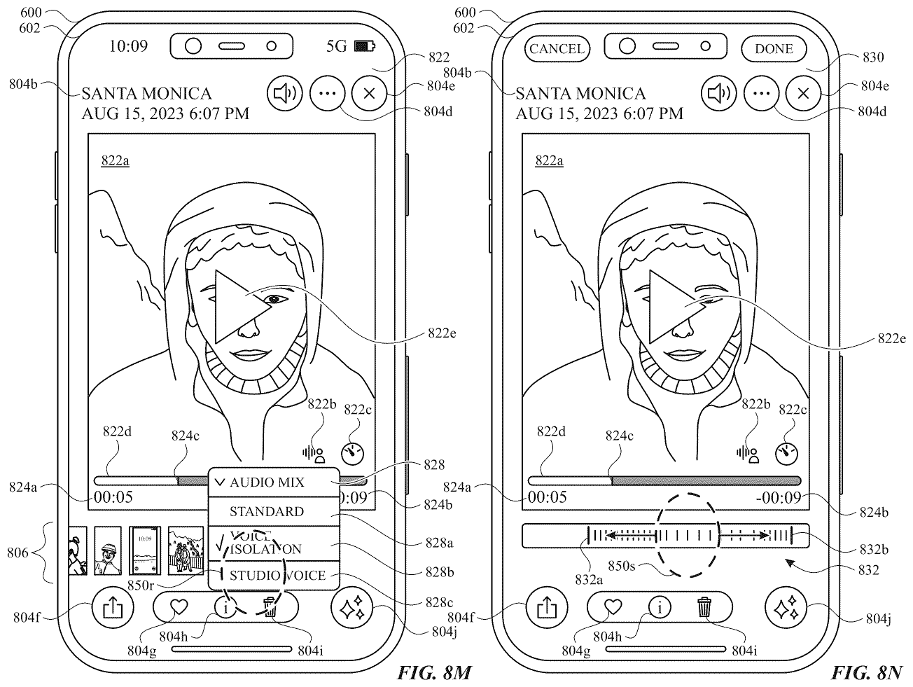

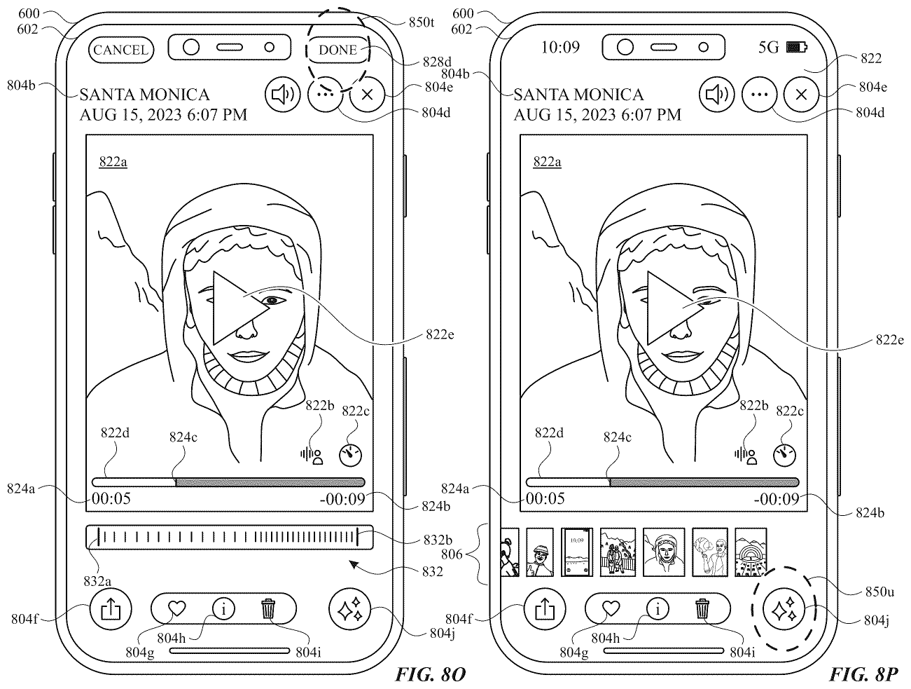

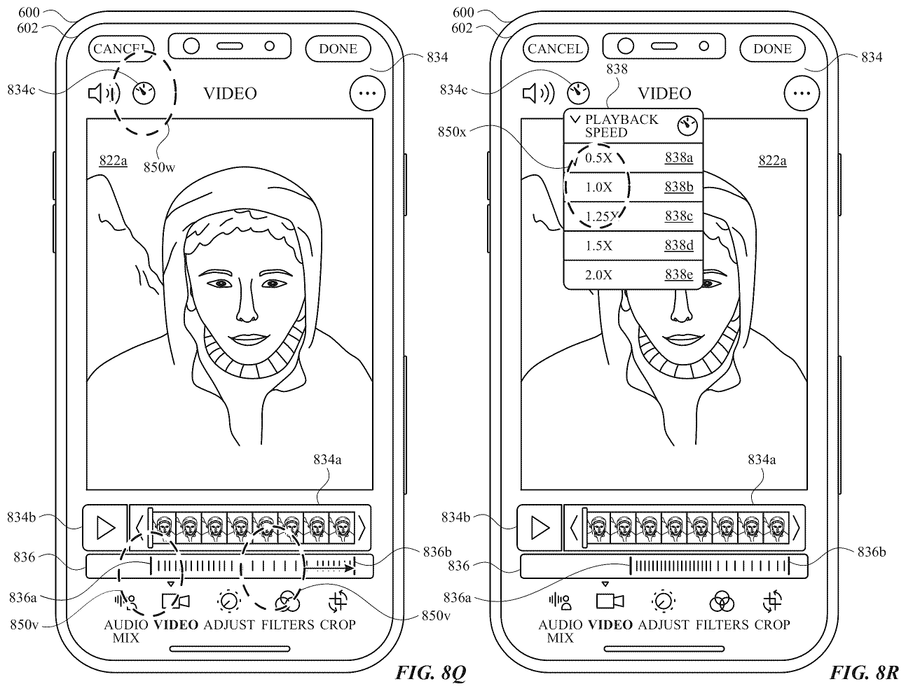

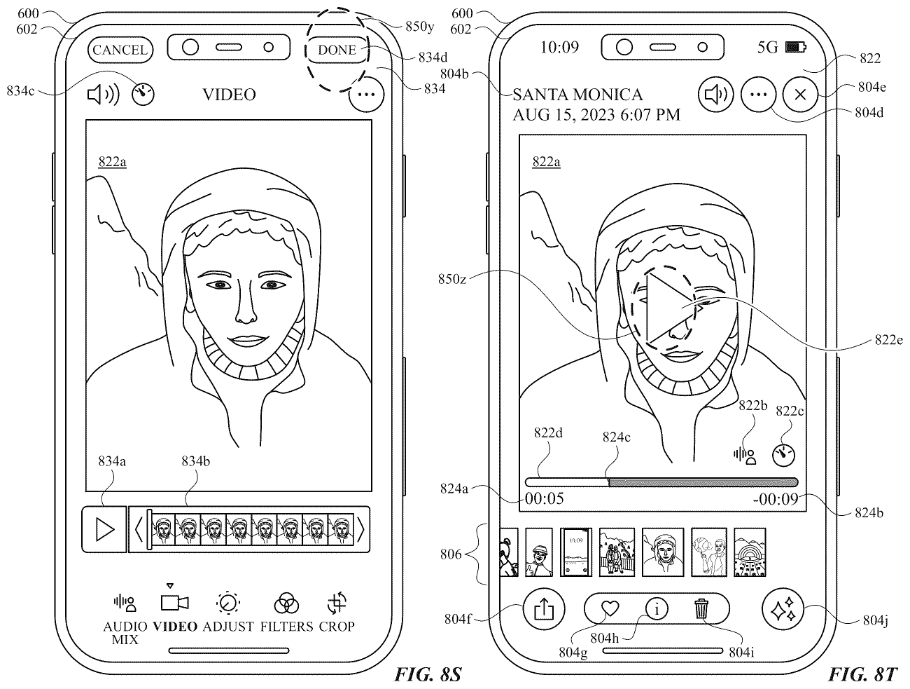

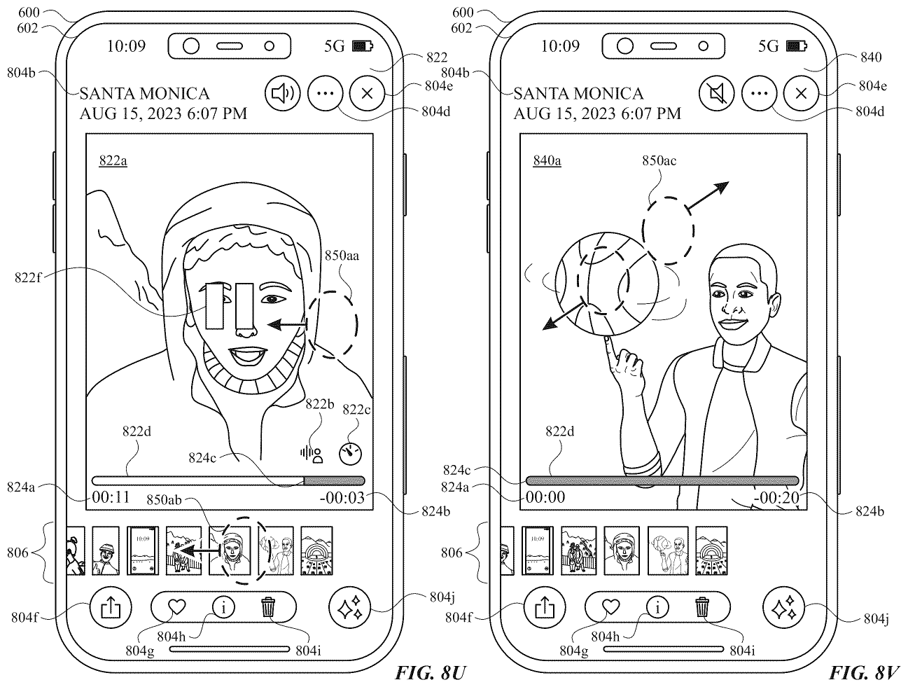

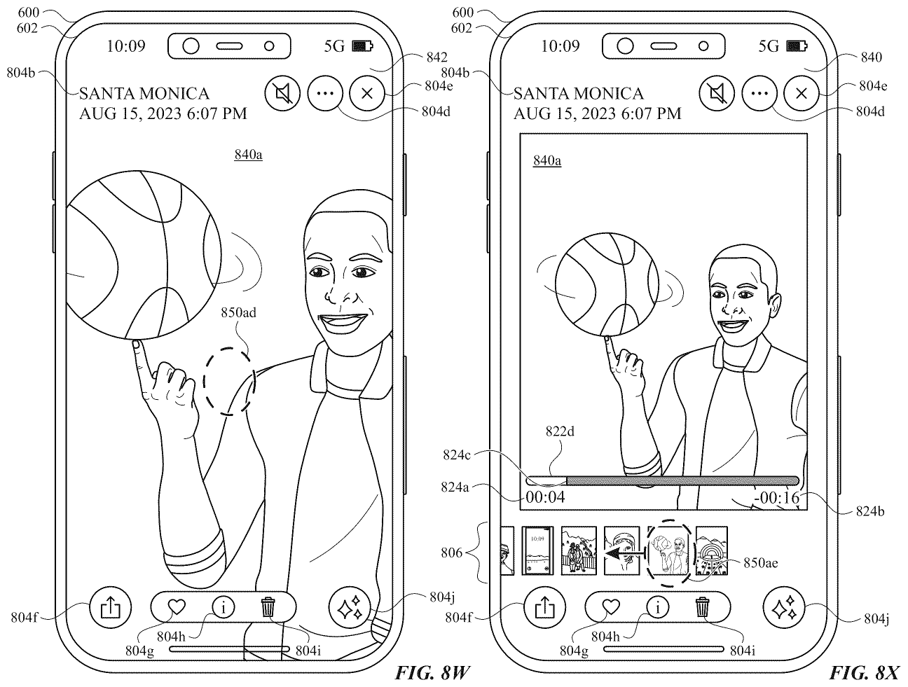

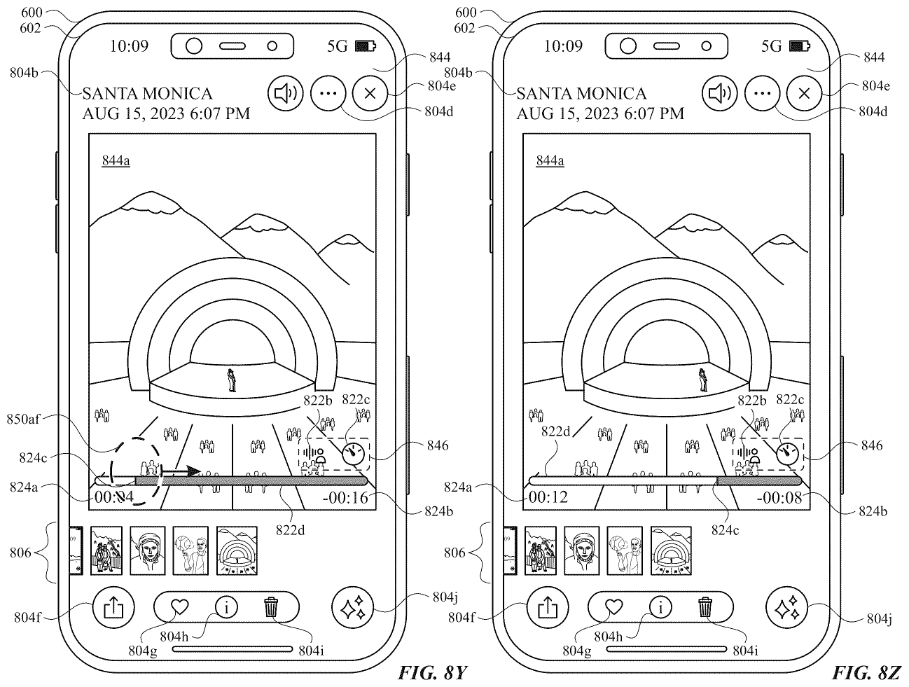

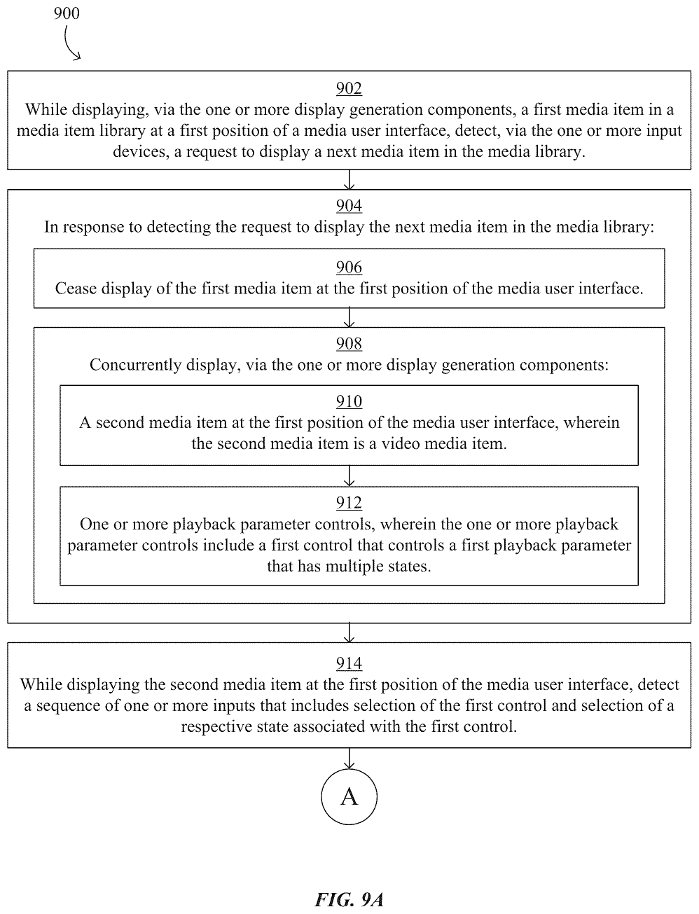

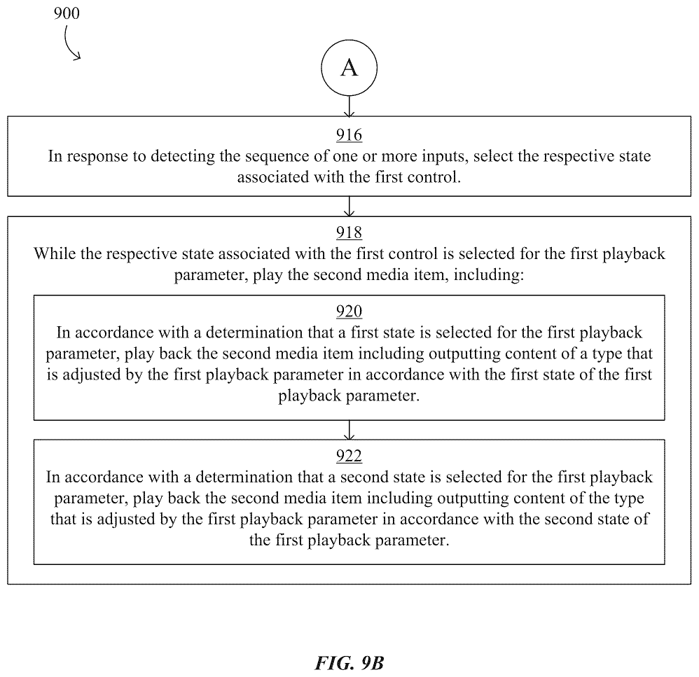

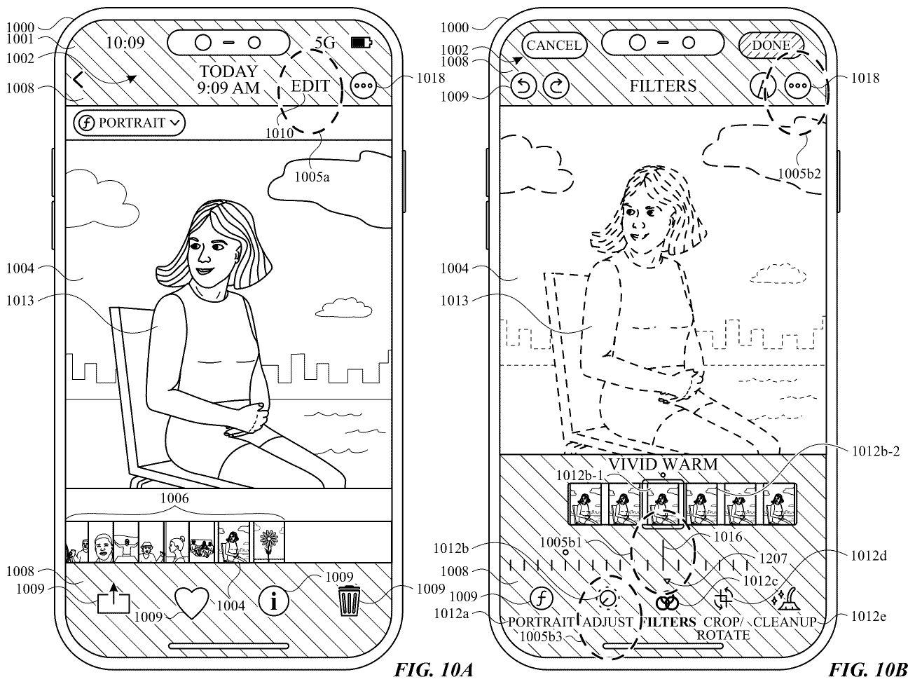

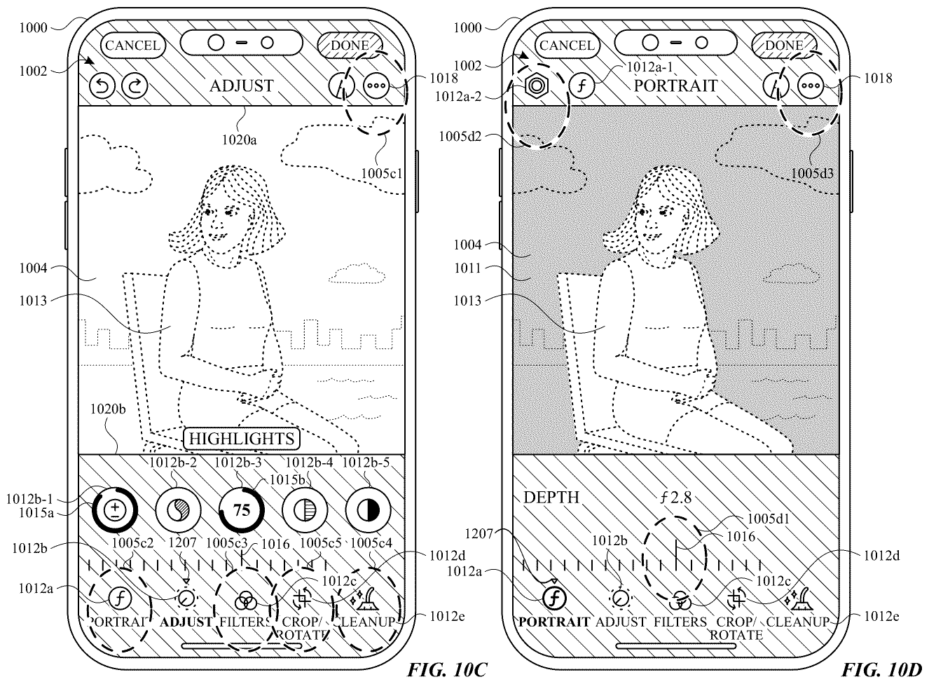

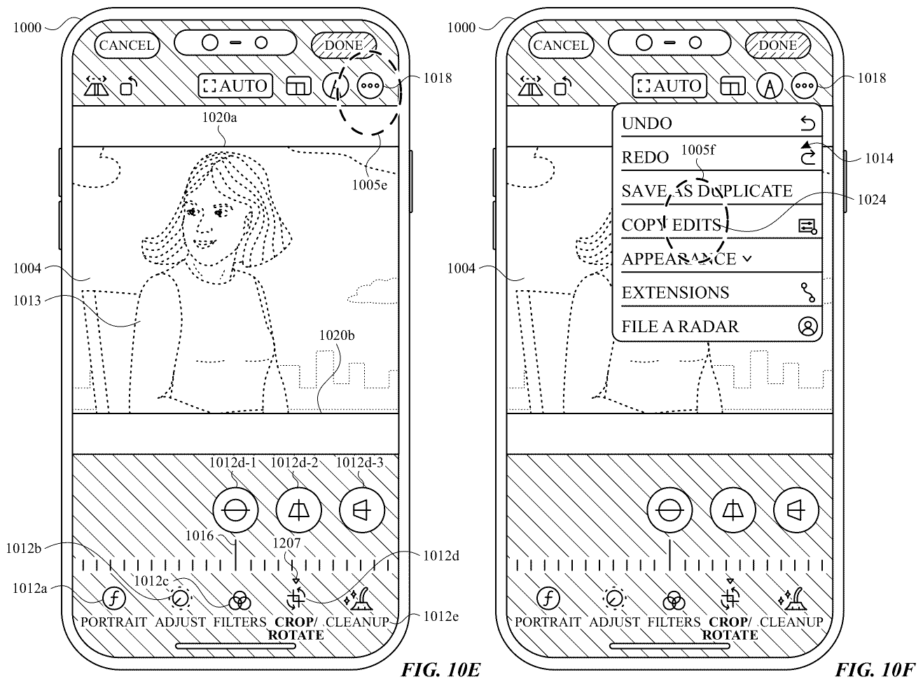

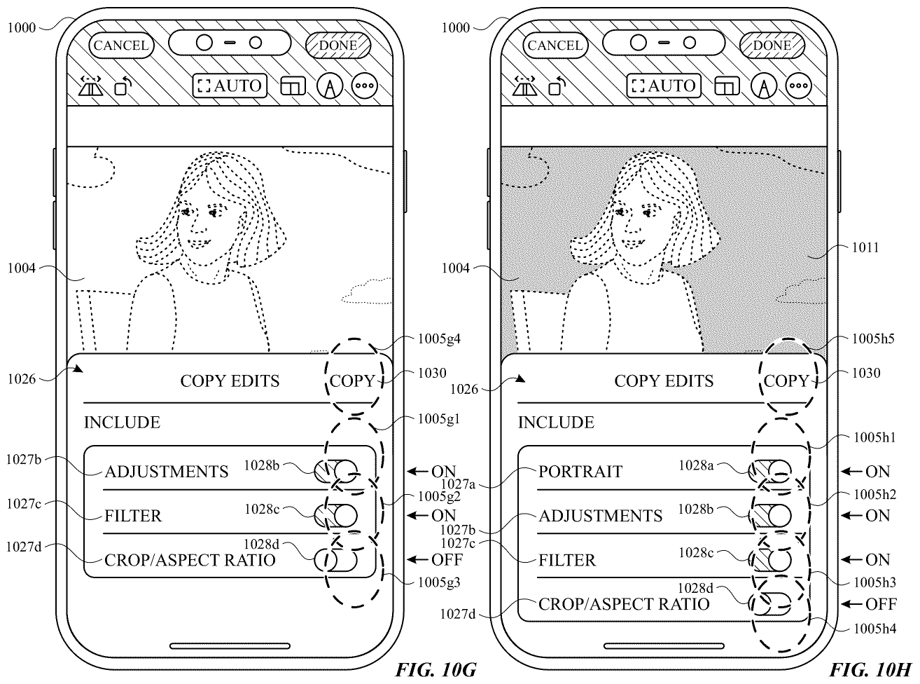

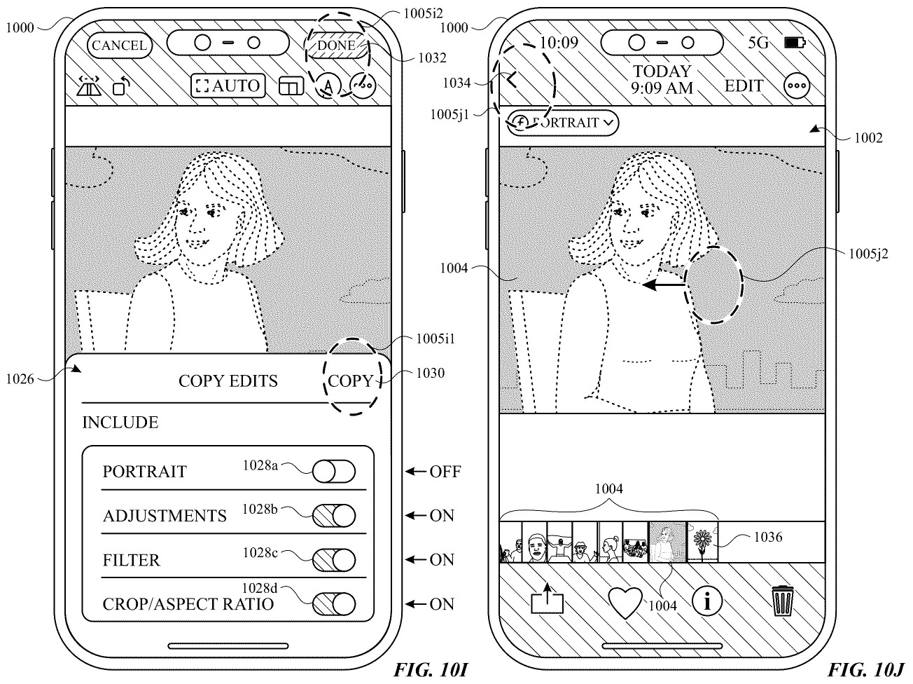

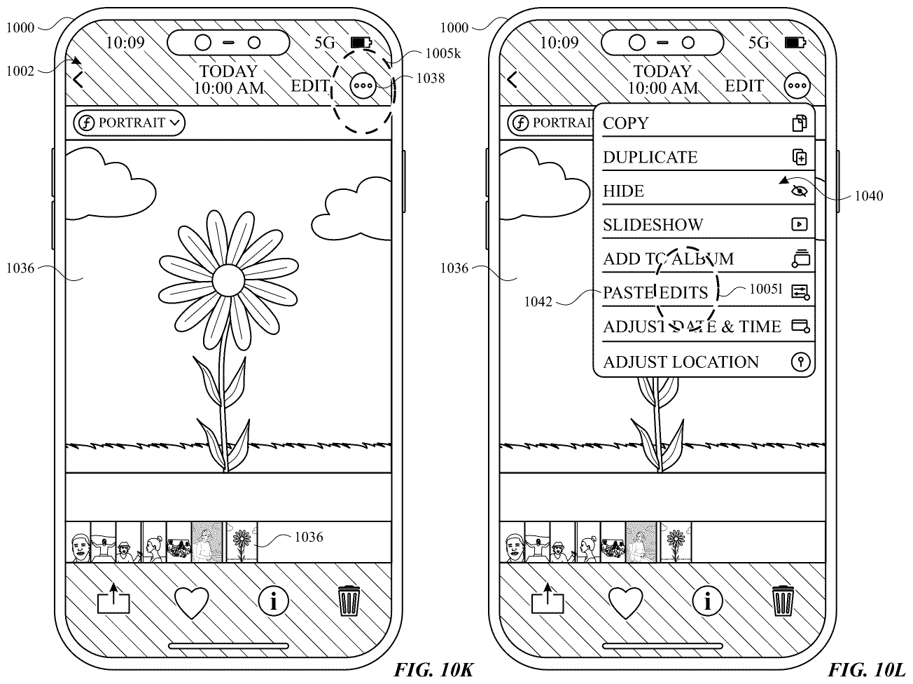

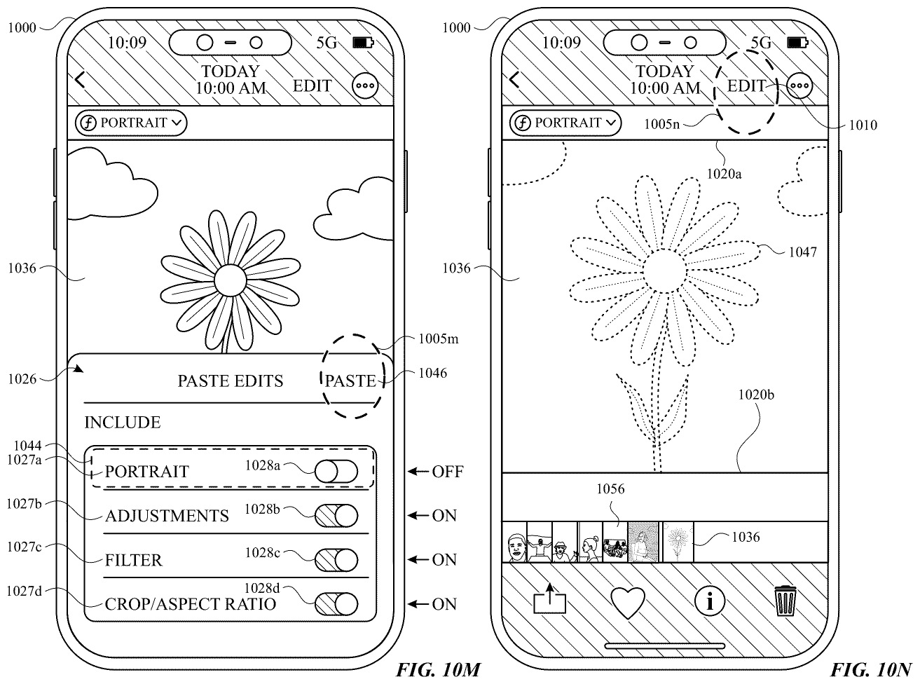

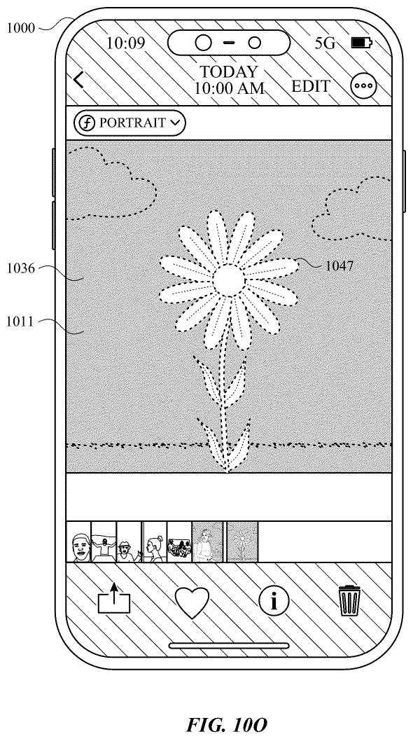

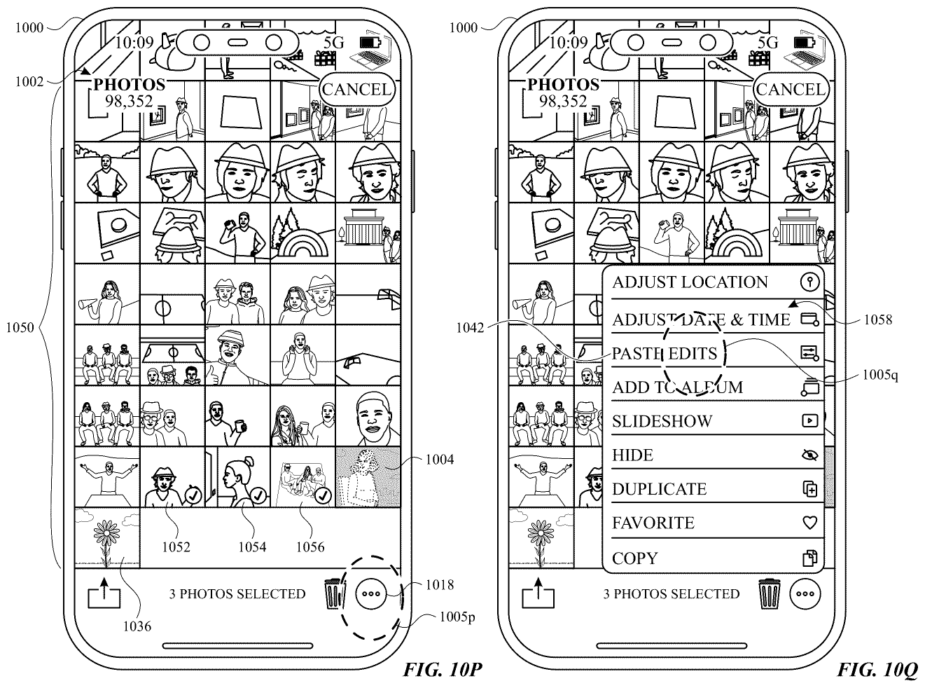

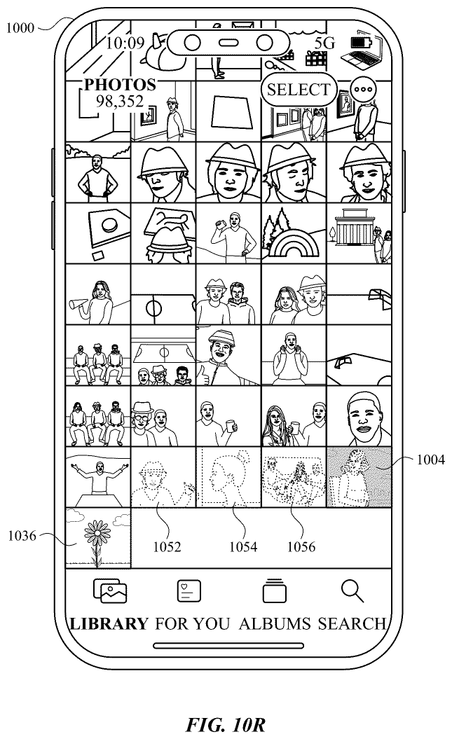

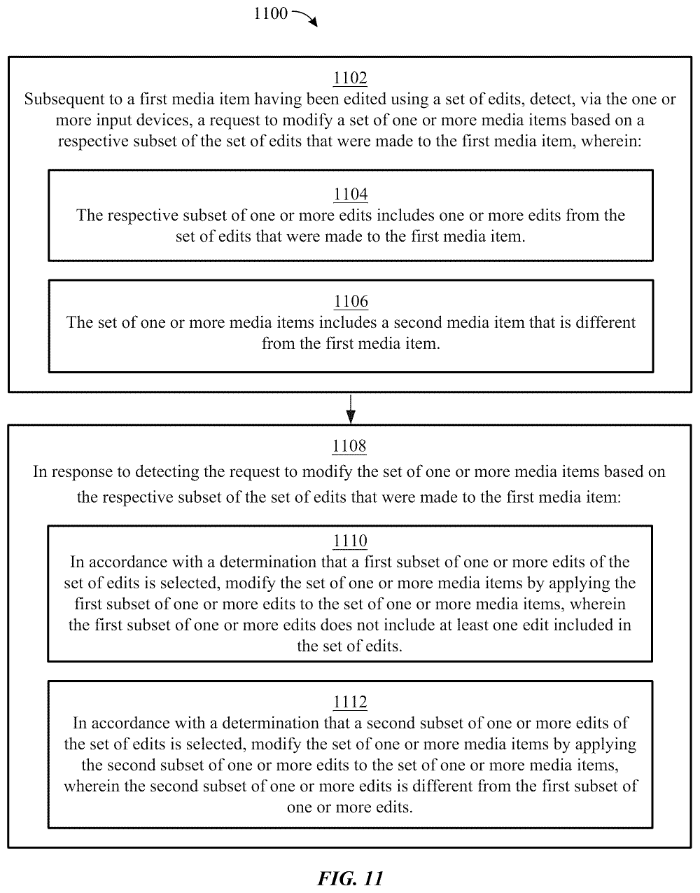

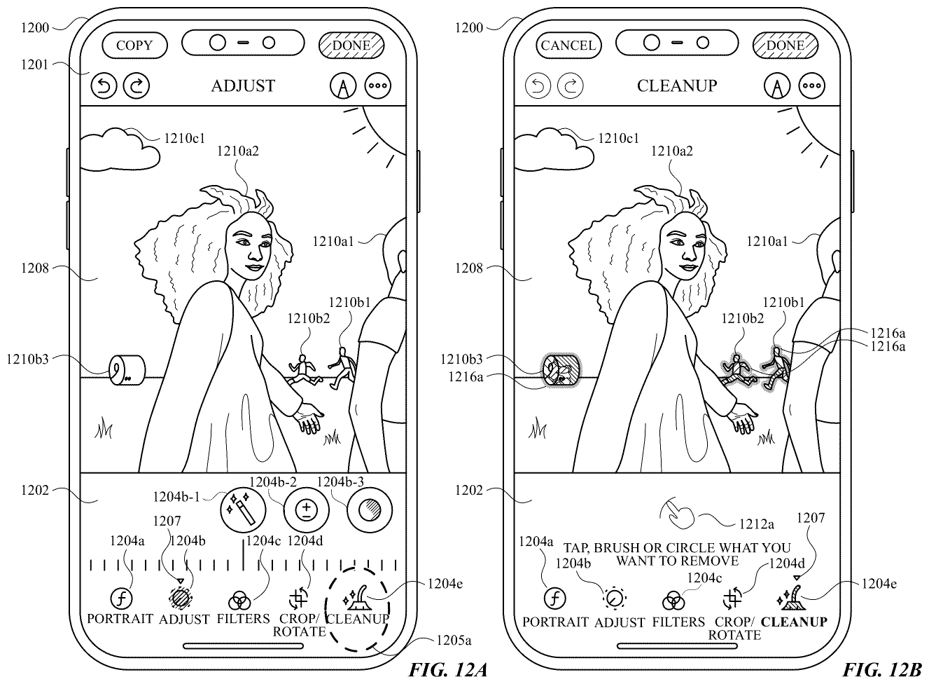

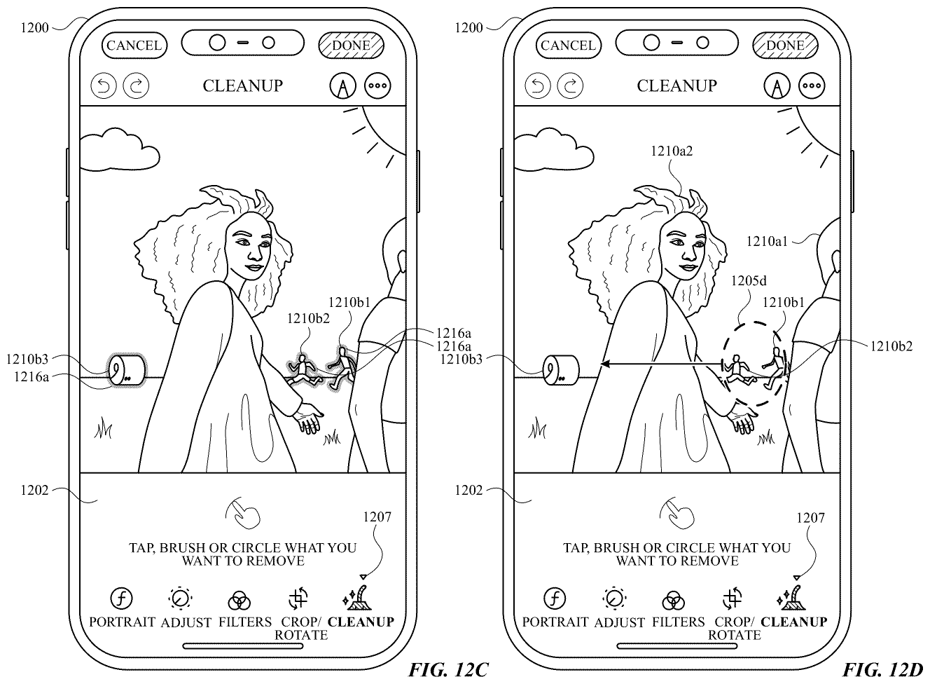

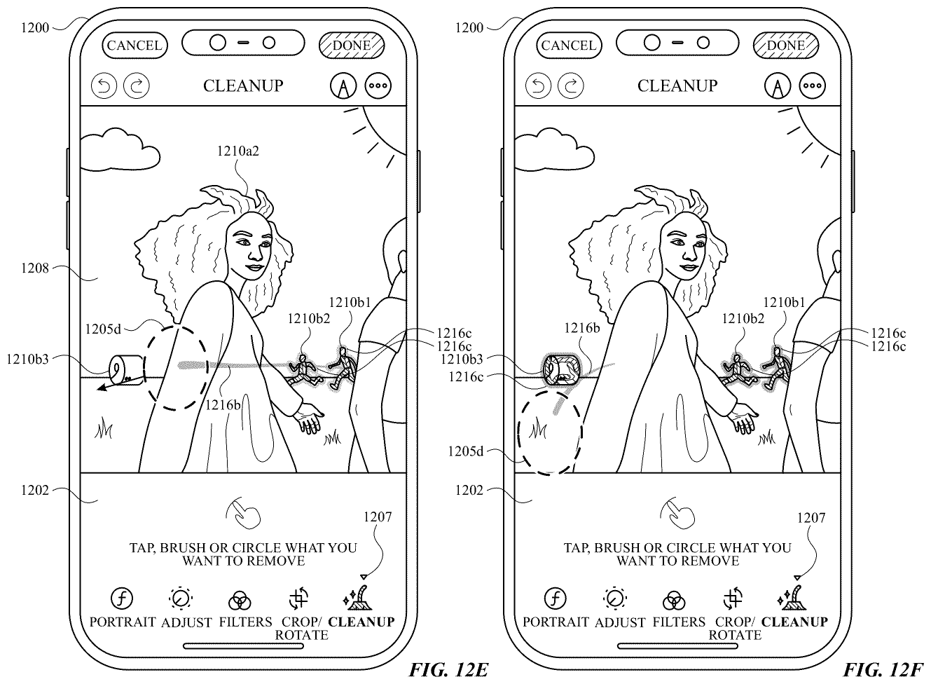

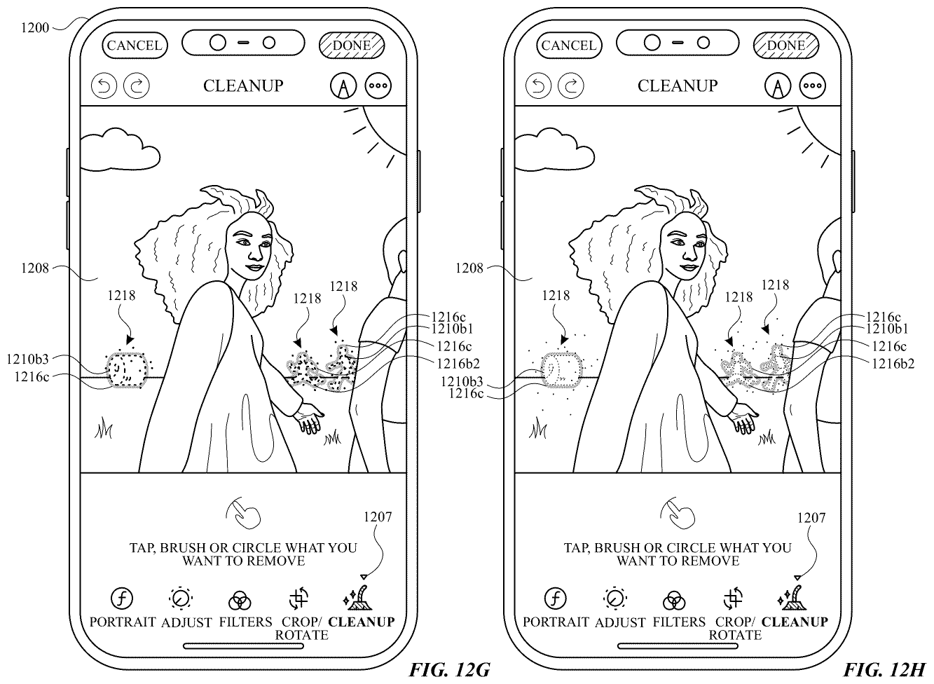

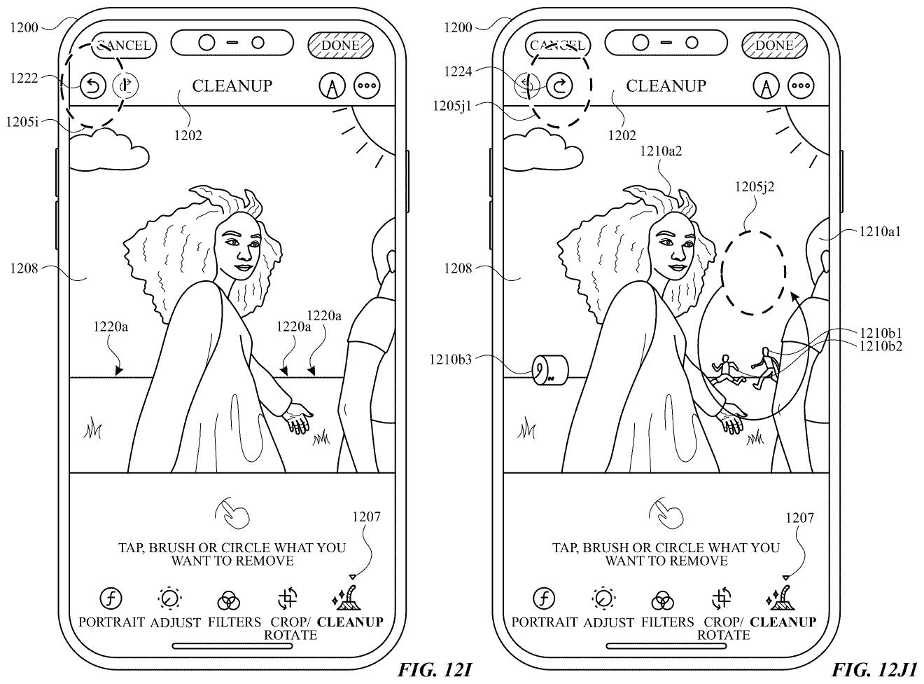

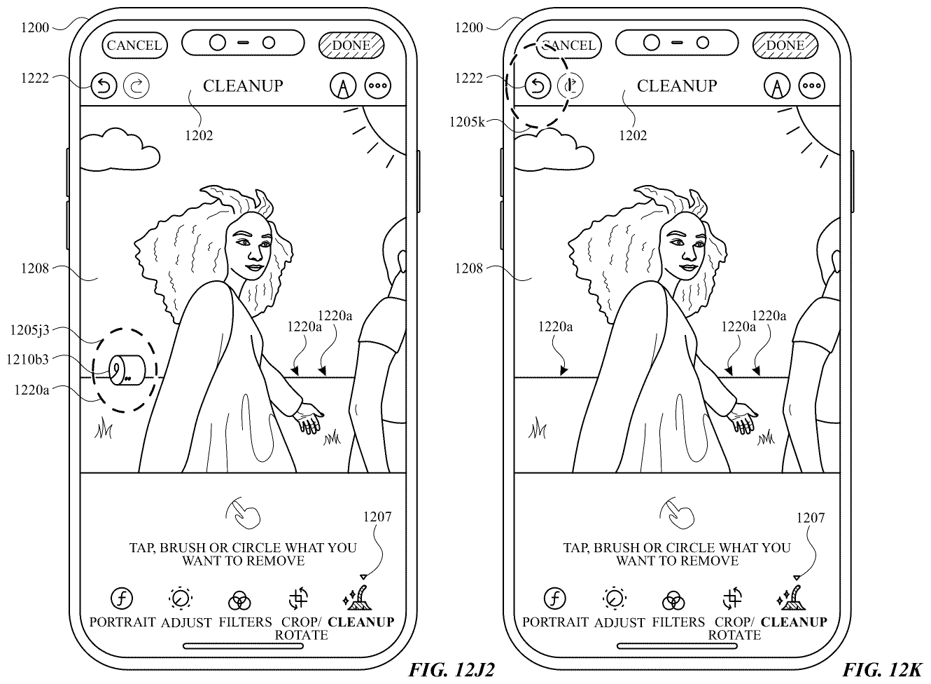

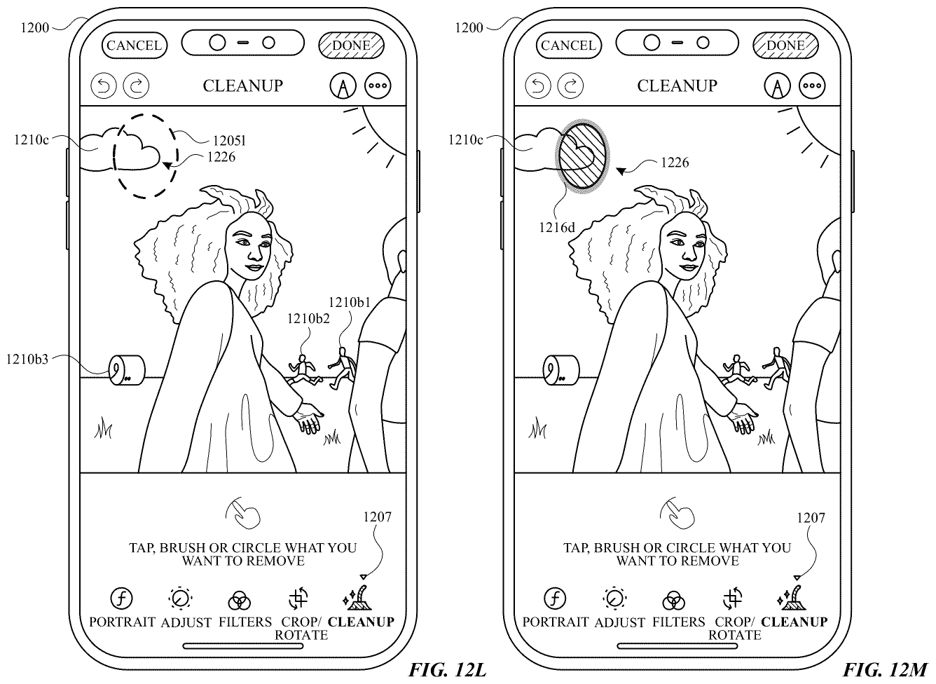

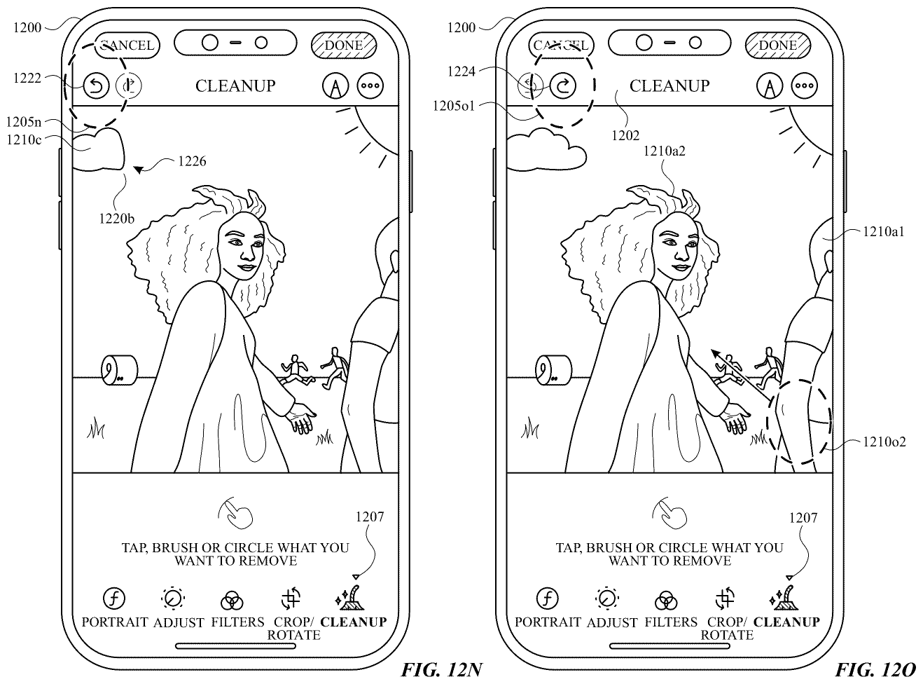

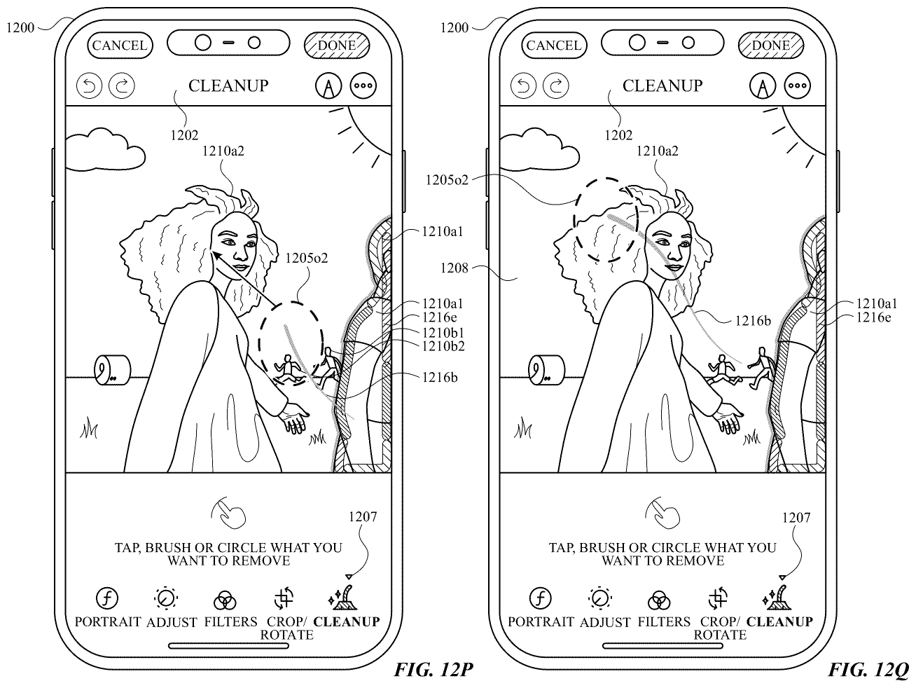

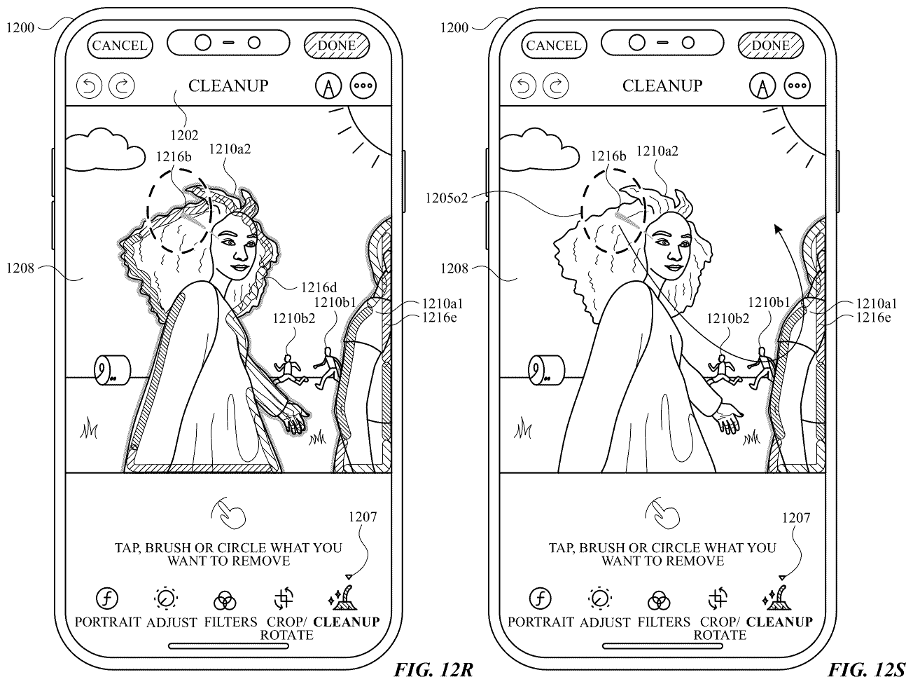

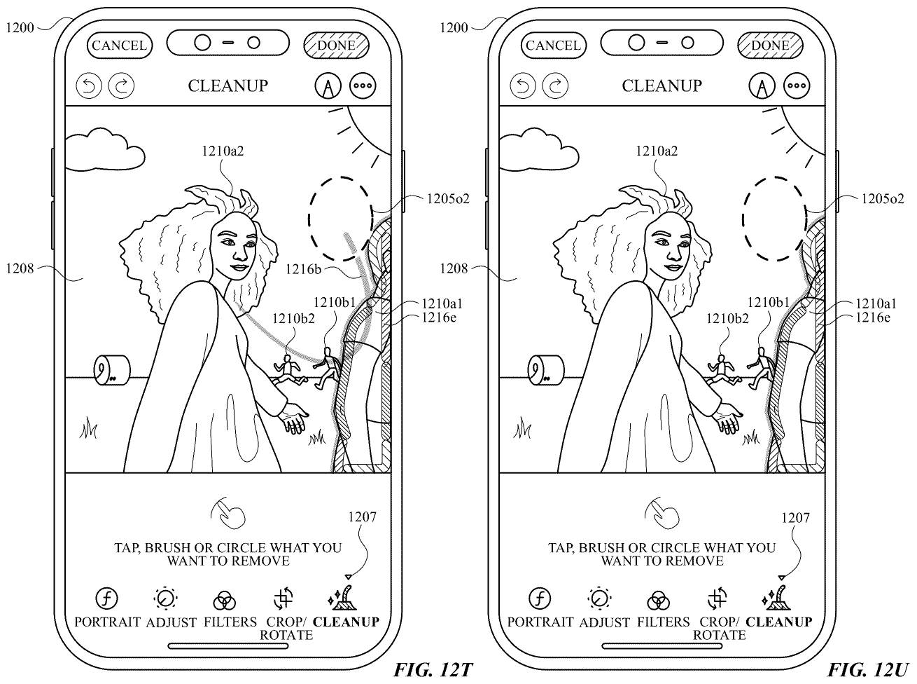

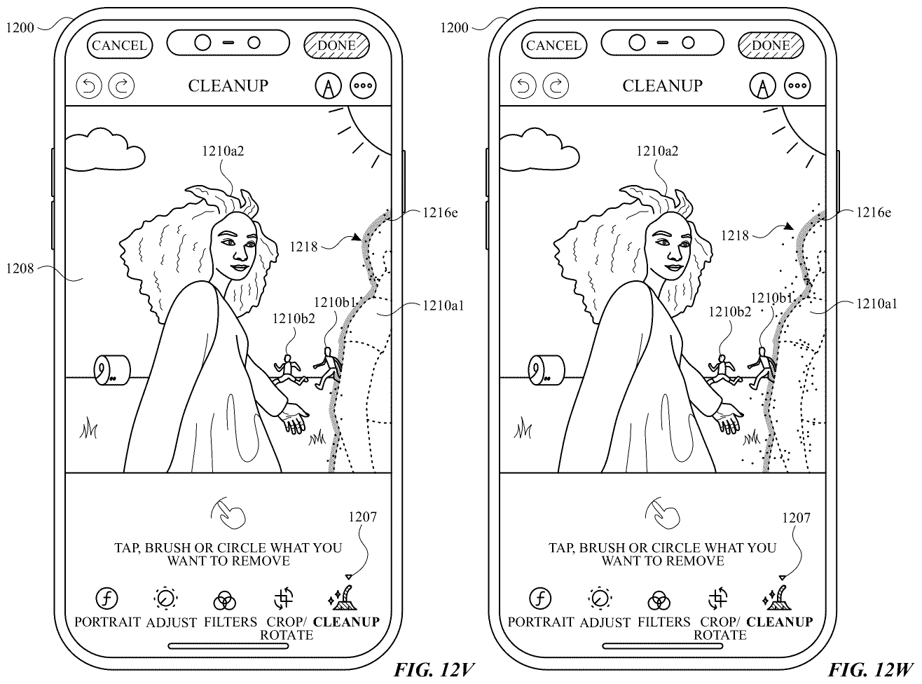

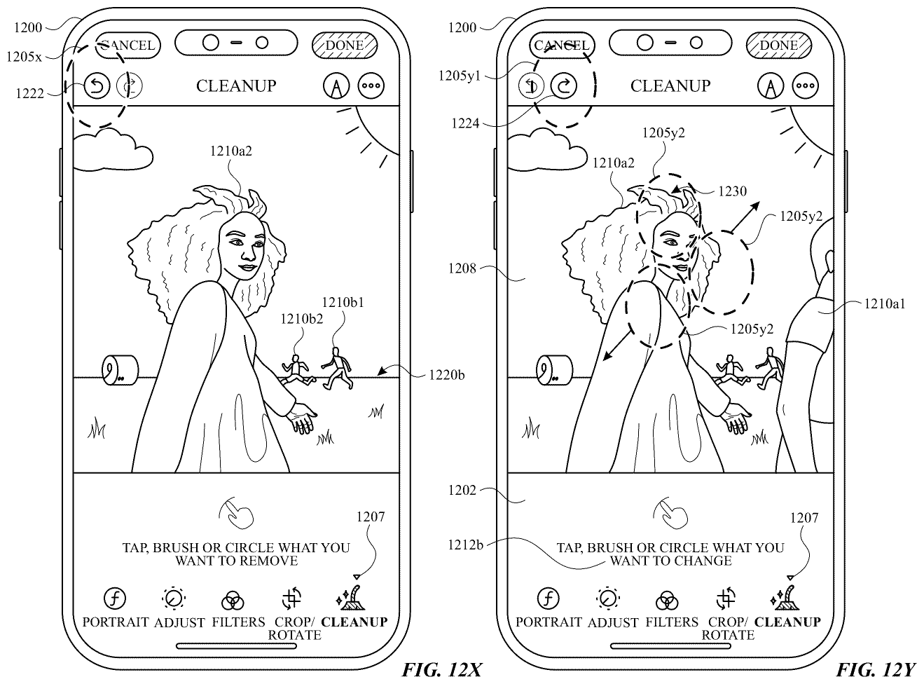

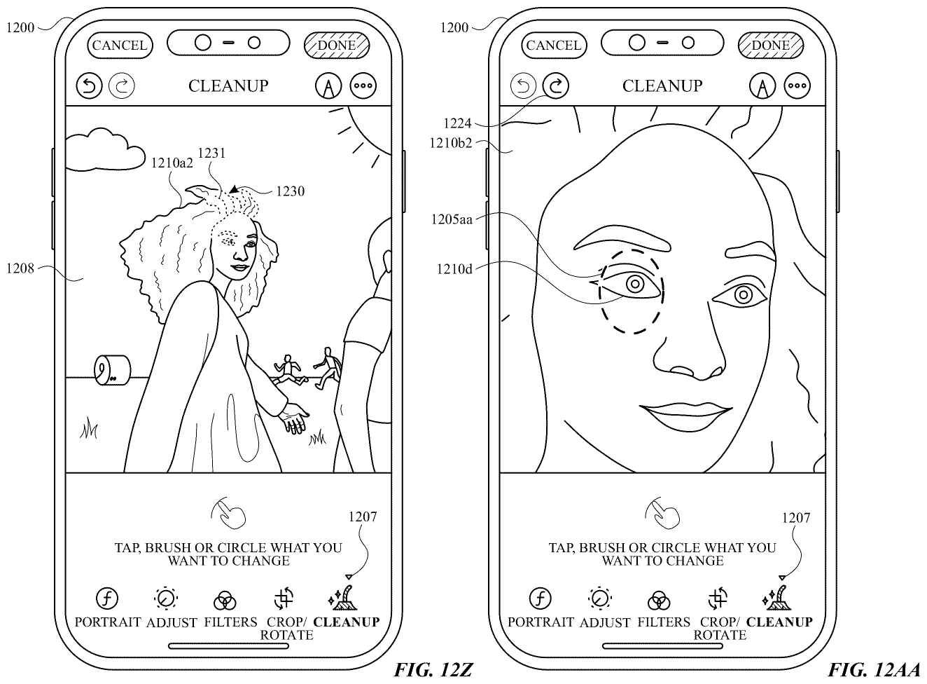

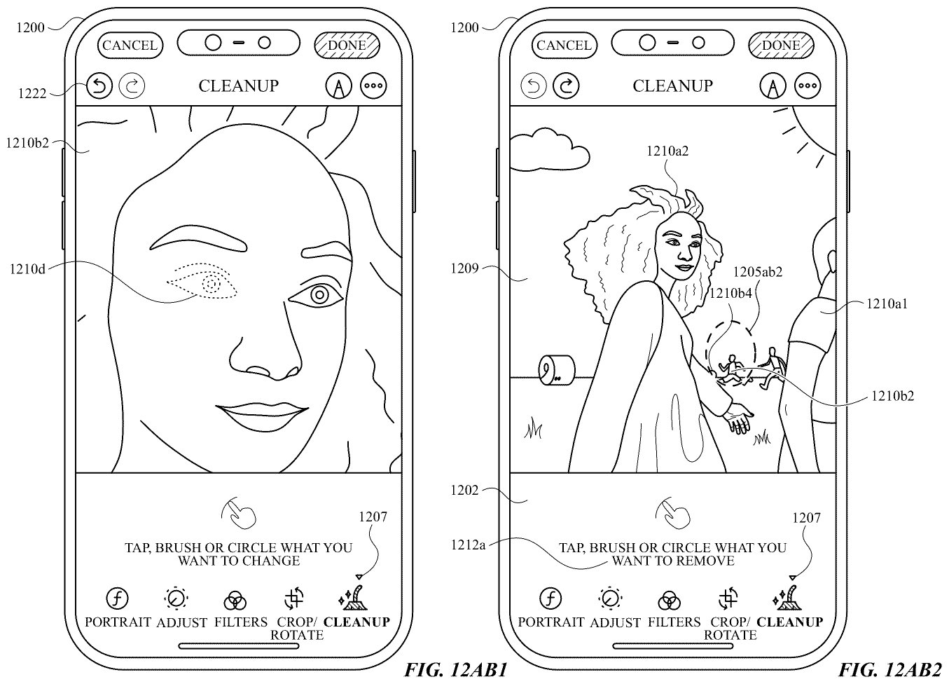

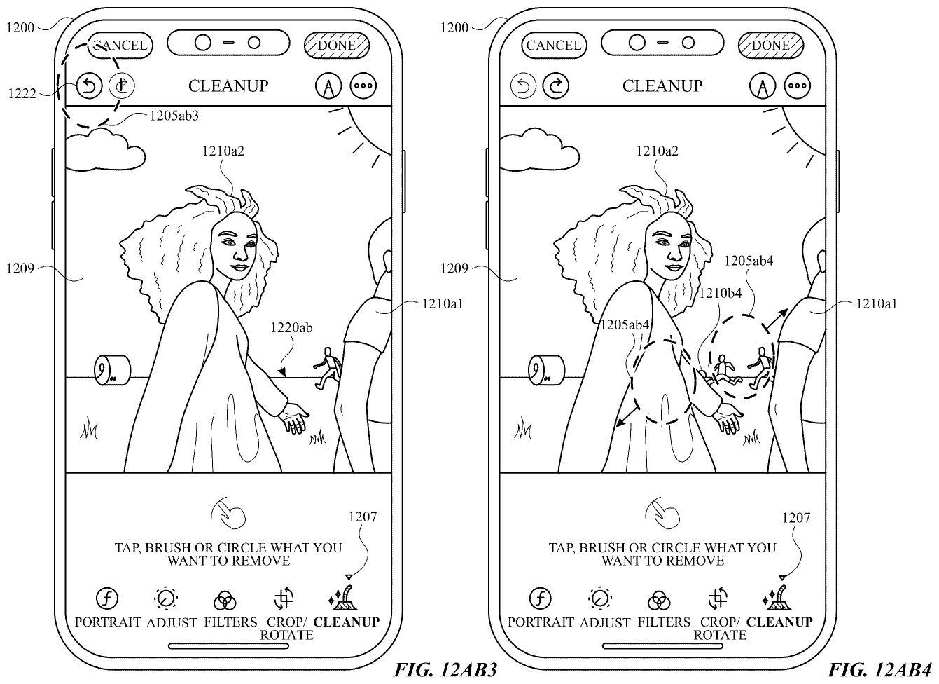

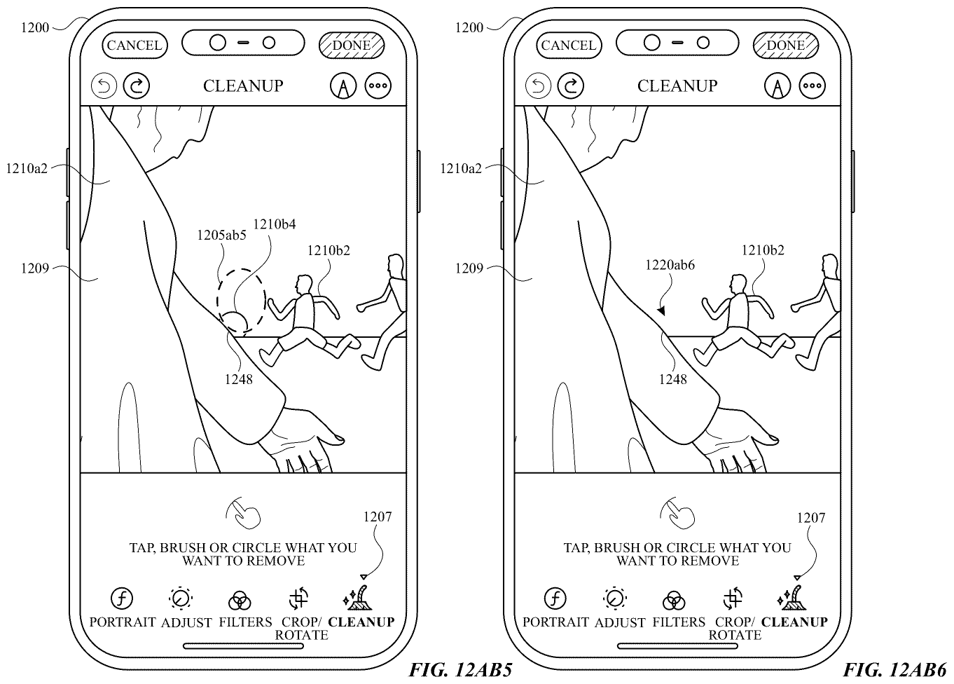

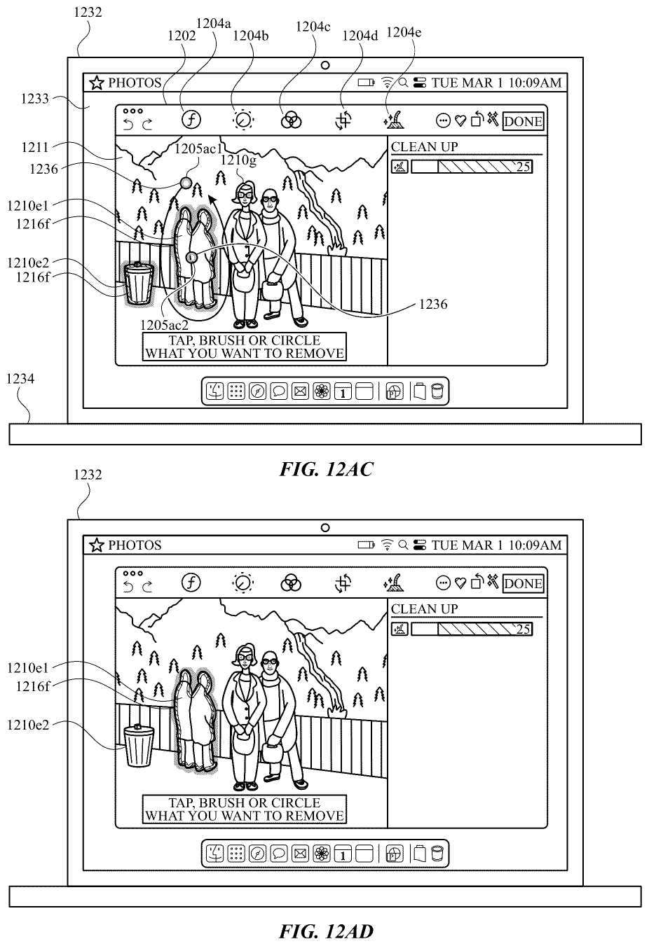

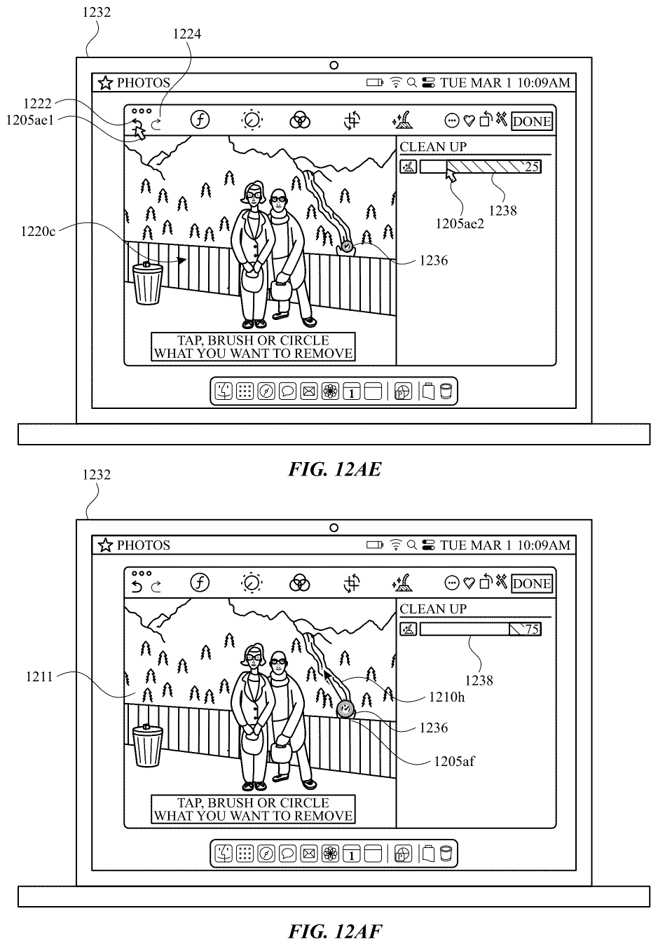

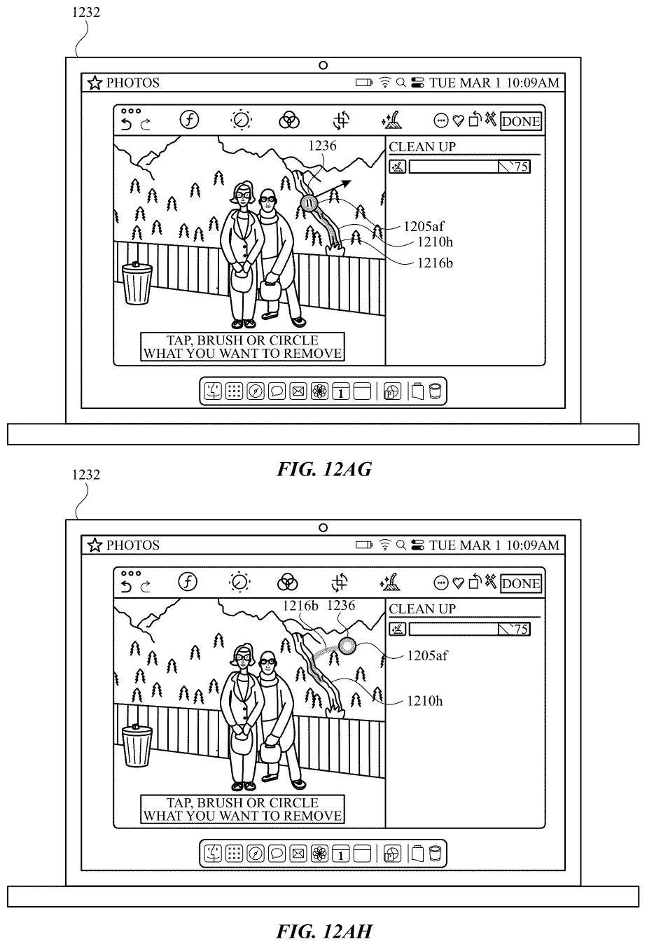

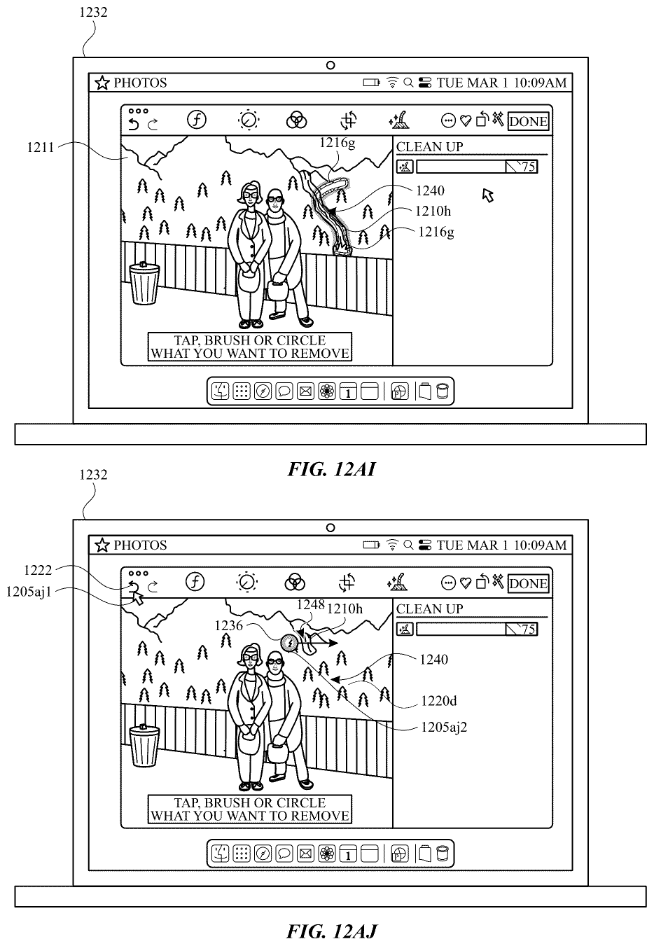

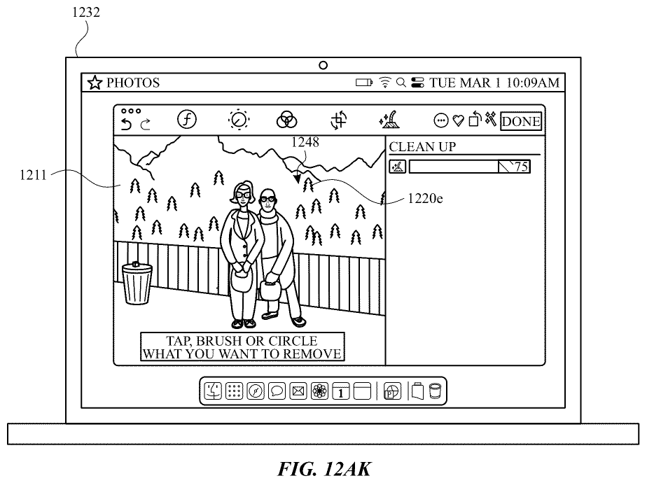

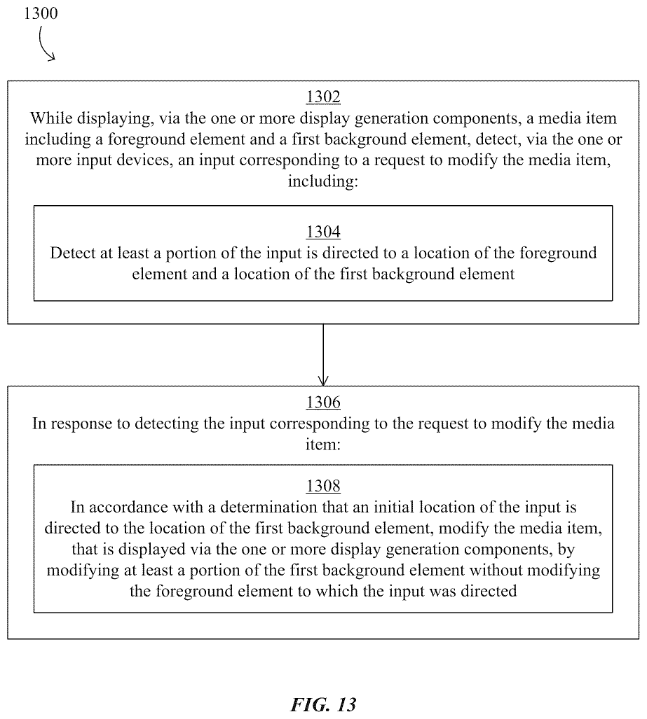

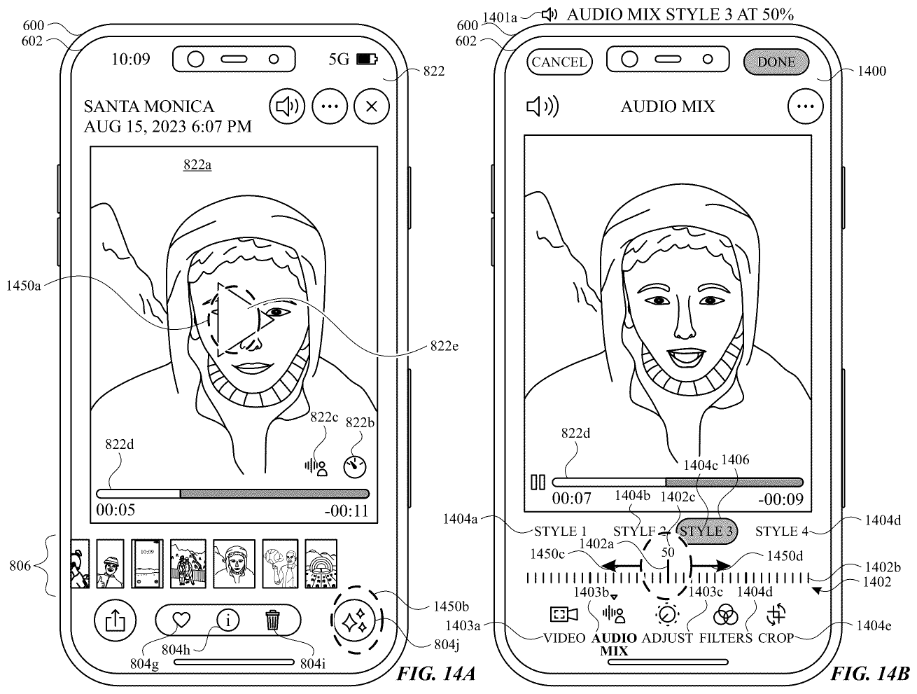

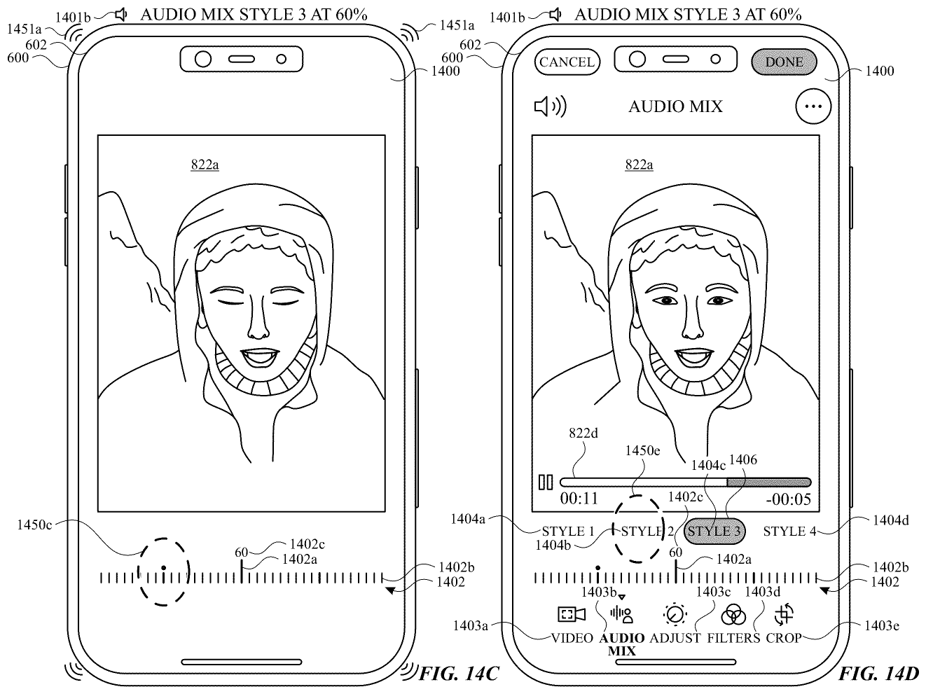

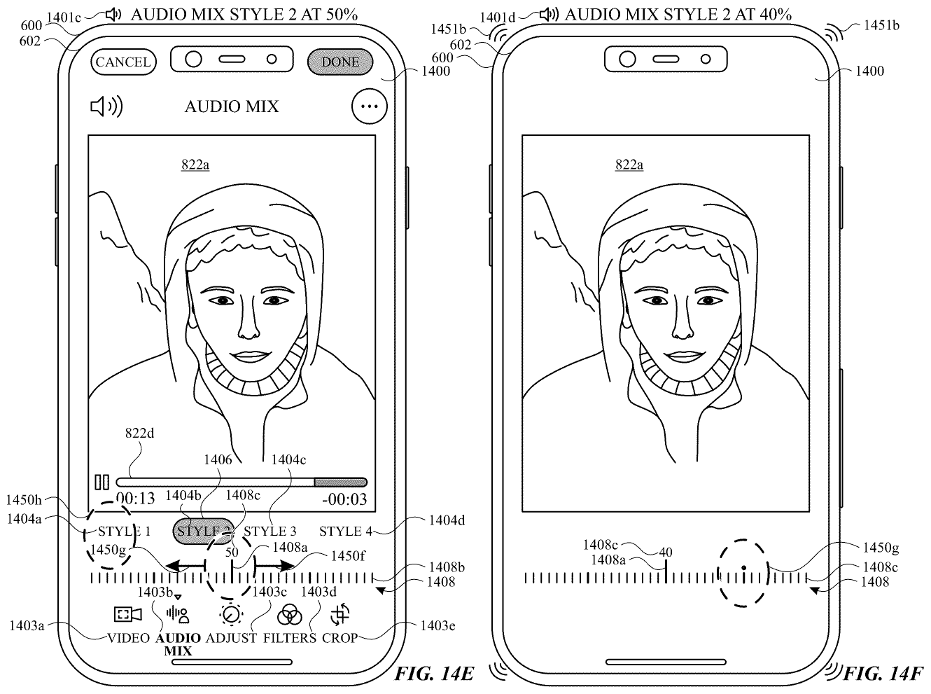

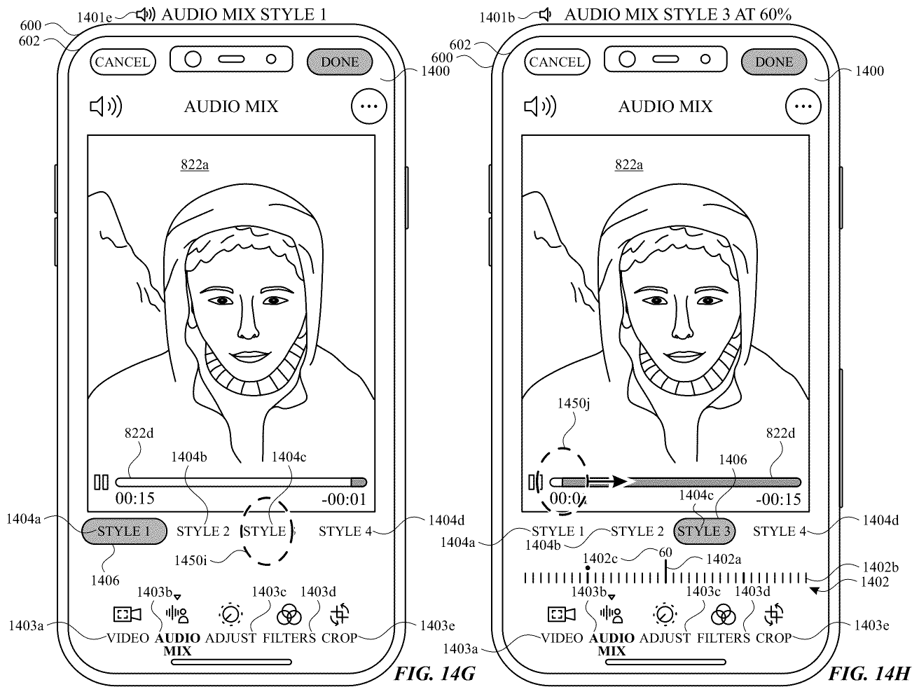

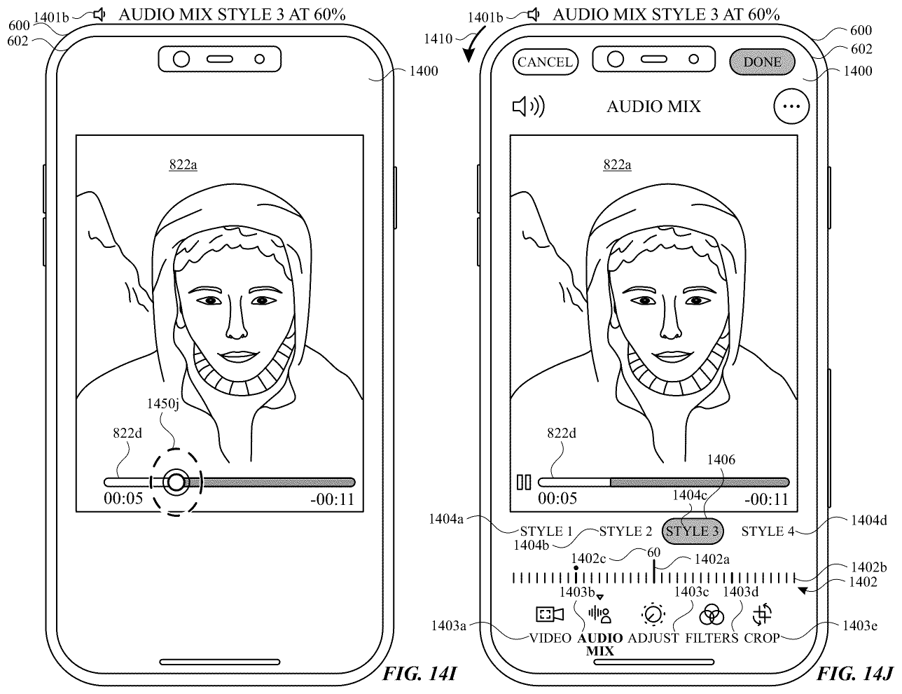

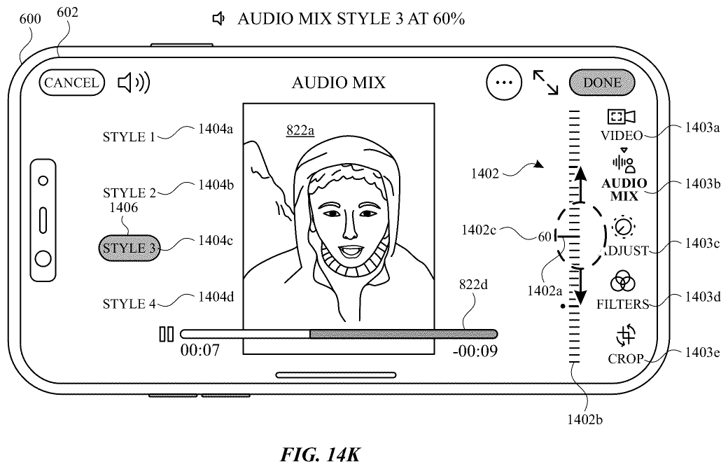

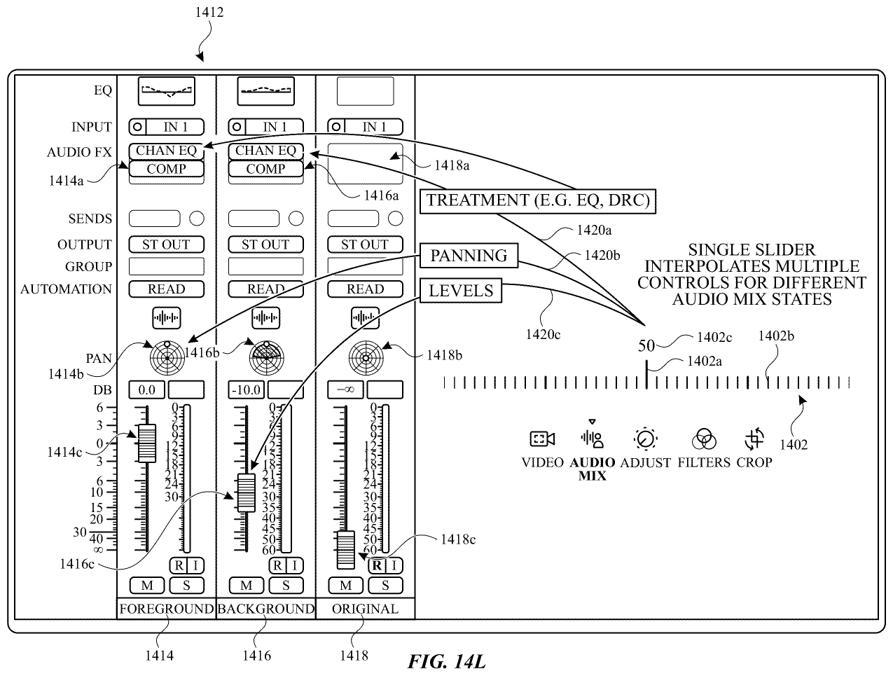

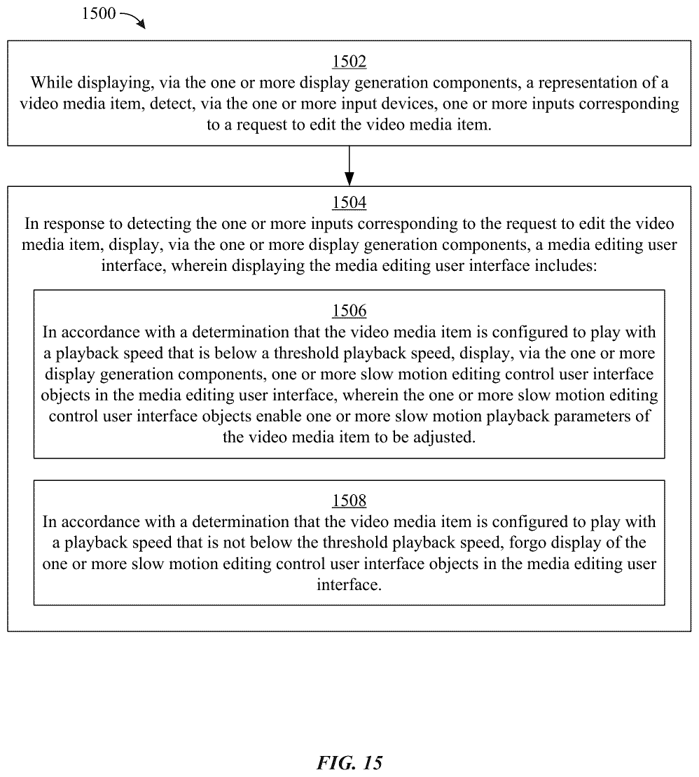

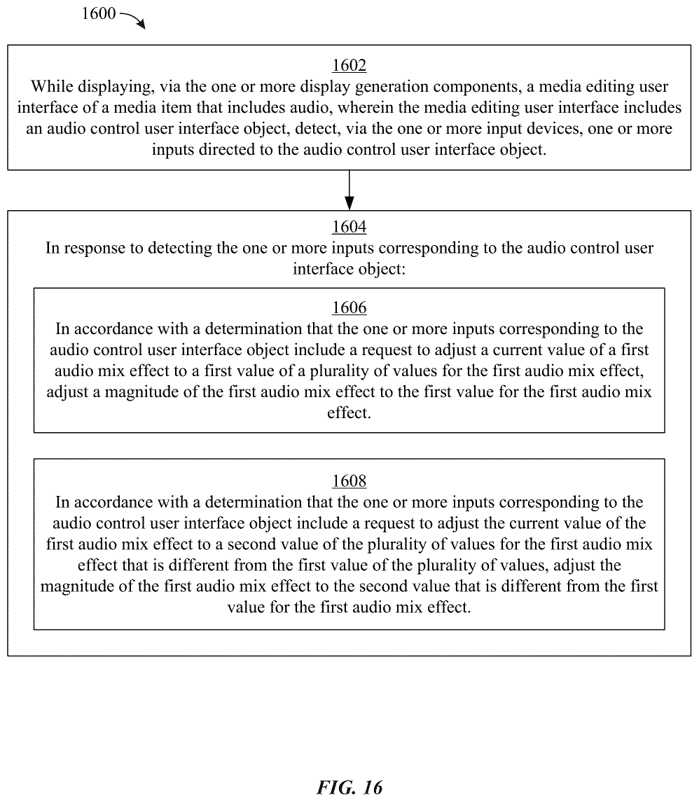

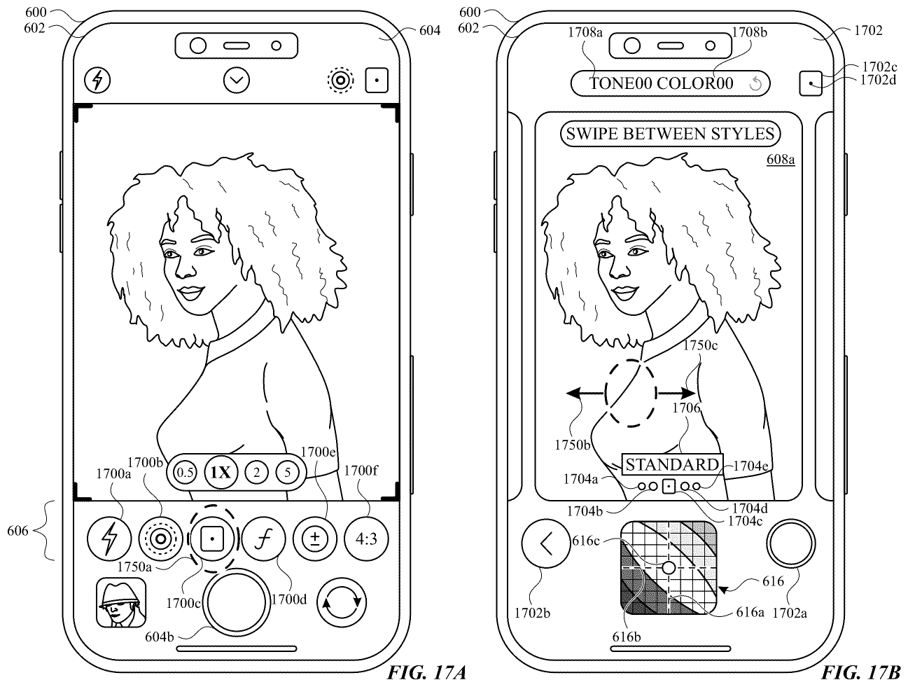

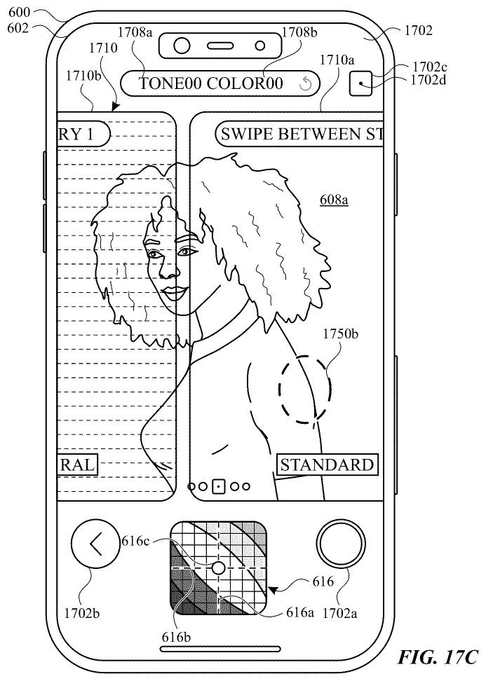

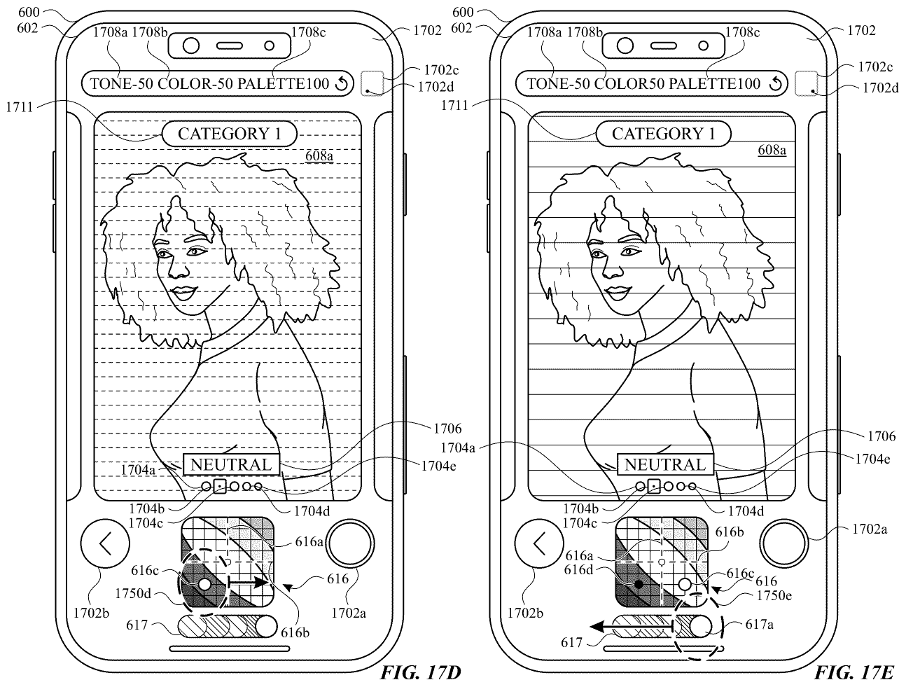

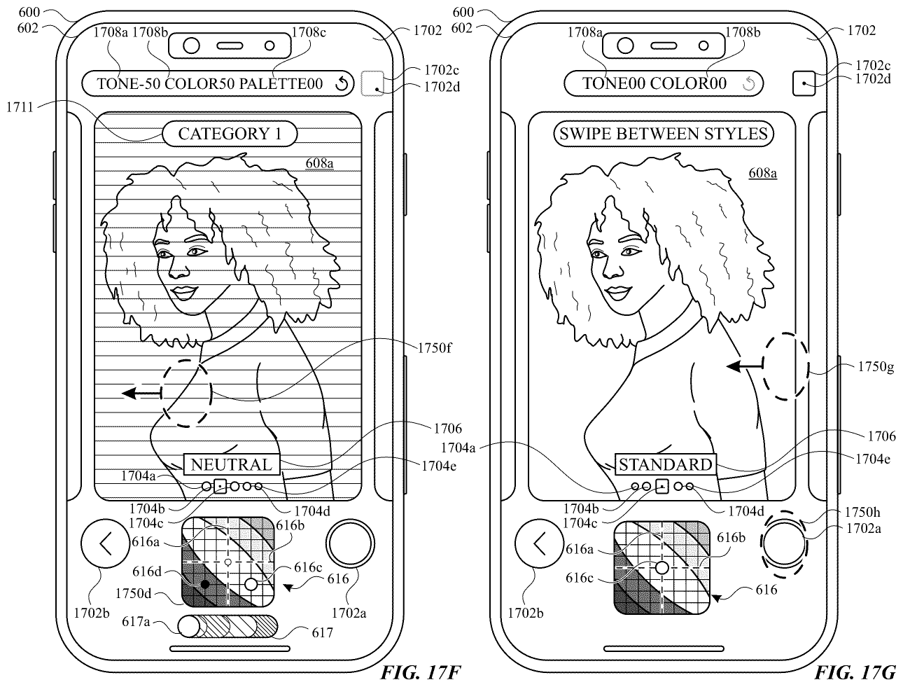

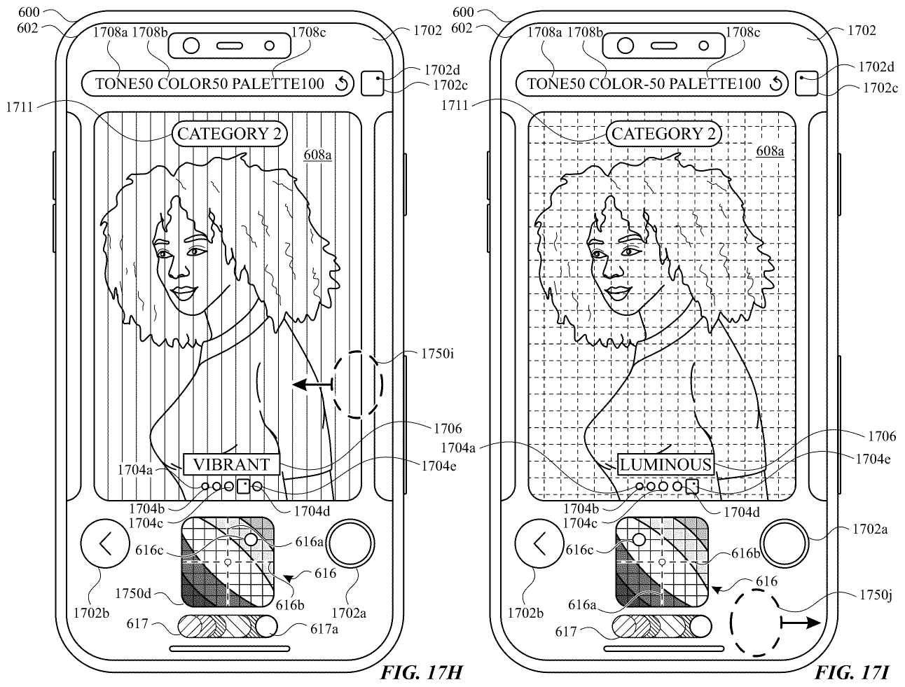

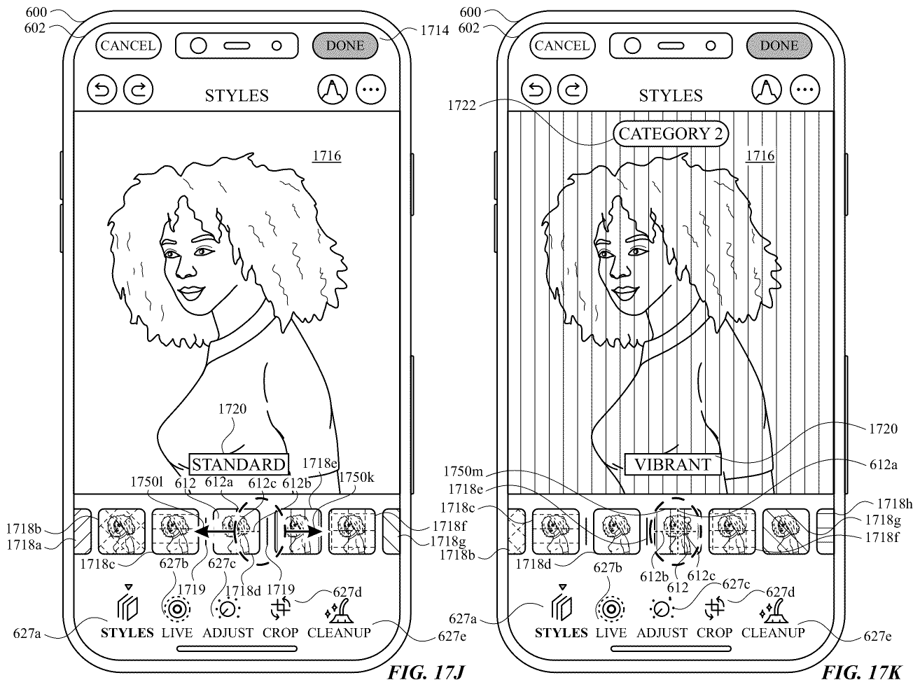

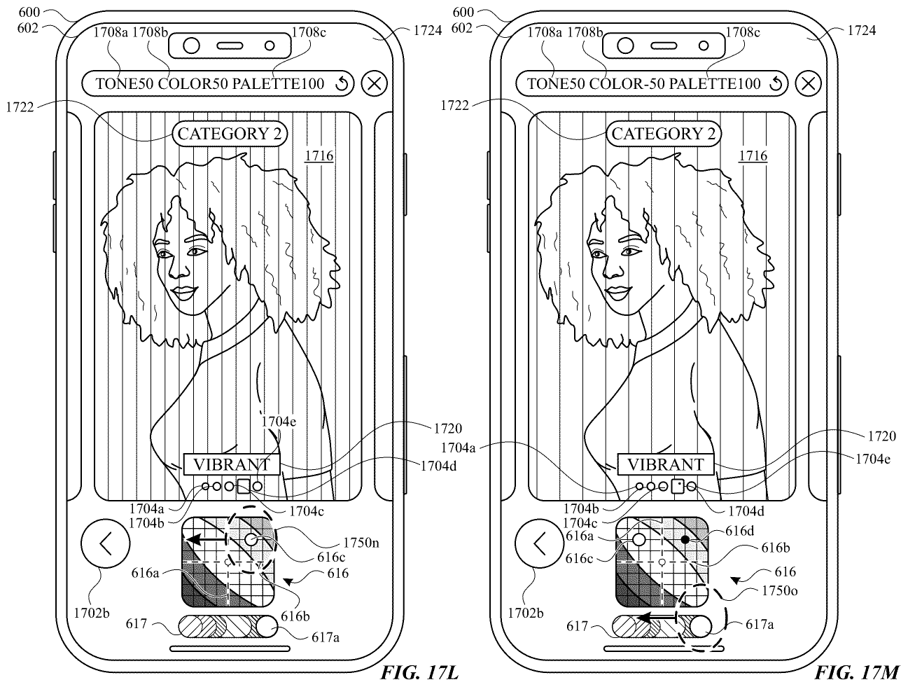

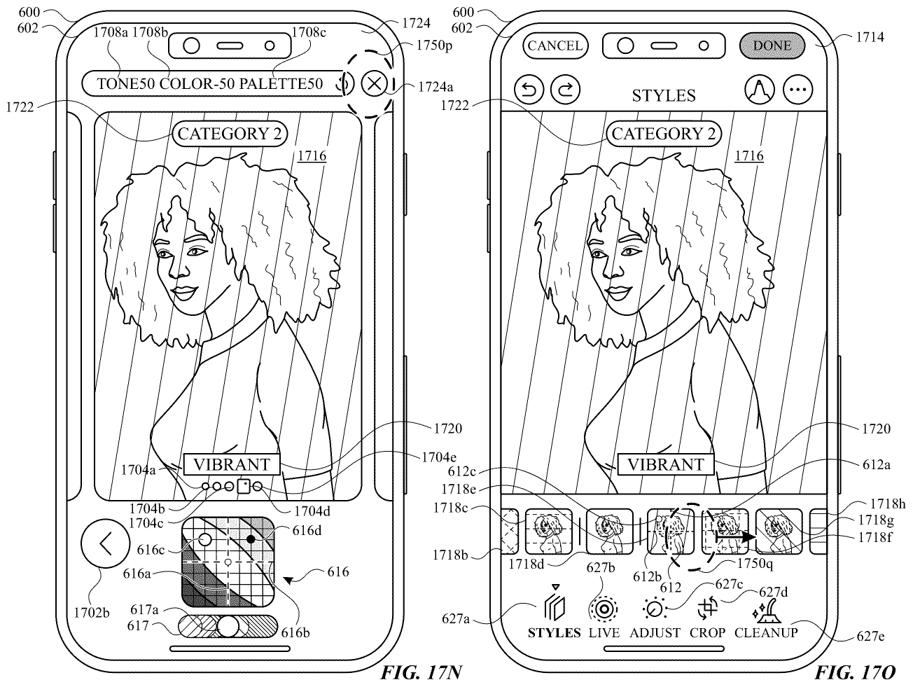

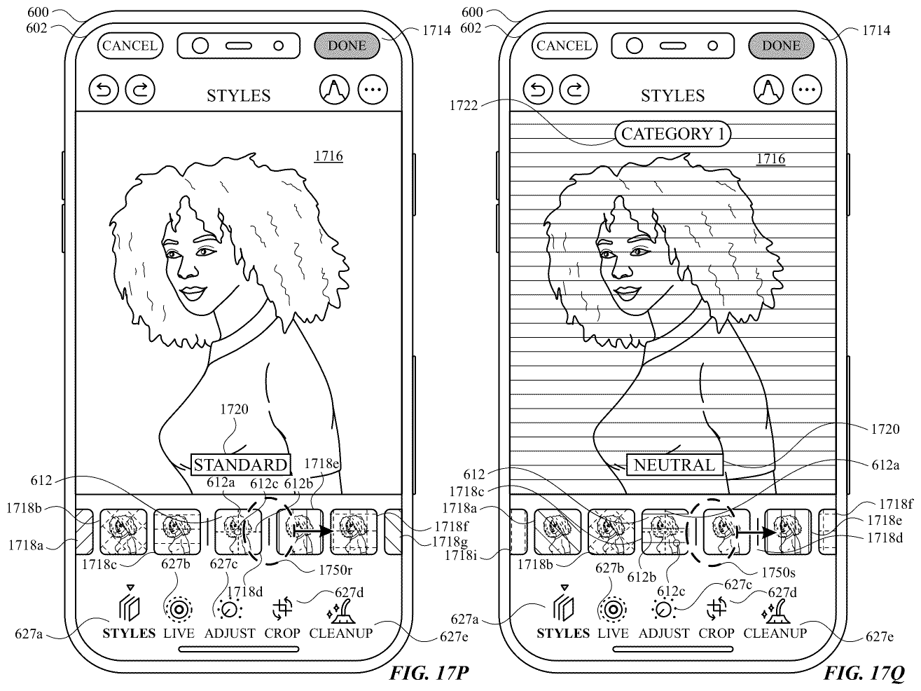

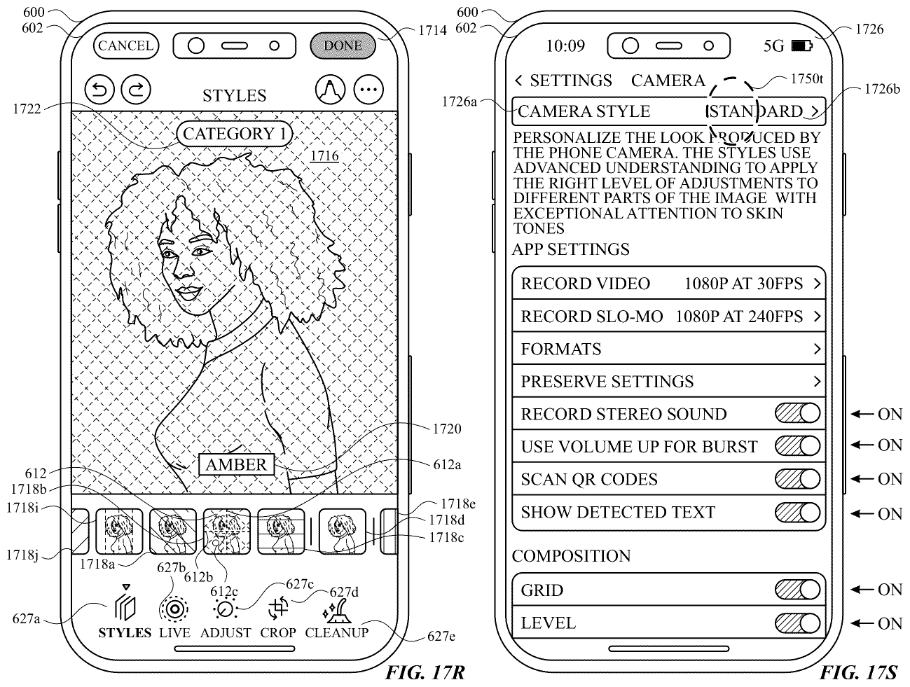

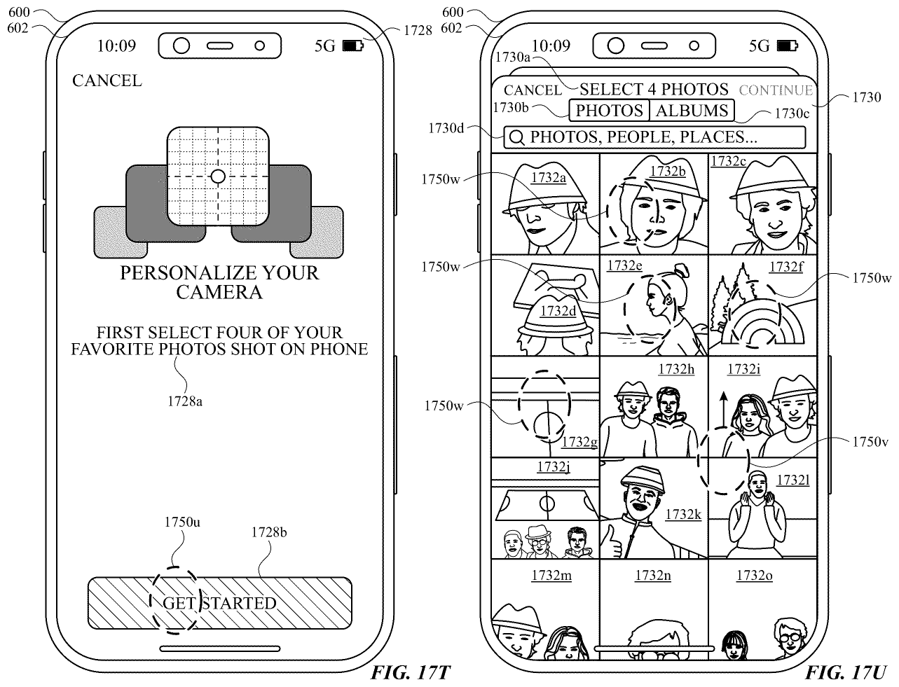

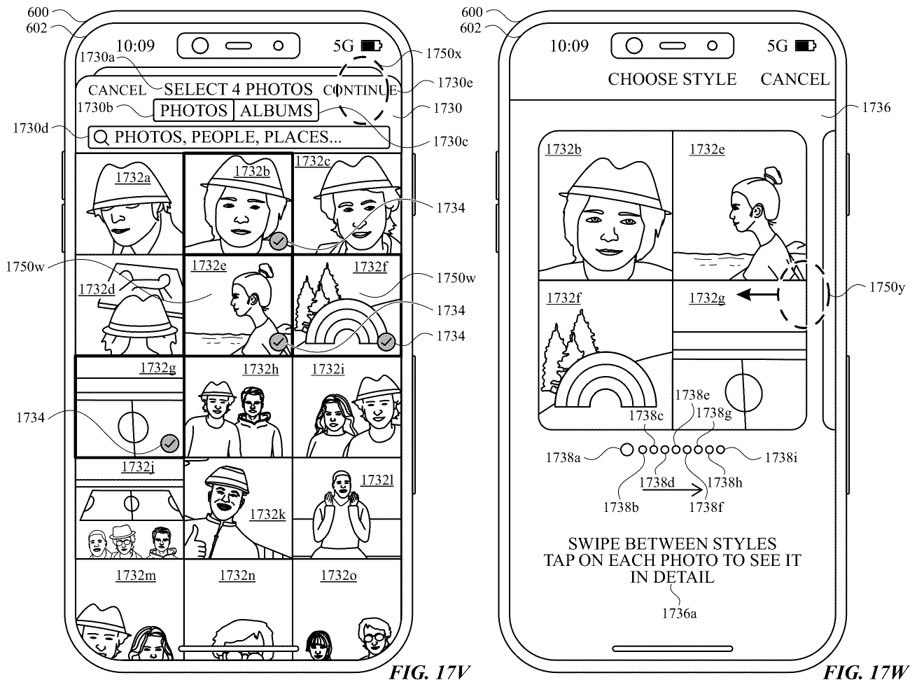

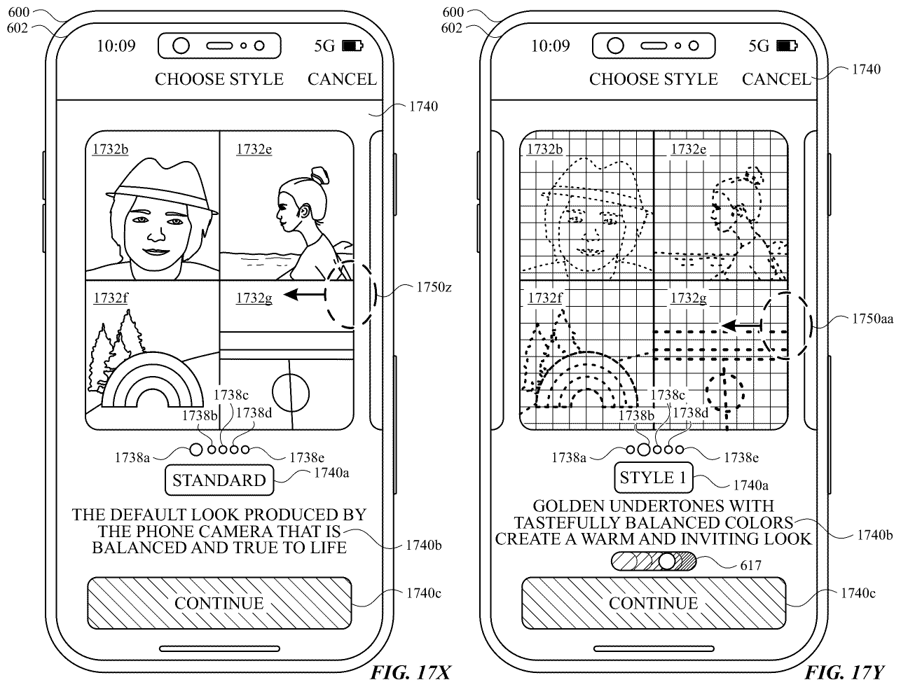

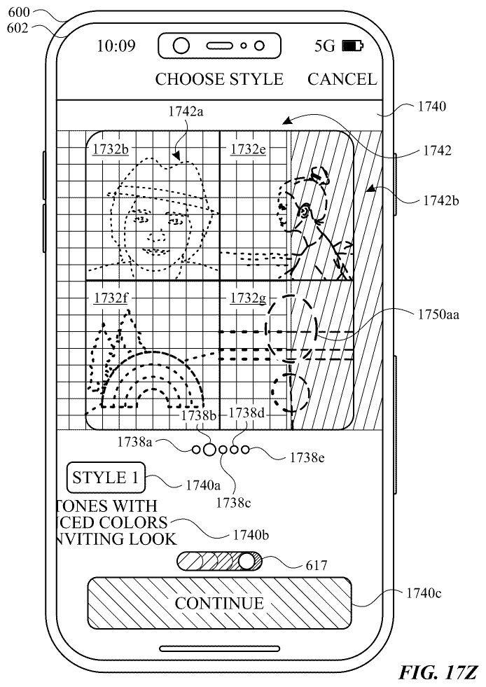

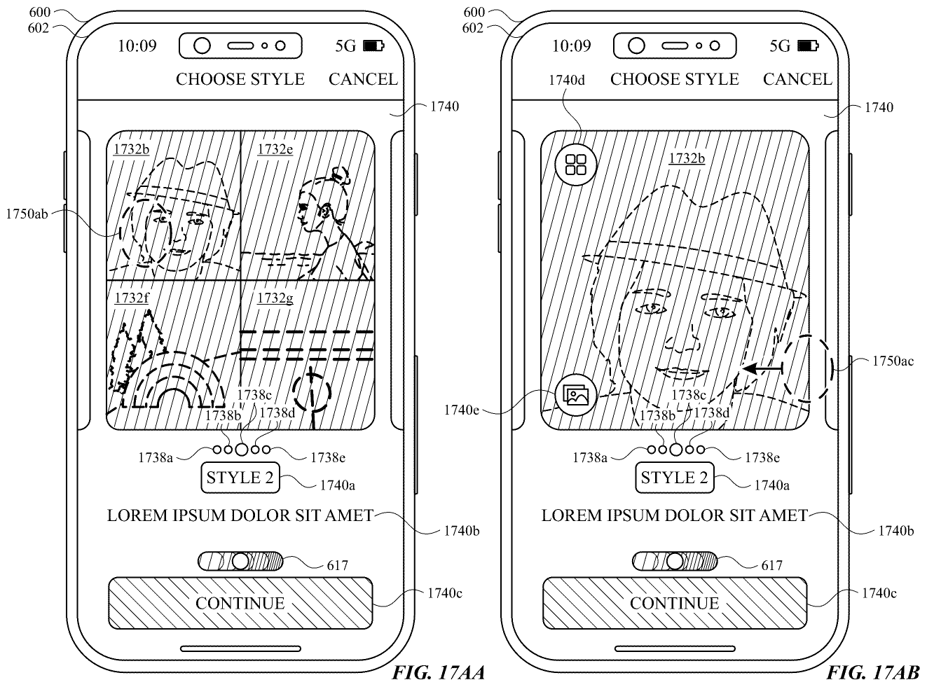

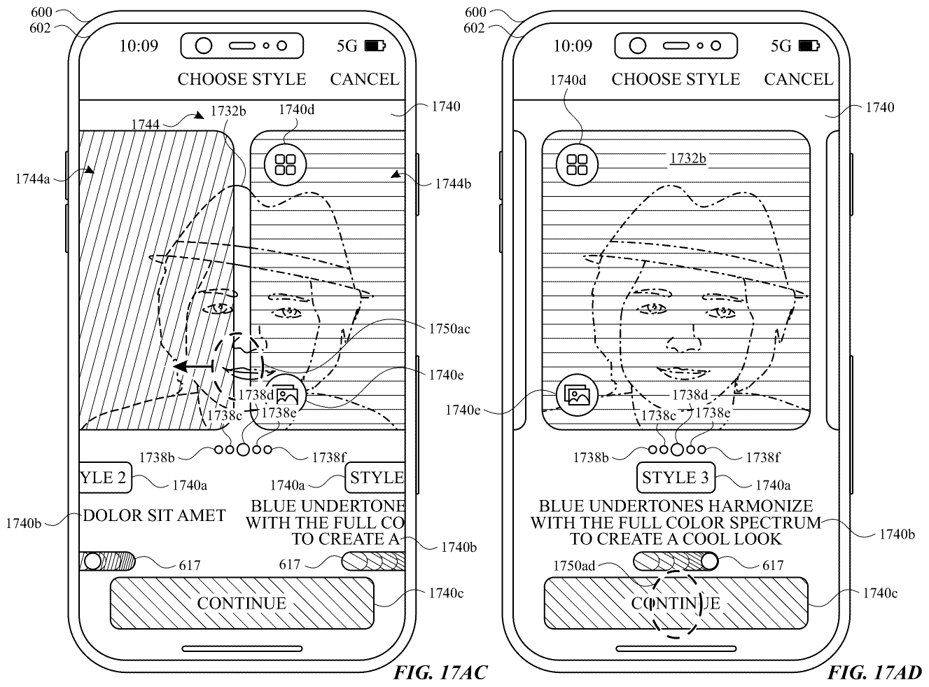

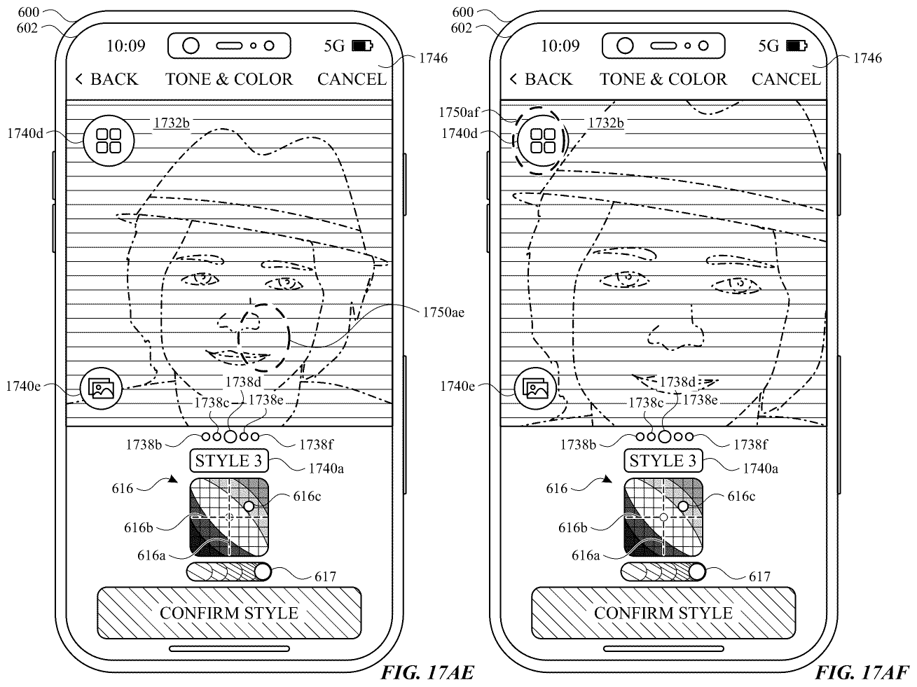

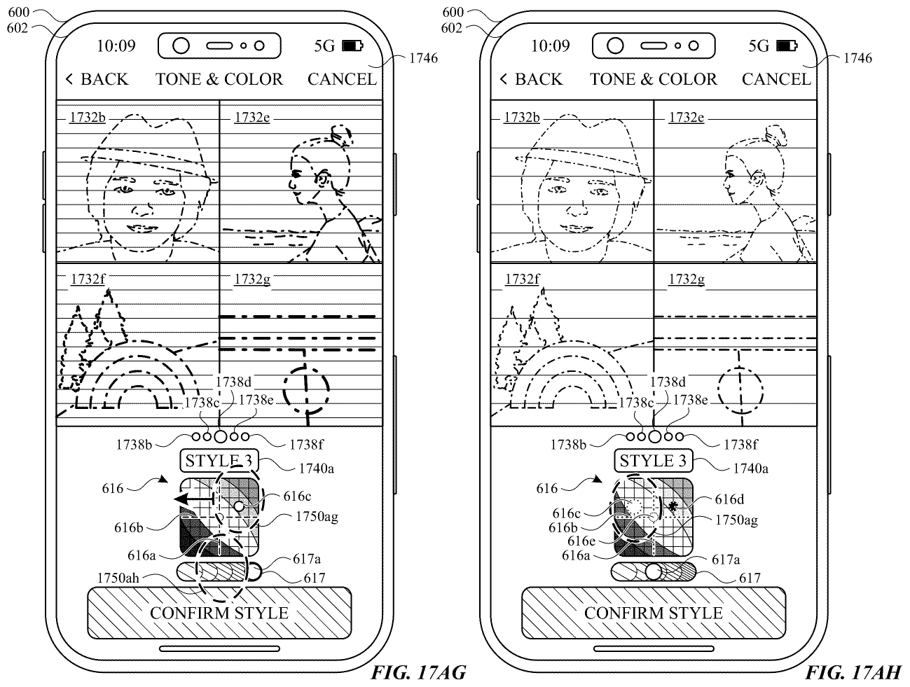

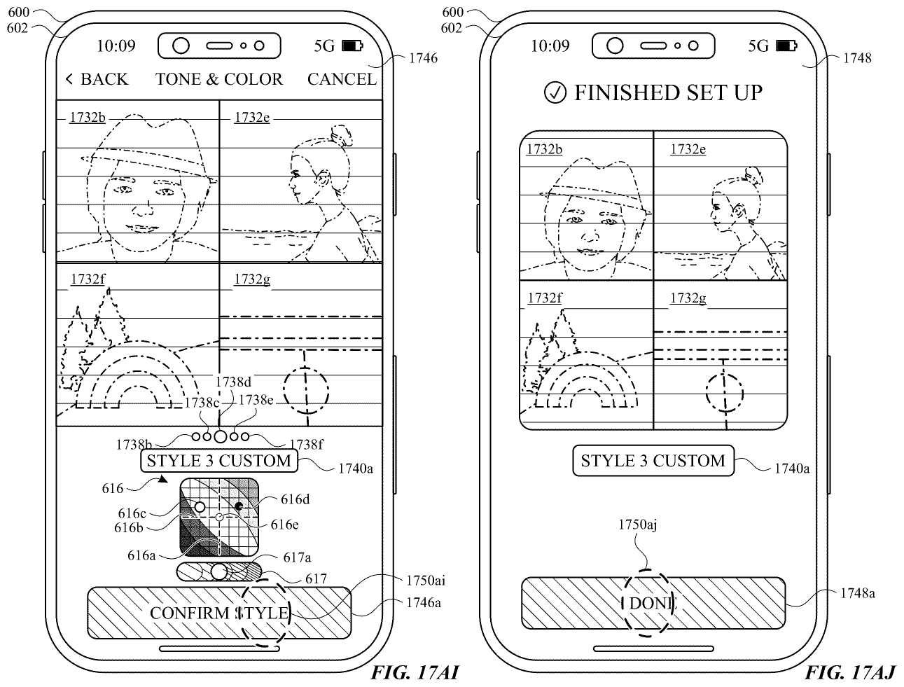

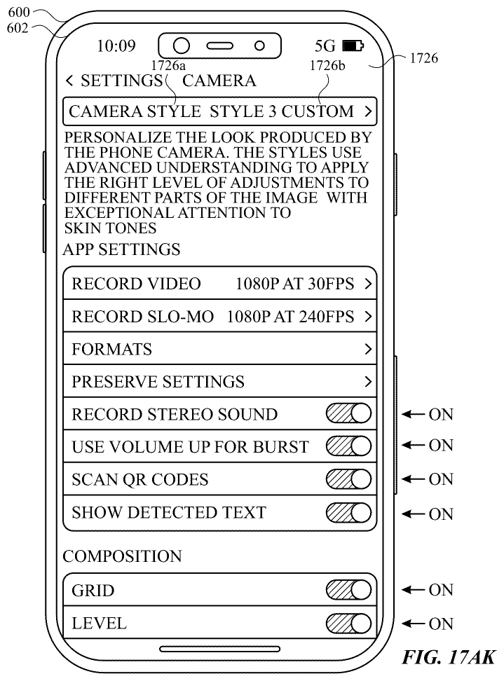

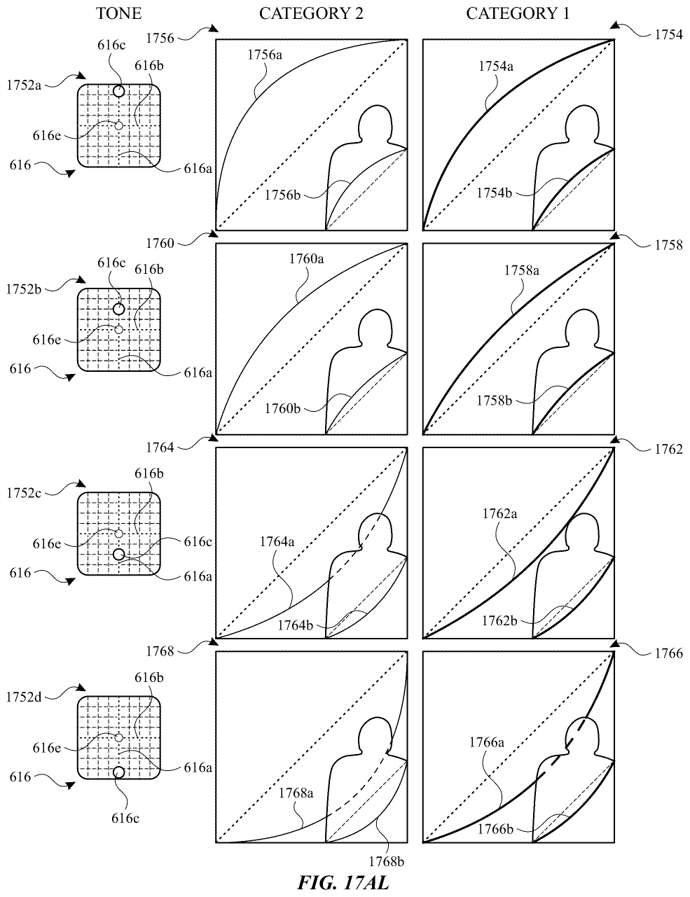

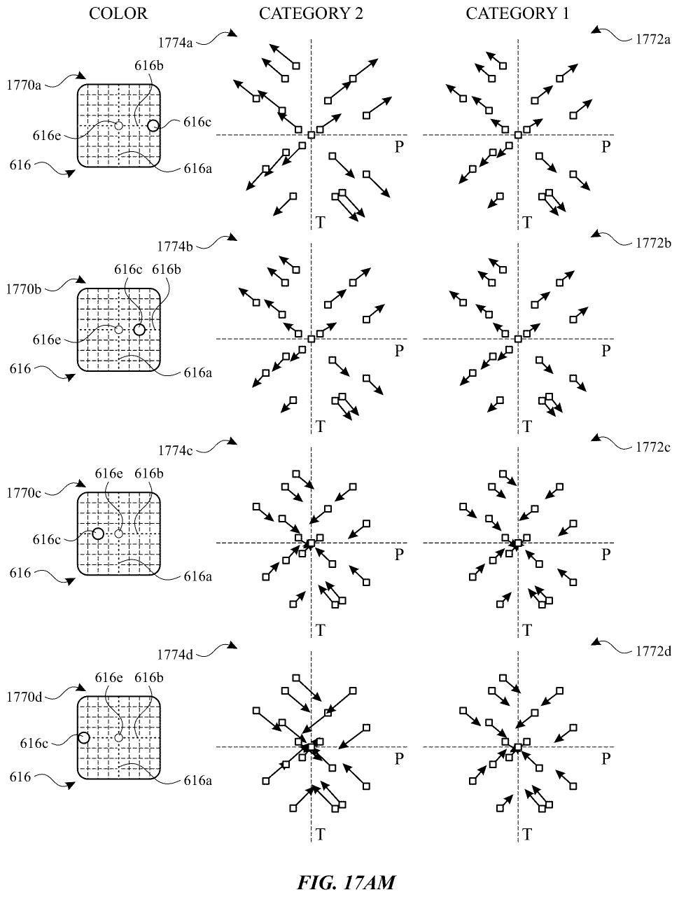

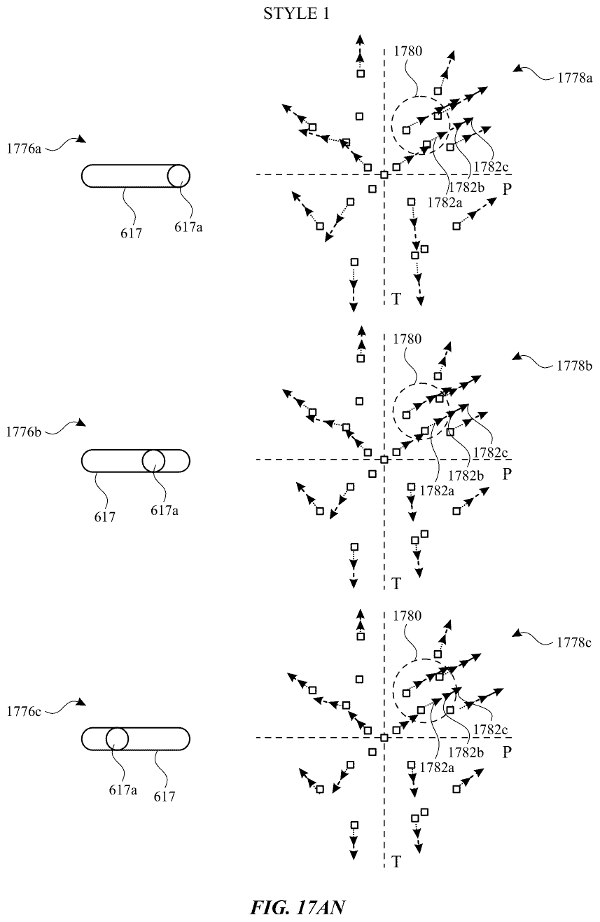

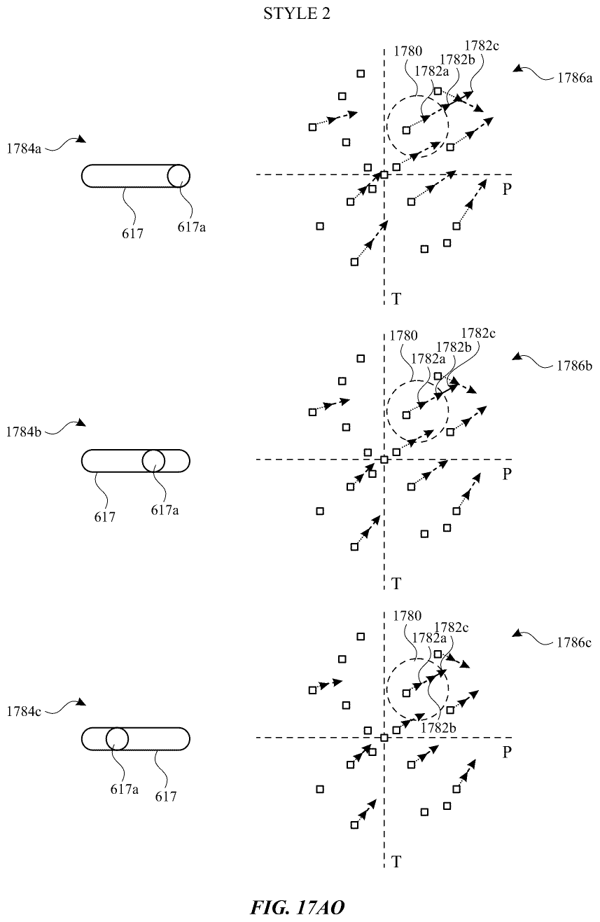

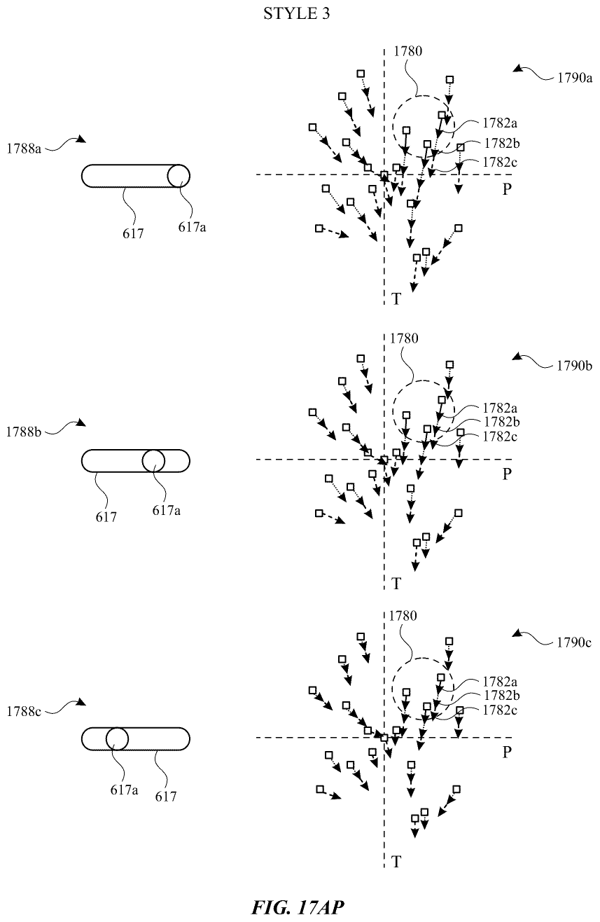

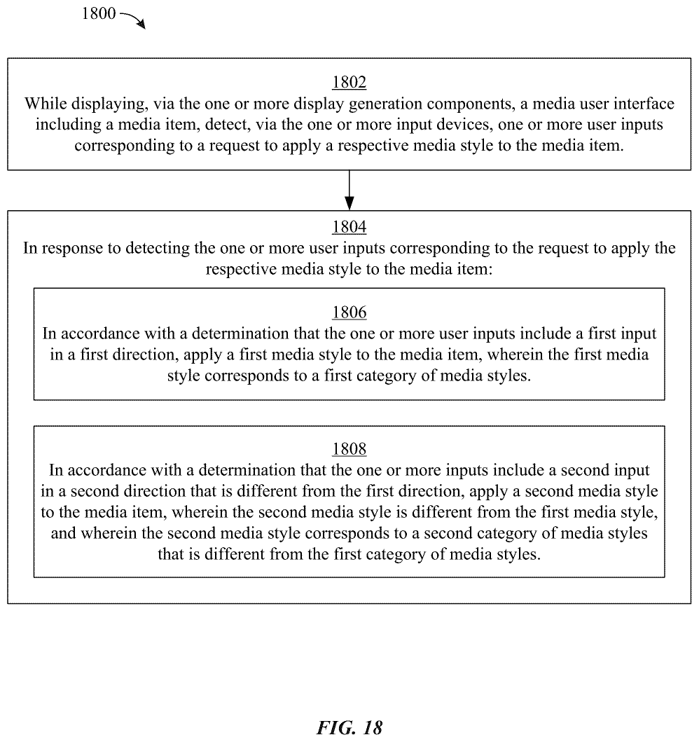

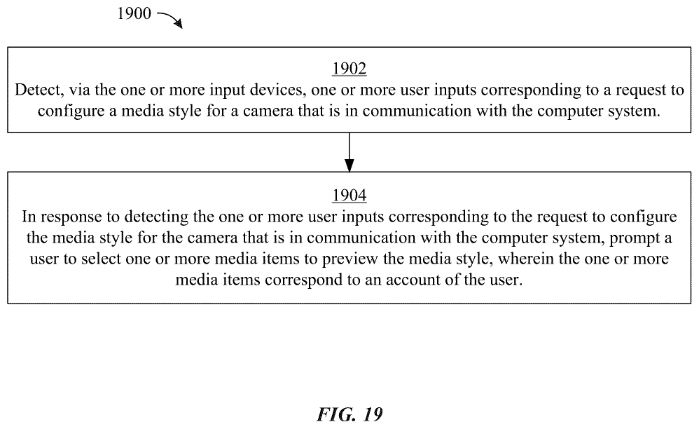

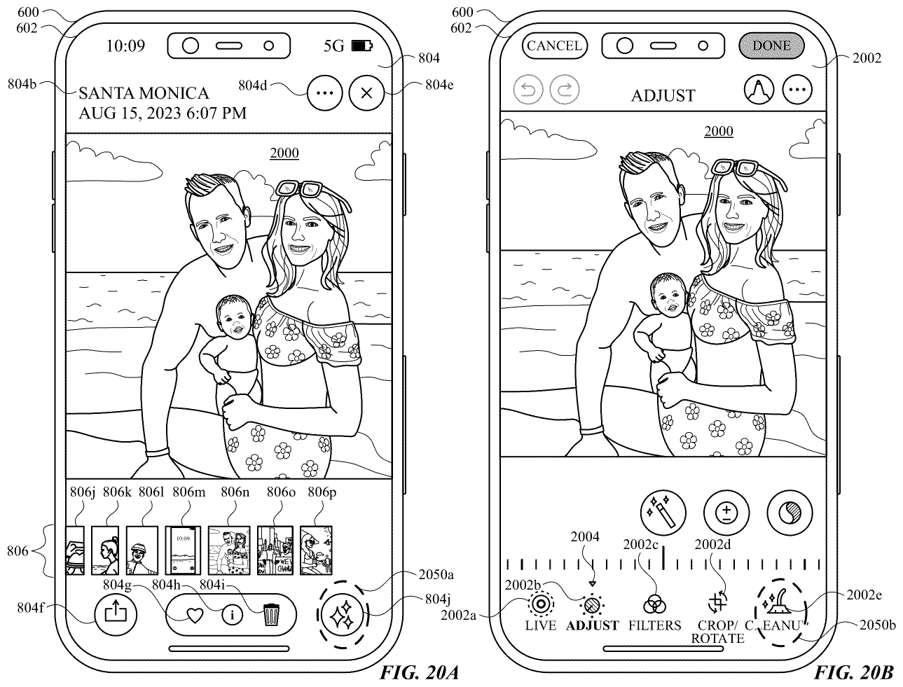

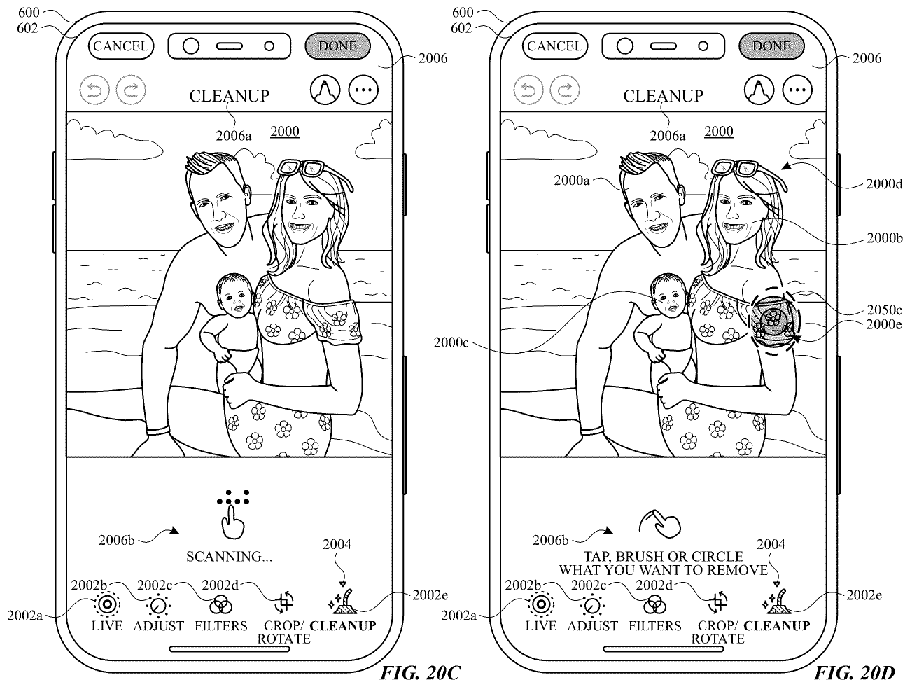

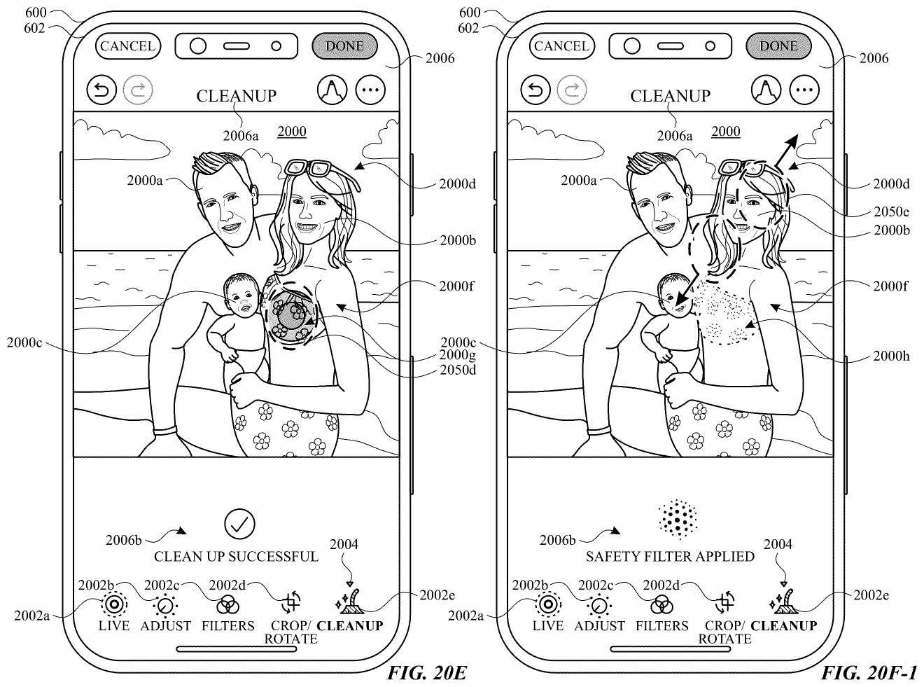

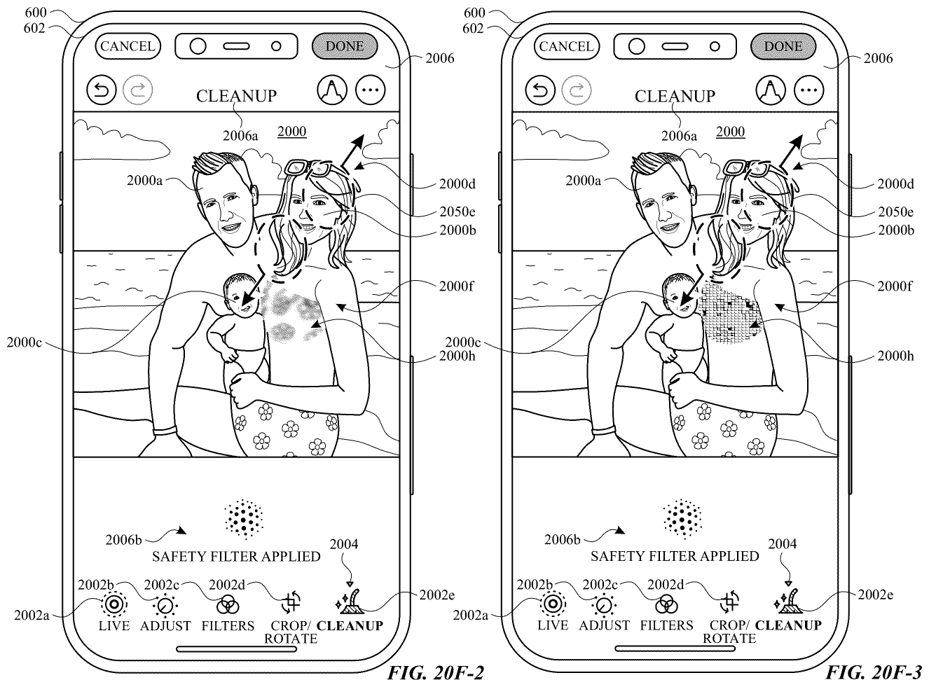

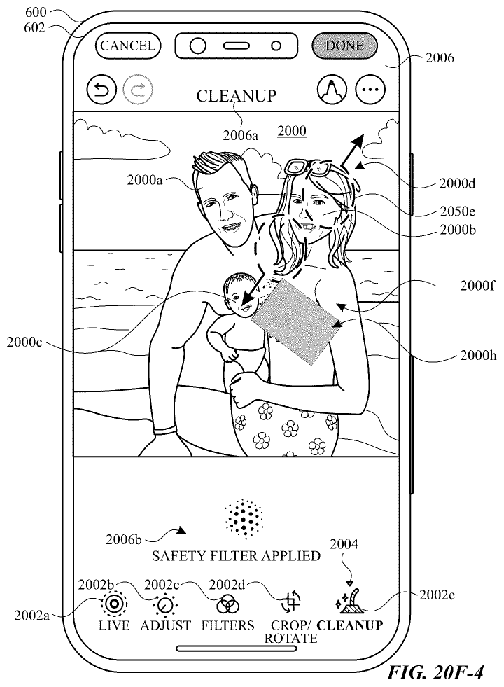

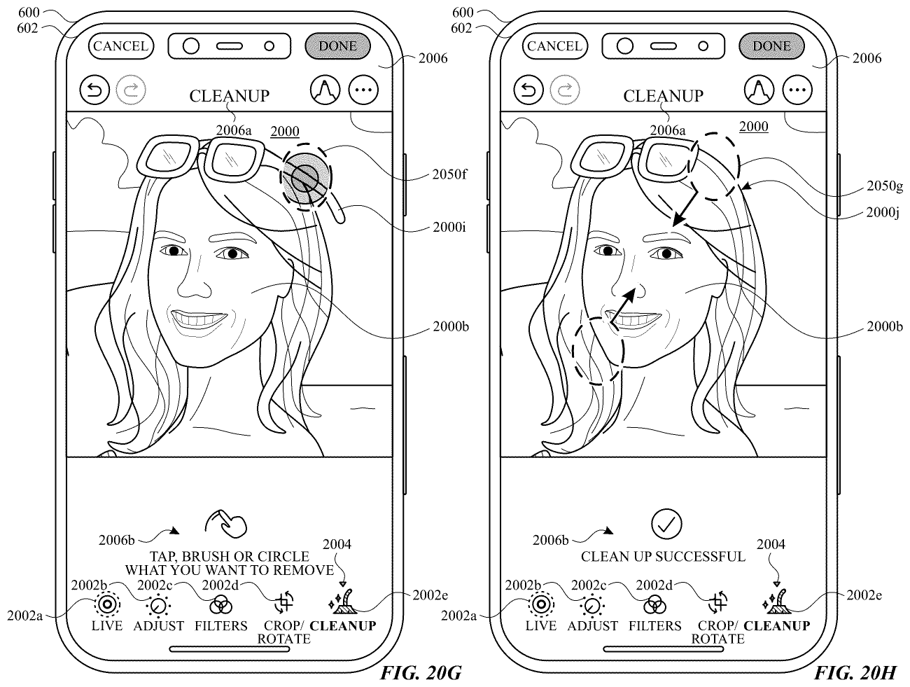

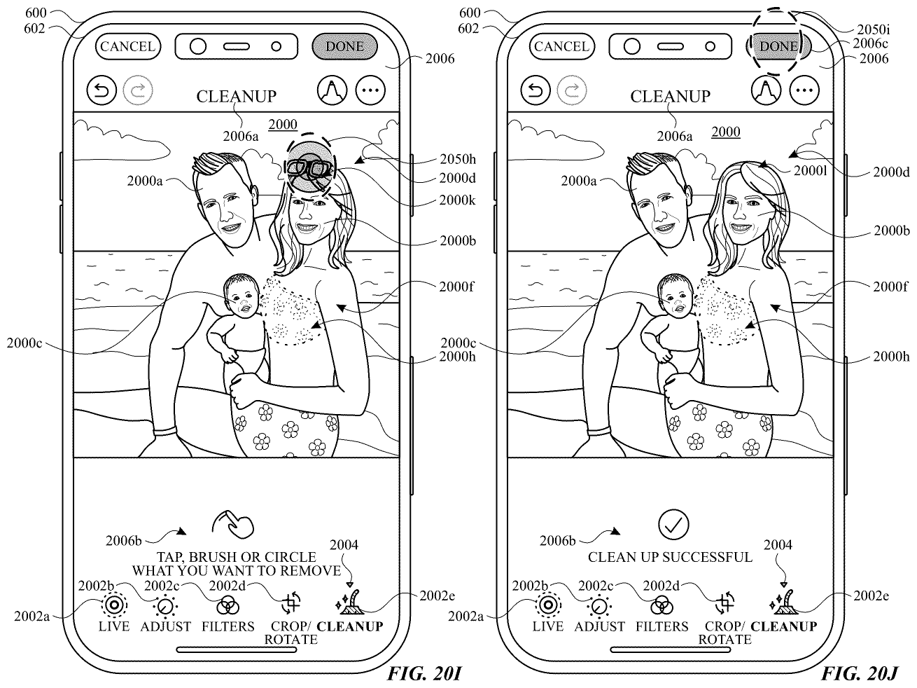

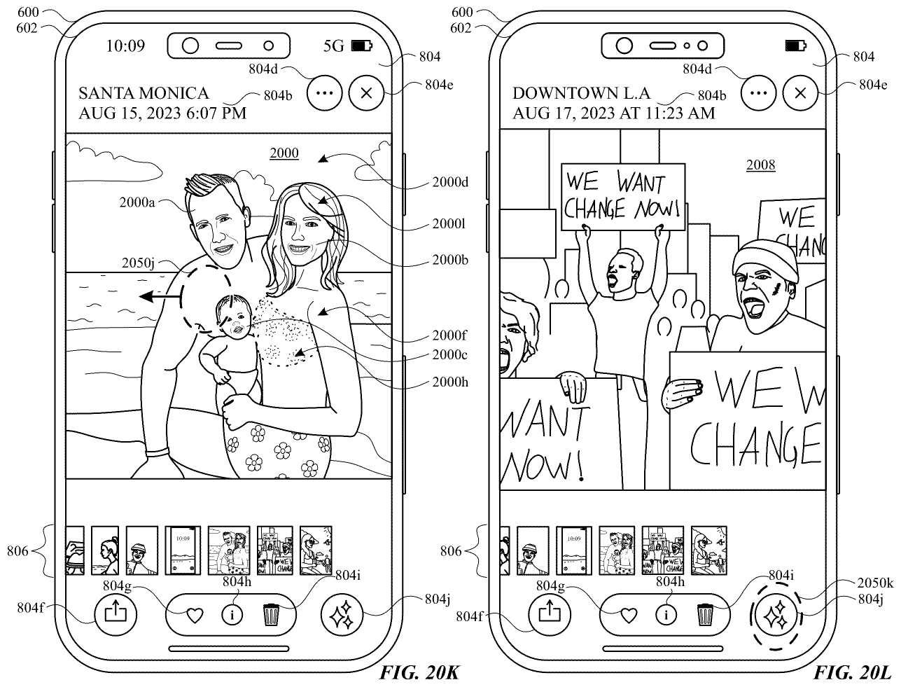

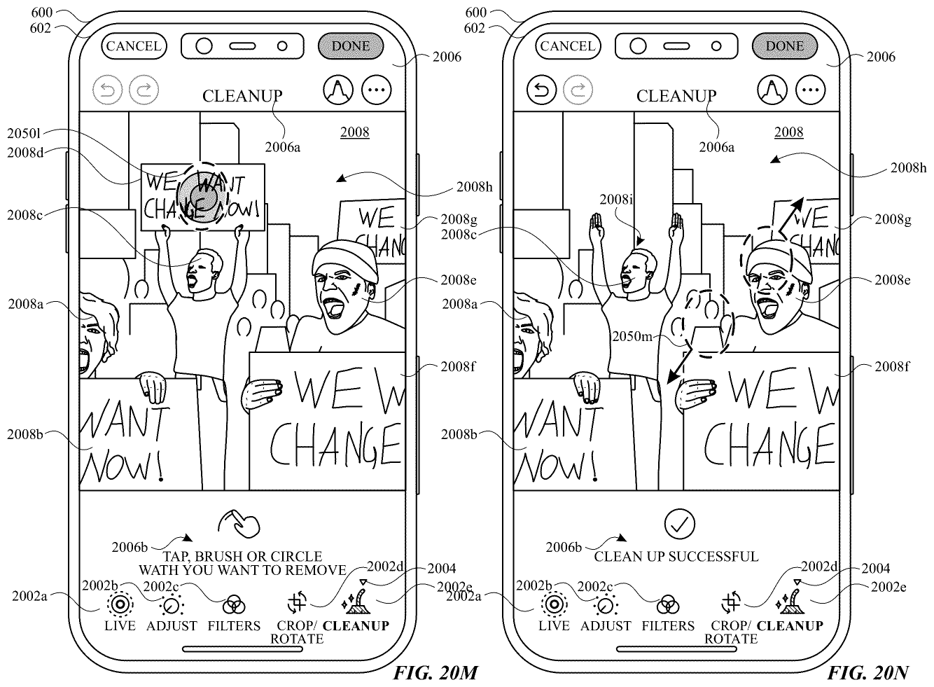

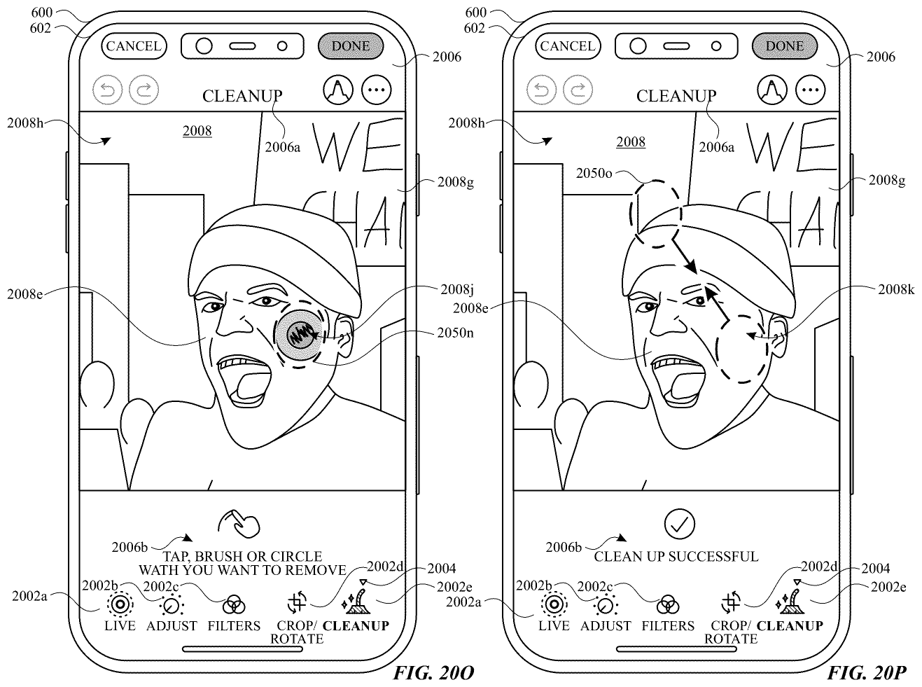

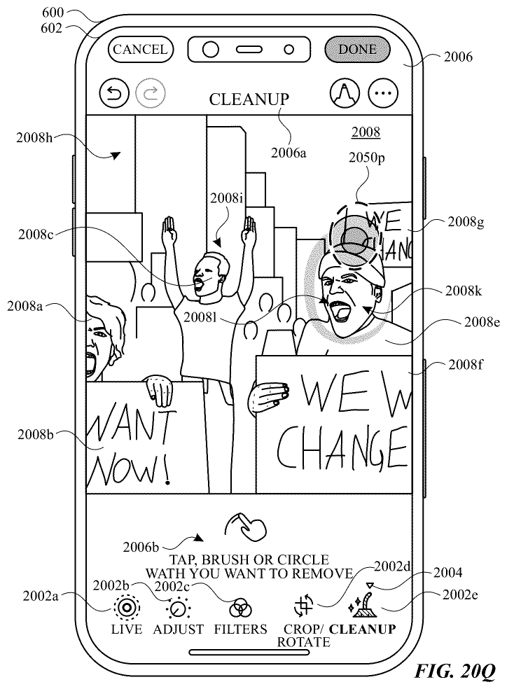

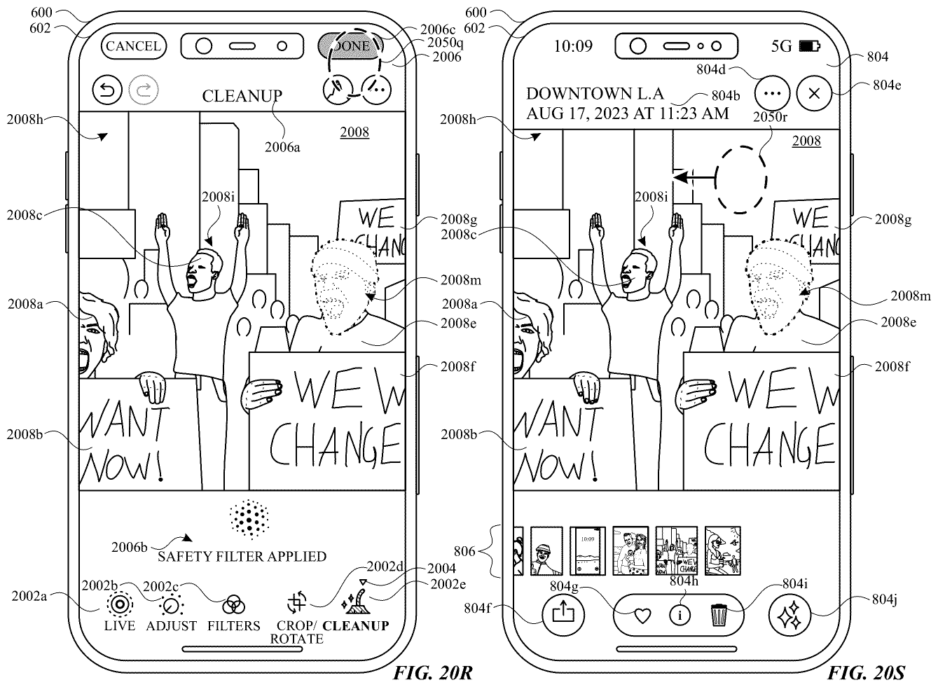

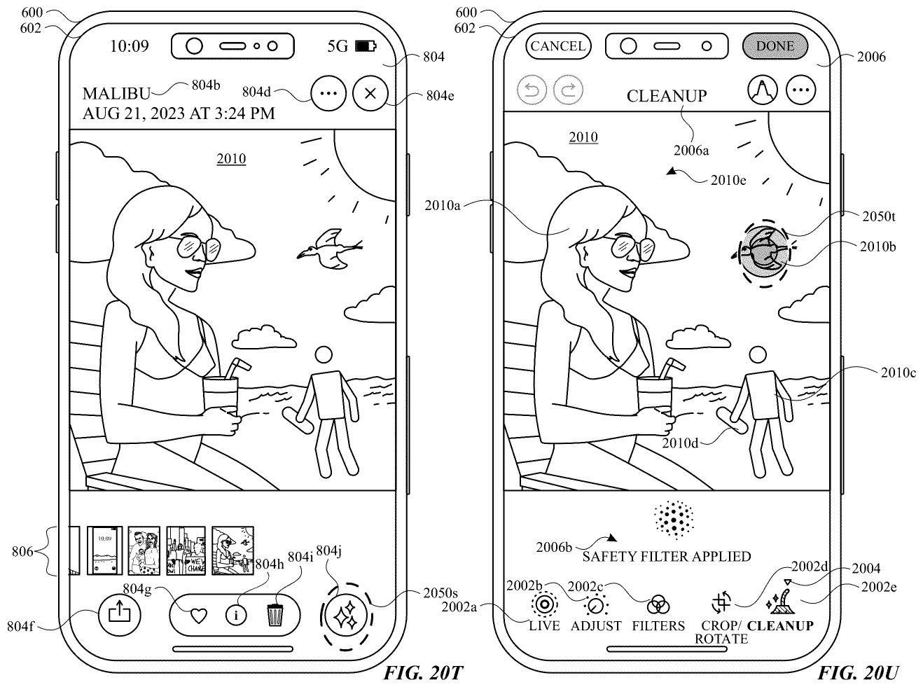

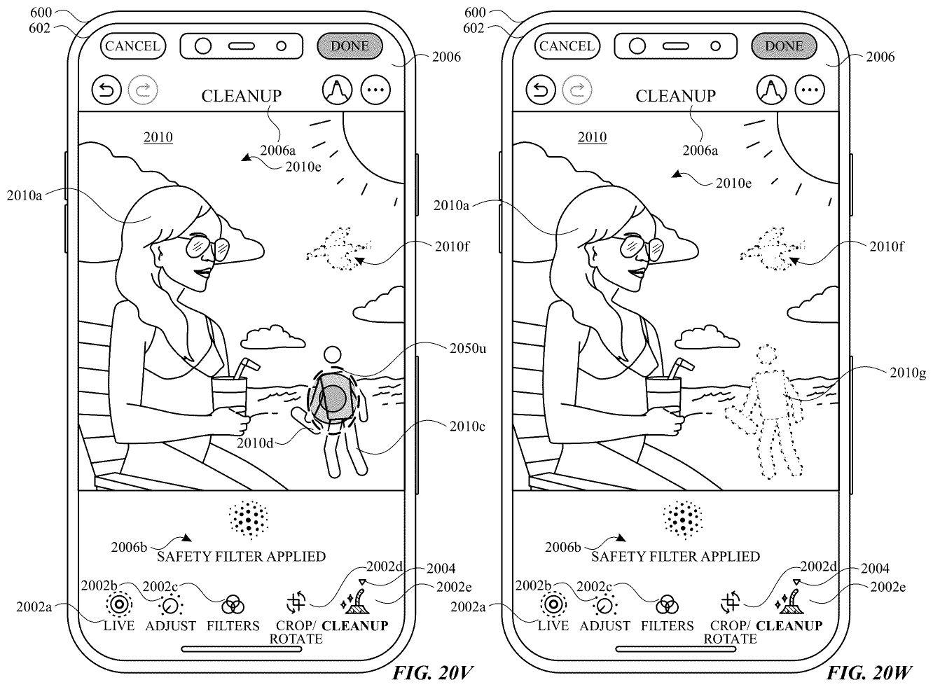

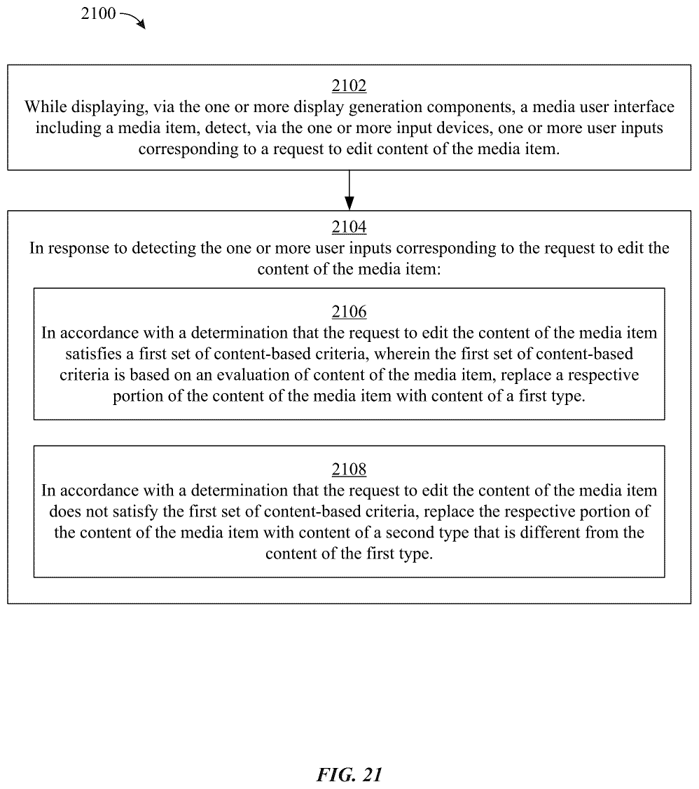

Below, FIGS. 1A-1B, 2, 3A, 4A-4B, and 5A-5B provide a description of exemplary devices for performing the techniques for editing media. FIGS. 6A-6AG illustrate exemplary user interfaces for managing photographic styles in accordance with some embodiments. FIGS. 7A-7B are flow diagrams illustrating methods for managing photographic styles in accordance with some embodiments. The user interfaces in FIGS. 6A-6AG are used to illustrate the processes described below, including the processes in FIGS. 7A-7B. FIGS. 8A-8Z illustrate exemplary user interfaces for editing video media items in accordance with some embodiments. FIGS. 9A-9B are flow diagrams illustrating methods for editing video media items in accordance with some embodiments. FIG. 15 is a flow diagram illustrating a method for managing slow motion controls in accordance with some embodiments. The user interfaces in FIGS. 8A-8Z are used to illustrate the processes described below, including the process in FIGS. 9A-9B and 15. FIGS. 10A-10R illustrate exemplary user interfaces for selectively applying edits from one image to another image, in accordance with some embodiments. FIG. 11 is a flow diagram illustrating a method for selectively applying edits from one image to another image, in accordance with some embodiments. FIGS. 12A-12AK illustrate exemplary user interfaces for editing media based on a location of an input in accordance with some embodiments. FIG. 13 is a flow diagram illustrating methods of editing media based on a location of an input in accordance with some embodiments. The user interfaces in FIGS. 12A-12AK are used to illustrate the processes described below, including the processes in FIG. 13. FIGS. 14A-14L illustrate exemplary user interfaces for editing audio of a media item, in accordance with some embodiments. FIG. 16 is a flow diagram illustrating a method for editing audio of a media item in accordance with some embodiments. The user interfaces in FIGS. 14A-14L are used to illustrate the processes described below, including the processes in FIG. 16. FIGS. 17A-17AP illustrate exemplary user interfaces for managing media styles, in accordance with some embodiments. FIG. 18 is a flow diagram illustrating a method for selecting media styles in accordance with some embodiments. FIG. 19 is a flow diagram illustrating a method for previewing a media style in accordance with some embodiments. The user interfaces in FIGS. 17A-17AP are used to illustrate the processes described below, including the processes in FIGS. 18 and 19. FIGS. 20A-20W illustrate exemplary user interfaces for editing a media item, in accordance with some embodiments. FIG. 21 is a flow diagram illustrating a method for editing a media item in accordance with some embodiments. The user interfaces in FIGS. 20A-20W are used to illustrate the processes described below, including the processes in FIG. 21.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device or component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

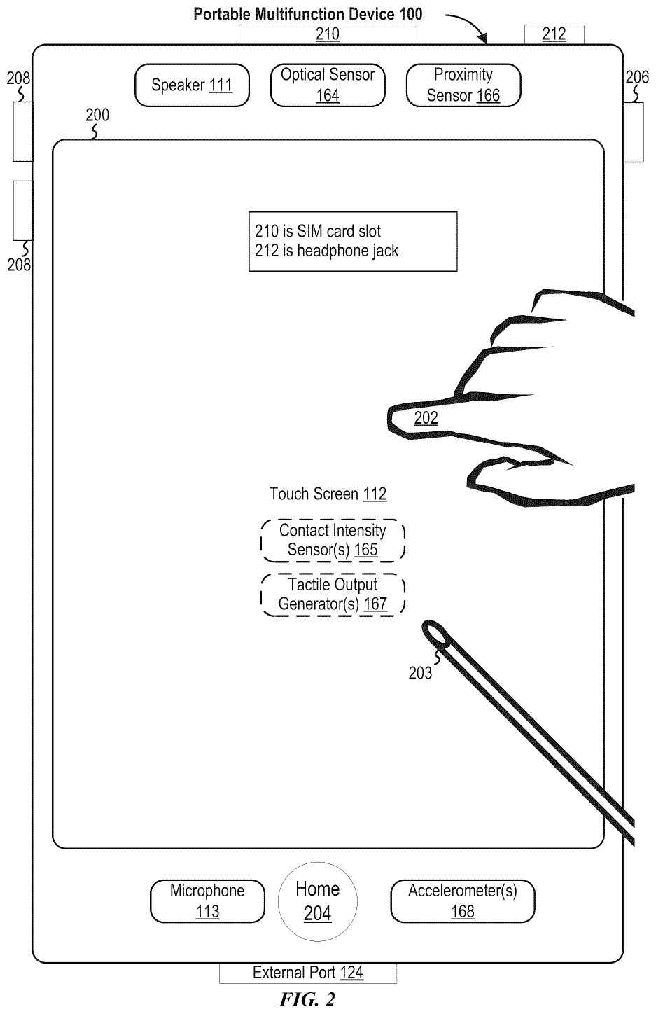

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch-sensitive display 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch screen 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

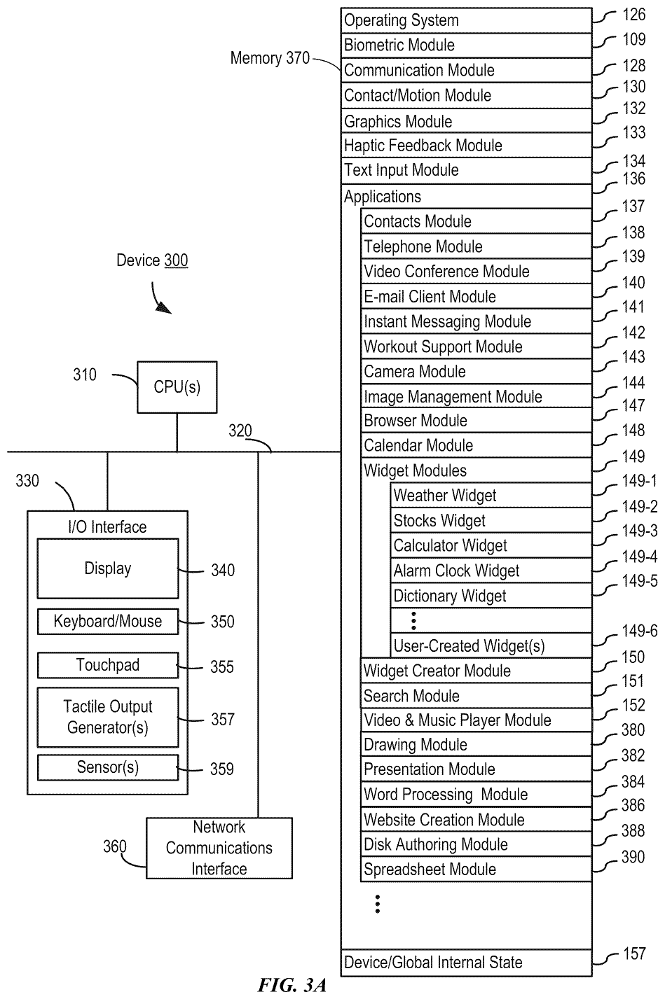

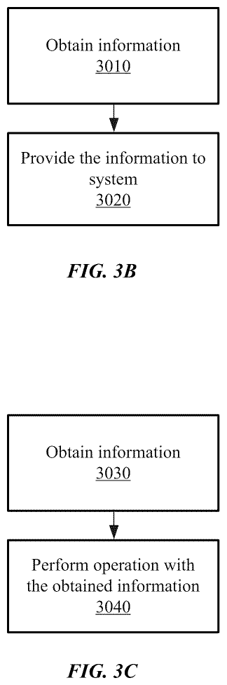

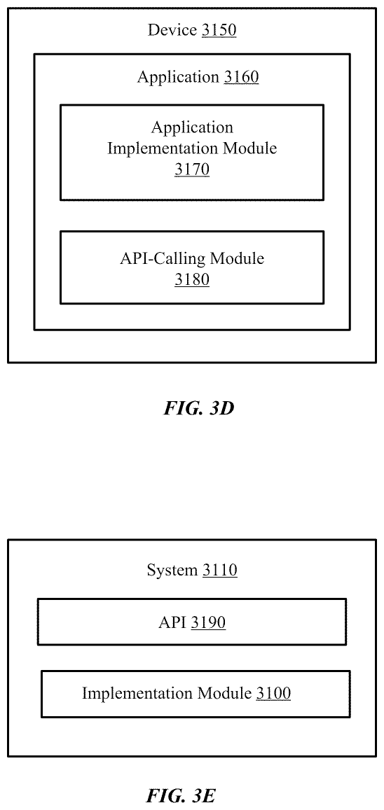

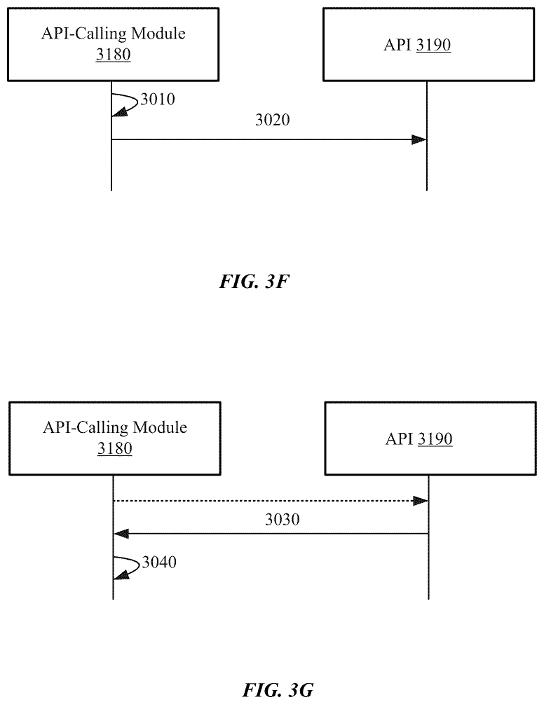

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 900, 1100, 1300, 1500, 1600, 1800, 1900, and/or 2100 (FIGS. 7A-7B, 9A-9B, 11, 13, 15, 16, 18, 19, and/or 21) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

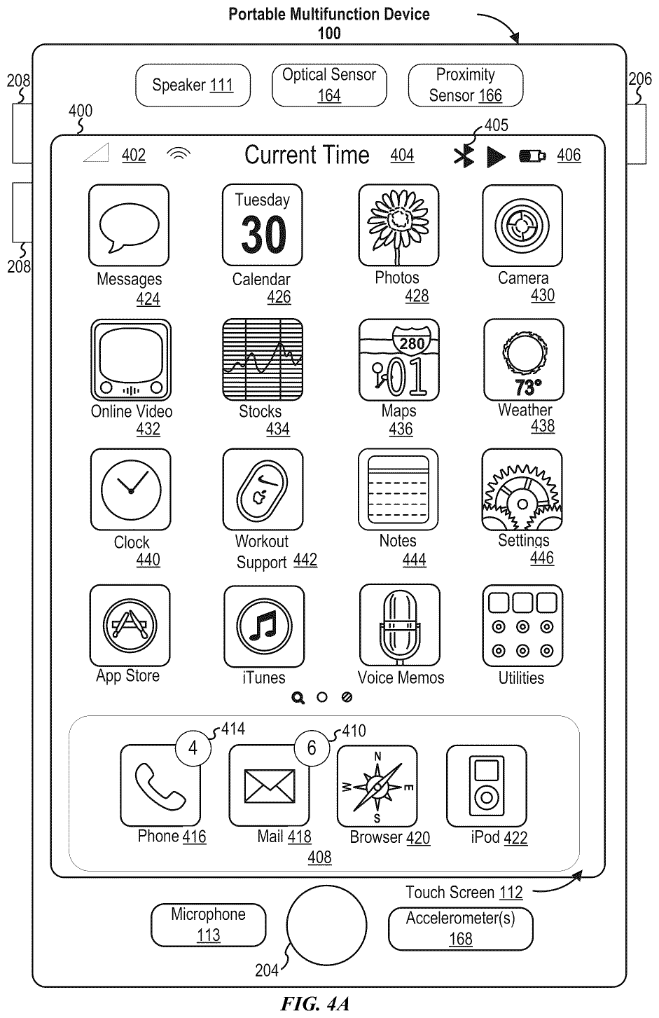

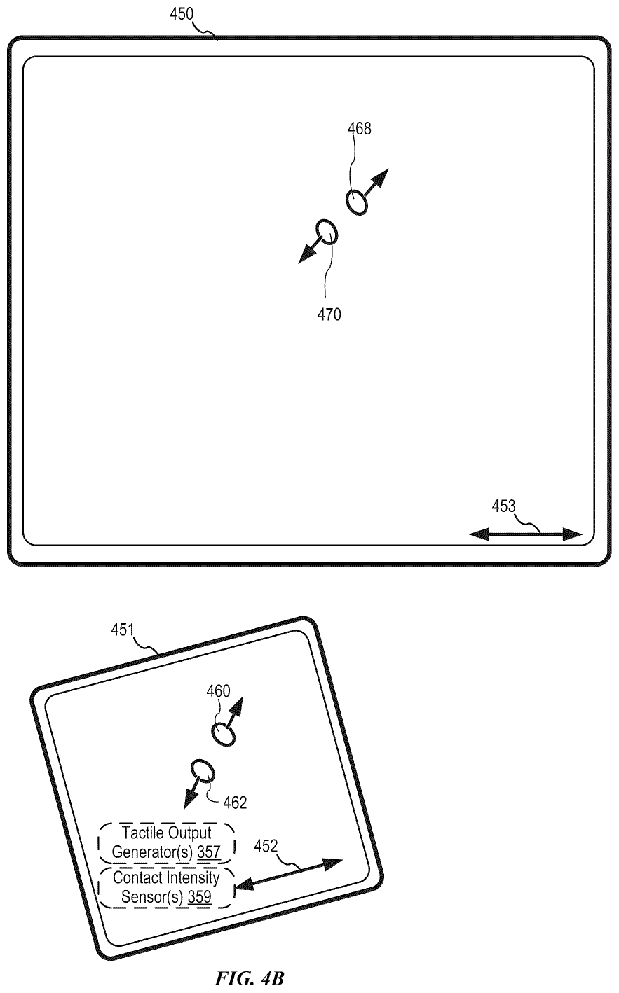

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

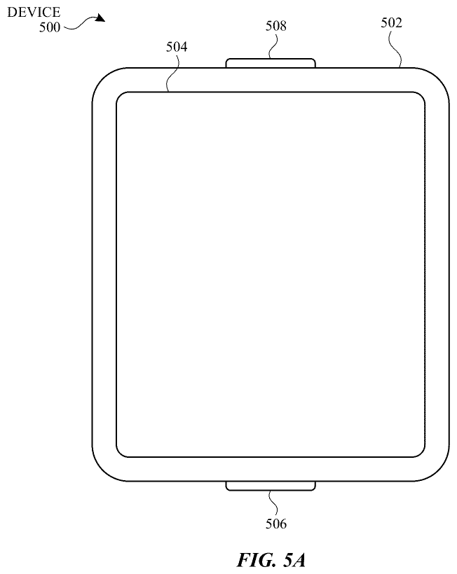

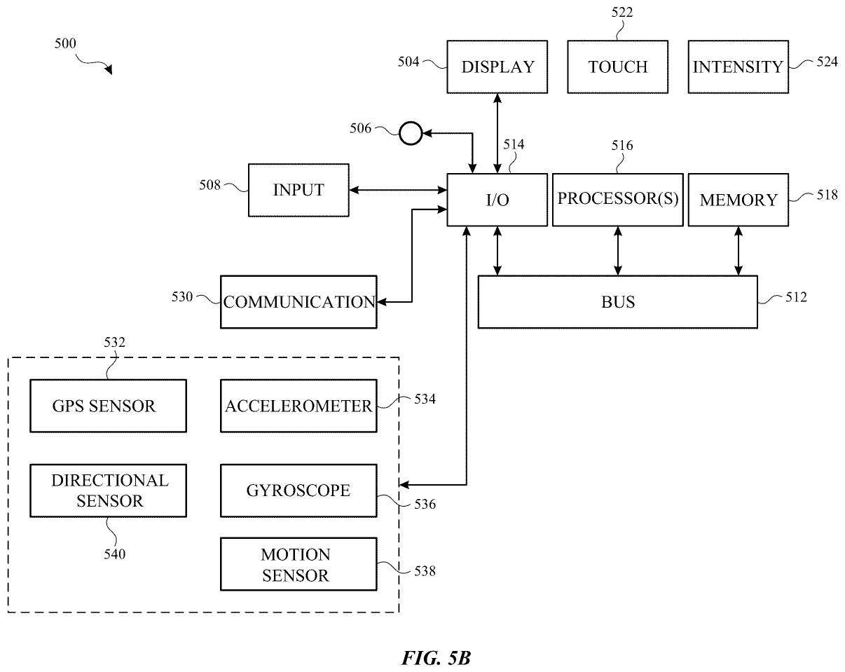

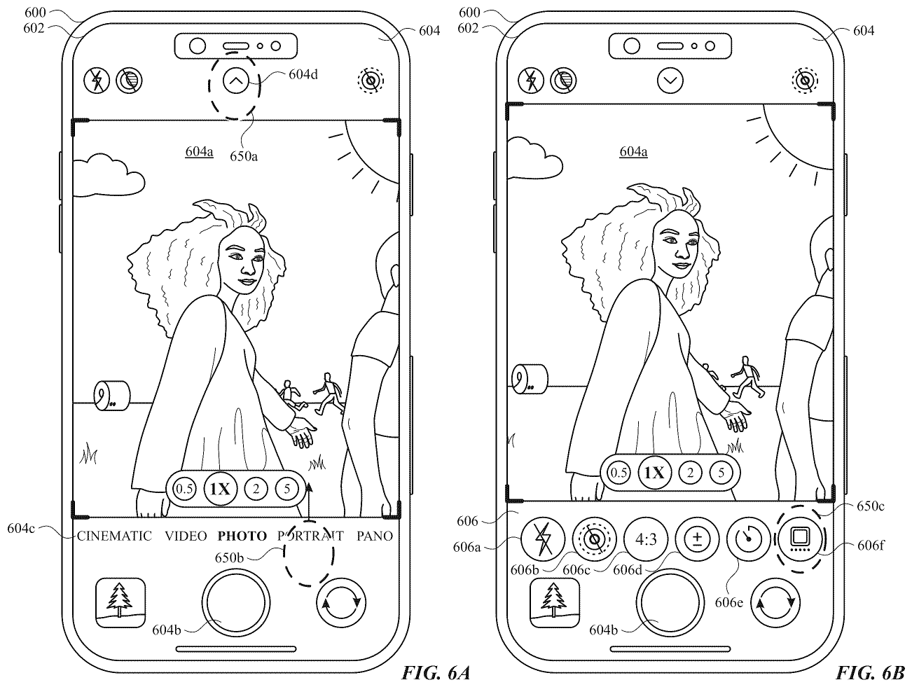

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display screen 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 900, 1100, 1300, 1500, 1600, 1800, 1900, and/or 2100 (FIGS. 7A-7B, 9A-9B, 11, 13, 15, 16, 18, 19, and/or 21). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as portable multifunction device 100, device 300, or device 500.

FIGS. 6A-6AG illustrate exemplary user interfaces for managing photographic styles, in accordance with some embodiments. The user interfaces in these figures are used to illustrate the processes described below, including the processes in FIGS. 7A-7B.

In some embodiments, any of the inputs described herein (e.g., input 650a, 650b, 650c, 650d, 650e, 650f, 650g, 650h, 650i, 650j, 650k, 650l, 650m, 650n, 650o, 650p, 650q, 650r, 650s, 650t, 650u, 650v, 650w, 650x, 650y, 650z, 650aa, 650ab, 650ac, 650ad, 650ae, 650af, 650ag, 650ah, 650ai, 650aj, 650ak, 650al, 650am, 650an) is or includes a touch input (e.g., a tap gesture and/or a swipe gesture). In some embodiments, any of the inputs described herein (e.g., input 650a, 650b, 650c, 650d, 650e, 650f, 650g, 650h, 650i, 650j, 650k, 650l, 650m, 650n, 650o, 650p, 650q, 650r, 650s, 650t, 650u, 650v, 650w, 650x, 650y, 650z, 650aa, 650ab, 650ac, 650ad, 650ae, 650af, 650ag, 650ah, 650ai, 650aj, 650ak, 650al, 650am, 650an) is or includes a voice input (e.g., a voice command to select a user interface element or to activate a feature or perform a function, such as a feature or function associated with a user interface element). In some embodiments, any of the inputs described herein (e.g., input 650a, 650b, 650c, 650d, 650e, 650f, 650g, 650h, 650i, 650j, 650k, 650l, 650m, 650n, 650o, 650p, 650q, 650r, 650s, 650t, 650u, 650v, 650w, 650x, 650y, 650z, 650aa, 650ab, 650ac, 650ad, 650ae, 650af, 650ag, 650ah, 650ai, 650aj, 650ak, 650al, 650am, 650an) is or includes an air gesture (e.g., an air gesture to select a user interface element or to activate a feature or perform a function, such as a feature or function associated with a user interface element). In some embodiments, any of the inputs described herein (e.g., input 650a, 650b, 650c, 650d, 650e, 650f, 650g, 650h, 650i, 650j, 650k, 650l, 650m, 650n, 650o, 650p, 650q, 650r, 650s, 650t, 650u, 650v, 650w, 650x, 650y, 650z, 650aa, 650ab, 650ac, 650ad, 650ae, 650af, 650ag, 650ah, 650ai, 650aj, 650ak, 650al, 650am, 650an) is or includes activation (e.g., a press, a rotation, and/or a movement) of a hardware device (e.g., a button, a rotatable input mechanism, a rotatable and depressible input mechanism, a mouse, a mouse button, a trackpad, a trackpad button, a button of a remote control, and/or a joystick). In some embodiments, any of the inputs described herein (e.g., input 650a, 650b, 650c, 650d, 650e, 650f, 650g, 650h, 650i, 650j, 650k, 650l, 650m, 650n, 650o, 650p, 650q, 650r, 650s, 650t, 650u, 650v, 650w, 650x, 650y, 650z, 650aa, 650ab, 650ac, 650ad, 650ae, 650af, 650ag, 650ah, 650ai, 650aj, 650ak, 650al, 650am, 650an) as a touch and drag gesture includes an air gesture (e.g., an air gesture including a pinch and/or movement) and/or a click and drag gesture (e.g., a click of a mouse button and/or a trackpad and/or movement while holding a press of a mouse button and/or trackpad) of a mouse and/or trackpad. In some embodiments, any of the user interface elements described as being selected herein (e.g., an icon, affordance, button, and/or selectable option) is selected by activating a hardware device while the user interface element is in focus (e.g., highlighted, bolded, outlined, visually distinguished from other user interface elements, and/or located at or near a cursor).

FIG. 6A illustrates computer system 600 displaying, via display 602, camera user interface 604. Camera user interface 604 corresponds to an application that enables computer system 600 to capture images and/or videos using a camera of (e.g., one or more cameras that are in communication with) computer system 600. Camera user interface 604 includes field of view representation 604a that includes a visual representation of an area surrounding computer system 600 and that is within a field of view of the camera of computer system 600. Camera user interface 604 also includes capture user interface object 604b. In response to detecting user input corresponding to capture user interface object 604b, computer system 600 initiates capturing an image and/or video that is within the field of view of the camera. Camera user interface 604 also includes photographic mode region 604c and options user interface object 604d. In some embodiments, in response to detecting user input corresponding to photographic mode region 604c, computer system 600 transitions among respective modes for capturing different types of photos and/or videos.

At FIG. 6A, computer system 600 detects user input 650a (e.g., a tap input and/or a touch input) corresponding to selection of options user interface object 604d. In response to detecting user input 650a, computer system 600 displays camera user interface 604 with settings region 606, as shown at FIG. 6B. In some embodiments, at FIG. 6A, computer system 600 detects user input 650b (e.g., a swipe up input and/or a touch input) corresponding to camera user interface 604. In some embodiments, in response to detecting user input 650b, computer system 600 displays settings region 606 on camera user interface 604, as shown at FIG. 6B.

At FIG. 6B, computer system 600 displays camera user interface 604, which includes display of settings region 606 replacing display of photographic mode region 604c. In some embodiments, computer system 600 does not replace display of photographic mode region 604c with settings region 606 and instead displays both photographic mode region 604c and settings region 606 concurrently on camera user interface 604.

At FIG. 6B, settings region 606 includes settings user interface objects 606a-606f corresponding to respective settings for capturing images and/or videos using the camera of computer system 600. For instance, at FIG. 6B, settings user interface object 606f corresponds to a styles setting for images and/or videos captured using the camera of computer system 600. In some embodiments, a style of an image and/or video captured using the camera of computer system 600 includes computer system 600 applying different combinations of tone, saturation, color temperature, brightness, contrast, and/or warmth to images and/or videos that are being captured and/or have been captured using the camera of computer system 600.

In some embodiments, while computer system 600 displays camera user interface 604 and in response to selection of a respective style, computer system 600 is configured to apply the respective style to images and/or videos captured via the camera (e.g., in response to detecting user input corresponding to capture user interface object 604b). As set forth below with reference to FIGS. 6S-6Y, computer system 600 is also configured to apply a respective style to an image and/or video that has already been captured via the camera of computer system 600 and/or an image and/or video that is otherwise accessible to computer system 600 (e.g., stored in a media library of computer system 600 and/or accessible via a server).

At FIG. 6B, computer system 600 detects user input 650c (e.g., a tap input and/or a touch input) corresponding to settings user interface object 606f. In response to detecting user input 650c, computer system 600 displays styles user interface 608, as shown at FIG. 6C.

At FIG. 6C, styles user interface 608 includes field of view representation 608a, capture user interface object 608b, and style region 610. Similar to field of view representation 604a, field of view representation 608a includes a visual representation of an area surrounding computer system 600 and that is within a field of view of the camera of computer system 600. Computer system 600 is configured to initiate capturing an image and/or video that is within the field of view of the camera in response to detecting user input corresponding to capture user interface object 608b.

Style region 610 includes style user interface objects 610a-610d. Style user interface objects 610a-610d correspond to respective styles that can be applied to images and/or videos captured via the camera of computer system 600. For instance, style user interface object 610a corresponds to a standard style that includes a first tone (e.g., a default tone), a first saturation (e.g., a default saturation), and/or a first color temperature (e.g., a default color temperature).

Style user interface objects 610a-610d include graphical representation 612 of the respective style corresponding to style user interface objects 610a-610d. Graphical representation 612 is a two dimensional grid and/or chart that is defined by first axis 612a and second axis 612b. As set forth below, first axis 612a represents values of tone and second axis 612b represents values of saturation. Graphical representation 612 also includes indicator 612c that represents a currently selected value of tone and saturation for the respective style. In other words, a position of indicator 612c relative to first axis 612a indicates a current value of tone and a position of indicator 612c relative to second axis 612b indicates a current value of saturation for the respective style. While the discussion of FIGS. 6A-6AG describes tone and saturation as the parameters represented by graphical representation 612, in some embodiments, graphical representation 612 represents other parameters, such as color temperature, contrast, brightness, and/or warmth.

At FIG. 6C, graphical representation 612 is different for each of style user interface objects 610a-610d indicating that different styles can be applied to images and/or videos captured via the camera of computer system 600. In some embodiments, the styles corresponding to style user interface objects 610a-610d are defined by computer system 600 (e.g., the styles are pre-set and/or default styles of computer system 600). In some embodiments, the styles corresponding to style user interface objects 610a-610d are user defined. In some embodiments, the styles corresponding to style user interface objects 610a-610d include a combination of styles defined by computer system 600 and user-defined styles. As set forth below, computer system 600 is configured to modify a style corresponding to a respective style user interface object 610a-610d in response to one or more user inputs.

At FIG. 6C, style user interface object 610a is currently selected, and thus, computer system 600 is configured to apply the respective style corresponding to style user interface object 610a to an image and/or video that is captured via the camera of computer system 600. In some embodiments, computer system 600 displays style user interface object 610a at a size that is larger than style user interface objects 610b-610d based on a determination that and/or when style user interface object 610a is currently selected. In some embodiments, computer system 600 displays style user interface object 610a with an appearance that is different from the appearance of style user interface objects 610b-610d based on a determination that and/or when style user interface object 610a is currently selected. For example, in some embodiments, computer system 600 displays style user interface object 610a with an outline, with a different color than style user interface objects 610b-610d, and/or with an emphasis when style user interface object 610a is currently selected.

In response to detecting user input corresponding to (e.g., a tap input on, a swipe input on, and/or a touch input directed to) a different style user interface object (e.g., style user interface objects 610b-610d), computer system 600 selects a respective style user interface object based on the input and is configured to apply the respective style corresponding to the selected respective style user interface object to captured images and/or videos. As set forth below, computer system 600 is also configured to apply the respective style to field of view representation 608a (e.g., display field of view representation 608a with a respective tone, saturation, and/or color temperature corresponding to the selected style) so that the user of computer system 600 can preview the style and determine whether to apply the style to images and/or videos captured via the camera of computer system 600 (e.g., or to select a different style).

In some embodiments, in response to detecting user input corresponding to style region 610, computer system 600 displays additional style user interface objects (e.g., style user interface object 610e shown at FIGS. 6D and 6E). For instance, at FIG. 6C, computer system 600 detects user input 650d (e.g., a swipe input and/or a touch input) corresponding to style region 610. In response to detecting user input 650d, computer system 600 moves and/or translates style user interface objects 610a-610d and displays style user interface object 610e, as shown at FIG. 6D. In addition, in response to detecting user input 650d, computer system 600 selects style user interface object 610b and de-selects style user interface object 610a.

At FIG. 6D, computer system displays styles user interface 608, where field of view representation 608a includes a modified appearance (e.g., as compared to the appearance of field of view representation 608a at FIG. 6C) based on the style corresponding to style user interface object 610b, as indicated by first hatching of 608a at FIG. 6D. Style user interface object 610b includes indicator 612c at a different location relative to first axis 612a and second axis 612b as compared to style user interface object 610a. Computer system 600 applies the style corresponding to style user interface object 610b so that an image and/or video captured by the camera of computer system 600 (e.g., in response to detecting user input corresponding to capture user interface object 608b) includes the style corresponding to style user interface object 610b.

At FIG. 6D, computer system 600 detects user input 650e (e.g., a swipe input and/or a touch input) corresponding to style region 610. In response to detecting user input 650e, computer system 600 moves and/or translates style user interface objects 610a-610e, as shown at FIG. 6E. In addition, in response to detecting user input 650e, computer system 600 selects style user interface object 610c and de-selects style user interface object 610b.

At FIG. 6E, computer system displays styles user interface 608, where field of view representation 608a includes a modified appearance (e.g., as compared to the appearance of field of view representation 608a at FIGS. 6C and 6D) based on the style corresponding to style user interface object 610c, as indicated by second hatching of 608a at FIG. 6E. Style user interface object 610c includes indicator 612c positioned at a different location relative to first axis 612a and second axis 612b as compared to style user interface objects 610a and 610b. At FIG. 6E, computer system 600 applies the style corresponding to style user interface object 610c so that an image and/or video captured by the camera of computer system 600 includes the style corresponding to style user interface object 610c.

As set forth above, in some embodiments, style user interface objects 610a-610e correspond to styles that are user-defined. In other words, in some embodiments, one or more of style user interface objects 610a-610e correspond to styles that include parameters selected by and/or customized via user input. At FIG. 6E, computer system 600 detects user input 650f (e.g., a tap input and/or a touch input) corresponding to style user interface object 610c. In response to detecting user input 650f, computer system 600 initiates an editing mode that enables computer system 600 to receive inputs to modify and/or adjust parameters of the style corresponding to style user interface object 610c. As shown at FIG. 6F, computer system 600 displays style editing user interface 614 in response to detecting user input 650f.

At FIG. 6F, style editing user interface 614 includes field of view representation 614a, tone value indicator 614b, saturation value indicator 614c, graphical representation 616, and slider 617. Similar to field of view representations 604a and 608a, field of view representation 614a includes a visual representation of an area surrounding computer system 600 and that is within a field of view of the camera of computer system 600. Field of view representation 614a includes the same appearance as 608a shown at FIG. 6E because the style corresponding to style user interface object 610c is selected, as indicated by second hatching of 614a at FIG. 6F. Style editing user interface 614 does not include capture user interface object 608b, such that computer system 600 is not configured to capture an image and/or video while displaying style editing user interface 614. In some embodiments, computer system 600 displays capture user interface object 608c concurrently with graphical representation 616, such that computer system 600 is configured to capture images and/or videos while displaying style editing user interface 614. As set forth below, computer system 600 is configured to adjust a color temperature of the style corresponding to style user interface object 610c in response to detecting user input corresponding to slider 617.

Tone value indicator 614b includes a textual and/or numerical indication of a currently selected tone value. Similarly, saturation value indicator 614c includes a textual and/or numerical indication of a currently selected saturation value. While tone value indicator 614b and saturation value indicator 614c are displayed below field of view representation 614a at FIG. 6F, in some embodiments, computer system 600 overlays tone value indicator 614b and/or saturation value indicator 614c onto field of view representation 614a. Computer system 600 is configured to modify, adjust, change, and/or update the currently selected tone value and/or the currently selected saturation value in response to detecting user input corresponding to graphical representation 616. Computer system 600 also updates tone value indicator 614b and/or saturation value indicator 614c in response to detecting user input corresponding to graphical representation 616. As set forth above, while the description of FIGS. 6A-6AG relates to graphical representation 616 corresponding to respective tone and saturation values, in some embodiments, computer system 600 is configured to cause adjustment of other parameters of a style in response to detecting user input corresponding to graphical representation 616.

As set forth below, computer system 600 is configured to concurrently adjust values of tone and saturation in response to user input corresponding to graphical representation 616. Computer system 600 is also configured to individually adjust a value of tone (e.g., without adjusting a value of saturation) and/or individually adjust a value of saturation (e.g., without adjusting a value of tone) in response to user input corresponding to graphical representation 616.

Graphical representation 616 includes first axis 616a corresponding to values of tone and second axis 616b corresponding to values of saturation. In addition, graphical representation 616 includes indicator 616c indicating a currently selected value of tone and a currently selected value of saturation, which is represented by a location of indicator 616c relative to first axis 616a and second axis 616b. Computer system 600 is configured to adjust, modify, and/or change the values of tone and/or saturation in response to user input corresponding to graphical representation 616. In some embodiments, the user input corresponding to graphical representation 616 includes a touch input that includes movement from an initial touch location to a second location. In some embodiments, the user input corresponding to graphical representation 616 includes a touch and/or tap input selecting a new position and/or location of indicator 616c relative to first axis 616a and/or second axis 616b.

For example, at FIG. 6F, computer system 600 detects user input 650g corresponding to graphical representation 616. User input 650g includes a request to adjust one or more parameters of the style corresponding to style user interface object 610c. At FIG. 6F, user input 650g is a touch gesture that includes movement while maintaining contact of the touch gesture (e.g., a swipe gesture). In response to detecting user input 650g, computer system 600 adjusts a position and/or location of indicator 616c in a direction along first axis 616a and/or second axis 616b that is based on the movement of user input 650g. For instance, at FIG. 6F, user input 650g includes movement in a direction that is parallel to first axis 616a and does not include movement in a direction along second axis 616b. In response to detecting user input 650g, computer system 600 adjusts a position of indicator 616c along first axis 616a, as shown at FIG. 6G. In addition, computer system adjusts a current value of tone for the style corresponding to style user interface object 610c in response to detecting user input 650g. For instance, as shown at FIG. 6G, field of view representation 614a includes third hatching indicating that an appearance of field of view representation 614a has been modified based on the change in the current value of tone. In addition, at FIG. 6G, tone value indicator 614b has been updated to indicate that the tone value has been changed to a value of 50 from a value of −25 (e.g., the tone value at FIG. 6F).

While user input 650g is a touch gesture that includes movement while maintaining contact with display 602, computer system 600 is also configured to adjust one or more parameters of the style corresponding to style user interface object 610c in response to other types of user inputs. For instance, at FIG. 6F, computer system 600 detects user input 650h corresponding to graphical representation 616. User input 650h is a tap gesture at a position of graphical representation 616 and does not include movement. In response to detecting user input 650h, computer system 600 adjusts and/or moves indicator 616c to a location of graphical representation 616 that is based on a location of user input 650h with respect to first axis 616a and second axis 616b of graphical representation 616. As shown at FIG. 6F, the location of user input 650h forms a line with a current position of indicator 616c that is parallel to first axis 616a. In response to detecting user input 650h, computer system 600 moves indicator 616c to an updated position on graphical representation 616 that includes movement along first axis 616a, but does not include movement along second axis 616b.

In addition, in response to detecting user input 650h, computer system 600 updates the current value of tone, as shown at FIG. 6G. For instance, as shown at FIG. 6G, field of view representation 614a includes the third hatching indicating that an appearance of field of view representation 614a has been modified based on the change in the current value of tone. In addition, at FIG. 6G, tone value indicator 614b has been updated to indicate that the tone value has been changed to a value of 50 from a value of −25 (e.g., the tone value at FIG. 6F).

At FIG. 6F, computer system 600 outputs tactile feedback 651a in response to detecting user input 650g and/or user input 650h corresponding to graphical representation 616. In some embodiments, as shown in FIG. 6F, computer system 600 outputs tactile feedback 651a in response to detecting an initial contact of user input 650g corresponding to graphical representation 616. Accordingly, computer system 600 provides confirmation that the user is interacting with graphical representation 616 to adjust one or more parameters of the style corresponding to style user interface object 610c.

Further still, in response to detecting user input 650g and/or user input 650h, computer system 600 adjusts and/or modifies an appearance of graphical representation 616. For instance, at FIG. 6F, computer system 600 displays graphical representation 616 with an appearance indicated by a first shading pattern. In response to detecting user input 650g and/or user input 650h, computer system 600 displays graphical representation 616 with an appearance indicated by a second shading pattern, as shown at FIG. 6G. In some embodiments, the appearance of graphical representation 616 is based on the current value of tone and/or the current value of saturation, indicated by the position of indicator 616c within graphical representation 616. For instance, in some embodiments, computer system 600 adjusts a tone of one or more colors of graphical representation 616 in response to detecting user input corresponding to a request to change a current value of tone. In some embodiments, computer system 600 adjusts a saturation of one or more colors of graphical representation 616 in response to detecting user input corresponding to a request to change a current value of saturation. In some embodiments, computer system 600 adjusts the tone and saturation of one or more colors of graphical representation 616 in response to detecting user input corresponding to a request to change a current value of tone and a current value of saturation. In some embodiments, computer system 600 updates and/or modifies an appearance (e.g., a color, a color temperature, a shading, a brightness, a tone, and/or a saturation) of slider 617 in response to detecting user input 650g and/or user input 650h.

At FIG. 6G, computer system 600 displays graphical representation 616 with indicator 616c at an updated location based on a location and/or movement of user input 650g and/or user input 650h. As set forth above, because user input 650g and user input 650h include inputs requesting to change the location of indicator 616c along first axis 616a, but not along second axis 616b, indicator 616c is displayed at a location that is to the right of the location of indicator 616c at FIG. 6F and moves along a path that is parallel to first axis 616a. Computer system 600 updates tone value indicator 614b to indicate the new current value of tone based on detecting user input 650g and/or user input 650h. However, computer system 600 does not update saturation value indicator 614c (e.g., computer system 600 maintains an appearance and/or a value associated with saturation value indicator 614c) because computer system 600 did not change the location of indicator 616c relative to second axis 616b in response to detecting user input 650g and/or user input 650h.

At FIG. 6G, computer system 600 outputs tactile feedback 651b in response to detecting an end of user input 650g and/or user input 650h. For instance, in response to detecting that contact associated with user input 650g and/or user input 650h has ended (e.g., the user lifts their finger from display 602), computer system 600 outputs tactile feedback 651b to confirm an end of user input 650g and/or user input 650h.

At FIG. 6G, computer system 600 detects user input 650i corresponding to graphical representation 616. User input 650i includes a request to adjust one or more parameters of the style corresponding to style user interface object 610c. At FIG. 6G, user input 650i is a touch gesture that includes movement while maintaining contact of the touch gesture. In response to detecting user input 650i, computer system 600 adjusts a position and/or location of indicator 616c in a direction along first axis 616a and/or second axis 616b that is based on the movement of user input 650i. For instance, at FIG. 6G, user input 650i includes movement in a direction that is parallel to second axis 616b and does not include movement in a direction along first axis 616a. In response to detecting user input 650i, computer system 600 adjusts a position of indicator 616c along second axis 616b, as shown at FIG. 6H. In addition, computer system 600 adjusts a current value of saturation for the style corresponding to style user interface object 610c in response to detecting user input 650i. For instance, as shown at FIG. 6H, field of view representation 614a includes fourth hatching indicating that an appearance of field of view representation 614a has been modified based on the change in the current value of saturation. In addition, at FIG. 6H, saturation value indicator 614c has been updated to indicate that the saturation value has been changed to a value of 50 from a value of 0 (e.g., the saturation value at FIG. 6G).

While user input 650i is a touch gesture that includes movement while maintaining contact with display 602, computer system 600 is also configured to adjust one or more parameters of the style corresponding to style user interface object 610c in response to other types of user inputs. For instance, at FIG. 6G, computer system 600 detects user input 650j corresponding to graphical representation 616. User input 650j is a tap gesture at a position of graphical representation 616 and does not include movement. In response to detecting user input 650j, computer system 600 adjusts and/or moves indicator 616c to a location of graphical representation 616 that is based on a location of user input 650j with respect to first axis 616a and second axis 616b of graphical representation 616. As shown at FIG. 6G, the location of user input 650j forms a line with a current position of indicator 616c that is parallel to second axis 616b. In response to detecting user input 650j, computer system 600 moves indicator 616c to an updated position on graphical representation 616 that includes movement along second axis 616b, but does not include movement along first axis 616a.

At FIG. 6G, computer system 600 outputs tactile feedback 651c in response to detecting user input 650i and/or user input 650j corresponding to graphical representation 616. In some embodiments, computer system 600 outputs tactile feedback 651c in response to detecting an initial contact of user input 650i corresponding to graphical representation 616. Accordingly, computer system 600 provides confirmation that the user is interacting with graphical representation 616 to adjust one or more parameters of the style corresponding to style user interface object 610c.

Further still, in response to detecting user input 650i and/or user input 650j, computer system 600 adjusts and/or modifies an appearance of graphical representation 616. For instance, at FIG. 6G, computer system 600 displays graphical representation 616 with an appearance indicated by a second shading pattern. In response to detecting user input 650i and/or user input 650j, computer system 600 displays graphical representation 616 with an appearance indicated by a third shading pattern, as shown at FIG. 6H. As set forth above, in some embodiments, the appearance of graphical representation 616 is based on the current value of tone and/or the current value of saturation, indicated by the position of indicator 616c within graphical representation 616.

At FIG. 6H, computer system 600 displays graphical representation 616 with indicator 616c at an updated location based on a location and/or movement of user input 650i and/or user input 650j. As set forth above, because user input 650i and user input 650j include inputs requesting to change the location of indicator 616c along second axis 616b, but not first axis 616a, indicator 616c is displayed at a location that is above the location of indicator 616c at FIG. 6G and at a location that is the same distance from second axis 616b as compared to the location of indicator 616c at FIG. 6G. Computer system 600 updates saturation value indicator 614c to indicate the new current value of saturation that is set based on detecting user input 650i and/or user input 650j. However, computer system 600 does not update tone value indicator 614b (e.g., computer system 600 maintains an appearance and/or a value associated with tone value indicator 614b) because computer system 600 did not change the location of indicator 616c relative to first axis 616a in response to detecting user input 650i and/or user input 650j.

At FIG. 6H, computer system 600 outputs tactile feedback 651d in response to detecting an end of user input 650i and/or user input 650j. For instance, in response to detecting that contact associated with user input 650i and/or user input 650j has ended (e.g., the user lifts their finger from display 602), computer system 600 outputs tactile feedback 651d to confirm an end of user input 650i and/or user input 650j.

At FIG. 6H, computer system 600 detects user input 650k corresponding to graphical representation 616. User input 650k includes a request to adjust one or more parameters of the style corresponding to style user interface object 610c. At FIG. 6H, user input 650k is a touch gesture that includes movement while maintaining contact of the touch gesture. In response to detecting user input 650k, computer system 600 adjusts a position and/or location of indicator 616c in a direction along first axis 616a and/or second axis 616b that is based on the movement of user input 650k. For instance, at FIG. 6H, user input 650k includes movement in a direction along both first axis 616a and second axis 616b. In response to detecting user input 650k, computer system 600 adjusts a position of indicator 616c along both first axis 616a and second axis 616b, as shown at FIG. 6I. In addition, computer system 600 adjusts a current value of tone and adjusts a current value of saturation for the style corresponding to style user interface object 610c in response to detecting user input 650k. For instance, as shown at FIG. 6I, field of view representation 614a includes fifth hatching indicating that an appearance of field of view representation 614a has been modified based on the change in the current value of tone and the current value of saturation. In addition, at FIG. 6I, tone value indicator 614b has been updated to indicate that the tone value has been changed to a value of −12 from a value of 50 (e.g., the tone value at FIG. 6H) and saturation value indicator 614c has been updated to indicate that the saturation value has been changed to a value of −12 from a value of 50 (e.g., the saturation value at FIG. 6H). In response to detecting user input 650k, computer system 600 outputs tactile feedback 651e.

At FIG. 6I, computer system 600 detects that contact associated with user input 650k is maintained (e.g., movement of user input 650k is still occurring at FIG. 6I). Based on a determination that user input 650k includes movement across a respective portion of graphical representation 616, computer system 600 outputs tactile feedback 651f. For instance, at FIG. 6I, computer system 600 detects that user input 650k includes movement across a center line of graphical representation 616 represented by first axis 616a. Based on a determination that user input 650k includes movement across the center line of graphical representation 616 represented by first axis 616a, computer system 600 outputs tactile feedback 651f. At FIG. 6I, computer system 600 also detects that user input 650k includes movement across a center line of graphical representation 616 represented by second axis 616b. Based on a determination that user input 650k includes movement across the center line of graphical representation 616 represented by second axis 616b, computer system 600 outputs tactile feedback 651g, as shown at FIG. 6I. In some embodiments, computer system 600 outputs tactile feedback 651f as user input 650k moves across the center line of graphical representation 616 represented by first axis 616a. In some embodiments, computer system 600 outputs tactile feedback 651g as user input 650k moves across the center line of graphical representation 616 represented by second axis 616b.

At FIG. 6J, computer system 600 detects an end of user input 650k (e.g., computer system 600 detects a lift off of contact associated with user input 650k and/or detects an end of movement associated with user input 650k). In response to detecting the end of user input 650k, computer system 600 outputs tactile feedback 651h, as shown at FIG. 6J. In addition, computer system 600 updates the location and/or position of indicator 616c relative to first axis 616a and second axis 616b based on the movement of user input 650k. For instance, at FIG. 6K, computer system 600 displays indicator 616c at a position that is to the left and below the position of indicator 616c shown at FIGS. 6H and 6I. Computer system 600 updates the appearance of field of view representation 614a to include an appearance that is based on the current tone value and the current saturation value represented by indicator 616c, as shown by sixth hatching of 614a at FIG. 6J. Further still, computer system 600 updates tone value indicator 614b to indicate updated values of tone and updates saturation value indicator 614c to indicate the updated values of saturation. At FIG. 6J, tone value indicator 614b indicates that the current value of tone has been changed from −12 to −25 and saturation value indicator 614c indicates that the current value of saturation has been changed from −12 to −25 based on user input 650k. As such, computer system 600 is configured to concurrently adjust both the values of tone and saturation in response to a single user input corresponding to graphical representation 616.

At FIG. 6J, computer system 600 detects user input 650l corresponding to slider 617 of style editing user interface 614. In response to detecting user input 650l, computer system 600 updates a color temperature of the style corresponding to style user interface object 610c, as shown at FIG. 6K. In response to detecting user input 650l, computer system 600 outputs tactile feedback 651i to confirm that computer system 600 received user input 650l and/or that computer system 600 is adjusting a parameter of the style corresponding to style user interface object 610c.

At FIG. 6K, a position of indicator 617a of slider 617 has moved to the right (e.g., relative to a display orientation of display 602) based on user input 650l. In response to detecting user input 650l, computer system 600 updates an appearance of field of view representation 614a to indicate the change and/or adjustment to the color temperature, as shown by seventh hatching at FIG. 6K. In response to detecting an end of user input 650l, computer system 600 outputs tactile feedback 651j to confirm that computer system 600 detected the end of user input 650l and/or that computer system 600 adjusted the color temperature of the style corresponding to style user interface object 610c.

At FIG. 6K, adjustment of the color temperature of the style corresponding to style user interface object 610c does not change the current values of tone and saturation. In some embodiments, adjustment of the color temperature based on user input directed to slider 617 causes a corresponding change in the current values of tone and saturation that is based on the adjustment of the color temperature. In some such embodiments, computer system 600 updates display of graphical representation 616 to include indicator 616c at a position that is based on the change to the current values of tone and saturation caused by the change in color temperature. In some embodiments, computer system 600 updates an appearance (e.g., a color, a shading, a color temperature, a tone, a saturation, and/or a contrast) of graphical representation 616 based on the change in color temperature.

At FIG. 6K, computer system 600 detects user input 650m corresponding to field of view representation 614a. In response to detecting user input 650m, computer system 600 displays styles user interface 608, as shown at FIG. 6L. While user input 650m corresponds to field of view representation 614a at FIG. 6K, in some embodiments, user input 650m corresponds to a different location of style editing user interface 614 that does not include a location of graphical representation 616 and/or slider 617. In some embodiments, computer system 600 detects a user input requesting display of styles user interface 608 and/or detects a timeout condition and, in response, displays styles user interface 608, as shown in FIG. 6L.

At FIG. 6L, computer system 600 displays styles user interface 608, where field of view representation 608a includes the appearance of field of view representation 614a shown at FIG. 6K, as indicated by the seventh hatching of 608a. Thus, computer system 600 has modified the style corresponding to style user interface object 610c based on the user inputs received and/or detected described above with reference to FIGS. 6F-6K. In addition, computer system 600 displays graphical representation 612 of style user interface object 610c with an appearance that corresponds to graphical representation 616 shown at FIG. 6K. In other words, a position of indicator 612c of graphical representation 612 for style user interface object 610c is at a position relative to first axis 612a and second axis 612b that corresponds to the position of indicator 616c relative to first axis 616a and second axis 616b of graphical representation 616.

At FIG. 6L, computer system 600 detects user input 650n corresponding to style user interface object 610b. In some embodiments, in response to detecting user input 650n, computer system 600 selects style user interface object 610b, de-selects style user interface object 610c, and applies a style corresponding to style user interface object 610b to field of view representation 608a. For instance, in some embodiments, computer system 600 updates display of field of view representation 608a to include an appearance associated with the style of style user interface object 610b and in response to detecting user input 650n, such as shown in FIG. 6D. While FIG. 6L illustrates user input 650n as a tap gesture corresponding to a location of style user interface object 610b, computer system 600 is also optionally configured to select style user interface object 610b in response to user input 6500. At FIG. 6L, user input 6500 corresponds to a right swipe gesture corresponding to style region 610.

At FIG. 6M, computer system 600 has detected user input requesting to display camera user interface 604 and/or to exit an editing mode. For instance, at FIG. 6M, computer system 600 displays camera user interface 604 without displaying styles user interface 608 and/or style region 610. At FIG. 6M, computer system 600 displays field of view representation 604a with an appearance that corresponds to style user interface object 610c. As shown at FIG. 6M, field of view representation 604a includes the seventh hatching, indicating that images and/or videos captured by the camera of computer system 600 will be captured with the style corresponding to style user interface object 610c.

At FIG. 6M, computer system 600 detects user input 650p corresponding to input device 600a (e.g., a physical and/or mechanical button that is distinct from display 602) of computer system 600. In some embodiments, input device 600a includes a capacitive button and/or a capacitive surface that is configured to detect touch inputs, movement of touch inputs, and/or swipe inputs. In response to detecting user input 650p, computer system 600 displays settings menu 618, as shown at FIG. 6N.

At FIG. 6N, computer system 600 displays settings menu 618 overlaid on camera user interface 604. Settings menu 618 includes setting user interface objects 618a-618d. At FIG. 6N, setting user interface object 618b corresponds to the styles in which computer system 600 is configured to apply to images and/or videos. For instance, at FIG. 6N, computer system 600 detects user input 650q (e.g., a tap input and/or a touch input) corresponding to setting user interface object 618b. In response to detecting user input 650q, computer system 600 displays style menu 620, as shown at FIG. 6O.

At FIG. 6O, computer system 600 displays style menu 620 overlaid on camera user interface 604. Style menu 620 includes style indicators 620a-620e corresponding to respective styles for images and/or videos captured via the camera of computer system 600. At FIG. 6O, style indicator 620c is currently selected and applied by computer system 600. For instance, at FIG. 6O, computer system 600 displays field of view representation 604a of camera user interface 604 with the appearance corresponding to the style of style indicator 620c, as represented by seventh hatching of 604a at FIG. 6O. Style menu 620 further includes style indicator 620f, which provides the user of computer system 600 with a visual indication that style menu 620 corresponds to respective styles that can be applied to images and/or videos captured via the camera of computer system 600.

At FIG. 6O, computer system 600 detects user input 650r corresponding to input device 600a of computer system 600. In response to detecting user input 650r, computer system 600 adjusts the style applied to images and/or videos captured via the camera of computer system 600. For example, at FIG. 6P, computer system 600 displays camera user interface 604 with field of view representation 604a including an appearance having eighth hatching.

At FIG. 6P, computer system 600 selects style indicator 620b instead of style indicator 620c, and therefore, displays field of view representation 604a with an appearance that is different from the appearance of field of view representation 604a shown at FIG. 60. Thus, computer system 600 is configured to adjust, modify, and/or change the style applied to images and/or videos captured via the camera of computer system 600 in response to user input detected while displaying style menu 620. In some embodiments, style menu 620 includes less than or greater than five style indicators. In some embodiments, computer system 600 displays additional style indicators on style menu 620 in response to detecting user input corresponding to input device 600a and/or style menu 620.

At FIG. 6P, computer system 600 detects user input 650s (e.g., a tap input and/or a touch input) corresponding to capture user interface object 604b. In response to detecting user input 650s, computer system 600 captures an image and/or video of content that is displayed within field of view representation 604a. In addition, computer system 600 applies the style corresponding to style indicator 620b to the image and/or video captured via the camera of computer system 600 in response to detecting user input 650s. Thus, computer system 600 is configured to apply a selected style to images and/or videos that are captured via the camera of computer system 600 while computer system 600 displays camera user interface 604.

At FIG. 6P, computer system 600 detects user input 650t (e.g., a swipe input and/or a touch input) corresponding to a request to display second camera user interface 621 corresponding to an application that is different from an application of camera user interface 604. In response to detecting user input 650t, computer system 600 displays second camera user interface 621, as shown at FIG. 6Q. Computer system 600 displays second camera user interface 621 and style menu 620 displayed overlaid on second camera user interface 621, as shown at FIG. 6Q. In addition, computer system 600 displays field of view representation 621a of second camera user interface 621 with the appearance corresponding to the style of style indicator 620b. Thus, computer system 600 is configured to apply a selected style to images and/or videos that are captured via the camera of computer system 600 using different types of camera applications. In other words, computer system 600 continues to apply a selected style to images and/or videos that are captured via the camera of computer system 600 regardless of which application of computer system 600 causes the camera of computer system 600 to capture the image and/or video.

At FIG. 6Q, computer system 600 detects user input 650u corresponding to input device 600a. In response to detecting user input 650u, computer system 600 displays second camera user interface 621 and displays field of view representation 621a with an appearance corresponding to a different style, as shown at FIG. 6R.

At FIG. 6R, computer system 600 displays field of view representation 621a with the appearance corresponding to the style of style indicator 620c, as represented by seventh hatching of 621a at FIG. 6Q. Therefore, computer system 600 is configured to change the style applied to images and/or videos that are captured via the camera of computer system 600 in response to detecting user input while displaying style menu 620. At FIG. 6R, computer system 600 detects user input 650v corresponding to capture user interface object 621b. In response to detecting user input 650v, computer system 600 captures an image and/or video of content that is displayed within field of view representation 621a and applies the style of style indicator 620c to the image and/or video. At FIG. 6R, computer system 600 detects user input 650w (e.g., a press input and/or a touch input) corresponding to a request to display a user interface of a different application from the application corresponding to second camera user interface 621. In response to detecting user input 650w, computer system 600 displays photos user interface 622, as shown at FIG. 6S.

At FIG. 6S, computer system displays photos user interface 622, which corresponds to a media library of computer system 600. At FIG. 6S, photos user interface 622 includes photo representation 622a, photo library region 624, and editing user interface object 622b. Photo representation 622a corresponds to a video of the media library of computer system 600. For instance, at FIG. 6S, computer system 600 displays scrubber 622c overlaid on photo representation 622a indicating that the media item corresponding to photo representation 622a is a video media item. In some embodiments, computer system 600 does not display and/or forgoes display of scrubber 622c based on a determination that the media item corresponding to photo representation 622a is not a video media item (e.g., is a photo media item and/or a screenshot media item). At FIG. 6S, photo library region 624 includes media item indicators 624a-624f corresponding to media items stored on and/or otherwise accessible to computer system 600. In some embodiments, in response to detecting user input corresponding to photo library region 624 and/or a respective media item indicator 624a-624f, computer system 600 updates photo representation 622a with an image and/or video of a media item corresponding to the respective media item indicator 624a-624f.

At FIG. 6S, computer system 600 detects user input 650x corresponding to editing user interface object 622b. In response to detecting user input 650x, computer system 600 displays editing user interface 626, as shown at FIG. 6T.

At FIG. 6T, editing user interface 626 corresponds to a user interface for editing a style of the media item of photo representation 622a. In some embodiments, computer system 600 displays editing user interface 626 for editing a different parameter (e.g., an editing parameter other than styles) in response to detecting user input 650x. For example, editing user interface 626 includes style user interface object 627a, live user interface object 627b, adjust user interface object 627c, and crop user interface object 627d. In some embodiments, computer system 600 displays editing user interface 626 for adjusting live images settings, adjusting visual parameters, and/or cropping the media item corresponding to photo representation 622a. In some such embodiments, computer system 600 displays editing user interface 626 for editing the styles of the media item of photo representation 622a in response to detecting user input corresponding to styles user interface object 627a of editing user interface 626.

At FIG. 6T, computer system 600 displays editing user interface 626 with style indicators 626a-626d, which correspond to respective styles that can be applied to the media item of photo representation 622a by computer system 600. In some embodiments, style indicators 626a-626d correspond to the same styles as style user interface objects 610a-610d. Thus, in some embodiments, computer system 600 provides the user of computer system 600 with the same styles that have been customized and/or edited by the user via style editing user interface 614.

As set forth above, the media item corresponding to photo representation 622a shown at FIG. 6T is a video media item. At FIG. 6T, computer system 600 detects user input 650y corresponding to playback user interface object 626e of editing user interface 626. In response to detecting user input 650y, computer system 600 initiates playback of the video media item of photo representation 622a, as shown at FIG. 6U.

At FIG. 6U, computer system 600 has initiated playback of the video media item corresponding to photo representation 622a. For instance, scrubber 622c indicates that playback of the video media item has progressed by two seconds and that 18 seconds remain in the playback of the video media item (e.g., as compared to zero seconds elapsing and 20 seconds remaining shown at FIG. 6T). Computer system 600 is therefore configured to adjust, modify, and/or change the style applied to the video media item corresponding to photo representation 622a while computer system 600 plays back the video media item. For example, at FIG. 6U, computer system 600 detects user input 650z (e.g., a tap input and/or a touch input) corresponding to style indicators 626a-626d. In response to detecting user input 650z, computer system 600 applies a different style to the video media item of photo representation 622a, as shown at FIG. 6V.

At FIG. 6V, computer system 600 displays photo representation 622a of the video media item with an appearance that is different from the appearance of photo representation 622a shown at FIG. 6U. For instance, at FIG. 6V, computer system 600 displays photo representation 622a with ninth hatching, whereas computer system 600 displayed photo representation 622a with no hatching at FIG. 6U. In addition, computer system 600 has continued to play back the video media item corresponding to photo representation 622a, as indicated by scrubber 622c. Scrubber 622c indicates that four seconds of the video media item have elapsed and that 16 second remain in the playback of the video media item. In some embodiments, computer system 600 pauses playback of the video media item in response to detecting user input 650z.

At FIG. 6V, computer system 600 detects user input 650aa corresponding to scrubber 622c. In response to detecting user input 650aa, computer system 600 adjusts, changes, and/or updates a playback time of the video media item corresponding to photo representation 622a. For instance, at FIG. 6W, scrubber 622c indicates that 16 seconds of the video media item have elapsed and that four seconds remain in the playback of the video media item. Therefore, computer system 600 updated the playback time of the video media item to a time corresponding to 16 seconds in response to detecting user input 650aa. In addition, at FIG. 6W, computer system 600 displays photo representation 622a with the style corresponding to style user interface object 626c, as indicated by ninth hatching. Thus, computer system 600 can display different styles applied to the video media item at different playback times.

At FIG. 6W, computer system 600 detects user input 650ab (e.g., a swipe input and/or a touch input) corresponding to photo representation 622a. User input 650ab corresponds to a request to display a different media item of the media library. In response to detecting user input 650ab, computer system 600 displays photo representation 622d corresponding to a second media item of the media library, as shown at FIG. 6X, where the second media item is different from the video media item corresponding to photo representation 622a.

At FIG. 6X, computer system 600 displays photos user interface 622 with photo representation 622d corresponding to the second media item that is different from the video media item corresponding to photo representation 622a. At FIG. 6X, the second media item corresponding to photo representation 622d is a photo media item and/or an image media item (e.g., not a video media item). Computer system 600 displays photo representation 622d as part of editing user interface 626 and applies the standard style to photo representation 622d. Thus, in some embodiments, computer system 600 does not apply the style applied to photo representation 622a to photo representation 622d in response to detecting user input 650ab. In some embodiments, computer system 600 does apply the style applied to photo representation 622a to photo representation 622d in response to detecting user input 650ab (e.g., in response to navigating from a first media item to a second media item of the media library while displaying editing user interface 626).

At FIG. 6X, computer system 600 detects user input 650ac (e.g., a de-pinch gesture and/or a two-finger touch gesture) corresponding to a request to change and/or modify a zoom level of photo representation 622d, while computer system 600 displays editing user interface 626. In addition, computer system 600 detects user input 650ad (e.g., a swipe input and/or a touch gesture) corresponding to a request to change the style applied to photo representation 622d. In response to detecting user input 650ac, computer system 600 zooms, enlarges, and/or magnifies photo representation 622d, as shown at FIG. 6Y. In response to detecting user input 650ad, computer system displays photo representation 622d with an appearance that corresponds to a style of style indicator 626b, as shown by tenth hatching at FIG. 6Y.

At FIG. 6Y, computer system 600 applies the style of style indicator 626b to photo representation 622d and zooms in photo representation 622d based on receiving user inputs 650ac and 650ad. Therefore, computer system 600 is configured to apply a style to photo representation 622d and/or change an appearance of photo representation 622d while photo representation 622d is magnified and/or zoomed. At FIG. 6Y, computer system 600 zooms and/or enlarges photo representation 622d within a frame. In other words, computer system 600 does not display a full screen view of photo representation 622d in response to detecting user input 650ac. Computer system 600 zooms photo representation 622d within the frame, as shown at FIG. 6Y, while computer system 600 displays photo representation 622d on editing user interface 626. As set forth below with reference to FIGS. 8A-8Z, computer system 600 is optionally configured to zoom photo representation 622d so that computer system 600 displays the zoomed in version of photo representation 622d as full screen while computer system 600 does not display editing user interface 626 (e.g., while computer system 600 displays photos user interface 622).

In some embodiments, computer system 600 is configured to enable a user to select a style for capturing an image and/or video via the camera of computer system 600 as part of a set up and/or configuration process of computer system 600. For instance, at FIG. 6Z, computer system 600 displays first configuration user interface 630. First configuration user interface 630 allows a user of computer system 600 to select, set, and/or customize a style to be applied to videos and/or images captured via the camera of computer system 600. First configuration user interface 630 includes information region 630a indicating that first configuration user interface 630 allows a user to customize a style applied to images and/or videos captured via the camera of computer system 600. First configuration user interface 630 also includes customization user interface object 630b and dismiss user interface object 630c.

At FIG. 6Z, computer system 600 detects user input 650ae (e.g., a tap input and/or a touch input) corresponding to dismiss user interface object 630c. In some embodiments, in response to detecting user input 650ae, computer system 600 ceases to display first configuration user interface 630 without setting and/or configuring a style to be applied to images and/or videos captured via the camera of computer system 600. For instance, in some embodiments, computer system 600 replaces display of first configuration user interface 630 with a different user interface (e.g., camera user interface 604 and/or photos user interface 622) in response to detecting user input 650ae.

In some embodiments, at FIG. 6Z, computer system 600 detects user input 650af corresponding to customization user interface object 630b. In response to detecting user input 650af, computer system 600 displays style user interface 632, as shown at FIG. 6AA.

At FIG. 6AA, style user interface 632 is similar to styles user interface 608 and/or editing user interface 626. For instance, style user interface 632 includes style indicators 632a-632d corresponding to different styles that computer system 600 can apply to images and/or videos captured via the camera of computer system 600. At FIG. 6AA, computer system 600 displays photo representation 632f corresponding to a respective image and/or video for which computer system 600 can apply a selected style. As set forth below, in some embodiments, the media item corresponding to photo representation 632f is a stock and/or system-defined photo that enables a user to view how the different styles look when applied to an image. For instance, in some embodiments, computer system 600 displays style user interface 632 before computer system 600 has captured any images and/or videos via the camera of computer system 600. In some embodiments, computer system 600 can apply styles to media items of a first type, but not media items of a second type. Thus, computer system 600 can provide, suggest, and/or otherwise display different images for a user to preview while selecting a respective style to apply to images and/or videos captured via the camera of computer system 600.

At FIG. 6AA, computer system 600 detects user input 650ag corresponding style indicators 632a-632e. In response to detecting user input 650ag, computer system 600 updates the style applied to photo representation 632f, as shown by eleventh hatching of photo representation 632f at FIG. 6AB.

At FIG. 6AB, computer system 600 has applied the updated style to photo representation 632f and updates display of photo representation 632f to include an appearance that is based on the selected style. For instance, at FIG. 6AB, computer system 600 has selected style indicator 632b instead of style indicator 632a (e.g., the style indicator selected at FIG. 6AA) and displays photo representation 632f with an appearance that is based on the style of style indicator 632b. At FIG. 6AB, computer system 600 detects user input 650ah corresponding to a request to display a different media item. In response to detecting user input 650ah, computer system 600 displays photo representation 632g corresponding to a media item that is different from the media item of photo representation 632f, as shown at FIG. 6AC.

At FIG. 6AC, the media item corresponding to photo representation 632g is different from the media item corresponding to photo representation 632f, shown at FIGS. 6AA and 6AB. In some embodiments, computer system 600 includes stock and/or stored media items so that the user of computer system 600 can view how different styles appear on various different media items. For instance, as set forth above, in some embodiments, computer system displays style user interface 632 before computer system 600 has captured, stored, and/or otherwise received images and/or videos that are specific to the user setting up the device. In some embodiments, computer system 600 is configured to apply styles to media items of a first type, but not media items of a second type. As such, computer system 600 includes various media items that a user can transition to and/or navigate through to view how different styles appear on different media items before selecting a style for applying to images and/or videos captured via the camera of computer system.

At FIG. 6AC, photo representation 632g includes the same style that was applied to photo representation 632f, shown at FIG. 6AB. For instance, at FIG. 6AC, computer system displays photo representation 632g with the eleventh hatching to indicate that the style of style indicator 632b is being applied to photo representation 632g. As such, computer system 600 can transition to and/or navigate between different media items while applying a respective style so that the user of computer system 600 can view how the style appears on different media items.

At FIG. 6AC, computer system 600 detects user input 650ai (e.g., a swipe input and/or a touch input) corresponding to a request to change the media item back to the media item of photo representation 632f. In response to detecting user input 650ai, computer system 600 displays style user interface 632 with photo representation 632f, as shown at FIG. 6AD.

At FIG. 6AD, computer system 600 displays photo representation 632f with an appearance based on the selected style (e.g., the style of style indicator 632b). As set forth above, computer system 600 is configured to apply the selected style to different media items so that a user can determine whether to select the respective style.

At FIG. 6AD, computer system 600 detects user input 650aj (e.g., a tap input and/or a touch input) corresponding to confirm user interface object 632h of style user interface 632. In response to detecting user input 650aj, computer system 600 displays customization user interface 634, as shown at FIG. 6AE.

At FIG. 6AE, customization user interface 634 includes style indicator 632b without displaying style indicators 632a and 632c-632e. In addition, computer system 600 displays style indicator 632b at a size that is larger than the size of style indicator 632b displayed at style user interface 632. Style indicator 632b includes graphical representation 636 having first axis 636a, second axis 636b, and indicator 636c. As set forth above, indicator 636c of graphical representation 636 indicates a current value of tone based on a position and/or location of indicator 636c relative to first axis 636a and/or indicates a current value of saturation based on a position and/or location of indicator 636c relative to second axis 636b. Computer system 600 also displays slider 636d on customization user interface 634 to indicate that the user of computer system 600 can customize and/or otherwise modify the style of style indicator 632b.

At FIG. 6AE, computer system 600 detects user input 650ak corresponding to graphical representation 636 and/or style indicator 632b. In response to detecting user input 650ak, computer system 600 displays editing user interface 638, as shown at FIG. 6AF.

At FIG. 6AF, editing user interface 638 includes graphical representation 636 and slider 636d, so that the user of computer system 600 can customize the style based on their preferences. Editing user interface 638 is similar to style editing user interface 614 described above with reference to FIGS. 6F-6K. For instance, in response to detecting user input corresponding to graphical representation 636 and/or slider 636d, computer system 600 is configured to adjust, modify, and/or change one or more parameters of the style of style indicator 632b. In some embodiments, in response to detecting user input corresponding to a request to change a position of indicator 636c relative to first axis 636a, computer system 600 adjusts and/or modifies a current value of tone for the style of style indicator 632b. In some embodiments, in response to detecting user input corresponding to a request to change a position of indicator 636c relative to second axis 636b, computer system 600 adjusts and/or modifies a current value of saturation for the style of style indicator 632b. In some embodiments, in response to detecting user input corresponding to a request to change a position indicator 636c relative to both first axis 636a and second axis 636b, computer system 600 adjusts and/or modifies a current value of both tone and saturation for the style of style indicator 632b. In some embodiments, in response to user input corresponding to slider 636d, computer system 600 adjusts and/or modifies a color temperature of the style of style indicator 632b (and, optionally, adjusts and/or modifies the current values of tone and/or saturation based on the change in color temperature).

At FIG. 6AF, computer system 600 detects user input 650al (e.g., a tap input, a swipe input, and/or a touch input) corresponding to graphical representation 636. In response to detecting user input 650al, computer system 600 adjusts and/or modifies a current value of tone, a current value of saturation, and/or a position of indicator 636c based on a location and/or movement associated with user input 650al. At FIG. 6AF, computer system 600 detects user input 650am (e.g., a tap input and/or a touch input) corresponding to photo representation 632f. In response to detecting user input 650am, computer system 600 displays confirmation user interface 640, as shown at FIG. 6AG.

At FIG. 6AG, computer system 600 displays photo representation 632f on confirmation user interface 640, where photo representation 632f includes an appearance based on the selected style. In other words, photo representation 632f is displayed with a style (e.g., a default style) that computer system 600 is configured to apply to images and/or videos captured via the camera of computer system 600. In some embodiments, computer system 600 displays one or more additional user interfaces that allow the user of computer system 600 to select and/or set different styles for image media items and video media items. In some embodiments, computer system 600 provides additional options for a user to apply different styles to images captured via the camera of computer system 600 and videos captured via the camera of computer system 600.

At FIG. 6AG, computer system 600 detects user input 650an (e.g., a tap input and/or a touch input) corresponding to done user interface object 640a of confirmation user interface 640. In response to detecting user input 650an, computer system 600 sets the selected style as the style (e.g., a default style) to be applied to images and/or videos captured via the camera of computer system 600.

FIGS. 7A-7B are flow diagrams illustrating a method for managing photographic styles using a computer system in accordance with some embodiments. Method 700 is performed at a computer system (e.g., 100, 300, 500, and/or 600) (e.g., a smart phone, a smart watch, a tablet computer, a laptop computer, a desktop computer, a wearable device, and/or head-mounted device) that is in communication with (e.g., includes and/or is connected to) one or more display generation components (e.g., 602) (e.g., one or more displays, touch-screen displays, monitors, holographic display systems, and/or head-mounted display systems) and one or more input devices (e.g., 600a and/or 602) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 700 are, optionally, combined, the orders of some operations are, optionally, changed, and some operations are, optionally, omitted.

As described below, method 700 provides an intuitive way for managing photographic styles. The method reduces the cognitive burden on a user for managing photographic styles, thereby creating a more efficient human-machine interface. For battery-operated computing devices, enabling a user to manage photographic styles faster and more efficiently conserves power and increases the time between battery charges.

Computer system (e.g., 100, 300, 500, and/or 600) displays (702), via the one or more display generation components (e.g., 602), a media editing user interface (e.g., 608, 614, 622, 626, 632, 634, and/or 638) (e.g., a user interface that includes display of one or more media items, one or more control user interface objects for editing, adjusting, modifying, and/or changing one or more visual aspects of a respective media item, and/or one or more user interface objects for adding, removing, repositioning, sharing, bookmarking, deleting, and/or providing a designation to the one or more media items), wherein the media editing user interface (e.g., 608, 614, 622, 626, 632, 634, and/or 638) includes a media editing control user interface object (e.g., 610a-610e, 616, 626a-626e, 632a-632e, and/or 636) (e.g., a button, an affordance, a graphical user interface element, a user selectable icon, and/or a region of the media editing control user interface that is configured to adjust one or more visual parameters and/or visual aspects of one or more media items).

The media editing control user interface object (e.g., 610a-610e, 616, 626a-626e, 632a-632e, and/or 636) includes (704) a two-dimensional region (e.g., 612, 616, and/or 636) (e.g., a region of the media editing user interface, such as a visibly distinct region of the media editing user interface that is separate from one or more media items of the media editing user interface, that includes a first axis and a second axis that are perpendicular to one another to form a two-dimensional shape, such as a square, a rectangle, a rhombus, a diamond, a circle, and/or a two-dimensional polygon) that is configured to concurrently (e.g., at the same time and/or separately) adjust a current value (e.g., as indicated by 614b and/or 614c) of a first parameter of a media item (e.g., 604a, 608a, 614a, 621a, 622a, 622d, 632f, 632g, 804a, 814a, 816a, 818a, 822a, 840a, and/or 844a) (e.g., tone, saturation, color temperature, brightness, opaqueness, and/or contrast) and a current value (e.g., as indicated by 614b and/or 614c) of a second parameter of the media item (e.g., 604a, 608a, 614a, 621a, 622a, 622d, 632f, 632g, 804a, 814a, 816a, 818a, 822a, 840a, and/or 844a) (e.g., tone, saturation, color temperature, brightness, opaqueness, and/or contrast) (in some embodiments, the first parameter and the second parameter are different from one another).

The current value (e.g., as indicated by 614b and/or 614c) of the first parameter of the media item (e.g., 604a, 608a, 614a, 621a, 622a, 622d, 632f, 632g, 804a, 814a, 816a, 818a, 822a, 840a, and/or 844a) is adjusted (706) (e.g., changed, modified, and/or altered) based on user input (e.g., 650g, 650h, 650i, 650j, 650k, and/or 650ak) (e.g., a tap gesture, a swipe gesture, an air gesture, a touch input, a voice command, and/or a button press) that includes a change in position of a parameter index point (e.g., 612a, 616a, and/or 636a) (e.g., based on movement of the input such as movement of a current value indicator that indicates a location of the parameter index point from a first location to a second location, or an input selecting a location that is different from a current location of the current value, such as a location that is different from a current value indicator that indicates a location of the parameter index point) relative to a first axis (e.g., 612a, 612b, 616a, 616b, 636a, and/or 636b) (e.g., a first one-dimensional axis extending in a first direction) of the two-dimensional region (e.g., 612, 616, and/or 636). In some embodiments, the parameter index point is a system-defined and/or user-selected location and/or point within the two-dimension region. In some embodiments, the two-dimensional region (e.g., 612, 616, and/or 636) includes a current value indicator (e.g., 612c, 616c, and/or 636c) that visually indicates a current location of the parameter index point. In some embodiments, the current value indicator (e.g., 612c, 616c, and/or 636c) includes an object, an icon, and/or a graphical user interface element within the two-dimensional region (e.g., 612, 616, and/or 636) that indicates the current value (e.g., as indicated by 614b and/or 614c) (e.g., as indicated by 614b and/or 614c) of the first parameter and/or the current value (e.g., as indicated by 614b and/or 614c) of the second parameter. In some embodiments, the first parameter of the media item (e.g., 604a, 608a, 614a, 621a, 622a, 622d, 632f, 632g, 804a, 814a, 816a, 818a, 822a, 840a, and/or 844a) is not adjusted based on user input that causes a change in position of the parameter index point relative to the second axis (e.g., 612a, 612b, 616a, 616b, 636a, and/or 636b).

The current value (e.g., as indicated by 614b and/or 614c) of the second parameter of the media item (e.g., 604a, 608a, 614a, 621a, 622a, 622d, 632f, 632g, 804a, 814a, 816a, 818a, 822a, 840a, and/or 844a) is adjusted (708) (e.g., changed, modified, and/or altered) based on user input (e.g., 650g, 650h, 650i, 650j, 650k, and/or 650ak) (e.g., a tap gesture, a swipe gesture, an air gesture, a touch input, a voice command, and/or a button press) that includes a change in position of the parameter index point (e.g., 612c, 616c, and/or 636c) (e.g., based on movement of the input such as movement of a current value indicator that indicates a location of the parameter index point from a first location to a second location, or an input selecting a location that is different from a current location of the current value, such as a location that is different from a current value indicator that indicates a location of the parameter index point) relative to a second axis (e.g., 612a, 612b, 616a, 616b, 636a, and/or 636b) (e.g., a second one-dimensional axis extending in a second direction, different from the first direction) of the two-dimensional region (e.g., 612, 616, and/or 636) that is perpendicular to the first axis (e.g., 612a, 612b, 616a, 616b, 636a, and/or 636b) of the two-dimensional region (e.g., 612, 616, and/or 636) (e.g., the first axis extends in a first direction and the second axis extends in a second direction that is different from the first direction and a point of intersection between the first axis and the second axis forms a right angle, such as a 90 degree angle, between the first axis and the second axis). In some embodiments, the second parameter of the media item (e.g., 604a, 608a, 614a, 621a, 622a, 622d, 632f, 632g, 804a, 814a, 816a, 818a, 822a, 840a, and/or 844a) is not adjusted based on user input that causes a change in position of the parameter index point relative to the first axis (e.g., 612a, 612b, 616a, 616b, 636a, and/or 636b).

While displaying the media editing user interface (e.g., 608, 614, 622, 626, 632, 634, and/or 638), the computer system (e.g., 100, 300, 500, and/or 600) detects (710), via the one or more input devices, user input (e.g., 650g, 650h, 650i, 650j, 650k, and/or 650ak) (e.g., a tap gesture, a swipe gesture, a touch gesture, an air gesture, a button press, and/or a voice command) corresponding to (e.g., corresponding to selection of) the media editing control user interface object (e.g., 610a-610e, 616, 626a-626e, 632a-632e, and/or 636).

In response to detecting the user input (e.g., 650g, 650h, 650i, 650j, 650k, and/or 650ak) corresponding to the media editing control user interface object (712) (e.g., 610a-610e, 616, 626a-626e, 632a-632e, and/or 636) and in accordance with a determination that the user input (e.g., 650g, 650h, 650i, 650j, 650k, and/or 650ak) includes a change in position of the parameter index point (e.g., 612c, 616c, and/or 636c) relative to the first axis (e.g., 612a, 612b, 616a, 616b, 636a, and/or 636b) of the media editing control user interface object (e.g., 610a-610e, 616, 626a-626e, 632a-632e, and/or 636), the computer system (e.g., 100, 300, 500, and/or 600) adjusts (714) (e.g., modifying, changing, altering, and/or editing) the first parameter of the media item (e.g., 604a, 608a, 614a, 621a, 622a, 622d, 632f, 632g, 804a, 814a, 816a, 818a, 822a, 840a, and/or 844a) based on a magnitude (e.g., a distance and/or speed) of the change in position of the parameter index point (e.g., 612c, 616c, and/or 636c) relative to the first axis (e.g., 612a, 612b, 616a, 616b, 636a, and/or 636b).

In response to detecting the user input (e.g., 650g, 650h, 650i, 650j, 650k, and/or 650ak) corresponding to the media editing control user interface object (712) (e.g., 610a-610e, 616, 626a-626e, 632a-632e, and/or 636) and in accordance with a determination that the user input (e.g., 650g, 650h, 650i, 650j, 650k, and/or 650ak) includes a change in position of the parameter index point (e.g., 612c, 616c, and/or 636c) relative to the second axis (e.g., 612a, 612b, 616a, 616b, 636a, and/or 636b) of the media editing control user interface object (e.g., 610a-610e, 616, 626a-626e, 632a-632e, and/or 636), the computer system (e.g., 100, 300, 500, and/or 600) adjusts (716) (e.g., modifying, changing, altering, and/or editing) the second parameter of the media item (e.g., 604a, 608a, 614a, 621a, 622a, 622d, 632f, 632g, 804a, 814a, 816a, 818a, 822a, 840a, and/or 844a) based on a magnitude (e.g., distance and/or speed) of the change in position of the parameter index point (e.g., 612c, 616c, and/or 636c) relative to the second axis (e.g., 612a, 612b, 616a, 616b, 636a, and/or 636b).

In some embodiments, in accordance with a determination that the user input includes a change in position of the parameter index point (e.g., 612c, 616c, and/or 636c) relative to the first axis (e.g., 612a, 612b, 616a, 616b, 636a, and/or 636b) and relative to the second axis (e.g., 612a, 612b, 616a, 616b, 636a, and/or 636b), the computer system (e.g., 100, 300, 500, and/or 600) concurrently adjusts the first parameter of the media item (e.g., 604a, 608a, 614a, 621a, 622a, 622d, 632f, 632g, 804a, 814a, 816a, 818a, 822a, 840a, and/or 844a) based on a magnitude of the change in position of the parameter index point (e.g., 612c, 616c, and/or 636c) relative to the first axis (e.g., 612a, 612b, 616a, 616b, 636a, and/or 636b) and adjusts the second parameter of the media item (e.g., 604a, 608a, 614a, 621a, 622a, 622d, 632f, 632g, 804a, 814a, 816a, 818a, 822a, 840a, and/or 844a) based on a magnitude of the change in position of the parameter index point (e.g., 612c, 616c, and/or 636c) relative to the second axis (e.g., 612a, 612b, 616a, 616b, 636a, and/or 636b).

Adjusting the first parameter of the media item based on the magnitude of the change in position of the parameter index point relative to the first axis and/or adjusting the second parameter of the media item based on the magnitude of the change in position of the parameter index point relative to the second axis enables the computer system to adjust one or both of the first parameter and the second parameter in response to detecting user input corresponding to the media editing control user interface object without requiring the user to provide additional user inputs and/or without requiring the computer system to display additional control options, thereby reducing the number of inputs needed to perform an operation and/or providing additional control options without cluttering the user interface with additional displayed controls.

In some embodiments, in response to detecting the user input (e.g., 650g, 650h, 650i, 650j, 650k, and/or 650ak) corresponding to the media editing control user interface object (e.g., 610a-610e, 616, 626a-626e, 632a-632e, and/or 636) and in accordance with a determination that the user input (e.g., 650g, 650h, 650i, 650j, 650k, and/or 650ak) includes a change in position of the parameter index point (e.g., 612c, 616c, and/or 636c) relative to both the first axis (e.g., 612a, 612b, 616a, 616b, 636a, and/or 636b) of the media editing control user interface object (e.g., 610a-610e, 616, 626a-626e, 632a-632e, and/or 636) and the second axis (e.g., 612a, 612b, 616a, 616b, 636a, and/or 636b) of the media editing control user interface object (e.g., 610a-610e, 616, 626a-626e, 632a-632e, and/or 636) (e.g., the computer system detects a concurrent change in the position of the parameter index point relative to the first axis and the second axis), the computer system (e.g., 100, 300, 500, and/or 600) adjusts (e.g., modifying, changing, altering, and/or editing) the first parameter of the media item (e.g., 604a, 608a, 614a, 621a, 622a, 622d, 632f, 632g, 804a, 814a, 816a, 818a, 822a, 840a, and/or 844a) based on a magnitude (e.g., distance and/or speed) of the change in position of the parameter index point (e.g., 612c, 616c, and/or 636c) relative to the first axis (e.g., 612a, 612b, 616a, 616b, 636a, and/or 636b) and the computer system (e.g., 100, 300, 500, and/or 600) adjusts (e.g., modifying, changing, altering, and/or editing) the second parameter of the media item (e.g., 604a, 608a, 614a, 621a, 622a, 622d, 632f, 632g, 804a, 814a, 816a, 818a, 822a, 840a, and/or 844a) based on a magnitude (e.g., distance and/or speed) of the change in position of the parameter index point (e.g., 612c, 616c, and/or 636c) relative to the second axis (e.g., 612a, 612b, 616a, 616b, 636a, and/or 636b). In some embodiments, the computer system (e.g., 100, 300, 500, and/or 600) concurrently adjusts the first parameter and the second parameter in accordance with the determination that the user input includes the change in the position of the parameter index point (e.g., 612c, 616c, and/or 636c) relative to both the first axis (e.g., 612a, 612b, 616a, 616b, 636a, and/or 636b) and the second axis (e.g., 612a, 612b, 616a, 616b, 636a, and/or 636b). In some embodiments, the computer system (e.g., 100, 300, 500, and/or 600) sequentially adjusts the first parameter and the second parameter in accordance with the determination that the user input includes the change in the position of the parameter index point (e.g., 612c, 616c, and/or 636c) relative to both the first axis (e.g., 612a, 612b, 616a, 616b, 636a, and/or 636b) and the second axis (e.g., 612a, 612b, 616a, 616b, 636a, and/or 636b). Adjusting the first parameter of the media item based on the magnitude of the change in position of the parameter index point relative to the first axis and adjusting the second parameter of the media item based on the magnitude of the change in position of the parameter index point relative to the second axis enables the computer system to adjust both the first parameter and the second parameter in response to detecting user input corresponding to the media editing control user interface object without requiring the user to provide additional user inputs and/or without requiring the computer system to display additional control options, thereby reducing the number of inputs needed to perform an operation and/or providing additional control options without cluttering the user interface with additional displayed controls.

In some embodiments, the computer system (e.g., 100, 300, 500, and/or 600) displays (e.g., concurrently with the media editing control user interface object), via the one or more display generation components and as part of the media editing user interface (e.g., 608, 614, 622, 626, 632, 634, and/or 638), a selectable control user interface object (e.g., 617 and/or 636d) (e.g., a slider, a button, an affordance, and/or an adjustable user interface element) that is configured to adjust (e.g., change and/or modify) a current value (e.g., as indicated by 614b and/or 614c) of a third parameter of the media item (e.g., 604a, 608a, 614a, 621a, 622a, 622d, 632f, 632g, 804a, 814a, 816a, 818a, 822a, 840a, and/or 844a) (e.g., tone, saturation, color temperature, brightness, opaqueness, and/or contrast), wherein the selectable control user interface object (e.g., 617 and/or 636d) is visually distinct from the media editing control user interface object (e.g., 610a-610e, 616, 626a-626e, 632a-632e, and/or 636) (e.g., the selectable control user interface object is located at a first position of the media editing user interface and the media editing control user interface object is located at the second position of the media editing user interface, where the first location and the second location are different from one another, do not overlap with one another, and/or are separate from one another), and wherein the third parameter is different from the first parameter and the second parameter. Displaying a selectable control user interface object that is configured to adjust a current value of a third parameter of the media item allows a user of the computer system to adjust multiple different parameters of the media item without having to navigate to a different user interface and/or otherwise provide additional user inputs, thereby reducing the number of inputs needed to perform an operation.

In some embodiments, the computer system (e.g., 100, 300, 500, and/or 600) detects, via the one or more input devices, user input (e.g., 650l) (e.g., a tap gesture, a swipe gesture, an air gesture, a touch input, a voice command, and/or a button press) corresponding to (e.g., directed toward or directed to) the selectable control user interface object (e.g., 617 and/or 636d). In response to detecting the user input (e.g., 650l) corresponding to the selectable control user interface object (e.g., 617 and/or 636d), the computer system (e.g., 100, 300, 500, and/or 600) adjusts the current value (e.g., as indicated by 614b and/or 614c) of the third parameter of the media item (e.g., 604a, 608a, 614a, 621a, 622a, 622d, 632f, 632g, 804a, 814a, 816a, 818a, 822a, 840a, and/or 844a) (e.g., adjusting and/or changing the current value of the third parameter and/or adjusting and/or changing the current value of the third parameter based on a magnitude, such as a distance and/or speed, of a change in position of the selectable control user interface object) and the computer system (e.g., 100, 300, 500, and/or 600) adjusts an appearance (e.g., a displayed position and/or location of the parameter index point relative to the first axis and/or the second axis, a color, a contrast, a brightness, a tone, and/or a saturation) of the two-dimensional region (e.g., 612, 616, and/or 636) of the media editing control user interface object (e.g., 610a-610e, 616, 626a-626e, 632a-632e, and/or 636). Adjusting the appearance of the two-dimensional region of the media editing control user interface in response to detecting the user input corresponding to the selectable control user interface object provides visual confirmation that the user input corresponding to the selectable user interface object was received and/or provides visual feedback to the user of the computer system that the user input corresponding to the selectable control user interface object adjusts the first parameter of the media item and/or the second parameter of the media item (e.g., in addition to adjusting the third parameter of the media item), thereby providing improved visual feedback to the user.

In some embodiments, in response to detecting the user input (e.g., 650g, 650h, 650i, 650j, 650k, and/or 650ak) corresponding to the media editing control user interface object (e.g., 610a-610e, 616, 626a-626e, 632a-632e, and/or 636), the computer system (e.g., 100, 300, 500, and/or 600) adjusts values (e.g., as indicated by 614b and/or 614c) of one or more parameters of the media item (e.g., 604a, 608a, 614a, 621a, 622a, 622d, 632f, 632g, 804a, 814a, 816a, 818a, 822a, 840a, and/or 844a) based on a magnitude (e.g., a distance and/or speed) of the change in position of the parameter index point (e.g., 612c, 616c, and/or 636c) without adjusting the current value (e.g., as indicated by 614b and/or 614c) of the third parameter of the media item (e.g., 604a, 608a, 614a, 621a, 622a, 622d, 632f, 632g, 804a, 814a, 816a, 818a, 822a, 840a, and/or 844a) (e.g., maintaining the current value of the third parameter of the media item and/or not changing and/or modifying the current value of the third parameter of the media item in response to detecting the user input corresponding to the media editing control user interface object) and the computer system (e.g., 100, 300, 500, and/or 600) adjusts values (e.g., as indicated by 614b and/or 614c) of one or more parameters of the media item (e.g., 604a, 608a, 614a, 621a, 622a, 622d, 632f, 632g, 804a, 814a, 816a, 818a, 822a, 840a, and/or 844a) based on a magnitude (e.g., a distance and/or speed) of the change in position of the parameter index point (e.g., 612c, 616c, and/or 636c) without adjusting an appearance of the selectable control user interface object (e.g., 617 and/or 636d) (e.g., maintaining the appearance of the selectable control user interface object and/or not changing the appearance of the selectable control user interface object in response to detecting the user input corresponding to the media editing control user interface object). Forgoing adjusting the current value of the third parameter of the media item and forgoing adjusting the appearance of the selectable control user interface object provides visual feedback to the user that the user input corresponding to the media editing control user interface object does not cause the computer system to adjust the current value of the third parameter of the media item, thereby providing improved visual feedback to the user.

In some embodiments, the computer system (e.g., 100, 300, 500, and/or 600) detects, via the one or more input devices, user input (e.g., 650l) (e.g., a tap gesture, a swipe gesture, an air gesture, a touch input, a voice command, and/or a button press) corresponding to (e.g., directed toward or directed to) the selectable control user interface object (e.g., 617 and/or 636d). In response to detecting the user input (e.g., 650l) corresponding to the selectable control user interface object (e.g., 617 and/or 636d), the computer system (e.g., 100, 300, 500, and/or 600) outputs (e.g., via a tactile and/or haptic output device) tactile (e.g., haptic) feedback (e.g., 651i) corresponding to the input (e.g., 650l) directed to the selectable control user interface object (e.g., 617 and/or 636d). Outputting tactile feedback in response to detecting the user input corresponding to the selectable control user interface object provides improved feedback and/or confirmation to the user that the user input corresponding to the selectable control user interface object was detected by the computer system, thereby providing improved feedback to the user.

In some embodiments, the first parameter and the second parameter are selected from the group consisting of: tone (e.g., an amount and/or value of brightness and/or contrast), saturation (e.g., an amount and/or value of clarity, depth, and/or intensity of color), and color temperature (e.g., an amount and/or value of warmth and/or coolness of colors and/or light). The first parameter and the second parameter being selected from the group consisting of: tone, saturation, and color temperature enables the computer system to adjust one or more of tone, saturation, and color temperature of the media item in response to detecting user input corresponding to the media editing control user interface object without requiring the user to provide additional user inputs and/or without requiring the computer system to display additional control options, thereby reducing the number of inputs needed to perform an operation and/or providing additional control options without cluttering the user interface with additional displayed controls.

In some embodiments, displaying the media editing user interface (e.g., 608, 614, 622, 626, 632, 634, and/or 638) includes the computer system (e.g., 100, 300, 500, and/or 600) concurrently displaying, via the one or more display generation components, the media item (e.g., 604a, 608a, 614a, 621a, 622a, 622d, 632f, 632g, 804a, 814a, 816a, 818a, 822a, 840a, and/or 844a) and the media editing control user interface object (e.g., 610a-610e, 616, 626a-626e, 632a-632e, and/or 636) (e.g., the computer system displays the media item and the media editing control user interface object at the same time). In some embodiments, the media editing user interface (e.g., 608, 614, 622, 626, 632, 634, and/or 638) includes a visual representation of the media item (e.g., 604a, 608a, 614a, 621a, 622a, 622d, 632f, 632g, 804a, 814a, 816a, 818a, 822a, 840a, and/or 844a) (e.g., displays an image and/or a frame of a video). Concurrently displaying the media item and the media editing control user interface object allows the user to view changes in appearance to the media item based on adjustments to the first parameter and/or the second parameter of the media item, thereby providing improved visual feedback to the user.

In some embodiments, in response to detecting the user input (e.g., 650g, 650h, 650i, 650j, 650k, and/or 650ak) corresponding to the media editing control user interface object (e.g., 610a-610e, 616, 626a-626e, 632a-632e, and/or 636), the computer system (e.g., 100, 300, 500, and/or 600) adjusts an appearance (e.g., a level of tone, a level of saturation, and/or a level of color temperature) of the media item (e.g., 604a, 608a, 614a, 621a, 622a, 622d, 632f, 632g, 804a, 814a, 816a, 818a, 822a, 840a, and/or 844a) based on the change in position of the parameter index point (e.g., 612c, 616c, and/or 636c) (e.g., based on a change in position of the parameter index point relative to the first axis and/or the second axis). In some embodiments, adjusting a respective parameter (e.g., first, second, and/or third parameter) of the media item (e.g., 604a, 608a, 614a, 621a, 622a, 622d, 632f, 632g, 804a, 814a, 816a, 818a, 822a, 840a, and/or 844a) causes a corresponding change to the visual appearance of the media item (e.g., 604a, 608a, 614a, 621a, 622a, 622d, 632f, 632g, 804a, 814a, 816a, 818a, 822a, 840a, and/or 844a) being displayed. In some embodiments, the computer system (e.g., 100, 300, 500, and/or 600) adjusts the appearance of the media item (e.g., 604a, 608a, 614a, 621a, 622a, 622d, 632f, 632g, 804a, 814a, 816a, 818a, 822a, 840a, and/or 844a) based on a magnitude (e.g., distance and/or speed) and/or direction of the user input corresponding to the media editing control user interface object (e.g., 610a-610e, 616, 626a-626e, 632a-632e, and/or 636). Adjusting the appearance of the media item based on the change in position of the parameter index point in response to detecting the user input corresponding to the media editing control user interface object allows the user to view changes in appearance to the media item based on adjustments to the first parameter and/or the second parameter of the media item, thereby providing improved visual feedback to the user.

In some embodiments, in response to detecting user input (e.g., 650g, 650h, 650i, 650j, 650k, and/or 650ak) (e.g., first detecting user contact and/or touch) corresponding to (e.g., directed toward or directed to) the two-dimensional region (e.g., 612, 616, and/or 636) of the media editing control user interface object (e.g., 610a-610e, 616, 626a-626e, 632a-632e, and/or 636), the computer system (e.g., 100, 300, 500, and/or 600) outputs (e.g., via a tactile and/or haptic output device) tactile (e.g., haptic) feedback (e.g., 651a, 651c, and/or 651e) corresponding to an input (e.g., 650g, 650h, 650i, 650j, 650k, and/or 650ak) directed to the two-dimensional region (e.g., 612, 616, and/or 636). In some embodiments, the user input (e.g., 650g, 650h, 650i, 650j, 650k, and/or 650ak) corresponding to the two-dimensional region (e.g., 612, 616, and/or 636) of the media editing control user interface object (e.g., 610a-610e, 616, 626a-626e, 632a-632e, and/or 636) is a touch input (e.g., a tap input, a double-tap input, and/or a tap-and-drag input) detected via a touch-sensitive surface (e.g., 602). In some embodiments, in response to detecting the user input (e.g., 650g, 650h, 650i, 650j, 650k, and/or 650ak) corresponding to the two-dimensional region (e.g., 612, 616, and/or 636) of the media editing control user interface object (e.g., 610a-610e, 616, 626a-626e, 632a-632e, and/or 636), the computer system (e.g., 100, 300, 500, and/or 600) adjusts the respective parameter (e.g., first and/or second parameter) of the media item (e.g., 604a, 608a, 614a, 621a, 622a, 622d, 632f, 632g, 804a, 814a, 816a, 818a, 822a, 840a, and/or 844a) based on a location and/or movement of the user input (e.g., 650g, 650h, 650i, 650j, 650k, and/or 650ak) corresponding to the two-dimensional region (e.g., 612, 616, and/or 636) of the media editing control user interface object (e.g., 610a-610e, 616, 626a-626e, 632a-632e, and/or 636). Outputting tactile feedback in response to detecting user input corresponding to the two-dimension region of the media editing control user interface object provides feedback and/or confirmation that the user input corresponding to the two-dimensional region of the media editing control user interface object was detected by the computer system, thereby providing improved feedback to the user.

In some embodiments, in response to detecting the user input (e.g., 650g, 650h, 650i, 650j, 650k, and/or 650ak) corresponding to the two-dimensional region (e.g., 612, 616, and/or 636) of the media editing control user interface object (e.g., 610a-610e, 616, 626a-626e, 632a-632e, and/or 636) and in accordance with a determination that the user input (e.g., 650g, 650h, 650i, 650j, 650k, and/or 650ak) corresponds to (e.g., causes and/or results in) a change in position of the parameter index point (e.g., 612c, 616c, and/or 636c) (e.g., movement of contact of the user input while maintaining contact of the user) across (e.g., movement from a first position on a first side of a respective portion to a second position of on a second side of the respective portion) a respective portion (e.g., a center line of graphical representation 612, 616, and/or 636 defined by axis 612a, 612b, 616a, 616b, 636a, and/or 636b) of the two-dimensional region (e.g., 612, 616, and/or 636) (e.g., a first center line of the two-dimensional region along the first axis and/or a second center line of the two-dimensional region along the second axis) of the media editing control user interface object (e.g., 610a-610e, 616, 626a-626e, 632a-632e, and/or 636), the computer system (e.g., 100, 300, 500, and/or 600) outputs (e.g., via a tactile and/or haptic output device) tactile (e.g., haptic) feedback (e.g., 651f and/or 651g) corresponding to an input (e.g., 650g, 650h, 650i, 650j, 650k, and/or 650ak) directed to the two-dimensional region (e.g., 612, 616, and/or 636) of the media editing control user interface object (e.g., 610a-610e, 616, 626a-626e, 632a-632e, and/or 636). Outputting tactile feedback in accordance with a determination that the user input includes a change in position of the parameter index point across a respective portion of the two-dimensional region and provides feedback to the user about a magnitude and/or an amount of change in the position of the parameter index point, thereby providing improved feedback to the user.

In some embodiments, in response to detecting an end of the user input (e.g., 650g, 650h, 650i, 650j, 650k, and/or 650ak) corresponding to the media editing control user interface object (e.g., 610a-610e, 616, 626a-626e, 632a-632e, and/or 636) (e.g., the computer system detects, via the one or more input devices, a lift-off of contact of the user input, such as touch input detected by a touch-sensitive surface), the computer system (e.g., 100, 300, 500, and/or 600) outputs (e.g., via a tactile and/or haptic output device) tactile (e.g., haptic) feedback (e.g., 651b, 651d, and/or 651h) corresponding to an end of input (e.g., 650g, 650h, 650i, 650j, 650k, and/or 650ak) being directed to the media editing control user interface object (e.g., 610a-610e, 616, 626a-626e, 632a-632e, and/or 636). Outputting tactile feedback in response to detecting the end of the user input corresponding to the media editing control user interface object provides feedback and/or confirmation to the user that the user input corresponding to the media editing control user interface object ended and/or notifies the user that the computer system no longer detects the user input if the user inadvertently ended the user input, thereby providing improved feedback to the user.

In some embodiments, prior to (e.g., before) detecting the user input (e.g., 650g, 650h, 650i, 650j, 650k, and/or 650ak) corresponding to the media editing control user interface object (e.g., 610a-610e, 616, 626a-626e, 632a-632e, and/or 636), the computer system (e.g., 100, 300, 500, and/or 600) displays, via the one or more display generation components, a graphical indication (e.g., 610a-610e, 616, 626a-626e, 632a-632e, and/or 636) (e.g., an image, an object, and/or a graphical user element that includes a grid, a chart, and/or a graph having a two-dimensional region defined by two perpendicular axes) of a current value (e.g., as indicated by 614b and/or 614c) of the first parameter and a current value (e.g., as indicated by 614b and/or 614c) of the second parameter (e.g., the current value of the first parameter and the current value of the second parameter are displayed as a point and/or object on the graphical indication). In some embodiments, the graphical indication (e.g., 610a-610e, 616, 626a-626e, 632a-632e, and/or 636) of the values (e.g., as indicated by 614b and/or 614c) of the first parameter and the second parameter includes a visual element (e.g., 612c, 616c, and/or 636c) (e.g., a point and or an object) that has a location that is based on the current values (e.g., as indicated by 614b and/or 614c) of the first parameter and the second parameter. Displaying the graphical indication of the current value of the first parameter and the current value of the second parameter prior to detecting the user input corresponding to the media editing control user interface object allows a user to view an indication of the current values of the first parameter and the second parameter before determining whether to adjust a respective current value of the first parameter and/or the second parameter, thereby providing improved visual feedback to the user.

In some embodiments, displaying the media editing user interface (e.g., 608, 614, 622, 626, 632, 634, 638, 1702, and/or 1724) includes displaying (e.g., concurrently with and/or separately from the media editing control user interface object), via the one or more display generation components (e.g., 602), a camera shutter user interface object (e.g., 604b and/or 1702a) (e.g., a button, an affordance, a graphical user interface element, and/or a user selectable icon that, when selected via user input, initiates a process for capturing an image, a video, and/or audio via a camera that is in communication with the computer system). In some embodiments, the camera shutter user interface object is displayed while the computer system detects the user input corresponding to the media editing control user interface object. In some embodiments, while displaying the camera shutter user interface object, the computer system detects user input corresponding to selection of the camera shutter user interface object; and in response to detecting the user input corresponding to selection of the camera shutter user interface object, the computer system captures a media item (e.g., an image, a video, and/or audio via a camera and/or microphone that is in communication with the computer system). Displaying the camera shutter user interface object on the media editing user interface allows a user to capture a media item while editing one or more visual parameters to apply to a respective media item without requiring the user to navigate to another user interface, thereby reducing the number of inputs needed to perform an operation.

In some embodiments, displaying the media editing user interface (e.g., 608, 614, 622, 626, 632, 634, 638, 1702, and/or 1724) includes displaying (e.g., concurrently with and/or separately from the media editing control user interface object), via the one or more display generation components (e.g., 602), a close user interface object (e.g., 1702b) (e.g., a button, an affordance, a graphical user interface element, and/or a user selectable icon that, when selected via user input, causes the computer system to display a user interface that was displayed prior to displaying the media editing user interface, cease displaying the media editing user interface, and/or cease displaying the media editing control user interface object). In some embodiments, the closer user interface object is displayed while the computer system detects the user input corresponding to the media editing control user interface object. In some embodiments, while displaying the close user interface object (e.g., 1702b), the computer system (e.g., 100, 300, 500, and/or 600), via the one or more input devices (e.g., 602), an input (e.g., input selecting 1702b) (e.g., a tap gesture, a swipe gesture, a touch gesture, an air gesture, a button press, and/or a voice command) corresponding to selection of the close user interface object (e.g., 1702b); and in response to detecting the input (e.g., input selecting 1702b) corresponding to selection of the close user interface object (e.g., 1702b), the computer system (e.g., 100, 300, 500, and/or 600) ceases display of the media editing user interface (e.g., 608, 614, 622, 626, 632, 634, 638, 1702, and/or 1724) (e.g., replacing display of the media editing user interface with a different user interface, such as a user interface that was displayed prior to display of the media editing user interface). Displaying the close interface object allows a user to quickly navigate from the media editing user interface to another user interface, thereby reducing the number of inputs needed to perform an operation.

In some embodiments, while displaying the graphical indication (e.g., 610a-610e, 616, 626a-626e, 632a-632e, and/or 636) of the current value (e.g., as indicated by 614b and/or 614c) of the first parameter and the current value (e.g., as indicated by 614b and/or 614c) of the second parameter, wherein the media editing control user interface object (e.g., 610a-610e, 616, 626a-626e, 632a-632e, and/or 636) is in a disabled state (e.g., the state at FIGS. 6C-6E, 6L, 6T-6Y, and/or 6AA-6AD) (e.g., a state in which the computer system is not configured and/or enabled to adjust a position of the parameter index point of the media editing control user interface object to adjust the current value of the first parameter of the media item and the current value of the second parameter of the media item) while displaying the graphical indication (e.g., 610a-610e, 616, 626a-626e, 632a-632e, and/or 636) of the current value (e.g., as indicated by 614b and/or 614c) of the first parameter and the current value (e.g., as indicated by 614b and/or 614c) of the second parameter, the computer system (e.g., 100, 300, 500, and/or 600) detects, user input (e.g., 650f, 650aj, and/or 650ak) (e.g., a tap gesture, a swipe gesture, an air gesture, a touch input, a voice command, and/or a button press) corresponding to (e.g., directed toward or directed to) the graphical indication (e.g., 610a-610e, 616, 626a-626e, 632a-632e, and/or 636). In response to detecting the user input (e.g., 650f, 650aj, and/or 650ak) corresponding to the graphical indication (e.g., 610a-610e, 616, 626a-626e, 632a-632e, and/or 636), the computer system (e.g., 100, 300, 500, and/or 600) transitions (e.g., changing, modifying, adjusting, and/or configuring) the media editing control user interface object (e.g., 610a-610e, 616, 626a-626e, 632a-632e, and/or 636) from the disabled state (e.g., the state shown at FIGS. 6C-6E, 6L, 6T-6Y, and/or 6AA-6AD) to an active state (e.g., the state shown at FIGS. 6F-6K, 6AE, and/or 6AF) (e.g., a state in which the computer system is configured and/or enabled to adjust a position of the parameter index point of the media editing control user interface object to adjust the current value of the first parameter of the media item and the current value of the second parameter of the media item), wherein the media editing control user interface object (e.g., 610a-610e, 616, 626a-626e, 632a-632e, and/or 636) is not configured to concurrently adjust the current value (e.g., as indicated by 614b and/or 614c) of the first parameter and the current value (e.g., as indicated by 614b and/or 614c) of the second parameter while in the disabled state (e.g., the state shown at FIGS. 6C-6E, 6L, 6T-6Y, and/or 6AA-6AD) (e.g., in response to detecting user inputs directed to the media editing control user interface object while the media editing control user interface object is in the disabled state, the computer system forgoes and/or does not adjust the current value of the first parameter and the current value of the second parameter). In some embodiments, the media editing control user interface object (e.g., 610a-610e, 616, 626a-626e, 632a-632e, and/or 636) is configured to concurrently adjust the current value (e.g., as indicated by 614b and/or 614c) of the first parameter and the current value (e.g., as indicated by 614b and/or 614c) of the second parameter while in the active state. Transitioning the media editing control user interface object from the disabled state to the active state in response to detecting the user input corresponding to the graphical indication allows a user to quickly and efficiently adjust a respective current value of the first parameter or the second parameter without the computer system displaying additional user interface objects and/or without requiring the user to navigate to another user interface, thereby reducing the number of inputs needed to perform an operation and/or providing additional control options without cluttering the user interface with additional displayed controls.

In some embodiments, while the media editing control user interface object (e.g., 610a-610e, 616, 626a-626e, 632a-632e, and/or 636) is in the disabled state (e.g., the state shown at FIGS. 6C-6E, 6L, 6T-6Y, and/or 6AA-6AD), the computer system (e.g., 100, 300, 500, and/or 600) displays, via the one or more display generation components, a camera shutter object (e.g., 604b, 608b, and/or 621b) (e.g., a button, an affordance, a graphical user interface element, and/or a user selectable icon that, when selected via user input, initiates a process for capturing an image, a video, and/or audio via a camera that is in communication with the computer system).

While the media editing control user interface object (e.g., 610a-610e, 616, 626a-626e, 632a-632e, and/or 636) is in the active state (e.g., the state shown at FIGS. 6F-6K, 6AE, and/or 6AF), the computer system (e.g., 100, 300, 500, and/or 600) forgoes display of the camera shutter object (e.g., 604b, 608b, and/or 621b) (e.g., not displaying and/or removing display of the camera user interface object). Displaying the camera shutter object while the media editing control user interface object is in the disabled state and forgoing display of the camera shutter object while the media editing control user interface object is in the active state provides feedback to the user about the current state of the media editing control user interface and/or whether user input corresponding to the media editing control user interface object causes adjustments to the first parameter and/or the second parameter, thereby providing improved visual feedback to the user.

In some embodiments, while displaying the graphical indication (e.g., 610a-610e, 616, 626a-626e, 632a-632e, and/or 636) of the current value (e.g., as indicated by 614b and/or 614c) of the first parameter and the current value (e.g., as indicated by 614b and/or 614c) of the second parameter, the computer system (e.g., 100, 300, 500, and/or 600) detects, via the one or more input devices, user input (e.g., 650d, 650e, 650z, 650ad, and/or 650ag) (e.g., a tap gesture, a swipe gesture, an air gesture, a touch input, a voice command, and/or a button press) corresponding to (e.g., directed toward or directed to) the media editing user interface (e.g., 608, 614, 622, 626, 632, 634, and/or 638) (e.g., user input directed to the media editing user interface, a user interface object of the media editing user interface, and/or a second graphical indication of a respective value of the first parameter and a respective value of the second parameter of the media editing user interface). In response to detecting the user input (e.g., 650d, 650e, 650z, 650ad, and/or 650ag) corresponding to the media editing user interface (e.g., 608, 614, 622, 626, 632, 634, and/or 638), the computer system (e.g., 100, 300, 500, and/or 600) displays, via the one or more display generation components, a second graphical indication (e.g., 610a-610e, 616, 626a-626e, 632a-632e, and/or 636) (e.g., an image, an object, and/or a graphical user element that includes a grid, a chart, and/or a graph having a two-dimensional region defined by two perpendicular axes) of an updated parameter value (e.g., as indicated by 614b and/or 614c) of the first parameter and an updated parameter value (e.g., as indicated by 614b and/or 614c) of the second parameter (e.g., the updated parameter value of the first parameter and the updated parameter value of the second parameter are displayed as a point and/or object on the second graphical indication), wherein the updated parameter value (e.g., as indicated by 614b and/or 614c) of the first parameter is different from (e.g., a different value) the current value (e.g., as indicated by 614b and/or 614c) of the first parameter and the updated parameter value (e.g., as indicated by 614b and/or 614c) of the second parameter is different from (e.g., a different value) the current value (e.g., as indicated by 614b and/or 614c) of the second parameter. Displaying a second graphical indication of an updated parameter value of the first parameter and an updated parameter value of the second parameter in response to detecting the user input corresponding to the media editing user interface provides the user with visual feedback about the adjustments to the first parameter and/or the second parameter, thereby providing improved visual feedback to the user.

In some embodiments, while displaying the media editing control user interface object (e.g., 610a-610e, 616, 626a-626e, 632a-632e, and/or 636), the computer system (e.g., 100, 300, 500, and/or 600) detects, via the one or more input devices, user input (e.g., 650m) (e.g., a tap gesture, a swipe gesture, an air gesture, a touch input, a voice command, and/or a button press) that is directed to a portion of a user interface (e.g., 614) that is outside of the media editing control user interface object (e.g., 610a-610e, 616, 626a-626e, 632a-632e, and/or 636) (e.g., wherein the user input corresponds to a location (e.g., a position of the media editing user interface relative to an area of the one or more display generation components) of the media editing user interface that is different from a location (e.g., a position of the media editing user interface relative to an area of the one or more display generation components) of the media editing control user interface object on the media editing user interface). In response to detecting the user input (e.g., 650m) that is directed to a portion of a user interface (e.g., 614) that is outside of the media editing control user interface object (e.g., 610a-610e, 616, 626a-626e, 632a-632e, and/or 636), the computer system (e.g., 100, 300, 500, and/or 600) collapses display of the media editing control user interface object (e.g., 610a-610e, 616, 626a-626e, 632a-632e, and/or 636) (e.g., reducing a size of the media editing control user interface object, shrinking the media editing control user interface object, and/or ceasing display of the media editing control user interface) and the computer system (e.g., 100, 300, 500, and/or 600) transitions (e.g., transforming display of and/or displaying an animation of the media editing control user interface object changing in appearance) display of the media editing control user interface object (e.g., 610a-610e, 616, 626a-626e, 632a-632e, and/or 636) into a graphical indication (e.g., 610a-610e, 626a-626e, and/or 632a-632e) (e.g., an image, an object, and/or a graphical user element that includes a grid, a chart, and/or a graph having a two-dimensional region defined by two perpendicular axes) of an adjusted parameter value (e.g., as indicated by 614b and/or 614c) of the first parameter and an adjusted parameter value (e.g., as indicated by 614b and/or 614c) of the second parameter (e.g., the adjusted parameter value of the first parameter and the adjusted parameter value of the second parameter are displayed as a point and/or object on the second graphical indication), wherein the adjusted parameter value (e.g., as indicated by 614b and/or 614c) of the first parameter was set while displaying the media editing control user interface object (e.g., 610a-610e, 616, 626a-626e, 632a-632e, and/or 636) (e.g., the computer system detected, via the one or more input devices, one or more user inputs corresponding to the media editing control user interface object, while the media control user interface object was displayed, requesting to change, adjust, and/or modify the current value of the first parameter to the adjusted parameter value of the first parameter), and wherein the adjusted parameter value (e.g., as indicated by 614b and/or 614c) of the second parameter was set while displaying the media editing control user interface object (e.g., 610a-610e, 616, 626a-626e, 632a-632e, and/or 636) (e.g., the computer system detected, via the one or more input devices, one or more user inputs corresponding to the media editing control user interface object, while the media control user interface object was displayed, requesting to change, adjust, and/or modify the current value of the second parameter to the adjusted parameter value of the second parameter). Collapsing display of the media editing control user interface object and transitioning display of the media editing control user interface object into a graphical indication of an adjusted parameter value of the first parameter and an adjusted parameter value of the second parameter in response to detecting the user input that does not correspond to the media editing control user interface object provides the user with a visual indication that the media editing control user interface object is in a disabled state and/or provides the user with visual feedback about the adjustments the first parameter and/or the second parameter, thereby providing improved visual feedback to the user.

In some embodiments, after (e.g., in response to) detecting the user input (e.g., 650g, 650h, 650i, 650j, 650k, and/or 650ak) corresponding to the media editing control user interface object (e.g., 610a-610e, 616, 626a-626e, 632a-632e, and/or 636) (e.g., adjusting the first parameter and/or adjusting the second parameter based on the user input), the computer system (e.g., 100, 300, 500, and/or 600) adjusts an appearance (e.g., a tone, a saturation, and/or a color temperature) of the media item (e.g., 604a, 608a, 614a, 621a, 622a, 622d, 632f, 632g, 804a, 814a, 816a, 818a, 822a, 840a, and/or 844a) based on an adjustment of a respective parameter of the media item (e.g., 604a, 608a, 614a, 621a, 622a, 622d, 632f, 632g, 804a, 814a, 816a, 818a, 822a, 840a, and/or 844a) (e.g., an adjustment of the first parameter of the media item based on the magnitude of the change in position of the parameter index point relative to the first axis and/or an adjustment of the second parameter of the media item based on the magnitude of the change in position of the parameter index point relative to the second axis), wherein the media item (e.g., 604a, 608a, 614a, 621a, 622a, 622d, 632f, 632g, 804a, 814a, 816a, 818a, 822a, 840a, and/or 844a) is an existing media item (e.g., 604a, 608a, 614a, 621a, 622a, 622d, 632f, 632g, 804a, 814a, 816a, 818a, 822a, 840a, and/or 844a) of a media library (e.g., the media item was captured via a camera in communication with the computer system prior to detecting the user input corresponding to the media editing control user interface object). Adjusting an appearance of the media item, where the media item is an existing media item of the media library, based on an adjustment of a respective parameter of the media item enables the computer system to adjust parameters of existing media items of the media library, thereby improving customization options for media items of the computer system.

In some embodiments, after detecting the user input (e.g., 650g, 650h, 650i, 650j, 650k, and/or 650ak) corresponding to the media editing control user interface object (e.g., 610a-610e, 616, 626a-626e, 632a-632e, and/or 636), the computer system (e.g., 100, 300, 500, and/or 600) detects, via the one or more input devices, user input (e.g., 650s and/or 650v) (e.g., a tap gesture, a swipe gesture, an air gesture, a touch input, a voice command, and/or a button press) corresponding to a request to capture the media item (e.g., 604a, 608a, 614a, 621a, 622a, 622d, 632f, 632g, 804a, 814a, 816a, 818a, 822a, 840a, and/or 844a) (e.g., the computer system detects user input corresponding to a camera user interface object that initiates a process for capturing the media item via a camera that is in communication with the computer system) using a first application (e.g., the application shown at FIGS. 6A-6P and/or the application shown at FIGS. 6Q and 6R). In response to detecting the user input (e.g., 650s and/or 650v) corresponding to the request to capture the media item (e.g., 604a, 608a, 614a, 621a, 622a, 622d, 632f, 632g, 804a, 814a, 816a, 818a, 822a, 840a, and/or 844a) using the first application (e.g., the application shown at FIGS. 6A-6P and/or the application shown at FIGS. 6Q and 6R), the computer system (e.g., 100, 300, 500, and/or 600) captures the media item (e.g., 604a, 608a, 614a, 621a, 622a, 622d, 632f, 632g, 804a, 814a, 816a, 818a, 822a, 840a, and/or 844a) (e.g., initiating a process to capture an image, a video, and/or audio via a camera that is in communication with the computer system) using an effect (e.g., a visual effect and/or an audio effect) that is based on (e.g., using) the current value (e.g., as indicated by 614b and/or 614c) of the first parameter and the current value (e.g., as indicated by 614b and/or 614c) of the second parameter. In some embodiments, the media item (e.g., 604a, 608a, 614a, 621a, 622a, 622d, 632f, 632g, 804a, 814a, 816a, 818a, 822a, 840a, and/or 844a) is captured and the computer system (e.g., 100, 300, 500, and/or 600) applies the effect to the media item (e.g., 604a, 608a, 614a, 621a, 622a, 622d, 632f, 632g, 804a, 814a, 816a, 818a, 822a, 840a, and/or 844a) (e.g., adjusting an appearance, such as a tone, saturation, and/or color temperature, of the media from an original appearance that includes a default value of the first parameter and a default value of the second parameter to an updated appearance that is based on the current value of the first parameter and the current value of the second parameter), wherein the effect includes applying (e.g., changing, modifying, updating, and/or adjusting from a default value) the current value (e.g., as indicated by 614b and/or 614c) of the first parameter and applying (e.g., changing, modifying, updating, and/or adjusting from a default value) the current value (e.g., as indicated by 614b and/or 614c) of the second parameter to the media item (e.g., 604a, 608a, 614a, 621a, 622a, 622d, 632f, 632g, 804a, 814a, 816a, 818a, 822a, 840a, and/or 844a). Capturing the media item using an effect that is based on the current value of the first parameter and the current value of the second parameter in response to detecting the user input corresponding to the request to capture the media item using the first application enables the computer system to automatically adjust an appearance of the media item based on the current value of the first parameter and/or the current value of the second parameter, thereby performing an operation when a set of conditions have been met without requiring further user input.

In some embodiments, in accordance with a determination that the media item (e.g., 604a, 608a, 614a, 621a, 622a, 622d, 632f, 632g, 804a, 814a, 816a, 818a, 822a, 840a, and/or 844a) is of a first type (e.g., an image, a video, a portrait, and/or a graphics interchange format item), the effect is a first effect (e.g., a first value of the first parameter and/or a first value of the second parameter) (e.g., updating an appearance of, such as a tone, a saturation, and/or a color temperature). In accordance with a determination that the media item (e.g., 604a, 608a, 614a, 621a, 622a, 622d, 632f, 632g, 804a, 814a, 816a, 818a, 822a, 840a, and/or 844a) is of a second type (e.g., an image, a video, a portrait, and/or a graphics interchange format item), the effect is a second effect (e.g., a second value of the first parameter and/or a second value of the second parameter) that is different from the first effect (e.g., updating an appearance of, such as a tone, a saturation, and/or a color temperature). In some embodiments, the computer system (e.g., 100, 300, 500, and/or 600) applies different effects to the media based on the type of the media. Capturing the media item using a first effect in accordance with a determination that the media item is of a first type and capturing the media item using a second effect in accordance with a determination that the media item is of a second type enables the computer system to automatically apply a respective effect to the media item based on the type of media item, thereby performing an operation when a set of conditions has been met without requiring further user input.

In some embodiments, after detecting the user input (e.g., 650g, 650h, 650i, 650j, 650k, and/or 650ak) corresponding to the media editing control user interface object (e.g., 610a-610e, 616, 626a-626e, 632a-632e, and/or 636), the computer system (e.g., 100, 300, 500, and/or 600) detects, via the one or more input devices, user input (e.g., 650s and/or 650v) (e.g., a tap gesture, a swipe gesture, an air gesture, a touch input, a voice command, and/or a button press) corresponding to (e.g., directed toward or directed to) a request to capture the media item (e.g., 604a, 608a, 614a, 621a, 622a, 622d, 632f, 632g, 804a, 814a, 816a, 818a, 822a, 840a, and/or 844a) (e.g., the computer system detects user input corresponding to a camera user interface object that initiates a process for capturing the media item via a camera that is in communication with the computer system) using a second application (e.g., the application shown at FIGS. 6A-6P and/or the application shown at FIGS. 6Q and 6R) that is different from the first application (e.g., the supplication shown at FIGS. 6A-6P and/or the application shown at FIGS. 6Q and 6R). In response to detecting the user input (e.g., 650s and/or 650v) corresponding to the request to capture the media item (e.g., 604a, 608a, 614a, 621a, 622a, 622d, 632f, 632g, 804a, 814a, 816a, 818a, 822a, 840a, and/or 844a) using the second application (e.g., the application shown at FIGS. 6A-6P and/or the application shown at FIGS. 6Q and 6R), the computer system (e.g., 100, 300, 500, and/or 600) captures the media item (e.g., 604a, 608a, 614a, 621a, 622a, 622d, 632f, 632g, 804a, 814a, 816a, 818a, 822a, 840a, and/or 844a) (e.g., initiating a process to capture an image, a video, and/or audio via a camera that is in communication with the computer system) using an effect (e.g., a visual effect and/or an audio effect) that is based on (e.g., using) the current value (e.g., as indicated by 614b and/or 614c) of the first parameter and the current value (e.g., as indicated by 614b and/or 614c) of the second parameter. In some embodiments, the media item (e.g., 604a, 608a, 614a, 621a, 622a, 622d, 632f, 632g, 804a, 814a, 816a, 818a, 822a, 840a, and/or 844a) is captured and the computer system (e.g., 100, 300, 500, and/or 600) applies the effect to the media item (e.g., 604a, 608a, 614a, 621a, 622a, 622d, 632f, 632g, 804a, 814a, 816a, 818a, 822a, 840a, and/or 844a) (e.g., adjusting an appearance, such as a tone, saturation, and/or color temperature, of the media from an original appearance that includes a default value of the first parameter and a default value of the second parameter to an updated appearance that is based on the current value of the first parameter and the current value of the second parameter), wherein the effect includes applying (e.g., changing, modifying, updating, and/or adjusting from a default value) the current value (e.g., as indicated by 614b and/or 614c) of the first parameter and applying (e.g., changing, modifying, updating, and/or adjusting from a default value) the current value (e.g., as indicated by 614b and/or 614c) of the second parameter to the media item (e.g., 604a, 608a, 614a, 621a, 622a, 622d, 632f, 632g, 804a, 814a, 816a, 818a, 822a, 840a, and/or 844a). In some embodiments, capturing the media item (e.g., 604a, 608a, 614a, 621a, 622a, 622d, 632f, 632g, 804a, 814a, 816a, 818a, 822a, 840a, and/or 844a) using the effect includes applying the effect to the media item (e.g., 604a, 608a, 614a, 621a, 622a, 622d, 632f, 632g, 804a, 814a, 816a, 818a, 822a, 840a, and/or 844a) irrespective of an application of the computer system (e.g., 100, 300, 500, and/or 600) that initiated capture of the media item (e.g., 604a, 608a, 614a, 621a, 622a, 622d, 632f, 632g, 804a, 814a, 816a, 818a, 822a, 840a, and/or 844a) (e.g., the computer system (e.g., 100, 300, 500, and/or 600) applies the effect to the media item (e.g., 604a, 608a, 614a, 621a, 622a, 622d, 632f, 632g, 804a, 814a, 816a, 818a, 822a, 840a, and/or 844a) regardless of whether a first application of the computer system (e.g., 100, 300, 500, and/or 600) initiated capture of the media item (e.g., 604a, 608a, 614a, 621a, 622a, 622d, 632f, 632g, 804a, 814a, 816a, 818a, 822a, 840a, and/or 844a) or a second application, different from the first application, of the computer system (e.g., 100, 300, 500, and/or 600) initiated capture of the media item). Capturing the media item using the effect that is based on the current value of the first parameter and the current value of the second parameter enables the computer system to automatically apply the effect to the media item for media items captured through different applications without requiring the user to provide additional inputs, thereby reducing the number of inputs needed to perform an operation.

In some embodiments, the media item (e.g., 604a, 608a, 614a, 621a, 622a, 622d, 632f, 632g, 804a, 814a, 816a, 818a, 822a, 840a, and/or 844a) is a video media item (e.g., 622a, 822a, 840a, and/or 844a) (e.g., a video, a recording of images, and/or a sequence of images that changes over time). In response to detecting the user input (e.g., 650g, 650h, 650i, 650j, 650k, and/or 650ak) corresponding to the media editing control user interface object (e.g., 610a-610e, 616, 626a-626e, 632a-632e, and/or 636) while playing back the video media item (e.g., 622a, 822a, 840a, and/or 844a) (e.g., the computer system is actively playing video of the video media item, such that content and/or a sequence of images displayed change over time), the computer system (e.g., 100, 300, 500, and/or 600) adjusts (e.g., modifying, changing, altering, and/or editing) a respective parameter (e.g., the first parameter and/or the second parameter) of the video media item (e.g., 622a, 822a, 840a, and/or 844a) (e.g., the first parameter of the video media item and/or the second parameter of the video media item can be adjusted while the video media item is being played back). Adjusting a respective parameter of the video media item in response to detecting the user input corresponding to the media editing control user interface object while playing back the video media item allows the user to view changes in appearance to the video media item based on adjustments to the first parameter and/or the second parameter while the video media item is playing back, thereby providing improved visual feedback to the user.

In some embodiments, the media item (e.g., 604a, 608a, 614a, 621a, 622a, 622d, 632f, 632g, 804a, 814a, 816a, 818a, 822a, 840a, and/or 844a) is a video media item (e.g., 622a, 822a, 840a, and/or 844a) (e.g., a video, a recording of images, and/or a sequence of images that changes over time). While displaying media editing control user interface object (e.g., 610a-610e, 616, 626a-626e, 632a-632e, and/or 636), the computer system (e.g., 100, 300, 500, and/or 600) detects, via the one or more input devices, a user input (e.g., 650y and/or 650aa) (e.g., a tap gesture, a swipe gesture, a touch gesture, an air gesture, a button press, and/or a voice command) corresponding to (e.g., directed toward or directed to) a request to adjust a playback position of the video media item (e.g., 622a, 822s, 840a, and/or 844a) (e.g., a request to initiate play back of the video media item from a user-selected playback time of the video media item, such as via user input corresponding to a scrubber user interface object of the media editing user interface). In response to detecting the user input (e.g., 650y and/or 650aa) corresponding to the request to adjust the playback position of the video media item (e.g., 622a, 822a, 840a, and/or 844a), the computer system (e.g., 100, 300, 500, and/or 600) adjusts (e.g., modifying, changing, altering, and/or editing) the playback position of the video media item (e.g., 622a, 822a, 840a, and/or 840a) (e.g., initiating playback of the video media item from a playback time that is based on the request to adjust the playback position of the video media item) while maintaining display of the media editing control user interface object (e.g., 610a-610e, 616, 626a-626e, 632a-632e, and/or 636) (e.g., the computer system displays the media editing control user interface object before detecting the user input corresponding to the request to adjust the playback position of the video media item and the computer system continues to display the media editing control user interface object after detecting the user input corresponding to the request to adjust the playback position of the video media item, while adjusting the playback position of the video media item, and/or after adjusting the playback position of the video media item). Adjusting the playback position of the video media item while maintaining display of the media editing control user interface object in response to detecting the user input corresponding to the request to adjust the playback position of the video media item allows the user to view changes in appearance to different portions of the video media item without requiring the user to provide additional inputs to display and/or re-display the media editing control user interface object, thereby reducing the number of inputs needed to perform an operation and/or providing improved visual feedback to the user.

In some embodiments, the computer system (e.g., 100, 300, 500, and/or 600) displays, via the one or more display generation components, a plurality of parameter configurations (e.g., 610a-610e, 626a-626e, and/or 632a-632e) (e.g., graphical representations (e.g., an image, an object, and/or a graphical user element that includes a grid, a chart, and/or a graph having a two-dimensional region defined by two perpendicular axes) of a respective parameter value of the first parameter and respective parameter value of the second parameter (e.g., the respective parameter value of the first parameter and the respective parameter value of the second parameter are displayed as a point and/or object on the second graphical indication)) for the media item (e.g., 604a, 608a, 614a, 621a, 622a, 622d, 632f, 632g, 804a, 814a, 816a, 818a, 822a, 840a, and/or 844a), wherein the plurality of parameter configurations (e.g., 610a-610e, 626a-626e, and/or 632a-632e) include different pairs of parameter values (e.g., as indicated by 614b and/or 614c) for the first parameter (e.g., text, images, objects, and/or indications on the respective parameter configuration) and corresponding parameter values (e.g., as indicated by 614b and/or 614c) for the second parameter (e.g., text, images, objects, and/or indications on the respective parameter configuration). In some embodiments, the pairs of parameter values include a first numerical value (e.g., a first numerical value ranging from −100 to 100) corresponding to a tone of the media item (e.g., 604a, 608a, 614a, 621a, 622a, 622d, 632f, 632g, 804a, 814a, 816a, 818a, 822a, 840a, and/or 844a) and a second numerical value (e.g., a second numerical value ranging from −100 to 100) corresponding to the saturation of the media item (e.g., 604a, 608a, 614a, 621a, 622a, 622d, 632f, 632g, 804a, 814a, 816a, 818a, 822a, 840a, and/or 844a). In some embodiments, the first numerical value includes positive and/or negative integers representing an amount of tone applied to the media item (e.g., 604a, 608a, 614a, 621a, 622a, 622d, 632f, 632g, 804a, 814a, 816a, 818a, 822a, 840a, and/or 844a) and/or the second numerical value includes positive and/or negative integers representing an amount of saturation applied to the media item (e.g., 604a, 608a, 614a, 621a, 622a, 622d, 632f, 632g, 804a, 814a, 816a, 818a, 822a, 840a, and/or 844a). In some embodiments, a negative integer corresponds to less tone and/or saturation being applied to the media item (e.g., 604a, 608a, 614a, 621a, 622a, 622d, 632f, 632g, 804a, 814a, 816a, 818a, 822a, 840a, and/or 844a). In some embodiments, a positive integer corresponds to more tone and/or saturation being applied to the media item (e.g., 604a, 608a, 614a, 621a, 622a, 622d, 632f, 632g, 804a, 814a, 816a, 818a, 822a, 840a, and/or 844a). In some embodiments, a value of zero corresponds to a default and/or standard amount of tone and/or saturation applied to the media item (e.g., 604a, 608a, 614a, 621a, 622a, 622d, 632f, 632g, 804a, 814a, 816a, 818a, 822a, 840a, and/or 844a). In some embodiments, the pairs of parameter values include first and second numerical values corresponding to parameters different from tone and saturation, such as any combination of tone, saturation, contrast, warmth, color temperature, brightness, brilliance, exposure, vibrance, tint, sharpness, and/or definition. For example, the plurality of parameter configurations includes a first configuration with first values for tone and saturation (e.g., 0, 0), a second configuration with second values for tone and saturation (e.g., 50, −50), a third configuration with third values for tone and saturation (e.g., −25, 75), or any other combinations for different values of tone and saturation. Displaying a plurality of parameter configurations for the media item allows a user to view different parameter configurations and select a parameter configuration based on their preference, thereby providing improved visual feedback to the user.

In some embodiments, displaying the plurality of parameter configurations (e.g., 610a-610e, 626a-626e, and/or 632a-632e) for the media item (e.g., 604a, 608a, 614a, 621a, 622a, 622d, 632f, 632g, 804a, 814a, 816a, 818a, 822a, 840a, and/or 844a) includes the computer system (e.g., 100, 300, 500, and/or 600) displaying, via the one or more display generation component, a first parameter configuration (e.g., 610a-610e, 626a-626e, and/or 632a-632e) (e.g., a first graphical representation of a respective parameter value of the first parameter and a respective parameter value of the second parameter) of the plurality of parameter configurations (e.g., 610a-610e, 626a-626e, and/or 632a-632e) at a first size (e.g., a first size that is larger than a second size at which the remaining parameter configurations of the plurality of parameter configurations are displayed), wherein the first parameter configuration (e.g., 610a-610e, 626a-626e, and/or 632a-632e) corresponds to a currently selected parameter configuration of the plurality of parameter configurations (e.g., 610a-610e, 626a-626e, and/or 632a-632e) (e.g., a parameter configuration selected via user input and/or a default parameter configuration) and a selectable control user interface object (e.g., 612c) (e.g., a button, an affordance, a graphical user interface element, a user selectable icon, and/or a region of the media editing control user interface that is configured to adjust one or more visual parameters and/or visual aspects of one or more media items) corresponding to the first parameter configuration (e.g., 610a-610e, 626a-626e, and/or 632a-632e). In some embodiments, the computer system (e.g., 100, 300, 500, and/or 600) is not configured to and/or enabled to adjust the first parameter and the second parameter in response to user input corresponding to the selectable control user interface object (e.g., 612c). Displaying a first parameter configuration at a first size and a selectable control user interface object corresponding to the first parameter configuration allows the user to view the respective current value of the first parameter and/or the second parameter and provides guidance to the user about the function of the first parameter configuration, thereby providing improved visual feedback to the user.

In some embodiments, displaying the plurality of parameter configurations (e.g., 610a-610e, 626a-626e, and/or 632a-632e) for the media item (e.g., 604a, 608a, 614a, 621a, 622a, 622d, 632f, 632g, 804a, 814a, 816a, 818a, 822a, 840a, and/or 844a) includes the computer system (e.g., 100, 300, 500, and/or 600) displaying, via the one or more display generation components, a currently selected parameter configuration (e.g., 610a-610e, 626a-626e, and/or 632a-632e) (e.g., a parameter configuration selected via user input and/or a default parameter configuration) of the plurality of parameter configurations (e.g., 610a-610e, 626a-626e, and/or 632a-632e) at a first size (e.g., a first size that is larger than a second size at which the remaining parameter configurations of the plurality of parameter configurations are displayed) and one or more non-selected parameter configurations (e.g., 610a-610e, 626a-626e, and/or 632a-632e) (e.g., one or more parameter configurations that were not selected via user input and/or are not default parameter configurations) of the plurality of parameter configurations (e.g., 610a-610e, 626a-626e, and/or 632a-632e) at a second size that is smaller than the first size (e.g., the first size is larger than the second size to indicate that a respective parameter configuration displayed at the first size is currently selected, while the remaining parameter configurations of the plurality of configurations are displayed at a reduced size to indicate that the remaining parameter configurations are not currently selected). In some embodiments, displaying the one or more non-selected parameter configurations of the plurality of parameter configurations at the second size includes displaying the one or more non-selected parameter configurations of the plurality of parameter configurations as thumbnails when compared to display of the currently selected parameter configuration. Displaying a current selected parameter configuration at a first size and one or more non-selected parameter configurations at a second size that is smaller than the first size provides visual confirmation and/or feedback to the user about which parameter configuration of the plurality of parameter configurations is currently selected, thereby providing improved visual feedback to the user.

In some embodiments, while displaying the media editing user interface (e.g., 608, 614, 622, 626, 632, 634, and/or 638), the computer system (e.g., 100, 300, 500, and/or 600) detects, via the one or more input devices, user input (e.g., 650ac) (e.g., a de-pinch gesture, a two-handed air gesture, a two finger drag, a crown rotation, a double tap gesture, and/or a tap gesture) requesting to zoom (e.g., enhance, increase a size of, and/or increase a size of a respective portion of) the media item (e.g., 604a, 608a, 614a, 621a, 622a, 622d, 632f, 632g, 804a, 814a, 816a, 818a, 822a, 840a, and/or 844a) (e.g., the request to zoom the media item includes a magnitude). In response to detecting the user input (e.g., 650ac) requesting to zoom the media item (e.g., 604a, 608a, 614a, 621a, 622a, 622d, 632f, 632g, 804a, 814a, 816a, 818a, 822a, 840a, and/or 844a), the computer system (e.g., 100, 300, 500, and/or 600) displays, via the one or more display generation components, a zoomed in (e.g., level of zoom based on the magnitude of the request to zoom the media item) portion (e.g., 622d at FIG. 6Y) of the media item (e.g., 604a, 608a, 614a, 621a, 622a, 622d, 632f, 632g, 804a, 814a, 816a, 818a, 822a, 840a, and/or 844a) (e.g., a respective portion of the media item that includes a first size prior to detecting the user input requesting to zoom the media item and includes a second size, larger than the first size, after detecting the user input requesting to zoom the media item) and the computer system (e.g., 100, 300, 500, and/or 600) displays, via the one or more display generation components, a border (e.g., the area of display 602 unoccupied by 622d at FIG. 6Y) (e.g., an edge, a frame, and/or a background) around the zoomed in portion (e.g., 622d at FIG. 6Y) of the media item (e.g., 604a, 608a, 614a, 621a, 622a, 622d, 632f, 632g, 804a, 814a, 816a, 818a, 822a, 840a, and/or 844a) (e.g., the zoomed in portion of the media item is not displayed on an entire and/or total display area of the one or more display generation components). In some embodiments, the zoomed in portion of the media item corresponds to a portion of the media item (e.g., 604a, 608a, 614a, 621a, 622a, 622d, 632f, 632g, 804a, 814a, 816a, 818a, 822a, 840a, and/or 844a) that is at a location of the user input requesting to zoom the media item (e.g., 604a, 608a, 614a, 621a, 622a, 622d, 632f, 632g, 804a, 814a, 816a, 818a, 822a, 840a, and/or 844a). Displaying a zoomed in portion of the media item and displaying a border around the zoomed in portion of the media item in response to detecting the user input requesting to zoom the media item while the media editing user interface is displayed provides visual confirmation and/or feedback to the user about an operating state of the computer system, such that the computer system is currently in an editing operating state, thereby providing improved visual feedback to the user.

In some embodiments, the media editing user interface (e.g., 608, 614, 622, 626, 632, 634, and/or 638) includes an effect user interface object (e.g., 627a) (e.g., a button, an affordance, a graphical user interface element, and/or a user selectable icon that, when selected via user input, initiates display of the media editing control user interface object for concurrently adjusting the first parameter of the media item and the second parameter of the media item), a live effect editing user interface object (e.g., 627b) (e.g., a button, an affordance, a graphical user interface element, and/or a user selectable icon that, when selected via user input, initiates display of one or more control user interface objects for adjusting, modifying, editing, and/or changing one or more frames, images, and/or positions of a live image and/or video), an adjustment user interface object (e.g., 627c) (e.g., a button, an affordance, a graphical user interface element, and/or a user selectable icon that, when selected via user input, initiates display of one or more control user interface objects for adjusting, modifying, editing, and/or changing one or more parameters of the media item, such as exposure, brilliance, highlights, shadows, contrast, brightness, black point, saturation, vibrance, warmth, tint, sharpness, definition, noise reduction, and/or vignette), and a crop user interface object (e.g., 627d) (e.g., a button, an affordance, a graphical user interface element, and/or a user selectable icon that, when selected via user input, initiates display of one or more control user interface objects for removing one or more portions of the media item). In some embodiments, the live effect editing user interface object corresponds to an animated image effect, such as an effect that includes capturing a sequence of images corresponding to a media item (e.g., 604a, 608a, 614a, 621a, 622a, 622d, 632f, 632g, 804a, 814a, 816a, 818a, 822a, 840a, and/or 844a) via a single user input (and, optionally, the sequence of images includes one or more images captured before detecting the single user input), displaying the sequence of images in a loop, not displaying the sequence of images in the loop, applying an exposure (e.g., long exposure) to at least one of the images of the sequence of images, and/or shaking and/or bouncing (e.g., moving the representation of media back and forth) a media item (e.g., 604a, 608a, 614a, 621a, 622a, 622d, 632f, 632g, 804a, 814a, 816a, 818a, 822a, 840a, and/or 844a). In some embodiments, in response to detecting selection (e.g., a gesture directed to) of the live effect editing user interface object, the computer system (e.g., 100, 300, 500, and/or 600) applies the effect to a media item (e.g., 604a, 608a, 614a, 621a, 622a, 622d, 632f, 632g, 804a, 814a, 816a, 818a, 822a, 840a, and/or 844a). The media editing user interface including an effect user interface object, a live effect editing user interface object, an adjustment user interface object, and a crop user interface object allows the user to quickly and/or efficiently select different editing options for the media item without requiring additional user input to navigate to another user interface, thereby reducing the number of inputs needed to perform an operation and/or providing additional control options without cluttering the user interface with additional displayed controls.

In some embodiments, displaying the media editing user interface (e.g., 608, 614, 622, 626, 632, 634, and/or 638) includes the computer system (e.g., 100, 300, 500, and/or 600) displaying, via the one or more display generation components, an indication (e.g., 614b and/or 614c) (e.g., text and/or a numerical value) of the current value (e.g., as indicated by 614b and/or 614c) of the first parameter (e.g., overlaid on the media item and/or displayed at respective location on the media editing user interface) and the computer system (e.g., 100, 300, 500, and/or 600) displaying, via the one or more display generation components, an indication (e.g., 614b and/or 614c) (e.g., text and/or a numerical value) of the current value (e.g., as indicated by 614b and/or 614c) of the second parameter (e.g., overlaid on the media item and/or displayed at respective location on the media editing user interface). Displaying an indication of the current value of the first parameter and an indication of the current value of the second parameter provides the user with visual feedback about quantitative values of the first parameter and the second parameter, thereby providing improved visual feedback to the user.

In some embodiments, prior to displaying the media editing user interface (e.g., 608, 614, 622, 626, 632, 634, and/or 638), the computer system (e.g., 100, 300, 500, and/or 600) detects, via the one or more input devices, a sequence of one or more user inputs (e.g., 650p, 650q, 650r, 650u, and/or 650w) (e.g., one or more tap gestures, swipe gestures, air gestures, touch inputs, voice commands, and/or button presses), wherein the sequence of one or more user inputs (e.g., 650p, 650q, 650r, 650u, and/or 650w) includes a first user input (e.g., 650p and/or 650w) corresponding to (e.g., directed toward or directed to) a hardware input device (e.g., 600a) of the one or more input devices (e.g., 602 and/or 600a) (e.g., a press of the hardware input device of the one or more input devices and/or a press of the hardware input device that includes a duration that is less than a threshold duration). In response to detecting the sequence of one or more user inputs (e.g., 650p, 650q, 650r, 650u, and/or 650w), the computer system (e.g., 100, 300, 500, and/or 600) displays, via the one or more display generation components, the media editing control user interface object (e.g., 610a-610e, 616, 626a-626e, 632a-632e, and/or 636) (e.g., the media editing control user interface object on the media user interface and/or the media editing control user interface on a user interface that is different from the media user interface). In some embodiments, the sequence of one or more user inputs includes a second user input corresponding to a touch input, such as a drag input, a swipe input, and/or a tap gesture, of the one or more display generation components. Displaying the media editing control user interface object in response to detecting the sequence of one more user inputs that includes a first user input corresponding to a hardware input device of the one or more input devices allows the user to access the media editing control user interface object without requiring the user to provide additional user inputs requesting to navigate to the media editing user interface, thereby reducing the number of inputs needed to perform an operation.

In some embodiments, while displaying the media editing user interface (e.g., 608, 614, 622, 626, 632, 634, and/or 638), the computer system (e.g., 100, 300, 500, and/or 600) displays, via the one or more display generation components, a tutorial animation (e.g., via user interface 630, 632, 634, and/or 638) (e.g., a sequence of images and/or a video that changes over time that demonstrates and/or provides guidance to a user of the computer system about how to operate one or more functions of the computer system), wherein displaying the tutorial animation includes the computer system (e.g., 100, 300, 500, and/or 600) displaying, via the one or more display generation components, a first animation of an adjustment to a respective parameter of the media item (e.g., 604a, 608a, 614a, 621a, 622a, 622d, 632f, 632g, 804a, 814a, 816a, 818a, 822a, 840a, and/or 844a) (e.g., a first sequence of images and/or a first video that demonstrates how to adjust the first parameter of the media item and/or the second parameter of the media item via user inputs directed to the media editing control user interface object) and a second animation of an adjustment to an appearance of the media item (e.g., 604a, 608a, 614a, 621a, 622a, 622d, 632f, 632g, 804a, 814a, 816a, 818a, 822a, 840a, and/or 844a) based on the adjustment to the respective parameter of the media item (e.g., 604a, 608a, 614a, 621a, 622a, 622d, 632f, 632g, 804a, 814a, 816a, 818a, 822a, 840a, and/or 844a) (e.g., a second sequence of images and/or a second video that demonstrates how adjustment of the first parameter of the media item and/or the second parameter of the media item causes an appearance of the media item to change). In some embodiments, the first animation and the second animation are displayed concurrently so that the user of the computer system (e.g., 100, 300, 500, and/or 600) can view how adjustment of the respective parameter changes the appearance of the media item (e.g., 604a, 608a, 614a, 621a, 622a, 622d, 632f, 632g, 804a, 814a, 816a, 818a, 822a, 840a, and/or 844a). In some embodiments, the first animation and the second animation are displayed sequentially. Displaying a tutorial animation that includes displaying a first animation of an adjustment of a respective parameter of the media item and a second animation of an adjustment to an appearance of the media item based on the adjustment to the respective parameter of the media item provides guidance to the user about how to adjust the first parameter and/or the second parameter of the media item so that the user does not spend time providing additional user inputs to determine how to adjust the first parameter and/or the second parameter, thereby reducing the number of inputs needed to perform an operation.

In some embodiments, while displaying the media editing user interface (e.g., 608, 614, 622, 626, 632, 634, and/or 638), the computer system (e.g., 100, 300, 500, and/or 600) detects, via the one or more input devices, user input (e.g., 650ab, 650ah, and/or 650ai) (e.g., a tap gesture, a swipe gesture, an air gesture, a touch input, a voice command, and/or a button press) corresponding to (e.g., directed toward or directed to) a request to display a second media item (e.g., 604a, 608a, 614a, 621a, 622a, 622d, 632f, 632g, 804a, 814a, 816a, 818a, 822a, 840a, and/or 844a) that is different from the media item (e.g., 604a, 608a, 614a, 621a, 622a, 622d, 632f, 632g, 804a, 814a, 816a, 818a, 822a, 840a, and/or 844a) (e.g., user input to navigate from the media item to a second media item). In response to detecting the user input (e.g., 650ab, 650ah, and/or 650ai) corresponding to the request to display the second media item (e.g., 604a, 608a, 614a, 621a, 622a, 622d, 632f, 632g, 804a, 814a, 816a, 818a, 822a, 840a, and/or 844a) that is different from the first media item (e.g., 604a, 608a, 614a, 621a, 622a, 622d, 632f, 632g, 804a, 814a, 816a, 818a, 822a, 840a, and/or 844a), the computer system (e.g., 100, 300, 500, and/or 600) displays, via the one or more display generation components (e.g., 602), the second media item (e.g., 604a, 608a, 614a, 621a, 622a, 622d, 632f, 632g, 804a, 814a, 816a, 818a, 822a, 840a, and/or 844a) (e.g., a photo, an image, a video, an animation, and/or a graphics interchange format item), wherein an appearance of the second media item (e.g., 604a, 608a, 614a, 621a, 622a, 622d, 632f, 632g, 804a, 814a, 816a, 818a, 822a, 840a, and/or 844a) is based on the current value (e.g., as indicated by 614b and/or 614c) of the first parameter and the current value (e.g., as indicated by 614b and/or 614c) of the second parameter (e.g., the current value of the first parameter and the current value of the second parameter are applied to the second media item so that the appearance of the second media item is based on the current value of the first parameter and the current value of the second parameter). In some embodiments, the media item (e.g., 604a, 608a, 614a, 621a, 622a, 622d, 632f, 632g, 804a, 814a, 816a, 818a, 822a, 840a, and/or 844a) and/or the second media item (e.g., 604a, 608a, 614a, 621a, 622a, 622d, 632f, 632g, 804a, 814a, 816a, 818a, 822a, 840a, and/or 844a) include stock media items stored in memory of the computer system (e.g., 100, 300, 500, and/or 600). In some embodiments, the media item (e.g., 604a, 608a, 614a, 621a, 622a, 622d, 632f, 632g, 804a, 814a, 816a, 818a, 822a, 840a, and/or 844a) and/or the second media item (e.g., 604a, 608a, 614a, 621a, 622a, 622d, 632f, 632g, 804a, 814a, 816a, 818a, 822a, 840a, and/or 844a) include media items captured via a camera that is in communication with the computer system (e.g., 100, 300, 500, and/or 600) in response to detecting user input requesting to capture the media item (e.g., 604a, 608a, 614a, 621a, 622a, 622d, 632f, 632g, 804a, 814a, 816a, 818a, 822a, 840a, and/or 844a) and/or the second media item (e.g., 604a, 608a, 614a, 621a, 622a, 622d, 632f, 632g, 804a, 814a, 816a, 818a, 822a, 840a, and/or 844a). In some embodiments, the appearance of the second media item (e.g., 604a, 608a, 614a, 621a, 622a, 622d, 632f, 632g, 804a, 814a, 816a, 818a, 822a, 840a, and/or 844a) is based on the current value (e.g., as indicated by 614b and/or 614c) of the first parameter and the current value (e.g., as indicated by 614b and/or 614c) of the second parameter, where the current value (e.g., as indicated by 614b and/or 614c) of the first parameter and/or the current value (e.g., as indicated by 614b and/or 614c) of the second parameter are determined based on one or more previously detected user inputs corresponding to a request to change, select, modify, and/or update the values (e.g., as indicated by 614b and/or 614c) of the first parameter and the second parameter. Displaying the second media item that includes an appearance based on the current value of the first parameter and the current value of the second parameter in response to detecting the user input requesting to display the second media item allows a user to quickly and efficiently apply an effect to different media items, thereby reducing the number of inputs needed to perform an operation.

In some embodiments, the request to display the second media item (e.g., 604a, 608a, 614a, 621a, 622a, 622d, 632f, 632g, 804a, 814a, 816a, 818a, 822a, 840a, and/or 844a) that is different from the first media item (e.g., 604a, 608a, 614a, 621a, 622a, 622d, 632f, 632g, 804a, 814a, 816a, 818a, 822a, 840a, and/or 844a) includes user input (e.g., 650ab, 650ah, and/or 650ai) (e.g., a tap gesture, a swipe gesture, an air gesture, a touch input, a voice command, and/or a button press) corresponding to (e.g., directed toward or directed to) selection of a respective media item (e.g., 604a, 608a, 614a, 621a, 622a, 622d, 632f, 632g, 804a, 814a, 816a, 818a, 822a, 840a, and/or 844a) (e.g., a first media item) of a plurality of media items (e.g., 624a-624f, 802, and/or 806a-806i) displayed on the media editing user interface (e.g., 608, 614, 622, 626, 632, 634, and/or 638) (e.g., the computer system displays a plurality of suggested and/or available media items that can be selected via user input and are configured to change in appearance based on the current value of the first parameter and the current value of the second parameter). In some embodiments, the plurality of media items (e.g., 624a-624f, 802, and/or 806a-806i) includes stock media items stored in memory of the computer system (e.g., 100, 300, 500, and/or 600). In some embodiments, the plurality of media items (e.g., 624a-624f, 802, and/or 806a-806i) includes media items captured via a camera that is in communication with or part of the computer system (e.g., 100, 300, 500, and/or 600) in response to detecting user input requesting to capture the media item (e.g., 604a, 608a, 614a, 621a, 622a, 622d, 632f, 632g, 804a, 814a, 816a, 818a, 822a, 840a, and/or 844a) and/or the second media item (e.g., 604a, 608a, 614a, 621a, 622a, 622d, 632f, 632g, 804a, 814a, 816a, 818a, 822a, 840a, and/or 844a). In some embodiments, the plurality of media items (e.g., 624a-624f, 802, and/or 806a-806i) includes suggested media items based on the current value (e.g., as indicated by 614b and/or 614c) of the first parameter and/or the current value (e.g., as indicated by 614b and/or 614c) of the second parameter. In some embodiments, the plurality of media items (e.g., 624a-624f, 802, and/or 806a-806i) includes media items of a media library associated with, stored on, and/or otherwise accessible by the computer system (e.g., 100, 300, 500, and/or 600). The request to display the second media item including user input corresponding to selection of a respective media item of a plurality of media items displayed on the media editing user interface allows a user to quickly and efficiently select a media item for which an effect can be applied without requiring the user to provide additional inputs to search for, capture, and/or otherwise find a media item for which the effect can be applied, thereby reducing the number of inputs needed to perform an operation.

Note that details of the processes described above with respect to method 700 (e.g., FIGS. 7A-7B) are also applicable in an analogous manner to the methods described below. For example, methods 900, 1100, and/or 1300 optionally include one or more of the characteristics of the various methods described above with reference to method 700. For example, the computer system of method 900 can be used to further edit video media items that are edited using the computer system of method 700. As another example, the computer system of method 1100 can be used to selectively apply edits made to a media item using the computer system of method 700 from one media item to another media item. Further still, the computer system of method 1300 can be used to make additional edits to a media item edited using the computer system of method 700. For brevity, these details are not repeated below.

FIGS. 8A-8Z illustrate exemplary user interfaces for editing video media items, in accordance with some embodiments. The user interfaces in these figures are used to illustrate the processes described below, including the processes in FIGS. 9A-9B and 15.

In some embodiments, any of the inputs described herein (e.g., input 850a, 850b, 850c, 850d, 850e, 850f, 850g, 850h, 850i, 850j, 850k, 850l, 850m, 850n, 850o, 850p, 850q, 850r, 850s, 850t, 850u, 850v, 850w, 850x, 850y, 850z, 850aa, 850ab, 850ac, 850ad, 850ae, and/or 850af) is or includes a touch input (e.g., a tap gesture and/or a swipe gesture). In some embodiments, any of the inputs described herein (e.g., input 850a, 850b, 850c, 850d, 850e, 850f, 850g, 850h, 850i, 850j, 850k, 850l, 850m, 850n, 850o, 850p, 850q, 850r, 850s, 850t, 850u, 850v, 850w, 850x, 850y, 850z, 850aa, 850ab, 850ac, 850ad, 850ae, and/or 850af) is or includes a voice input (e.g., a voice command to select a user interface element or to activate a feature or perform a function, such as a feature or function associated with a user interface element). In some embodiments, any of the inputs described herein (e.g., input 850a, 850b, 850c, 850d, 850e, 850f, 850g, 850h, 850i, 850j, 850k, 850l, 850m, 850n, 850o, 850p, 850q, 850r, 850s, 850t, 850u, 850v, 850w, 850x, 850y, 850z, 850aa, 850ab, 850ac, 850ad, 850ae, and/or 850af) is or includes an air gesture (e.g., an air gesture to select a user interface element or to activate a feature or perform a function, such as a feature or function associated with a user interface element). In some embodiments, any of the inputs described herein (e.g., input 850a, 850b, 850c, 850d, 850e, 850f, 850g, 850h, 850i, 850j, 850k, 850l, 850m, 850n, 850o, 850p, 850q, 850r, 850s, 850t, 850u, 850v, 850w, 850x, 850y, 850z, 850aa, 850ab, 850ac, 850ad, 850ae, and/or 850af) is or includes activation (e.g., a press, a rotation, and/or a movement) of a hardware device (e.g., a button, a rotatable input mechanism, a rotatable and depressible input mechanism, a mouse, a mouse button, a trackpad, a trackpad button, a button of a remote control, and/or a joystick). In some embodiments, any of the inputs described herein (e.g., input 850a, 850b, 850c, 850d, 850e, 850f, 850g, 850h, 850i, 850j, 850k, 850l, 850m, 850n, 850o, 850p, 850q, 850r, 850s, 850t, 850u, 850v, 850w, 850x, 850y, 850z, 850aa, 850ab, 850ac, 850ad, 850ae, and/or 850af) as a touch and drag gesture includes an air gesture (e.g., an air gesture including a pinch and/or movement) and/or a click and drag gesture (e.g., a click of a mouse button and/or a trackpad and/or movement while holding a press of a mouse button and/or trackpad) of a mouse and/or trackpad. In some embodiments, any of the user interface elements described as being selected herein (e.g., an icon, affordance, button, and/or selectable option) is selected by activating a hardware device while the user interface element is in focus (e.g., highlighted, bolded, outlined, visually distinguished from other user interface elements, and/or located at or near a cursor).

FIG. 8A illustrates computer system 600 displaying, via display 602, media library user interface 800. Media library user interface 800 includes a plurality of media item representations 802 corresponding to respective media items of computer system 600 (e.g., stored on computer system 600 and/or otherwise accessible by computer system 600). At FIG. 8A, computer system 600 detects user input 850a (e.g., a tap input and/or a touch input) corresponding to media item representation 802a. In response to detecting user input 850a, computer system 600 displays media item user interface 804, as shown at FIG. 8B.

At FIG. 8B, media item user interface 804 includes media item representation 804a, which corresponds to the media item of media item representation 802a. At FIG. 8B, media item representation 804a is displayed at a size that is larger than the size of media item representation 802a shown at FIG. 8A. As such, computer system 600 is configured to enlarge media items of the media library via selection of a respective media item representation 802 of media library user interface 800.

Media item user interface 804 includes media item information 804b, media item mode control 804c, settings user interface object 804d, and exit user interface object 804e. At FIG. 8B, media item information 804b includes information (e.g., metadata) about a location where media item was captured, a time at which the media item was captured, and/or a date at which the media item was captured. Media item mode control 804c includes information about a mode used to capture the media item (e.g., portrait mode) and/or controls for activating and/or deactivating a respective effect applied to the media item. In some embodiments, in response to detecting user input corresponding to settings user interface object 804d, computer system 600 displays a settings menu for the media item corresponding to media item representation 804a. In some embodiments, in response to detecting user input corresponding to exit user interface object 804e, computer system 600 displays (e.g., re-displays) media library user interface 800, as shown at FIG. 8A.

At FIG. 8B, media item user interface 804 includes media item region 806, which includes media item representations 806a-806i corresponding to the media items of the media library of computer system 600. As set forth below, computer system 600 is configured to display different media items of the media library on media item user interface 804 in response to detecting user input. For instance, in some embodiments, computer system 600 transitions from displaying media item representation 804a corresponding to a first media item of the media library to displaying media item representation 804k (e.g., as shown at FIG. 8E) in response to detecting user input.

Media item user interface 804 also includes share user interface object 804f for sharing the media item corresponding to media item representation 804a to an external device and/or account. Media item user interface 804 includes favorite user interface object 804g, information user interface object 804h, and delete user interface object 804i. In some embodiments, in response to detecting user input corresponding to favorite user interface object 804g, computer system 600 designates the media item corresponding to media item representation 804a as a favorite media item (e.g., adds the media item to a favorites folder of the media library). In some embodiments, in response to detecting user input corresponding to information user interface object 804h, computer system 600 displays additional information about the media item corresponding to media item representation 804a (e.g., information that is the same as or different from the information indicated by media item information 804b). In some embodiments, in response to detecting user input corresponding to delete user interface object 804i, computer system 600 removes and/or deletes the media item corresponding to media item representation 804a from the media library of computer system 600.

Media item user interface 804 also includes edit user interface object 804j. As set forth below, in response to detecting user input corresponding to edit user interface object 804j, computer system 600 displays editing user interface 834, as shown at FIG. 8Q. Editing user interface 834 allows the user of computer system 600 to modify, adjust, and/or change various parameters of the media item corresponding to media item representation 804a. For instance, in some embodiments, computer system 600 is configured to adjust, modify, and/or change visual parameters of the media item, playback parameters of the media item, and/or audio parameters of the media item in response to detecting one or more user inputs while displaying editing user interface 834.

At FIG. 8B, computer system 600 detects user input 850b corresponding to media item representation 804a. In some embodiments, user input 850b includes a tap gesture, a double tap gesture, a pinch gesture, and/or a de-pinch gesture. In response to detecting user input 850b, computer system 600 displays second media item user interface 808, as shown at FIG. 8C.

At FIG. 8C, second media item user interface 808 includes media item representation 804a, but does not include media item region 806 and media item representations 806a-806i. Thus, computer system 600 is configured to remove display of media item region 806 and media item representations 806a-806i to provide the user of computer system 600 with a simplified view of media item representation 804a. As shown at FIG. 8C, second media item user interface 808 does not include media item mode control 804c. In some embodiments, computer system 600 does not display media item mode control 804c on second media item user interface 808 to provide the user with a less cluttered user interface and/or to provide focus on media item representation 804a. In some embodiments, computer system 600 displays media item user interface 804 in response to detecting additional user input corresponding to media item representation 804a (e.g., the same type of user input as user input 850b). Thus, in some embodiments, computer system 600 is configured to transition between display of media item user interface 804 and second media item user interface 808 based on user input.

At FIG. 8C, computer system 600 detects user input 850c (e.g., a de-pinch gesture and/or a double tap gesture) corresponding to media item representation 804a of second media item user interface 808. At FIG. 8C, user input 850c includes and/or corresponds to a request to zoom and/or enlarge at least a portion of media item representation 804a. In response to detecting user input 850c, computer system 600 displays full screen media item user interface 810 (e.g., with displayed portions of media item representation 804a reaching all sides of display 602 and/or with displayed portions of media item representation 804a occupying an entire display area of display 602), as shown at FIG. 8D.

At FIG. 8D, computer system 600 displays media item representation 804a within the entire display area of display 602 of computer system 600 in response to detecting user input 850c. At FIG. 8D, computer system 600 also zooms in and/or enlarges media item representation 804a, such that a portion 812 of media item representation 804a is substantially centered and/or is the focus of media item representation 804a. Portion 812 includes the portion of media item representation 804a depicting and/or showing person 812a. In some embodiments, computer system 600 determines a relevant portion of media item representation 804a (e.g., in response to detecting user input 850c) and zooms media item representation 804a to center, emphasize, and/or enlarge the relevant portion. In some embodiments, computer system 600 determines the relevant portion of media item representation 804a based on people, entities, objects, items, and/or articles that appear to be the subject and/or focus of the media item corresponding to media item representation 804a.

At FIG. 8D, full screen media item user interface 810 includes media item information 804b, settings user interface object 804d, exit user interface object 804e, share user interface object 804f, favorite user interface object 804g, information user interface object 804h, delete user interface object 804i, and edit user interface object 804j overlaid on media item representation 804a. Thus, computer system 600 is configured to perform various operations with respect to the media item corresponding to media item representation 804a while displaying full screen media item user interface 810.

In some embodiments, computer system 600 ceases display of and/or removes one or more of media item information 804b and/or user interface objects 804d-804j in response to user input corresponding to full screen media item user interface 810. In some embodiments, computer system 600 displays one or more of media item information 804b and/or user interface objects 804d-804j with an appearance that is based on a portion of media item representation 804a in which media item information 804b and/or user interface objects 804d-804j are overlaid. For instance, in some embodiments, media item information 804b and/or user interface objects 804d-804j include a color that is based on a color of a portion of media item representation 804a in which media item information 804b and/or user interface objects 804d-804j are overlaid. In some embodiments, computer system 600 updates, changes, modifies, and/or adjusts an appearance of media item information 804b and/or user interface objects 804d-804j based on user inputs requesting to adjust a magnification of media item representation 804a, pan and/or translate media item representation 804a, and/or as media item representation 804a plays back (e.g., when media item representation is a video media item).

While computer system 600 displays full screen media item user interface 810, computer system 600 detects user input 850d corresponding to media item representation 804a. At FIG. 8D, user input 850d includes a tap gesture at a location that is on a right side of display 602. In response to detecting user input 850d and/or based on a determination that computer system 600 is displaying full screen media item user interface 810, computer system 600 displays full screen media item user interface 814 with media item representation 814a, as shown at FIG. 8E. In some embodiments, computer system 600 continues to display media item representation 804a while computer system 600 displays media item user interface 804 and/or second media item user interface 808 in response to detecting user input 850d. In other words, computer system 600 does not display the next media item in the media item library in response to detecting user input 850d while displaying media item representation 804a at a magnification level that is less than a threshold magnification level.

Additionally or alternatively, computer system 600 detects user input 850e corresponding to media item representation 804a. At FIG. 8D, user input 850e includes a swipe gesture and/or a user input that includes an initial contact followed by movement while contact is maintained on display 602. In response to detecting user input 850e, computer system 600 displays full screen media item user interface 814 with media item representation 814a, as shown at FIG. 8E. In some embodiments, computer system 600 displays media item representation 814a regardless of whether computer system 600 is displaying full screen media item user interface 810 when computer system 600 detects user input 850e.

At FIG. 8E, computer system 600 displays full screen media item user interface 814 with media item representation 814a, where media item representation 814a corresponds to a different media item than media item representation 804a. At FIG. 8E, computer system 600 maintains display of media item representation 814a within an entire display area of display 602 because computer system 600 detected user input 850d and/or 850e while displaying full screen media item user interface 810. Thus, computer system 600 maintains a level of zoom and/or magnification level of a media item while transitioning between media items.

At FIG. 8E, computer system 600 displays media item representation 814a so that a portion of the media item corresponding to media item representation 814a is substantially centered on display 602. For instance, as set forth above, computer system 600 is configured to determine a relevant portion of the media item and zoom in on and/or center the relevant portion of the media item. At FIG. 8E, computer system 600 determines that the person in the media item corresponding to media item representation 814a is the relevant portion of the media item and zooms in and/or centers media item representation 814a so that the person is enlarged and/or substantially centered on display 602.

At FIG. 8E, computer system 600 detects user input 850f corresponding to a request to display full screen media item user interface 810. At FIG. 8E, user input 850f includes a tap gesture corresponding to a position that is on a left side of display 602. In response to detecting user input 850f and/or based on a determination that computer system 600 is displaying full screen media item user interface 814, computer system 600 displays full screen media item user interface 810, as shown at FIG. 8D. As set forth above, in some embodiments, computer system 600 is configured to transition between display of different media items in response to detecting tap gestures at locations that are on the right or left side of display 602. In some embodiments, computer system 600 displays a previous media item in response to detecting a tap gesture at a location that is on the left side of display 602 while displaying full screen media item user interface 814. In some embodiments, computer system 600 displays a next media item in response to detecting a tap gesture at a location that is on the right side of display 602 while displaying full screen media item user interface 814. In some embodiments, while computer system 600 is not displaying a full screen media item user interface (e.g., a media item representation is not occupying an entire display area of display 602), computer system 600 does not transition to a previous and/or next media item in response to detecting a tap gesture located on the right or left side of display 602.

Additionally or alternatively, computer system 600 detects user input 850g corresponding to a request to display full screen media item user interface 810. At FIG. 8E, user input 850g includes a right swipe gesture. In response to detecting user input 850g, computer system 600 displays full screen media item user interface 810.

At FIG. 8E, computer system 600 detects user input 850h corresponding to a request to display a next media item. At FIG. 8E, user input 850h includes a tap gesture corresponding to a position that is on a right side of display 602. In response to detecting user input 850h and/or based on a determination that computer system 600 is displaying full screen media item user interface 814, computer system 600 displays media item user interface 816, as shown at FIG. 8F. Additionally or alternatively, computer system 600 detects user input 850i corresponding to a request to display the next media item. At FIG. 8E, user input 850i includes a left swipe gesture. In response to detecting user input 850i, computer system 600 displays media item user interface 816, as shown at FIG. 8F.

At FIG. 8F, computer system 600 displays media item representation 816a on media item user interface 816. However, media item representation 816a is not displayed on an entire display area of display 602 (e.g., media item user interface 816 is not a full screen media item user interface). In other words, computer system 600 does not display a full screen media item user interface in response to detecting user input 850h and/or 850i. At FIG. 8F, computer system 600 has determined that the media item corresponding to media item representation 816a is a screenshot media item. In some embodiments, a screenshot media item includes an image and/or depiction of a user interface that is displayed on computer system 600 (and/or another computer system) when computer system 600 (and/or another computer system) detects user input requesting to capture a screenshot. At FIG. 8F, computer system 600 does not display media item representation 816a on a full screen media item user interface and/or on the entire display area of display 602 because some features of the screenshot would overlap with graphical user interface objects displayed on computer system 600. In some embodiments, computer system 600 displays media item representation 816a on less than the entire display area of display 602 to reduce overlap of the screenshot with displayed graphical objects on display 602 of computer system 600.

At FIG. 8F, computer system 600 detects user input 850j corresponding to a request to display a next media item. At FIG. 8F, user input 850j includes a left swipe gesture. At FIG. 8F, in response to detecting user input 850j, computer system 600 displays full screen media item user interface 818, as shown at FIG. 8G. In some embodiments, computer system 600 does not transition from displaying media item representation 816a to a different media item representation in response to a tap gesture at a position to the left or the right of display 602. For instance, because computer system 600 is not displaying media item representation 816a on the entire display area of display 602, computer system 600 forgoes displaying the next media item in response to a tap gesture input.

At FIG. 8G, computer system 600 displays full screen media item user interface 818, which includes media item representation 818a. At FIG. 8G, computer system 600 displays media item representation 818a in the entire display area of display 602. Even though computer system 600 did not display media item representation 816a in the entire display area of display 602, computer system displays media item representation 818a in the entire display area of display 602 because the media item corresponding to media item representation 818a is not a screenshot media item. In some embodiments, computer system 600 displays media item representation 818a in the entire display area of display 602 when computer system 600 does not receive user input corresponding to a request to adjust and/or modify a zoom level of media item representation 816a, shown at FIG. 8F. Thus, computer system 600 is configured to maintain display of subsequent media items at a zoom level that is based on a previously displayed media item (e.g., the most recently displayed media item prior to displaying the currently displayed media item).

As set forth above, computer system 600 displays media item representation 818a on the entire display area of display 602. Computer system 600 also centers and/or zooms in on a relevant portion of the media item corresponding to media item representation 818a. For instance, at FIG. 8G, the people posing for a picture are determined to be the relevant portion of the media item corresponding to media item representation 818a. As such, computer system 600 zooms in on and/or centers the people in the media item while displaying full screen media item user interface 818.

At FIG. 8G, computer system 600 detects user input 850k (e.g., a pinch gesture) corresponding to a request to change the zoom level of media item representation 818a. At FIG. 8G, user input 850k includes a pinch gesture requesting to zoom out of and/or reduce a level of magnification of media item representation 818a. In response to detecting user input 850k, computer system 600 displays media item user interface 820, as shown at FIG. 8H.

At FIG. 8H, media item user interface 820 includes media item representation 818a at a second zoom level that is different from the first zoom level shown at FIG. 8G. For instance, at FIG. 8H, computer system 600 has zoomed out media item representation 818a and/or reduced the level of magnification of media item representation 818a in response to detecting user input 850k. In other words, at FIG. 8H, media item representation 818a is displayed within a portion of the display area of display 602 that is not the entire display area of display 602.

At FIG. 8H, media item user interface 820 includes media item region 806, which includes media item representations 806c-806k corresponding to the media items of the media library of computer system 600.

At FIG. 8H, computer system 600 detects user input 850l corresponding to a request to display a next media item of the media library of computer system 600. In response to detecting user input 850l, computer system 600 displays media item user interface 822, as shown at FIG. 8I. At FIG. 8H, user input 850l includes a left swipe gesture on media item representation 818a. As set forth above, computer system 600 is configured to display the next media item in response to a left swipe gesture regardless of a zoom level at which media item representation 818a is displayed. In contrast, computer system 600 forgoes displaying the next media item in response to detecting a tap gesture located on a right side of display 602 while displaying media item representation 818a at the second zoom level shown at FIG. 8H. In other words, because computer system 600 is not displaying media item representation 818a on the entire display area of display 602, computer system 600 does not display the next media item in response to a tap gesture located at the right side of display 602.

At FIG. 8I, computer system 600 displays media item user interface 822, which includes media item representation 822a corresponding to a media item of the media library of computer system 600. At FIG. 8I, the media item corresponding to media item representation 822a is a video media item. In some embodiments, a video media item includes a video and/or a sequence of images that are configured to play back over time. At FIG. 8I, computer system 600 determines that the media item corresponding to media item representation 822a is a video media item and displays video controls 822b-822d. As set forth below, in some embodiments, computer system 600 displays one or more of video controls 822b-822d and/or does not display one or more of video controls 822b-822d based on the type of video media item, content of the video media item, one or more parameters used to capture the video media item, and/or characteristics of the video media item.

In some embodiments, the video media item corresponding to media item representation 822a is a video media item that was captured with a frame rate above a threshold frame rate and/or a video media item that was captured with a first type of sound effect (e.g., a sound filter and/or a sound effect applied to sound captured via one or more microphones in communication with computer system 600). In some embodiments, computer system 600 displays video control 822b based on a determination that the video media item corresponding to media item representation 822a was captured with a frame rate that is above the threshold frame rate. In some embodiments, computer system 600 forgoes displaying video control 822b based on a determination that the video media item corresponding to media item representation 822a was captured with a frame rate below the threshold frame rate. In some embodiments, computer system 600 displays video control 822c based on a determination that the video media item corresponding to media item representation 822a was captured with a sound effect. In some embodiments, computer system forgoes display of video control 822c based on a determination that the video media item corresponding to media item representation 822a was not captured with a sound effect.

At FIG. 8I, video controls 822b-822d include scrubber control 822d, which indicates a playback time of the video media item and/or enables the user of computer system 600 to control a playback time of the video media item. For example, scrubber control 822d includes playback time indicator 824a, time remaining indicator 824b, and thumb 824c. Playback time indicator 824a indicates an amount of time that has elapsed as the video media item plays back. Time remaining indicator 824b indicates an amount of time remaining in the play back of the video media item. Thumb 824c is configured to move along scrubber control 822d indicating the playback time and/or progression of playback of the video media item. In response to detecting user input corresponding to thumb 824c, computer system 600 is configured to adjust and/or change the playback time of the video media item, as set forth below with reference to FIGS. 8Y and 8Z.

At FIG. 8I, computer system 600 has not initiated play back of the video media item corresponding to media item representation 822a. Computer system 600 displays play user interface object 822e indicating that the video media item is not playing back and/or that the user of computer system 600 can cause playback of the video media item in response to selection of play user interface object 822e. At FIG. 8I, computer system 600 detects user input 850m (e.g., a tap input and/or a touch input) corresponding to play user interface object 822e. In response to detecting user input 850m, computer system 600 initiates play back of the video media item corresponding to media item representation 822a.

At FIG. 8J, computer system 600 has initiated playback of the video media item corresponding to media item representation 822a in response to detecting user input 850m. At FIG. 8J, computer system 600 displays playback time indicator 824a to indicate that five seconds of the video media item have elapsed. Computer system 600 also displays time remaining indicator 824b to indicate that nine seconds remain in the playback of the video media item. Further, computer system 600 updates a position of thumb 824c to indicate a current playback time and/or position of the video media item. For instance, at FIG. 8J, thumb 824c is displayed at a position along scrubber control 822d that corresponds to five seconds having elapsed.

At FIG. 8J, computer system 600 detects user input 850n corresponding to video control 822c. In some embodiments, in response to detecting user input corresponding to video control 822c, computer system 600 pauses and/or stops playing back the video media item. In some embodiments, computer system 600 detects user input 850o corresponding to pause user interface object 822f and pauses and/or stops playing back the video media item in response to detecting user input 850o. In response to detecting user input 850n, computer system 600 displays playback speed menu 826, as shown at FIG. 8K.

At FIG. 8K, computer system 600 displays playback speed menu 826, which includes speed user interface objects 826a-826e corresponding to different playback speed for playing back the video media item. As set forth above, in some embodiments, computer system 600 does not display video control 822c when computer system 600 determines that the video media item corresponding to media item representation 822a does not include a frame rate above the threshold frame rate. In some embodiments, computer system 600 displays video control 822c when the video media item does not include a frame rate above the threshold frame rate, but forgoes displaying playback speed menu 826 in response to detecting user input 850n.

At FIG. 8K, speed user interface object 826a corresponds to a playback speed that is slower than a default and/or original playback speed of the video media item corresponding to media item representation 822a. For instance, in some embodiments, the video media item is captured (e.g., via a camera in communication with computer system 600) at a first speed. In response to detecting user input corresponding to speed user interface object 826a, computer system 600 is configured to play back the video media item at a second speed that is slower than (e.g., half of) the first speed. Speed user interface object 826b corresponds to the default and/or original playback speed of the video media item. Speed user interface objects 826c-826e correspond to respective playback speeds that are faster than the default and/or original playback speed of the video media item. For instance, in response to detecting user input corresponding to one of speed user interface objects 826c-826e, computer system 600 is configured to playback the video media item at a speed that is faster than the first speed.

At FIG. 8K, computer system 600 detects user input 850p corresponding to selection of speed user interface object 826a. In response to detecting user input 850p, computer system 600 updates the playback speed of the video media item. As set forth below with reference to FIGS. 8Q and 8R, computer system 600 is configured to enable the user of computer system 600 to adjust slow motion settings of the video media item based on a determination that the playback speed of the video media item is slower than the default and/or original playback speed.

At FIG. 8L, computer system 600 ceases to display playback speed menu 826 after and/or in response to detecting user input 850p. In addition, computer system 600 continues to pause play back of the video media item. In some embodiments, computer system 600 does not resume play back of the video media item in response to detecting user input 850p. In some embodiments, computer system 600 resumes playback of the video media item at the second and/or slower playback speed after and/or in response to detecting user input 850p.

At FIG. 8L, computer system 600 detects user input 850q corresponding to video control 822b. In response to detecting user input 850q, computer system 600 displays audio menu 828, as shown at FIG. 8M.

At FIG. 8M, computer system 600 displays audio menu 828, which includes audio user interface objects 828a-828c corresponding to different audio effects that can be applied to audio of the video media item. As set forth above, in some embodiments, computer system 600 does not display video control 822b when computer system 600 determines that the video media item corresponding to media item representation 822a does not include and/or was not captured with an audio effect. In some embodiments, computer system 600 displays video control 822b when the video media item does not include and/or was not captured with an audio effect, but forgoes displaying audio menu 828 in response to detecting user input 850q.

At FIG. 8M, audio user interface objects 828a-828c correspond to different types of audio effects that computer system 600 is configured to apply (e.g., applies based on user input) to audio of and/or corresponding to the video media item. For instance, audio user interface object 828a corresponds to a standard audio effect. In some embodiments, the standard audio effect does not apply an audio effect to the original audio of the video media item. Audio user interface object 828b corresponds to a voice isolation audio effect. In some embodiments, the voice isolation effect corresponds to computer system 600 reducing background noise of the audio corresponding to the video media item. In some embodiments, the voice isolation effect includes computer system 600 detecting and/or determining a portion of the audio of the video media item that is associated with speech and computer system 600 blocking, reducing a volume of, and/or removing any other portions of the audio of the video media item. Audio user interface object 828c corresponds to a studio voice audio effect. In some embodiments, the studio voice audio effect corresponds to computer system 600 applying a sound effect to a portion of the audio of the video media item that includes speech.

At FIG. 8M, audio user interface object 828b is currently selected. In some embodiments, computer system 600 displays audio user interface object 828b as the currently selected audio effect because the video media item corresponding to media item representation 822a was captured using the voice isolation audio effect. At FIG. 8M, computer system 600 detects user input 850r corresponding to audio user interface object 828c. In response to detecting user input 850r, computer system 600 displays audio editing user interface 830, as shown at FIG. 8N.

At FIG. 8N, computer system 600 displays audio editing user interface 830, which includes audio editing control 832. At FIG. 8N, audio editing control 832 is displayed at a position of media item region 806. In some embodiments, computer system 600 replaces display of media item region 806 with audio editing control 832 in response to detecting user input 850r.

At FIG. 8N, audio editing control 832 enables computer system 600 to adjust, modify, and/or change how the audio effect corresponding to audio user interface object 828c is applied to the video media item. In some embodiments, audio editing control 832 enables computer system 600 to adjust a time range of the total playback time for which the audio effect is applied. In some embodiments, audio editing control 832 enables computer system 600 to adjust a magnitude and/or amount at which the audio effect is applied to the audio of the video media item. Audio editing control 832 includes first control user interface object 832a and second control user interface object 832b. In some embodiments, first control user interface object 832a corresponds to a start time of the video media item for which the audio effect is applied. In some embodiments, second control user interface object 832b corresponds to an end time of the video media item for which the audio effect is applied. In some embodiments, first control user interface object 832a and/or second control user interface object 832b are configured to adjust a magnitude and/or amount of the audio effect to apply to the audio of the video media item.

At FIG. 8N, computer system 600 detects user input 850s (e.g., a swipe input and/or a touch input) corresponding to audio editing control 832. In response to detecting user input 850s, computer system 600 adjusts the audio effect applied to the audio of the video media item, as shown at FIG. 8O.

At FIG. 8O, computer system 600 updates the respective positions of first control user interface object 832a and second control user interface object 832b based on user input 850s. For instance, in some embodiments, computer system 600 changes the positions of first control user interface object 832a and second control user interface object 832b based on a magnitude associated with user input 850s, such as a direction and/or an amount of movement associated with user input 850s. As set forth above, in some embodiments, user input 850s causes computer system 600 to adjust a time range for which the audio effect is applied to the audio of the video media item. In some embodiments, user input 850s causes computer system 600 to adjust a magnitude and/or an amount of the audio effect applied to the audio of the video media item.

At FIG. 8O, computer system 600 detects user input 850t corresponding to done user interface object 828d of audio editing user interface 830. In response to detecting user input 850t, computer system 600 displays media item user interface 822, as shown at FIG. 8P.

At FIG. 8P, computer system 600 replaces display of audio editing control 832 with media item region 806 indicating that editing the audio effect of the audio of the video media item is concluded. At FIG. 8P, computer system 600 detects user input 850u corresponding to edit user interface object 804j. In response to detecting user input 850u, computer system 600 displays editing user interface 834, as shown at FIG. 8Q.

At FIG. 8Q, editing user interface 834 includes scrubber 834a, play user interface object 834b, and slow motion control 836. As set forth above, in some embodiments, computer system 600 displays slow motion control 836 when computer system 600 determines that the video media item includes (e.g., has been modified to include) a playback speed that is slower than a threshold speed, a default speed. and/or an original speed of the video media item. For instance, in some embodiments, in response to detecting user input 850u and based on a determination that the video media item includes a playback speed that is at or above a threshold speed, a default speed, and/or an original speed of the video, computer system 600 forgoes display of slow motion control 836 and/or displays editing user interface 834 without displaying slow motion control 836 (e.g., as shown at FIG. 8S). At FIG. 8Q, slow motion control 836 includes start user interface object 836a and end user interface object 836b. Start user interface object 836a corresponds to a playback time of the video media item for which a slow motion playback speed is initiated during playback of the video media item. End user interface object 836b corresponds to a playback time of the video media item for which the slow motion playback speed ends during playback of the video media item. In some embodiments, adjusting respective positions of start user interface object 836a and end user interface object 836b relative to one another increases or decreases a time range duration of slow motion playback of the video media item.

At FIG. 8Q, computer system 600 detects user input 850v corresponding to slow motion control 836. In response to detecting user input 850v, computer system 600 adjusts the respective positions of start user interface object 836a and end user interface object 836b, such that the slow motion playback speed is applied to a different time range of the video media item. For instance, at FIG. 8R, the respective positions of start user interface object 836a and end user interface objects 836b are different from the respective positions shown at FIG. 8Q. In some embodiments, computer system 600 adjusts a position of start user interface object 836a, a position of end user interface object 836b, or positions of both start user interface object 836a and end user interface object 836b in response to detecting user input corresponding to slow motion control 836.

At FIG. 8Q, editing user interface 834 includes playback speed user interface object 834c. In some embodiments, computer system 600 displays playback speed user interface object 834c in editing user interface 834 based on a frame rate of the video media item (e.g., the video media item corresponding to media item representation 822a). For instance, in some embodiments, based on a determination that the video media item includes a frame rate that is above a frame rate threshold (e.g., 24 frames per second, 30 frames per second, 60 frames per second, 100 frames per second, 120 frames per second, or 200 frames per second), computer system 600 displays playback speed user interface object 834c in editing user interface 834. In some embodiments, based on a determination that the video media item includes a frame rate that is at or below the frame rate threshold, computer system 600 forgoes display of playback speed user interface object 834c and/or displays editing user interface 834 without displaying playback speed user interface object 834c. At FIG. 8Q, computer system 600 detects user input 850w corresponding to playback speed user interface object 834c of editing user interface 834. In response to detecting user input 850w, computer system 600 displays playback speed menu 838, as shown at FIG. 8R.

At FIG. 8R, computer system displays slow motion control 836, where the respective positions of start user interface object 836a and end user interface object 836b are updated based on user input 850v. In some embodiments, computer system 600 modifies and/or adjusts the respective positions of start user interface object 836a and end user interface object 836b based on a magnitude associated with user input 850v (e.g., a magnitude of movement associated with user input 850v).

At FIG. 8R, playback speed menu 838 includes speed user interface objects 838a-838e, which correspond to respective playback speeds at which computer system 600 is configured to play back the video media item. Speed user interface objects 838a-838e correspond to speed user interface objects 826a-826e. Accordingly, computer system 600 is configured to modify and/or adjust the playback speed of the video media item via user input corresponding to playback speed menu 826 and/or playback speed menu 838.

At FIG. 8R, computer system 600 detects user input 850x corresponding to speed user interface object 838b. At FIG. 8R, speed user interface object 838b corresponds to the default and/or original speed of the video media item. In other words, speed user interface object 838b does not corresponds to a playback speed that is slower than the default and/or original speed of the video media item. In response to detecting user input 850x, computer system 600 displays editing user interface 834, as shown at FIG. 8S.

At FIG. 8S, editing user interface 834 does not include slow motion control 836 because computer system 600 has adjusted and/or modified the playback speed of the video media item to the original and/or default speed of the video media item in response to user input 850x. As such, computer system 600 displays slow motion control 836 when computer system 600 determines that the current and/or selected playback speed of the video media item is slower than the original and/or default speed of the video media item. In some embodiments, computer system 600 is configured to display (e.g., re-display) slow motion control 836 in response to detecting playback speed user interface object 834c and speed user interface object 838a.

At FIG. 8S, computer system 600 detects user input 850y corresponding to done user interface object 834d of editing user interface 834. In response to detecting user input 850y, computer system 600 displays media item user interface 822, as shown at FIG. 8T.

At FIG. 8T, computer system 600 has applied the updated playback speed and audio effects to the video media item. Computer system 600 indicates that the video media item is paused and/or not playing back, as indicated by play user interface object 822e. At FIG. 8T, computer system 600 detects user input 850z corresponding to play user interface object 822e. In response to detecting user input 850z, computer system initiates play back of the video media item, as shown at FIG. 8U.

At FIG. 8U, computer system 600 plays back the video media item. For instance, at FIG. 8U, computer system 600 displays playback time indicator 824a to indicate that eleven seconds of the video media item have elapsed. Computer system 600 also displays time remaining indicator 824b to indicate that three seconds remain in the playback of the video media item. Further, computer system 600 updates a position of thumb 824c to indicate a current playback time and/or position of the video media item. For instance, at FIG. 8U, thumb 824c is displayed at a position along scrubber control 822d that corresponds to eleven seconds having elapsed. While computer system 600 plays back the video media item at FIG. 8U, computer system 600 plays back the video media item with the playback speed selected via user input 850x. In addition, computer system 600 plays back audio of the video media item with an audio effect that is based on user inputs 850r and/or 850s. As such, computer system 600 modifies and/or adjusts playback of the video media item based on user inputs requesting to change a playback speed and/or an audio effect of the video media item.

At FIG. 8U, computer system 600 detects user input 850aa (e.g., swipe input and/or touch input) corresponding to media item representation 822a. Additionally or alternatively, computer system 600 detects user input 850ab (e.g., swipe input and/or touch input) corresponding to media item region 806. In response to detecting user input 850aa and/or user input 850ab, computer system 600 transitions to displaying the next media item of the media library of computer system, as shown at FIG. 8V.

At FIG. 8V, computer system 600 displays media item user interface 840, which includes media item representation 840a corresponding to the next media item of the media library of computer system 600. At FIG. 8V, the media item corresponding to media item representation 840a is a video media item. However, at FIG. 8V, computer system 600 forgoes displaying video control 822b and video control 822c. In some embodiments, computer system 600 does not display video control 822b because computer system 600 determines that the video media item corresponding to media item representation 840a includes and/or was captured with a frame rate that is below a threshold frame rate. In some embodiments, computer system 600 does not display video control 822c because computer system 600 determines that the video media item corresponding to media item representation 840a does not include and/or was not captured with an audio effect. As such, computer system 600 is unable to adjust, modify, and/or edit the playback speed of the video media item and/or is unable to apply audio effects to audio of the video media item.

At FIG. 8V, computer system 600 displays scrubber control 822d even though computer system 600 does not display video control 822b and video control 822c. Therefore, computer system 600 is still configured to cause and/or initiate playback of the video media item corresponding to media item representation 840a.

At FIG. 8V, computer system 600 detects user input 850ac corresponding to media item representation 840a. At FIG. 8V, user input 850ac includes a de-pinch gesture requesting to zoom and/or enlarge at least a portion of media item representation 840a. In response to detecting user input 850ac, computer system 600 displays full screen media item user interface 842, as shown at FIG. 8W.

At FIG. 8W, computer system 600 displays media item representation 840a occupying an entire display area of display 602 of computer system 600 in response to detecting user input 850ac. Thus, computer system 600 is configured to display video media items (e.g., in addition to image and/or photo media items) within the entire display area of display 602. As set forth above, computer system 600 is configured to determine a relevant portion of media item representation 840a after and/or in response to detecting user input 850ac. In some embodiments, the relevant portion of media item representation 840a changes as computer system 600 plays back the video media item corresponding to media item representation 840a. At FIG. 8W, computer system 600 determines and/or identifies the person and the basketball as the relevant portion of media item representation 840a, and thus, computer system 600 zooms in on, enlarges, and/or centers display of the person and the basketball on display 602.

At FIG. 8W, full screen media item user interface 842 does not include display of video controls 822b-822d. As set forth above, computer system 600 does not display video control 822b and/or video control 822c based on characteristics of the video media item corresponding to media item representation 840a. At FIG. 8W, computer system 600 does not display scrubber control 822d so that a view of media item representation 840a is not blocked and/or otherwise obstructed by scrubber control 822d. In some embodiments, computer system 600 is configured to display scrubber control 822d on full screen media item user interface 842 in response to detecting user input.

At FIG. 8W, computer system 600 detects user input 850ad corresponding to media item representation 840a of full screen media item user interface 842. In response to detecting user input 850ad, computer system 600 displays (e.g., re-displays) media item user interface 840, as shown at FIG. 8X.

At FIG. 8X, computer system 600 displays media item user interface 840 and initiates playback of the video media item corresponding to media item representation 840a. In some embodiments, computer system 600 initiates playback of the video media item in response to detecting user input corresponding to play user interface object 822e of media item user interface 840 (e.g., after detecting user input 850ad). In some embodiments, computer system 600 initiates playback of the video media item in response to detecting user input 850ad.

For instance, at FIG. 8X, playback time indicator 824a indicates that four seconds of the video media item have elapsed. Computer system 600 also displays time remaining indicator 824b to indicate that 16 seconds remain in the play back of the video media item. Further, computer system 600 updates a position of thumb 824c to indicate a current playback time and/or position of the video media item. For instance, at FIG. 8X, thumb 824c is displayed at a position along scrubber control 822d that corresponds to four seconds having elapsed.

At FIG. 8X, computer system 600 detects user input 850ae corresponding to media item region 806. In response to detecting user input 850ae, computer system 600 displays media item user interface 844 corresponding to the next media item of the media library of computer system 600, as shown at FIG. 8Y.

At FIG. 8Y, computer system 600 displays media item user interface 844, which includes media item representation 844a corresponding to a video media item of the media library of computer system 600. FIG. 8Y includes dashed box 846 around video control 822b and video control 822c indicating that display of video control 822b and/or video control 822c is optional and/or based on context, in some embodiments. As set forth above, computer system 600 is configured to display video control 822b based on a determination that the video media item corresponding to media item representation 844a includes and/or was captured with a frame rate that is above a threshold frame rate. In contrast, computer system 600 does not display and/or forgoes display of video control 822b based on a determination that the video media item corresponding to media item representation 844a does not include and/or was not captured with a frame rate that is above the threshold frame rate. Computer system 600 is configured to display video control 822c based on a determination that the video media item corresponding to media item representation 844a includes and/or was captured with an audio effect. Computer system 600 does not display and/or forgoes display of video control 822c based on a determination that the video media item corresponding to media item representation 844a does not include and/or was not captured with an audio effect.

As set forth above, computer system 600 is configured to adjust and/or update a playback time of the video media item in response to detecting user input corresponding to scrubber control 822d. At FIG. 8Y, computer system 600 detects user input 850af (e.g., a swipe input and/or a touch input) corresponding to scrubber control 822d. In response to detecting user input 850af, computer system adjusts, changes, and/or updates the playback time of the video media item, as shown at FIG. 8Z.

At FIG. 8Z, playback time indicator 824a indicates that twelve seconds of the video media item have elapsed, as compared to four seconds at FIG. 8Y. Computer system 600 also displays time remaining indicator 824b to indicate that eight seconds remain in the play back of the video media item, as compared to 16 seconds at FIG. 8Y. Further, computer system 600 updates a position of thumb 824c to indicate a current playback time and/or position of the video media item. For instance, at FIG. 8Z, thumb 824c is displayed at a position along scrubber control 822d that corresponds to twelve seconds having elapsed, as compared to the position of thumb 824c shown at FIG. 8Y.

In some embodiments, computer system 600 adjusts and/or changes the playback time of the video media item by an amount that is based on user input 850af. For instance, at FIG. 8Y, user input 850af includes a movement component. In some embodiments, computer system 600 adjusts and/or changes the playback time of the video media item by an amount that is based on a magnitude (e.g., a direction and/or speed) of the movement component of user input 850af. For instance, in some embodiments, computer system 600 moves thumb 824c of scrubber control 822d by an amount that is proportional to the movement component of user input 850af.

FIGS. 9A-9B are flow diagrams illustrating a method for editing video media items using a computer system in accordance with some embodiments. Method 900 is performed at a computer system (e.g., 100, 300, 500, and/or 600) (e.g., a smart phone, a smart watch, a tablet computer, a laptop computer, a desktop computer, a wearable device, and/or head-mounted device) that is in communication with (e.g., includes and/or is connected to) one or more display generation components (e.g., 602) (e.g., one or more displays, touch-screen displays, monitors, holographic display systems, and/or head-mounted display systems) and one or more input devices (e.g., 600a and/or 602) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 900 are, optionally, combined, the orders of some operations are, optionally, changed, and some operations are, optionally, omitted.

As described below, method 900 provides an intuitive way for editing video media items. The method reduces the cognitive burden on a user for editing video media items, thereby creating a more efficient human-machine interface. For battery-operated computing devices, enabling a user to edit video media items faster and more efficiently conserves power and increases the time between battery charges.

While displaying, via the one or more display generation components, a first media item (e.g., 604a, 608a, 614a, 621a, 622a, 622d, 632f, 632g, 804a, 814a, 816a, 818a, 822a, 840a, and/or 844a) in a media library (e.g., the media library of user interface 800) (e.g., a media item that occupies at least half of an area of the one or more display generation components of the computer system and/or a media item that is displayed at a first size that is larger than respective sizes of other media items that are displayed via the one or more display generation components) at a first position (e.g., the position of media item representation 804a shown at FIG. 8B) (e.g., a substantially central position and/or a first central region of the media user interface) of a media user interface (e.g., 804, 808, 816, 820, 822, 840, and/or 844) (e.g., a user interface that includes one or more media items, such as photos, images, graphical objects, videos, graphical interchange format items, and/or audio recordings), the computer system (e.g., 100, 300, 500, and/or 600) detects (902), via the one or more input devices (e.g., 600a and/or 602), a request (e.g., 850d, 850e, 850f, 850g, 850h, 850i, 850j, 850l, 850aa, and/or 850ae) (e.g., a tap gesture, a swipe gesture, a touch gesture, an air gesture, a button press, and/or a voice command) to display a next media item (e.g., 604a, 608a, 614a, 621a, 622a, 622d, 632f, 632g, 804a, 814a, 816a, 818a, 822a, 840a, and/or 844a) in the media library (e.g., a video, a recording of images, and/or a sequence of images that changes over time).

In response to detecting the request (e.g., 850d, 850e, 850f, 850g, 850h, 850i, 850j, 850l, 850aa, and/or 850ae) to display the next media item (e.g., 604a, 608a, 614a, 621a, 622a, 622d, 632f, 632g, 804a, 814a, 816a, 818a, 822a, 840a, and/or 844a) in the media library (904), the computer system (e.g., 100, 300, 500, and/or 600) ceases (906) display of the first media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844) (e.g., removing display of the first media item from the first position of the media user interface) (in some embodiments, ceasing display of the first media item at the first position of the media user interface includes displaying the first media item at a second position of the media user interface, wherein the first media item is displayed at a smaller size when displayed at the second position as compared to the first position).

In response to detecting the request (e.g., 850d, 850e, 850f, 850g, 850h, 850i, 850j, 850l, 850aa, and/or 850ae) to display the next media item (e.g., 604a, 608a, 614a, 621a, 622a, 622d, 632f, 632g, 804a, 814a, 816a, 818a, 822a, 840a, and/or 844a) in the media library (904), the computer system (e.g., 100, 300, 500, and/or 600) concurrently displays (908) (e.g., the computer system displays the video media item and one or more playback controls at the same time via the one or more display generation components), via the one or more display generation components (e.g., 602), a second media item (910) (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844), wherein the second media item (e.g., 604a, 608a, 614a, 621a, 622a, 622d, 632f, 632g, 804a, 814a, 816a, 818a, 822a, 840a, and/or 844a) is a video media item (e.g., 622a, 822a, 840a, and/or 844a) (e.g., the video media item occupies at least half of an area of the one or more display generation components and/or the video media item is displayed at a first size that is larger than respective sizes of other media items that are displayed via the one or more display generation components) (in some embodiments, displaying the video media item replaces display of the first media item at the first position of the media user interface) and one or more playback parameter controls (912) (e.g., 822b, 822c, and/or 822d) (e.g., buttons, affordances, graphical user interface elements, and/or selectable icons), wherein the one or more playback parameter controls (e.g., 822b, 822c, and/or 822d) include a first control (e.g., 822b and/or 822c) that controls a first playback parameter (e.g., playback speed, audio parameters, visual parameters, initiating playback of the video media item, pausing playback of the video media item, scrubbing to a particular time of playback of the video media item, fast forwarding playback of the video media item, rewinding playback of the video media item, and/or stopping playback of the video media item) that has multiple states (e.g., 826a-826e, 828a-828c, and/or 838a-838e) (e.g., at least two states that adjust playback of the video media item differently, such as at a different speed and/or rate and/or with different audio output and/or with different audio effects).

While displaying the second media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844), the computer system (e.g., 100, 300, 500, and/or 600) detects (914) a sequence of one or more inputs (e.g., 850n, 850p, 850q, 850r, 850w, and/or 850x) that includes selection of the first control (e.g., 822a and/or 822c) and selection of a respective state (e.g., 826a-826e, 828a-828c, and/or 838a-838e) associated with the first control (e.g., 822b and/or 822c) (e.g., a tap gesture, a swipe gesture, a touch gesture, an air gesture, a button press, and/or a voice command).

In response to detecting the sequence of one or more inputs (e.g., 850n, 850p, 850q, 850r, 850w, and/or 850x), the computer system (e.g., 100, 300, 500, and/or 600) selects (916) (e.g., the computer system activates, enables, and/or applies the respective state to playback of the video media item) the respective state (e.g., 826a-826e, 828a-828c, and/or 838a-838e) associated with the first control (e.g., 822b and/or 822c).

While the respective state (e.g., 826a-826e, 828a-828c, and/or 838a-838e) associated with the first control (e.g., 822b and/or 822c) is selected for the first playback parameter, the computer system (e.g., 100, 300, 500, and/or 600) plays (918) the second media item (e.g., 604a, 608a, 614a, 621a, 622a, 622d, 632f, 632g, 804a, 814a, 816a, 818a, 822a, 840a, and/or 844a), including in accordance with a determination that a first state (e.g., 826a-826e, 828a-828c, and/or 838a-838e) is selected for the first playback parameter, the computer system (e.g., 100, 300, 500, and/or 600) plays (920) back the second media item (e.g., 604a, 608a, 614a, 621a, 622a, 622d, 632f, 632g, 804a, 814a, 816a, 818a, 822a, 840a, and/or 844a) including outputting content of a type (e.g., video content, image content, audio content, and/or visual effect content) that is adjusted (e.g., changed and/or modified from an original state to the first state) by the first playback parameter in accordance with the first state (e.g., 826a-826e, 828a-828c, and/or 838a-838e) of the first playback parameter (e.g., the computer system plays the second media item by adjusting the output of the content of a type using the first state of the first parameter, such as by applying a playback speed effect and/or an audio effect corresponding to the first state of the first parameter).

While the respective state (e.g., 826a-826e, 828a-828c, and/or 838a-838e) associated with the first control (e.g., 822b and/or 822c) is selected for the first playback parameter, the computer system (e.g., 100, 300, 500, and/or 600) plays (918) the second media item (e.g., 604a, 608a, 614a, 621a, 622a, 622d, 632f, 632g, 804a, 814a, 816a, 818a, 822a, 840a, and/or 844a), including in accordance with a determination that a second state (e.g., 826a-826e, 828a-828c, and/or 838a-838e) is selected for the first playback parameter, the computer system (e.g., 100, 300, 500, and/or 600) plays (922) back the second media item (e.g., 604a, 608a, 614a, 621a, 622a, 622d, 632f, 632g, 804a, 814a, 816a, 818a, 822a, 840a, and/or 844a) including outputting content of the type that is adjusted (e.g., changed and/or modified from an original state to the second state) by the first playback parameter in accordance with the second state (e.g., 826a-826e, 828a-828c, and/or 838a-838e) of the first playback parameter (e.g., the computer system plays the second media item by adjusting the output of the content of a type using the second state of the first parameter, such as by applying a playback speed effect and/or an audio effect corresponding to the second state of the first parameter).

In some embodiments, while the computer system (e.g., 100, 300, 500, and/or 600) displays a first media item (e.g., 604a, 608a, 614a, 621a, 622a, 622d, 632f, 632g, 804a, 814a, 816a, 818a, 822a, 840a, and/or 844a) at a first position (e.g., the position of media item representation 804a shown at FIG. 8B) of a media user interface (e.g., 804, 808, 816, 820, 822, 840, and/or 844), the computer system (e.g., 100, 300, 500, and/or 600) detects, via the one or more input devices, a user input (e.g., 850d, 850e, 850f, 850g, 850h, 850i, 850j, 850l, 850aa, and/or 850ae). In some embodiments, in response to detecting the user input (e.g., 850d, 850e, 850f, 850g, 850h, 850i, 850j, 850l, 850aa, and/or 850ae), the computer system (e.g., 100, 300, 500, and/or 600): ceases display of the first media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844); and displays, via the one or more display generation components, a second media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844), wherein displaying the second media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844) includes: in accordance with a determination that the second media item (e.g., 604a, 608a, 614a, 621a, 622a, 622d, 632f, 632g, 804a, 814a, 816a, 818a, 822a, 840a, and/or 844a) is a video media item (e.g., 622a, 822a, 840a, and/or 844a), the computer system (e.g., 100, 300, 500, and/or 600) displays, concurrently with the second media item (e.g., 604a, 608a, 614a, 621a, 622a, 622d, 632f, 632g, 804a, 814a, 816a, 818a, 822a, 840a, and/or 844a), one or more playback controls (e.g., 822b, 822c, and/or 822d) that are configured to control respective playback parameters of the video media item (e.g., 604a, 608a, 614a, 621a, 622a, 622d, 632f, 632g, 804a, 814a, 816a, 818a, 822a, 840a, and/or 844a); and in accordance with a determination that the second media item (e.g., 604a, 608a, 614a, 621a, 622a, 622d, 632f, 632g, 804a, 814a, 816a, 818a, 822a, 840a, and/or 844a) is not a video media item (e.g., 622a, 822a, 840a, and/or 844a), the computer system (e.g., 100, 300, 500, and/or 600) displays the second media item (e.g., 604a, 608a, 614a, 621a, 622a, 622d, 632f, 632g, 804a, 814a, 816a, 818a, 822a, 840a, and/or 844a) without displaying the one or more playback controls (e.g., 822b, 822c, and/or 822d).

Playing back the second media item including outputting content of a type that is adjusted by the first playback parameter in accordance with the first state of the first playback parameter or playing back the second media item including outputting content of the type that is adjusted by the first playback parameter in accordance with the second state of the first playback parameter while the respective state associated with the first control is selected for the first playback parameter and while concurrently displaying the second media item at the first position of the media user interface and the one or more playback parameter controls allows the computer system to display controls that are relevant to a respective media item of the media library without requiring additional user input requesting to navigate to a different user interface and/or allows the user to perceive an adjustment of the content of the type based on a respective state of a first playback parameter while the video media item is playing back, thereby reducing the number of inputs needed to perform an operation, providing additional control options without cluttering the user interface with additional displayed controls, and/or providing improved visual feedback to the user.

In some embodiments, the first playback parameter includes three or more states (e.g., 826a-826e, 828a-828c, and/or 838a-838e) (e.g., at least three states that adjust playback of the video media item differently, such as at three or more different speeds and/or rates and/or with three or more different audio outputs and/or with three or more different audio effects). The first playback parameter including three or more states allows the computer system to provide and/or display different options for the first playback parameter without requiring the user to navigate to another user interface, thereby reducing the number of inputs needed to perform an operation.

In some embodiments, displaying the one or more playback parameter controls (e.g., 822b, 822c, and/or 822d) includes the computer system (e.g., 100, 300, 500, and/or 600) displaying, via the one or more display generation components and concurrently with the first control (e.g., 822b, 822c, and/or 822d) that controls the first playback parameter that has multiple states (e.g., 826a-826e, 828a-828c, and/or 838a-838e), a second control (e.g., 822b, 822c, and/or 822d) (e.g., a button, an affordance, a graphical user interface element, and/or a selectable icon), different from the first control (e.g., 822b, 822c, and/or 822d), that controls a second playback parameter (e.g., playback speed, audio parameters, visual parameters, initiating playback of the video media item, pausing playback of the video media item, scrubbing to a particular time of playback of the video media item, fast forwarding playback of the video media item, rewinding playback of the video media item, and/or stopping playback of the video media item) that is different from the first playback parameter. Concurrently displaying the first control that controls the first playback parameter that has multiple states and the second control that controls a second playback parameter allows the computer system to display multiple controls that are relevant to a respective media item of the media library without requiring additional user input requesting to navigate to a different user interface, thereby reducing the number of inputs needed to perform an operation.

In some embodiments, while concurrently displaying the second media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844) and the one or more playback parameter controls (e.g., 822b, 822c, and/or 822d), the computer system (e.g., 100, 300, 500, and/or 600) detects, via the one or more input devices, user input (e.g., 850ac) (e.g., a tap gesture, a swipe gesture, a touch gesture, an air gesture, a button press, and/or a voice command) directed to (e.g., corresponding to selection of) the second media item (e.g., 604a, 608a, 614a, 621a, 622a, 622d, 632f, 632g, 804a, 814a, 816a, 818a, 822a, 840a, and/or 844a). In response to detecting the user input (e.g., 850ac) directed to (e.g., corresponding to selection of) the second media item (e.g., 604a, 608a, 614a, 621a, 622a, 622d, 632f, 632g, 804a, 814a, 816a, 818a, 822a, 840a, and/or 844a), the computer system (e.g., 100, 300, 500, and/or 600) ceases display of (e.g., no longer displaying and/or removing display of) the one or more playback parameter controls (e.g., 822b, 822c, and/or 822d) while continuing to display the second media item (e.g., 604a, 608a, 614a, 621a, 622a, 622d, 632f, 632g, 804a, 814a, 816a, 818a, 822a, 840a, and/or 844a) (e.g., the computer system displays the second media item without displaying the one or more playback parameter controls in response to detecting the user input corresponding to selection of the second media item). Ceasing display of the one or more playback controls while continuing to display the second media item in response to detecting the user input directed to the second media item allows a user to dismiss the one or more playback parameter controls so that the one or more playback parameter controls don't obscure other content, thereby providing more display space for displaying other content and providing improved visual feedback to the user.

In some embodiments, while displaying, via the one or more display generation components (e.g., 602), the second media item (e.g., 604a, 608a, 614a, 621a, 622a, 622d, 632f, 632g, 804a, 814a, 816a, 818a, 822a, 840a, and/or 844a) without displaying the one or more playback parameter controls (e.g., 822b, 822c, and/or 822d) (e.g., after ceasing display of the one or more playback parameter controls), the computer system (e.g., 100, 300, 500, and/or 600) detects, via the one or more input devices, second user input (e.g., 850ad) (e.g., a tap gesture, a swipe gesture, a touch gesture, an air gesture, a button press, and/or a voice command) directed to (e.g., corresponding to selection of) the second media item (e.g., 604a, 608a, 614a, 621a, 622a, 622d, 632f, 632g, 804a, 814a, 816a, 818a, 822a, 840a, and/or 844a). In response to detecting the second user input (e.g., 850ad) directed to (e.g., corresponding to selection of) the second media item (e.g., 604a, 608a, 614a, 621a, 622a, 622d, 632f, 632g, 804a, 814a, 816a, 818a, 822a, 840a, and/or 844a), the computer system (e.g., 100, 300, 500, and/or 600) displays (e.g., re-displaying), via the one or more display generation components (e.g., 602), the one or more playback parameter controls (e.g., 822b, 822c, and/or 822d) (e.g., the computer system displays the one or more playback controls in response to subsequent user inputs corresponding to selection of the second media item). In some embodiments, displaying the one or more playback parameter controls (e.g., 822b, 822c, and/or 822d) includes concurrently displaying the first control and the second control (e.g., concurrently with the second media item). Displaying the one or more playback parameter controls in response to detecting the second user input directed to the second media item allows the user to quickly and efficiently access the one or more playback parameter controls without requiring additional user input to navigate to another user interface and/or without requiring the computer system to display additional user interface objects, thereby reducing the number of inputs needed to perform an operation and/or providing additional control options without cluttering the user interface with additional displayed controls.

In some embodiments, while displaying, via the one or more display generation components (e.g., 602), the second media item (e.g., 604a, 608a, 614a, 621a, 622a, 622d, 632f, 632g, 804a, 814a, 816a, 818a, 822a, 840a, and/or 844a) without displaying the one or more playback parameter controls (e.g., 822b, 822c, and/or 822d) (e.g., after ceasing display of the one or more playback parameter controls), the computer system (e.g., 100, 300, 500, and/or 600) detects, via the one or more input devices, user input (e.g., 850aa and/or 850ae) (e.g., a tap gesture, a swipe gesture, a touch gesture, an air gesture, a button press, and/or a voice command that is optionally directed to the second media item) corresponding to (e.g., directed toward or directed to) a request to display a third media item (e.g., 604a, 608a, 614a, 621a, 622a, 622d, 632f, 632g, 804a, 814a, 816a, 818a, 822a, 840a, and/or 844a) in the media library (e.g., a video, a recording of images, and/or a sequence of images that changes over time). In response to detecting the user input (e.g., 850aa and/or 850ae) corresponding to a request to display the third media item (e.g., 604a, 608a, 614a, 621a, 622a, 622d, 632f, 632g, 804a, 814a, 816a, 818a, 822a, 840a, and/or 844a) in the media item library, the computer system (e.g., 100, 300, 500, and/or 600) displays, via the one or more display generation components (e.g., 602), the third media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844) without displaying the one or more playback parameter controls (e.g., 822b, 822c, and/or 822d) (e.g., the computer system displays the third media item at the first position of the media user interface without displaying the one or more playback parameter controls because the second media item was displayed at the first position of the media user interface without displaying the one or more playback controls when the computer system detects the user input requesting to display the third media item in the media library). Displaying the third media item at the first position of the media user interface without displaying the one or more playback parameter controls in response to detecting the user input requesting to display the third media item in the media library and while displaying the second media item without displaying the one or more playback parameter controls allows the user to navigate between media items having a same user interface layout and/or configuration without requiring additional user input from the user, thereby reducing the number of inputs needed to perform an operation.

In some embodiments, the first playback parameter includes a playback speed of the video media item (e.g., 604a, 608a, 614a, 621a, 622a, 622d, 632f, 632g, 804a, 814a, 816a, 818a, 822a, 840a, and/or 844a) (e.g., a speed at which the computer system plays back the video media item relative to a speed at which the video media item was captured and/or a real-time speed) and the sequence of one or more inputs (e.g., 850n, 850p, 850q, 850r, 850w, and/or 850x) that includes selection of the first control (e.g., 822b and/or 822c) and selection of a respective state (e.g., 826a-826e, 828a-828c, and/or 838a-838e) associated with the first control (e.g., 822b and/or 822c) includes selection of a respective playback speed (e.g., 826a-826e and/or 838a-838e) for the second media item (e.g., 604a, 608a, 614a, 621a, 622a, 622d, 632f, 632g, 804a, 814a, 816a, 818a, 822a, 840a, and/or 844a) (e.g., 0.5 times of a real-time speed of the video media item, the real-time speed of the video media item, 1.25 times the real-time speed of the video media item, and/or 1.5 times the real-time speed of the video media item). The sequence of one or more user inputs that includes selection of the first control and selection of a respective state associated with the first control including selection of a respective playback speed for the media item allows the computer system to display controls that are relevant to a respective media item of the media library without requiring additional user input requesting to navigate to a different user interface, thereby reducing the number of inputs needed to perform an operation.

In some embodiments, the first playback parameter includes an audio mixing parameter (e.g., a parameter that applies an audio effect to audio associated with the respective media file and/or a parameter that adjusts, modifies, and/or changes one or more characteristics of the audio, such as pitch, frequency, amplitude, tone, wavelength, velocity, sound exposure, volume, loudness, speed, duration, wave, pressure, envelope, period, sound level, impedance, dynamics, and/or timbre) and the sequence of one or more inputs (e.g., 850n, 850p, 850q, 850r, 850w, and/or 850x) that includes selection of the first control (e.g., 822b and/or 822c) and selection of a respective state (e.g., 826a-826e, 828a-828c, and/or 838a-838e) associated with the first control (e.g., 822b and/or 822c) includes selection of a respective audio mix parameter (e.g., 828a-828c) for the second media item (e.g., 604a, 608a, 614a, 621a, 622a, 622d, 632f, 632g, 804a, 814a, 816a, 818a, 822a, 840a, and/or 844a) (e.g., ambient sound, studio sound, background noise removal, on-camera focus sound, standard sound, increasing a volume of voices in the field of view of the one or more cameras, decreasing a volume of voices outside of the field of view of the one or more cameras, increasing a volume of sounds that are closer to (e.g., within a threshold distance of) the device, decreasing a volume of sounds further from (e.g., further than the threshold distance from) the device, and/or voice isolation). The sequence of one or more inputs that includes selection of the first control and selection of a respective state associated with the first control including selection of a respective audio mix parameter for the second media item allows the computer system to display controls that are relevant to a respective media item of the media library without requiring additional user input requesting to navigate to a different user interface, thereby reducing the number of inputs needed to perform an operation.

In some embodiments, the one or more playback parameter controls (e.g., 822b, 822c, and/or 822d) include an adjustable control (e.g., 832) (e.g., a scrubber, a slider, a button, an affordance, a graphical user interface element, and/or a selectable icon) configured to adjust a magnitude of the respective audio mix parameter (e.g., 828a-828c) for the second media item (e.g., 604a, 608a, 614a, 621a, 622a, 622d, 632f, 632g, 804a, 814a, 816a, 818a, 822a, 840a, and/or 844a) (e.g., a level, amount, and/or intensity at which an effect corresponding to the respective audio mix parameter is applied to audio of the second media item). The one or more playback parameter controls including an adjustable control configured to adjust a magnitude of the respective audio mix parameter for the second media item allows the computer system to display controls that are relevant to a respective media item of the media library without requiring additional user input requesting to navigate to a different user interface, thereby reducing the number of inputs needed to perform an operation.

In some embodiments, the sequence of one or more inputs (e.g., 850n, 850p, 850q, 850r, 850w, and/or 850x) includes a first input (e.g., 850n, 850q, and/or 850w) (e.g., a tap gesture, a swipe gesture, a touch gesture, an air gesture, a button press, and/or a voice command) selecting the first control (e.g., 822b and/or 822c) and a second input (e.g., 850p, 850r, and/or 850x) (e.g., a tap gesture, a swipe gesture, a touch gesture, an air gesture, a button press, and/or a voice command) selecting the respective state (e.g., 826a-826e, 828a-828c, and/or 838a-838e) associated with the first control (e.g., 822b and/or 822c). In response to detecting the first input (e.g., 850n, 850q, and/or 850w) selecting the first control (e.g., 822b and/or 822c), the computer system (e.g., 100, 300, 500, and/or 600) displays, via the one or more display generation components (e.g., 602), a first selectable user interface object (e.g., 826a-826e, 828a-828c, and/or 838a-838e) (e.g., a button, an affordance, a graphical user interface element, and/or a selectable icon) corresponding to a first state (e.g., a first playback speed, a first audio mix parameter effect, and/or a first visual effect) associated with the first control (e.g., 822b and/or 822c) and a second selectable user interface object (e.g., 826a-826e, 828a-828c, and/or 838a-838e) corresponding to a second state (e.g., a second playback speed, a second audio mix parameter effect, and/or a second visual effect) associated with the first control (e.g., 822b and/or 822c). In response to detecting the second input (e.g., 850p, 850r, and/or 850x) selecting the respective state (e.g., 826a-826e, 828a-828c, and/or 838a-838e) associated with the first control (e.g., 822b and/or 822c), wherein the second input (e.g., 850p, 850r, and/or 850x) corresponds to selection of a respective selectable user interface object (e.g., 826a-826e, 828a-828c, and/or 838a-838e) (e.g., the first selectable user interface object, the second selectable user interface object, or another selectable user interface object), the computer system (e.g., 100, 300, 500, and/or 600) selects the respective state (e.g., 826a-826e, 828a-828c, and/or 838a-838e) associated with the first control (e.g., 822b and/or 822c) (e.g., playing back the second media item including outputting content of the type that is adjusted by the respective playback parameter in accordance with the respective state of the respective playback parameter). In some embodiments, the first state associated with the first control is different from the second state associated with the first control. Selecting the respective state associated with the first control in response to detecting the second input selecting the respective state associated with the first control allows the computer system to display multiple controls for adjusting the media item without requiring additional user input requesting to navigate to a different user interface, thereby reducing the number of inputs needed to perform an operation.

In some embodiments, while concurrently displaying the one or more playback parameter controls (e.g., 822b, 822c, and/or 822d) and the second media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844), the computer system (e.g., 100, 300, 500, and/or 600) detects, via the one or more input devices, user input (e.g., 850ab and/or 850ae) (e.g., a tap gesture, a swipe gesture, a touch gesture, an air gesture, a button press, and/or a voice command) requesting to display a respective media item (e.g., 604a, 608a, 614a, 621a, 622a, 622d, 632f, 632g, 804a, 814a, 816a, 818a, 822a, 840a, and/or 844a) in the media library (e.g., a video, a recording of images, and/or a sequence of images that changes over time). In response to detecting the user input (e.g., 850ab and/or 850ae) requesting to display the respective media item (e.g., 604a, 608a, 614a, 621a, 622a, 622d, 632f, 632g, 804a, 814a, 816a, 818a, 822a, 840a, and/or 844a) in the media library, the computer system (e.g., 100, 300, 500, and/or 600) displays, via the one or more generation components (e.g., 602), the respective media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844), in accordance with a determination that a first set of video criteria is satisfied (e.g., the respective media item is a video media item, the respective media item is a video media item that includes a frame rate above a threshold frame rate, and/or the respective media item is a video media item that includes a predefined type of audio recording information), the computer system (e.g., 100, 300, 500, and/or 600) displays (e.g., concurrently with the respective media item), via the one or more display generation components (e.g., 602), a third control (e.g., 822b, 822c, and/or 822d) of the one or more playback parameter controls (e.g., 822b, 822c, and/or 822d) that controls a third playback parameter, and in accordance with a determination that the first set of video criteria is not satisfied (e.g., the respective media item is not a video media item, the respective media item is not a video media item that includes a frame rate above a threshold frame rate, and/or the respective media item is not a video media item that includes a predefined type of audio recording information), the computer system (e.g., 100, 300, 500, and/or 600) forgoes display of the third control (e.g., 822b, 822c, and/or 822d) of the one or more playback parameter controls that controls the third playback parameter. In some embodiments, the first set of video criteria is not satisfied when the respective media item does not include content of a first type (e.g., the respective media item does not include video having a frame rate above a threshold frame rate and/or the respective media item does not have the predefined type of audio recording information).

In some embodiments, while concurrently displaying the one or more playback parameter controls (e.g., 822b, 822c, and/or 822d) and the second media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844), the computer system (e.g., 100, 300, 500, and/or 600) detects, via the one or more input devices, user input (e.g., 850aa and/or 850ae) (e.g., a tap gesture, a swipe gesture, a touch gesture, an air gesture, a button press, and/or a voice command) requesting to display a respective media item (e.g., 604a, 608a, 614a, 621a, 622a, 622d, 632f, 632g, 804a, 814a, 816a, 818a, 822a, 840a, and/or 844a) in the media library (e.g., a video, a recording of images, and/or a sequence of images that changes over time). In response to detecting the user input (e.g., 850aa and/or 850ae) requesting to display the respective media item (e.g., 604a, 608a, 614a, 621a, 622a, 622d, 632f, 632g, 804a, 814a, 816a, 818a, 822a, 840a, and/or 844a) in the media library, in accordance with a determination that a second set of video criteria is satisfied (e.g., the respective media item is a video media item, the respective media item is a video media item that includes a frame rate above a threshold frame rate, and/or the respective media item is a video media item that includes a predefined type of audio recording information), the computer system (e.g., 100, 300, 500, and/or 600) displays (e.g., concurrently with the respective media item), via the one or more display generation components (e.g., 602), a fourth control (e.g., 822b, 822c, and/or 822d) of the one or more playback parameter controls (e.g., 822b, 822c, and/or 822d) that controls a fourth playback parameter, and in accordance with a determination that the second set of video criteria is not satisfied (e.g., the respective media item is not a video media item, the respective media item is a video media item that does not include a frame rate above a threshold frame rate, and/or the respective media item is a video media item that does not include a predefined type of audio recording information), the computer system (e.g., 100, 300, 500, and/or 600) forgoes display of the fourth control (e.g., 822b, 822c, and/or 822d) of the one or more playback parameter controls (e.g., 822b, 822c, and/or 822d) that controls the fourth playback parameter. In some embodiments, the second set of video criteria is not satisfied when the respective media item does not include content of a second type (e.g., the respective media item does not include video having a frame rate above a threshold frame rate and/or the respective media item does not have the predefined type of audio recording information) that is different from the content of the first type. Displaying the respective media item at the first position of the media user interface and displaying the third control that controls the third playback parameter and/or the fourth control that controls the fourth playback parameter based on whether a first set of video criteria is satisfied and/or whether a second set of video criteria is satisfied allows the computer system to display controls that are relevant to a respective media item of the media library without requiring additional user input requesting to navigate to a different user interface and/or allows the computer system to forgo displaying controls that are not relevant to the respective media item, thereby reducing the number of inputs needed to perform an operation and/or providing improved visual feedback to the user.

In some embodiments, the first set of video criteria includes a first criterion that is met when the respective media item (e.g., 604a, 608a, 614a, 621a, 622a, 622d, 632f, 632g, 804a, 814a, 816a, 818a, 822a, 840a, and/or 844a) is a video media item (e.g., 622a, 822a, 840a, and/or 844a) (e.g., a video, a recording of images, and/or a sequence of images that changes over time) that includes a frame rate (e.g., a number of frames, such as images, captured and/or displayed per unit of time, such as per second) above a threshold frame rate (e.g., above 24 frames per second, above, 30 frames per second, above 60 frames per second, above 100 frames per second, above 120 frames per second, or above 200 frames per second), and the third control (e.g., 822c) of the one or more playback parameter controls (e.g., 822b, 822c, and/or 822d) includes a playback speed control (e.g., a speed at which the computer system plays back the video media item relative to a speed at which the video media item was captured and/or a real-time speed). The third control of the one or more playback parameter controls including a playback speed control when the respective media item is a video media item that includes a frame rate above a threshold frame rate allows the computer system to display controls that are relevant to a respective media item of the media library without requiring additional user input requesting to navigate to a different user interface, thereby reducing the number of inputs needed to perform an operation.

In some embodiments, the second set of video criteria includes a second criterion that is met when the respective media item (e.g., 604a, 608a, 614a, 621a, 622a, 622d, 632f, 632g, 804a, 814a, 816a, 818a, 822a, 840a, and/or 844a) is a video media item (e.g., 622a, 822a, 840a, and/or 844a) (e.g., a video, a recording of images, and/or a sequence of images that changes over time) that includes audio mixing information (e.g., audio of the video media item was captured, such as via a speaker in communication with the computer system with information that enables audio mixing for the captured audio to be changed such as including audio streams from different microphones that enable recorded audio to be remixed using an audio mixing effect to adjust, modify, and/or change one or more audio characteristics of the audio), and the fourth control (e.g., 822b) of the one or more playback parameter controls (e.g., 822b, 822c, and/or 822d) includes an audio mixing control (e.g., a parameter that applies an audio effect to audio associated with the respective media file and/or a parameter that adjusts, modifies, and/or changes one or more characteristics of the audio, such as pitch, frequency, amplitude, tone, wavelength, velocity, sound exposure, volume, loudness, speed, duration, wave, pressure, envelope, period, sound level, impedance, dynamics, relative volume of different types of audio, relative volume of audio coming from different portions of the physical environment, and/or timbre). The fourth control of the one or more playback parameter controls including an audio mixing control when the respective media item is a video media item that includes audio mixing information allows the computer system to display controls that are relevant to a respective media item of the media library without requiring additional user input requesting to navigate to a different user interface, thereby reducing the number of inputs needed to perform an operation.

In some embodiments, while displaying a respective media item (e.g., 604a, 608a, 614a, 621a, 622a, 622d, 632f, 632g, 804a, 814a, 816a, 818a, 822a, 840a, and/or 844a) (e.g., a video, a recording of images, and/or a sequence of images that changes over time) at the first position (e.g., the position of media item representation 804a shown at FIG. 8B) of the media user interface (e.g., 804, 808, 816, 820, 822, 840, and/or 844) at a first zoom level (e.g., the zoom level of 840a at FIG. 8V) (e.g., a first amount and/or level at which the respective media item has been enlarged, enhanced, and/or increased in size (e.g., from a default size and/or an original size) relative to a display area of the one or more display generation components), the computer system (e.g., 100, 300, 500, and/or 600) detects, via the one or more input devices, user input (e.g., 850ac) (e.g., a double tap gesture, a pinch gesture, selection of a selectable user interface object, a tap gesture, a swipe gesture, a touch gesture, an air gesture, a button press, and/or a voice command) requesting to adjust a zoom level of the respective media item (e.g., 604a, 608a, 614a, 621a, 622a, 622d, 632f, 632g, 804a, 814a, 816a, 818a, 822a, 840a, and/or 844a) (e.g., an amount and/or level at which the respective media item is enlarged, enhanced, and/or increased in size (e.g., from a default size and/or an original size) relative to a display area of the one or more display generation components). In response to detecting the user input (e.g., 850ac) requesting to adjust the zoom level of the respective media item (e.g., 604a, 608a, 614a, 621a, 622a, 622d, 632f, 632g, 804a, 814a, 816a, 818a, 822a, 840a, and/or 844a), the computer system (e.g., 100, 300, 500, and/or 600) displays, via the one or more display generation components (e.g., 602), the respective media item (e.g., 604a, 608a, 614a, 621a, 622a, 622d, 632f, 632g, 804a, 814a, 816a, 818a, 822a, 840a, and/or 844a) at a second zoom level (e.g., the zoom level of 840a shown at FIG. 8W) (e.g., a second amount and/or level at which the respective media item has been enlarged, enhanced, and/or increased in size (e.g., from a default size and/or original size) relative to a display area of the one or more display generation components) that is different from (e.g., increased or decreased as compared to) the first zoom level (e.g., the zoom level of 840a shown at FIG. 8V), and wherein the second zoom level (e.g., the zoom level of 840a at FIG. 8W) is independent of a magnitude of the user input (e.g., 850ac) requesting to adjust the zoom level of the respective media item (e.g., 604a, 608a, 614a, 621a, 622a, 622d, 632f, 632g, 804a, 814a, 816a, 818a, 822a, 840a, and/or 844a). Displaying the respective media item at a second zoom level that is different from the first zoom level and that is independent of a magnitude of the user input requesting to adjust the zoom level of the respective media item in response to detecting the user input requesting to adjust the zoom level of the respective media item allows the computer system to display the respective media item at different zoom levels so that the user can view enhanced portions of the respective media item, thereby providing improved visual feedback to the user.

In some embodiments, while displaying a respective media item (e.g., 604a, 608a, 614a, 621a, 622a, 622d, 632f, 632g, 804a, 814a, 816a, 818a, 822a, 840a, and/or 844a) (e.g., a video, a recording of images, and/or a sequence of images that changes over time) at the first position (e.g., the position of media item representation 804a shown at FIG. 8B) of the media user interface (e.g., 804, 808, 816, 820, 822, 840, and/or 844) at a respective zoom level (e.g., a first amount and/or level at which the respective media item has been enlarged, enhanced, and/or increased in size (e.g., from a default size and/or an original size) relative to a display area of the one or more display generation components), the computer system (e.g., 100, 300, 500, and/or 600) detects, via the one or more input devices, user input (e.g., 850b and/or 850c) (e.g., a tap gesture, a swipe gesture, a touch gesture, an air gesture, a button press, and/or a voice command) directed to the respective media item (e.g., 604a, 608a, 614a, 621a, 622a, 622d, 632f, 632g, 804a, 814a, 816a, 818a, 822a, 840a, and/or 844a) displayed at the respective zoom level. In response to detecting the user input (e.g., 850b and/or 850c) directed to the respective media item (e.g., 604a, 608a, 614a, 621a, 622a, 622d, 632f, 632g, 804a, 814a, 816a, 818a, 822a, 840a, and/or 844a) displayed at the respective zoom level and in accordance with a determination that the respective zoom level is a first zoom level (e.g., the zoom level of 804a shown at FIG. 8B) (e.g., a default zoom level, a zoom level that displays a first amount of the respective media item, and/or a zoom level that is based on a magnitude of a user input requesting to display the respective media item at the first zoom level), the computer system (e.g., 100, 300, 500, and/or 600) displays (e.g., concurrently with the respective media item), via the one or more display generation components (e.g., 602), a first set of one or more controls (e.g., 804c, 806, and/or 822d) (e.g., a first set of buttons, affordances, graphical user interface elements, and/or selectable icons). In response to detecting the user input (e.g., 850b and/or 850c) directed to the respective media item (e.g., 604a, 608a, 614a, 621a, 622a, 622d, 632f, 632g, 804a, 814a, 816a, 818a, 822a, 840a, and/or 844a) displayed at the respective zoom level and in accordance with a determination that the respective zoom level is a second zoom level (e.g., the zoom level of 804a shown at FIG. 8D) (e.g., a user-defined zoom level, a zoom level that displays a second amount of the respective media item that is less than the first amount of the respective media item, and/or a zoom level that is not based on a magnitude of a user input requesting to display the respective media item at the second zoom level) that is different from (e.g., greater than, higher than, and/or more magnified than; or less than, lower than, and/or less magnified than) the first zoom level (e.g., the zoom level of 804a shown at FIG. 8B), the computer system (e.g., 100, 300, 500, and/or 600) displays (e.g., concurrently with the respective media item), via the one or more display generation components (e.g., 602), a second set of one or more controls (e.g., 804b and/or 804e-804j) (e.g., a second set of buttons, affordances, graphical user interface elements, and/or selectable icons) that is different from (e.g., includes different controls, includes more controls and/or includes fewer controls) the first set of one or more controls (e.g., 804c, 806, and/or 822d). Displaying a first set of one or more controls or a second set of one or more controls based on a zoom level of the respective media item allows the computer system to display controls that are relevant to the respective media item of the media library while the respective media item is displayed at a respective zoom level without requiring additional user input requesting to navigate to a different user interface, thereby reducing the number of inputs needed to perform an operation and/or performing an operation when a set of conditions has been met without requiring further user input.

In some embodiments, the first set of one or more controls (e.g., 804c, 806, and/or 822d) includes a portrait effect control (e.g., 804c) (e.g., a button, an affordance, a graphical user interface element, and/or a user selectable icon that, when selected via user input, enables or disables a portrait mode, where the portrait mode includes displaying the respective media item with simulated depth-of-field effects (e.g., effects simulating capture with a particular focal length (f-stop) by selectively blurring portions of the respective media item that would not be in focus (e.g., would be outside of the depth-of-field) when captured using a lens with the particular focal length) and/or displaying the respective media item with depth information) and the second set of one or more controls (e.g., 804b and/or 804d-804j) does not include the portrait effect control (e.g., 804c) (e.g., the second set of one or more control user interface objects excludes and/or is without the portrait effect control user interface object). The first set of one or more controls including a portrait effect control and the second set of one or more controls not including the portrait effect control allows the computer system to display controls that are relevant to the respective media item of the media library while the respective media item is displayed at a respective zoom level without requiring additional user input requesting to navigate to a different user interface, thereby reducing the number of inputs needed to perform an operation and/or performing an operation when a set of conditions has been met without requiring further user input.

In some embodiments, the first set of one or more controls includes (e.g., 804c, 806, and/or 822d) a video scrubber user interface object (e.g., 822d) (e.g., a selectable user interface object that includes a control such as a bar and/or trough having a control element such as a thumb and/or point on and/or within the bar and/or trough, where the control element is configured to move as playback of a video media item progresses and/or control element is configured to move from a first playback position to a second playback position in response to user input corresponding to the thumb and/or point) and the second set of one or more controls (e.g., 804b and/or 804d-804j) does not include the video scrubber user interface object (e.g., 822d) (e.g., the second set of one or more control user interface objects excludes and/or is without the video scrubber user interface object). In some embodiments, in response to detecting user input (e.g., 850af) corresponding to the video scrubber user interface object (e.g., 822d), the computer system (e.g., 100, 300, 500, and/or 600) adjusts, changes, and/or updates a playback position and/or time of a video media item (e.g., 622a, 822a, 840a, and/or 844a). In some embodiments, the computer system (e.g., 100, 300, 500, and/or 600) adjusts, changes, and/or updates the playback position and/or time of the video media item (e.g., 622a, 822a, 840a, and/or 844a) from a first playback position and/or time to a second playback position and/or time in response to detecting user input (e.g., 850af) corresponding to the video scrubber user interface object (e.g., 822d). In some embodiments, the second playback position and/or time is based on a magnitude (e.g., a distance or speed) and/or direction of the user input (e.g., 850af) corresponding to the video scrubber user interface object (e.g., 822d). The first set of one or more controls including a video scrubber user interface object and the second set of one or more controls not including the video scrubber user interface object allows the computer system to display controls that are relevant to the respective media item of the media library while the respective media item is displayed at a respective zoom level without requiring additional user input requesting to navigate to a different user interface, thereby reducing the number of inputs needed to perform an operation and/or performing an operation when a set of conditions has been met without requiring further user input.

In some embodiments, the first set of one or more controls (e.g., 804c, 806, and/or 822d) includes a media item scrubber user interface object (e.g., 806) (e.g., one or more user interface objects corresponding to respective media items in the media library, where the computer system is configured to transition between displaying media items at the first position of the media user interface in response to user input corresponding to the one or more user interface objects of the media item scrubber user interface object) and the second set of one or more controls (e.g., 804b and/or 804d-804j) does not include the media item scrubber user interface object (e.g., 806) (e.g., the second set of one or more control user interface objects excludes and/or is without the media item user interface object). The first set of one or more controls including a media item scrubber user interface object and the second set of one or more controls not including the media item scrubber user interface object allows the computer system to display controls that are relevant to the respective media item of the media library while the respective media item is displayed at a respective zoom level without requiring additional user input requesting to navigate to a different user interface, thereby reducing the number of inputs needed to perform an operation and/or performing an operation when a set of conditions has been met without requiring further user input.

In some embodiments, the request (e.g., 850d, 850e, 850f, 850g, 850h, 850i, 850j, 850l, 850aa, and/or 850ae) to display the next media item (e.g., 604a, 608a, 614a, 621a, 622a, 622d, 632f, 632g, 804a, 814a, 816a, 818a, 822a, 840a, and/or 844a) in the media library is detected while the first media item (e.g., 604a, 608a, 614a, 621a, 622a, 622d, 632f, 632g, 804a, 814a, 816a, 818a, 822a, 840a, and/or 844a) is displayed at a first zoom level (e.g., the zoom level of 804a shown at FIG. 8D and/or the zoom level of 804a shown at FIG. 8B) (e.g., a first amount and/or level at which the respective media item has been enlarged, enhanced, and/or increased in size (e.g., from a default size and/or an original size) relative to a display area of the one or more display generation components) and displaying the second media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844) includes the computer system (e.g., 100, 300, 500, and/or 600) displaying the second media item (e.g., 604a, 608a, 614a, 621a, 622a, 622d, 632f, 632g, 804a, 814a, 816a, 818a, 822a, 840a, and/or 844a) at a second zoom level (e.g., the zoom level of 814a shown at FIG. 8E, the zoom level of 816a shown at FIG. 8F, and/or the zoom level of 818a shown at FIG. 8G) (e.g., the same as or different from the first zoom level) that is based on the first zoom level (e.g., the zoom level of 804a shown at FIG. 8D and/or the zoom level of 804a shown at FIG. 8B) (e.g., the computer system displays the second media item at a zoom level that is based on a zoom level of the first media item that was displayed when the computer system detected the request to display the next media item in the media library). Displaying the second media item at the first position of the media user interface at the second zoom level that is based on the first zoom level of the first media item allows the user to navigate between media items having the same zoom level without requiring additional user input from the user, thereby reducing the number of inputs needed to perform an operation.

In some embodiments, displaying the second media item (e.g., 604a, 608a, 614a, 621a, 622a, 622d, 632f, 632g, 804a, 814a, 816a, 818a, 822a, 840a, and/or 844a) at the second zoom level (e.g., the zoom level of 814a shown at FIG. 8E, the zoom level of 816a shown at FIG. 8F, and/or the zoom level of 818a shown at FIG. 8G) includes, in accordance with a determination that a first set of criteria is met (e.g., a set of criteria that includes a first criterion that is met when the second zoom level is a user-defined zoom level, a zoom level that displays a second amount of the respective media item that is less than the first amount of the respective media item, and/or a zoom level that is not based on a magnitude of a user input requesting to display the respective media item at the second zoom level) and that a first portion (e.g., 812) of the second media is more relevant than a second portion (e.g., a portion of 804a not including 812) of the second media item (e.g., 604a, 608a, 614a, 621a, 622a, 622d, 632f, 632g, 804a, 814a, 816a, 818a, 822a, 840a, and/or 844a) (e.g., the first portion of the second media item is determined to be a key feature and/or target of the second media item, such as a portion of the second media item that is largest, has the most focus, and/or has the most amount of clarity as compared to other portions of the second media item), the computer system (e.g., 100, 300, 500, and/or 600) displaying the second media item (e.g., 604a, 608a, 614a, 621a, 622a, 622d, 632f, 632g, 804a, 814a, 816a, 818a, 822a, 840a, and/or 844a) zoomed into (e.g., displaying the second media item with an enlarged, enhanced, and/or increased size (e.g., from a default size and/or an original size) relative to a display area of the one or more display generation components) the first portion (e.g., 812) of the second media item (e.g., 604a, 608a, 614a, 621a, 622a, 622d, 632f, 632g, 804a, 814a, 816a, 818a, 822a, 840a, and/or 844a) (e.g., displaying the first portion of the second media item at a magnification level that is greater than a magnification level of the first portion of the second media item while the user input is detected); and in accordance with a determination that the first set of criteria is met and that the second portion (e.g., the portion of 804a not including 812) of the second media item (e.g., 604a, 608a, 614a, 621a, 622a, 622d, 632f, 632g, 804a, 814a, 816a, 818a, 822a, 840a, and/or 844a) is more relevant than the first portion (e.g., 812) of the second media item (e.g., 604a, 608a, 614a, 621a, 622a, 622d, 632f, 632g, 804a, 814a, 816a, 818a, 822a, 840a, and/or 844a) (e.g., the second portion of the second media item is determined to be a key feature and/or target of the second media item, such as a portion of the second media item that is largest, has the most focus, and/or has the most amount of clarity as compared to other portions of the second media item), the computer system (e.g., 100, 300, 500, and/or 600) displaying the second media item (e.g., 604a, 608a, 614a, 621a, 622a, 622d, 632f, 632g, 804a, 814a, 816a, 818a, 822a, 840a, and/or 844a) zoomed into (e.g., displaying the second media item with an enlarged, enhanced, and/or increased size (e.g., from a default size and/or an original size) relative to a display area of the one or more display generation components) the second portion (e.g., the portion of 804a not including 812) of the second media item (e.g., 604a, 608a, 614a, 621a, 622a, 622d, 632f, 632g, 804a, 814a, 816a, 818a, 822a, 840a, and/or 844a) (e.g., displaying the second portion of the second media item at a magnification level that is greater than a magnification level of the second portion of the second media item while the user input is detected). In some embodiments, displaying the second media item (e.g., 604a, 608a, 614a, 621a, 622a, 622d, 632f, 632g, 804a, 814a, 816a, 818a, 822a, 840a, and/or 844a) zoomed into the second portion of the second media item (e.g., 604a, 608a, 614a, 621a, 622a, 622d, 632f, 632g, 804a, 814a, 816a, 818a, 822a, 840a, and/or 844a) includes enlarging the second portion of the second media item (e.g., 604a, 608a, 614a, 621a, 622a, 622d, 632f, 632g, 804a, 814a, 816a, 818a, 822a, 840a, and/or 844a) and ceasing to display at least some of the first portion of the second media item (e.g., 604a, 608a, 614a, 621a, 622a, 622d, 632f, 632g, 804a, 814a, 816a, 818a, 822a, 840a, and/or 844a). In some embodiments, displaying the second media item (e.g., 604a, 608a, 614a, 621a, 622a, 622d, 632f, 632g, 804a, 814a, 816a, 818a, 822a, 840a, and/or 844a) zoomed into the first portion (e.g., 812) of the second media item (e.g., 604a, 608a, 614a, 621a, 622a, 622d, 632f, 632g, 804a, 814a, 816a, 818a, 822a, 840a, and/or 844a) includes enlarging the first portion (e.g., 812) of the second media item (e.g., 604a, 608a, 614a, 621a, 622a, 622d, 632f, 632g, 804a, 814a, 816a, 818a, 822a, 840a, and/or 844a) and ceasing to display at least some of the second portion (e.g., the portion of 804a not including 812) of the second media item (e.g., 604a, 608a, 614a, 621a, 622a, 622d, 632f, 632g, 804a, 814a, 816a, 818a, 822a, 840a, and/or 844a). Zooming in on the first portion of the second media item when the first portion of the second media item is more relevant than the second portion of the second media item and zooming in on the second portion of the second media item when the second portion of the second media item is more relevant than the first portion of the second media item allows the computer system to display a relevant portion of the second media item at the second zoom level without requiring the user to provide additional inputs to cause display of the relevant portion of the second media item, thereby reducing the number of inputs needed to perform an operation.

In some embodiments, while displaying a respective media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844), the computer system (e.g., 100, 300, 500, and/or 600) detects user input (e.g., 850d, 850f, and/or 850h) (e.g., a tap gesture, an air gesture, and/or a touch gesture) corresponding to (e.g., directed toward or directed to) a respective side (e.g., a right side or a left side relative to a display orientation of the one or more display generation components) of the respective media item (e.g., 604a, 608a, 614a, 621a, 622a, 622d, 632f, 632g, 804a, 814a, 816a, 818a, 822a, 840a, and/or 844a). In response to detecting the user input (e.g., 850d, 850f, and/or 850h) corresponding to the respective side of the respective media item, (e.g., 604a, 608a, 614a, 621a, 622a, 622d, 632f, 632g, 804a, 814a, 816a, 818a, 822a, 840a, and/or 844a) in accordance with a determination that a set of navigation criteria is met and that the user input (e.g., 850d, 850f, and/or 850h) corresponds to a first side (e.g., a right side or a left side) of the respective media item (e.g., 604a, 608a, 614a, 621a, 622a, 622d, 632f, 632g, 804a, 814a, 816a, 818a, 822a, 840a, and/or 844a), the computer system (e.g., 100, 300, 500, and/or 600) displays, via the one or more display generation components (e.g., 602), a subsequent media item (e.g., 604a, 608a, 614a, 621a, 622a, 622d, 632f, 632g, 804a, 814a, 816a, 818a, 822a, 840a, and/or 844a) (e.g., a video, a recording of images, and/or a sequence of images that changes over time) at the first position (e.g., the position of media item representation 804a shown at FIG. 8B) of the media user interface (e.g., 804, 808, 816, 820, 822, 840, and/or 844); and in accordance with a determination that the set of navigation criteria is met and that the user input (e.g., 850d, 850f, and/or 850h) corresponds to a second side (e.g., a right side or a left side) of the respective media item (e.g., 604a, 608a, 614a, 621a, 622a, 622d, 632f, 632g, 804a, 814a, 816a, 818a, 822a, 840a, and/or 844a) that is different from (e.g., opposite of) the first side of the respective media item (e.g., 604a, 608a, 614a, 621a, 622a, 622d, 632f, 632g, 804a, 814a, 816a, 818a, 822a, 840a, and/or 844a), the computer system (e.g., 100, 300, 500, and/or 600) displays, via the one or more display generation components (e.g., 602), a previous media item (e.g., 604a, 608a, 614a, 621a, 622a, 622d, 632f, 632g, 804a, 814a, 816a, 818a, 822a, 840a, and/or 844a) (e.g., a right side or a left side) at the first position (e.g., the position of media item representation 804a shown at FIG. 8B) of the media user interface (e.g., 804, 808, 816, 820, 822, 840, and/or 844), wherein the previous media item (e.g., 604a, 608a, 614a, 621a, 622a, 622d, 632f, 632g, 804a, 814a, 816a, 818a, 822a, 840a, and/or 844a) is different from the subsequent media item (e.g., 604a, 608a, 614a, 621a, 622a, 622d, 632f, 632g, 804a, 814a, 816a, 818a, 822a, 840a, and/or 844a) (e.g., the subsequent media item is a next media item in the media library and the previous media item is a previous media item in the media library, or vice versa). Displaying a subsequent media item in accordance with a determination that a set of navigation criteria is met and that the user input corresponds to a first side of the respective media item and displaying a previous media item that is different from the subsequent media item in accordance with a determination that the set of navigation criteria is met and that the user input corresponds to a second side of the respective media item that is different from the first side of the respective media item allows the computer system to navigate between media items without displaying additional user interface objects, thereby providing additional control options without cluttering the user interface with additional displayed controls.

In some embodiments, the set of navigation criteria includes a zoom criterion that is met when a current zoom level (e.g., the zoom level of 804a shown at FIG. 8D, the zoom level of 814a shown at FIG. 8E, and/or the zoom level of 818a shown at FIG. 8G) (e.g., an amount and/or level at which the respective media item has been enlarged, enhanced, and/or increased in size (e.g., from a default size and/or an original size) relative to a display area of the one or more display generation components) of the respective media item (e.g., 604a, 608a, 614a, 621a, 622a, 622d, 632f, 632g, 804a, 814a, 816a, 818a, 822a, 840a, and/or 844a) is above a threshold zoom level (e.g., a zoom level that is greater than zero). In some embodiments, in response to detecting the user input corresponding to the respective side of the respective media item (e.g., 604a, 608a, 614a, 621a, 622a, 622d, 632f, 632g, 804a, 814a, 816a, 818a, 822a, 840a, and/or 844a) and in accordance with a determination that the current zoom level (e.g., an amount and/or level at which the respective media item (e.g., 604a, 608a, 614a, 621a, 622a, 622d, 632f, 632g, 804a, 814a, 816a, 818a, 822a, 840a, and/or 844a) has been enlarged, enhanced, and/or increased in size (e.g., from a default size and/or original size) relative to a display area of the one or more display generation components) is below the threshold zoom level, maintaining display of the respective media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844) (e.g., forgoing displaying the subsequent media item or the previous media item in response to detecting the user input corresponding to the respective side of the respective media item). The set of navigation criteria including a zoom criterion that is met when the current zoom level of the respective media item is above a threshold zoom level allows the computer system to either display controls and/or forgo displaying controls that would obscure display of the respective media item when the respective media item is at a respective zoom level, thereby performing an operation when a set of conditions has been met without requiring further user input, providing additional control options without cluttering the user interface with additional displayed controls, and/or providing improved visual feedback to the user.

In some embodiments, while displaying the first media item (e.g., 604a, 608a, 614a, 621a, 622a, 622d, 632f, 632g, 804a, 814a, 816a, 818a, 822a, 840a, and/or 844a) in the media library at the first position (e.g., the position of media item representation 804a shown at FIG. 8B) of the media user interface (e.g., 804, 808, 816, 820, 822, 840, and/or 844), the computer system (e.g., 100, 300, 500, and/or 600) displays, via the one or more display generation components (e.g., 602), one or more user interface objects (e.g., 804b-804j) (e.g., text, one or more buttons, affordances, graphical user interface elements, and/or selectable icons) overlaid on (e.g., displayed on and/or over such that the one or more user interface objects partially obscure at least a portion of the first media item) the first media item (e.g., 604a, 608a, 614a, 621a, 622a, 622d, 632f, 632g, 804a, 814a, 816a, 818a, 822a, 840a, and/or 844a), wherein an appearance (e.g., a color, a tone, a brightness, a darkness, an amount of blur, a shape, a size, and/or an image representing a respective one or more user interface object) of the one or more user interface objects (e.g., 804b-804j) is based on (e.g., the same as and/or similar to) an appearance (e.g., a color, a tone, a brightness, a darkness, an amount of blur, a shape, a size, and/or an image of the first media item) of the first media item (e.g., 604a, 608a, 614a, 621a, 622a, 622d, 632f, 632g, 804a, 814a, 816a, 818a, 822a, 840a, and/or 844a). In some embodiments, the one or more user interface objects include an indication of a location where the first media item (e.g., 604a, 608a, 614a, 621a, 622a, 622d, 632f, 632g, 804a, 814a, 816a, 818a, 822a, 840a, and/or 844a) was captured, the date and/or time at which the first media item (e.g., 604a, 608a, 614a, 621a, 622a, 622d, 632f, 632g, 804a, 814a, 816a, 818a, 822a, 840a, and/or 844a) was captured, an edit user interface object, a delete user interface object, a share user interface object, and/or a favorites designation user interface object. Displaying the one or more user interface objects overlaid on the first media item and having an appearance that is based on an appearance of the first media item allows the user to easily view the one or more user interface objects, thereby providing improved visual feedback to the user.

In some embodiments, while displaying the one or more user interface objects (e.g., 804b-804j) overlaid on the first media item (e.g., 604a, 608a, 614a, 621a, 622a, 622d, 632f, 632g, 804a, 814a, 816a, 818a, 822a, 840a, and/or 844a) and in response to detecting a change in the appearance of the first media item (e.g., 604a, 608a, 614a, 621a, 622a, 622d, 632f, 632g, 804a, 814a, 816a, 818a, 822a, 840a, and/or 844a) (e.g., the first media item is a video that is playing back, the computer system detects user input requesting to zoom, pan, move, and/or change a playback position of the first media item, and/or the computer system detects user input requesting to transition display from the first media item to a different media item), the computer system (e.g., 100, 300, 500, and/or 600) adjusts a color (e.g., a color temperature, a warmth, a coolness, a brightness, and/or a darkness) of the one or more user interface objects (e.g., 804b-804j) based on the change in the appearance of the first media item (e.g., 604a, 608a, 614a, 621a, 622a, 622d, 632f, 632g, 804a, 814a, 816a, 818a, 822a, 840a, and/or 844a) (e.g., the color of the one or more user interface objects is adjusted to include a same and/or similar change in color of the appearance of the first media item and/or a portion of the first media item in which the one or more user interface objects are overlaid). Adjusting a color of the one or more user interface objects based on the change in appearance of the first media item allows the user to easily view the one or more user interface objects, thereby providing improved visual feedback to the user.

In some embodiments, the change in the appearance of the first media item (e.g., 604a, 608a, 614a, 621a, 622a, 622d, 632f, 632g, 804a, 814a, 816a, 818a, 822a, 840a, and/or 844a) is based a zoom and/or a pan of the first media item (e.g., 604a, 608a, 614a, 621a, 622a, 622d, 632f, 632g, 804a, 814a, 816a, 818a, 822a, 840a, and/or 844a). In some embodiments, the zoom and/or pan of the first media item (e.g., 604a, 608a, 614a, 621a, 622a, 622d, 632f, 632g, 804a, 814a, 816a, 818a, 822a, 840a, and/or 844a) is in response to user input (e.g., a tap gesture, a swipe gesture, a touch gesture, an air gesture, a button press, and/or a voice command) requesting to zoom (e.g., a request to adjust and/or change an amount and/or level at which the respective media item (e.g., 604a, 608a, 614a, 621a, 622a, 622d, 632f, 632g, 804a, 814a, 816a, 818a, 822a, 840a, and/or 844a) is enlarged, enhanced, and/or increased in size (e.g., from a default size and/or an original size) relative to a display area of the one or more display generation components) and/or pan (e.g., move, translate, and/or shift a position of at least a portion of the first media item (e.g., 604a, 608a, 614a, 621a, 622a, 622d, 632f, 632g, 804a, 814a, 816a, 818a, 822a, 840a, and/or 844a) with respect to a display area of the one or more display generation components) the first media item (e.g., 604a, 608a, 614a, 621a, 622a, 622d, 632f, 632g, 804a, 814a, 816a, 818a, 822a, 840a, and/or 844a). The change in appearance of the first media item being based on a zoom and/or a pan the first media item allows the user to easily view the one or more user interface objects when the first media item is zoomed and/or panned, thereby providing improved visual feedback to the user.

In some embodiments, the change in the appearance of the first media item (e.g., 604a, 608a, 614a, 621a, 622a, 622d, 632f, 632g, 804a, 814a, 816a, 818a, 822a, 840a, and/or 844a) is based on playback (e.g., the computer system is actively playing video of the first media item, such that content and/or a sequence of images displayed change over time) of the first media item (e.g., 604a, 608a, 614a, 621a, 622a, 622d, 632f, 632g, 804a, 814a, 816a, 818a, 822a, 840a, and/or 844a) or navigation through the first media item (e.g., 604a, 608a, 614a, 621a, 622a, 622d, 632f, 632g, 804a, 814a, 816a, 818a, 822a, 840a, and/or 844a) (e.g., in response to a user input (e.g., a tap gesture, a swipe gesture, a touch gesture, an air gesture, a button press, and/or a voice command) requesting to play back the first media item at a respective time (e.g., a request to initiate play back of the video media item from a user-selected playback time of the video media item, such as via user input corresponding to a scrubber user interface object of the media editing user interface)). The change in appearance of the first media item being based on playback of the first media item or navigation through the first media item allows the user to easily view the one or more user interface objects while the first media item is being played back and/or transitioning from a first playback time to a second playback time, thereby providing improved visual feedback to the user.

In some embodiments, a first user interface object (e.g., 804b-804j) (e.g., a first letter of text, word of text, button, affordance, graphical user interface element, and/or selectable icon) of the one or more user interface objects (e.g., 804b-804j) includes a first appearance (e.g., a color, a tone, a brightness, a darkness, an amount of blur, a shape, a size, and/or an image representing the first user interface object) that is based on a first color (e.g., a color temperature, a warmth, a coolness, a brightness, and/or a darkness) of a first portion (e.g., a first region, area, and/or segment that is less than a total region, area, and/or segment of the first media item), on which the first user interface object (e.g., 804b-804j) is overlaid, of the first media item (e.g., 604a, 608a, 614a, 621a, 622a, 622d, 632f, 632g, 804a, 814a, 816a, 818a, 822a, 840a, and/or 844a) (e.g., the first portion of the first media item corresponds to a location of the first user interface object (e.g., the first user interface object is overlaid on the first portion of the first media item and/or positioned proximate to the first portion of the first media item)), a second user interface object (e.g., 804b-804j) (e.g., a second letter of text, word of text, button, affordance, graphical user interface element, and/or selectable icon) of the one or more user interface objects (e.g., 804b-804j) includes a second appearance (e.g., a color, a tone, a brightness, a darkness, an amount of blur, a shape, a size, and/or an image representing the second user interface object) that is based on a second color (e.g., a color temperature, a warmth, a coolness, a brightness, and/or a darkness) of a second portion (e.g., a second region, area, and/or segment that is less than a total region, area, and/or segment of the first media item), on which the second user interface object (e.g., 804b-804j) is overlaid, of the first media item (e.g., 604a, 608a, 614a, 621a, 622a, 622d, 632f, 632g, 804a, 814a, 816a, 818a, 822a, 840a, and/or 844a) (e.g., the second portion of the first media item corresponds to a location of the second user interface object (e.g., the second user interface object is overlaid on the second portion of the first media item and/or positioned proximate to the second portion of the first media item)), and the first appearance of the first user interface object (e.g., 804b-804j) is different from the second appearance of the second user interface object (e.g., 804b-804j) (e.g., the first user interface object and the second user interface object include different colors, tones, brightnesses, darknesses, amounts of blur, shapes, sizes, and/or images representing the respective user interface object) based on the first color and the second color. The first user interface object including a first appearance based on a first color of a first potion of the first media item and the second user interface object including a second appearance based on a second color of a second portion of the first media item allows the user to easily view the first user interface object and the second user interface object, thereby providing improved visual feedback to the user.

In some embodiments, while displaying a respective media item (e.g., 604a, 608a, 614a, 621a, 622a, 622d, 632f, 632g, 804a, 814a, 816a, 818a, 822a, 840a, and/or 844a) at the first position (e.g., the position of media item representation 804a shown at FIG. 8B) of the media user interface (e.g., 804, 808, 816, 820, 822, 840, and/or 844), the computer system (e.g., 100, 300, 500, and/or 600) detects, via the one or more input devices, a request (e.g., 850d, 850e, 850f, 850g, 850h, 850i, 850j, 850l, 850aa, and/or 850ae) (e.g., a tap gesture, a swipe gesture, a touch gesture, an air gesture, a button press, and/or a voice command) to display a respective media item (e.g., 604a, 608a, 614a, 621a, 622a, 622d, 632f, 632g, 804a, 814a, 816a, 818a, 822a, 840a, and/or 844a) (e.g., a video, a recording of images, and/or a sequence of images that changes over time). In response to detecting the request (e.g., 850d, 850e, 850f, 850g, 850h, 850i, 850j, 850l, 850aa, and/or 850ae) to display the respective media item (e.g., 604a, 608a, 614a, 621a, 622a, 622d, 632f, 632g, 804a, 814a, 816a, 818a, 822a, 840a, and/or 844a), in accordance with a determination that the respective media item (e.g., 604a, 608a, 614a, 621a, 622a, 622d, 632f, 632g, 804a, 814a, 816a, 818a, 822a, 840a, and/or 844a) is a screenshot media item (e.g., 816a) (e.g., an image that, when captured, includes a depiction and/or representation of a currently displayed user interface and/or one or more user interface objects of the one or more display generation components), the computer system (e.g., 100, 300, 500, and/or 600) displays, via the one or more display generation components (e.g., 602), the respective media item (e.g., 604a, 608a, 614a, 621a, 622a, 622d, 632f, 632g, 804a, 814a, 816a, 818a, 822a, 840a, and/or 844a) at a first level of inset (e.g., the level of inset shown at FIG. 8F) (e.g., the computer displays the respective media item at a first percentage of a total display area of the one or more display generation components that is less than 100 percent of the total display area of the one or more display generation components, the computer system displays the respective media item with a border, edge, and/or frame around the respective media item, the computer system displays the respective media item within a portion of a content display region, such as a window, an application window, and/or a display area that includes the respective media item, that is less than a total display area of the content display region, and/or the computer system displays the respective media item with a border, edge, and/or frame around the respective media item within a content display region), and in accordance with a determination that the respective media item (e.g., 604a, 608a, 614a, 621a, 622a, 622d, 632f, 632g, 804a, 814a, 816a, 818a, 822a, 840a, and/or 844a) is not a screenshot media item (e.g., 816a) (e.g., the respective media item is a photograph and/or a video), the computer system (e.g., 100, 300, 500, and/or 600) displays, via the one or more display generation components (e.g., 602), the respective media item (e.g., 604a, 608a, 614a, 621a, 622a, 622d, 632f, 632g, 804a, 814a, 816a, 818a, 822a, 840a, and/or 844a) at a second level of inset (e.g., the level of inset of 804a shown at FIG. 8D, the level of inset of 814a shown at FIG. 8E, and/or the level of inset of 818a shown at FIG. 8G) (e.g., the computer displays the respective media item at a first percentage of a total display area of the one or more display generation components that is up to 100 percent of the total display area of the one or more display generation components and/or the computer system displays the respective media item without a border, edge, and/or frame around the respective media item) that is different from (e.g., greater than or less than) the first level of inset. Displaying the respective media item at a first level of inset in accordance with a determination that the respective media item is a screenshot media item and displaying the respective media item at a second level of inset that is different from the first level of inset in accordance with a determination that the respective media item is not a screenshot media item allows the user to view the screenshot media item without various portions of the screenshot media item overlapping with one or more user interface objects displayed via the one or more display generation components of the computer system, thereby providing improved visual feedback to the user.

In some embodiments, the one or more playback parameter controls (e.g., 822b, 822c, and/or 822d) includes an embedded (e.g., a programmed control and/or a default control that is overlaid on a respective video media item) video playback control (e.g., 822d) (e.g., a selectable user interface object that includes a control such as a bar and/or trough having a control element such as a thumb and/or point on and/or within the bar and/or trough, where the control element is configured to move as playback of a video media item progresses and/or the control element is configured to move from a first playback position to a second playback position in response to user input corresponding to the thumb and/or point). In some embodiments, in response to detecting user input (e.g., 850af) corresponding to the video scrubber user interface object (e.g., 822d), the computer system (e.g., 100, 300, 500, and/or 600) adjusts, changes, and/or updates a playback position and/or time of a video media item (e.g., 622a, 822a, 840a, and/or 844a). In some embodiments, the computer system (e.g., 100, 300, 500, and/or 600) adjusts, changes, and/or updates the playback position and/or time of the video media item (e.g., 622a, 622d, 822a, 840a, and/or 844a) from a first playback position and/or time to a second playback position and/or time in response to detecting user input (e.g., 850af) corresponding to the video scrubber user interface object (e.g., 822d). In some embodiments, the second playback position and/or time is based on a magnitude (e.g., a distance or speed) and/or direction of the user input (e.g., 840af) corresponding to the video scrubber user interface object (e.g., 822d). The one or more playback parameter controls including an embedded video playback control provides the user with visual feedback that the second media item is a video media item and/or allows the user to quickly adjust a playback parameter of the second video media item without requiring additional inputs requesting to navigate to another user interface, thereby providing improved visual feedback to the user and/or reducing the number of inputs needed to perform an operation.

In some embodiments, while playing back the second media item (e.g., 604a, 608a, 614a, 621a, 622a, 622d, 632f, 632g, 804a, 814a, 816a, 818a, 822a, 840a, and/or 844a) (e.g., the computer system is actively playing video of the first media item, such that content and/or a sequence of images displayed change over time), in accordance with a determination that a playback speed (e.g., a speed at which the computer system plays back the video media item relative to a speed at which the video media item was captured and/or a real-time speed) of the second media item (e.g., 604a, 608a, 614a, 621a, 622a, 622d, 632f, 632g, 804a, 814a, 816a, 818a, 822a, 840a, and/or 844a) is (e.g., has been reduced to be) (e.g., adjusted, changed, and/or modified to be a playback speed that is less than the speed at which the video media item was captured and/or less than a real-time speed) below a threshold playback speed (e.g., a speed at which the video media item was captured and/or a real-time speed), the computer system (e.g., 100, 300, 500, and/or 600) displays, via the one or more display generation components (e.g., 602), one or more slow motion controls (e.g., 834c, 836, 836a, and/or 836b) (e.g., one or more user interface objects that that enable a user to adjust a playback speed of the second media item, select and/or display one or more frames of a video of the second media item, select and/or initiate playback of a video of the second media item at a particular playback time, select and/or cease playback of a video of the second media item at a particular time, and/or apply different playback speeds to different portions of a video of the second media item); and in accordance with a determination that the playback speed of the second media item (e.g., 604a, 608a, 614a, 621a, 622a, 622d, 632f, 632g, 804a, 814a, 816a, 818a, 822a, 840a, and/or 844a) is not (e.g., has not been reduced to be) below the threshold playback speed (e.g., the playback speed of the second media item has not been adjusted, changed, and/or modified to be a playback speed that is less than the speed at which the video media item was captured and/or less than a real-time speed), the computer system (e.g., 100, 300, 500, and/or 600) forgoes display of the one or more slow motion controls (e.g., 834c, 836, 836a, and/or 836b) (e.g., the computer system does not display the one or more slow motion controls when the playback speed of the second media item has not been reduced below the threshold playback speed and/or when the playback speed of the second media item is above the threshold playback speed). In some embodiments, the computer system (e.g., 100, 300, 500, and/or 600) displays one or more controls (e.g., 834c) for increasing a playback speed of the second media item regardless of whether the playback speed of the second media item is or is not below the threshold playback speed. Displaying one or more slow motion controls in accordance with a determination that a playback speed of the second media item is below a threshold playback speed and forgoing display of the one or more slow motion controls in accordance with a determination that the playback speed of the second media item is not below the threshold playback speed enables the computer system to display relevant controls for the second media item based on a current playback speed of the user and/or provides the user with an indication of a current playback speed of the second media item, thereby performing an operation when a set of conditions has been met without requiring further user input and/or providing improved visual feedback to the user.

In some embodiments, the one or more slow motion controls (e.g., 834c, 836, 836a, and/or 836b) includes a first slow motion control (e.g., 834c, 836, 836a and/or 836b) (e.g., a first slow motion control that that enable a user to adjust a playback speed of the second media item, select and/or display one or more frames of a video of the second media item, select and/or initiate playback of a video of the second media item at a particular playback time, select and/or cease playback of a video of the second media item at a particular time, and/or apply different playback speeds to different portions of a video of the second media item). While displaying the one or more slow motion controls (e.g., 834c, 836, 836a, and/or 836b), the computer system (e.g., 100, 300, 500, and/or 600) detects, via the one or more input devices, user input (e.g., 850v) (e.g., a tap gesture, a swipe gesture, a touch gesture, an air gesture, a button press, and/or a voice command) corresponding to (e.g., directed toward or directed to) selection of the first slow motion control (e.g., 834c, 836, 836a, and/or 836b). In response to detecting the user input corresponding to selection of the first slow motion control (e.g., 834c, 836, 836a and/or 836b), the computer system (e.g., 100, 300, 500, and/or 600) adjusts slow motion playback of the second media item (e.g., 604a, 608a, 614a, 621a, 622a, 622d, 632f, 632g, 804a, 814a, 816a, 818a, 822a, 840a, and/or 844a) (e.g., adjusting a playback speed of the second media item, selecting one or more frames of a video of the second media item, initiating playback of a video of the second media item at a particular playback time, selecting a playback time of a video of the second media item for stopping and/or ceasing playback of the video of the second media item, and/or applying a respective playback speed to a selected portion of a video of the second media item). Adjusting slow motion playback of the second media item in response to detecting user input corresponding to selection of the first slow motion control allows the computer system to provide additional functions that customize playback of the second media item, thereby improving customization options for media items of the computer system.

In some embodiments, the one or more slow motion controls (e.g., 834c, 836, 836a, and/or 836b) includes a playback speed control (e.g., 834c) (e.g., a button, affordance, graphical user interface element, and/or selectable icon that, when selected via user input, adjusts a speed at which the computer system plays back the video media item relative to a speed at which the video media item was captured and/or a real-time speed). While displaying the one or more slow motion controls (e.g., 834c, 836, 836a, and/or 836b), the computer system (e.g., 100, 300, 500, and/or 600) detects, via the one or more input devices (e.g., 600a and/or 602), user input (e.g., 850w) (e.g., a tap gesture, a swipe gesture, a touch gesture, an air gesture, a button press, and/or a voice command) corresponding to (e.g., directed toward or directed to) the playback speed control (e.g., 834c). In response to detecting the user input (e.g., 850w) corresponding to selection of the playback speed control (e.g., 834c), the computer system (e.g., 100, 300, 500, and/or 600) adjusts a playback speed of the second media item (e.g., 604a, 608a, 614a, 621a, 622a, 622d, 632f, 632g, 804a, 814a, 816a, 818a, 822a, 840a, and/or 844a) (adjusting a speed at which the computer system plays back the video media item relative to a speed at which the video media item was captured and/or a real-time speed). Adjusting a playback speed of the second media item in response to detecting the user input corresponding to selection of the playback speed controls allows the computer system to provide additional functions that customize playback of the second media item, thereby improving customization options for media items of the computer system.

Note that details of the processes described above with respect to method 900 (e.g., FIGS. 9A-9B) are also applicable in an analogous manner to the methods described above/below. For example, methods 700, 1100, and/or 1300 optionally include one or more of the characteristics of the various methods described above with reference to method 900. For example, the computer system of method 700 can be used to further edit video media items that are edited using the computer system of method 900. As another example, the computer system of method 1100 can be used to selectively apply the edits made to a media item using the computer system of method 900 from one media item to another media item. Further still, the computer system of method 1300 can be used to make additional edits to a media item edited using the computer system of method 900. For brevity, these details are not repeated herein.

FIGS. 10A-10R illustrate exemplary user interfaces for selectively applying edits from one image to another image, in accordance with some embodiments. The user interfaces in these figures are used to illustrate the processes described below, including the processes in FIG. 11. In some embodiments, device 1000 of FIGS. 10A-10R includes one or more features of portable multifunction device 100, device 300, or device 500.

In some embodiments, any of the inputs described herein (e.g., input 1005a, 1005b1, 1005b2, 1005b3, 1005c1, 1005c2, 1005c3, 1005c4, 1005c5, 1005d1, 1005d2, 1005d3, 1005e, 1005f, 1005g1, 1005g2, 1005g3, 1005g4, 1005h1, 1005h2, 1005h3, 1005h4, 1005h5, 1005i1, 1005i2, 1005j1, 1005j2, 1005k, 1005l, 1005m, 1005n, 1005p, and/or 1005q) is or includes a touch input (e.g., a tap gesture and/or a swipe gesture). In some embodiments, any of the inputs described herein (e.g., input 1005a, 1005b1, 1005b2, 1005b3, 1005c1, 1005c2, 1005c3, 1005c4, 1005c5, 1005d1, 1005d2, 1005d3, 1005e, 1005f, 1005g1, 1005g2, 1005g3, 1005g4, 1005h1, 1005h2, 1005h3, 1005h4, 1005h5, 1005i1, 1005i2, 1005j1, 1005j2, 1005k, 1005l, 1005m, 1005n, 1005p, and/or 1005q) is or includes a voice input (e.g., a voice command to select a user interface element or to activate a feature or perform a function, such as a feature or function associated with a user interface element). In some embodiments, any of the inputs described herein (e.g., input 1005a, 1005b1, 1005b2, 1005b3, 1005c1, 1005c2, 1005c3, 1005c4, 1005c5, 1005d1, 1005d2, 1005d3, 1005e, 1005f, 1005g1, 1005g2, 1005g3, 1005g4, 1005h1, 1005h2, 1005h3, 1005h4, 1005h5, 1005i1, 1005i2, 1005j1, 1005j2, 1005k, 1005l, 1005m, 1005n, 1005p, and/or 1005q) is or includes an air gesture (e.g., an air gesture to select a user interface element or to activate a feature or perform a function, such as a feature or function associated with a user interface element). In some embodiments, any of the inputs described herein (e.g., input 1005a, 1005b1, 1005b2, 1005b3, 1005c1, 1005c2, 1005c3, 1005c4, 1005c5, 1005d1, 1005d2, 1005d3, 1005e, 1005f, 1005g1, 1005g2, 1005g3, 1005g4, 1005h1, 1005h2, 1005h3, 1005h4, 1005h5, 1005i1, 1005i2, 1005j1, 1005j2, 1005k, 1005l, 1005m, 1005n, 1005p, and/or 1005q) is or includes activation (e.g., a press, a rotation, and/or a movement) of a hardware device (e.g., a button, a rotatable input mechanism, a rotatable and depressible input mechanism, a mouse, a mouse button, a trackpad, a trackpad button, a button of a remote control, and/or a joystick). In some embodiments, any of the inputs described herein (e.g., input 1005a, 1005b1, 1005b2, 1005b3, 1005c1, 1005c2, 1005c3, 1005c4, 1005c5, 1005d1, 1005d2, 1005d3, 1005e, 1005f, 1005g1, 1005g2, 1005g3, 1005g4, 1005h1, 1005h2, 1005h3, 1005h4, 1005h5, 1005i1, 1005i2, 1005j1, 1005j2, 1005k, 1005l, 1005m, 1005n, 1005p, and/or 1005q) as a touch and drag gesture includes an air gesture (e.g., an air gesture including a pinch and/or movement) and/or a click and drag gesture (e.g., a click of a mouse button and/or a trackpad and/or movement while holding a press of a mouse button and/or trackpad) of a mouse and/or trackpad. In some embodiments, any of the user interface elements described as being selected herein (e.g., an icon, affordance, button, and/or selectable option) is selected by activating a hardware device while the user interface element is in focus (e.g., highlighted, bolded, outlined, visually distinguished from other user interface elements, and/or located at or near a cursor).

At FIG. 10A, device 1000 displays, on display 1001, image interface 1002 for an image application. Image interface 1002 is in a non-editing mode and includes thumbnail images 1006 and image 1004. In some embodiments, device 1000 displays image 1004 in response to detecting that image 1004 is a currently selected image from thumbnail images 1006. In some embodiments, image 1004 is video media item. In some embodiments, image 1004 is a video media item that includes depth information (e.g., a depth map) (e.g., depth information detected via a depth sensor and/or determined based on an appearance of one or more object in the video media item (e.g., and/or without depth information that is detected via a depth sensor)). In some embodiments, image 1004 is three-dimensional media item (e.g., a media item that includes information for one or more objects and/or subjects in the media item in a three dimensional environment). In some embodiments, image 1004 includes spatial information (e.g., on a three-dimensional axis) for one or more objects in image 1004. In some embodiments, spatial information includes a spatial relationship between a first object and a second object that is different from the first object. In some embodiments, spatial information includes a three-dimensional relationship between a first object and a second object that is different from the first object. In some embodiments, spatial information includes information for a first perspective of one or more objects in a media item and information for a second perspective of the one or more objects in a media item that is different from the first perspective of the one or more objects. In some embodiments, spatial information includes information to view one or more objects in a media item from a first angle (e.g., perspective and/or viewpoint) and information to view the one or more objects from a second angle (e.g., perspective and/or viewpoint) of the one or more objects in a media item that is different from the first angle.

At FIG. 10A, image interface 1002 includes chrome visual characteristic 1008 and button visual characteristic 1009. Chrome visual characteristic 1008 is dark (e.g., black and/or dark gray) while button visual characteristic 1009 is light (e.g., white and/or light gray). In some embodiments, a parameter (e.g., color and/or brightness) of chrome visual characteristic 1008 and a parameter of button visual characteristic 1009 are based on a display mode of device 1000. In some embodiments, the display mode is a system setting of device 1000. In some embodiments, the display mode is for a particular display theme (e.g., light theme and/or dark theme) and/or is based on a current time relative to a schedule and/or time of day (e.g., day mode and/or night mode). In some embodiments, device 1000 updates the parameter of chrome visual characteristic 1008 and the parameter of button visual characteristic 1009 in response to detecting that the display mode of device 1000 has changed (e.g., either automatically or in response to user input). In such embodiments, in response to detecting the display mode has changed, device 1000 changes the parameter of chrome visual characteristic 1008 from being darker to being lighter while also changing the parameter of button visual characteristic 1009 from being lighter to being darker (or vice versa). In some embodiments, in response to detecting the display mode has changed, device 1000 does not change a parameter of a visual appearance of other portions of image interface 1002 (e.g., image 1004). In some embodiments, the display mode controls a visual appearance of a user interface that is displayed by device 1000 throughout different applications (e.g., including the image application corresponding to image interface 1002 and an application different from the image application) and/or system user interfaces of the computer system. In some embodiments, a particular display mode is manually activated, such as by a user selecting a particular theme and/or mode. In some embodiments, the display mode is automatically activated. In such embodiments, device 1000 detects an event (e.g., a time of day and/or amount of ambient light) and, in response, changes the display mode from one mode to a different mode. At FIG. 10A, device 1000 detects input 1005a (e.g., a touch input, an air gesture, a gaze, and/or a button click) directed at edit option 1010. In response to detecting input 1005a, device 1000 enters an edit mode, as depicted in FIG. 10B.

At FIG. 10B, device 1000 displays image interface 1002 in an edit mode. In some embodiments, at least a portion (e.g., some but not all and/or all) of the image interface 1002 in an edit mode is based on the display mode of device 1000. For example, while in an editing mode, image interface 1002 of FIG. 10B includes chrome visual characteristic 1008 that is similar to chrome visual characteristic 1008 of image interface 1002 of FIG. 10A. Image interface 1002 of FIG. 10B also includes button visual characteristic 1009 that is similar to button visual characteristic 1009 of image interface 1002 of FIG. 10A. In some embodiments, device 1000 changes chrome visual characteristic 1008 and button visual characteristic 1009 in response to detecting a change in the display mode, as described with respect to FIG. 10A.

At FIG. 10B, editing tool options 1012a-1012e are displayed. While in edit mode, image interface 1002 includes editing tool options 1012a-1012e. Editing tool options 1012a-1012e are similar to editing tool options 1204a-1204e of FIGS. 12A-12AK, but have a different state. At FIG. 10B, editing tool options 1012a-1012e include portrait editing mode option 1012a, visual characteristic editing mode option 1012b, filter editing mode option 1012c, image orientation editing mode option 1012d, and cleanup editing mode option 1012e. Mode selection indicator 1207 indicates which editing tool option is currently selected. In some embodiments, editing mode options 1012a-1012e cause device 1000 to enter different editing modes to modify an appearance of image 1004 using different types of tools. In some embodiments, editing tool options 1014a-1014e correspond to different categories of editing tools and/or different editing user interfaces. In some embodiments, an editing tool in one category of editing tools (or, optionally, in one editing user interface) is not provided in a different category of editing tools (or, optionally, other editing user interfaces). In some embodiments, different editing tool options in editing tool options 1012a-1012e correspond to different subsets of editing tools, where an editing tool in one editing tool option is not provided in a different editing tool option.

At FIG. 10B, device 1000 displays options to edit image 1004 via one or more filter editing tools. Filter editing mode option 1012c is selected, as depicted by device 1000 displaying mode selection indicator 1207 above filter editing mode option 1012c. In response to detecting that filter editing mode option 1012c is selected, device 1000 displays editing tool options for applying a filter (e.g., original, vivid, vivid warm, vivid cool, dramatic, dramatic warm, dramatic cool, mono, silvertone, and/or noir) to image 1004. In some embodiments, a filter and/or a style includes a preconfigured set of one or more visual characteristics (e.g., brightness, contrast, shadows, exposure value, highlights, blackpoint, saturation, vibrance, temperature, tint, sharpness, definition, noise reduction, vignette, color, and/or black and white). In some embodiments, a first filter and/or a first style includes a first preconfigured set of one or more visual characteristics and a second filter and/or a second style includes a second preconfigured set of one or more visual characteristics that is different (e.g., non-overlapping and/or at least one visual characteristic that is different) from the first preconfigured set of one or more visual characteristics.

At FIG. 10B, image 1004 has a different visual appearance than image 1004 of FIG. 10A, as illustrated by person 1013 in FIG. 10B having dashed lines. Device 1000 displays image 1004 of FIG. 10B as having a different visual appearance in response to detecting that vivid warm filter 1012b-1 has been applied to image 1004. In some embodiments, vivid warm filter 1012-1 modifies a set of one or more visual characteristics including brightness, contrast, shadows, exposure value, highlights, blackpoint, saturation, vibrance, temperature, tint, sharpness, definition, noise reduction, vignette, color, and/or black and white. In some embodiments, device 1000 modifies a parameter (e.g., intensity and/or magnitude) of the selected filter in response to detecting input 1005b1 (e.g., a swipe, a drag gesture, a mouse click, an air gesture, and/or a touch input) directed at slider tool 1016. At FIG. 10B, the intensity of vivid warm filter 1012b-1 is at 75%. At FIG. 10B, device 1000 displays other filters, such as dramatic cool 1012b-2. In some embodiments, device 1000 displays image 1004 with a different appearance than the appearance of image 1004 in FIG. 10B in response to device 1000 detecting an input directed to dramatic cool filter 1012b-2. While image 1004 has been modified in response to using different tools (e.g., a slider tool 1016 and filter 1012b-1), these tools are a subset of tools that are available under filter editing mode option 1012c (e.g., and/or are not available under other editing modes and/or editing tool options).

At FIG. 10B, in some embodiments and as described in further detail herein, device 1000 detects a request to initiate a process to copy (e.g., replicate and/or transfer) a modification made to image 1004 to another image, such as images 1036, 1052, 1054, and/or 1056 of FIGS. 10K-10R. At FIG. 10B, the appearance of image 1004 has been modified using a single editing tool option (e.g., filter editing mode option 1012c). As described with greater detail with respect to FIG. 10E and/or FIG. 10K, in some embodiments, device 1000 does not display an edit selection interface if an image has been modified using a single editing tool option (e.g., a single category of editing tools and/or a particular type of editing mode). In some embodiments, while image 1004 has been edited via tools associated with filter editing mode option 1012c (e.g., and/or has not been edited via a tool associated with an editing tool option different from filter editing mode option 1012c), device 1000 detects input 1005b2 (e.g., a touch input, an air gesture, a gaze, and/or a button click) directed at menu option 1018. In such embodiments, in response to detecting input 1005b2, device 1000 displays a menu including a copy edits option that is similar to copy edits option 1024 of FIG. 10D.

At FIG. 10B, device 1000 detects an input to further edit image 1004 via a different editing mode. For example, device 1000 detects input 1005b3 (e.g., a touch input, an air gesture, a gaze, and/or a button click) directed at visual characteristic editing mode option 1012b. In response to detecting input 1005b3, device 1000 displays image interface 1002 of FIG. 10C.

At FIG. 10C, device 1000 displays image interface 1002 while in a visual characteristic editing mode, as depicted by device 1000 displaying mode selection indicator 1207 above visual characteristic editing mode option 1012b. Image 1004 of FIG. 10C has a different appearance than image 1004 of FIG. 10B because image 1004 of FIG. 10C has been modified using a tool that is available via visual characteristic editing mode option 1012b. While visual characteristic editing mode option 1012b is selected, device 1000 displays visual characteristic editing tool options 1012b-1, 1012b-2, 1012b-3, 1012b-4, and 1012b-5. Visual characteristic editing tool options 1012b-1, 1012b-2, 1012b-3, 1012b-4, and 1012b-5 each correspond to a tool that modifies a single parameter (e.g., brightness, contrast, shadows, exposure value, highlights, blackpoint, saturation, vibrance, temperature, tint, sharpness, definition, noise reduction, vignette, color, and/or black and white) of image 1004.

At FIG. 10C, multiple visual characteristics of image 1004 have been modified. For example, at FIG. 10C, an exposure value of image 1004 has been modified, as depicted by device 1000 displaying exposure value indicator 1015a. In some embodiments, device 1000 modifies the exposure value in response to detecting an input (e.g., a touch input, an air gesture, a gaze, and/or a button click) that moves slider tool 1016 while visual characteristic editing tool option 1012b-1 (e.g., an exposure value editing tool) is selected. A highlight value of image 1004 has also been modified, as depicted by device 1000 displaying highlight value indicator 1015b. In some embodiments, while visual characteristic editing tool 1012b-2 (e.g., a highlight editing tool) is selected, device 1000 detects an input (e.g., a touch input, an air gesture, a gaze, and/or a button click) to move slider tool 1016 and, in response, modifies the highlight value of image 1004. In some embodiments, visual characteristic editing tool options 1012b-1 and 1012b-2 are a subset of tools that are available via visual characteristics editing mode option 1012b (e.g., and are not available under other editing modes and/or editing tool options).

At FIG. 10C, in some embodiments, device 1000 modifies other visual characteristics. For example, in some embodiments, device 1000 modifies a brilliance value via visual characteristic editing tool option 1012b-2 in response to device 1000 detecting an input (e.g., a touch input, an air gesture, a gaze, and/or a button click) to move slider tool 1016 while visual characteristic editing tool option 1012b-2 is selected. In some embodiments, device 1000 modifies a shadow value via visual characteristic editing tool option 1012b-4 in response to device 1000 detecting an input (e.g., a touch input, an air gesture, a gaze, and/or a button click) to move slider tool 1016 while visual characteristic editing tool option 1012b-4 is selected. In some embodiments, device 1000 modifies a contrast value via visual characteristic editing tool option 1012b-5 in response to device 1000 detecting an input (e.g., a touch input, an air gesture, a gaze, and/or a button click) to move slider tool 1016 while visual characteristic editing tool option 1012b-5 is selected. In some embodiments, device 1000 modifies a color in response to detecting a request to display image 1004 in black and white tones (e.g., while decreasing and/or removing other colors). In some embodiments, device 1000 displays image 1004 in black and white tones in response to detecting a request to reduce a saturation value of image 1004. In some embodiments, while a saturation editing tool option is selected, device 1000 modifies a saturation value in response to detecting an input (e.g., a touch input, an air gesture, a gaze, and/or a button click) that moves slider tool 1016. In some embodiments, while a brightness editing tool option is selected, device 1000 modifies a brightness value in response to detecting an input (e.g., a touch input, an air gesture, a gaze, and/or a button click) that moves slider tool 1016.

At FIG. 10C, in some embodiments, while image 1004 has been modified via editing tools corresponding to filter editing mode option 1012c and visual characteristic editing mode option 1012b, device 1000 detects a request to initiate a process to apply the modifications made to image 1004 to a different image, such as images 1036, 1052, 1054, and/or 1056 of FIGS. 10K-10R. For example, in such embodiments, device 1000 detects input 1005cl (e.g., a touch input, an air gesture, a gaze, and/or a button click) directed at menu option 1018. In such embodiments, in response to detecting input 1005c1, device 1000 displays a menu including a copy edits option, similar to menu 1014 and copy edits option 1024 of FIG. 10F.

At FIG. 10C, device 1000 detects one or more inputs to change an editing mode. At FIG. 10C, device 1000 detects input 1005c2 (e.g., a touch input, an air gesture, a gaze, and/or a button click) directed at portrait editing mode option 1012a. In response to detecting input 1005b2, device 1000 enters a portrait editing mode, as depicted in FIG. 10D. In some embodiments, device 1000 detects input 1005c3 (e.g., a touch input, an air gesture, a gaze, and/or a button click) directed at filter editing mode option 1012c. In such embodiments, in response to detecting input 1005c3, device 1000 returns to a filter editing mode, as depicted in FIG. 10B. In some embodiments, device 1000 detects input 1005c4 (e.g., a touch input, an air gesture, a gaze, and/or a button click) directed at cleanup editing mode option 1012e. In such embodiments, in response to detecting input 1005c4, device 1000 displays an image editing user interface similar to image editing user interface 1202 of FIG. 12B. At FIG. 10C, device 1000 detects input 1005c5 (e.g., a touch input, an air gesture, a gaze, and/or a button click) directed at image orientation editing mode option 1012d. In response to detecting input 1005c5, device 1000 enters an image orientation editing mode, as depicted in FIG. 10E.

At FIG. 10D, in response to detecting input 1005c2 of FIG. 10C, device 1000 displays image interface 1002 while in a portrait editing mode, as depicted by device 1000 displaying mode selection indicator 1207 above portrait editing mode option 1012a. Image 1004 of FIG. 10D has a different appearance than image 1004 of FIGS. 10A-10C because image 1004 of FIG. 10D has been modified using a tool that is available via portrait editing mode option 1012a. For example, at FIG. 10D, device 1000 displays image 1004 with depth effect 1011 (e.g., blurring and/or a bokeh effect). In some embodiments, depth effect 1011 is a simulated depth-of-field effect (e.g., an effect simulating capture with a particular focal length (e.g., f-stop) by selectively blurring portions of a media item that would not be in focus (e.g., would be outside of the depth-of-field) when captured using a lens with the particular focal length). In some embodiments, portrait editing mode option 1012a includes editing tools to modify image 1004 based on image segmentation (e.g., depth information (e.g., a depth map)). In some embodiments, the depth information is captured via one or more sensors (e.g., depth sensors). In some embodiments, the depth information is determined (e.g., inferred and/or calculated) from an appearance of one or more objects in image 1004 (e.g., without using depth information captured via a depth sensor). Device 1000 displays tools to modify a magnitude and/or position of depth effect 1011, including depth effect option 1012a-1, which controls a value (e.g., f-stop value and/or depth value) for depth effect 1011. In some embodiments, device 1000 modifies a magnitude and/or a value for depth effect 1011 in response to detecting input 1005d1 (e.g., a touch input, an air gesture, a gaze, and/or a button click) that moves slider tool 1016. In some embodiments, device 1000 displays depth effect 1011 based on image segmentation.

At FIG. 10D, in some embodiments, device 1000 modifies a brightness of image 1004 based on image segmentation (e.g., a depth map). In some embodiments, device 1000 detects input 1005d2 (e.g., a touch input, an air gesture, a gaze, and/or a button click) directed at lighting effect option 1012a-2. In such embodiments, in response to detecting input 1005d2, device 1000 displays editing tools to modify visual characteristics (e.g., brightness and/or color) of image 1004 based on depth information associated with image 1004. In some embodiments, lighting effect option 1012a-2 includes editing tools that modify a brightness and/or color of image 1004 based on depth information (e.g., a depth map that is detected via depth sensor and/or estimated based on an appearance of visual elements in image 1004). In some embodiments, the depth information is captured via one or more sensors (e.g., depth sensors). In some embodiments, the depth information is determined from an image that does not include captured depth information (e.g., the computer system determines (e.g., infers and/or calculates) depth information based on the appearance of one or more objects in image 1004). In some embodiments, lighting effect option 1012a-2 corresponds to editing tools to modify a brightness based on a segmentation (and/or depth information) of image 1004. In some embodiments, lighting effect option 1012a-2 includes an editing tool that modifies (e.g., increases and/or decreases) a brightness of a first portion of image 1004 without modifying a brightness of a second portion of image 1004, where the second portion of image 1004 is different from the first portion of image 1004. In some embodiments, device 1000 determines the first portion of image 1004 and the second portion of image 1004 based on depth information (e.g., detected and/or inferred). In some embodiments, the computer system modifies image 1004 via lighting effect option 1012a-2 by modifying a brightness level (and/or color) of different portions of image 1004 (and/or different portions of detected facial features) by different amounts based on depth information (e.g., a color, a brightness level, and/or a lighting effect is applied differently based on depth information). In some embodiments, device 1000 modifies image 1004 via lighting effect option 1012a-2 by applying a first level of brightness (and/or color) to a first portion of image 1004 (e.g., a foreground element, a first portion of a foreground element, and/or a first facial feature) and applying a second level of brightness (and/or color) that is different from the first level of brightness to a second portion of image 1004 (e.g., a background element, a second portion of a foreground element, and/or a second facial feature), where the second portion of image 1004 is different from the first portion of image 1004. In some embodiments, device 1000 modifies image 1004 via lighting effect option 1012a-2 by applying a simulated lighting effect (e.g., from a simulated light source). In some embodiments, device 1000 modifies image 1004 via a tool of lighting effect option 1012a-2 by brightening a first facial feature without brightening a second facial feature different from the first facial feature. In some embodiments, device 1000 modifies image 1004 via a tool of lighting effect option 1012a-2 that darkens (e.g., blackens and/or decreases a brightness of) an area around a detected subject in the image. In some embodiments, device 1000 modifies image 1004 via a tool of lighting effect option 1012a-2 that darkens (e.g., blackens and/or decreases a brightness of) an area around a detected subject in the image while editing a color of a detected subject so the color appears in black and/or white color tones (e.g., while decreasing and/or removing other colors). In some embodiments, device 1000 modifies image 1004 via a tool of lighting effect option 1012a-2 lightens (e.g., whitens and/or increases a brightness of) an area around a detected subject while editing a color of a detected subject so that the color appears in black and white color tones (e.g., while decreasing and/or removing other colors). In some embodiments, the simulated lighting effect includes a simulated light source is positioned to substantially recreate the original lighting of a media item (e.g., the natural lighting that was originally captured in the image data for the media item) (e.g., amount of light, color of the light, direction(s) of source(s) of light).

At FIG. 10D, in some embodiments, while image 1004 has been modified via editing tools corresponding to filter editing mode option 1012c, visual characteristic editing mode option 1012b, and portrait editing mode option 1012a, device 1000 detects a request to initiate a process to apply the modifications made to image 1004 to a different image(s), such as images 1036, 1052, 1054, and/or 1056 of FIGS. 10K-10R. For example, in such embodiments, device 1000 detects input 1005d3 (e.g., a touch input, an air gesture, a gaze, and/or a button click) directed at menu option 1018. In such embodiments, in response to detecting input 1005d3, device 1000 displays a menu including a copy edits option, similar to menu 1014 and copy edits option 1024 of FIG. 10F. In some embodiments, device 1000 detects an input to further edit image 1004, such as an input directed at editing mode options 1012a, 1012b, 1012d, and 1012e.

At FIG. 10D, in some embodiments, device 1000 determines that image 1004 corresponds to an animated image media or video media (e.g., a video or a live photo) and, in response, displays an animated media editing mode option. In such embodiments, when an animated media editing mode option is selected, device 1000 displays a particular set of tool options for selecting an image from a sequence of images (e.g., a video) and setting the selected image as a representative image of the sequence of images. In some embodiments, the sequence of images is captured in response to device 1000 detecting activation of a shutter button at a first time (e.g., the device detects pressing of a physical button at the first time or detects a gesture directed at a virtual shutter button at the first time). In some embodiments, the detected activation of the shutter button at the first time is a single activation of the shutter button (e.g., analogous to a single activation used in a digital camera to capture a single image in the still image mode of a conventional digital camera). In response to detecting activation of the shutter button at the first time, device 1000 groups a plurality of images acquired by a camera in temporal proximity to the activation of the shutter button at the first time into a sequence of images. The sequence of images includes: a plurality of images acquired by the camera prior to detecting activation of the shutter button at the first time; a representative image that represents the sequence of images and was acquired by the camera after one or more of the other images in the sequence of images; and a plurality of images acquired by the camera after acquiring the representative image. In some embodiments, the representative image is acquired by the camera at the first time and is analogous to the single image captured in the still image mode of a digital camera when its shutter button is activated. In some embodiments, the representative image acquired by the camera corresponds to an image that was acquired at the first time. In some embodiments, the representative image acquired by the camera corresponds to an image that was acquired shortly after detecting activation of the shutter button at the first time, at a time that takes into account shutter lag (the time delay between detecting activation of the shutter button and capturing/storing the representative image). In some embodiments, the representative image acquired by the camera is used to represent the sequence of images, for example in an image presentation mode. In some embodiments, the sequence of images includes a predefined number of images (e.g., 5, 10, 15, 20, 25, or 30 images) acquired after acquiring the representative image. In some embodiments, the images acquired after acquiring the representative image are images that are within a predefined time after acquiring the representative image (e.g., within 0.5, 1.0, 1.5, 2.0, or 2.5 seconds) after acquiring the representative image. In some embodiments, the sequence of images includes a predefined number of images (e.g., 5, 10, 15, 20, 25, or 30 images) acquired after detecting activation of the shutter button at the first time. In some embodiments, the images acquired after detecting activation of the shutter button at the first time are images that are within a predefined time after the first time (e.g., within 0.5, 1.0, 1.5, 2.0, or 2.5 seconds after the first time). In some embodiments, the plurality of images, in the sequence of images, that are acquired after acquiring the representative image meet predefined grouping criteria. In some embodiments, the predefined grouping criteria include selecting a predefined number of images after the representative image. In some embodiments, the predefined grouping criteria include selecting images in a predefined range of time immediately after detecting activation of the shutter button. In some embodiments, the predefined grouping criteria include selecting images in a predefined range of time immediately after the time at which the representative image is acquired. In some embodiments, the sequence of images is stored as a distinct set of images in the memory (e.g., stored together in a data structure in non-volatile memory). In some embodiments, the representative image acquired by the camera is used to represent the distinct set of images, for example in an image presentation mode. In some embodiments, when an animated media editing mode option is selected, device 1000 displays a particular set of tool options for changing the representative image from a first image in the sequence of images to a second image in the sequence of images that is different from the first image. In some embodiments, the first image is an image that is acquired prior to (or, optionally, after) detecting activation of the shutter button at the first time (and/or the representative image acquired at the first time). In some embodiments, the second image is an image that is acquired prior to (or, optionally, after) detecting activation of the shutter button at the first time (and/or the representative image acquired at the first time).

At FIG. 10E, in response to detecting input 1005c5 of FIG. 10C, device 1000 enters a mode to crop and/or rotate image 1004, as depicted by device 1000 displaying mode selection indicator 1207 above image orientation editing mode option 1012d. While device 1000 is in a mode to crop and/or rotate image 1004, device 1000 displays image interface 1002 that includes editing tool options 1012d-1, 1012d-2, and 1012d-3 for editing an orientation of image 1004. In some embodiments, while rotation option 1012d-1 is selected, device 1000 rotates image 1004 in response to detecting an input directed at slider tool 1016. In some embodiments, while editing vertical skew option 1012d-2 is selected, device 1000 vertically skews image 1004 in response to detecting an input directed at slider tool 1016. In some embodiments, while horizontal skew option 1012d-3 is selected, device 1000 horizontally skews image 1004 in response to detecting an input directed at slider tool 1016.

At FIG. 10E, image 1004 has a different appearance than image 1004 of FIGS. 10C-10D because device 1000 has cropped image 1004 in response to detecting one or more inputs. For example, device 1000 has cropped a portion above top boundary 1020a and a portion below bottom boundary 1020b in response to detecting one or more inputs (e.g., a touch input, an air gesture, a gaze, and/or a button click) to crop image 1004. Image 1004 of FIG. 10E has a different appearance than image 1004 of FIG. 10D because image 1004 of FIG. 10D does not include depth effect 1011.

At FIG. 10E, while image 1004 has been modified via editing tools corresponding to filter editing mode option 1012c, visual characteristic editing mode option 1012b, and image orientation editing mode option 1012d, device 1000 detects a request to initiate a process to apply the modifications made to image 1004 to a different image, such as such as images 1036, 1052, 1054, and/or 1056 of FIGS. 10K-10R. For example, device 1000 detects input 1005e (e.g., a touch input, an air gesture, a gaze, and/or a button click) directed at menu option 1018. In response to detecting input 1005e, device 1000 displays menu 1014, as depicted in FIG. 10F.

At FIG. 10F, menu 1014 includes copy edits option 1024. Device 1000 detects input 1005f (e.g., a touch input, an air gesture, a gaze, and/or a button click) directed at copy edits option 1024. In response to detecting input 1005f, device 1000 initiates a process to apply an edit from image 1004 to a different image. In some embodiments, device 1000 does not have to be in an edit mode to copy and paste edits from one image to another image. For example, in some embodiments, device 1000 detects an input (e.g., a touch input, an air gesture, a gaze, and/or a button click) directed at menu option 1018 of FIG. 10A. In some embodiments, in response to detecting the input at menu option 1018 of FIG. 10A, device 1000 displays a menu that includes a copy edits option similar to copy edits option 1024 of FIG. 10F. In such embodiments, in response to detecting an input directed to the copy edits option that is displayed in response to detecting an input at menu option 1018 of FIG. 10A, device 1000 displays a selection interface that is similar to selection interface 1026 of FIGS. 10G-10I.

At FIG. 10G, in response to detecting input 1005f, device 1000 displays selection interface 1026. Selection interface 1026 includes information about what edits have been made to image 1004. For example, device 1000 displays adjustment indicator 1027b to indicate that a visual characteristic of image 1004 of FIG. 10G has been modified (e.g., via one or more tools of visual characteristic editing mode option 1012b). Device 1000 displays filter indicator 1027c to indicate that a filter has been applied to image 1004 of FIG. 10G (e.g., via one or more tools of filter editing mode option 1012c). Device 1000 displays crop/aspect ratio indicator 1027d to indicate that an orientation of image 1004 of FIG. 10G has been modified (e.g., via one or more tools of image orientation editing mode option 1012d). Device 1000 does not display an indicator for an editing category that has not been used to modify image 1004. For example, because image 1004 of FIG. 10G has not been edited to include depth effect 1011, portrait indicator 1027a of FIG. 10H is not displayed in selection interface 1026 of FIG. 10G.

At FIG. 10G, selection interface 1026 includes options to select and/or deselect modifications that have been made to image 1004 to make the selected modifications available to be applied to a different image. Adjustment option 1028b allows a user to select one or more modifications that were made via visual characteristics editing mode option 1012b. Adjustment option 1028b, when selected (e.g., enabled), causes device 1000 to select the modifications that were made via visual characteristics editing mode option 1012b as described with respect to FIG. 10C (e.g., including the modifications that were made via visual characteristic editing tool option 1012b-1 and visual characteristic editing tool option 1012b-3). Filter option 1028c, when selected (e.g., enabled), causes device 1000 to select the modifications that were made via filter editing mode option 1012c as described with respect to FIG. 10B (e.g., including the selection of filter option 1012c-1 and/or an intensity of that filter). Crop/aspect ratio option 1028d, when selected (e.g., enabled), causes device 1000 to select the modifications that were made via orientation editing tool option 1012d as described with respect to FIG. 10E (e.g., including the cropping of image 1004 as depicted in FIG. 10E). Any combination of edits made to image 1004 are optionally selected in response to device 1000 detecting a request to select (e.g., enable) and/or deselect (e.g., disable) adjustment option 1028b, filter option 1028c, and/or crop/aspect ratio option 1028d. In some embodiments, only a single option is selected. In some embodiments, less than all or all options are selected. In some embodiments, adjustment option 1028b, filter option 1028c, and/or crop/aspect ratio option 1028d are toggle switches. In some embodiments, adjustment option 1028b, filter option 1028c, and/or crop/aspect ratio option 1028d are selectable objects that are different from toggle switches.

At FIG. 10G, several options have a default state of being selected or deselected. For example, adjustment option 1028b and filter option 1028c are automatically selected when selection interface 1026 is initially displayed. In some embodiments, adjustment option 1028b and filter option 1028c are automatically selected because adjustment option 1028b and filter option 1028c have a default selection status of being selected. Crop/aspect ratio option 1028d is automatically deselected when selection interface 1026 is initially displayed. In some embodiments, crop/aspect ratio option 1028d is automatically deselected because crop/aspect ratio option 1028d has a default selection status of being deselected.

At FIG. 10G, while device 1000 displays (e.g., initially displays) selection interface 1026 with several options automatically selected and/or deselected, device 1000 detects an input to select or deselect an option. For example, in some embodiments, device 1000 detects input 1005g1 (e.g., a touch input, an air gesture, a gaze, and/or a button click) directed at adjustment option 1028b. In such embodiments, in response to detecting input 1005g1, device 1000 deselects adjustment option 1028b. In some embodiments, in response to device 1000 detecting that adjustment option 1028b is deselected, device 1000 does not select the modifications that were made via visual characteristics editing mode option 1012b for copying to a different image.

At FIG. 10G, in some embodiments, device 1000 detects input 1005g2 (e.g., a touch input, an air gesture, a gaze, and/or a button click) directed to filter option 1028c. In such embodiments, in response to detecting input 1005g2, device 1000 deselects filter option 1028c. In some embodiments, in response to device 1000 detecting that filter option 1028c is deselected, device 1000 does not select the modifications that were made via filter editing mode option 1012c for copying to a different image.

At FIG. 10G, in some embodiments, device 1000 detects input 1005g3 (e.g., a touch input, an air gesture, a gaze, and/or a button click) directed to crop/aspect ratio option 1028d. In such embodiments, in response to detecting input 1005g3, device 1000 selects crop/aspect ratio option 1028d. In some embodiments, in response to device 1000 detecting that crop/aspect ratio option 1028d is selected, device 1000 selects the modifications that were made via image orientation editing mode option 1012d for copying to a different image.

At FIG. 10G, while adjustment option 1028b and filter option 1028c are selected and crop/aspect ratio option 1028d is not selected, device 1000 detects input 1005g4 (e.g., a touch input, an air gesture, a gaze, and/or a button click) directed at copy option 1030. In response to detecting input 1005g4, device 1000 initiates a process to apply the modifications made via adjustment option 1028b and filter option 1028c while not applying the modifications made via crop/aspect ratio option 1028d to a different image. In some embodiments, in response to detecting input 1005g4, device 1000 initiates a process to select an image to apply the selected modifications, similar to the processes described with respect to FIGS. 10J-10R.

At FIG. 10G, in some embodiments, in response to activation of copy edits option 1024, device 1000 conditionally displays selection interface 1026 based on determining whether a threshold number of edits (e.g., 1, 2, 3, and/or 4) and/or edit categories (e.g., 1, 2, 3, and/or 4) have been used to modify image 1004. In some embodiments, if device 1000 detects activation of copy edits option 1024 when the threshold number of edits and/or threshold number of edit categories has not been met (e.g., a single edit and/or a single edit category has been used to modify an image), then device 1000 does not display selection interface 1026 (e.g., and, optionally, automatically copies all edits). In some embodiments, when the threshold number of edits is two edit categories and an edits of single edit category has been made (e.g., threshold number of edit categories has not been met), device 1000 automatically selects one or more edits (e.g., a plurality of edits) of the single category for copying to another image without displaying selection interface 1026. In some embodiments, if device 1000 detects activation of copy edits option 1024 when the threshold number of edits and/or threshold number of edit categories has been met (e.g., more than one edit and/or more than one edit category has been used to modify an image), then device 1000 displays selection interface 1026. In some embodiments, device 1000 displays selection interface 1026 during a process of selecting modifications to apply to a different image independent of a threshold number of edits and/or threshold number of edit categories being satisfied.

At FIG. 10G, in some embodiments, device 1000 displays selection interface 1026 at a different step in the process of applying edits from one image to another image. For example, in some embodiments, device 1000 does not display selection interface 1026 in response to detecting input 1005f. In such embodiments, device 1000 does not display selection interface 1026 at FIG. 10G. In some embodiments, device 1000 displays selection interface 1026 at FIG. 10M (e.g., when device 1000 detects a request to paste the edits to a different media item) without displaying selection interface 1026 at FIG. 10G. In some embodiments, selection interface 1026 is displayed multiple times during the process of applying edits from one image to another image. In some embodiments, device 1000 displays selection interface 1026 at FIG. 10G and at FIG. 10M. In some embodiments, device 1000 displays selection interface 1026 at FIG. 10G, but does not display the interface at FIG. 10M (e.g., and optionally automatically applies all copied edits to the image).

At FIG. 10H, device 1000 displays (e.g., initially displays) selection interface 1026 with a different set of options than what is included in selection interface 1026 of FIG. 10G because image 1004 of FIG. 10H has different edits applied to it (e.g., as compared to image of FIG. 10G). At FIG. 10H, device 1000 displays selection interface 1026 in response to detecting an input directed to a copy edits option, similar to input 1005f directed to copy edits option 1024 in FIG. 10F. At FIG. 10H, in addition to indications 1028b-1028d, device 1000 displays portrait indicator 1027a that indicates image 1004 has been modified via portrait editing mode option 1012a (e.g., as described with respect to FIG. 10D). In addition to displaying options 1028b-1028d, device 1000 displays portrait option 1028a. In some embodiments, device 1000 displays portrait option 1028a because a depth effect of image 1004 has been modified (as described with respect to FIG. 10D). As depicted in FIG. 10H, portrait option 1028a is automatically selected when selection interface 1026 is initially displayed. In some embodiments, portrait option 1028a is automatically selected because portrait option 1028a has a default status of being selected. In some embodiments, while portrait option 1028a, adjustment option 1028b, and filter option 1028c are selected and while crop/aspect ratio option 1028d is not selected, device 1000 detects input 1005h5 (e.g., a touch input, an air gesture, a gaze, and/or a button click) directed at copy option 1030. In such embodiments, in response to detecting input 1005h5, device 1000 initiates a process to copy the modifications made via portrait editing mode option 1012a, visual characteristic editing mode option 1012b, and filter editing mode option 1012c while not copying the modifications made via crop/aspect ratio option 1028d.

At FIG. 10H, in some embodiments, prior to detecting input 1005h5, the options of selection interface 1026 can be deselected and/or selected. For example, device 1000 optionally selects (or deselects) portrait option 1028a, adjustment option 1028b, filter option 1028c, and/or crop/aspect ratio option 1028d in response to detecting an input (e.g., inputs 1005h1, 1005h2, 1005h3, and/or 1005h4) directed to each respective option. In some embodiments, only a single option is selected. In some embodiments, all options are selected. In some embodiments, any combination of options are selected.

At FIG. 10I, various options of selection interface 1026 have been selected and/or deselected in response to one or more inputs detected by device 1000 of FIG. 10H. For example, in response to detecting input 1005h1, which was directed at portrait option 1028a in FIG. 10H, device 1000 deselects portrait option 1028a, as depicted in FIG. 10I. In response to detecting input 1005h4, which is directed at crop/aspect ratio option 1028d in FIG. 10H, device 1000 selects crop/aspect ratio option 1028d, as depicted in FIG. 10I. At FIG. 10I, while adjustments option 1028b, filter option 1028c, and crop/aspect ratio option 1028d are selected and portrait option 1028a is deselected, device 1000 detects input 1005i1 (e.g., a touch input, an air gesture, a gaze, and/or a button click) directed at copy option 1030. In response to detecting input 1005i1, device 1000 selects the modifications made with respect to visual characteristic editing mode option 1012b, filter editing mode option 1012c, and crop/aspect ratio option 1028d for copying while not selecting the modifications made with respect to portrait editing mode option 1012a for copying.

At FIG. 10I, after detecting input 1005i1, device 1000 detects input 1005i2 (e.g., a touch input, an air gesture, a gaze, and/or a button click) directed at done option 1032. In response to detecting input 1005i2, device 1000 exits the edit mode and displays image interface 1002 of FIG. 10J.

At FIG. 10J, device 1000 is in a non-edit mode and detects a request to view another image. For example, device 1000 detects input 1005j1 (e.g., a touch input, an air gesture, a gaze, and/or a button click) directed at back option 1034. In response to detecting input 1005j1, device 1000 displays a grid view of image interface 1002 as depicted in FIG. 10P. While displaying image interface 1002, device 1000 detects swipe input 1005j2 (e.g., an air gesture and/or a touch input) directed at image 1004. In response to detecting swipe input 1005j2, device 1000 displays image 1036 in image interface 1002 of FIG. 10K.

At FIG. 10K, device 1000 displays image 1036 in image interface 1002 while in a non-edit mode. As depicted, image 1036 does not include one or more edits and/or includes a set of edits other than the edits that have been selected for copying from image 1004. While displaying image 1036, device 1000 detects input 1005k (e.g., a touch input, an air gesture, a gaze, and/or a button click) directed at menu option 1038. In response to detecting input 1005k, device 1000 displays menu 1040, as depicted in FIG. 10L.

At FIG. 10L, device 1000 detects input 1005l directed at paste edits option 1042. In response to detecting input 1005l, device 1000 displays selection interface 1026, as depicted in FIG. 10M. In some embodiments, device 1000 does not display selection interface 1026 in response to detecting input 1005l and, instead, applies the selected edits of image 1004 to image 1036, as depicted in FIGS. 10N-100.

At FIG. 10M, device 1000 displays selection interface 1026 in response to detecting input 1005l. Selection interface 1026 of FIG. 10M is similar to selection interface 1026 of FIGS. 10G-10I but has a different state. In some embodiments, selection interface 1026 of FIG. 10M includes similar graphical objects that were previously displayed in selection interface 1026 of FIGS. 10G-10I. For example, selection interface 1026 of FIG. 10M includes indications 1027a-1027b and options 1028a-1028d. In some embodiments, a selection state of options 1028a-1028d are based on the selection state of options 1028a-1028d of FIG. 10I. In some embodiments, device 1000 at FIG. 10M changes the selection status of portrait option 1028a, adjustments option 1028b, filter option 1028c, and/or crop/aspect ratio option 1028d based on detecting inputs (e.g., a touch input, an air gesture, a gaze, and/or a button click) directed to portrait option 1028a, adjustments option 1028b, filter option 1028c, and/or crop/aspect ratio option 1028d (as described in further detail with respect to FIGS. 10G-101). In some embodiments, as depicted by dashed box 1044, portrait indication 1027a and/or portrait option 1028a are not included in selection interface 1026 in response to device 1000 detecting deselection of portrait option 1028a in selection interface 1026 of FIG. 10I.

At FIG. 10M, in some embodiments, device 1000 displays selection interface 1026 in addition to displaying selection interface 1026 of FIGS. 10G-10I (e.g., which are displayed in response to device 1000 detecting an input directed to copy edits option, as depicted by input 1005f in FIG. 10F). In such embodiments, selection interface 1026 of FIG. 10M is another opportunity for a user to select which modifications will be applied to image 1036.

At FIG. 10M, in some embodiments, device 1000 displays selection interface 1026 of FIG. 10M as an alternative to (and/or without) displaying selection interface 1026 of FIG. 10H and/or FIG. 10I. For example, in some embodiments, device 1000 detects an input (e.g., a touch input, an air gesture, a gaze, and/or a button click) directed to a copy edits option, as depicted by input 1005f in FIG. 10F. In response to detecting the input directed to the copy edits option, device 1000 copies all the edits applied to the image (e.g., without displaying selection interface 1026 of FIG. 10H and/or FIG. 10I). In some embodiments, after detecting the input directed to the copy edits option (e.g., and without displaying selection interface 1026 of FIG. 10H and/or FIG. 10I), device 1000 detects a request to apply the copied edits to a different image (e.g., similar to input 1005l directed to paste edits option 1042). In some embodiments, in response to detecting the request to apply the copied edits to a different image, device 1000 displays selection interface 1026.

At FIG. 10M, device 1000 detects input 1005m (e.g., a touch input, an air gesture, a gaze, and/or a button click) directed to paste option 1046. In response to detecting input 1005m, device 1000 applies selected modifications to a different image, as depicted in FIG. 10N.

At FIG. 10N, image 1036 of FIG. 10N has a different appearance than image 1036 of FIGS. 10K-10M. At FIG. 10N, device 1000 displays image 1036 with an appearance that is based on the edits that were selected in selection interface 1026 of FIG. 10I and/or selection interface 1026 of FIG. 10M. As depicted in FIG. 10I, portrait option 1028a is deselected and adjustments option 1028b, filter option 1028c, and crop/aspect ratio option 1028d are selected. In response to detecting which options are selected and deselected, device 1000 selectively applies the edits from image 1004 to image 1036. At FIG. 10N, image 1036 includes dashed lines 1047 to illustrate that device 1000 displays image 1036 based on the filter edits that were made to image 1004 as described with respect to FIG. 10B and the visual characteristic edits that were made to image 1004 as described with respect to FIG. 10C. For example, device 1000 displays image 1036 with vivid warm filter 1012b-1 of FIG. 10B, an exposure value corresponding to exposure value indicator 1015a of image 1004 of FIG. 10C, and a highlight value corresponding to highlight value indicator 1015b of image 1004 of FIG. 10C. Device 1000 also displays image 1036 based on a magnitude and/or placement of a crop made to image 1004. For example, device 1000 has cropped a portion of image 1036 above top boundary 1020a and a portion below bottom boundary 1020b.

At FIG. 10N, device 1000 does not apply, to image 1036, a particular edit that is not selected in selection interface 1026. For example, image 1036 does not include depth effect 1011 of image 1004. In some embodiments, device 1000 does not apply depth effect 1011 in response to detecting that portrait option 1028a is deselected (e.g., as shown in selection interface 1026 of FIG. 10I and/or FIG. 10M). In some embodiments, in response to detecting input 1005n (e.g., a touch input, an air gesture, a gaze, and/or a button click) directed to edit option 1010, device 1000 enters an edit mode to edit image 1036 similar to the edit mode to edit image 1004 as described with respect to FIGS. 10B-10E. As such, in some embodiments, device 1000 optionally selectively applies the selected edits without entering an edit mode. In some embodiments, image 1036 is a video media item. In some embodiments, image 1036 is a video media item that includes depth information (e.g., a depth map) (e.g., depth information detected via a depth sensor and/or determined based on an appearance of one or more object in the video media item (e.g., and/or without depth information that is detected via a depth sensor)). In some embodiments, image 1036 is a three-dimensional media item (e.g., a media item that includes information for one or more objects and/or subjects in a three dimensional environment). In some embodiments, image 1036 includes spatial information (e.g., on a three-dimensional axis and/or a three-dimensional environment) for one or more objects in image 1036.

At FIG. 10N, in some embodiments, device 1000 applies previously selected edits to different images (e.g., sequentially) without redisplaying selection interface 1026. In some embodiments, after applying selected edits to image 1036, device 1000 detects a request to apply the selected edits to image 1056. In such embodiments, device 1000 detects a request (e.g., a touch input, an air gesture, a button press, a gaze, and/or a speech input) to select image 1056 (e.g., such as input directed at image 1056). In such embodiments, after detecting the request to select image 1056, device 1000 detects a request (e.g., an input similar to input 1005l or input 1005m) to paste the selected edits (e.g., the selected edits that were selected prior to applying the edits to image 1036) to image 1056. In such embodiments, in response to detecting the request to paste (e.g., re-apply) the selected edits to the respective image that is different from image 1036, device 1000 applies the selected edits to the respective image (e.g., without redisplaying selection interface 1026).

At FIG. 10O, image 1036 has a different appearance than image 1036 of FIG. 10N. At FIG. 10O, device 1000 displays image 1036 with an appearance that is based on the edits that were selected in selection interface 1026 of FIG. 10H. As depicted in FIG. 10H, portrait option 1028a is selected, adjustments option 1028b is selected, filter option 1028c is selected, and crop/aspect ratio option 1028d is deselected. As such, device 1000 applies a different subset of edits to image 1036 in FIG. 10O as compared to the subset of edits that have been applied to image 1036 of FIG. 10N. For example, device 1000 displays depth effect 1011 for image 1036 in FIG. 10O in response to determining that portrait option 1028a is selected. Moreover, device 1000 does not display image 1036 of FIG. 10O with the crop of image 1004 of FIG. 10E in response to determining that crop/aspect ratio option 1028d is deselected. For example, device 1000 has not cropped a portion of image 1036 above a position of a top boundary that corresponds to a position of top boundary 1020a of FIG. 10N and a portion below a position of a bottom boundary that corresponds a position of bottom boundary 1020b of FIG. 10N.

At FIG. 10O, some of the subset of edits that have been applied to image 1036 are similar to the subset of edits that have been applied to image 1036 of FIG. 10M. For example, as illustrated by dashed lines 1047 at FIG. 10O, device 1000 displays image 1036 with vivid warm filter 1012b-1 as described with respect to FIG. 10B, an exposure value corresponding to exposure value indicator 1015a as described with respect to FIG. 10C, and a highlight value corresponding to highlight value indicator 1015b as described with respect to FIG. 10C. Thus, device 1000 can present options to the user to select which edits to copy (e.g., based on user input) or to automatically copy all edits (e.g., based on user input) and to present options to the user to select which copied edits to paste (e.g., based on user input) or to automatically paste all copied edits (e.g., based on user input).

At FIGS. 10P-10R, device 1000 applies selected edits to multiple images. At FIG. 10P, device 1000 displays image interface 1002 including image grid 1050 in response to detecting input 1005j1 of FIG. 10J. At FIG. 10P, device 1000 detects that images 1052, 1054, and 1056 have been selected (as illustrated by the check marks in the bottom right corner of images 1052, 1054, and 1056). While images 1052, 1054, and 1056 are selected, device 1000 detects input 1005p (e.g., a touch input, an air gesture, a gaze, and/or a button click) directed at menu option 1018. In response to detecting input 1005p, device 1000 displays menu 1058 that includes paste edits option 1042, as depicted in FIG. 10Q. At FIG. 10Q, device 1000 detects input 1005q (e.g., a touch input, an air gesture, a gaze, and/or a button click) directed at paste edits option 1042. In response to detecting input 1005q, device 1000 applies edits selected in selection interface 1026 of FIG. 10I and/or FIG. 10M to images 1052, 1054, and 1056, as depicted in FIG. 10R. In some embodiments, images 1052, 1054, and 1056 are video media items. In some embodiments, images 1052, 1054, and 1056 are a video media item that include depth information (e.g., a depth map) (e.g., depth information detected via a depth sensor and/or determined based on an appearance of one or more object in the video media item (e.g., and/or without depth information that is detected via a depth sensor)). In some embodiments, images 1052, 1054, and 1056 are three-dimensional media items (e.g., a media items that include information for one or more objects and/or subjects in the media item in a three dimensional environment). In some embodiments, images 1052, 1054, and 1056 include spatial information (e.g., on a three-dimensional axis) for one or more objects in images 1052, 1054, and 1056.

At FIG. 10R, images 1052, 1054, and 1056 of FIG. 10R have a different visual appearance than images 1052, 1054, and 1056 of FIG. 10P based on applying the edits that were selected via selection interface 1026 of FIG. 10I and/or FIG. 10M (e.g., and without applying the deselected edits). Accordingly, device 1000 applies a selected subset of edits made to image 1004 to multiple images. In some embodiments, device 1000 applies edits that were selected via selection interface 1026 of FIGS. 10H-I and/or FIG. 10M (e.g., and without applying the deselected edits) from first video media item to one or more video media item that are different from first video media item. In some embodiments, device 1000 applies edits that were selected via selection interface 1026 of FIGS. 10H-I and/or FIG. 10M (e.g., and without applying the deselected edits) from first video media item including depth information (e.g., a depth map) (e.g., depth information detected via a depth sensor and/or determined based on an appearance of one or more object in the video media item (e.g., and/or without depth information that is detected via a depth sensor)) to one or more video media items that include depth information that are different from first video media item. In some embodiments, device 1000 applies edits that were selected via selection interface 1026 of FIGS. 10H-I and/or FIG. 10M (e.g., and without applying the deselected edits) from a first three-dimensional media item (e.g., a media item that includes information for one or more objects and/or subjects in the media item in a three dimensional environment) to one or more three dimensional media items that are different from the first three-dimensional media item. In some embodiments, device 1000 applies edits that were selected via selection interface 1026 of FIGS. 10H-I and/or FIG. 10M (e.g., and without applying the deselected edits) from a first media item (e.g., photo and/or video) that includes spatial information (e.g., on a three-dimensional axis) for one or more objects in the first media item to one or more media items that includes spatial information (e.g., on a three-dimensional axis) for one or more objects in one or more media items.

FIG. 11 is a flow diagram illustrating a method for selectively applying edits from one image to another image in accordance with some embodiments. Method 1100 is performed at a computer system (e.g., 100, 300, 500, 1000, 1200, and/or 1232) (e.g., a smartphone, a tablet computer, a laptop computer, a desktop computer, and/or a head mounted device (e.g., a head mounted augmented reality and/or extended reality device)) that is in communication with one or more display generation components (e.g., 1001, 1201 and/or 1233) (e.g., a display controller, a touch-sensitive display system, a monitor, and/or a head mounted display system) and one or more input devices (e.g., 1001, 1201 and/or 1234) (e.g., a touch-sensitive surface, a keyboard, a controller, and/or a mouse). In some embodiments, the computer system in communication with one or more cameras (e.g., an infrared camera, a depth camera, and/or a visible light camera). Some operations in method 1100 are, optionally, combined, the orders of some operations are, optionally, changed, and some operations are, optionally, omitted.

As described below, method 1100 provides an intuitive way for selectively applying edits from one image to another image. The method reduces the cognitive burden on a user for editing media, thereby creating a more efficient human-machine interface. For battery-operated computing devices, enabling a user to edit media faster and more efficiently conserves power and increases the time between battery charges.

Subsequent to a first media item (e.g., 1004, 1036, 1052, 1054, and/or 1056) (e.g., image data, photograph, video, a photograph and/or video item including depth information, a three-dimensional media item, and/or a media item including spatial information (e.g., on a three-dimensional axis and/or in a three-dimensional environment)) having been edited using a set of edits (e.g., the edits described with respect to FIGS. 10B-10E, 1015a, 1015b, 1011, 1020a, 1020b, and/or edits made via 1012a-1012e) (e.g., where the set of edits include one or more changes to the appearance of the first media item after the first media item has been captured), the computer system detects (1102), via the one or more input devices, a request (e.g., 1005e, 1005f, 1005g1-1005g4, 1005h1-1005h5, 1005j1, 1005j2, 1005k, 1005l, 1005m, 1005p, and/or 1005q) (e.g., one or more gestures, one or more mouse clicks, and/or one or more taps) to modify a set of one or more media items (e.g., 1004, 1036, 1052, 1054, and/or 1056) (e.g., image data, photograph, video, a photograph and/or video item including depth information, a three-dimensional media item, a media item including spatial information (e.g., on a three-dimensional axis and/or in a three-dimensional environment)) based on a respective subset of the set of edits that were made to the first media item (e.g., a subset of the edits described with respect to FIGS. 10B-10E; a subset of edits including one or more of edits 1015a, 1015b, 1011, 1020a, and/or 1020b; and/or a subset of edits including one or more edits made via 1012a-1012e), where the respective subset of one or more edits includes (1104) one or more edits from the set of edits that were made to the first media item (e.g., the subset of the edits includes one or more edits described with respect to FIGS. 10B-10E, 1015a, 1015b, 1011, 1020a, 1020b, and/or edits made via 1012a-1012e) and the set of one or more media items includes (1106) a second media item (e.g., 1004, 1036, 1052, 1054, and/or 1056) that is different from the first media item. In some embodiments, the request to modify the set of one or more media items includes a series of one or more inputs. In some embodiments, the series of one or more inputs to modify the set of one or more media items includes an input that corresponds to a copy selectable graphical object that, when selected, copies at least a portion of the set of one or more edits. In some embodiments, the series of one or more inputs to modify the set of one or more media items includes an input that corresponds to a paste selectable graphical object that, when selected, applies at least a portion of the set of respective edits to the set of one or more media items. In some embodiments, the series of one or more inputs to modify the set of one or more media items includes one or more inputs that correspond to a selection of the set of one or more media items to be modified. In some embodiments, the series of one or more inputs to modify the set of one or more media items a confirmation to apply the set of respective edits to the set of one or more media items. In response to detecting the request to modify the set of one or more media items based on the respective subset of the set of edits that were made to the first media item 1108 and in accordance with a determination that a first subset of one or more edits (e.g., a subset of the edits described with respect to FIGS. 10B-10E; a subset of edits including one or more of edits 1015a, 1015b, 1011, 1020a, and/or 1020b; and/or a subset of edits including one or more edits made via 1012a-1012e) (e.g., some but not all and/or less than all) of the set of edits is selected, the computer system modifies (1110) the set of one or more media items by applying the first subset of one or more edits to the set of one or more media items (e.g., a subset of edits have been applied to images 1036, 1052, 1054, and/or 1056 as described with respect to FIGS. 10N-10P), wherein the first subset of one or more edits does not include at least one edit included in the set of edits (e.g., 1036 of FIG. 10N does not include 1011; 1036 of FIG. 10M does not include a crop edit corresponding to 1020a, and/or 1020b; the first subset of one or more edits does not include at least one edit described with respect to FIGS. 10B-10E; the first subset of one or more edits does not include at least one of 1015a, 1015b, 1011, 1020a, and/or 1020b; the first subset of one or more edits does not include at least one of the edits made via 1012a-1012e; and/or the first subset of one or more edits does not include one or more edits as depicted in FIGS. 10N-10M) (e.g., some, but not all, of the edits made to the first media item are used in modifying the set of one or more media items). In some embodiments, in accordance with a determination that the first subset of one or more edits of the set of edits is not selected, the computer system forgoes applying the first subset of one or more edits to the set of one or more media items. In some embodiments, the first subset of one or more edits is applied without applying a second set of one or more edits to the set of one or more media items. In response to detecting the request to modify the set of one or more media items based on the respective subset of the set of edits that were made to the first media item 1108 and in accordance with a determination that a second subset of one or more edits (e.g., some but not all and/or less than all) of the set of edits is selected (e.g., a subset of the edits described with respect to FIGS. 10B-10E; a subset of edits including one or more of edits 1015a, 1015b, 1011, 1020a, and/or 1020b; and/or a subset of edits including one or more edits made via 1012a-1012e), the computer system modifies (1112) the set of one or more media items by applying the second subset of one or more edits to the set of one or more media items, wherein the second subset of one or more edits is different from the first subset of one or more edits (e.g., 1036 of FIG. 10N does not include 1011 that is included in 1036 of FIG. 10M; 1036 of FIG. 10M does not include a crop edit corresponding to 1020a, and/or 1020b that is included in 1036 of FIG. 10N; the second subset of one or more edits does includes at least one edit described with respect to FIGS. 10B-10E that does not overlap with an edit in the first subset of edits; the second subset of one or more edits includes at least one of 1015a, 1015b, 1011, 1020a, and/or 1020b that that does not overlap with an edit in the first subset of edits; and/or the second subset of one or more edits includes at least one of the edits made via 1012a-1012e that does not overlap with an edit in the first subset of edits) (e.g., the second subset of edits includes an edit that is not included in the first subset of edits and/or vice versa) (e.g., the edits of the second subset of edits do not overlap with (e.g., are not included in) the edits of the first subset and/or vice versa). In some embodiments, the second subset of one or more edits does not (or, optionally, does) include at least one edit included in the set of edits (e.g., some, but not all, of the edits made to the first media item are used in modifying the set of one or more media items). In some embodiments, in accordance with a determination that the second subset of one or more edits of the set of edits is not selected, the computer system forgoes applying the second subset of one or more edits to the set of one or more media items. In some embodiments, the second subset of one or more edits is applied without applying the first subset of edits to the set of one or more media items. In some embodiments, the computer system applies both the first subset of edits and the second subset of edits to the set of one or more media items (e.g., when both the first subset of edits and the second subset of edits are selected). Detecting a request to modify a set of one or more media items based on a respective subset of one or more edits that were made to the first media item subsequent to a first media item having been edited using a set of edits where the respective edits includes of one or more edits includes one or more edits from the set of edits and the set of one or more media items includes a second media item that is different from the first media item, and, in response, conditionally modifying the set of one or more media items by applying the first subset of one or more edits of the set of edits and/or the second subset of one or more edits of the set of edits based on whether the first subset of one or more edits and/or the second subset of one or more edits of the set of edits performs an operation when a set of conditions has been met without requiring further user input and provides additional control options to selectively apply edits from one media item to another media item.

In some embodiments, the set of one or more media items includes a third media item (e.g., 1004, 1036, 1052, 1054, and/or 1056) that is different from the first media item and the second media item (e.g., the edits from 1004 are applied to 1036 are subsequently applied to a different image, such as images 1052, 1054, 1056; and/or the edits from 1004 are applied are concurrently applied to images 1052, 1054, 1056 as described with respect to FIGS. 10P-10R) (e.g., the edits are applied to multiple media items). In some embodiments, the one or mode media items includes a plurality of media items (e.g., of varying sizes, resolutions, and/or aspect ratios). In some embodiments, the computer system applies a selected set of edits (e.g., the first subset of one or more edits the second subset of one or more edits) to the first media item and the third media item at the same time and/or concurrently (e.g., based on both the first media item and the third media item being selected when the selected set of edits are pasted and/or applied). In some embodiments, the computer system sequentially applies a selected set of edits (e.g., the first subset of one or more edits the second subset of one or more edits) to the first media item and the third media item. In such embodiments, the computer system detects, at a first time, a first request to apply a selected set of edits to the first media item (e.g., where the first request includes a request to copy a selected set of edits and/or a request to paste the selected edits to the first media item) and, after applying the selected set of edits to the first media item, the computer system detects, at a second time that is different from the first time, a second request to apply the selected set of edits to the third media item (e.g., where the second request includes a request to paste the selected set of edits to the third media item without including a request to copy (e.g., re-copy) the selected set of edits). Including a third media item in addition to the second media item in the set of one or more media items reduces the number of inputs needed to perform an operation allows for selectively applying edits made one media item to multiple other media items.

In some embodiments, prior to detecting the request to modify the set of one or more media items based on the respective subset of the set of edits that were made to the first media item, the computer system detects, via the one or more input devices, a request (e.g., 1005f) (e.g., one or more inputs) to initiate a process to copy edits of the set of edits that were made to the first media item (e.g., 1005f initiates a process to copy edits made to 1004). In response to detecting the request to initiate the process to copy the edits of the set of edits that were made to the first media item, the computer system displays, via the one or more display generation components, a user interface (e.g., 1026 of FIGS. 10G-10H) configured to receive one or more user inputs to select a respective subset, of the set of edits, to be copied (e.g., 1026 includes options to select a set of edits, as depicted in FIGS. 10G-10H). Displaying a user interface configured to receive one or more user inputs to select a respective subset, of the set of edits, to be copied in response to a request to initiate a process to copy edits of the set of edits that were made to the first media item provides additional control options to selectively apply edits from one media item to another media item.

In some embodiments, displaying the user interface includes displaying a set of (e.g., one or a plurality of) graphical elements (e.g., 1027a-1027d of FIGS. 10G-10I and/or 1028a-1028d of FIGS. 10G-101) that correspond to the set of edits that were made to the first media item. In some embodiments, when a respective graphical element of the set of graphical elements is selected, a respective edit of the set of edits corresponding to the selected respective element is included as part of the respective subset of the one or more edits to be copied. Displaying the user interface includes displaying a set of graphical elements that correspond to the set of edits that were made to the first media item reduces the number of inputs required, during a process to copy edits, to view a list of edits made to the first media item and provides visual feedback of the edits made to the first media item.

In some embodiments, displaying the set of graphical elements includes, in accordance with a determination that the set of edits that were made to the first media item is a first set of edits (e.g., the edits to image 1004 of FIG. 10G include edits corresponding to 1027b-1027d as described with respect to FIG. 10G; and/or the edits to image 1004 of FIGS. 10H-10I include edits corresponding to 1027a-1027d as described with respect to FIGS. 10H-101), the computer system displaying the set of graphical elements with a first visual appearance (e.g., 1027b-1027d and/or 1028b-1028d are included in 1026 of FIG. 10G; and/or 1027a-1027d and/or 1028a-1028d are included in 1026 of FIGS. 10H-101) (e.g., the set of graphical elements is a first set of graphical elements). In some embodiments, displaying the set of graphical elements includes, in accordance with a determination that the set of edits that were made to the first media item is a second set of edits that is different from the first set of edits (e.g., the edits to image 1004 of FIG. 10G include edits corresponding to 1027b-1027d as described with respect to FIG. 10G; and/or the edits to image 1004 of FIGS. 10H-10I include edits corresponding to 1027a-1027d as described with respect to FIGS. 10H-101), the computer system displaying the set of graphical elements with a second visual appearance (e.g., 1027b-1027d and/or 1028b-1028d are included in 1026 of FIG. 10G; and/or 1027a-1027d and/or 1028a-1028d are included in 1026 of FIGS. 10H-101) (e.g., the set of graphical elements is a second set of graphical elements that is different from the first set of graphical elements) that is different from the first visual appearance. Conditionally displaying the set of graphical elements with a different visual appearance when the set of edits that were made to the first media item is a first set of edits or a second set of edits, different from the first set, performs an operation when a set of conditions has been met without requiring further user input, declutters the user interface and provides additional control options to selectively apply edits from one media item to another media item.

In some embodiments, the set of graphical elements include a first selectable object (e.g., 1028a-1028d in FIGS. 10H-101) to enable and/or disable (e.g., activate and/or deactivate) the copying of a first edit (e.g., an edit described with respect to FIGS. 10B-10E, 1015a, 1015b, 1011, 1020a, 1020b, and/or one or more edits made via 1012a-1012e) (e.g., a single edit and/or single category of a first set of one or more edits) made to the first media item. In some embodiments, the set of graphical elements include a second selectable object (e.g., 1028a-1028d in FIGS. 10H-101), different from the first selectable object, to enable and/or disable (e.g., activate and/or deactivate) the copying of a second edit (e.g., an edit described with respect to FIGS. 10B-10E, 1015a, 1015b, 1011, 1020a, 1020b, and/or one or more edits made via 1012a-1012e) (e.g., a single edit and/or single category of a second set of one or more edits) made to the first media item, wherein the second edit is different from the first edit. In some embodiments, the computer system detects an input directed to the set of graphical elements. In response to detecting the input directed to the set of graphical elements and in accordance with a determination that the input is directed to the first selectable object, enable and/or disable the copying of a first edit made to the first media item. In response to detecting the input directed to the set of graphical elements and in accordance with a determination that the input is directed to the second selectable object, enable and/or disable the copying of a second edit made to the first media item, wherein the second edit is different from the first edit. Including a first selectable object to enable and/or disable the copying of a first edit and a second selectable object to enable and/or disable the copying of a second edit made to the first media item that is different from the first edit provides additional control options to selectively apply edits from one media item to another media item and provides visual feedback as to which edits are being selected.

In some embodiments, the first selectable object (e.g., a switch, slider, and/or check mark) is displayed adjacent to (e.g., near and/or within a threshold distance of) a representation (e.g., 1027a-1027d) (e.g., image and/or text) of the first edit (e.g., 1027a-1027d are adjacent to 1028a-1028d as depicted in FIGS. 10H-101). In some embodiments, the first toggle selectable object is aligned with (e.g., visually and/or spatially) (e.g., and/or is in a respective direction of) the representation of the first edit. In some embodiments, the second selectable object is displayed adjacent to a representation (e.g., 1027a-1027d) of the second edit (e.g., 1027a-1027d are adjacent to 1028a-1028d as depicted in FIGS. 10H-101), wherein the representation of the second edit is different from the representation of the first edit.

In some embodiments, a visual appearance of the first selectable object indicates whether first edit is enabled or disabled. In some embodiments, a visual appearance of the second selectable object indicates whether the second edit is enabled or disabled. Displaying a first selectable object that is adjacent a representation of the first edit a second selectable object that is adjacent to a representation of the second edit provides additional control options to selectively apply edits from one media item to another media item and provides visual feedback as to which edits are being selected.

In some embodiments, the first edit is enabled for copying by default (e.g., 1028a, 1028b, 1028c are on by default as depicted in FIGS. 10G-10H) (e.g., automatically and/or are preconfigured to be selected). In some embodiments, the computer system detects a request to disable the first edit after the first edit has been enabled by default. In some embodiments, the second edit is disabled for copying by default (e.g., 1028d is off by default as depicted in FIG. 10H). In some embodiments, the computer system detects a request to enable the second edit after the second edit has been disabled by default. Enabling the first edit for copying by default and disabling the second edit by default reduces the number of user inputs and provides additional control options to selectively apply edits from one media item to another media item.

In some embodiments, the second edit includes an edit that crops (e.g., image 1004 of FIG. 10E is cropped at 1020a and 1020b) (e.g., change a size and/or an aspect ratio of an image) and/or rotates (e.g., device 1000 rotates image 1004 in response to detecting an input directed at slider tool 1016 while rotation option 1012d-1 is selected, as described with respect to FIG. 10E) (e.g., clockwise, counterclockwise, 90 degrees, and/or 180 degrees) a media item. In some embodiments, the edit to crop and/or rotate is made via a cropping edit tool (e.g., a tool that crops the first media item) and/or made via an orientation edit tool (e.g., a tool that rotates the first media item). In some embodiments, the cropping edit tool modifies a magnitude of a crop of the first media item. In some embodiments, the rotation edit tool modifies an orientation (e.g., rotation and/or position) of the first media item. Having the second edit disabled by default when it includes an edit to crop and/or rotate a media item reduces the number of user inputs and provides additional control options to selectively apply edits from one media item to another media item.

In some embodiments, the first edit includes an edit that changes (e.g., modifies, specifies, and/or sets) a color (e.g., a color of image 1004 is edited so as to include black and white tones (e.g., while not including and/or decreasing other colors)) (e.g., hue), a saturation (e.g., a saturation of image 1004 is edited so as to include an increased and/or decreased level of saturation) (e.g., intensity of hues), and/or a brightness (e.g., a brightness of image 1004 is edited so as to include an increased and/or decreased level of brightness) (e.g., lightness or darkness of colors) of a media item. In some embodiments, the edit that changes the color is made via a color edit tool (e.g., a tool that modifies a color of the first media item). In some embodiments, the color edit tool modifies a magnitude a color characteristic of the first media item (e.g., editing a color, editing a color saturation, and/or editing a brightness of a color). In some embodiments, the computer system displays separate selectable objects that are used to individually select a color, a saturation, and/or a brightness (e.g., the computer system displays a color selectable object (e.g., a switch, slider, and/or check mark) adjacent to a representation of an edit that changes a color of the media item (e.g., if a color of the media item has been edited), a saturation selectable object adjacent to a representation of an edit that changes a saturation of the media item (e.g., if a saturation of the media item has been edited), and/or a brightness selectable object adjacent to a representation of an edit that changes a brightness of the media item of a media item (e.g., if a brightness of the media item has been edited)). In some embodiments, the computer system displays a single selectable object that is used for selecting one or more edits for all three parameters (e.g., a single selectable object is configured select one or more edits corresponding to a change a color, a change in saturation, and/or a change in a brightness). In such embodiments, the single selectable object is displayed if at least one parameter (e.g., a color, a saturation, and/or a brightness) of a media item has been edited. Having the first edit enabled by default when it includes an edit to change a color, a saturation, and/or a brightness of media item reduces the number of user inputs and provides additional control options to selectively apply edits from one media item to another media item.

In some embodiments, first edit includes an edit that is based on a depth map (e.g., 1004 includes 1011) (e.g., image depth information, information indicating the depth of objects in an image, information indicating whether an object in the foreground would be in focus while one or more objects in the background should be out of focus, information indicating whether an image should be modified based on the depth information). In some embodiments, the depth map is based on depth information that is captured via one or more sensors (e.g., depth sensors and/or one or more cameras) and/or depth information that is determined from an image that does not include captured depth information (e.g., the computer system determines (e.g., infers and/or calculates) depth information based on the appearance of one or more objects in the captured image). In some embodiments, the edit based on a depth map modifies a magnitude and/or position of a synthetic depth of field effect of the media item being edited (e.g., the first media item and/or a second media item). Having the first edit enabled by default when it includes an edit based on a depth map reduces the number of user inputs and provides additional control options to selectively apply edits from one media item to another media item.

In some embodiments, the first subset of one or more edits (or, optionally, the second subset of one or more edits) includes an edit that is based on image segmentation (e.g., 1011 and/or a brightness effect is applied based on image segmentation, as described with respect to FIG. 10D) (e.g., based on a depth map) (e.g., image depth information, information indicating the depth of objects in an image, information indicating whether an object in the foreground would be in focus while one or more objects in the background should be out of focus, information indicating whether an image should be modified based on the depth information). In some embodiments, an edit that is based on image segmentation includes an edit that changes an f-stop value and/or a simulated lighting effect (e.g., that modifies a brightness of a media item based on image segmentation (e.g., based on a depth map or other segmentation of a foreground or subject) or based on a location and/or appearance of an identified subject) of a media item. In some embodiments, an edit that is based on image segmentation includes an edit to simulated depth-of-field effect (e.g., an effect simulating capture with a particular focal length (f-stop) by selectively blurring portions of a media item that would not be in focus (e.g., would be outside of the depth-of-field) when captured using a lens with the particular focal length) and/or displaying the media item with depth information. In some embodiments, the edit based on a depth map modifies a magnitude and/or position of a synthetic depth of field effect of the media item being edited (e.g., the first media item and/or a second media item). In some embodiments, the depth map is based on depth information that is captured via one or more sensors (e.g., depth sensors and/or one or more cameras) and/or depth information that is determined from an image that does not include captured depth information (e.g., the computer system determines (e.g., infers and/or calculates) depth information based on the appearance of objects in the captured image). In some embodiments, a segmentation edit includes an edit that modifies a brightness of the media idem (e.g., to create a simulated lighting effect (e.g., from a simulated light source)) based on a segmentation of the media item (e.g., and/or a depth map). In some embodiments, the computer system modifies a brightness of the media item based on depth information (e.g., the lighting effect is applied differently based on depth information). In some embodiments, the depth information is captured via one or more sensors (e.g., depth sensors and/or one or more cameras) and/or is determined from an image that does not include captured depth information (e.g., the computer system determines (e.g., infers and/or calculates) depth information based on the appearance of objects in the captured image). In some embodiments, applying a segmentation edit includes applying a first level of brightness (e.g., a first amount of a simulated lighting effect) to a first portion of a media item (e.g., a foreground element, a first portion of a foreground element, and/or a first facial feature (e.g., nose, forehead, cheeks, and/or chin)) while applying a second level of brightness (e.g., a second amount of a simulated lighting effect) that is different from the first level of brightness to a second portion of the media item (e.g., a background element, a second portion of a foreground element, and/or a second facial feature (e.g., nose, forehead, cheeks, and/or chin)), where the second portion of the media item is different from the first portion of the media item. In some embodiments, the computer system modifies a brightness of the media item (e.g., applies a simulated lighting effect) based on (e.g., dependent on and/or in accordance with a determination of) a location of a detected subject (e.g., a detected person and/or detected object in the media item) (e.g., the computer system applies a first level of brightness at a location corresponding to a location the detected subject while not applying the first level of brightness (or, optionally, applying a second level of brightness that is different from the first level of brightness) at a location that is different from the location of the detected subject). In some embodiments, the computer system modifies a level of brightness of the media item based on (e.g., dependent on and/or in accordance with a determination of) a location of one or more detected facial features (e.g., the computer system applies a first level of brightness at a location of a first detected facial feature while not applying the first level of brightness (or, optionally, applying a second level of brightness that is different from the first level of brightness) to a location of a second detected facial feature that is different from the location of the first detected facial feature). In some embodiments, the computer system darkens (e.g., blackens and/or decreases a brightness of) an area around a detected subject in the media (e.g., without darkening an area corresponding to a detected subject in the media). In some embodiments, the computer system darkens (e.g., blackens and/or decreases a brightness of) an area around a detected subject in the image while editing a color of a detected subject so the color of the detected subject appears in black and/or white color tones (e.g., while decreasing and/or removing other colors). In some embodiments, the computer system lightens (e.g., whitens and/or increases a brightness of) an area around a detected subject while editing a color of a detected subject so that the color of the detected subject appears in black and white color tones (e.g., while decreasing and/or removing other colors). In some embodiments, the simulated lighting effect includes a simulated light source is initially positioned to substantially recreate the original lighting of a media item (e.g., the natural lighting that was originally captured in the image data for the media item) (e.g., amount of light, color of the light, direction(s) of source(s) of light). Conditionally modifying the set of one or more media items using an edit that that is based on image segmentation performs an operation when a set of conditions has been met without requiring further user input and provides additional control options to selectively apply edits from one media item to another media item.

In some embodiments, the first subset of one or more edits (or, optionally, the second subset of one or more edits) includes an edit that is based on a selection of a filter and/or a style (e.g., 1004 includes vivid warm filter 1012b-1, as described with respect to FIG. 10B) (e.g., a visual filter and/or visual style that applies multiple types of changes). In some embodiments, the filter and/or style is a black-and-white filter, a vivid filter to increase a color saturation of the image, a warm filter to increase the warmth of colors in the image, a cool filter to decrease the warmth of colors in the image. In some embodiments, the filter and/or style is selected from among a plurality of different filters and/or styles. Conditionally modifying the set of one or more media items by using an edit that is based on selection of a filter and/or a style performs an operation when a set of conditions has been met without requiring further user input and provides additional control options to selectively apply edits from one media item to another media item.

In some embodiments, the first subset of one or more edits (or, optionally, the second subset of one or more edits) includes an edit to change (e.g., modify, specify, and/or set) a color (e.g., an edit that changes a color of image 1004 is applied to images 1036, 1052, 1054, and/or 1056) (e.g., hue), a saturation (e.g., an edit that changes a saturation of image 1004 is applied to images 1036, 1052, 1054, and/or 1056) (e.g., intensity of hues), and/or a brightness (e.g., an edit that changes a brightness of image 1004 is applied to images 1036, 1052, 1054, and/or 1056) (e.g., lightness or darkness of colors). In some embodiments, the edit that changes the color is made via a color edit tool (e.g., a tool that modifies a color of the first media item). In some embodiments, the color edit tool modifies a magnitude a color characteristic of the first media item (e.g., editing a color, editing a color saturation, and/or editing a brightness of a color). Conditionally modifying the set of one or more media items by using that includes an edit to change a color, a saturation, and/or a brightness performs an operation when a set of conditions has been met without requiring further user input and provides additional control options to selectively apply edits from one media item to another media item.

In some embodiments, the first subset of one or more edits (or, optionally, the second subset of one or more edits) includes an edit to crop (e.g., an edit that changes crop of image 1004 is applied to images 1036, 1052, 1054, and/or 1056) (e.g., change a size and/or an aspect ratio of an image) and/or rotate (e.g., an edit that changes a rotation of image 1004 is applied to images 1036, 1052, 1054, and/or 1056) (e.g., clockwise, counterclockwise, 90 degrees, and/or 180 degrees) an image. In some embodiments, the edit is made via a cropping edit tool (e.g., a tool that crops the first media item) and/or made via an orientation edit tool (e.g., a tool that rotates the first media item). In some embodiments, the cropping edit tool modifies a magnitude of a crop of the first media item. In some embodiments, the rotation edit tool modifies an orientation (e.g., rotation and/or position) of the first media item. Conditionally modifying the set of one or more media items by using an edit to crop and/or rotate performs an operation when a set of conditions has been met without requiring further user input and provides additional control options to selectively apply edits from one media item to another media item.

In some embodiments, prior to detecting the request to modify the set of one or more media items based on the respective subset of the set of edits that were made to the first media item (e.g., prior to input 1005l), the computer system detects, via the one or more input devices, a request (e.g., input 1005f) (e.g., one or more inputs) to initiate a process to copy edits of the set of edits that were made to the first media item (e.g., input 1005f directed to 1024 initiates a process to copy edits made to image 1004). In some embodiments, in response to detecting the request to initiate the process to copy the edits of the set of edits that were made to the first media item and in accordance with a determination that the set of edits that were made to the first media item (e.g., including the first subset of one or more edits and/or the second subset of one or more edits) include one or more edits from more than a threshold number of different (e.g., a plurality and/or two or more) edit categories (e.g., the set of edits include edits from two or more of 1012a, 1012b, 1012c, 1012d, and/or 1012e) (e.g., the set of edits include edits from two or more different edit categories or three or more different edit categories), the computer system displays, via the one or more display generation components, a user interface (e.g., 1026) configured to receive one or more user inputs to select a respective subset (e.g., 1026 includes 1028a, 1028b, 1028c, and/or 1028d that selects edits corresponding to 1012a, 1012b, 12012c, and/or 1012d, accordingly), of the set of edits, to be copied. In some embodiments, the one or more edits are from different edit categories when the one or more edits correspond to different edit types, when the one or more edits correspond to different editing modes, when the one or more edits correspond are made via editing tools from different edit categories, and/or when the one or more edits correspond to edits made via editing tools that are displayed when different tabs of a media editing user interface are selected. In some embodiments, in response to detecting the request to initiate the process to copy the edits of the set of edits that were made to the first media item and in accordance with a determination that the set of edits that were made to the first media item (e.g., including the first subset of one or more edits and/or the second subset of one or more edits) do not include one or more edits from more than the threshold number of different edit categories (e.g., the set of edits includes edits from only one of 1012a, 1012b, 1012c, 1012d, and/or 1012e) (e.g., the set of edits include edits (or only includes edits) from the threshold number of edit categories (e.g., a single edit category)), the computer system forgoes display of the user interface configured to receive one or more user inputs to select a respective subset, of the set of edits, to be copied (e.g., 1026 is not displayed when 1004 has been edited from only one of 1012a, 1012b, 1012c, 1012d, and/or 1012e) (e.g., the user interface is not displayed when the set of edits include edits from same category of edits). In some embodiments, the set of edits that were made to the first media item do not include one or more edits from different edit categories when the one or more edits correspond to one edit type, when the one or more edits correspond to one edit mode, when the one or more edits correspond made editing tools for single edit category, and/or when the one or more edits correspond to edits made using editing tools that are displayed when a single tab of a media editing user interface is selected. Conditionally displaying the user interface configured to receive one or more user inputs to select a respective subset, of the set of edits, to be copied based on whether the set of edits that were made to the first media item include one or more edits from more than a threshold number of different edit categories performs an operation when a set of conditions has been met without requiring further user input reduces the number of inputs needed to perform an operation and provides additional control options to selectively apply edits from one media item to another media item.

In some embodiments, before detecting the request to modify the set of one or more media items based on the respective subset of one or more edits that were made to the first media item (e.g., before detecting 1005m), the computer system copies a plurality of edits (e.g., all and/or less than all) of the set of one or more edits that were made to the first media item (e.g., copying some of and/or all of the edits made to 1004). In some embodiments, after copying the plurality of edits, the computer system detects, via the one or more input devices, one or more inputs (e.g., an input directed to 1028a, 1028b, 1028c, 1028d in FIG. 10M) selecting the respective subset of the one or more edits that were made to the first media item based on a selection and/or deselection of one or more edits from the plurality of edits (e.g., 1036 of FIG. 10N is modified based on the selection of 1028b, 1028c, and 1028d and a deselection of 1028a, as depicted in FIG. 10M) (e.g., a user can select which edits to paste after the edits have been copied). Detecting one or more inputs selecting the respective subset of the one or more edits that were made to the first media item based on a selection and/or deselection of one or more edits from the plurality of edits after copying a plurality of edits of the set of one or more edits that were made to the first media item reduces the number of inputs needed to perform an operation and provides additional control options to selectively apply edits from one media item to another media item.

In some embodiments, the computer system displays a media item editing user interface (e.g., 1002 is in an editing mode in FIGS. 10A-10E), including, in accordance with a determination that a system setting that corresponds to a first setting (e.g., as described with respect to FIGS. 10A-10B, 1002 is displayed based on a display mode a system setting of device 1000; as described with respect to FIG. 10A, the display mode is optionally a particular theme (e.g., a light theme and/or a dark theme)) that changes the color of one or more first types of visual objects (e.g., of a set of one or more applications) in a first manner (e.g., a system setting of device 1000 changes a color and/or brightness of chrome visual characteristic 1008, as described with respect to FIGS. 10A-10B) (e.g., making black text lighter (e.g., white)) and changes the color of one or more second types of visual objects in a second manner (e.g., a system setting of device 1000 changes a color and/or brightness of button visual characteristic 1009) (e.g., making light background (e.g., white) darker (e.g., black)), the computer system displays, via the one or more display generation components, at least a portion (e.g., a chrome portion of 1002 above and/or below 1004 in FIGS. 10A-10B; and/or the selectable objects above and/or below 1004 in FIGS. 10A-10B) (e.g., chrome, text, and/or selectable objects) (e.g., some but not all) of the media item editing user interface with a visual appearance (e.g., a visual appearance of 1008 and/or 1009) that is based on the first setting (e.g., 1008 and/or 1009 are based on a light theme system setting of device 1000). In some embodiments, a second portion of the media item editing user interface, different from at least the portion, has a visual appearance that is independent of the first setting (e.g., does not change based on the first setting). In some embodiments, the computer system displays a media item editing user interface (e.g., 1002 is in an editing mode in FIGS. 10A-10E), including, in accordance with a determination that the system setting corresponds to a second setting (e.g., as described with respect to FIGS. 10A-10B, 1002 is displayed based on a display mode a system setting of device 1000; as described with respect to FIG. 10A, the display mode is optionally a particular theme (e.g., a light theme and/or a dark theme)) that changes the color of the one or more first types of visual objects (e.g., of a set of one or more applications) in a third manner (e.g., a system setting of device 1000 changes a color and/or brightness of chrome visual characteristic 1008) (e.g., making lighter text darker (e.g., black)) and changes the color of the one or more second types of visual objects in a fourth manner (e.g., a system setting of device 1000 changes a color and/or brightness of button visual characteristic 1009) (making dark background (e.g., black) lighter (e.g., white)), the computer system displays, via the one or more display generation components, at least the portion of media item editing user interface (e.g., a chrome portion of 1002 above and/or below 1004 in FIGS. 10A-10B; and/or the selectable objects above and/or below 1004 in FIGS. 10A-10B) with a visual appearance that is based on the second setting (e.g., 1008 and/or 1009 are based on a dark theme system setting of device 1000) (e.g., and is not based on the first visual appearance setting), wherein the third manner is different from the first manner, and wherein the fourth manner is different from the second manner. In some embodiments, a second portion of the media item editing user interface, different from at least the portion, has a visual appearance that is independent of the second setting (e.g., does not change based on the second setting). In some embodiments, the system setting is user-configurable (e.g., the system setting is accessible via a settings menu). In some embodiments, the system setting automatically switches between the first setting and the second setting based on a current time of day (e.g., the system setting is set to the first setting when a current time is within a first period of time (e.g., 8:00 am to 8:00 pm) and the system setting is set to the second setting when a current time is within a second period of time that is different from the first time period of time (e.g., 8:01 pm to 7:59 am)). Conditionally displaying at least a portion of the media item editing user interface with a visual appearance that is based on a first setting or a visual appearance that is based on a second setting when a system setting corresponds to a first setting that changes the color of one or more types of visual objects in a first manner and changes the color of one or more types of visual objects in a second manner or when a system setting corresponds to a second setting that changes the color of one or more types of visual objects in a third manner and changes the color of one or more types of visual objects in a fourth manner, where the third manner is different from the first manner, and where the fourth manner is different from the second manner performs an operation when a set of conditions has been met without requiring further user input.

Note that details of the processes described above with respect to method 1100 (e.g., FIG. 11) are also applicable in an analogous manner to the methods described above/below. For example, methods 700, 900, and/or 1300 optionally include one or more of the characteristics of the various methods described above with reference to method 1100. For example, the computer system of method 1100 can be used to selectively apply edits described with respect to methods 700 and/or 900 from one media item to another media item. As another example, the computer system of method 1100 can be used selectively apply edits described with respect to methods 1300 from one media item to another media item. For brevity, these details are not repeated herein.

FIGS. 12A-12AK illustrate exemplary user interfaces for editing images based on a location of an input, in accordance with some embodiments. The user interfaces in these figures are used to illustrate the processes described below, including the processes in FIG. 13. In some embodiments, device 1200 of FIGS. 12A-12AK includes one or more features of portable multifunction device 100, device 300, or device 500.

In some embodiments, any of the inputs described herein (e.g., input 1205a, 1205d, 1205i, 1205j1, 1205j2, 1205j3, 1205k, 1205l, 1205n, 1205o1, 1205o2, 1205x, 1205y1, 1205y2, 1205aa, 1205ab2, 1205ab3, 1205ab4, 1205ab5, 1205ac1, 1205ac2, 1205ae1, 1205ae2, 1205af, 1205aj1, and/or 1205aj2) is or includes a touch input (e.g., a tap gesture and/or a swipe gesture). In some embodiments, any of the inputs described herein (e.g., input 1205a, 1205d, 1205i, 1205j1, 1205j2, 1205j3, 1205k, 1205l, 1205n, 1205o1, 1205o2, 1205x, 1205y1, 1205y2, 1205aa, 1205ab2, 1205ab3, 1205ab4, 1205ab5, 1205ac1, 1205ac2, 1205ae1, 1205ae2, 1205af, 1205aj1, and/or 1205aj2) is or includes a voice input (e.g., a voice command to select a user interface element or to activate a feature or perform a function, such as a feature or function associated with a user interface element). In some embodiments, any of the inputs described herein (e.g., input 1205a, 1205d, 1205i, 1205j1, 1205j2, 1205j3, 1205k, 1205l, 1205n, 1205o1, 1205o2, 1205x, 1205y1, 1205y2, 1205aa, 1205ab2, 1205ab3, 1205ab4, 1205ab5, 1205ac1, 1205ac2, 1205ae1, 1205ae2, 1205af, 1205aj1, and/or 1205aj2) is or includes an air gesture (e.g., an air gesture to select a user interface element or to activate a feature or perform a function, such as a feature or function associated with a user interface element). In some embodiments, any of the inputs described herein (e.g., input 1205a, 1205d, 1205i, 1205j1, 1205j2, 1205j3, 1205k, 1205l, 1205n, 1205o1, 1205o2, 1205x, 1205y1, 1205y2, 1205aa, 1205ab2, 1205ab3, 1205ab4, 1205ab5, 1205ac1, 1205ac2, 1205ae1, 1205ae2, 1205af, 1205aj1, and/or 1205aj2) is or includes activation (e.g., a press, a rotation, and/or a movement) of a hardware device (e.g., a button, a rotatable input mechanism, a rotatable and depressible input mechanism, a mouse, a mouse button, a trackpad, a trackpad button, a button of a remote control, and/or a joystick). In some embodiments, any of the inputs described herein (e.g., input 1205a, 1205d, 1205i, 1205j1, 1205j2, 1205j3, 1205k, 1205l, 1205n, 1205o1, 1205o2, 1205x, 1205y1, 1205y2, 1205aa, 1205ab2, 1205ab3, 1205ab4, 1205ab5, 1205ac1, 1205ac2, 1205ae1, 1205ae2, 1205af, 1205aj1, and/or 1205aj2) as a touch and drag gesture includes an air gesture (e.g., an air gesture including a pinch and/or movement) and/or a click and drag gesture (e.g., a click of a mouse button and/or a trackpad and/or movement while holding a press of a mouse button and/or trackpad) of a mouse and/or trackpad. In some embodiments, any of the user interface elements described as being selected herein (e.g., an icon, affordance, button, and/or selectable option) is selected by activating a hardware device while the user interface element is in focus (e.g., highlighted, bolded, outlined, visually distinguished from other user interface elements, and/or located at or near a cursor).

At FIG. 12A, device 1200 displays, on display 1201, image 1208 (e.g., photo and/or video) and image editing user interface 1202. Image editing user interface 1202 includes editing tool options 1204a-1204e that when selected, cause device 1200 to enter different modes for editing image 1208. Editing tool options 1204a-1204e (also referred to as editing tool affordances 1204a-1204e) include portrait media editing mode affordance 1204a, visual characteristic editing mode affordance 1204b, filter editing mode affordance 1204c, image orientation editing mode affordance 1204d, and cleanup editing mode affordance 1204e.

At FIG. 12A, cleanup editing mode affordance 1204e corresponds to an edit mode that includes a tool(s) to edit image 1208 based on a location of an input and/or based on using a machine learning algorithm. As described in greater detail herein, while cleanup editing mode affordance 1204e is selected, device 1200 detects whether an input begins in a foreground and/or background of a visual media (e.g., an image and/or a video) and edits the visual media accordingly. Moreover, as described herein, while cleanup editing mode affordance 1204e is selected, device 1200 optionally edits image 1208 differently when an input is directed at a detected object and/or a non-detected object of the visual media. In some embodiments, while cleanup editing mode affordance 1204e is selected, device 1200 edits image 1208 using a machine learning algorithm (e.g., generative artificial intelligence). In some embodiments, cleanup editing mode affordance 1204e, when selected, causes device 1200 to display multiple options to edit image 1208 in different manners using one or more machine learning algorithms.

At FIG. 12A, device 1200 detects selection of visual characteristic editing mode affordance 1204b and, in response, displays mode selection indicator 1207 over visual characteristic editing mode affordance 1204b. While visual characteristic editing mode affordance 1204b is selected, device 1200 is in a mode to edit a visual characteristic of image 1208 and displays visual characteristic editing tool options 1204b-1, 1204b-2, and 1204b-3. Visual characteristic editing tool options 1204b-1, 1204b-2, and 1204b-3 correspond to different manners of modifying a visual characteristic (e.g., brightness, contrast, shadows, exposure value, highlights, blackpoint, saturation, vibrance, temperature, tint, sharpness, definition, noise reduction, vignette, color, and/or black and white) of image 1208. At FIG. 12A, auto visual characteristic editing mode affordance 1204b-1, when selected, causes device 1200 to automatically modify a visual characteristic (e.g., brightness, contrast, and/or exposure value) of image 1208. When exposure editing tool affordance 1204b-2 is selected, device 1200 enters a mode to adjust an exposure value of image 1208 in response to detecting an input. When brightness editing tool affordance 1204b-3 is selected, device 1200 enters a mode to adjust a brightness value of image 1208 in response to detecting an input.

At FIG. 12A, portrait media editing mode affordance 1204a, when selected, causes device 1200 to enter a mode to edit a depth effect (e.g., a bokeh effect intensity and/or a simulated f-stop value) for image 1208. In some embodiments, device 1200 determines that image 1208 corresponds to a portrait image (e.g., based on the media including depth information and/or based on the visuals of the image being based on the depth information) and, in response, displays portrait media editing mode affordance 1204a. When portrait media editing mode affordance 1204a is selected, mode selection indicator 1207 is displayed above portrait media editing mode affordance 1204a and device 1200 displays editing tool options for editing depth effects.

At FIG. 12A, in some embodiments, when device 1200 determines that a representation corresponds to an animated image media or video media (e.g., a video or a live photo), device 1200 displays an animated media editing mode affordance. In such embodiments, when animated media editing mode affordance is selected, device 1200 displays a particular set of tool options for selecting an image from a sequence of images (e.g., a video) and setting the selected image as a representative image of the sequence of images. In some embodiments, the sequence of images is captured in response to device 1200 detecting activation of a shutter button at a first time (e.g., the device detects pressing of a physical button at the first time or detects a gesture directed at a virtual shutter button at the first time). In some embodiments, the detected activation of the shutter button at the first time is a single activation of the shutter button (e.g., analogous to a single activation used in a conventional digital camera to capture a single image in the still image mode of a conventional digital camera). In response to detecting activation of the shutter button at the first time, device 1200 groups a plurality of images acquired by a camera in temporal proximity to the activation of the shutter button at the first time into a sequence of images. The sequence of images includes: a plurality of images acquired by the camera prior to detecting activation of the shutter button at the first time; a representative image that represents the sequence of images and was acquired by the camera after one or more of the other images in the sequence of images; and a plurality of images acquired by the camera after acquiring the representative image. In some embodiments, the representative image is acquired by the camera at the first time and is analogous to the single image captured in the still image mode of a conventional digital camera when its shutter button is activated. In some embodiments, the representative image acquired by the camera corresponds to an image that was acquired at the first time. In some embodiments, the representative image acquired by the camera corresponds to an image that was acquired shortly after detecting activation of the shutter button at the first time, at a time that takes into account shutter lag (the time delay between detecting activation of the shutter button and capturing/storing the representative image). In some embodiments, the representative image acquired by the camera is used to represent the sequence of images, for example in an image presentation mode. In some embodiments, the sequence of images includes a predefined number of images (e.g., 5, 10, 15, 20, 25, or 30 images) acquired after acquiring the representative image. In some embodiments, the images acquired after acquiring the representative image are images that are within a predefined time after acquiring the representative image (e.g., within 0.5, 1.0, 1.5, 2.0, or 2.5 seconds) after acquiring the representative image. In some embodiments, the sequence of images includes a predefined number of images (e.g., 5, 10, 15, 20, 25, or 30 images) acquired after detecting activation of the shutter button at the first time. In some embodiments, the images acquired after detecting activation of the shutter button at the first time are images that are within a predefined time after the first time (e.g., within 0.5, 1.0, 1.5, 2.0, or 2.5 seconds after the first time). In some embodiments, the plurality of images, in the sequence of images, that is acquired after acquiring the representative image meet predefined grouping criteria. In some embodiments, the predefined grouping criteria include selecting a predefined number of images after the representative image. In some embodiments, the predefined grouping criteria include selecting images in a predefined range of time immediately after detecting activation of the shutter button. In some embodiments, the predefined grouping criteria include selecting images in a predefined range of time immediately after the time at which the representative image is acquired. In some embodiments, the sequence of images is stored as a distinct set of images in the memory (e.g., stored together in a data structure in non-volatile memory). In some embodiments, the representative image acquired by the camera is used to represent the distinct set of images, for example in an image presentation mode. In some embodiments, when animated media editing mode affordance is selected, device 1200 displays a particular set of tool options for changing the representative image from a first image in the sequence of images to a second image in the sequence of images that is different from the first image. In some embodiments, the first image is an image that is acquired prior to (or, optionally, after) detecting activation of the shutter button at the first time (and/or the representative image acquired at the first time). In some embodiments, the second image is an image that is acquired prior to (or, optionally, after) detecting activation of the shutter button at the first time (and/or the representative image acquired at the first time).

At FIG. 12A, filter editing mode affordance 1204c, when selected, causes device 1200 to enter a mode for applying a filter to image 1208. When filter editing mode affordance 1204c is selected, mode selection indicator 1207 is displayed above filter editing mode affordance 1204c and device 1200 displays editing tool options for applying a filter to image 1208 (e.g., original, vivid, vivid warm, vivid cool, dramatic, dramatic warm, dramatic cool, mono, silvertone, and/or noir). In some embodiments, a filter includes a preconfigured set of one or more visual characteristics (e.g., brightness, contrast, shadows, exposure value, highlights, blackpoint, saturation, vibrance, temperature, tint, sharpness, definition, noise reduction, vignette, color, and/or black and white). In some embodiments, when filter editing mode affordance 1204c is selected, device 1200 displays a first filter that corresponds to a first preconfigured set of one or more visual characteristics and second filter that corresponds to a second preconfigured set of one or more visual characteristics that is different from the first preconfigured set of one or more visual characteristics. In some embodiments, device 1200 applies a filter to image 1208 by applying a selected preconfigured set of one or more visual characteristics to image 1208.

At FIG. 12A, image orientation editing mode affordance 1204d, when selected, causes device 1200 to enter a mode to edit an orientation of image 1208. When image orientation editing mode affordance 1204d is selected, mode selection indicator 1207 is displayed above image orientation editing mode affordance 1204d and device 1200 displays editing tool options for editing an orientation of image 1208 (e.g., an affordance to crop image 1208, an affordance to edit a horizontal perspective correction, an affordance to edit a vertical perspective correction, and/or an affordance to edit a horizon correction).

At FIG. 12A, while displaying image editing user interface 1202, device 1200 detects input 1205a (e.g., a mouse click, an air gesture, and/or a touch input) directed at cleanup editing mode affordance 1204e. In response to detecting input 1205a, device 1200 displays image editing user interface 1202 of FIG. 12B.

At FIG. 12B, in response to detecting input 1205a, device 1200 enters a cleanup editing mode, as depicted by mode selection indicator 1207 being displayed above cleanup editing mode affordance 1204e. In some embodiments, device 1200 displays editing tool 1236, as described with respect to device 1232 of FIGS. 12AC-12AK, while in the cleanup editing mode.

At FIG. 12B, image 1208 includes visual content that is associated with a detected object and/or a non-detected object. In some embodiments, an object is a detected object when device 1200 detects a particular type of object (e.g., a recognized object and/or an object that an object recognition analysis identifies) (e.g., a person, a building, a plant, a ball, petals of a plant, eyes of a person, and/or a roof of a building, and/or a trashcan). In some embodiments, detected objects have a particular shape and/or border that is detected by device 1200. In some embodiments, an object is a non-detected when the object is a different type of object (e.g., an unrecognized object and/or an object that an object recognition analysis does not identify) (e.g., an object type that is different from a person, a building, a plant, a ball, and/or a trashcan). Image 1208 includes detected objects, including foreground person 1210a1, foreground person 1210a2, background running person 1210b1, background running person 1210b2, and background hay bale 1210b3. Image 1208 also includes non-detected objects, including cloud 1210c1. In some embodiments, device 1200 detects an object by detecting that a specific portion of an image corresponds to a recognizable object. In some embodiments, device 1200 does not detect cloud 1210cl because the cloud does not correspond to a recognizable object. In some embodiments, computer system 600 detects a border of a detected object (e.g., such that device 1200 detects what portions of image 1208 are within the border of the detected object and/or which portions of image 1208 are outside of the border of the detected object).

At FIG. 12B, different portions of image 1208 (e.g., detected objects and/or non-detected objects) have different depths relative to one another. For example, depths (e.g., actual depth based on depth data and/or estimated depth based on an appearance of objects in image) of foreground person 1210a1 and foreground person 1210a2 are relatively less as compared to a depth of portions of image 1208 that are in the background, including background running person 1210b1, background running person 1210b2, and background hay bale 1210b3. In such embodiments, foreground person 1210a1 and foreground person 1210a2 are grouped into the foreground of image 1208. As a further example, the depths of background running person 1210b1, background running person 1210b2, and background hay bale 1210b3 are relatively greater as compared to a depth of an object in the foreground of image 1208, including foreground person 1210a1 and foreground person 1210a2. In some embodiments, image 1208 is associated with depth data. In some embodiments, image 1208 is not associated with and/or does not include depth data. In such embodiments, device 1200 determines the depth based on how the objects appear in image 1208 (e.g., using image recognition). In some embodiments, portions of image 1208 in the foreground are closer to a camera that captured the image as compared to portions of image 1208 in the background.

At FIG. 12B, in some embodiments, portions of image 1208 are grouped into the foreground and/or background of image 1208. In such embodiments, background running person 1210b1, background running person 1210b2, and background hay bale 1210b3 are grouped into the background of image 1208. In some embodiments, background running person 1210b1, background running person 1210b2, and background hay bale 1210b3 have different depths relative to each other but are still grouped into the background of image 1208. In some embodiments, foreground person 1210a1 and foreground person 1210a2 have different depths relative to each other but are still grouped into the foreground of image 1208. While the objects are described as being in the foreground and/or background, in some embodiments, objects are found in other layers and/or grouped in other ranges of depth, such as a range of depths that is closer to the camera than the range of depths used for the foreground and/or a range of depths that are further from the camera than a range of depths used for the background.

At FIG. 12B, in response to detecting input 1205a and/or entering the cleanup editing mode, device 1200 displays initial visual effect 1216a (e.g., a glow, highlight or other visual effect) at a detected object in the background in image 1208. As depicted, device 1200 displays initial visual effect 1216a at background running person 1210b1, background running person 1210b2, and background hay bale 1210b3. Initial visual effect 1216a is displayed around and/or within a border of background running person 1210b1, background running person 1210b2, and background hay bale 1210b3. As depicted, device 1200 does not display initial visual effect 1216a at other portions of image 1208 (e.g., cloud 1210c1) and/or detected objects in the foreground, including foreground person 1210a1 and foreground person 1210a2. In some embodiments, device 1200 displays initial visual effect 1216a at foreground person 1210a1 and foreground person 1210a2. In some embodiments, initial visual effect 1216a is an HDR visual effect, where the color(s) of initial visual effect 1216a is a color and/or brightness in a high dynamic range (HDR). In some embodiments, initial visual effect 1216a is displayed at only a portion (e.g., less than all) of a detected object. In some embodiments, device 1200 displays initial visual effect 1216a at the border of an object without displaying initial visual effect 1216a at a portion inside of the border of an object.

At FIG. 12C, device 1200 automatically begins to gradually decrease the brightness of initial visual effect 1216a over time. Initial visual effect 1216a of FIG. 12C is depicted as not having hatching as compared to initial visual effect 1216a of FIG. 12B to depict that initial visual effect 1216a of FIG. 12C is not as bright as initial visual effect 1216a of FIG. 12B. In some embodiments, after a threshold amount of time (e.g., 1 second, 5 seconds, or 10 seconds) has passed since a triggering event, device 1200 begins to gradually decrease the brightness of initial visual effect 1216a. In such embodiments, the triggering event optionally includes an input (e.g., input 1205a) directed to cleanup editing mode affordance 1204e and/or an input directed to image 1208 to edit image 1208. In some embodiments, device 1200 displays initial visual effect 1216a as long as cleanup editing mode affordance 1204e remains selected (and/or as long as device 1200 is in an editing mode that is editing image 1208 via a machine-learning algorithm). In some embodiments, device 1200 continues to display initial visual effect 1216a until an input directed to image 1208 is detected. In some embodiments, device 1200 ceases to display initial visual effect 1216a when an input directed to image 1208 is detected.

At FIG. 12D, device 1200 is not displaying initial visual effect 1216a based on having gradually decreased the brightness of initial visual effect 1216a until initial visual effect 1216a is no longer displayed. As depicted, device 1200 no longer displays initial visual effect 1216a at background running person 1210b1, background running person 1210b2, and background hay bale 1210b3. Device 1200 detects input 1205d (e.g., a mouse click, an air gesture, and/or a touch input) directed at background running person 1210b1 (and/or background running person 1210b2). In some embodiments, device 1200 detects an initial location (e.g., using an average location and/or a centroid of a touch input) of input 1205d that corresponds to a location of a background object (e.g., background running person 1210b1 and/or background running person 1210b2) and subsequent movement of input 1205d over background running person 1210b2 and foreground person 1210a2. In response to detecting input 1205d, device 1200 displays image editing user interface 1202 of FIG. 12E. In some embodiments, device 1200 detects that a portion (e.g., some, but not all) of an area of input 1205d corresponds to an area occupied by the background object. In some embodiments, device 1200 detects that a portion (e.g., some but not all) of the area of input 1205d corresponds to an area that is not occupied by the background object.

At FIG. 12E, device 1200 displays a trailing visual effect that follows the path of an input and a visual effect at a selected object in the path of the input. For example, trailing visual effect 1216b follows the path of movement of input 1205d. Device 1200 also displays object visual effect 1216c at background running person 1210b1 and background running person 1210b2. As illustrated, object visual effect 1216c is displayed at background running person 1210b2 even though a leg of background running person 1210b2 is obscured by an arm of foreground person 1210a2. As described in greater detail with respect to FIG. 12F, device 1200 does not display a visual effect at foreground person 1210a2. Trailing visual effect 1216b and object visual effect 1216c are similar to initial visual effect 1216a (e.g., have a similar visual characteristic) but have a different state. In some embodiments, trailing visual effect 1216b is an HDR visual effect, where the color(s) of trailing visual effect 1216b is a color and/or brightness in a high dynamic range (HDR).

At FIG. 12E, trailing visual effect 1216b and object visual effect 1216c share a common visual characteristic. The trailing visual effect 1216b includes a visual characteristic (e.g., color, pattern, and/or animation) that is depicted by gray shading for illustrative purposes. Background running person 1210b1 and background running person 1210b2 are depicted with the same gray shading as trailing visual effect 1216b to illustrate that object visual effect 1216c has a common visual characteristic as trailing visual effect 1216b. In some embodiments, trailing visual effect 1216b and object visual effect 1216c have a common visual characteristic as initial visual effect 1216a of FIG. 12B. At FIG. 12E, device 1200 continues to detect movement of input 1205d over background hay bale 1210b3 and other portions of image 1208. In response to continuing to detect movement of input 1205d over background hay bale 1210b3 and other portions of image 1208, device 1200 displays image editing user interface 1202 of FIG. 12F.

At FIG. 12F, device 1200 displays visual effect 1216c at background hay bale 1210b3 in response to detecting a path of the movement of input 1205d crossing over background hay bale 1210b3. As depicted, device 1200 does not display a visual effect for objects other than detected background objects that are in the path of the movement of input 1205d. For example, device 1200 detects that the movement of input 1205d has moved over foreground person 1210a2. Even though device 1200 detects that movement of input 1205d has moved over foreground person 1210a2, device 1200 does not display a visual effect at foreground person 1210a2 because foreground person 1210a2 is not a background object. In some embodiments, because device 1200 detects that input 1205d had an initial location that corresponded to a background object (e.g., background running person 1210b1 and/or background running person 1210b2), device 1200 does not display a visual effect at foreground objects (e.g., foreground person 1210a2). In some embodiments, device 1200 detects that the movement of input 1205d has moved over portions in the background (and/or foreground) that does not include a detected object, such as a portion corresponding to the sky and/or the grass field of image 1208. While device 1200 detects that movement of input 1205d has moved over portions in the background (and/or foreground) that do not include a detected object, device 1200 does not display a visual effect in portions of the background (and/or foreground) that do not include a detected object, such as the sky and/or grass field.

At FIG. 12F, trailing visual effect 1216b continues to follow the path of the movement of input 1205d. The size and/or location of trailing visual effect 1216b of FIG. 12F is a different from the size and/or location of trailing visual effect 1216b of FIG. 12E. The size and/or location of trailing visual effect 1216b is different because device 1200 gradually decreases the brightness of trailing visual effect 1216b over time. For example, device 1200 displays trailing visual effect 1216b at a detected location of an input and then gradually decreases the brightness of trailing visual effect 1216b at that location over time until device 1200 no longer displays trailing visual effect 1216b. Thus, the size, shape, and/or length of trailing visual effect 1216b changes over the duration of time that trailing visual effect 1216b is displayed. At FIG. 12F, device 1200 detects input 1205d has ended (e.g., a release of a depress of a mouse button, a release of a pinch of an air pinch gesture, and/or an end of contact of a touch input). In response to detecting input 1205d has ended, device 1200 displays image editing user interface 1202 of FIG. 12G.

At FIGS. 12G-12I, device 1200 displays animation 1218 of gradually ceasing display of background running person 1210b1, background running person 1210b2, and background hay bale 1210b3 in response to detecting input 1205d. As depicted, animation 1218 includes separating a particular portion (e.g., a particle and/or element) of the object from other portions of the object and gradually moving the separated portion away from the object. Animation 1218 optionally includes a color that is based on a color of background running person 1210b1, background running person 1210b2, and background hay bale 1210b3 and/or a color of object visual effect 1216c. In some embodiments, prior to separating the particular portion from other portions of the object, device 1200 displays the separated portion with a visual characteristic (e.g., color and/or pattern) of the object and/or a visual characteristic (e.g., color and/or pattern) of object visual effect 1216c before separating from the object. In some embodiments, after the particular portion has separated from other portions of the object, the separated portion includes the same visual characteristic (e.g., color and/or pattern) of the object and/or the same visual characteristic (e.g., color and/or pattern) of object visual effect 1216c the separated portion had prior to separating from the other portions of the object. In some embodiments, device 1200 concurrently and/or sequentially displays multiple portions of the object begin to separate from the remaining portions of the object. In some embodiments, device 1200 gradually displays infill 1220a (as shown in FIG. 12I) while animation 1218 is displayed. For example, while a particular portion of the object is being separated from the other portions of an object, device 1200 replaces the area vacated by the separated portion with infill 1220a. At FIG. 12H, animation 1218 includes gradually ceasing display of (e.g., fading out and/or reducing in size) a particular portion of the object that has been separated from the remaining portion. Device 1200 continues to display animation 1218 until background running person 1210b1, background running person 1210b2, and background hay bale 1210b3 are no longer displayed, as shown in FIG. 12I.

At FIG. 12G, in some embodiments, device 1200 begins to display animation 1218 for multiple objects at the same time (or, optionally, different times). In some embodiments, device 1200 does not display animation 1218 until device 1200 detects input 1205d has ended. In such embodiments, device 1200 begins to display animation 1218 (and/or displays infill 1220a) within a threshold amount of time of detecting input 1205d has ended. In some embodiments, device 1200 displays animation 1218 (and/or displays infill 1220a) within a threshold amount of time of detecting that an object is selected by input 1205d (e.g., independent of whether input 1205d has ended). In such embodiments, because background running person 1210b1, background running person 1210b2, and background hay bale 1210b3 were selected at different times, device 1200 sequentially begins display, at different times, animation 1218 (and/or infill 1220a) for background running person 1210b1, background running person 1210b2, and background hay bale 1210b3. For example, in such embodiments, device 1200 begins displaying animation 1218 (and/or infill 1220a) for background running person 1210b1 at a first time, begins displaying animation 1218 (and/or infill 1220a) for background running person 1210b2 at a second time that is after the first time, and then begins displaying animation 1218 (and/or infill 1220a) for background hay bale 1210b3 at a third time that is after the second time.

At FIG. 12I, animation 1218 has ended and device 1200 displays infill 1220a without displaying background running person 1210b1, background running person 1210b2, and background hay bale 1210b3. Device 1200 displays infill 1220a at a location that was previously occupied by background running person 1210b1, background running person 1210b2, and background hay bale 1210b3. In some embodiments, infill 1220a is automatically-generated content and/or content generated based on nearby content. In some embodiments, infill 1220a is visual content that was not captured and/or included in image data when image 1208 was captured. In some embodiments, infill 1220a is content that is generated via a machine learning model (e.g., via generative artificial intelligence). In some embodiments, device 1200 detects visual content that is within a threshold distance of an input to generate an infill having a similar appearance as the content within the threshold distance.

At FIG. 12I, image editing user interface 1202 includes undo affordance 1222. Undo affordance 1222, when selected, reverts a previous edit. In some embodiments, device 1200 detects a series of inputs directed to undo affordance 1222. In such embodiments, device 1200 reverts a series of previous edits based on the series of inputs directed to undo affordance 1222. Device 1200 detects input 1205i (e.g., a mouse click, an air gesture, and/or a touch input) directed to undo affordance 1222. In response to detecting input 1205i, device 1200 reverts the removal of background running person 1210b1, background running person 1210b2, and background hay bale 1210b3, as illustrated in FIG. 12J1.

At FIG. 12J1, in response to detect input 1205i, device 1200 displays (e.g., re-displays) background running person 1210b1, background running person 1210b2, and background hay bale 1210b3 at a location that was previously occupied by infill 1220a. At FIG. 12J1, device 1200 displays redo affordance 1224. Redo affordance, when selected, re-executes an edit that was reverted (e.g., by selecting undo affordance 1222). In some embodiments, device 1200 detects a series of inputs directed to redo affordance 1224. In such embodiments, device 1200 re-executes a series of edits that were reverted based on the series of inputs directed to redo affordance 1224. In some embodiments, device 1200 detects input 1205j1 (e.g., a mouse click, an air gesture, and/or a touch input) directed to redo affordance 1224. In such embodiments, in response to detecting input 1205j1, device 1200 displays image editing user interface 1202 of FIG. 12I (e.g., including infill 1220a).

At FIGS. 12J1-12J2, device 1200 detects different types of inputs to edit image 1208. At FIG. 12J1, device 1200 detects a first type of input that includes a movement component that moves partially around a detected object and, in response, stops displaying the detected object and displays an infill. For example, device 1200 detects input 1205j2 (e.g., a mouse click, an air gesture, and/or a touch input) at an initial location that corresponds to neither background running person 1210b1 nor background running person 1210b2. Device 1200 then detects input 1205j2 move at least partially (e.g., at least 25%, at least 50%, at least 75%, or at least 80%) around background running person 1210b1 and background running person 1210b2. In response to detecting input 1205j2, device 1200 displays infill 1220a and ceases to display background running person 1210b1 and/or background running person 1210b2 (e.g., based on input 1205j2 circling or partially circling the objects), as depicted in FIG. 12J2. In some embodiments, device 1200 detects input 1205j2 move around a threshold amount (e.g., 25%, 50%, 75%, or 80%) of a perimeter of the detected object. In some embodiments, neither the initial location of input 1205j2 nor the movement of input 1205j2 crosses over a boundary and/or overlaps with a portion of background running person 1210b1 and/or background running person 1210b2. In some embodiments, while detecting input 1205j2 moving around a background object, device 1200 detects input 1205j2 moving over a foreground object. For example, in some embodiments, the movement of input 1205j2 crosses over at least a portion of foreground person 1210a1 and/or foreground person 1210a2. In such embodiments, device 1200 does not remove foreground person 1210a1 and/or foreground person 1210a2, but still removes background running person 1210b1 and/or background running person 1210b2.

At FIG. 12J2, device 1200 detects a second type of input (e.g., that does not include a movement component) that is directed to a detected object and, in response, removes the detected object and displays an infill. For example, device 1200 detects input 1205j3 (e.g., a mouse click, an air gesture, and/or a touch input) directed at background hay bale 1210b3, where input 1205j3 does not move over other portions of image 1208. In response to detecting input 1205j3, device 1200 displays infill 1220a without displaying background hay bale 1210b3, as depicted in FIG. 12K. In some embodiments, in response to detecting input 1205j3, device 1200 displays an object visual effect similar to object visual effect 1216c of FIG. 12F. In some embodiments, in response to detecting input 1205j3, device 1200 displays an animation similar to animation 1218 of FIGS. 12G-12I.

At FIG. 12K, device 1200 displays infill 1220a at the locations that were previously occupied by background running person 1210b1, background running person 1210b2, and background hay bale 1210b3.

At FIG. 12L, device 1200 detects input 1205l at location 1226 corresponding to a portion of cloud 1210c (e.g., a non-detected object as described with respect to FIG. 12A). In response to detecting input 1205l, device 1200 displays image editing user interface 1202 of FIG. 12M.

At FIG. 12M, device 1200 displays visual effect 1216d at location 1226 of input 1205l. In some embodiments, device 1200 displays visual effect 1216d at location 1226 of input 1205l as opposed to around a boundary of cloud 1210c because cloud 1210c is a non-detected object. For example, visual effect 1216d is displayed beyond the border of cloud 1210c. In some embodiments, cloud 1210c is a detected object. In such embodiments, visual effect 1216d would be displayed in a location different from location 1226 (e.g., visual effect 1216d would have been displayed along a border of cloud 1210c as opposed to at the location of input 1205l). At FIG. 12M, a shape of visual effect 1216d corresponds to a detected shape of input 1205l (and/or shape of any movement made by input 1205l). In some embodiments, device 1200 displays visual effect 1216d at a shape and/or area corresponding to a detected shape and/or area of input 1205l. As described in greater detail with respect to path visual effect 1216g of FIG. 6AI, in some embodiments, device 1200 detects input 1205l moves and, in response, displays a visual effect along the path of movement of input 1205l. In some embodiments, cloud 1210c is in the background of image 1208.

At FIG. 12N, in response to detecting input 1205l, device 1200 displays infill 1220b at location 1226 without displaying a portion of cloud 1210c. Infill 1220b is similar to infill 1220a but has a different state (e.g., different generated content and/or location). In some embodiments, device 1200 displays an animation for the portion of cloud 1210c that is similar to animation 1218 of FIGS. 12G-12I. Device 1200 detects input 1205n (e.g., a mouse click, an air gesture, and/or a touch input) directed at undo affordance 1222. In response to detecting input 1205n, device 1200 displays image editing user interface 1202 of FIG. 12O.

At FIG. 12O, device 1200 displays (re-displays) the portion of cloud 1210c that was not displayed in FIG. 12N. In some embodiments, device 1200 detects input 1205o1 (e.g., a mouse click, an air gesture, and/or a touch input) directed at redo affordance 1224. In such embodiments, in response to detecting input 1205o1, device 1200 displays image editing user interface 1202 of FIG. 12N (e.g., including infill 1220b). At FIG. 12O, device 1200 detects input 1205o2 (e.g., a mouse click, an air gesture, and/or a touch input) directed to foreground person 1210a1 and then detects subsequent movement of input 1205o2. In some embodiments, device 1200 detects an initial location of input 1205o2 that overlaps (e.g., at least partially overlapping) with a location of foreground person 1210a1. In some embodiments, device 1200 detects a portion (e.g., some but not all) of an area of input 1205o2 that corresponds to an area occupied by the foreground object. In some embodiments, device 1200 detects at least a portion (e.g., some but not all) of the area of input 105d1 that corresponds to an area that is not occupied by the foreground object.

At FIG. 12P, device 1200 displays object visual effect 1216e at foreground person 1210a1 and trailing visual effect 1216b. Object visual effect 1216e is similar to visual effects 1216a-1216d but has a different state (e.g., shape and/or location). At FIG. 12P, device 1200 detects that input 1205o2 has moved over background running person 1210b1 and/or background running person 1210b2. Device 1200 does not display a visual effect at background running person 1210b1 and/or background running person 1210b2 because the input 1205o2 was initially directed at foreground person 1210a1, as described with respect to FIG. 12O. At FIG. 12P, device 1200 detects further movement of input 1205o2 as input 1205o2 moves over foreground person 1210a2.

At FIGS. 12R-12S, device 1200 displays the size of trailing visual effect 1216b decreasing as input 1205o2 no longer moves, as depicted by the size of trailing visual effect 1216b of FIGS. 12R-12S as compared to the size of trailing visual effect 1216b of FIG. 12Q.

At FIGS. 12Q-12S, device 1200 detects input 1205o2 has moved over foreground person 1210a2, which optionally selects foreground person 1210a2 for editing. At FIG. 12R, in some embodiments, in response to detecting movement of input 1205o2 moving over foreground person 1210a2, device 1200 displays visual effect 1216d at foreground person 1210a2, indicating that foreground person 1210a2 has been selected for editing. At FIG. 12S, as an alternative as FIG. 12R, in response to detecting movement of input 1205o2 moving over foreground person 1210a2, device 1200 does not display visual effect 1216d at foreground person 1210a2, indicating that foreground person 1210a2 has not been selected for editing. In some embodiments, device 1200 does not display a visual effect at foreground person 1210a2 at FIG. 12S because device 1200 determines foreground person 1210a2 is a primary subject of image 1208. In some embodiments, device 1200 determines foreground person 1210a2 is a primary subject based on a position of foreground person 1210a2 (e.g., foreground person 1210a2 is positioned within a threshold distance of a center point of image 1208), a visual characteristic of foreground person 1210a2 relative to other portions of image 1208 (e.g., foreground person 1210a2 has less blur relative to other portions of image 1208 based on being in focus while image 1208 was captured), and/or based on a user input selecting foreground person 1210a2 as a primary subject (e.g., while image 1208 was captured and/or after image 1208 was captured). At FIG. 12S, device 1200 detects further movement of input 1205o2 back over background running person 1210b1, background running person 1210b2, foreground person 1210a2, and foreground person 1210a1. In response to detecting further movement of input 1205o2, device 1200 does not select and/or display a visual effect for background running person 1210b1, background running person 1210b2, and foreground person 1210a2 for editing, as described with respect to FIGS. 12T-12U.

At FIGS. 12T-12U, device 1200 does not display a visual effect at background running person 1210b1, background running person 1210b2, and foreground person 1210a2 even though device 1200 detects input 1205o2 repeatedly moving over background running person 1210b1, background running person 1210b2, and foreground person 1210a2. In some embodiments, because input 1205o2 was initially directed to foreground person 1210a1, device 1200 does not display a visual effect at background running person 1210b1, background running person 1210b2, and foreground person 1210a2. In some embodiments, a visual effect is not displayed to indicate that background running person 1210b1, background running person 1210b2, and foreground person 1210a2 are not selected for editing, as shown in FIG. 12U. As depicted in FIG. 12U, device 1200 maintains display of object visual effect 1216e at foreground person 1210a1 in response to detecting movement of input 1205o crossing back over foreground person 1210a1. In some embodiments, object visual effect 1216e is continued to be displayed to indicate that foreground person 1210a1 remains selected. At FIG. 12U, device 1200 detects input 1205o2 has ended (e.g., a release of a depress of a mouse button, a release of a pinch of an air pinch gesture, and/or an end of contact of a touch input). In response to detecting that input 1205o2 has ended, device 1200 removes foreground person 1210a1, as depicted in FIGS. 12V-12W.

At FIGS. 12V-12W, device 1200 displays animation 1218 for removing foreground person 1210a1, described in more detail with respect to FIGS. 12G-12H. At FIGS. 12V-12W, device 1200 gradually displays infill 1228c at the area vacated by foreground person 1210a1. Infill 1228c is similar to infill 1228a but has a different state (e.g., includes different visual content and/or is at a different location).

At FIG. 12X, in response to detecting input 1205o2, device 1200 does not display foreground person 1210a1 and displays infill 1220b at a location that was previously occupied by foreground person 1210a1. As depicted, infill 1220b includes a foot of background running person 1210b1 that was previously obscured by foreground person 1210a1. At FIG. 12X, device 1200 detects input 1205x (e.g., a mouse click, an air gesture, and/or a touch input) directed at undo affordance 1222. In response to detecting input 1205x, device 1200 reverts the previous edit by displaying foreground person 1210a1 and ceasing to display infill 1220b, as depicted in FIG. 12Y. At FIG. 12Y, in some embodiments, after detecting input 1205x and while foreground person 1210a1 is displayed, device 1200 detects input 1205y1 (e.g., a mouse click, an air gesture, and/or a touch input) directed at redo affordance 1224. In such embodiments, in response to detecting input 1205y1, device 1200 redoes the previous edit by displaying infill 1220b and ceasing display of foreground person 1210a1, as depicted in FIG. 12X.

At FIGS. 12Y-12AB1, device 1200 edits image 1208 in a manner that is different from the manner depicted in FIGS. 12A-12X. For example, visual indication 1212b indicates an input needed to edit image 1208 via a machine learning algorithm to change image 1208 in a manner that is different from removing a portion of an image and displaying an infill, as described in FIGS. 12A-12X. Visual indication 1212b includes an image of hand gesture and text (“TAP, BRUSH OR CIRCLE WHAT YOU WANT TO CHANGE”) that describe an input needed to edit image 1208. In some embodiments, image editing user interface 1202 includes different options that, when selected, change to different types of editing modes that use a machine learning algorithm to edit an image. In some embodiments, device 1200 edits image 1208 by changing a visual characteristic (e.g., color, tint, and/or blur) of an object of image 1208 using a machine learning model (e.g., as opposed to removing an object). At FIG. 12Y, device 1200 detects input 1205y2 (e.g., a mouse click, an air gesture, and/or a touch input) directed at a portion of foreground person 1210a2 at location 1230. In response to detecting input 1205y2, device 1200 changes a visual characteristic of foreground person 1210a2 at location 1230, as depicted by dashed lines 1231 in FIG. 12Z. At FIG. 12Z, device 1200 displays a different visual characteristic of foreground person 1210a2 at location 1230 as compared to foreground person 1210a2 in FIG. 12Y, as depicted by dashed lines 1231 in FIG. 12Z. In some embodiments, displaying a different visual characteristic of foreground person 1210a2 at location 1230 includes displaying a portion of the hair and eyes of foreground person 1210a2 in a different color.

At FIG. 12AA, device 1200 displays a zoomed-in view of the face of foreground person 1210a2 in response to detecting input 1205y3 (e.g., a mouse click, an air gesture, and/or a touch input) of FIG. 12Y to zoom into a face of foreground person 1210a2. In some embodiments, device 1200 displays a zoomed-in view to provide improved precision in editing image 1208. Eye 1210d is depicted as having solid lines to illustrate eye 1210d has a particular visual characteristic. Device 1200 detects input 1205aa (e.g., a mouse click, an air gesture, and/or a touch input) directed to eye 1210d. In response to detecting input 1205aa, device 1200 changes the visual characteristic of eye 1210d, as depicted by the dashed lines of eye 1210d in FIG. 12AB1.

At FIG. 12AB1, device 1200 displays eye 1210d with a visual characteristic that is different from the visual characteristic of eye 1210d of FIG. 12AA. For example, eye 1210d of FIG. 12AB1 is illustrated with dashed lines and eye 1210d of FIG. 12AA is illustrated with solid lines to depict eye 1210d having different visual characteristics. In some embodiments, to change and/or edit an object, device 1200 continues to display a border of eye 1210d while modifying a visual characteristic within the border of eye 1210d.

At FIGS. 12AB2-12AB6, device 1200 displays image 1209 in image editing user interface 1202. Image 1209 is similar to image 1208 but has a different state (e.g., image 1209 further includes background ball 1210b4). Moreover, device 1200 is in an editing mode to remove an object, similar to the editing mode described with respect to FIGS. 12A-12X. For example, device 1200 displays visual indicator 1212a of FIG. 12A (“TAP, BRUSH OR CIRCLE WHAT YOU WANT TO REMOVE”). In some embodiments, device 1200 displays an image editing tool similar to editing tool 1236 described in greater detail with respect to FIG. 12AC.

At FIG. 12AB2, device 1200 displays image 1209 at a zoomed-out level. Device 1200 detects input 1205ab2 directed at background ball 1210b4. In some embodiments, because device 1200 is displaying image 1209 at a zoomed-out level while input 1205ab2 is detected, an area of input 1205ab2 overlaps with a location of background ball 1210b4 and a location of background running person 1210b2. In response to detecting input 1205ab2, device 1200 displays infill 1220ab without displaying background ball 1210b4 and background running person 1210b2, as depicted in FIG. 12AB3.

At FIG. 12AB3, device 1200 detects input 1205ab3 (e.g., a mouse click, an air gesture, and/or a touch input) directed at undo affordance 1222. In response to detecting input 1205ab3, device 1200 displays background ball 1210b4 and background running person 1210b2 without displaying infill 1220ab, as depicted in FIG. 12AB4.

At FIG. 12AB4, device 1200 detects input 1205ab4 (e.g., a mouse click, an air gesture, and/or a touch input) corresponding to a request to zoom into a portion of image 1209 that includes background ball 1210b4. In response to detecting input 1205ab4, device 1200 displays a zoomed-in view of image 1209, as depicted in FIG. 12AB5.

At FIG. 12AB5, device 1200 displays a zoomed-in view of background ball 1210b4 and background running person 1210b2. As depicted the arm of foreground person 1210a2 at location 1228 obscures a portion of background ball 1210b4. Device 1200 detects input 1205ab5 (e.g., a mouse click, an air gesture, and/or a touch input) direct at background ball 1210b4. In response to detecting input 1205ab5, device 1200 displays infill 1220ab6 without displaying background ball 1210b4. As depicted, device 1200 displays background running person 1210b2. In some embodiments, because device 1200 is displaying image 1209 at a zoomed-in view while input 1205ab5 is detected, an area of input 1205ab5 overlaps with a location of background ball 1210b4 without overlapping with a location of background running person 1210b2. In some embodiments, by zooming in, input 1205ab5 has a higher precision than input 1205ab3. In some embodiments, input 1205ab3 and input 1205ab5 have a similar dimension (e.g., shape and/or radius) that is independent of the zoom level such that the same input that is directed at the same location will result in modifying different amounts and/or portions of image 1209.

At FIG. 12AB6, device 1200 displays infill 1220ab6. As depicted infill 1220ab6 does not alter the arm of foreground person 1210a2 at location 1248. In some embodiments, device 1200 detects that the arm of foreground person 1210a2 is in the foreground of image 1209 and, in response, does not modify the portion of the arm of foreground person 1210a2 that is at location 1228 (where the arm of foreground person 1210a2 previously obscured background ball 1210b4).

At FIG. 12AC, device 1232 displays, via display 1233, image 1211 and image editing user interface 1202. Image 1211 of FIG. 12AC is similar to image 1208 of FIG. 12A but has a different state. Image editing user interface 1202 of FIG. 12AC is similar to image editing user interface 1202 of FIG. 12A but has a different state. Image editing user interface 1202 includes editing tool categories 1204a-1204e, which are similar to editing tool categories 1204a-1204e of FIG. 12A but have a different state. In some embodiments, device 1232 includes one or more features of portable multifunction device 100, device 300, or device 500. In some embodiments, device 1232 includes input device 1234 (e.g., a track pad and/or a mouse).

At FIG. 12AC, device 1232 displays background people 1210e1 and background trashcan 1210e2. Background people 1210e1 and background trashcan 1210e2 are detected objects (e.g., as opposed to non-detected objects as described with respect to FIG. 12A) and are in the background of image 1211. Foreground couple 1210g is a detected object and is in the foreground of image 1211. Device 1232 displays visual effect 1216f at background people 1210e1 and background trashcan 1210e2 and does not display a visual effect at foreground couple 1210g. In some embodiments, device 1232 displays visual effect 1216f at background people 1210e1 and background trashcan 1210e2 until device 1232 detects an input that edits image 1211, an input to leave an editing mode that edits image 1211 via a machine learning algorithm, and/or an input selecting one of editing tool categories 1204a-1204d (e.g., so as to leave the clean-up editing mode that uses one or more machine learning algorithms).

At FIG. 12AC, device 1232 displays editing tool 1236. In some embodiments, device 1200 of FIGS. 12A-12AB6 displays editing tool 1236. Device 1232 detects input 1205ac1 that starts above background people 1210e1 and subsequent movement around background people 1210e1. In response to detecting input 1205ac1, device 1232 continues to display object visual effect 1216f at background people 1210e1 and stops displaying object visual effect 1216f at background trashcan 1210e2, as depicted in FIG. 12AD. Device 1232 detects input 1205ac2 directed to background people 1210e1 without detecting movement of input 1205ac2. In response to detecting input 1205ac2, device 1232 continues to display object visual effect 1216f at background people 1210e1 and stops displaying object visual effect 1216f at background trashcan 1210e2, as depicted in FIG. 12AD.

At FIG. 12AD, device 1232 continues displaying object visual effect 1216f at background people 1210e1 without displaying object visual effect 1216f at background trashcan 1210e2. In some embodiments, device 1232 continues to display object visual effect 1216f at background people 1210e1 and stops displaying object visual effect 1216f at background trashcan 1210e2 to indicate that background people 1210e1 are selected for editing and background trashcan 1210e2 is not selected for editing.

At FIG. 12AE, device 1232 displays infill 1220c at a location that was previously occupied by background people 1210e. In some embodiments, device 1232 displays an animation for background people 1210e that is similar to animation 1218 of FIGS. 12G-12I. In some embodiments, device 1232 does not display an animation. In some embodiments, device 1232 detects input 1205ae1 directed to undo affordance 1222. In such embodiments, in response to detecting input 1205ae1, device 1232 displays (e.g. re-displays) background people 1210e1 and stops displaying infill 1220c, as depicted in FIG. 12AD. In some embodiments, device 1232 detects input 1205ae1 directed to redo affordance 1224. In such embodiments, in response to detecting input 1205ae1, device 1232 displays infill 1220c at a location that was previously occupied by background people 1210e, as depicted in FIG. 12AE.

At FIG. 12AE, device 1232 displays control 1238 for increasing and/or deceasing an area that is modified by editing tool 1236. Device 1232 detects input 1205ae2 directed to control 1238 to increase the area that will be modified editing tool 1236 in response to detecting an input. In response to detecting input 1205ae2, device 1232 increases the area that will be modified by editing tool 1236 in response to detecting an input, as depicted in FIG. 12AF. In some embodiments, the size of editing tool 1236 changes to illustrate an area that will be affected by the editing tool 1236 in response to detecting an input. For example, editing tool 1236 of FIG. 12AF is larger than editing tool 1236 of FIG. 12AE, indicating editing tool 1236 of FIG. 12AF will modify a larger area than editing tool 1236 of FIG. 12AE. In some embodiments, device 1200 displays editing tool 1236 in FIGS. 12Y-12AB6. In such embodiments, the size of editing tool 1236 does not change when changing a zoom level, indicating that a dimension of the editing tool 1236 does not change as the zoom level changes.

At FIG. 12AF, device 1232 displays river 1210h. River 1210h is a non-detected object (e.g., as opposed to detected object as described with respect to FIG. 12A). At FIG. 12AF, device 1232 detects an initial location of input 1205af while editing tool 1236 is positioned at river 1210h and then detects subsequent movement of input 1205af over river 1210h, as depicted in FIG. 12AG.

At FIG. 12AG, device 1232 displays trailing visual effect 1216b along the path of movement of input 1205af. Device 1232 detects further movement of input 1205af moving away from river 1210h, as depicted in FIG. 12AH. In response to detecting further movement of input 1205af, device 1232 displays editing tool 1236 and trailing visual effect 1216b at a location that is different from the location of river 1210h, as depicted in FIG. 12AH.

At FIG. 12AH, editing tool 1236 and trailing visual effect 1216b are located to the right of river 1210h. At FIG. 12AH device 1232 detects input 1205af has ended. In response to detecting that input 1205af has ended, device 1232 displays path visual effect 1216g, as depicted in FIG. 12AI.

At FIG. 12AI, in response to detecting input 1205af, device 1232 displays path visual effect 1216g along the path of detected movement of input 1205af. Path visual effect 1216g is similar to visual effects 1216a-1216f, but has a different state (e.g., path visual effect 1216g is located at an area of image 1211 that was traversed by an input). For example, path visual effect 1216g starts at the initial location of input 1205af and extends through the path of movement of input 1205af. As depicted, path visual effect 1216g is located along a portion of river 1210h and along a portion of image 1211 other than river 1210h. In some embodiments, device 1232 displays path visual effect 1216g at a bottom half of river 1210h at location 1240 as opposed to a visual effect at the entire portion of river 1210h because river 1210h is a non-detected object. In some embodiments, river 1210h is a detected object. In such embodiments, device 1232 displays a visual effect along the border of river 1210h (and/or does not display a visual effect along a portion where the movement of input 1205af has moved away from and/or off of river 1210h). In some embodiments, device 1232 displays an animation similar to animation 1218.

At FIG. 12AJ, device 1232 displays infill 1220d at location 1240, which was previously occupied by the bottom portion of river 1210h. In some embodiments, device 1232 detects input 1205aj1 directed at undo affordance 1222. In such embodiments, device 1232 reverts the previous edits by displaying the bottom of river 1210h at location 1240 and not displaying infill 1220b, as depicted in FIG. 12AI.

At FIG. 12AJ, device 1232 continues to display a top portion of river 1210h because input 1205af did not move over the top portion of river 1210h. Device 1232 detects input 1205aj2 and subsequent movement of input 1205aj2 over the top portion of river 1210h at location 1248. In response to detecting input 1205aj2, device 1232 displays infill 1220e at location 1248 and does not display the top portion of river 1210h, as depicted in FIG. 12AK. In some embodiments, device 1232 displays an animation similar to animation 1218.

At FIG. 12AK, device 1232 displays infill 1220e at location 1248 and does not display the top portion of river 1210h. In some embodiments, device 1232 displays a path visual effect similar to path visual effect 1216g at a location of input 1205aj1.

FIG. 13 is a flow diagram illustrating a method for editing media based on a location of an input using a computer system in accordance with some embodiments. Method 1300 is performed at a computer system (e.g., 100, 300, 500, 1200, and/or 1232) (e.g., a smartphone, a tablet computer, a laptop computer, a desktop computer, and/or a head mounted device (e.g., a head mounted augmented reality and/or extended reality device)) that is in communication with one or more display generation components (e.g., 1201 and/or 1233) (e.g., a display controller, a touch-sensitive display system, a monitor, and/or a head mounted display system) and one or more input devices (e.g., 1201 and/or 1234) (e.g., a touch-sensitive surface, a keyboard, a controller, and/or a mouse). In some embodiments, the computer system in communication with one or more cameras (e.g., an infrared camera, a depth camera, and/or a visible light camera). Some operations in method 1300 are, optionally, combined, the orders of some operations are, optionally, changed, and some operations are, optionally, omitted.

As described below, method 1300 provides an intuitive way for editing media based on a location of an input. The method reduces the cognitive burden on a user for editing media, thereby creating a more efficient human-machine interface. For battery-operated computing devices, enabling a user to edit media faster and more efficiently conserves power and increases the time between battery charges.

The computer system (e.g., 100, 300, 500, 1200, and/or 1232), while displaying, via the one or more display generation components, a media item (e.g., 1208, 1209, and/or 1211) (e.g., photo, and/or video) including a foreground element (e.g., 1210a1 and/or 1210a) and a first background element (e.g., 1210b1, 1210b2, 1210b3, 1210b4, 21210c, 1010e1, and/or 1210e2), detects (1302), via the one or more input devices, an input (e.g., 1205d, 1205l, 1205j2, 1205o2, 1205ac1, 1205ac2) (e.g., an air gesture, a touch input, and/or a mouse click) corresponding to a request to modify the media item. Detecting the input corresponding request to modify the media idem includes the computer system detecting (1304) at least a portion of the input (e.g., movement of input 1205d, movement of input 1205j2, movement of input 1205o2, and/or movement of input 1205ac1) (e.g., a movement component of the input) is directed to (e.g., follows a path that corresponds to or moves over) a location of the foreground element and a location of the first background element (e.g., movement of input 1205d, movement of input 1205j2, movement of input 1205o2, and/or movement of input 1205ac1) (e.g., the input moves over the foreground element and the first background element). In response to detecting the input corresponding to the request to modify the media item (1306) and in accordance with a determination that an initial location of the input (e.g., the initial location of input 1205d in FIG. 12D, an initial location of input 1205j2, and/or an initial location of input 1205ac1) is directed to the location of the first background element (e.g., the initial location of input 1205d is directed to 1210b1 in FIG. 12D, an initial location of input 1205j2 is directed to the location of 1210b1 and/or 1210b2, and/or an initial location of input 1205ac1 is directed to the location of 1210e1), the computer system modifies (e.g., using an AI process or a generative AI process) the media item, that is displayed via the one or more display generation components, by modifying (e.g., using an AI process or a generative AI process) at least a portion of the first background element without modifying the foreground element to which the input was directed (e.g., 1210b1, 1210b2, and/or 1210b3 are no longer displayed in FIG. 12I) (e.g., even though the input moved over both the foreground element and the first background element, only the first background element is modified because the input began on the first background element). In some embodiments, the initial location corresponds to a location of where an input starts (e.g., a location of a pinch gesture and/or a location of a touch-down event) before a movement component of the input is detected. In some embodiments, detecting the movement component includes detecting a movement of the input while a portion of the input is maintained (e.g., detecting a movement component of the pinch gesture while the pinch gesture is maintained and/or detecting a movement component of the touch input while contact of the touch input is maintained). In some embodiments, the foreground element is an element (e.g., person, building, and/or plant) of the media having a different depth (e.g., as determined using depth data and/or as determined without depth data) from the first background element. In some embodiments, the foreground element is an element that is determined to be closer to a camera that captured the media item (e.g., relative to the first background element). In some embodiments, in response to detecting the input corresponding to the request to modify the media item and in accordance with a determination that the initial location of the input is not directed to the location of the first background element, the computer system forgoes modifying at least the portion of the first background element. Detecting the input corresponding to the request to modify the media item, including detecting at least a portion of the input is directed to a location of the foreground element and a location of the first background element and, in response, conditionally modifying the media item by modifying at least a portion of the first background element without modifying the foreground element to which the input was directed when the initial location of the input is directed to the location of the first background element improves image editing technologies because it performs an operation when a set of conditions has been met without requiring further user input, modifies specific elements even if an input is accidentally directed to two different elements, and provides additional control options without cluttering the user interface.

In some embodiments, in response to detecting the input corresponding to the request to modify the media item and in accordance with a determination that the initial location of the input (e.g., the initial location of input 1205o2 in FIG. 12O) is directed to the location of the foreground element (e.g., 1210a1 and/or 1210a2), the computer system modifies (e.g., using an AI process or a generative AI process) the media item by modifying (e.g., using an AI process or a generative AI process) at least a portion of the foreground element (e.g., automatically-generated and/or automatically-modified visual content) without modifying the first background element to which the input was directed (e.g., 1210a1 is no longer displayed inf FIG. 12x) (e.g., even though the input moved over both the first foreground element and the background element, only the first foreground element is modified because the input began on the foreground element). In some embodiments, in response to detecting the input corresponding to the request to modify the media item and in accordance with a determination that the initial location of the input is not directed to the location of the foreground element, the computer system forgoes modifying at least the portion of the foreground element. Detecting the input corresponding to the request to modify the media item, including detecting at least a portion of the input is directed to a location of the foreground element and a location of the first background element and, in response, conditionally modifying the media item by modifying at least a portion of the foreground element without modifying the first background element to which the input was directed when the initial location of the input is directed to the location of the foreground element improves image editing technologies because it performs an operation when a set of conditions has been met without requiring further user input, modifies specific elements even if an input is accidentally directed to two different elements, and provides additional control options without cluttering the user interface.

In some embodiments, detecting the input corresponding to the request to modify the media item includes the computer system detecting at least a portion of the input is directed to a location of the foreground element (or, optionally, a background element) at a first time (e.g., input 1205o2 in FIG. 12O; and/or input 1205d moves over 1210a2 at FIG. 12E). In some embodiments, detecting the input corresponding to the request to modify the media item includes the computer system detecting at least a portion of the input is directed to a location that does not correspond to a location of the foreground element (or, optionally, a background element) at a second time, after the first time (e.g., input 1205-2 moves off of 1210a2 after moving over 1210a2 in FIG. 12O; and/or input 1205d moves off of 1210a2 after moving over 1210a2 at FIG. 12E). In some embodiments, detecting the input corresponding to the request to modify the media item includes the computer system detecting at least a portion of the input is directed to a location of the foreground element (or, optionally, a background element) at a third time, after the second time (e.g., input 1205-2 moves back over 1210a2 after moving off of 1210a2; and/or input 1205d moves back over 1210a2 after moving off of 1210a2) (e.g., the input moves back and forth over the foreground element without changing the foreground element). Detecting at least a portion of the input is directed to a location of the foreground element at different times and, in response, conditionally modifying the media item by modifying at least a portion of the first background element without modifying the foreground element when the initial location of the input is directed to the location of the first background element improves image editing technologies because it performs an operation when a set of conditions has been met without requiring further user input, modifies specific elements when an input is directed to two different elements, and provides additional control options without cluttering the user interface.

In some embodiments, detecting the input corresponding to the request to modify the media item includes the computer system detecting at least a portion of the input is directed to a location of a second background element (e.g., 1210b1, 1210b2, 1210b3, 1210b4, 21210c, 1010e1, and/or 1210e2), different from the first background element (e.g., the first background element is still modified even though a portion of the input is directed to the second background element). In some embodiments, in response to detecting the input corresponding to the request to modify the media item, and in accordance with the determination that the initial location of the input is directed to the location of the first background element, and in accordance with a determination that at least a portion of the input is directed to the location of the second foreground element, the computer system modifies (e.g., using an AI process or a generative AI process) the media item (e.g., automatically-generated and/or automatically-modified visual content) by modifying (e.g., using an AI process or a generative AI process) at least a portion of the second background element (or, optionally the computer system forgoes modifying the second background element) (e.g., the first background element and the second background element are modified in response to input starting at the first foreground element and moving over the second foreground element). Detecting at least a portion of the input is directed to a location of a second background element that is different from the first background element and, in response, conditionally modifying the media item by modifying at least a portion of the first background element without modifying the foreground element when the initial location of the input is directed to the location of the first background element improves image editing technologies because it performs an operation when a set of conditions has been met without requiring further user input, modifies specific elements even if an input is accidentally directed to two different elements, and provides additional control options without cluttering the user interface.

In some embodiments, modifying (e.g., using an AI process or a generative AI process) at least the portion of the first background element includes the computer system replacing at least the portion of the first background element with automatically-generated visual content (e.g., computer generated content and/or content generated using a machine learning algorithm and/or artificial intelligence) (e.g., automatically-generated visual content and/or generative visual content) that is based on content of the media item that is near the first background element (e.g., 1220a, 1220b, 1220c, and/or 1220d) (e.g., a portion of the first background element is replaced by the automatically-generated visual content). In some embodiments, the computer system modifies (e.g., using an AI process or a generative AI process) at least a portion of the first background element by changing a first visual characteristic (e.g., color, brightness, clarity, and/or blur) of at least the portion of the first background item to a second visual characteristic (e.g., automatically-generated visual content and/or generative visual content), different from the first visual characteristic (e.g., while maintaining display of at least the portion of the first background element). In some embodiments, the automatically-generated visual content (e.g., automatically-generated visual content and/or generative visual content) extends nearby content into the space that was occupied by the first background element, and the automatically-generated visual content (e.g., automatically-generated visual content and/or generative visual content) is generated (e.g., using an AI process or a generative AI process) with a spatially varied appearance. In some embodiments, the automatically-generated visual content (e.g., automatically-generated visual content and/or generative visual content) is generated by an AI process (e.g., a generative AI model such as a diffusion model or large language model based visual content generation model) that generates (e.g., using an AI process or a generative AI process) content (e.g., automatically-generated visual content and/or generative visual content) that is consistent with the nearby content. Conditionally modifying at least the portion of the first background element by displaying automatically-generated visual content that is based on content of the media item that is near the first background element without modifying the foreground element when the initial location of the input is directed to the location of the first background element improves image editing technologies because it performs an operation when a set of conditions has been met without requiring further user input, stops displaying specific elements even if an input is accidentally directed to two different elements, and provides additional control options without cluttering the user interface.

In some embodiments, the foreground element and the first background element are distinguished from each other automatically (e.g. without user input) (e.g., using an AI process or a generative AI process) based on information associated with the media item (e.g., device 1200 automatically distinguishes 1210a1-1210a2 from 1210b1-1210b3 as described with respect to FIG. 12B) (e.g., the computer system automatically distinguishes the foreground element from the first background element). In some embodiments, the computer system automatically (e.g., using an AI process or a generative AI process) detects the foreground element and the first background element using a machine learning model (e.g., with detected depth data based on one or more depth sensors and/or information from multiple cameras that capture image data from different viewpoints, or without detected depth data). In some embodiments, the computer system automatically (e.g., using an AI process or a generative AI process) detects the foreground element and the first background element using depth data (e.g., the foreground element has a different depth than the first background element). In some embodiments, a depth of the foreground element is less than a depth of the first background element. In some embodiments, the foreground element is an element that has a depth within a first range of depths (e.g., 1 ft. to 4 ft and/or 1 ft to 10 ft) and the first background element has a depth within a second range of depths (e.g., 4.1 ft to 15 ft and/or 10.1 ft to 30 ft), different from the first range of depths (e.g., the second range does not overlap with the first rang of depths). In some embodiments, the computer system groups elements of the media items into different (e.g., non-overlapping) ranges of depths (e.g., a first range of depths, a second range of depth, and/or a third range of depths). Automatically distinguishing the foreground element and first the background element from each other based on information associated with the media item reduces the number of inputs needed to perform an operation.

In some embodiments, prior to detecting the input corresponding to the request to modify the media item, the computer system detects a request to display a media editing user interface (e.g., 1205a causes display of 1208 in FIG. 12B) (e.g., at a respective time) (or, optionally, detecting a request to enter an edit mode). In response to detecting the request to display the media editing user interface (or, optionally, in response to detecting the request to enter the edit mode), the computer system displays, via the one or more display generation components, a visual effect (e.g., 1216a and/or 1216f) (e.g., automatically-generated visual content and/or generative visual content) emphasizing a first type of element of the media item (e.g., 1210a1, 1210a2, 1210b1, 1210b2, 1210b3, 1201e2, 1201e2, and/or 1210g) (e.g., one or more elements that are automatically detected by the computer system, one or more elements that are available for removal using a first type of input, and/or one or more elements that are in the background) relative to a second type of element of the media item (e.g., 1210a1, 1210a2, and/or 1210c) (e.g., one or more elements that are not automatically detected by the computer system, one or more elements that are not available for removal using the first type of input, and/or one or more elements that are in the foreground), different from the first type of element. In some embodiments, emphasizing the first type of element includes displaying a visual element (e.g., color and/or animation) at least partially around the first type of element. In some embodiments, all the detected elements of the first type are emphasized relative to the second type of element. In some embodiments, the first type of element is emphasized by displaying an indication along a portion of (or, optionally, along the entire portion of) a boundary of the first type of element (e.g., without displaying the indication along a portion of the second type of element). In some embodiments, the first type of element of the media item is modified (e.g., using an AI process or a generative AI process) in a first manner (e.g., via a first type of input) (e.g., all portions of the element will be modified, even the portions that have not be traced) and the second type of media item is modified in a second manner, different from the first manner (via a second type of input) (e.g., only the portions that have been traced will be modified while the other portions will not be modified). Displaying a visual effect emphasizing a first type of element of the media item relative to a second type of element of the media item, different from the first type of element, improves image editing technologies because it provides visual feedback about the different types of elements in the media item.

In some embodiments, emphasizing the first type of element includes the computer system decreasing the visual emphasis of the first type of element relative to the second type of element over a period of time (e.g., 1216a gradually decrease over FIGS. 12B-12C) (e.g., the first type of element becomes less emphasized over time) (e.g., a visual effect displayed at the first type of element fades over time). In some embodiments, once a threshold period-of-time has been reached, the first type of element is not emphasized relative to the second type of element (e.g., the visual effect no longer is displayed). Decreasing the emphasis of the first type of element relative to the second type of element over a period of time improves image editing technologies because it provides visual feedback about different types of elements in the media item.

In some embodiments, emphasizing the first type of element relative to the second type of element includes the computer system displaying a visual indication (e.g., shading and/or hatching of 1216a in FIGS. 12B-12C) (e.g., automatically-generated visual content and/or generative visual content) having a brightness level that includes a degree of brightness that exceeds a standard dynamic range of brightness for the one or more display generation components (e.g., 1216a is a color and/or brightness in an HDR range, as described with respect to FIG. 12B) (e.g., brightness that is in an extended dynamic range for the one or more display generation components that is used for limited media items and/or specific types of media items (e.g., HDR media)) (e.g., the visual indication has a brightness level that exceeds the brightest level found in the standard dynamic range (SDR)) (e.g., the visual indication has a brightness level that is within a brightness level that is within the high-dynamic range (HDR range) and is not within the SDR range). Emphasizing the first type of element relative to the second type of element by displaying a visual indication having a brightness level that includes a degree of brightness that exceeds a standard dynamic range of brightness for the one or more display generation components improves image editing technologies because it provides visual feedback about different types of elements in the media item when the media item includes bright content.

In some embodiments, modifying (e.g., using an AI process or a generative AI process) the first background element includes modifying (e.g., using an AI process or a generative AI process) a respective portion of the first background element (e.g., a hand or foot of 1210b1 and/or 1210b2 is removed; and/or a top portion of 1210b3 is removed), wherein the input is not directed to the respective portion of the first background element (e.g., 1205d does not overlap with the hand and/or foot of 1210b1 and/or 1210b2; and/or 1205d does not overlap with the top portion of 1210b3) (e.g., even though the input was directed to one portion, one or more different portions of the first background element are modified, including a portion to which the input was not directed to). In some embodiments, modifying (e.g., using an AI process or a generative AI process) the first background element includes modifying (e.g., using an AI process or a generative AI process) all portions within a boundary (e.g., a boundary that is automatically detected by the computer system) of the first background element. In some embodiments, the computer system detects, via the one or more input devices, a selection of an element (e.g., the first background element and/or the foreground element) of the first media item (e.g., before or after detecting the input corresponding to the request to modify the media item). In some embodiments, in response to detecting the selection of the element, the computer system modifies (e.g., using an AI process or a generative AI process) the selected element (e.g., without modifying a non-selected element). In some embodiments, the element of the first media item is selected by detecting an input directed to at least one location within a boundary of the element. In some embodiments, the input to select an element is an input (tap and/or an air gesture) directed to a portion (e.g., some but not all of the element) of the element and/or an input that moves over a portion (some but not all) of the element. Modifying the first background element by modifying a respective portion of the first background element to which the input is not directed to improves image editing technologies because it reduces the number of inputs needed to perform an operation and provides additional control options without cluttering the user interface.

In some embodiments, detecting the input corresponding to the request to modify the media item includes the computer system detecting a movement component of the input (e.g., movement of 1205d) (e.g., a movement of a pinch gesture and/or a movement component of a swipe) directed to one or more locations of the first background element (e.g., movement of input 1205d moves over 1210b1, 1210b2, and/or 1210b3). In some embodiments, an element is selected when a movement component of the input moves over a boundary (e.g., crosses over into a portion) of an element. Detecting a movement component of the input is directed to one or more locations of the first background element and, in response, modifying at least a portion of the first background element improves image editing technologies because it reduces the number of inputs needed to perform an operation.

In some embodiments, in response to detecting the input corresponding to the request to modify the media item, the computer system displays, via the one or more display generation components, a first indication (e.g., as depicted by gray shading for 1216b in FIGS. 12E-12F) (e.g., a graphical object and/or visual effect) at one or more locations corresponding to one or more locations of the movement component (e.g., a trailing visual effect is displayed as the input moves). In some embodiments, in response to detecting the input corresponding to the request to modify the media item, the computer system gradually reduces a visual emphasis (e.g., increasing the transparency, gradually reducing a brightness, and/or gradually ceasing to display) of the first indication over time (e.g., the gray shading for 1216b gradually fades until it is no longer is displayed). In some embodiments, the computer system ceases to display the first indication when a threshold time has been met. Detecting a movement component of the input and, in response, displaying an indication at one or more locations of the movement component and gradually reducing a visual emphasis of the visual indication over time improves image editing technologies because it provides visual feedback of the movement of the input.

In some embodiments, the first indication includes a first visual characteristic (e.g., gray shading of 1216b in FIGS. 12E-12F) (e.g., color, animation, and/or shape). In some embodiments, in response to detecting the input corresponding to the request to modify the media item and in accordance with a determination that an initial location of the input is directed to the location of the first background element (e.g., the initial location of 1205d is directed at 1210b1 in FIG. 12D): the computer system displays, via the one or more display generation components, an indication (e.g., a graphical object and/or visual effect) at one or more locations of the first background element (e.g., gray shading of 1216c is displayed at 1210b1 in FIG. 12E) (or optionally, one or more locations of an element different from the first background element), wherein the indication at one or more locations of the first background element includes the first visual characteristic (e.g., gray shading of 1216c is the same gray shading of 1216b in FIG. 12E) (e.g., a trailing visual effect that is displayed along a path of a moving input attaches to an object in the path of the movement). In some embodiments, the indication at one or more locations of the first background element is displayed at one or more location of the first background element that are different from the one or more locations of the movement component (e.g., specific portions of the first background element visual effect even though the input did not move over those specific portions) (e.g., a trailing visual effect of the input attaches to a detected object when the input moves over some but not all of the detected object). Detecting a movement component of the input and, in response, displaying an indication at one or more locations of the first background element, where indication has the same visual characteristic as the first indication, improves image editing technologies because it provides visual feedback that the movement of the input has selected an element to modify.

In some embodiments, in response to detecting the input corresponding to the request to modify the media item, wherein the input corresponding to the request to modify the media item traverses a path (e.g., path of movement of 1205d and/or path of movement of 1205af) (e.g., the input includes movement and the path is defined by the movement): in accordance with a determination that the path crosses one or more detected visual elements (e.g., 1210a1, 1210a2, 1210b1, 1210b2, and/or 1210b3) (e.g., background items and/or foreground items) (e.g., automatically detected) of the media item, the computer system displays (e.g., under and/or around the one or more detected visual elements on the path) a first type of indication (e.g., 1216c is displayed at 1210b1, 1210b2, and/or 1210b3) (e.g., automatically-generated visual content and/or generative visual content). In some embodiments, the first type of indication (e.g., automatically-generated visual content and/or generative visual content) is automatically (e.g., using an AI process or a generative AI process) positioned at a location corresponding to the first background element. In some embodiments, the first type of indication (e.g., automatically-generated visual content and/or generative visual content) partially surrounds the first background element. In some embodiments, in response to detecting the input corresponding to the request to modify the media item, wherein the input corresponding to the request to modify the media item traverses a path (e.g., path of movement of 1205d and/or path of movement of 1205af): in accordance with a determination that the path does not cross one or more detected visual elements of the media item (e.g., 1210c and/or 1210h) (e.g., crosses visual elements that are not automatically detected) (e.g., are not a recognized object and/or are not identified objects), the computer system displays a second type of indication (e.g., 1216g follows a path of movement of 1205af), different from the first type of indication. In some embodiments, the second type of indication is not automatically positioned at a location corresponding to the one or more detected visual elements (e.g., the first background element). In some embodiments, the second type of indication is positioned at a location corresponding to the location of the movement component (e.g., the path) (e.g., without automatically positioning the first type of indication). Conditionally displaying a first type of indication or a second type of indication based on whether the path crosses one or more detected visual elements performs an operation when a set of conditions has been met without requiring further user input and provides improved visual feedback as to whether the element is a detected object.

In some embodiments, the first indication is displayed with a brightness level that includes a degree of brightness that exceeds a standard dynamic range of brightness for the one or more display generation components (e.g., 1216b is a color and/or brightness in an HDR range, as described with respect to FIG. 12E) (e.g., brightness that is in an extended dynamic range for the one or more display generation components that is used for limited media items and/or specific types of media items (e.g., HDR media)) (e.g., the first indication has a brightness level that exceeds a brightest level found in the standard dynamic range (SDR)) (e.g., the first indication has a brightness level that is within a brightness level that is within the high-dynamic range (HDR range) and is not within the SDR range). Displaying the first indication as having a degree of brightness exceeds a standard dynamic range of brightness for the one or more display generation components improves image editing technologies because it provides visual feedback of a path of the input and what portions of the media item might be modified.

In some embodiments, the media item includes a first element (e.g., 1210a1, 1210a2, 1210b1, 1210b2, 1210b3, 1210e1, and/or 1210e2) (e.g., the first foreground element, the background element, an element different from the first foreground element, and/or an element different from the background element) that is automatically (e.g., using an AI process or a generative AI process) detected by the computer system. In some embodiments, while displaying the media item including the first element, the computer system detects, via the one or more input devices, a respective input (e.g., 1205j2, 1205ab5, and/or 1205ac2) (e.g., tap, mouse click, and/or air gesture) directed to a location of the first element and without detecting a movement component of the respective input (e.g., 1205j2, 1205ab5, and/or 1205ac2 do not move after the input is detected a respective location) (e.g., the input does not move). In some embodiments, in response to detecting the respective input directed to the location of the first element and without detecting the movement component of the respective input, the computer system selects the first element of the media item (e.g., 1210b3 is selected for editing and/or 1210e1 is selected in FIG. 12AC) (e.g., the first element is selected by a non-moving input) (e.g., using an AI process or a generative AI process). In some embodiments, the computer system modifies (e.g., using an AI process or a generative AI process) the first element of the media item in response to the first element being selected. Detecting a respective input a respective input directed to a location of the first element and without detecting a movement component of the respective input and without detecting a movement component of the respective input and, in response, selecting the first element of the media item reduces the number of inputs (and movement) needed to perform an operation.

In some embodiments, in response to detecting the input corresponding to the request to modify the media item and in accordance with the determination that the initial location of the input is directed to the location of the first background element (e.g., the initial location of input 1205d is directed to 1210b1 in FIG. 12D, an initial location of input 1205j2 is directed to the location of 1210b1 and/or 1210b2, and/or an initial location of input 1205ac1 is directed to the location of 1210e1) (e.g., while displaying the first background item): the computer system displays, via the one or more display generation components, a visual indication (e.g., 1216c is displayed at 1210b1 in FIG. 12D) (e.g., a graphical object and/or a visual effect) that visually distinguishes the first background element from content (e.g., the foreground element and/or other background elements) in the media item (e.g., 1216c distinguishes 1210b1 from other portions of 1208 in FIG. 12D) (e.g., an indication is displayed when an element is selected). In some embodiments, the first background element is emphasized relative to the foreground element (and/or other portions of the media item that are not selected). In some embodiments, in response to detecting the input corresponding to the request to modify the media item and in accordance with a determination that the initial location of the input is directed to the location of the foreground element, the computer system displays an indication that visually distinguishes the foreground element from a different element of the media item (e.g., the first background element). Displaying a visual indication that visually distinguishes the first background element from content of the media item in response to detecting the input corresponding to the request to modify the media item and in accordance with the determination that the initial location of the input is directed to the location of the first background element performs an operation when a set of conditions has been met without requiring further user input and provides visual feedback regarding which elements are selected and will be modified.

In some embodiments, in response to detecting the input corresponding to the request to modify the media item and in accordance with the determination that the initial location of the input is directed to the location of the first background element (e.g., the initial location of input 1205d is directed to 1210b1 in FIG. 12D, an initial location of input 1205j2 is directed to the location of 1210b1 and/or 1210b2, and/or an initial location of input 1205ac1 is directed to the location of 1210e1): the computer system ceases display, via the one or more display generation components, of a visual indication (e.g., 1216f at 1210e2 depicted in FIG. 12AC) (e.g., a graphical object and/or a visual effect) that visually distinguishes a second element (e.g., 1216f distinguishes 1210e2 from other portions of 1211) (e.g., the foreground element and/or a background element) from content (e.g., the foreground element and/or other background elements) of the media item (e.g., when an element is selected (e.g., with a tap or drag), the computer system stops displaying an indication from an element that is not selected). In some embodiments, the first background element is emphasized relative to the foreground element (and/or other portions of the media item that are not selected). In some embodiments, in response to detecting the input corresponding to the request to modify the media item and in accordance with a determination that the initial location of the input is directed to the location of the foreground element, the computer system ceases to display of an indication (e.g., a graphical object and/or a visual effect) that visually distinguishes the foreground element from a different element of the media item (e.g., another foreground element and/or a background element). Ceasing display of a visual indication that visually distinguishes the an element from content of the media item in response to detecting the input corresponding to the request to modify the media item and in accordance with the determination that the initial location of the input is directed to the location of the first background element performs an operation when a set of conditions has been met without requiring further user input and provides visual feedback regarding which elements will be modified.

In some embodiments, modifying (e.g., using an AI process or a generative AI process) at least a portion of the first background element without modifying the foreground element to which the input was directed includes: in accordance with a determination that the media item is displayed at a first zoom level (e.g., the zoom level depicted in FIG. 12AB2) (e.g., a level that defines how large or how small the media item is displayed), the computer system modifying (e.g., using an AI process or a generative AI process) at least the portion of the first background element using a respective dimension (e.g., radius, width, and/or height) for modifying the media item in response to detecting an input (e.g., both 1210b4 and 1210b2 are removed in response to detecting input 1205ab2, as depicted in FIG. 12AB3) (e.g., mouse click, air gesture, and/or touch input); and in some embodiments, the respective dimension is a respective area that will be edited in response to detecting the input. In some embodiments, modifying (e.g., using an AI process or a generative AI process) at least a portion of the first background element without modifying the foreground element to which the input was directed includes: in accordance with a determination that the media item is displayed at a second zoom level (e.g., the zoom level depicted in FIG. 12AB5), different from the first zoom level, the computer system modifying (e.g., using an AI process or a generative AI process) at least the portion of the first background element using the respective dimension for modifying the media item in response to detecting the input (e.g., as depicted in FIG. 12AB6, only 1210b4 is removed in response to detecting input 1205ab5, where the same dimension was used for input 1205ab2 and input 1205ab5) (e.g., a dimension of an input to modify the media item is the same at different zoom levels so that a user can zoom into the image to make more precise edits). In some embodiments, the respective dimension (e.g., height and/or width) for a respective input is independent of the zoom level (e.g., the area covered by a respective input is the same regardless of a zoom level, but a user can zoom in to provide more precise edits). In some embodiments, the computer system maintains the respective dimension for the respective input at different zoom levels (e.g., which results in different degrees of precision when zooming in or out of a media item). When content can be displayed at a plurality of different zoom levels, displaying the content at a higher zoom level of the plurality of zoom levels includes displaying the content with larger size (optionally, while a displayed portion of the content has a first spatial extent or is displayed in a first region), while displaying the content at a lower zoom level of the plurality of zoom levels includes displaying the content with smaller size (optionally, while a displayed portion of the content has the first spatial extent or is displayed in the first region). Modifying at least a portion of the first background element the media item using the same respective dimension for the same input across different zoom levels improves image editing technologies because a user can adjust the zoom to make more precise or less precise of an edit.

In some embodiments, modifying (e.g., using an AI process or a generative AI process) at least a portion of the first background element without modifying the foreground element to which the input was directed includes: in accordance with a determination that a setting for a dimension (e.g., 1238) (e.g., radius, width, and/or height) for modifying the media item in response to detecting a respective input (e.g., mouse click, air gesture, and/or touch input) (e.g., an editing input and/or an input directed to the media item so as to modify an appearance of the media item) is set at a first value (e.g., the value of 1238 in FIG. 12AE), the computer system modifying (e.g., using an AI process or a generative AI process) at least the portion of the first background element using a first dimension for the respective input (e.g., edits in FIG. 12AC were made using the value of 1238 in FIG. 12AE). In some embodiments, modifying (e.g., using an AI process or a generative AI process) at least a portion of the first background element without modifying the foreground element to which the input was directed includes: in accordance with a determination that the setting for the dimension for modifying the media item in response to detecting the respective input is set at a second value (e.g., the value of 1238 in FIG. 12AF) that is different from (e.g., higher or lower than) the first value, the computer system modifying (e.g., using an AI process or a generative AI process) at least the portion of the first background element using a second dimension for the respective input that is different from (e.g., larger or smaller than) the first dimension (e.g., edits in FIGS. 12AF-12AK were made using the value of 1238 in FIG. 12AF). Conditionally using a first or second dimension for a respective input based on a setting for a dimension for modifying the media item in response to a respective input improves image editing technologies because it performs an operation when a set of conditions has been met without requiring further user input and provides greater precision when modifying a media item.

In some embodiments, modifying (e.g., using an AI process or a generative AI process) at least the portion of the first background element (e.g., by replacing the portion of the first background content that was automatically-generated, where the automatically-generated visual content optionally extends nearby content into the space that was occupied by the first background element, and the automatically-generated visual content is generated with a spatially varied appearance) includes the computer system displaying, via one or more display generation components, an animation (e.g., 1218) of gradually ceasing to display the portion of the first background element (e.g., 1210b1, 1210b2, 1210b3 begin to separate into individual particles until 1210b1, 1210b2, 1210b3 are no longer displayed) (e.g., the portion of the first background begins to be removed and/or dissolve). In some embodiments, the animation (e.g., 1218) of gradually ceasing to display the portion of the first background element includes: in accordance with a determination that the portion of the first background element has a first color (e.g., 1210b1, 1210b2, and/or 1210b3 has one color) (e.g., red, blue, yellow, green, or a color value that is a mix of two or more of those colors), a respective color of the animation is based on the first color (e.g., 1218 includes a separated particle of 1210b1, 1210b2, and/or 1210b3 has a color that is based on the particular color); and in accordance with a determination that the portion of the first background element has a second color (e.g., 1210b1, 1210b2, and/or 1210b3 has a different color), different from the first color, the respective color of the animation is based on the second color (e.g., 1218 includes a separated particle of 1210b1, 1210b2, and/or 1210b3 has a color that is based on that different color). In some embodiments, the automatically-generated visual content (e.g., automatically-generated visual content and/or generative visual content) is generated (e.g., using an AI process or a generative AI process) by an AI process (e.g., a generative AI model such as a diffusion model or large language model based visual content generation model) that generates content that is consistent with the nearby content. Displaying an animation of gradually ceasing display of the portion of the first background element, where the animation includes a color that is based on a color of the portion of the first background element improves image editing technologies because it provides visual feedback of the portion(s) of the first background element that are being removed.

In some embodiments, the animation of gradually ceasing display of the portion of the first background element includes moving a graphical element (e.g., particles of 1210b1, 1210b2, and/or 1210b3 as depicted in FIGS. 12G-12I) having the respective color away from the portion of the first background element (e.g., particles of 1210b1, 1210b2, and/or 1210b3 move away from the remaining portions of 1210b1, 1210b2, and/or 1210b3 as depicted in FIGS. 12G-121) (e.g., away from a center of, an edge of, or another portion of the first background). Displaying an animation that includes moving the graphical element having the respective color away from the portion of the first background improves image editing technologies because it provides visual feedback of the portion(s) of the first background element that are being removed.

In some embodiments, the computer system detects, via the one or more input devices, an undo input (e.g., 1205i, 1205n, 1205k, and/or 1205o1) (e.g., mouse click, air gesture, and/or touch input) directed to an undo selectable object (e.g., 1222). In some embodiments, in response to detecting the undo input directed to the undo selectable object, the computer system undoes a first modification that is a most recently performed modification (e.g., 1210b1, 1210b2, and/or 1210b3 is re-displayed in FIG. 12J1). In some embodiments, subsequent to detecting the undo input, the computer system detects, via the one or more input devices, a redo input (e.g., 1205j1) (e.g., mouse click, air gesture, and/or touch input) directed to a redo selectable object (e.g., 1224). In some embodiments, in response to detecting the redo input, the computer system redoes the first modification (e.g., 1210b1, 1210b2, and/or 1210b3 removed again when input 1205j1 is detected). In some embodiments, prior to detecting the redo input, the computer system detects a second undo input directed to the undo selectable object and, in response, undoes a second modification that is a modification that occurred immediately before the first modification (e.g., a user can undo multiple steps of editing). In some embodiments, after undoing the second modification, the computer system detects a second redo input directed to the redo selectable object and, in response, redoes the second (e.g., a user can redo multiple steps of editing). Detecting an undo input and, in response undoing a first modification that is a most recently performed modification and then detecting a redo input and, in response, redoing the first modification improves image editing technologies because it reduces the number of inputs to undo and redo edits and provides better control over modifying the media item.

In some embodiments, prior detecting the request to modify the media item, the computer system displays, via one or more display generation components, a first media editing user interface (e.g., 1202 in FIG. 12A) that includes a first selectable object (e.g., 1204e) that corresponds to a first category of one or more editing tools. In some embodiments, the computer system detects, via one or more input devices, an input (e.g., 1205a) (e.g., mouse click, air gesture, and/or touch input) directed to the first selectable object. In some embodiments, in response to detecting the input directed to the first selectable object, the computer system displays, one or more display generation components, a second media editing user interface (e.g., 1202 in FIG. 12B) that includes a first set (e.g., one or more) of editing selectable objects (e.g., 1210a1, 1210a2, 1210b1-1210b4, and/or 1210e1-1210e2 are selectable so as to be edited; and/or 1202 in FIG. 12B optionally includes options to switch between editing image 1208 in different manners, such as removing and/or changing portions of image 1208, using a machine learning algorithm, as described with respect to FIG. 12Y) that, when selected, modifies the media item via one or more machine learning algorithms (e.g., using an AI process or a generative AI process). In some embodiments, the second media editing user interface is displayed when the request to modify the media item is detected (e.g., 1202 is displayed in FIG. 12B). In some embodiments, wherein at least the portion of first background element is modified (e.g., using an AI process or a generative AI process) via the one or more machine learning algorithms (e.g., 1210a1, 1210a2, 1210b1-1210b4, 1210d, and/or 1210e1-1210e2 are edited using a machine learning algorithm). (e.g., the first media editing user interface has a tab that, when selected, displays an option to use an editing tool that modifies the media item via one or more machine learning algorithms). In some embodiments, the one or more machine learning algorithms includes a generative machine learning algorithm. In some embodiments, the first set of selectable objects to modify the media item via one or more machine learning algorithms includes a selectable object that, when selected, displays simulated content (e.g., automatically-generated visual content and/or generative visual content) via one or more machine learning algorithms (e.g., using an AI process or a generative AI process) in response to an input directed to the media item. In some embodiments, the first set selectable objects to modify the media item via one or more machine learning algorithms (e.g., using an AI process or a generative AI process) includes a selectable object that, when selected, changes, via one or more machine learning algorithms (e.g., using an AI process or a generative AI process), a characteristic of existing content of the media item in response to an input directed to the media item. Detecting the input directed to the first selectable object and, in response, displaying a second media editing user interface that includes a first set of editing selectable objects that, when selected, modifies the media item via one or more machine learning algorithms, where the second media editing user interface is displayed when the request to modify the media item is detected and where at least the portion of the first background element is modified via the one or more machine learning algorithms improves image editing technologies because it provides access to one or more machine learning algorithms to modify the media item and declutters the user interface.

In some embodiments, the first media editing user interface (e.g., and/or the second media editing user interface) includes a second selectable object (e.g., 1204a, 1204b, 1204,c, and/or 1204d), different from the first selectable object, that corresponds to a second category (e.g., portrait media editing mode tools, visual characteristic editing mode tools, filter editing mode tools, and/or image orientation editing mode tools as described with respect to FIG. 12A) of one or more editing tools (e.g., different from the first category of one or more editing tools) (e.g., a crop category of editing tools that includes a set of one or more editing tools that adjust a crop and/or orientation correction of the media item (e.g., horizontal perspective correction, vertical perspective correction, and/or horizon correction), a visual characteristic category that includes a set of one or more editing tools that modify a visual characteristic (e.g., brightness, contrast, shadows, exposure value, highlights, blackpoint, saturation, vibrance, temperature, tint, sharpness, definition, noise reduction, vignette, color, and/or black and white) of the media item, a filter category of editing tools that includes a set of one or more tools that apply different filters (e.g., original, vivid, vivid warm, vivid cool, dramatic, dramatic warm, dramatic cool, mono, silvertone, and/or noir) to the media item, a portrait category that includes a set of one or more tools that adjust an f-stop value and/or a lighting effect (e.g., natural light, studio light, contour light, stage light, and/or stage light mono), and/or animated image category of editing tools that includes a set of one or more tools that select a frame from an animated image). In some embodiments, the second selectable object is concurrently displayed with the first selectable object (e.g., as depicted in FIG. 12A). In some embodiments, after detecting the input directed to the first selectable object, the computer system detects, via one or more input devices, an input (e.g., mouse click, air gesture, and/or touch input) directed to the second selectable object (e.g., At FIG. 12B, after detecting input 1205a, device 1200 detects an input directed at 1204b). In some embodiments, in response to detecting the input directed to the second selectable object: the computer system displays, via the one or more generation components, the second category of one or more editing tools without displaying first category of one or more editing tools (e.g., 1202 as depicted in FIG. 12A) (and/or the second user interface). In some embodiments, the second category of one or more editing tools includes an editable selectable object (e.g., 1204b-1, 1204b-2, and/or 1204b-3) for adjusting a first editable parameter (e.g., the parameters associated with auto visual characteristic editing tool affordance 1204b-1, exposure parameter of exposure editing tool affordance 1204b-2, and/or brightness editing tool affordance 1204b-3) (e.g., crop, orientation, brightness, contrast, shadows, exposure value, highlights, filter, f-stop value, lighting effect, and/or a frame of an animated image) of the media item. In some embodiments, the second category of one or more editing tools includes an editable selectable object (e.g., 1204b-1, 1204b-2, and/or 1204b-3) for adjusting a second editable parameter of the media item that is different from the first editable parameter (e.g., the parameters associated with auto visual characteristic editing tool affordance 1204b-1, exposure parameter of exposure editing tool affordance 1204b-2, and/or brightness editing tool affordance 1204b-3). In some embodiments, the first media editing user interface includes a third selectable object, different from the first selectable object and the second selectable object, that corresponds to a third category of one or more editing tools (e.g., different from the first category and/or the second category of one or more editing tools). In some embodiments, the second category of one or more editing tools and/or the third category of one or more editing tools do not include a tool to modify the media item via a generative machine learning algorithm (e.g., using an AI process or a generative AI process). Displaying the first media editing user interface that includes a second selectable object, different from the first selectable object, that corresponds to a second category of one or more editing tools, where the second selectable object is concurrently displayed with the first selectable object, where the second category of one or more editing tools are displayed without displaying the first set of editing selectable objects in response to an input directed to the second selectable object, and where the second category of one or more editing tools includes an editable selectable object for adjusting a first editable parameter and an editable selectable object for adjusting a second editable parameter that is different from the first editable parameter improves image editing technologies because it provides access to different categories of editing tools (e.g., including a category one or more machine learning algorithms to modify the media item) and declutters the user interface.

In some embodiments, the second media editing user interface includes an indication (e.g., 1212a and/or 1212b) of one or more input criteria that needs to be satisfied in order to modify the media item via the one or more machine learning algorithms (e.g., using an AI process or a generative AI process). In some embodiments, the indication of the one or more input criteria includes an indication to tap, circle, and/or swipe over the media item. Including an indication one or more input criteria that needs to be satisfied to modify the media item via the one or more machine learning algorithms in the second media editing user interface improves image editing technologies because it provides visual feedback of the necessary inputs to modify the media item, which reduces the number of inputs needed to modify the media item.

Note that details of the processes described above with respect to method 1300 (e.g., FIG. 13) are also applicable in an analogous manner to the methods described above. For example, methods 700, 900, and/or 1100 optionally include one or more of the characteristics of the various methods described above with reference to method 1300. For example, the computer system of method 1300 can be used to further edit a media item that is edited using the computer system of methods 700 and/or 900. As another example, the computer system of method 1100 can be used selectively apply edits described with respect to methods 1300 from one media item to another media item. For brevity, these details are not repeated herein.

FIGS. 14A-14L illustrate exemplary user interfaces for editing audio of a media item, in accordance with some embodiments. The user interfaces in these figures are used to illustrate the processes described below, including the processes in FIG. 16.

In some embodiments, any of the inputs described herein (e.g., input 1450a, 1450b, 1450c, 1450d, 1450e, 1450f, 1450g, 1450h, 1450i, 1450j, and/or 1410) is or includes a touch input (e.g., a tap gesture and/or a swipe gesture). In some embodiments, any of the inputs described herein (e.g., input 1450a, 1450b, 1450c, 1450d, 1450e, 1450f, 1450g, 1450h, 1450i, 1450j, and/or 1410) is or includes a voice input (e.g., a voice command to select a user interface element or to activate a feature or perform a function, such as a feature or function associated with a user interface element). In some embodiments, any of the inputs described herein (e.g., input 1450a, 1450b, 1450c, 1450d, 1450e, 1450f, 1450g, 1450h, 1450i, 1450j, and/or 1410) is or includes an air gesture (e.g., an air gesture to select a user interface element or to activate a feature or perform a function, such as a feature or function associated with a user interface element). In some embodiments, any of the inputs described herein (e.g., input 1450a, 1450b, 1450c, 1450d, 1450e, 1450f, 1450g, 1450h, 1450i, 1450j, and/or 1410) is or includes activation (e.g., a press, a rotation, and/or a movement) of a hardware device (e.g., a button, a rotatable input mechanism, a rotatable and depressible input mechanism, a mouse, a mouse button, a trackpad, a trackpad button, a button of a remote control, and/or a joystick). In some embodiments, any of the inputs described herein (e.g., input 1450a, 1450b, 1450c, 1450d, 1450e, 1450f, 1450g, 1450h, 1450i, 1450j, and/or 1410) as a touch and drag gesture includes an air gesture (e.g., an air gesture including a pinch and/or movement) and/or a click and drag gesture (e.g., a click of a mouse button and/or a trackpad and/or movement while holding a press of a mouse button and/or trackpad) of a mouse and/or trackpad. In some embodiments, any of the user interface elements described as being selected herein (e.g., an icon, affordance, button, and/or selectable option) is selected by activating a hardware device while the user interface element is in focus (e.g., highlighted, bolded, outlined, visually distinguished from other user interface elements, and/or located at or near a cursor).

FIG. 14A illustrates computer system 600 displaying media item user interface 822, which includes media item representation 822a corresponding to a media item of the media library of computer system 600. At FIG. 14A, the media item corresponding to media item representation 822a is a video media item. In some embodiments, a video media item includes a video and/or a sequence of images that are configured to play back over time. At FIG. 14A, computer system 600 determines that the media item corresponding to media item representation 822a is a video media item and displays scrubber control 822d and/or video controls 822b and 822c.

At FIG. 14A, computer system 600 has not initiated play back of the video media item corresponding to media item representation 822a. Computer system 600 displays play user interface object 822e indicating that the video media item is not playing back and/or that the user of computer system 600 can cause playback of the video media item in response to selection of play user interface object 822e. At FIG. 14A, computer system 600 detects user input 1450a (e.g., a tap input and/or a touch input) corresponding to play user interface object 822e. In response to detecting user input 1450a, computer system 600 initiates play back of the video media item corresponding to media item representation 822a and outputs audio 1401a, as shown at FIG. 14B.

At FIG. 14A, computer system 600 also detects user input 1450b (e.g., a tap input and/or a touch input) corresponding to edit user interface object 804j. While edit user interface object 804j is displayed at a location of media item user interface 822 that is to the right of favorite user interface object 804g, information user interface object 804h, and delete user interface object 804i, in some embodiments, computer system 600 displays edit user interface object 804j at a different location of media item user interface 822 (e.g., computer system 600 displays edit user interface object 804j at the location of delete user interface object 804i and displays delete user interface object 804i at the location of edit user interface object 804j). In response to detecting user input 1450b corresponding to edit user interface object 804j, computer system 600 displays audio editing user interface 1400, as shown at FIG. 14B.

At FIG. 14B, computer system 600 outputs audio 1401a in response to detecting user input 1450a corresponding to play user interface object 822e. For instance, FIG. 14B includes the text “AUDIO MIX STYLE 3 AT 50%” to indicate that computer system 600 is outputting audio of the video media item with a respective audio mix effect (e.g., audio mix style 3 and/or a studio audio mix effect) applied at a magnitude, intensity, and/or value of 50%. As set forth below, computer system 600 is configured to adjust and/or change a magnitude and/or intensity of a respective audio effect based on input corresponding to audio editing user interface 1400.

At FIG. 14B, computer system 600 displays audio editing user interface 1400 (e.g., the same audio editing user interface as audio editing user interface 830 or a different audio editing user interface), which includes audio editing control 1402 (e.g., the same audio editing control as audio editing control 832 or a different audio editing control). At FIG. 14B, audio editing control 1402 is displayed at a position of media item region 806. In some embodiments, computer system 600 replaces display of media item region 806 with audio editing control 1402 in response to detecting user input 1450b. Audio editing user interface 1400 also includes editing controls 1403a-1403e corresponding to different editing options for adjusting visual characteristics and/or audio characteristics of the video media item. In some embodiments, in response to detecting user input corresponding to a respective editing control 1403a-1403e, computer system 600 ceases display of audio editing user interface 1400 and displays a user interface that includes editing controls corresponding to the respective editing control 1403a-1403e. In some embodiments, computer system 600 replaces display of audio editing user interface 1400 with a user interface that includes editing controls corresponding to the selected editing control 1403a-1403e in response to selection of a respective editing control 1403a-1403e. At FIG. 14B, editing control 1403b is selected, thereby indicating that audio editing user interface 1400 corresponds to controls for adjusting an audio mix of the video media item.

At FIG. 14B, audio editing control 1402 is a slider user interface object that enables computer system 600 to adjust, modify, and/or change how a respective audio effect is applied to the video media item. As set forth below with reference to FIG. 14L, computer system 600 is configured to concurrently adjust multiple audio parameters of the audio of the video media item based on use interaction with audio editing control 1402. For instance, in some embodiments, computer system 600 adjusts one or more of equalization (e.g., a volume of different frequency bands of the audio), dynamic range compression (e.g., reducing a volume of louder sounds of the audio and/or increasing a volume of quieter sounds of the audio), panning (e.g., distribution of sound in space), and/or audio levels (e.g., an intensity and/or magnitude of a foreground, background, and/or an original stream of the audio) based on user interaction with audio editing control 1402. In some embodiments, audio editing control 1402 enables computer system 600 to adjust a magnitude and/or amount at which the respective audio effect is applied to the audio of the video media item. As set forth below, increasing the magnitude and/or amount at which the audio effect is applied to the audio of the video media item causes the audio of the video media item to become more distinguished and/or more different from originally captured audio of the video media item (e.g., originally captured audio that does not include adjustments to one or more parameters of the audio of the video media item and/or includes adjustments to one or more parameters of the audio of the video media item by less than a threshold amount) and/or a standard audio effect. Decreasing the magnitude and/or amount at which the audio effect is applied to the audio of the video media item causes the audio of the video media item to more closely resemble the originally captured audio of the video media item and/or a standard audio effect.

At FIG. 14B, audio editing control 1402 includes position indicator 1402a, slider 1402b, and value indicator 1402c. At FIG. 14B, value indicator 1402c indicates that a current value and/or magnitude of the respective audio effect applied to the audio of the video media item is 50 (50%). In some embodiments, in response to detecting user input (e.g., a touch and drag gesture or a swipe gesture) corresponding to audio editing control 1402, computer system 600 moves slider 1402b while maintaining a position of position indicator 1402a relative to media item representation 822a and/or display 602. In some embodiments, in response to detecting user input (e.g., a touch gesture, a tap gesture, a touch and drag gesture, and/or a swipe gesture) corresponding to audio editing control 1402, computer system 600 moves position indicator 1402a relative to (e.g., along a length of) slider 1402b. In some embodiments, computer system 600 increases a magnitude and/or intensity of a respective audio effect in response to user input corresponding to audio editing control 1402 in a first direction (e.g., a left swipe or a touch gesture and a left drag gesture). In some embodiments, computer system 600 reduces and/or decreases a magnitude and/or intensity of the respective audio effect in response to user input corresponding to audio editing control 1402 in a second direction (e.g., a right swipe or a touch gesture and a right drag gesture).

At FIG. 14B, audio editing user interface 1400 includes audio effect options 1404a-1404d. At FIG. 14B, audio effect option 1404c is currently selected, as shown by indicator 1406. In some embodiments, computer system 600 displays audio editing user interface 1400 with a respective audio effect option 1404a-1404d selected that corresponds to an audio effect with which the video media item was captured. For instance, in some embodiments, computer system 600 displays audio editing user interface 1400 with audio effect option 1404c selected because the video media item corresponding to media item representation 822a was captured with an audio effect corresponding to audio effect option 1404c (e.g., audio mix style 3 and/or a studio audio effect). In some embodiments, computer system 600 displays audio editing user interface 1400 with a respective audio effect option 1404a-1404d selected that corresponds to a most recent and/or last used audio effect, such as an audio effect option 1404a-1404d corresponding to an audio effect that was last applied to the video media item and/or an audio effect that was last adjusted. In some embodiments, computer system 600 displays audio editing user interface 1400 with a default audio effect option 1404a-1404d selected, such as audio effect option 1404a.

In some embodiments, audio effect option 1404a corresponds to a standard audio effect. In some embodiments, a standard audio effect does not apply changes and/or adjustments to original audio of the video media item and/or originally captured audio of the video media item. For instance, in some embodiments, audio is captured via one or more microphones while the video media item is captured. In some embodiments, the originally captured audio does not include any filters and/or adjustments to one or more audio parameters of the originally captured audio of the video media item. In some embodiments, the standard audio effect does not include computer system 600 applying isolation (e.g., audio filtering and/or mixing that includes prioritizing and/or emphasizing sounds that include voices, vocals, and/or music and/or suppressing and/or de-emphasizing sounds that do not include voices, vocals, and/or music, such as background and/or ambient noises). In some embodiments, the standard audio effect does not include computer system 600 applying reverberation removal. In some embodiments, reverberation removal includes computer system 600 filtering and/or suppressing sounds that persist after they are generated (e.g., sounds that are reflected, bounced, and/or echoed in an environment in which they are generated). In some embodiments, computer system 600 adjusts one or more parameters of the originally captured audio of the video media item by less than a threshold amount when applying the standard audio effect.

In some embodiments, audio effect option 1404b corresponds to a voice isolation audio effect. In some embodiments, the voice isolation audio effect emphasizes a portion of the audio of the video media item that corresponds to voices and/or de-emphasizes a portion of the audio of the video media item that does not correspond to voices. For instance, in some embodiments, computer system 600 detects and/or identifies portions of the audio that include voices and increases a volume and/or clarity of the voice portions of the audio. In some embodiments, computer system 600 detects and/or identifies portions of the audio that do not include voices, such as background sounds, and reduces a volume and/or clarity of the respective portions of the audio. In some embodiments, the voice isolation audio effect includes computer system 600 applying isolation (e.g., audio filtering and/or mixing that includes prioritizing and/or emphasizing sounds that include voices, vocals, and/or music and/or suppressing and/or de-emphasizing sounds that do not include voices, vocals, and/or music, such as background and/or ambient noises). In some embodiments, computer system 600 applies isolation to sounds that include voices, vocals, and/or music when applying the voice isolation audio effect. In some embodiments, the voice isolation audio effect does not include reverberation removal. In some embodiments, reverberation removal includes computer system 600 filtering and/or suppressing sounds that persist after they are generated (e.g., sounds that are reflected, bounced, and/or echoed in an environment in which they are generated).

In some embodiments, audio effect option 1404c corresponds to a studio audio effect. In some embodiments, the studio audio effect emphasizes a portion of the audio of the video media item that corresponds to voices, de-emphasizes a portion of the audio of the video media item that does not correspond to voices, and/or removes and/or reduces reverberation (e.g., a persistence of sound after it is generated and/or produced) of the audio of the video media item. In some embodiments, the studio audio effect includes applying one or more effects to the portion of the audio of the video media item that includes voices. For instance, in some embodiments, computer system 600 applies distortion and/or changes to tones of the portion of the audio of the video media item that includes voices when applying the studio audio effect. In some embodiments, the studio audio effect includes computer system 600 applying isolation (e.g., audio filtering and/or mixing that includes prioritizing and/or emphasizing sounds that include voices, vocals, and/or music and/or suppressing and/or de-emphasizing sounds that do not include voices, vocals, and/or music, such as background and/or ambient noises). In some embodiments, computer system 600 applies isolation to sounds that include voices, vocals, and/or music when applying the studio audio effect. In some embodiments, the studio audio effect includes computer system 600 applying reverberation removal. In some embodiments, reverberation removal includes computer system 600 filtering and/or suppressing sounds that persist after they are generated (e.g., sounds that are reflected, bounced, and/or echoed in an environment in which they are generated).

In some embodiments, audio effect option 1404d corresponds to a camera audio effect. In some embodiments, the camera audio effect emphasizes sounds that are generated within a field of view of one or more cameras used to capture the video media item and/or de-emphasizes sounds that are not generated within a field of view of the one or more cameras used to capture the video media item. For instance, in some embodiments, computer system 600 determines a portion of the audio of the video media item that includes sounds generated within a field of view of one or more cameras used to capture the video media item. In some embodiments, computer system 600 determines the portion of the audio that includes sounds generated within the field of view of the one or more cameras based on visual information and/or images of the video media item (e.g., captured video and/or images of people talking, captured video and/or images of objects generating sound, and/or captured video and/or images of movements of people or objects generating sound). In some embodiments, computer system 600 determines the portion of the audio that includes sounds generated within the field of view of the one or more cameras based on a difference in volume of different tracks of the audio captured by different microphones (e.g., microphones that are physically spaced apart from one another and/or different microphones in an array of microphones). For instance, in some embodiments, computer system 600 compares first audio captured by a first microphone and second audio captured by a second microphone to determine whether the volume of a sound is greater in the first audio or the second audio. In some embodiments, computer system 600 determines and/or estimates a position of the person and/or object that generated the sound relative to a field of view of a camera that captured the video media item based on the comparison of the first audio and the second audio. In some embodiments, the camera audio effect includes computer system 600 applying isolation (e.g., audio filtering and/or mixing that includes prioritizing and/or emphasizing sounds that include voices, vocals, and/or music and/or suppressing and/or de-emphasizing sounds that do not include voices, vocals, and/or music, such as background and/or ambient noises). In some embodiments, computer system 600 applies isolation to sounds that include voices, vocals, and/or music and that are determined to be within the field of view of the camera that captured the video media item. In some embodiments, the camera audio effect does not include computer system 600 applying reverberation removal. In some embodiments, reverberation removal includes computer system 600 filtering and/or suppressing sounds that persist after they are generated (e.g., sounds that are reflected, bounced, and/or echoed in an environment in which they are generated).

The above description of the various audio effects is summarized below in Table 1.

TABLE 1
Summary of Audio Effect Embodiments

| | Isolation (Which | |
|---|---|---|
| | sounds are isolated | Treatment (Complete |
| Audio Mix Mode | for foreground?) | reverberation removal?) |
| Audio Mix Style 1 (e.g., | None | No |
| represented by 1404a) | | |
| Audio Mix Style 2 (e.g., | All voices, vocals, | No |
| represented by 1404b) | and music | |
| Audio Mix Style 3 (e.g., | All voices, vocals, | Yes |
| represented by 1404c) | and music | |
| Audio Mix Style 4(e.g., | Voices, vocals, and | No |
| represented by 1404d) | music within a field | |
| | of view of camera | |

At FIG. 14B, computer system 600 detects user input 1450c corresponding to audio editing control 1402 while outputting audio 1401a. Alternatively, computer system 600 detects user input 1450d corresponding to audio editing control 1402 while outputting audio 1401a. At FIG. 14B, user input 1450c and user input 1450d correspond to movement in different directions (e.g., opposite directions). In some embodiments, computer system 600 is configured to increase an intensity of the respective audio effect corresponding to audio effect option 1404c in response to detecting user input 1450c and configured to decrease the intensity of the respective audio effect corresponding to audio effect option 1404c in response to detecting user input 1450d. In response to detecting user input 1450c, computer system 600 initiates a process to adjust the studio audio effect, as shown at FIG. 14C.

At FIG. 14C, computer system 600 continues to detect user input 1450c. While detecting user input 1450c, computer system adjusts and/or moves slider 1402b relative to position indicator 1402a, such that a magnitude of the audio effect applied to the audio of the video media item is adjusted. At FIG. 14C, while computer system detects user input 1450c, computer system 600 removes display of and/or ceases to display audio mix effect options 1404a-1404d and/or editing controls 1403a-1403e to provide a user of computer system 600 with visual confirmation that user input 1450c was detected and/or received. In some embodiments, computer system 600 displays a fading animation of one or more of audio mix effect options 1404a-1404d and/or editing controls 1403a-1403e in response to detecting user input 1450c. In some embodiments, computer system 600 removes and/or ceases display of all visual elements of audio editing user interface 1400 except for media item representation 822a and audio editing control 1402 while detecting user input 1450c.

At FIG. 14C, computer system 600 outputs tactile feedback 1451a in response to detecting user input 1450c (or user input 1450d). Tactile feedback 1451a includes vibration and/or haptics generated by a tactile output component of computer system 600. Outputting tactile feedback 1451a provides further feedback to the user of computer system 600 that confirms that user input 1450c (or user input 1450d) was detected and/or received by computer system 600.

At FIG. 14C, computer system 600 outputs audio 1401b that is different from audio 1401a and that is based on user input 1450c. For instance, FIG. 14C includes the text “AUDIO MIX STYLE 3 AT 60%” to indicate that computer system 600 has adjusted and/or is adjusting the magnitude, value, and/or intensity of the respective audio effect. At FIG. 14C, computer system 600 is adjusting the magnitude of the respective audio effect from a value of 50% to a value of 60%, thereby increasing the intensity of the respective audio effect. In some embodiments, increasing the magnitude and/or intensity of the respective audio effect causes the audio of the video media item to be more distinguished and/or more different from originally captured audio of the video media item. Computer system 600 is configured to adjust output of the audio of the video media item while making adjustments to the audio effect that is applied to the audio so that the user can listen to the changes to the audio in real time, thereby providing improved feedback to the user.

At FIG. 14C, computer system 600 detects an end (e.g., a release of contact) of user input 1450c corresponding to audio editing control 1402. In response to detecting the end of user input 1450c, computer system 600 displays audio editing user interface 1400, as shown at FIG. 14D.

At FIG. 14D, computer system 600 displays (e.g., re-displays) audio mix effect options 1404a-1404d, editing controls 1403a-1403e, and/or other visual elements of audio editing user interface 1400 in response to detecting the end of user input 1450c. At FIG. 14D, computer system 600 displays audio editing user interface 1400, which includes audio editing control 1402 at an updated position. For instance, audio editing control 1402 includes value indicator 1402c indicating that the value of the audio effect applied to the audio of the video media item has been adjusted to a value of 60 (60%). At FIG. 14D, slider 1402b of audio editing control 1402 has also been adjusted and/or moved relative to position indicator 1402a to indicate that the magnitude, intensity, and/or value of the audio effect applied to the audio of the video media item has been adjusted in response to user input 1450c. As set forth above, in some embodiments, computer system 600 increases an intensity and/or magnitude of the audio effect in response to detecting user input 1450c because user input 1450c includes a movement component that is in a first direction (e.g., to the left relative to display 602).

At FIG. 14D, computer system 600 outputs audio 1401b, which is different from audio 1401a. FIG. 14D includes the text “AUDIO MIX STYLE 3 at 60%” to indicate that the value and/or magnitude of the respective audio effect (e.g., audio mix style 3) has been increased from 50% to 60% based on user input 1450c.

At FIG. 14D, computer system 600 detects user input 1450e (e.g., a tap gesture, a touch gesture, and/or an air gesture) corresponding to selection of audio effect option 1404b. In response to detecting user input 1450e, computer system 600 displays audio editing user interface 1400, as shown at FIG. 14E.

At FIG. 14E, computer system 600 displays audio editing user interface 1400 with audio effect option 1404b selected, as shown by indicator 1406. Audio editing user interface 1400 includes audio editing control 1408 for adjusting an audio mix effect (e.g., audio mix effect 2 and/or a voice isolation audio mix effect) corresponding to audio effect option 1404b. At FIG. 14E, computer system 600 outputs audio 1401c, which is different from audio 1401a and audio 1401b. For instance, the audio mix effect corresponding to audio effect option 1404b is different from the audio mix effect corresponding to audio effect option 1404c. Thus, computer system 600 adjusts and/or changes the audio of video media item by applying the audio mix effect corresponding to audio effect option 1404b (e.g., at a magnitude of 50 or 50%) instead of applying the audio mix effect corresponding to audio mix effect option 1404c.

At FIG. 14E, audio editing control 1408 is similar to audio editing control 1402 described above. For instance, audio editing control 1408 is a slider user interface object that enables computer system 600 to adjust, modify, and/or change how a respective audio effect is applied to the video media item. In some embodiments, adjustment of audio editing control 1408 in a first direction (e.g., a direction that causes a magnitude of the respective audio mix effect to increase) causes computer system 600 to output first audio and/or adjustment of audio editing control 1402 in the first direction causes computer system 600 to output second audio. In some embodiments, the first audio and the second audio become further away from one another (e.g., more different from one another and/or more distinguishable from one another) as audio editing control 1408 and/or audio editing control 1402 are adjusted in the first direction. In some embodiments, adjustment of audio editing control 1408 in a second direction (e.g., a direction that causes a magnitude of the respective audio mix effect to decrease) causes computer system 600 to output third audio and/or adjustment of audio editing control 1402 in the second direction causes computer system 600 to output fourth audio. In some embodiments, the third audio and the fourth audio become closer to one another (e.g., more similar to one another and/or sound more alike to one another) as audio editing control 1408 and/or audio editing control 1402 are adjusted in the second direction.

As set forth below with reference to FIG. 14L, computer system 600 is configured to concurrently adjust multiple audio parameters of the audio of the video media item in response to detecting user input corresponding to audio editing control 1408. For instance, in some embodiments, computer system 600 adjusts one or more of equalization (e.g., a volume of different frequency bands of the audio), dynamic range compression (e.g., reducing a volume of louder sounds of the audio and/or increasing a volume of quieter sounds of the audio), panning (e.g., distribution of sound in space), and/or audio levels (e.g., an intensity and/or magnitude of a foreground, background, and/or an original stream of the audio) based on user input corresponding to audio editing control 1408. In some embodiments, audio editing control 1408 enables computer system 600 to adjust a magnitude and/or amount at which the respective audio effect is applied to the audio of the video media item. As set forth below, increasing the magnitude and/or amount at which the audio effect is applied to the audio of the video media item causes the audio of the video media item to become more distinguished and/or more different from originally captured audio of the video media item (e.g., the originally captured audio that does not include adjustments to one or more parameters of the audio of the video media item and/or includes adjustments to one or more parameters of the audio of the video media item by less than a threshold amount) and/or a standard audio effect. Decreasing the magnitude and/or amount at which the audio effect is applied to the audio of the video media item causes the audio of the video media item to more closely resemble the originally captured audio of the video media item and/or a standard audio effect.

At FIG. 14E, audio editing control 1408 includes position indicator 1408a, slider 1408b, and value indicator 1408c. At FIG. 14E, value indicator 1402c indicates that a current value and/or magnitude of the respective audio effect applied to the audio of the video media item is 50 (50%). In some embodiments, in response to detecting user input (e.g., a touch and drag gesture or a swipe gesture) corresponding to audio editing control 1408, computer system 600 moves slider 14082b while maintaining a position of position indicator 1408a relative to media item representation 822a and/or display 602. In some embodiments, in response to detecting user input (e.g., a touch gesture, a tap gesture, a touch and drag gesture, and/or a swipe gesture) corresponding to audio editing control 1408, computer system 600 moves position indicator 1408a relative to slider 1408b. In some embodiments, computer system 600 increases a magnitude and/or intensity of a respective audio effect in response to user input corresponding to audio editing control 1408 that is in a first direction (e.g., a left swipe or a touch gesture and a left drag gesture). In some embodiments, computer system 600 reduces and/or decreases a magnitude and/or intensity of the respective audio effect in response to user input corresponding to audio editing control 1408 that is in a second direction (e.g., a right swipe or a touch gesture and a right drag gesture).

At FIG. 14E, computer system 600 detects user input 1450f corresponding to audio editing control 1408 while outputting audio 1401c. Alternatively, computer system 600 detects user input 1450g corresponding to audio editing control 1408 while outputting audio 1401c. At FIG. 14E, user input 1450f and user input 1450g correspond to movement in different directions (e.g., opposite directions). In some embodiments, computer system 600 is configured to increase an intensity of the respective audio effect in response to detecting user input 1450g and configured to decrease the intensity of the respective audio effect in response to detecting user input 1450f. In response to detecting user input 1450f, computer system 600 initiates a process to adjust the respective audio effect, as shown at FIG. 14F.

Alternatively, computer system 600 detects user input 1450h corresponding to audio effect option 1404a. In response to detecting user input 1450h, computer system 600 displays audio editing user interface 1400 as shown at FIG. 14G.

At FIG. 14F, computer system 600 continues to detect user input 1450f. While detecting user input 1450f, computer system adjusts and/or moves slider 1408b relative to position indicator 1408a, such that a magnitude of the audio effect applied to the audio of the video media item is adjusted. At FIG. 14F, while computer system 600 detects user input 1450f, computer system 600 removes display of and/or ceases to display audio mix effect options 1404a-1404d and/or editing controls 1403a-1403e to provide a user of computer system 600 with visual confirmation that user input 1450f was detected and/or received. In some embodiments, computer system 600 displays a fading animation of one or more of audio mix options 1404a-1404d and/or editing controls 1403a-1404e in response to detecting user input 1450f. In some embodiments, computer system 600 removes and/or ceases display of all visual elements of audio editing user interface 1400 except for media item representation 822a and audio editing control 1408 while detecting user input 1450f.

At FIG. 14F, computer system 600 outputs tactile feedback 1451b in response to detecting user input 1450f (or user input 1450g). Tactile feedback 1451b includes vibration and/or haptics generated by a tactile output component of computer system 600. Outputting tactile feedback 1451b provides further feedback to the user of computer system 600 confirming that user input 1450f (or user input 1450g) was detected and/or received by computer system 600.

At FIG. 14F, computer system 600 outputs audio 1401d that is different from audio 1401c and that is based on user input 1450f. For instance, FIG. 14F includes the text “AUDIO MIX STYLE 2 AT 40%” to indicate that computer system 600 has adjusted and/or is adjusting the magnitude, value, and/or intensity of the respective audio effect. At FIG. 14F, computer system 600 is adjusting the magnitude of the respective audio effect from a value of 50% to a value of 40%, thereby decreasing the intensity of the respective audio effect. In some embodiments, decreasing the magnitude of the respective audio effect causes the audio of the video media item to be more similar to originally captured audio of the video media item. Computer system 600 is configured to adjust output of the audio of the video media item while making adjustments to the audio effect that is applied to the audio so that the user can listen to the changes to the audio in real time.

In some embodiments, in response to detecting an end (e.g., a release of contact) of user input 1450f corresponding to audio editing control 1408, computer system 600 displays audio editing user interface 1400 with audio mix effect options 1404a-1404d, editing controls 1403a-1403e, and/or other visual elements of audio editing user interface 1400. In some embodiments, in response to detecting the end of user input 1450f, computer system 600 displays audio editing user interface 1400, which includes audio editing control 1408 at an updated position.

As set forth above, in response to detecting user input 1450h corresponding to audio effect option 1404a, computer system 600 displays audio editing user interface 1400, as shown at FIG. 14G. At FIG. 14G, computer system 600 outputs audio 1401e of the video media item corresponding to the audio effect corresponding to audio effect option 1404a. FIG. 14G includes the text “AUDIO MIX EFFECT 1” indicating that audio 1401e is based on the audio effect corresponding to audio effect option 1404a. Audio 1401e is different from audio 1401a, 1401b, 1401c, and/or 1401d. In some embodiments, audio effect option 1404a corresponds to a standard audio effect, which does not include adjustments and/or changes to originally captured audio of the video media item. In some embodiments, the standard audio effect corresponds to adjustments to one or more parameters of the originally captured audio of the video media item by less than a threshold amount.

At FIG. 14G, audio editing user interface 1400 includes audio effect options 1404a-1404d corresponding to the different audio mix effects that computer system 600 is configured to apply to the audio of video media item, but does not include an audio editing control (e.g., audio editing control 1402 and/or 1408). As set forth above, in some embodiments, audio effect option 1404a corresponds to a standard audio effect, which does not include adjustments and/or changes to the originally captured audio of the video media item. As such, computer system 600 forgoes display of the audio editing control to provide visual feedback to the user of computer system 600 that the standard audio effect cannot be adjusted to further change the audio of the video media item. In some embodiments, computer system 600 displays an audio editing control when audio effect option 1404a is selected and/or when the audio mix effect corresponding to audio effect option 1404a is configured to be adjusted and/or is adjustable. In some embodiments, computer system 600 displays an audio editing control that includes a respective appearance (e.g., a greyed out appearance, a reduced brightness, and/or a reduced size) when audio effect option 1404a is selected and/or when the audio mix effect corresponding to the audio effect option 1404a is not configured to be adjusted and/or is not adjustable.

At FIG. 14G, computer system 600 detects user input 1450i corresponding to audio effect option 1404c. In response to detecting user input 1450i, computer system 600 outputs audio 1401b and displays audio editing user interface 1400, as shown at FIG. 14H.

At FIG. 14H, audio 1401b includes the same audio that was output by computer system 600 in response to detecting user input 1450c. As set forth above with respect to FIGS. 14B-14D, computer system 600 adjusts the magnitude and/or intensity of the respective audio effect corresponding to audio effect option 1404c from 50% to 60% based on user input 1450c. In response to detecting user input 1450i, computer system 600 displays audio editing user interface 1400 with audio editing control 1402 having the same position and/or indicating the same value and/or magnitude of the respective audio effect as shown at FIG. 14D. Thus, even though computer system 600 detected one or more of user inputs 1450e-1450h, computer system 600 maintains the same value and/or magnitude of the respective audio mix effect corresponding to audio effect option 1404c upon receiving user input corresponding to audio effect option 1404c. In other words, computer system 600 maintains a most recent and/or last value of audio editing control 1402 upon receiving a request to navigate away from displaying audio editing control 1402 and receiving a request to display (e.g., re-display) audio editing control 1402. In some embodiments, while displaying audio editing user interface 1400, as shown at FIG. 14H, computer system 600 detects user input corresponding to audio effect option 1404b, and in response to detecting the user input, computer system 600 displays audio editing control 1408 with the same position and/or indicating the same magnitude and/or value as shown at FIG. 14F (e.g., 40%). Therefore, computer system 600 saves, stores, and/or maintains a most recent value and/or magnitude of a respective audio effect so that the user of computer system 600 does not have to provide additional inputs when switching and/or transitioning between audio mix effects (e.g., by selecting respective audio effect options 1404a-1404d).

At FIG. 14H, computer system 600 plays the video media item corresponding to media item representation 822a at a playback time of 00:01 seconds. At FIG. 14G, computer system 600 plays the video media item corresponding to media item representation 822a at a playback time of 00:15 seconds. As indicated by scrubber control 822d, the video media item corresponding to media item representation 822a includes a total duration of approximately 16 seconds. Therefore, at FIG. 14G, playback of the video media item is reaching an end. In some embodiments, when the playback of the video media item reaches an end, computer system 600 loops playback of the video media item and/or re-starts playback of the video media item from a beginning of the video media item (e.g., at 00:00). Therefore, computer system 600 continues to play back the video media item while displaying audio editing user interface 1400 so that the user of computer system 600 does not have to provide additional user input to listen to changes to the audio of the video media item as the audio is adjusted. In some embodiments, computer system 600 continues to loop and/or re-start playback of the video media item while displaying audio editing user interface 1400 until computer system 600 detects user input requesting to pause and/or stop playback of the video media item.

Computer system 600 is configured to output audio of the video media item with a respective audio mix effect applied while scrubbing (e.g., adjusting and/or changing a playback time of video media item). For instance, at FIG. 14H, computer system 600 detects user input 1450j (e.g., a touch and drag gesture and/or a swipe gesture) corresponding to scrubber control 822d. At FIG. 14H, computer system 600 is playing video media item from a first playback time (e.g., 00:01). In response to detecting user input 1450j, computer system 600 initiates a process to adjust a playback position of the video media item from the first playback time to an updated playback time, as shown at FIG. 14I.

At FIG. 14I, computer system 600 continues to detect user input 1450j and displays audio editing user interface 1400 without displaying audio editing control 1402, editing controls 1403a-1403e, and/or audio effect options 1404a-1404d. For instance, at FIG. 14I, computer system 600 ceases to display audio editing control 1402, editing controls 1403a-1403e, and audio effect options 1404a-1404d of audio editing user interface 1400. In some embodiments, in response to detecting user input 1450j, computer system 600 displays audio editing user interface 1400 without the visual elements of audio editing user interface 1400 (e.g., the visual elements shown at FIG. 14H) except for media item representation 822a and scrubber control 822d. Accordingly, computer system 600 provides visual feedback and/or confirmation that user input 1450j was detected and/or received.

At FIG. 14I, computer system 600 adjusts the playback position of the video media item based on (e.g., based on a magnitude and/or direction of) user input 1450j. For instance, at FIG. 14I, the playback position of the video media item has been adjusted from the first playback position to a second playback position (e.g., 00:05), which is different from the first playback position. In addition, computer system 600 outputs audio 1401b as represented by the text “AUDIO MIX EFFECT 2 60%.” Audio 1401b corresponds to the audio of the video media item corresponding to the current playback time of the video media item (e.g., 00:05). Thus, computer system 600 continues to output the audio of the video media item while adjusting the playback position of the video media item. In addition, computer system 600 maintains application of the respective audio mix effect while adjusting the playback position of the video media item.

At FIG. 14I, computer system 600 detects an end of user input 1450j. In response to detecting the end of user input 1450j, computer system 600 displays audio editing user interface 1400, as shown at FIG. 14J.

At FIG. 14J, computer system 600 plays the video media item at the second playback position (e.g., 00:05) in response to detecting the end of user input 1450j. Computer system 600 continues to output audio 1401b based on the audio mix effect corresponding to audio effect option 1404c. Thus, the user of computer system 600 is able to listen to and/or perceive the audio of the video media item with the respective audio mix effect applied to the audio at different playback times and/or portions of the video media item. In addition, at FIG. 14J, computer system 600 displays audio editing user interface 1400 with audio editing control 1402, editing options 1403a-1403e, and audio effect options 1404a-1404d. As such, computer system 600 displays (e.g., re-displays) audio editing control 1402, editing options 1403a-1403e, and audio effect options 1404a-1404d in audio editing user interface 1400 to provide visual feedback and/or confirmation that the end of user input 1450j was detected.

At FIG. 14J, an orientation of computer system 600 is adjusted, as indicated by arrow 1410. In response to detecting the change in orientation of computer system 600, computer system 600 displays audio editing user interface 1400, as shown at FIG. 14K.

At FIG. 14K, audio editing user interface 1400 includes a different layout and/or respective positions of various elements based on the change in orientation of computer system 600. For instance, at FIG. 14K, audio effect options 1404a-1404d are displayed to the left of media item representation 822a as compared to being displayed beneath media item representation 822a, as shown at FIG. 14B. In addition, audio editing control 1402 and editing controls 1403a-1403e are displayed to the right of media item representation 822a as compared to being displayed beneath and/or below media item representation 822a, as shown at FIG. 14B. At FIG. 14B, audio editing control 1402 is displayed as being parallel (e.g., extending in a direction that is parallel to a direction in which scrubber control 822d extends) to scrubber control 822d. At FIG. 14K, audio editing control 1402 is displayed as being perpendicular (e.g., extending in a direction that is perpendicular to a direction in which scrubber control 822d extends) to scrubber control 822d. Accordingly, computer system 600 rearranges and/or displays the various elements of audio editing user interface 1400 at different positions relative to media item representation 822a and/or display 602 based on the orientation of computer system 600. In some embodiments, computer system 600 arranges and/or displays the various elements of audio editing user interface 1400 to maximize a size of media item representation 822a, to maximize an area of display 602, and/or to facilitate interaction with the controls of audio editing user interface 1400.

As set forth above, computer system 600 is configured to concurrently adjust multiple parameters of the audio of the video media item in response to an adjustment to a respective audio mix effect. FIG. 14L is a diagram depicting how interaction with audio editing control 1402 and/or audio editing control 1408 changes one or more audio parameters of the audio of the video media item.

At FIG. 14L, audio editing control 1402 (and/or audio editing control 1408) is illustrated with audio mixing board representation 1412. Audio mixing board representation 1412 includes representations of various controls for foreground 1414, background 1416, and original 1418 tracks of audio. Foreground 1414 track includes treatment control representation 1414a, panning control representation 1414b, and level control representation 1414c. Background 1416 track includes treatment control representation 1416a, panning control representation 1416b, and level control representation 1416c. Original 1418 track includes treatment control representation 1418a, panning control representation 1418b, and level control representation 1418c.

At FIG. 14L, the adjustments to various audio parameters based on the adjustment of audio editing control 1402 are illustrated by adjustment indicators 1420a-1420c. For instance, at FIG. 14L, user interaction with audio editing control 1402 causes a first adjustment to both treatment control of foreground 1414 and treatment control of background 1416, as shown by adjustment indicator 1420a. In some embodiments, adjustments to treatment control of foreground and/or background cause adjustment to an amount of equalization (e.g., a volume of different frequency bands of the audio) and/or dynamic range compression (e.g., reducing a volume of louder sounds of the audio and/or increasing a volume of quieter sounds of the audio) applied to the audio of the video media item.

At FIG. 14L, user interaction with audio editing control 1402 causes a second adjustment to panning control of foreground 1414. In some embodiments, adjustments to the panning control cause adjustments to a position of one or more portions of the audio of the video media item in space. For instance, in some embodiments, computer system 600 adjusts the output of one or more portions of the audio of the video media item, such that the one or more portions of the audio are perceived from a particular location relative to a speaker outputting the audio. At FIG. 14L, user interaction with audio editing control 1402 causes a third adjustment to level control of background 1416. In some embodiments, adjustments to the level control adjust an intensity and/or magnitude of background 1416 track of the audio. Accordingly, adjustment to audio editing control 1402 causes concurrent adjustment to multiple audio parameters of the audio of the video media item.

In some embodiments, computer system 600 is configured to adjust one or more audio parameters of a portion of audio corresponding to music (e.g., background music, music added to a video media item, music generated via one or more instruments included in a media item, and/or music generated by a person singing in a media item). In some embodiments, computer system 600 applies automatic equalization to portions of audio corresponding to music, voices, and/or vocals. In some embodiments, computer system applies de-esser (e.g., audio compression that reduces sibilance and/or high frequencies) to portions of audio corresponding to music, voice, and/or vocals. In some embodiments, computer system 600 adjusts a level of music included in the audio of the media item. Table 2 below provides an example of how adjustment of audio editing control 1402 causes adjustment to the one or more audio parameters of the audio of the video media item.

TABLE 2
Adjustments to Audio Parameters based on Adjustment to Audio Editing Control

| | | Treatment | | | | | | | |
|---|---|---|---|---|---|---|---|---|---|
| | | DRC is | | | | | | | |
| | | applied | Automatic | | | | | | |
| Audio | | individually | EQ is | Automatic | Automatic | | | | |
| Effect | Panning | to foreground | applied to | EQ is | EQ is | | Automatic | Level | |
| Slider | Voices | sound and | isolated | applied to | applied to | | EQ is | Background | |
| Position | are re- | background | foreground | isolated | isolated | De-esser | applied to | sounds are | Music |
| (e.g., 1402 | panned | sound, and | sound (e.g. | background | voices/ | is applied | isolated | reduced in | adjusted |
| or 1408) | to center | music | voice) | sounds | vocals | to voices | music | level? | in level |
| 0% | No | No | No | No | No | No | No | No | No |
| 25% | Yes | Yes | Yes, with | Yes, with | Yes, with | Yes, with | Yes, with | No | No |
| | | | low intensity | low intensity | low intensity | low intensity | low intensity | | |
| | | | (e.g., less | (e.g., less | (e.g., less | (e.g., less | (e.g., less | | |
| | | | than 1, 2, 5, | than 1, 2, 5, | than 1, 2, 5, | than 1, 2, 5, | than 1, 2, 5, | | |
| | | | 10, 15, or | 10, 15, or | 10, 15, or | 10, 15, or | 10, 15, or | | |
| | | | 25 percent) | 25 percent) | 25 percent) | 25 percent) | 25 percent) | | |
| 50% | Yes | Yes | Yes | Yes | Yes | Yes | Yes | Yes, auto | Yes, auto |
| | | | | | | | | determined | determined |
| | | | | | | | | amount | amount |
| 75% | Yes | Yes | Yes | Yes | Yes | Yes | Yes | Yes, more | Yes, auto |
| | | | | | | | | than auto | determined |
| | | | | | | | | determined | amount |
| | | | | | | | | amount | |
| 100% | Yes | Yes | Yes | Yes | Yes | Yes | Yes | Yes, | Yes, auto |
| | | | | | | | | completely | determined |
| | | | | | | | | | amount |

FIG. 15 is a flow diagram illustrating a method for managing slow motion controls using a computer system in accordance with some embodiments. Method 1500 is performed at a computer system (e.g., 100, 300, 500, and/or 600) (e.g., a smart phone, a smart watch, a tablet computer, a laptop computer, a desktop computer, a wearable device, and/or head-mounted device) that is in communication with (e.g., includes and/or is connected to) one or more display generation components (e.g., 602) (e.g., one or more displays, touch-screen displays, monitors, holographic display systems, and/or head-mounted display systems) and one or more input devices (e.g., 600a and/or 602) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 1500 are, optionally, combined, the orders of some operations are, optionally, changed, and some operations are, optionally, omitted.

As described below, method 1500 provides an intuitive way for managing slow motion controls. The method reduces the cognitive burden on a user for managing slow motion controls, thereby creating a more efficient human-machine interface. For battery-operated computing devices, enabling a user to manage photographic styles faster and more efficiently conserves power and increases the time between battery charges.

While displaying, via the one or more display generation components (e.g., 602), a representation of a video media item (e.g., a video, a recording of images, a sequence of images that changes over time, a still image of a video, and/or a frame of a video), computer system (e.g., 100, 300, 500, and/or 600) detects (1502), via the one or more input devices (e.g., 600a and/or 602), one or more inputs (e.g., 850u) (e.g., one or more tap gestures, swipe gestures, touch gestures, air gestures, button presses, and/or voice commands) corresponding to a request to edit (e.g., directed toward or directed to one or more selectable user interface objects for editing) the video media item (e.g., 822a) (e.g., a request to modify, change, edit, and/or adjust a playback speed of one or more portions of the video media item, audio output of the video media item, and/or visual aspects of the video media item).

In response to detecting the one or more inputs (e.g., 850u) corresponding to the request to edit the video media item (e.g., 822a), computer system (e.g., 100, 300, 500, and/or 600) displays (1504), via the one or more display generation components (e.g., 602), a media editing user interface (e.g., 822 and/or 834) (e.g., a user interface that includes display of one or more media items, one or more control user interface objects for editing, adjusting, modifying, and/or changing one or more visual aspects of a respective media item, one or more user interface objects for adding, removing, repositioning, sharing, bookmarking, deleting, and/or providing a designation to the one or more media items, and/or one or more control user interface objects for editing, adjusting, modifying, and/or changing a playback speed of a respective media item and/or audio parameters of the respective media item).

Displaying the media editing user interface (e.g., 822 and/or 834) includes, in accordance with a determination that the video media item (e.g., 822a) is configured to play with a playback speed (e.g., a speed at which the computer system plays back the video media item relative to a speed at which the video media item was captured and/or a real-time speed) that is (e.g., has been reduced to be and/or was captured) below a threshold playback speed (e.g., a speed at which the video media item was captured and/or a real-time speed), computer system (e.g., 100, 300, 500, and/or 600) displaying (1506), via the one or more display generation components (e.g., 602), one or more slow motion editing control user interface objects (e.g., 836, 836a, and/or 836b) in the media editing user interface (e.g., 822 and/or 834), wherein the one or more slow motion editing control user interface objects (e.g., 836, 836a, and/or 836b) enable one or more slow motion playback parameters of the video media item (e.g., 822a) to be adjusted (e.g., one or more user interface objects that that enable adjustment of a playback speed of the video media item, select and/or display one or more frames of a video of the video media item, select and/or initiate playback of the video media item at a particular playback time, select and/or cease playback of the video media item at a particular time, and/or apply different playback speeds to different portions of the video media item such as specifying a starting time for a slowed down portion of the video media item, specifying a duration of the slowed down portion of the video media item, and/or specifying an ending time for the slowed down portion of the video media item).

Displaying the media editing user interface (e.g., 822 and/or 834) includes, in accordance with a determination that the video media item (e.g., 822a) is configured to play with a playback speed that is (e.g., has not been reduced to be and/or was not captured) not below (e.g., equal to or above) the threshold playback speed, computer system (e.g., 100, 300, 500, and/or 600) forgoing (1508) display of the one or more slow motion editing control user interface objects (e.g., 836, 836a, and/or 836b) in the media editing user interface (e.g., 822 and/or 834) (e.g., the computer system does not display the one or more slow motion controls when the playback speed of the video media item was not captured at a playback speed and/or has not been reduced below the threshold playback speed and/or when the playback speed of the video media item is above the threshold playback speed).

Displaying the one or more slow motion editing control user interface objects when the video media item is configured to play with a playback speed below a threshold playback speed and not displaying the one or more slow motion editing control user interface objects when the video media item is configured to play with a playback speed that is not below the threshold playback speed allows a user to determine whether the video media item is configured to play with a playback speed that is below the threshold playback speed, provides the user with controls that are relevant to the respective video media item, and reduces the number of inputs required to access the one or more slow motion editing control user interface objects by displaying the one or more slow motion editing controls on the media editing user interface, thereby providing improved visual feedback to the user, performing an operation when a set of conditions has been met without requiring further user input, and reducing the number of inputs needed to perform an operation.

In some embodiments, while displaying the one or more slow motion editing control user interface objects (e.g., 836, 836a, and/or 836b), computer system (e.g., 100, 300, 500, and/or 600) detects, via the one or more input devices (e.g., 600a and/or 602), user input (e.g., 850v) (e.g., a touch and drag input corresponding to a slider, a pinch and/or a de-pinch input corresponding to a slider, a click of a mouse and/or trackpad followed by movement of the mouse and/or touch on the trackpad while a cursor is displayed over a slider, a tap gesture, a swipe gesture, a touch gesture, an air gesture, a button press, and/or a voice command) corresponding to (e.g., corresponding to selection of) a first slow motion editing control user interface object (e.g., 836, 836a, and/or 836b) (e.g., a user interface object that is configured to adjust a respective portion of the video media item that plays back at the playback speed that is below the threshold speed, such as a slider user interface object that is configured to set a duration, a starting point, and/or an end point of the respective portion of the video media item that plays back at the playback speed that is below the threshold speed) of the one or more slow motion editing control user interface objects (e.g., 836, 836a, and/or 836b); and in response to detecting the user input (e.g., 850v) corresponding to the first slow motion editing control user interface object (e.g., 836, 836a, and/or 836b) of the one or more slow motion editing control user interface objects (e.g., 836, 836a, and/or 836b), computer system (e.g., 100, 300, 500, and/or 600) adjusts (e.g., setting and/or applying) a respective portion (e.g., an entire portion of the video media item and/or a portion of the video media item that is less than the entire portion of the video media item) of the video media item (e.g., 822a) that is configured to play with the playback speed that is below the threshold playback speed (e.g., adjusting, modifying, and/or changing a respective portion of the video media item that plays back with the playback speed that is below the threshold playback speed, such as adjusting, modifying, and/or changing a duration, a starting point, and/or an ending point of the video media item that plays back with the playback speed that is below the threshold playback speed). In some embodiments, a second portion of the video media item (e.g., 822a) that is different from the respective portion of the video media item (e.g., 822a) is configured to play with a playback speed that is faster than a playback speed of the respective portion of the video media item (e.g., 822a) (e.g., the second portion of the video media item is configured to play with a playback speed that is above the threshold playback speed). Adjusting the respective portion of the video media item that is configured to play with the playback speed that is below the threshold playback speed in response to detecting the user input corresponding to the first slow motion editing control user interface object allows a user to apply different playback speeds to different portions of the video media item without requiring the user to navigate to another user interface, thereby reducing the number of inputs needed to perform an operation.

In some embodiments, while displaying a playback speed user interface object (e.g., 822c, 826a-826e, 834c, and/or 838a-838e) (e.g., a button, an affordance, a graphical user interface element, and/or a user selectable icon that is displayed as part of the media editing user interface and/or that, when selected via user input, causes the computer system to adjust a playback speed of one or more portions of the video media item), computer system (e.g., 100, 300, 500, and/or 600) detects, via the one or more input devices (e.g., 600a and/or 602), one or more user inputs (e.g., 850n, 850p, 850w, and/or 850x) (e.g., a tap gesture corresponding to the playback speed user interface object, a touch input corresponding to the playback speed user interface object, a click of a mouse and/or trackpad while a cursor is displayed over the playback speed user interface object, one or more tap gestures, swipe gestures, touch gestures, air gestures, button presses, and/or voice commands) corresponding to (e.g., directed to and/or corresponding to selection of) the playback speed user interface object (e.g., 822c, 826a-826e, 834c, and/or 838a-838e); and in response to detecting the one or more user inputs (e.g., 850n, 850p, 850w, and/or 850x) corresponding to the playback speed user interface object (e.g., 822c, 826a-826e, 834c, and/or 838a-838e), computer system (e.g., 100, 300, 500, and/or 600) adjusts (e.g., changing and/or modifying) a playback speed (e.g., a speed at which the computer system plays back the video media item relative to a speed at which the video media item was captured and/or a real-time speed) of at least a portion of the video media item (e.g., 822a) (e.g., an entire portion of the video media item and/or a portion of the video media item that is less than the entire portion of the video media item) from a first playback speed to a second playback speed that is different from the first playback speed. In some embodiments, the playback speed user interface object (e.g., 822c, 826a-826e, 834c, and/or 838a-838e) is displayed on the media editing user interface (e.g., 822 and/or 834). In some embodiments, the computer system (e.g., 100, 300, 500, and/or 600) displays the playback speed user interface object (e.g., 822c, 826a-826e, 834c, and/or 838a-838e) in response to user input (e.g., 850n, 850p, 850w, and/or 850x) selecting a speed adjustment affordance (e.g., 822c, 826a-826e, 834c, and/or 838a-838e). In some embodiments, the playback speed user interface object (e.g., 822c, 826a-826e, 834c, and/or 838a-838e) includes one or more selectable options (e.g., 826a-826e and/or 838a-838e) corresponding to different playback speeds at which the video media item (e.g., 822a) is configured to play. In some embodiments, the computer system (e.g., 100, 300, 500, and/or 600) is configured to cause at least the portion of the video media item (e.g., 822a) to be played with the second playback speed while detecting the one or user inputs (e.g., 850n, 850p, 850w, and/or 850x), while displaying the playback speed user interface object (e.g., 822c, 826a-826e, 834c, and/or 838a-838e), and/or when playing at least the portion of the video media item (e.g., 822a) after detecting the one or more user inputs (e.g., 850n, 850p, 850w, and/or 850x). In some embodiments, the computer system (e.g., 100, 300, 500, and/or 600) adjusts the playback speed of at least the portion of the video media item (e.g., 822a) so that at least the portion of the video media item (e.g., 822a) plays back with the second playback speed in response to a request to cause the computer system (e.g., 100, 300, 500, and/or 600) to play at least the portion of the video media item (e.g., 822a) (e.g., the request to cause the computer system to play at least the portion of the video media item is detected prior to and/or while detecting the one or more user inputs corresponding to the playback speed user interface object or at a time that is after computer system detects the one or more user inputs corresponding to the playback speed user interface object). Adjusting a playback speed of the video media item in response to detecting the one or more user inputs corresponding to the playback speed user interface object allows a user to change the playback speed of the video media item without requiring the user to navigate to another user interface, thereby reducing the number of inputs needed to perform an operation.

In some embodiments, while displaying a speed adjustment user interface object (e.g., 822c, 826a-826e, 834c, and/or 838a-838e) (e.g., a button, an affordance, a graphical user interface element, and/or a user selectable icon that is displayed as part of the media editing user interface and/or that, when selected via user input, causes the computer system to display the playback speed user interface object), computer system (e.g., 100, 300, 500, and/or 600) detects (e.g., while not displaying the playback speed user interface object), via the one or more input devices (e.g., 600a and/or 602), user input (e.g., 850n, 850p, 850w, and/or 850x) (e.g., a tap gesture corresponding to the speed adjustment user interface object, a touch input corresponding to the speed adjustment user interface object, a click of a mouse and/or trackpad while a cursor is displayed over the speed adjustment user interface object, a tap gesture, a swipe gesture, a touch gesture, an air gesture, a button press, and/or a voice command) corresponding to selection of the speed adjustment user interface object (e.g., 822c, 826a-826e, 834c, and/or 838a-838e); and in response to detecting the user input (e.g., 850n, 850p, 850w, and/or 850x) corresponding to selection of the speed adjustment user interface object (e.g., 822c, 826a-826e, 834c, and/or 838a-838e) (and, optionally, in accordance with a determination that a set of one or more frame rate criteria are satisfied), computer system (e.g., 100, 300, 500, and/or 600) displays, via the one or more display generation components (e.g., 602), the playback speed user interface object (e.g., 822c, 826a-826e, 834c, and/or 838a-838e) (e.g., the computer system displays the playback speed user interface object that is configured to adjust the playback speed of the video media item in response to detecting selection of the speed adjustment user interface object). In some embodiments, in response to detecting the user input (e.g., 850n, 850p, 850w, and/or 850x) corresponding to selection of the speed adjustment user interface object (e.g., 822c, 826a-826e, 834c, and/or 838a-838e) and in accordance with a determination that the set of one or more frame rate criteria are not satisfied, forgoing display of the playback speed user interface object (e.g., 822c, 826a-826e, 834c, and/or 838a-838e). In some embodiments, the set of one or more frame rate criteria includes a frame rate criterion that is based on a frame rate of the video being edited (e.g., satisfied if the frame rate of the video is above a frame rate threshold or, alternatively, satisfied if below a frame rate threshold). Displaying the playback speed user interface object in response to detecting the user input corresponding to selection of the speed adjustment user interface object enables the computer system to provide access to additional controls on the media editing user interface without cluttering the media editing user interface, thereby providing additional control options without cluttering the user interface with additional displayed controls.

In some embodiments, in response to detecting one or more inputs (e.g., 850u) (e.g., one or more tap gestures, swipe gestures, touch gestures, air gestures, button presses, and/or voice commands) corresponding to a request to edit (e.g., directed toward or directed to one or more selectable user interface objects for editing) a second video media item (e.g., 822a, 840a, and/or 844a) (e.g., a request to modify, change, edit, and/or adjust a playback speed of one or more portions of the second video media item, audio output of the second video media item, and/or visual aspects of the second video media item), computer system (e.g., 100, 300, 500, and/or 600) displays, via the one or more display generation components (e.g., 602), a second media editing user interface (e.g., 822 and/or 834) (e.g., a user interface that includes display of one or more media items, one or more control user interface objects for editing, adjusting, modifying, and/or changing one or more visual aspects of a respective media item, one or more user interface objects for adding, removing, repositioning, sharing, bookmarking, deleting, and/or providing a designation to the one or more media items, and/or one or more control user interface objects for editing, adjusting, modifying, and/or changing a playback speed of a respective media item and/or audio parameters of the respective media item), wherein displaying the second media editing user interface (e.g., 822 and/or 834) includes: in accordance with a determination that a frame rate (e.g., a number of frames, such as images, captured and/or displayed per unit of time, such as per second) of the second video media item (e.g., 822a, 840a, and/or 844a) is above a frame rate threshold (e.g., above 24 frames per second, above, 30 frames per second, above 60 frames per second, above 100 frames per second, above 120 frames per second, or above 200 frames per second), computer system (e.g., 100, 300, 500, and/or 600) displaying, via the one or more display generation components (e.g., 602), a second speed adjustment user interface object (e.g., 822c, 826a-826e, 834c, and/or 838a-838e) (e.g., a button, an affordance, a graphical user interface element, and/or a user selectable icon that is displayed as part of the second media editing user interface and/or that, when selected via user input, causes the computer system to display the playback speed user interface object); and in accordance with a determination that the frame rate of the second video media item (e.g., 822a, 840a, and/or 844a) is not above the frame rate threshold (e.g., the frame rate of the second video media item is equal to or below 24 frames per second, 30 frames per second, 60 frames per second, 100 frames per second, 120 frames per second, or 200 frames per second), computer system (e.g., 100, 300, 500, and/or 600) forgoing display of the second speed adjustment user interface object (e.g., 822c, 826a-826e, 834c, and/or 838a-838e) (e.g., not displaying the second speed adjustment user interface object on the second media editing user interface). In some embodiments, the second media item (e.g., 822a, 840a, and/or 844a) is different from the video media item (e.g., 822a). In some embodiments, the computer system (e.g., 100, 300, 500, and/or 600) displays the second speed adjustment user interface object (e.g., 822c, 826a-826e, 834c, and/or 838a-838e) and the speed adjustment user interface object (e.g., 822c, 826a-826e, 834c, and/or 838a-838e) concurrently (e.g., at the same time or separately). In some embodiments, in response to detecting a request to change a playback speed of the video media item (e.g., 822a): in accordance with a determination that the request includes a first input corresponding to the speed adjustment user interface object (e.g., 822c, 826a-826e, 834c, and/or 838a-838e) (and, optionally, the request does not include input corresponding to the second speed adjustment user interface object), adjusting the playback speed of the video media item (e.g., 822a) to a first playback speed; and in accordance with a determination that the request includes a second input corresponding to the second speed adjustment user interface object (e.g., 822c, 826a-826e, 834c, and/or 838a-838e) (and, optionally, the request does not include input corresponding to the speed adjustment user interface object), adjusting the playback speed of the video media item (e.g., 822a) to a second playback speed that is different from the first playback speed. In some embodiments, forgoing display of the second speed adjustment user interface object (e.g., 822c, 826a-826e, 834c, and/or 838a-838e) includes displaying the speed adjustment user interface object (e.g., 822c, 826a-826e, 834c, and/or 838a-838e) without displaying the second speed adjustment user interface object (e.g., 822c, 826a-826e, 834c, and/or 838a-838e). Displaying the playback speed user interface object when the frame rate of the second video media item is above the frame rate threshold and not displaying the playback speed user interface object when the frame rate of the second video media item is not above the frame rate threshold allows the computer system to display controls that are relevant to the second video media item and allows a user to determine whether a control is available for the second video media item, thereby providing improved visual feedback to the user.

In some embodiments, while displaying the one or more slow motion editing control user interface objects (e.g., 836, 836a, and/or 836b), computer system (e.g., 100, 300, 500, and/or 600) detects, via the one or more input devices (e.g., 600a and/or 602), one or more user inputs (e.g., 850v) (e.g., a touch and drag input corresponding to a slider, a pinch and/or a de-pinch input corresponding to a slider, a click of a mouse and/or trackpad followed by movement of the mouse and/or touch on the trackpad while a cursor is displayed over a slider, one or more tap gestures, swipe gestures, touch gestures, air gestures, button presses, and/or voice commands) corresponding to a request to adjust (e.g., directed toward or directed to one or more selectable user interface objects for adjusting) a playback speed of the video media item (e.g., 822a) (e.g., adjusting, modifying, and/or changing a speed at which the computer system plays back the video media item relative to a speed at which the video media item was captured and/or a real-time speed); and in response to detecting the one or more user inputs (e.g., 850v) corresponding to the request to adjust the playback speed of the video media item (e.g., 822a) (and, optionally, in accordance with a determination that the request to adjust the playback speed of the video media item is a request to adjust the playback speed of the video media item to a playback speed that is above the threshold playback speed), computer system (e.g., 100, 300, 500, and/or 600) ceases display of the one or more slow motion editing control user interface objects (e.g., 836, 836a, and/or 836b) (e.g., removing display of and/or not displaying the one or more slow motion editing control user interface objects). Ceasing display of the one or more slow motion editing control user interface objects in response to detecting the one or more user inputs corresponding to the request to adjust the playback speed of the video media item allows the computer system to display controls that are relevant to the video media item and allows a user to determine whether a control is available for the video media item, thereby providing improved visual feedback to the user.

In some embodiments, while displaying the media editing user interface (e.g., 822 and/or 834) without displaying the one or more slow motion editing control user interface objects (e.g., 836, 836a, and/or 836b) (e.g., the computer system displays the media editing user interface without the one or more slow motion editing control user interface objects based on a determination that the video media item is configured to play with a playback speed that is not below the threshold playback speed), computer system (e.g., 100, 300, 500, and/or 600) detects, via the one or more input devices (e.g., 600a and/or 602), one or more user inputs (e.g., 850n, 850p, 850w, and/or 850x) (e.g., a touch and drag input corresponding to a slider, a pinch and/or a de-pinch input corresponding to a slider, a click of a mouse and/or trackpad followed by movement of the mouse and/or touch on the trackpad while a cursor is displayed over a slider, one or more tap gestures, swipe gestures, touch gestures, air gestures, button presses, and/or voice commands) corresponding to a request to adjust (e.g., directed toward or directed to one or more selectable user interface objects for adjusting) a playback speed of the video media item (e.g., 822a) (e.g., adjusting, modifying, and/or changing a speed at which the computer system plays back the video media item relative to a speed at which the video media item was captured and/or a real-time speed); and in response to detecting the one or more user inputs (e.g., 850n, 850p, 850w, and/or 850x) corresponding to the request to adjust the playback speed of the video media item (e.g., 822a) (and, optionally, in accordance with a determination that the request to adjust the playback speed of the video media item is a request to adjust the playback speed of the video media item to a playback speed that is below the threshold playback speed), computer system (e.g., 100, 300, 500, and/or 600) displays, via the one or more display generation components (e.g., 602), the one or more slow motion editing control user interface objects (e.g., 836, 836a, and/or 836b) (e.g., based on a determination that the request to adjust the playback speed of the video media item is a request to adjust the playback speed of the video media item to a playback speed that is below the threshold playback speed). In some embodiments, the one or more slow motion editing control user interface objects (e.g., 836, 836a, and/or 836b) are configured to adjust (e.g., set and/or apply) a respective portion (e.g., an entire portion of the video media item and/or a portion of the video media item that is less than the entire portion of the video media item) of the video media item (e.g., 822a) that is configured to play with the playback speed that is below the threshold playback speed (e.g., adjusting, modifying, and/or changing a respective portion of the video media item that plays back with the playback speed that is below the threshold playback speed, such as adjusting, modifying, and/or changing a duration, a starting point, and/or an ending point of the video media item that plays back with the playback speed that is below the threshold playback speed). In some embodiments, a second portion of the video media item (e.g., 822a) that is different from the respective portion of the video media item (e.g., 822a) is configured to play with a playback speed that is faster than a playback speed of the respective portion of the video media item (e.g., 822a) (e.g., the second portion of the video media item is configured to play with a playback speed that is above the threshold playback speed). Displaying the one or more slow motion editing control user interface objects in response to detecting the one or more user inputs corresponding to the request to adjust the playback speed of the video media item allows the computer system to display controls that are relevant to the video media item and allows a user to determine whether a control is available for the video media item, thereby providing improved visual feedback to the user.

Note that details of the processes described above with respect to method 1500 (e.g., FIG. 15) are also applicable in an analogous manner to the methods described above/below. For example, methods 900, 1100, 1300, 1600, 1800, 1900, and/or 2100 optionally include one or more of the characteristics of the various methods described above with reference to method 1500. For example, the computer system of method 700 can be used to edit a media style for a media item that includes a playback speed edited using computer system 1500. For example, the computer system of method 900 can be used to further edit video media items that are edited using the slow motion controls of method 1500. As another example, the computer system of method 1100 can be used to selectively apply edits made to a media item using the computer system of method 1500 from one media item to another media item. Further still, the computer system of method 1300 can be used to make additional edits to a media item edited using the computer system of method 1500. The computer system of method 1600 can be used to adjust and/or edit audio of a media item edited using the computer system of method 1500. The computer system of method 1800 can be used to select media styles for a media item editing using the computer system of method 1500. The computer system of method 1900 can be used to select media items edited using the computer system of method 1500 to preview a media style. The computer system of method 2100 can be used to make additional edits to a media item edited using the computer system of method 1500. For brevity, these details are not repeated below.

FIG. 16 is a flow diagram illustrating a method for editing audio of a media item using a computer system in accordance with some embodiments. Method 1600 is performed at a computer system (e.g., 100, 300, 500, and/or 600) (e.g., a smart phone, a smart watch, a tablet computer, a laptop computer, a desktop computer, a wearable device, and/or head-mounted device) that is in communication with (e.g., includes and/or is connected to) one or more display generation components (e.g., 602) (e.g., one or more displays, touch-screen displays, monitors, holographic display systems, and/or head-mounted display systems) and one or more input devices (e.g., 600a and/or 602) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 1600 are, optionally, combined, the orders of some operations are, optionally, changed, and some operations are, optionally, omitted.

As described below, method 1600 provides an intuitive way for editing audio of a media item. The method reduces the cognitive burden on a user for editing audio of a media item, thereby creating a more efficient human-machine interface. For battery-operated computing devices, enabling a user to manage photographic styles faster and more efficiently conserves power and increases the time between battery charges.

While displaying, via the one or more display generation components (e.g., 602), a media editing user interface (e.g., 822, 830, and/or 1400) (e.g., a user interface that includes display of one or more media items, one or more control user interface objects for editing, adjusting, modifying, and/or changing one or more visual aspects of a respective media item, one or more user interface objects for adding, removing, repositioning, sharing, bookmarking, deleting, and/or providing a designation to the one or more media items, and/or one or more control user interface objects for editing, adjusting, modifying, and/or changing audio parameters of a respective media item and/or a playback speed of the respective media item) of a media item (e.g., 822a) (e.g., a photo, an image, a graphical object, a video, a graphical interchange format item, and/or an audio recording) that includes audio (e.g., sound and/or noise captured and/or recorded via a microphone of the computer system and/or a microphone of a different computer system), wherein the media editing user interface (e.g., 822, 830, and/or 1400) includes an audio control user interface object (e.g., 832, 832a, 832b, 1402, 1402a, 1402b, 1402c, 1408, 1408a, 1408b, and/or 1408c) (e.g., a scrubber, a slider, a button, an affordance, a graphical user interface element, and/or a selectable icon), computer system (e.g., 100, 300, 500, and/or 600) detects (1602), via the one or more input devices (e.g., 600a and/or 602), one or more inputs (e.g., 850s, 1450c, 1450d, 1450f, and/or 1450g) (e.g., one or more tap gestures, swipe gestures, touch gestures, air gestures, button presses, and/or voice commands) directed to (e.g., at a location corresponding to or that is detected while attention is directed to) the audio control user interface object (e.g., 832, 832a, 832b, 1402, 1402a, 1402b, 1402c, 1408, 1408a, 1408b, and/or 1408c).

In response to detecting the one or more inputs (e.g., 850s, 1450c, 1450d, 1450f, and/or 1450g) corresponding to the audio control user interface object (1604) (e.g., 832, 832a, 832b, 1402, 1402a, 1402b, 1402c, 1408, 1408a, 1408b, and/or 1408c) and in accordance with a determination that the one or more inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c) include a request (e.g., the one or more user inputs include a tap gesture and/or a swipe gesture directed toward and/or directed to the audio control user interface object that cause a thumb and/or another user interface object of the audio control user interface object to move and/or change positions from a first position corresponding to the original value to a first updated value that corresponds to the first value selected via the one or more user inputs) to adjust (e.g., edit, change, and/or modify) a current value of a first audio mix effect to a first value of a plurality of values for the first audio mix effect (e.g., a first value that is determined based on a magnitude, direction, duration, and/or speed of the one or more user input), computer system (e.g., 100, 300, 500, and/or 600) adjusts (1606) (e.g., changing, applying, and/or updating) a magnitude (e.g., an intensity, a level, and/or an amount of the first audio mix effect that is applied to the audio of the media item) of the first audio mix effect to the first value for the first audio mix effect (e.g., the first value and/or a value of the first audio mix effect that is based on a location, magnitude, direction, and/or speed of the one or more inputs).

In response to detecting the one or more inputs (e.g., 850s, 1450c, 1450d, 1450f, and/or 1450g) corresponding to the audio control user interface object (1604) (e.g., 832, 832a, 832b, 1402, 1402a, 1402b, 1402c, 1408, 1408a, 1408b, and/or 1408c) and in accordance with a determination that the one or more inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c) include a request (e.g., the one or more user inputs include a tap gesture and/or a swipe gesture directed toward and/or directed to the audio control user interface object that cause a thumb and/or another user interface object of the audio control user interface object to move and/or change positions from a first position corresponding to the original value to a second updated value that corresponds to the second value selected via the one or more user inputs) to adjust (e.g., edit, change, and/or modify) the current value of the first audio mix effect to a second value of the plurality of values for the first audio mix effect (e.g., a second value that is determined based on a magnitude, direction, duration, and/or speed of the one or more user input) that is different from the first value of the plurality of values, computer system (e.g., 100, 300, 500, and/or 600) adjusts (1608) (e.g., changing, applying, and/or updating) the magnitude (e.g., an intensity, a level, and/or an amount of the first audio mix effect that is applied to the audio of the media item) of the first audio mix effect to the second value that is different from the first value for the first audio mix effect (e.g., the second value and/or a value of the first audio mix effect that is based on a location, magnitude, direction, and/or speed of the one or more inputs).

In some embodiments, in response to detecting user input (e.g., 850s, 1450c, 1450d, 1450f, and/or 1450g) corresponding to selection of and/or interaction with the audio control user interface object (e.g., 832, 832a, 832b, 1402, 1402a, 1402b, 1402c, 1408, 1408a, 1408b, and/or 1408c), the computer system (e.g., 100, 300, 500, and/or 600) adjusts a value of a first audio mix effect for and/or applied to audio of the media item from an original value to a respective value. In some embodiments, the first audio mix effect includes ambient sound, studio sound, background noise removal, on-camera focus sound, standard sound, increasing a volume of voices in the field of view of the one or more cameras, decreasing a volume of voices outside of the field of view of the one or more cameras, increasing a volume of sounds that are closer to (e.g., within a threshold distance of) the device, decreasing a volume of sounds further from (e.g., further than the threshold distance from) the device, and/or voice isolation (e.g., as described in Tables 1 and 2).

Adjusting the magnitude of the first audio mix effect to different values based on the one or more user inputs corresponding to the audio control user interface object enables a user to have enhanced control of the first audio mix effect and/or allows the user to adjust the first audio mix effect to different values without requiring additional user input to navigate to a different user interface, thereby reducing the number of inputs needed to perform an operation.

In some embodiments, the audio control user interface object (e.g., 832, 832a, 832b, 1402, 1402a, 1402b, 1402c, 1408, 1408a, 1408b, and/or 1408c) is displayed concurrently (e.g., at the same time as and/or separately) with a plurality of audio mix effect user interface objects (e.g., 1404a-1404d) (e.g., buttons, affordances, graphical user interface elements, and/or selectable icons that correspond to respective audio mix effects that are configured to be applied to the media item) on the media editing user interface (e.g., 822, 830, and/or 1400). In some embodiments, while displaying the plurality of audio mix effect user interface objects (e.g., 1404a-1404d), computer system (e.g., 100, 300, 500, and/or 600) detects user input (e.g., 1450e, 1450h, and/or 1450i) corresponding to a respective audio mix effect user interface object (e.g., 1404a-1404d); in response to detecting the user input (e.g., 1450e, 1450h, and/or 1450i) corresponding to the respective audio mix effect user interface object (e.g., 1404a-1404d): in accordance with a determination that the respective audio mix effect user interface object (e.g., 1404a-1404d) is a first audio mix effect user interface object, computer system (e.g., 100, 300, 500, and/or 600) applies a second audio mix effect to the audio of the media item (e.g., 822a) that corresponds to the first audio mix effect user interface object (e.g., 1404a-1404d); and in accordance with a determination that the respective audio mix effect user interface object (e.g., 1404a-1404d) is a second audio mix effect user interface object that is different from the first audio mix effect user interface object, computer system (e.g., 100, 300, 500, and/or 600) applies a third audio mix effect to the audio of the media item (e.g., 822a) that corresponds to the second audio mix effect user interface object, wherein the third audio mix effect is different from the second audio mix effect. Displaying a plurality of audio mix effect user interface object concurrently with the audio control user interface object allows a user to switch between respective audio mix effects without requiring additional user input to navigate to a different user interface, thereby reducing the number of inputs needed to perform an operation.

In some embodiments, the plurality of audio mix effect user interface objects (e.g., 1404a-1404d) includes a first audio mix effect user interface object (e.g., 1404a-1404d) (e.g., a first button, affordance, graphical user interface element and/or selectable icon) corresponding to a voice emphasis audio mix effect (e.g., Audio Mix Style 2 at Table 1) (e.g., an audio mix effect that is configured to be applied to the media item and that includes emphasizing one or more voices of the audio of the media item over other sounds of the audio of the media item). In some embodiments, the computer system (e.g., 100, 300, 500, and/or 600) is configured to adjust a magnitude of the voice emphasis audio mix effect based on (e.g., in response to) an adjustment of an adjustment control (e.g., 832, 832a, 832b, 1402, 1402a, 1402b, 1402c, 1408, 1408a, 1408b, and/or 1408c) (e.g., a slider and/or the audio control user interface object). In some embodiments, adjusting the magnitude of the voice emphasis audio mix effect includes panning one or more sounds corresponding to voices included in the audio of the media item. In some embodiments, adjusting the magnitude of the voice emphasis audio mix effect includes applying dynamic range compression individually to foreground sound and background sound of the audio of the media item. In some embodiments, adjusting the magnitude of the voice emphasis audio mix effect includes applying automatic equalization to isolated foreground sounds (e.g., voice sounds) of the audio of the media item with varying levels of intensity (e.g., the level of intensity is based on an amount of adjustment to the adjustment control). In some embodiments, adjusting the magnitude of the voice emphasis audio mix effect includes applying automatic equalization to isolated background sounds of the audio of the media item with varying levels of intensity (e.g., the level of intensity is based on an amount of adjustment to the adjustment control). In some embodiments, adjusting the magnitude of the voice emphasis audio mix effect includes reducing a level of background sounds of the audio of the media item by varying amounts (e.g., the amount is based on an amount of adjustment to the adjustment control). In some embodiments, the voice emphasis audio mix effect includes isolation of voices (e.g., all voices) included in a foreground track of the audio of the media item. In some embodiments, the voice emphasis audio mix effect includes reverberation removal (e.g., removal of sound persisting after the source generating the sound has stopped generating the sound and/or removal of reflection and/or scattering of sound), but not complete reverberation removal. The plurality of audio mix effect user interface objects including a first audio mix effect user interface object corresponding to a voice emphasis audio mix effect allows a user to switch from the first audio mix effect to the voice emphasis audio mix effect without requiring additional user input to navigate to a different user interface, thereby reducing the number of inputs needed to perform an operation.

In some embodiments, the plurality of audio mix effect user interface objects (e.g., 1404a-1404d) includes a second audio mix effect user interface object (e.g., 1404a-1404d) (e.g., a second button, affordance, graphical user interface element and/or selectable icon) corresponding to a background noise removal audio mix effect (e.g., Audio Mix Style 3 at Table 1) (e.g., an audio mix effect that is configured to be applied to the media item and that includes removing, decreasing the volume of, and/or otherwise de-emphasizing background sound and/or noise of the audio of the media item and/or increasing the volume of and/or emphasizing sound that is not background sound and/or noise of the audio of the media item). In some embodiments, the computer system (e.g., 100, 300, 500, and/or 600) is configured to adjust a magnitude of the background noise removal audio mix effect based on (e.g., in response to) an adjustment of an adjustment control (e.g., 832, 832a, 832b, 1402, 1402a, 1402b, 1402c, 1408, 1408a, 1408b, and/or 1408c) (e.g., a slider and/or the audio control user interface object). In some embodiments, adjusting the magnitude of the background noise removal audio mix effect includes panning one or more sounds corresponding to voices included in the audio of the media item. In some embodiments, adjusting the magnitude of the background noise removal audio mix effect includes applying dynamic range compression individually to foreground sound and background sound of the audio of the media item. In some embodiments, adjusting the magnitude of the background noise removal audio mix effect includes applying automatic equalization to isolated foreground sounds (e.g., voice sounds) of the audio of the media item with varying levels of intensity (e.g., the level of intensity is based on an amount of adjustment to the adjustment control). In some embodiments, adjusting the magnitude of the background noise removal audio mix effect includes applying automatic equalization to isolated background sounds of the audio of the media item with varying levels of intensity (e.g., the level of intensity is based on an amount of adjustment to the adjustment control). In some embodiments, adjusting the magnitude of the background noise removal audio mix effect includes reducing a level of background sounds of the audio of the media item by varying amounts (e.g., the amount is based on an amount of adjustment to the adjustment control). In some embodiments, the background noise removal audio mix effect includes isolation of voices (e.g., some or all voices) included in a foreground track of the audio of the media item. In some embodiments, the background noise removal audio mix effect includes reverberation removal (e.g., removal of sound persisting after the source generating the sound has stopped generating the sound and/or removal of reflection and/or scattering of sound). In some embodiments, the background noise removal audio mix effect includes complete reverberation removal. The plurality of audio mix effect user interface objects including a second audio mix effect user interface object corresponding to a background noise removal audio mix effect allows a user to switch from the first audio mix effect to the background noise removal audio mix effect without requiring additional user input to navigate to a different user interface, thereby reducing the number of inputs needed to perform an operation.

In some embodiments, the plurality of audio mix effect user interface objects (e.g., 1404a-1404d) includes a third audio mix effect user interface object (e.g., 1404a-1404d) (e.g., a third button, affordance, graphical user interface element and/or selectable icon) corresponding to a field of view emphasis audio mix effect (e.g., Audio Mix Effect 4 at Table 1) (e.g., an audio mix effect that is configured to be applied to the media item and that includes emphasizing sound and/or noise of the audio of the media item that corresponds to sound and/or noise originating within a field of view of one or more cameras that were used to capture the media item), wherein the field of view emphasis audio mix effect (e.g., Audio Mix Effect 4 at Table 1) emphasizes sounds (e.g., one or more portions, tracks, and/or mixes of the audio of the media item that) corresponding to a field of view (e.g., an area and/or region of an environment that is within a range and/or scope of one or more cameras, such that the one or more cameras capture images, photographs, and/or videos of the area and/or region of the environment but do not capture images, photographs and/or videos outside of the area and/or region of the environment) of one or more cameras used to capture a respective media item (e.g., 822a) (e.g., increases the volume of the sounds corresponding to the field of view of the one or more cameras used to capture the respective media item relative to other sounds and/or noise of the audio of the respective media item and/or reducing and/or removing sounds and/or noise that do not correspond to the field of view of the one or more cameras used to capture the respective media item). In some embodiments, the computer system (e.g., 100, 300, 500, and/or 600) is configured to adjust a magnitude of the field of view emphasis audio mix effect based on (e.g., in response to) an adjustment of an adjustment control (e.g., 832, 832a, 832b, 1402, 1402a, 1402b, 1402c, 1408, 1408a, 1408b, and/or 1408c) (e.g., a slider and/or the audio control user interface object). In some embodiments, adjusting the magnitude of the field of view emphasis audio mix effect includes panning one or more sounds corresponding to voices included in the audio of the media item. In some embodiments, adjusting the magnitude of the field of view emphasis audio mix effect includes applying dynamic range compression individually to foreground sound and background sound of the audio of the media item. In some embodiments, adjusting the magnitude of the field of view emphasis audio mix effect includes applying automatic equalization to isolated foreground sounds (e.g., voice sounds) of the audio of the media item with varying levels of intensity (e.g., the level of intensity is based on an amount of adjustment to the adjustment control). In some embodiments, adjusting the magnitude of the field of view emphasis audio mix effect includes applying automatic equalization to isolated background sounds of the audio of the media item with varying levels of intensity (e.g., the level of intensity is based on an amount of adjustment to the adjustment control). In some embodiments, adjusting the magnitude of the field of view emphasis audio mix effect includes reducing a level of background sounds of the audio of the media item by varying amounts (e.g., the amount is based on an amount of adjustment to the adjustment control). In some embodiments, the field of view emphasis audio mix effect includes isolation of voices that are within a field of view of a camera and included in a foreground track of the audio of the media item. In some embodiments, the field of view emphasis audio mix effect does not include reverberation removal (e.g., removal of sound persisting after the source generating the sound has stopped generating the sound and/or removal of reflection and/or scattering of sound). The plurality of audio mix effect user interface objects including a third audio mix effect user interface object corresponding to a field of view emphasis audio mix effect allows a user to switch from the first audio mix effect to the field of view emphasis audio mix effect without requiring additional user input to navigate to a different user interface, thereby reducing the number of inputs needed to perform an operation.

In some embodiments, the sounds corresponding to the field of view of the one or more cameras used to capture the respective media item (e.g., 822a) are determined (e.g., via the computer system and/or another computer system) based on visual information (e.g., images, photographs, and/or videos) captured via the one or more cameras while recording audio of the respective media item (e.g., 822a) (e.g., the sounds corresponding to the field of view of the one or more cameras include sounds that originate from objects, people, beings, and/or other sound creation devices that are captured via the one or more cameras and/or represented, displayed, and/or included in the visual information of the respective media item). Determining the sounds corresponding to the field of view of the one or more cameras used to capture the respective media item based on visual information captured via the one or more cameras while recording audio of the respective media item allows a user to emphasize sounds that originate from within the field of view of the one or more cameras without requiring additional user inputs, thereby reducing the number of inputs needed to perform an operation.

In some embodiments, the sounds corresponding to the field of view of the one or more cameras used to capture the respective media item (e.g., 822a) are determined (e.g., via the computer system and/or another computer system) based on differences (e.g., differences in volume, intensity, frequency range, balance, and/or clarity) between a first audio stream (e.g., a first portion of the overall audio corresponding to the respective media item) of the respective media item (e.g., 822a) captured via a first microphone (e.g., a first microphone of an array of microphones used to capture the audio of the respective media item) and a second audio stream (e.g., a second portion of the overall audio corresponding to the respective media item) of the respective media item (e.g., 822a) captured via a second microphone (e.g., a second microphone of an array of microphones used to capture the audio of the respective media item), wherein the first microphone and the second microphone are physically separate from one another (e.g., the first microphone and the second microphone are different microphones of an array of microphones, the first microphone and the second microphone are located at different positions that are physically spaced apart from one another, and/or the first microphone and the second microphone are located on and/or part of the same device and are separated from one another by a housing of the device). Determining the sounds corresponding to the field of view of the one or more cameras used to capture the respective media item based on differences between first and second audio streams captured by microphones that are physically separate from one another allows a user to emphasize sounds that originate from within the field of view of the one or more cameras without requiring additional user inputs, thereby reducing the number of inputs needed to perform an operation.

In some embodiments, while concurrently displaying the audio control user interface object (e.g., 832, 832a, 832b, 1402, 1402a, 1402b, 1402c, 1408, 1408a, 1408b, and/or 1408c) and the plurality of audio mix effect user interface objects (e.g., 1404a-1404d), computer system (e.g., 100, 300, 500, and/or 600) detects, via the one or more input devices (e.g., 600a and/or 602), user input (e.g., 1450e, 1450h, and/or 1450i) (e.g., a tap gesture corresponding to a respective audio mix effect user interface object, a touch gesture corresponding to a respective audio mix effect user interface object, a click of a mouse and/or trackpad while a cursor is displayed over a respective audio mix effect user interface object, a tap gesture, a swipe gesture, a touch gesture, an air gesture, a button press, and/or a voice command) corresponding to selection of a respective audio mix effect user interface object (e.g., 1404a-1404d) (e.g., an audio mix effect user interface object that corresponds to an audio mix effect that is different from the first audio mix effect); and in response to detecting the user input (e.g., 1450e, 1450h, and/or 1450i) corresponding to selection of the respective audio mix effect user interface object (e.g., 1404a-1404d), computer system (e.g., 100, 300, 500, and/or 600) displays, via the one or more display generation components (e.g., 602), a second media editing user interface (e.g., 1400) (e.g., a user interface that includes display of one or more media items, one or more control user interface objects for editing, adjusting, modifying, and/or changing one or more visual aspects of a respective media item, one or more user interface objects for adding, removing, repositioning, sharing, bookmarking, deleting, and/or providing a designation to the one or more media items, and/or one or more control user interface objects for editing, adjusting, modifying, and/or changing audio parameters of a respective media item and/or a playback speed of the respective media item) corresponding to a second audio mix effect (e.g., ambient sound, studio sound, background noise removal, on-camera focus sound, standard sound, increasing a volume of voices in the field of view of the one or more cameras, decreasing a volume of voices outside of the field of view of the one or more cameras, increasing a volume of sounds that are closer to (e.g., within a threshold distance of) the device, decreasing a volume of sounds further from (e.g., further than the threshold distance from) the device, and/or voice isolation) that is different from the first audio mix effect. Displaying the second media editing user interface corresponding to a second audio mix effect in response to detecting user input corresponding to selection of the respective audio mix effect user interface object allows a user to switch between respective audio mix effects without requiring additional user input to navigate to a different user interface, thereby reducing the number of inputs needed to perform an operation.

In some embodiments, the second media editing user interface (e.g., 1400) includes a second audio control user interface object (e.g., 832, 832a, 832b, 1402, 1402a, 1402b, 1402c, 1408, 1408a, 1408b, and/or 1408c) (e.g., a scrubber, a slider, a button, an affordance, a graphical user interface element, and/or a selectable icon). In some embodiments, while displaying the second audio control user interface object (e.g., 832, 832a, 832b, 1402, 1402a, 1402b, 1402c, 1408, 1408a, 1408b, and/or 1408c), computer system (e.g., 100, 300, 500, and/or 600) detects, via the one or more input devices (e.g., 600a and/or 602), one or more inputs (e.g., 850s, 1450c, 1450d, 1450f, and/or 1450g) (e.g., a touch and drag input corresponding to a slider, a pinch and/or a de-pinch input corresponding to a slider, a click of a mouse and/or trackpad followed by movement of the mouse and/or touch on the trackpad while a cursor is displayed over a slider, one or more tap gestures, swipe gestures, touch gestures, air gestures, button presses, and/or voice commands) directed to (e.g., at a location corresponding to or that is detected while attention is directed to) the second audio control user interface object (e.g., 832, 832a, 832b, 1402, 1402a, 1402b, 1402c, 1408, 1408a, 1408b, and/or 1408c); and in response to detecting the one or more inputs (e.g., 850s, 1450c, 1450d, 1450f, and/or 1450g) corresponding to the second audio control user interface object (e.g., 832, 832a, 832b, 1402, 1402a, 1402b, 1402c, 1408, 1408a, 1408b, and/or 1408c): in accordance with a determination that the one or more inputs (e.g., 850s, 1450c, 1450d, 1450f, and/or 1450g) corresponding to the second audio control user interface object (e.g., 832, 832a, 832b, 1402, 1402a, 1402b, 1402c, 1408, 1408a, 1408b, and/or 1408c) include a request (e.g., the one or more user inputs include a tap gesture and/or a swipe gesture directed toward and/or directed to the second audio control user interface object that cause a thumb and/or another user interface object of the second audio control user interface object to move and/or change positions from a first position corresponding to the original value to a first updated value that corresponds to the first value selected via the one or more user inputs) to adjust (e.g., edit, change, and/or modify) a current value of the second audio mix effect to a first value of a plurality of values for the second audio mix effect (e.g., a first value that is determined based on a magnitude, direction, duration, and/or speed of the one or more user inputs), computer system (e.g., 100, 300, 500, and/or 600) adjusts (e.g., adjusts based on information shown at Table 2) (e.g., changing, applying, and/or updating) a magnitude (e.g., an intensity, a level, and/or an amount of the second audio mix effect that is applied to the audio of the media item) of the second audio mix effect to the first value for the second audio mix effect (e.g., the first value and/or a value of the second audio mix effect that is based on a location, magnitude, direction, and/or speed of the one or more inputs); and in accordance with a determination that the one or more inputs (e.g., 850s, 1450c, 1450d, 1450f, and/or 1450g) corresponding to the second audio control user interface object (e.g., 832, 832a, 832b, 1402, 1402a, 1402b, 1402c, 1408, 1408a, 1408b, and/or 1408c) include a request (e.g., the one or more user inputs include a tap gesture and/or a swipe gesture directed toward and/or directed to the second audio control user interface object that cause a thumb and/or another user interface object of the second audio control user interface object to move and/or change positions from a first position corresponding to the original value to a second updated value that corresponds to the second value selected via the one or more user inputs) to adjust (e.g., edit, change, and/or modify) the current value of the second audio mix effect to a second value of the plurality of values for the second audio mix effect (e.g., a second value that is determined based on a magnitude, direction, duration, and/or speed of the one or more user inputs) that is different from the first value of the plurality of values, computer system (e.g., 100, 300, 500, and/or 600) adjusts (e.g., adjusts based on information shown at Table 2) (e.g., changing, applying, and/or updating) the magnitude (e.g., an intensity, a level, and/or an amount of the second audio mix effect that is applied to the audio of the media item) of the second audio mix effect to the second value that is different from the first value for the second audio mix effect (e.g., the second value and/or a value of the second audio mix effect that is based on a location, magnitude, direction, and/or speed of the one or more inputs). In some embodiments, adjusting the magnitude of the second audio mix effect to a respective value includes panning one or more sounds corresponding to voices included in the audio of the media item. In some embodiments, adjusting the magnitude of the second audio mix effect to a respective value includes applying dynamic range compression individually to foreground sound and background sound of the audio of the media item. In some embodiments, adjusting the magnitude of the second audio mix effect to a respective value includes applying automatic equalization to isolated foreground sounds (e.g., voice sounds) of the audio of the media item with varying levels of intensity (e.g., the level of intensity is based on an amount of adjustment to the second audio control user interface object). In some embodiments, adjusting the magnitude of the second audio mix effect to a respective value includes applying automatic equalization to isolated background sounds of the audio of the media item with varying levels of intensity (e.g., the level of intensity is based on an amount of adjustment to the second audio control user interface object). In some embodiments, adjusting the magnitude of the second audio mix effect to a respective value includes reducing a level of background sounds of the audio of the media item by varying amounts (e.g., the amount is based on an amount of adjustment to the second audio control user interface object). Adjusting the magnitude of the second audio mix effect to different values based on the one or more user inputs corresponding to the second audio control user interface object enables a user to have enhanced control of the second audio mix effect and/or allows the user to adjust the second audio mix effect to different values without requiring additional user input to navigate to a different user interface, thereby reducing the number of inputs needed to perform an operation.

In some embodiments, in response to detecting the one or more inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c) (e.g., while displaying the audio control user interface object): in accordance with a determination that the one or more user inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c) include a first input in a first direction (e.g., without including a second input in a second direction that is different from the first direction), computer system (e.g., 100, 300, 500, and/or 600) increases the magnitude of the first audio mix effect (e.g., increasing an intensity of the first audio mix effect applied to the audio of the media item, such that output of the audio of the media item becomes more different from original audio of the media item); and in accordance with a determination that the one or more user inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c) include a second input in a second direction that is different from the first direction (e.g., without including the first input that is in the first direction), computer system (e.g., 100, 300, 500, and/or 600) decreases the magnitude of the first audio mix effect (e.g., reducing an intensity of the first audio mix effect applied to the audio of the media item, such that output of the audio of the media item more closely resembles original audio of the media item); and in response to detecting the one or more user inputs (e.g., 850s, 1450c, 1450d, 1450f, and/or 1450g) corresponding to the second audio control user interface object (e.g., 832, 832a, 832b, 1402, 1402a, 1402b, 1402c, 1408, 1408a, 1408b, and/or 1408c) (e.g., while displaying the second audio control user interface object): in accordance with a determination that the one or more user inputs (e.g., 850s, 1450c, 1450d, 1450f, and/or 1450g) corresponding to the second audio control user interface object (e.g., 832, 832a, 832b, 1402, 1402a, 1402b, 1402c, 1408, 1408a, 1408b, and/or 1408c) include a third input in the first direction (e.g., without including a fourth input in the second direction that is different from the first direction), computer system (e.g., 100, 300, 500, and/or 600) increases the magnitude of the second audio mix effect (e.g., increasing an intensity of the second audio mix effect applied to the audio of the media item, such that output of the audio of the media item becomes more different from original audio of the media item); and in accordance with a determination that the one or more inputs (e.g., 850s, 1450c, 1450d, 1450f, and/or 1450g) corresponding to the second audio control user interface object (e.g., 832, 832a, 832b, 1402, 1402a, 1402b, 1402c, 1408, 1408a, 1408b, and/or 1408c) include a fourth input in the second direction that is different from the first direction (e.g., without including the third input in the first direction), computer system (e.g., 100, 300, 500, and/or 600) decreases the magnitude of the second audio mix effect (e.g., reducing an intensity of the second audio mix effect applied to the audio of the media item, such that output of the audio of the media item more closely resembles original audio of the media item). Increasing a magnitude of a respective audio mix effect when the one or more user inputs corresponding to a respective audio control user interface object include an input in a first direction and decreasing a magnitude of the respective audio mix effect when the one or more user inputs corresponding the respective audio control user interface object allows the user to control a magnitude of a respective audio mix effect consistently and without having to provide additional inputs to learn how to use the respective audio control user interface object, thereby reducing the number of inputs needed to perform an operation.

In some embodiments, a difference between the first audio mix effect and the second audio mix effect increases based on increasing the magnitude of the first audio mix effect and/or increasing the magnitude of the second audio mix effect (e.g., based on user inputs 1450c and/or 1450g) (e.g., the audio of the media item becomes more different as the magnitude of the first audio mix effect increases and/or as the magnitude of the second audio mix effect increases), and the difference between the first audio mix effect and the second audio mix effect decreases based on decreasing the magnitude of the first audio mix effect and/or decreasing the magnitude of the second audio mix effect (e.g., based on user inputs 1450d and/or 1450f) (e.g., the audio of the media item becomes more similar and/or closer to originally captured audio as the magnitude of the first audio mix effect decreases and/or as the magnitude of the second audio mix effect decreases). Increasing a difference between the first and second audio mix effects as the magnitudes of the first and second audio mix effects increases and decreasing the difference between the first and second audio mix effects as the magnitudes of the first and second audio mix effects decreases allows the user to control a magnitude of a respective audio mix effect consistently and without having to provide additional inputs to learn how to use the respective audio control user interface object, thereby reducing the number of inputs needed to perform an operation.

In some embodiments, in response to detecting the user input (e.g., 1450e, 1450h, and/or 1450i) corresponding to selection of the respective audio mix effect user interface object (e.g., 1404a-1404d): in accordance with a determination that the respective audio mix effect user interface object (e.g., 1404a-1404d) is of a first type (e.g., a type corresponding to 1404b-1404d) (e.g., the audio mix effect user interface object corresponds to an audio mix effect that adjusts, modifies, and/or changes originally captured audio of the media item and/or adjusts, modifies, and/or changes the originally captured audio of the media item by more than a threshold amount), computer system (e.g., 100, 300, 500, and/or 600) displays, via the one or more display generation components (e.g., 602), the second media editing user interface (e.g., 1400) that includes the second audio control user interface object (e.g., 832, 832a, 832b, 1402, 1402a, 1402b, 1402c, 1408, 1408a, 1408b, and/or 1408c); and in accordance with a determination that the respective audio mix effect user interface object (e.g., 1404a-1404d) is of a second type (e.g., a type corresponding to 1404a) that is different from the first type (e.g., the audio mix effect user interface object corresponds to an audio mix effect that does not adjust, modify, and/or change originally captured audio of the media item and/or adjusts, modifies, and/or changes the originally captured audio of the media item by less than a threshold amount), computer system (e.g., 100, 300, 500, and/or 600) displays, via the one or more display generation components (e.g., 602), the second media editing user interface (e.g., 1400) without displaying the second audio control user interface object (e.g., as shown at FIG. 14G) (e.g., the computer system displays the second media editing user interface and does not display the second audio control user interface object, such that the magnitude of the respective audio mix effect corresponding to the respective audio mix effect user interface object is not able to be adjusted). Displaying the second media editing user interface with the second audio control user interface object when the respective audio mix effect user interface object is of a first type and displaying the second media user interface without the second audio control user interface object when the respective audio mix effect user interface object is of a second type automatically provides relevant controls to the user and/or allows the user to determine whether the respective audio mix effect can be adjusted, thereby performing an operation when a set of conditions has been met without requiring further user input and/or providing improved visual feedback to the user.

In some embodiments, while displaying the second media editing user interface (e.g., 1400) corresponding to the second audio mix effect that is different from the first audio mix effect, computer system (e.g., 100, 300, 500, and/or 600) detects, via the one or more input devices (e.g., 600a and/or 602), user input (e.g., 1450i) (e.g., a tap gesture corresponding to a respective audio mix effect option, a touch gesture corresponding to a respective audio mix effect option, a click of a mouse and/or trackpad while a cursor is displayed over a respective audio mix effect option, a tap gesture, a swipe gesture, a touch gesture, an air gesture, a button press, and/or a voice command) corresponding to a request to display the media editing user interface (e.g., 822, 830, and/or 1400); and in response to detecting the user input (e.g., 1450i) corresponding to the request to display the media editing user interface (e.g., 822, 830, and/or 1400), computer system (e.g., 100, 300, 500, and/or 600) displays, via the one or more display generation components (e.g., 602), the media editing user interface (e.g., 822, 830, and/or 1400) that includes the audio control user interface object (e.g., 832, 832a, 832b, 1402, 1402a, 1402b, 1402c, 1408, 1408a, 1408b, and/or 1408c), wherein the audio control user interface object (e.g., 832, 832a, 832b, 1402, 1402a, 1402b, 1402c, 1408, 1408a, 1408b, and/or 1408c) includes a value indicator (e.g., 1402c and/or 1408c) corresponding to a respective value for the first audio mix effect, and wherein the respective value corresponds to a most recent (e.g., user-selected and/or a default) value for the first audio mix effect (e.g., after navigating away from the media editing user interface, the computer system detects a request to re-display the media editing user interface, and in response to detecting the request to re-display the media editing user interface, the computer system maintains the respective value for the first audio mix effect based on the last user input and/or the most recent user input corresponding to a request to adjust the value and/or magnitude of the first audio mix effect that is applied to the audio of the media item). In some embodiments, after detecting the one or more inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c), the computer system (e.g., 100, 300, 500, and/or 600) adjusts the magnitude of the first audio mix effect to an updated value for the first audio mix effect. After adjusting the magnitude of the first audio mix effect (e.g., and without detecting any additional inputs corresponding to the audio control user interface object), the computer system (e.g., 100, 300, 500, and/or 600) detects a request to display the second media editing user interface (e.g., 1400). In response to detecting the request to display the second media editing user interface (e.g., 1400), the computer system (e.g., 100, 300, 500, and/or 600) displays the second media editing user interface (e.g., 1400) and/or the second audio control user interface object (e.g., 832, 832a, 832b, 1402, 1402a, 1402b, 1402c, 1408, 1408a, 1408b, and/or 1408c). While the computer system (e.g., 100, 300, 500, and/or 600) displays the second media editing user interface (e.g., 1400), the computer system detects a request (e.g., 1450i) to display (e.g., re-display) the media editing user interface (e.g., 822, 830, and/or 1400) that includes the audio control user interface object (e.g., 832, 832a, 832b, 1402, 1402a, 1402b, 1402c, 1408, 1408a, 1408b, and/or 1408c). In response to detecting the request (e.g., 1450i) to display the media editing user interface (e.g., 822, 830, and/or 1400) that includes the audio control user interface object (e.g., 832, 832a, 832b, 1402, 1402a, 1402b, 1402c, 1408, 1408a, 1408b, and/or 1408c), the computer system (e.g., 100, 300, 500, and/or 600) displays the media editing user interface (e.g., 822, 830, and/or 1400) that includes the audio control user interface object (e.g., 832, 832a, 832b, 1402, 1402a, 1402b, 1402c, 1408, 1408a, 1408b, and/or 1408c), wherein the audio control user interface object (e.g., 832, 832a, 832b, 1402, 1402a, 1402b, 1402c, 1408, 1408a, 1408b, and/or 1408c) includes an indication (e.g., 1402c and/or 1408c) (e.g., a visual indication) of the updated value for the first audio mix effect (e.g., the computer system maintains a current value for the first audio mix effect when navigating to different user interfaces from the media editing user interface). Displaying the media editing user interface with the audio control user interface object that includes a value indicator corresponding to a last value for the first audio mix effect maintains a selected value for the first audio mix effect even when the device transitions between displaying different user interfaces, thereby reducing the number of inputs needed to perform an operation.

In some embodiments, the second audio control user interface object (e.g., 832, 832a, 832b, 1402, 1402a, 1402b, 1402c, 1408, 1408a, 1408b, and/or 1408c) includes a slider user interface object (e.g., an interactive graphical user interface element that includes a point that is configured to move in at least two directions along the slider user interface object based on user input corresponding to the slider user interface object, where movement of the point along the slider user interface object causes adjustment of a value and/or magnitude of the second audio mix effect). In some embodiments, in response to detecting the one or more user inputs (e.g., 850s, 1450c, 1450d, 1450f, and/or 1450g) (e.g., a touch and drag input corresponding to a slider, a pinch and/or a de-pinch input corresponding to a slider, a click of a mouse and/or trackpad followed by movement of the mouse and/or touch on the trackpad while a cursor is displayed over a slider, one or more swipe gestures, tap gestures, touch gestures, air gestures, button presses, and/or voice commands) corresponding to the second audio control user interface object (e.g., 832, 832a, 832b, 1402, 1402a, 1402b, 1402c, 1408, 1408a, 1408b, and/or 1408c), wherein the one or more user inputs (e.g., 850s, 1450c, 1450d, 1450f, and/or 1450g) corresponding to the second audio control user interface object (e.g., 832, 832a, 832b, 1402, 1402a, 1402b, 1402c, 1408, 1408a, 1408b, and/or 1408c) include a request to move a position of the slider user interface object (e.g., a position of 1402a, 1402b, 1408a, and/or 1408b) (e.g., the one or more user inputs correspond to a request to move a position of a point of the slider user interface from a first position corresponding to a first value for the second audio mix effect to a second position corresponding to a second value for the second audio mix effect, where the second position is based on a speed, direction, and/or magnitude of the one or more user inputs), computer system (e.g., 100, 300, 500, and/or 600) outputs tactile (e.g., haptic and/or vibration) feedback (e.g., 1451a and/or 1451b). Outputting tactile feedback in response to detecting the one or more user inputs corresponding to the second audio control user interface object provides additional feedback to the user that the magnitude and/or value for the second audio mix effect is being adjusted, thereby providing improved feedback to the user.

In some embodiments, while (e.g., during, before, after) detecting the one or more inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c), computer system (e.g., 100, 300, 500, and/or 600) outputs (e.g., via one or more speakers that are in communication with the computer system) the audio (e.g., 1401a, 1401b, 1401c, 1401d, and/or 1401e) of the media item (e.g., 822a) (and, optionally, playing video corresponding to the media item). In some embodiments, the audio (e.g., 1401a, 1401b, 1401c, 1401d, and/or 1401e) of the media item (e.g., 822a) changes based on changes to the magnitude of the first audio mix effect, such that the audio (e.g., 1401a, 1401b, 1401c, 1401d, and/or 1401e) of the media item (e.g., 822a) changes in real time as the computer system (e.g., 100, 300, 500, and/or 600) adjusts the magnitude of the first audio mix effect. Outputting the audio of the media item while detecting the one or more inputs corresponding to the audio control user interface object allows a user to quickly perceive changes to the first audio mix effect and determine a respective magnitude for the first audio mix effect, thereby reducing the number of inputs needed to perform an operation, improving feedback to the user, and/or reducing an amount of battery consumption.

In some embodiments, while detecting the one or more inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c) and while outputting the audio (e.g., 1401a, 1401b, 1401c, 1401d, and/or 1401e) (and, optionally video) of the media item (e.g., 822a): in accordance with a determination that an end of the audio (e.g., 1401a, 1401b, 1401c, 1410d, and/or 1401e) of the media item (e.g., 822a) is reached (e.g., the audio of the media item reaches an end of a total duration of the audio), computer system (e.g., 100, 300, 500, and/or 600) outputs (e.g., re-outputting) the audio (e.g., 1401a, 1401b, 1401c, 1401d, and/or 1401e) (and, optionally video) of the media item (e.g., 822a) from a beginning of the audio of the media item (e.g., as shown at FIGS. 14G and 14H) (e.g., the audio and/or video of the media item loops and/or re-plays from the beginning of a total duration of the audio and/or video upon reaching the end of the audio and/or video of the media item). In some embodiments, the computer system (e.g., 100, 300, 500, and/or 600) continues to loop the audio (e.g., 1401a, 1401b, 1401c, 1401d, and/or 1401e) and/or video of the media item (e.g., 822a) until the computer system (e.g., 100, 300, 500, and/or 600) detects one or more user inputs corresponding to a request to pause the audio (e.g., 140a, 1401b, 1401c, 1401d, and/or 1401e) and/or video of the media item (e.g., 822a). Outputting the audio of the media item from a beginning of the audio of the media item in accordance with a determination that an end of the audio of the media item is reached allows the user to continue to perceive changes to the first audio mix effect without having to provide additional inputs to restart and/or re-output the audio, thereby reducing the number of inputs needed to perform an operation and/or improving feedback to the user.

In some embodiments, while detecting the one or more inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c) and while outputting the audio (e.g., 1401a, 1401b, 1401c, 1401d, and/or 1401e) of the media item (e.g., 822a), computer system (e.g., 100, 300, 500, and/or 600) detects, via the one or more input devices (e.g., 600a and/or 602), one or more user inputs (e.g., 1450j) (e.g., a touch and drag input corresponding to a slider, a pinch and/or a de-pinch input corresponding to a slider, a click of a mouse and/or trackpad followed by movement of the mouse and/or touch on the trackpad while a cursor is displayed over a slider, one or more swipe gestures, tap gestures, touch gestures, air gestures, button presses, and/or voice commands) corresponding to a request to change (e.g., directed toward or directed to one or more selectable user interface objects, such as a scrubber user interface object, for changing) a playback time (e.g., a time corresponding to content currently being output relative to an overall duration of the media item) of the audio (e.g., 1401a, 1401b, 1401c, 1401d, and/or 1401e) of the media item (e.g., 822a) (e.g., change the playback time from a first playback time to a second playback time that is different from the first playback time); and in response to detecting the one or more user inputs (e.g., 1450j) corresponding to the request to change the playback time of the audio (e.g., 1401a, 1401b, 1401c, 1401d, and/or 1401e) of the media item (e.g., 822a), computer system (e.g., 100, 300, 500, and/or 600) outputs (e.g., via one or more speakers that are in communication with the computer system) the audio (e.g., 1401a, 1401b, 1401c, 1401d, and/or 1401e) of the media item (e.g., 822a) from a respective playback time that is based on (e.g., based on a direction, speed, and/or magnitude of) the one or more user inputs (e.g., 1450j) corresponding to the request to change the playback time of the audio (e.g., 1401a, 1401b, 1401c, 1401d, and/or 1401e) of the media item (e.g., 822a) (e.g., the computer system is configured to adjust a playback time of the audio of the media item while the computer system adjusts the magnitude of the first audio mix effect). In some embodiments, the one or more user inputs (e.g., 1450j) corresponding to the request to change the playback time of the audio (e.g., 1401a, 1401b, 1401c, 1401d, and/or 1401e) media item (e.g., 822a) include one or more user inputs corresponding to a scrubber user interface object (e.g., 822d). Outputting the audio of the media item from a respective playback time that is based on the one or more user inputs corresponding to the request to change the playback time of the audio of the media item while detecting the one or more user inputs corresponding to the audio control user interface object allows the user to continue to perceive changes to the first audio mix effect without having to provide additional inputs to restart and/or re-output the audio at various playback times, thereby reducing the number of inputs needed to perform an operation and/or improving feedback to the user.

In some embodiments, displaying the media editing user interface (e.g., 822, 830, and/or 1400) includes concurrently (e.g., at the same time as or separately) displaying the audio control user interface object (e.g., 832, 832a, 832b, 1402, 1402a, 1402b, 1402c, 1408, 1408a, 1408b, and/or 1408c) and one or more editing control user interface objects (e.g., 1403a-1403e) (e.g., one or more buttons, affordances, graphical user interface elements, user selectable icons, and/or regions of the media editing control user interface corresponding to respective controls for editing, adjusting, and/or modifying the media item). In some embodiments, while concurrently displaying the audio control user interface object (e.g., 832, 832a, 832b, 1402, 1402a, 1402b, 1402c, 1408, 1408a, 1408b, and/or 1408c) and the one or more editing control user interface objects (e.g., 1403a-1403e), detecting user input corresponding to a respective editing control user interface object (e.g., 1403a-1403e); and in response to detecting the user input corresponding to the respective editing control user interface object (e.g., 1403a-1403e): in accordance with a determination that the respective editing control user interface object (e.g., 1403a-1403e) is a first editing control user interface object, displaying, via the one or more display generation components, a first editing user interface including one or more first editing controls (and, optionally, editing the media item by adjusting one or more first parameters of the media item); and in accordance with a determination that the respective editing control user interface object (e.g., 1403a-1403e) is a second editing control user interface object that is different from the first editing control user interface object, displaying, via the one or more display generation components, a second editing user interface that is different from the first editing user interface (and, optionally, editing the media item by adjusting one or more second parameters of the media item), wherein the second editing user interface includes one or more second editing controls that are different from the one or more first editing controls. Concurrently displaying one or more editing control user interface objects with the audio control user interface object allows a user to navigate and/or transition to another editing control user interface without requiring the user to navigate away from the media editing user interface, thereby reducing the number of inputs needed to perform an operation.

In some embodiments, the one or more editing control user interface objects (e.g., 1403a-1403e) correspond to respective visual properties of the media item (e.g., one or more controls and/or user interfaces corresponding to a filter, video trimming, cropping, brightness, contrast, saturation, and/or exposure). In some embodiments, a respective editing control user interface object of the one or more editing control user interface objects corresponds to a group of related controls (e.g., a group of controls that adjust multiple visual properties that are related to one another). In some embodiments, a respective editing control user interface object (e.g., 1403a-1403e) of the one or more editing control user interface objects (e.g., 1403a-1403e) corresponds to a single control that includes multiple values (e.g., the single control is configured to be adjusted to respective values). The one or more editing control user interface objects corresponding to respective visual properties of the media item allows a user to navigate and/or transition to an editing user interface without requiring the user to navigate away from the media editing user interface, thereby reducing the number of inputs needed to perform an operation.

In some embodiments, computer system (e.g., 100, 300, 500, and/or 600) detects, via the one or more input devices (e.g., 600a and/or 602), user input (e.g., 2050b) (e.g., a tap gesture corresponding to a respective editing control user interface object, a touch gesture corresponding to a respective editing control user interface object, a click of a mouse and/or trackpad while a cursor is displayed over a respective editing control user interface object, a tap gesture, swipe gesture, touch gesture, air gesture, button press, and/or voice command) corresponding to selection of a respective editing control user interface object (e.g., 1403a-1403e) of the one or more editing control user interface objects (e.g., 1403a-1403e); and in response to detecting the user input (e.g., 2050b) corresponding to selection of the respective editing control user interface object (e.g., 1403a-1403e) of the one or more editing control user interface objects (e.g., 1403a-1403e): computer system (e.g., 100, 300, 500, and/or 600) ceases (e.g., removing and/or stopping) display of the audio control user interface object (e.g., 832, 832a, 832b, 1402, 1402a, 1402b, 1402c, 1408, 1408a, 1408b, and/or 1408c); and computer system (e.g., 100, 300, 500, and/or 600) displays, via the one or more display generation components (e.g., 602), one or more control user interface objects (e.g., 616 and/or 2002) (e.g., one or more buttons, affordances, graphical user interface elements, user selectable icons, and/or regions of a user interface corresponding to respective controls for editing, adjusting, and/or modifying a visual appearance of the media item) corresponding to the respective editing control user interface object (e.g., 1403a-1403e). In some embodiments, the one or more control user interface objects corresponding to the respective editing control user interface object (e.g., 1403a-1403e) are displayed at a location (e.g., relative to the one or more display generation components) in which the audio control user interface object (e.g., 832, 832a, 832b, 1402, 1402a, 1402b, 1402c, 1408, 1408a, 1408b, and/or 1408c) was previously displayed (e.g., the one or more control user interface objects corresponding to the respective editing control user interface object replace display of the audio control user interface object). In some embodiments, the one or more control user interface objects corresponding to the respective editing control user interface object (e.g., 1403a-1403e) are displayed concurrently with a representation of the media item (e.g., 822a), and optionally, concurrently with the representation of the media item (e.g., 822a) while the media item is playing. Displaying one or more control user interface objects and ceasing display of the media editing user interface in response to user input selecting a respective editing control user interface object allows a user to navigate and/or transition to another editing control user interface without requiring the user to navigate away from the media editing user interface, thereby reducing the number of inputs needed to perform an operation.

In some embodiments, in response to detecting the one or more user inputs (e.g., 850s, 1450c, 1450d, 1450f, and/or 1450g) corresponding to the audio control user interface object (e.g., 832, 832a, 832b, 1402, 1402a, 1402b, 1402c, 1408, 1408a, 1408b, and/or 1408c), computer system (e.g., 100, 300, 500, and/or 600) reduces a visual prominence of (e.g., fading or ceasing to display) one or more user interface objects (e.g., 822d, 1404a-1404d, and/or 1403a-1403e) of the media editing user interface (e.g., 822, 830, and/or 1400) (e.g., displaying, via the one or more display generation components, a fading animation (e.g., gradually reducing a brightness, sharpness, opaqueness, and/or visibility of the one or more user interface objects of the media editing user interface) of one or more user interface objects (e.g., the audio control user interface object and/or one or more video editing control user interface objects) of the media editing user interface). Reducing a visual prominence of one or more user interface objects of the media editing user interface in response to detecting the one or more user inputs corresponding to the audio control user interface object provides confirmation to the user that the magnitude of the first audio mix effect is being adjusted, thereby providing improved visual feedback to the user.

In some embodiments, displaying the media editing user interface (e.g., 822, 830, and/or 1400) includes displaying one or more audio mix effect user interface objects (e.g., 1404a-1404d) (e.g., one or more buttons, affordances, graphical user interface elements, user selectable icons, and/or regions of the media editing user interface corresponding to respective audio mix effects) at a first position (e.g., a position shown at FIGS. 14B and 14D) (e.g., a first location of the one or more display generation components) relative to the audio control user interface object (e.g., 832, 832a, 832b, 1402, 1402a, 1402b, 1402c, 1408, 1408a, 1408b, and/or 1408c). In some embodiments, computer system (e.g., 100, 300, 500, and/or 600) detects, via the one or more input devices (e.g., 600a and/or 602) (e.g., such as one or more IMUs or accelerometers), a change in orientation (e.g., 1410) of the media editing user interface (e.g., 822, 830, and/or 1400); and in response to detecting the change in orientation (e.g., 1410) of the media editing user interface (e.g., 822, 830, and/or 1400) (e.g., based on a detected change in orientation of the computer system and/or based on one or more detected user inputs corresponding to a request to change the orientation of the media editing user interface), computer system (e.g., 100, 300, 500, and/or 600) displays, via the one or more display generation components (e.g., 602), the one or more audio mix effect user interface objects (e.g., 1404a-1404d) at a second position (e.g., a position shown at FIG. 14K) relative to the audio control user interface object (e.g., 832, 832a, 832b, 1402, 1402a, 1402b, 1402c, 1408, 1408a, 1408b, and/or 1408c) that is different from the first position relative to the audio control user interface object (e.g., 832, 832a, 832b, 1402, 1402a, 1402b, 1402c, 1408, 1408a, 1408b, and/or 1408c) (e.g., the one or more audio mix effect user interface objects are displayed further away from the adjustable control and/or on a different side of a representation of the media item when at the second position as compared to the first position). Displaying the one or more audio mix effect user interface objects at different positions relative to the audio control user interface object while the media editing user interface is displayed at different orientations automatically adjusts the position of the one or more audio mix effect user interface objects to fit the orientation of the media editing user interface without requiring additional user input, thereby performing an operation when a set of conditions has been met without requiring further user input and/or reducing a number of inputs needed to perform an operation.

In some embodiments, prior to the change in the orientation (e.g., 1410) of the media editing user interface (e.g., 822, 830, and/or 1400) (e.g., while displaying the one or more audio mix effect user interface objects at the first position relative to the audio control user interface object), computer system (e.g., 100, 300, 500, and/or 600) displays, via the one or more display generation components (e.g., 602), the media editing user interface (e.g., 822, 830, and/or 1400), wherein displaying the media editing user interface (e.g., 822, 830, and/or 1400) includes displaying a scrubber user interface object (e.g., 822d) (e.g., a selectable user interface object that includes a control such as a bar and/or trough having a control element such as a thumb and/or point on and/or within the bar and/or trough, where the control element is configured to move as playback of a video media item progresses and/or control element is configured to move from a first playback position to a second playback position in response to user input corresponding to the thumb and/or point) that has a first spatial orientation (e.g., an orientation shown at FIGS. 14B and 14D) relative to the audio control user interface object (e.g., 832, 832a, 832b, 1402, 1402a, 1402b, 1402c, 1408, 1408a, 1408b, and/or 1408c) (e.g., the scrubber is parallel to the audio control user interface object, for example, one or more visual elements, such as a bar and/or trough, of the scrubber user interface object and one or more visual elements, such as a bar and/or trough, of the audio control user interface object are displayed and/or extend parallel to one another); and in response to the change in the orientation (e.g., 1410) of the media editing user interface (e.g., 822, 830, and/or 1400), computer system (e.g., 100, 300, 500, and/or 600) displays, via the one or more display generation components (e.g., 602), the scrubber (e.g., 822d) with a second spatial orientation (e.g., an orientation shown at FIG. 14K), different from the first spatial orientation, relative to the audio control user interface object (e.g., 832, 832a, 832b, 1402, 1402a, 1402b, 1402c, 1408, 1408a, 1408b, and/or 1408c) (e.g., the scrubber is perpendicular to the audio control user interface object, for example one or more visual elements, such as a bar and/or trough, of the scrubber user interface object and one or more visual elements, such as a bar and/or trough, of the audio control user interface object are displayed and/or extend perpendicular to one another). Displaying the scrubber user interface object parallel to the audio control user interface object or perpendicular to the audio control user interface object based on an orientation of the media editing user interface automatically adjusts the position of the scrubber user interface object to fit the orientation of the orientation of the media editing user interface without requiring additional user input, thereby performing an operation when a set of conditions has been met without requiring further user input and/or reducing a number of inputs needed to perform an operation.

Note that details of the processes described above with respect to method 1600 (e.g., FIG. 16) are also applicable in an analogous manner to the methods described above/below. For example, methods 900, 1100, 1300, 1500, 1800, 1900, and/or 2100 optionally include one or more of the characteristics of the various methods described above with reference to method 1600. For example, the computer system of method 700 can be used to edit a media style of a media item that includes audio edited using the computer system of method 1600. For example, the computer system of method 900 can be used to further edit video media items that are edited using the computer system of method 1600. As another example, the computer system of method 1100 can be used to selectively apply edits made to a media item using the computer system of method 1600 from one media item to another media item. Further still, the computer system of method 1300 can be used to make additional edits to a media item edited using the computer system of method 1600. The computer system of method 1500 can be used to adjust and/or edit a playback speed of a media item edited using the computer system of method 1600. The computer system of method 1800 can be used to select media styles for a media item editing using the computer system of method 1600. The computer system of method 1900 can be used to select media items edited using the computer system of method 1600 to preview a media style. The computer system of method 2100 can be used to make additional edits to a media item edited using the computer system of method 1600. For brevity, these details are not repeated below.

FIGS. 17A-17AP illustrate exemplary user interfaces for managing media styles, in accordance with some embodiments. The user interfaces in these figures are used to illustrate the processes described below, including the processes in FIGS. 18 and 19.

In some embodiments, any of the inputs described herein (e.g., input 1750a, 1750b, 1750c, 1750d, 1750e, 1750f, 1750g, 1750h, 1750i, 1750j, 1750k, 1750l, 1750m, 1750n, 1750o, 1750p, 1750q, 1750r, 1750s, 1750t, 1750u, 1750v, 1750w, 1750x, 1750y, 1750z, 1750aa, 1750ab, 1750ac, 1750ad, 1750ae, 1750af, 1750ag, 1750ah, 1750ai, and/or 1750aj) is or includes a touch input (e.g., a tap gesture and/or a swipe gesture). In some embodiments, any of the inputs described herein (e.g., input 1750a, 1750b, 1750c, 1750d, 1750e, 1750f, 1750g, 1750h, 1750i, 1750j, 1750k, 1750l, 1750m, 1750n, 1750o, 1750p, 1750q, 1750r, 1750s, 1750t, 1750u, 1750v, 1750w, 1750x, 1750y, 1750z, 1750aa, 1750ab, 1750ac, 1750ad, 1750ae, 1750af, 1750ag, 1750ah, 1750ai, and/or 1750aj) is or includes a voice input (e.g., a voice command to select a user interface element or to activate a feature or perform a function, such as a feature or function associated with a user interface element). In some embodiments, any of the inputs described herein (e.g., input 1750a, 1750b, 1750c, 1750d, 1750e, 1750f, 1750g, 1750h, 1750i, 1750j, 1750k, 1750l, 1750m, 1750n, 1750o, 1750p, 1750q, 1750r, 1750s, 1750t, 1750u, 1750v, 1750w, 1750x, 1750y, 1750z, 1750aa, 1750ab, 1750ac, 1750ad, 1750ae, 1750af, 1750ag, 1750ah, 1750ai, and/or 1750aj) is or includes an air gesture (e.g., an air gesture to select a user interface element or to activate a feature or perform a function, such as a feature or function associated with a user interface element). In some embodiments, any of the inputs described herein (e.g., input 1750a, 1750b, 1750c, 1750d, 1750e, 1750f, 1750g, 1750h, 1750i, 1750j, 1750k, 1750l, 1750m, 1750n, 1750o, 1750p, 1750q, 1750r, 1750s, 1750t, 1750u, 1750v, 1750w, 1750x, 1750y, 1750z, 1750aa, 1750ab, 1750ac, 1750ad, 1750ae, 1750af, 1750ag, 1750ah, 1750ai, and/or 1750aj) is or includes activation (e.g., a press, a rotation, and/or a movement) of a hardware device (e.g., a button, a rotatable input mechanism, a rotatable and depressible input mechanism, a mouse, a mouse button, a trackpad, a trackpad button, a button of a remote control, and/or a joystick). In some embodiments, any of the inputs described herein (e.g., input 1750a, 1750b, 1750c, 1750d, 1750e, 1750f, 1750g, 1750h, 1750i, 1750j, 1750k, 1750l, 1750m, 1750n, 1750o, 1750p, 1750q, 1750r, 1750s, 1750t, 1750u, 1750v, 1750w, 1750x, 1750y, 1750z, 1750aa, 1750ab, 1750ac, 1750ad, 1750ae, 1750af, 1750ag, 1750ah, 1750ai, and/or 1750aj) as a touch and drag gesture includes an air gesture (e.g., an air gesture including a pinch and/or movement) and/or a click and drag gesture (e.g., a click of a mouse button and/or a trackpad and/or movement while holding a press of a mouse button and/or trackpad) of a mouse and/or trackpad. In some embodiments, any of the user interface elements described as being selected herein (e.g., an icon, affordance, button, and/or selectable option) is selected by activating a hardware device while the user interface element is in focus (e.g., highlighted, bolded, outlined, visually distinguished from other user interface elements, and/or located at or near a cursor).

At FIG. 17A, computer system 600 displays camera user interface 604, which includes display of settings region 606. At FIG. 17A, settings region 606 includes settings user interface objects 1700a-1700f corresponding to respective settings for capturing images and/or videos using the camera of computer system 600. In some embodiments, settings user interface objects 1700a-1700f correspond to the same settings as settings user interface objects 606a-606f shown at FIG. 6B. In some embodiments, one or more of settings user interface objects 1700a-1700f correspond to different settings as compared to settings user interface objects 606a-606f. At FIG. 17A, settings user interface object 1700c corresponds to a styles setting for images and/or videos captured using the camera of computer system 600. In some embodiments, a style of an image and/or video captured using the camera of computer system 600 includes computer system 600 applying different combinations of tone, saturation, color, color temperature, color palette, brightness, contrast, and/or warmth to images and/or videos that are being captured and/or have been captured using the camera of computer system 600.

In some embodiments, while computer system 600 displays camera user interface 604 and in response to selection of a respective style, computer system 600 is configured to apply the respective style to images and/or videos captured via the camera (e.g., in response to detecting user input corresponding to capture user interface object 604b and/or capture user interface object 1702a). As set forth below with reference to FIGS. 17J-17R, computer system 600 is also configured to apply a respective style to an image and/or video that has already been captured via the camera of computer system 600 and/or an image and/or video that is otherwise accessible to computer system 600 (e.g., stored in a media library of computer system 600 and/or accessible via a server).

At FIG. 17A, computer system 600 detects user input 1750a (e.g., a tap input and/or a touch input) corresponding to settings user interface object 1700c. In response to detecting user input 1750a, computer system 600 displays styles user interface 1702 of a camera application of computer system 600, as shown at FIG. 17B.

At FIG. 17B, styles user interface 1702 includes field of view representation 608a, capture user interface object 1702a, back user interface object 1702b, style selection indicators 1704a-1704e, and graphical representation 616. Field of view representation 608a includes a visual representation of an area surrounding computer system 600 and that is within a field of view of the camera of computer system 600. Computer system 600 is configured to initiate capturing an image and/or video that is within the field of view of the camera in response to detecting user input corresponding to capture user interface object 1702a. In some embodiments, computer system 600 displays (e.g., re-displays) camera user interface 604 in response to detecting user input corresponding to selection of back user interface object 1702b.

Style selection indicators 1704a-1704e correspond to respective styles that can be applied to images and/or videos captured via the camera of computer system 600 and/or to field of view representation 608a. For instance, style user interface object 1704c corresponds to a standard style that includes a first tone (e.g., a default tone), a first color (e.g., a default color and/or a default saturation), and/or a first color palette (e.g., a default color palette). At FIG. 17B, style selection indicator 1704c is currently selected, as indicated by style selection indicator 1704c having a different appearance than style selection indicators 1704a, 1704b, 1704d, and 1704e (e.g., a different shape and/or a different size) and/or by style selection indicator 1704c being displayed at a center position relative to field of view representation 608a. At FIG. 17B, styles user interface 1702 includes style indicator 1706 (e.g., “Standard”) indicating a name, description, and/or summary of the respective media style that is currently selected (e.g., the media style corresponding to style selection indicator 1704c). Styles user interface 1702 also includes first parameter indicator 1708a and second parameter indicator 1708b that provide visual indications of values corresponding to respective visual parameters for the selected media style.

As set forth below, styles corresponding to style selection indicators 1704a-1704e that are positioned and/or displayed on a first side (e.g., a left side) of style selection indicator 1704c correspond to media styles (e.g., photographic styles) of a first category (e.g., media styles of the first category that include adjustments to one or more visual parameters of a media item, as described below with reference to FIGS. 17AL-17AP). Styles corresponding to style selection indicators 1704a-1704e that are positioned and/or displayed on a second side (e.g., a right side and/or an opposite side of the first side) of style selection indicator 1704c correspond to media styles of a second category (e.g., media styles of the second category that include adjustments to one or more visual parameters of a media item, as described below with reference to FIGS. 17AL-17AP) that is different from the first category. In some embodiments, style selection indicator 1704c corresponds to a standard style that includes no adjustments to one or more visual parameters of a media item (e.g., absent user input requesting to adjust a respective visual parameter of the media item). In some embodiments, style selection indicator 1704c is selected by default when computer system 600 displays styles user interface 1702. In some embodiments, style selection indicator 1704c corresponds to a media style of a third category that is different from both the first category and the second category.

In some embodiments, the first category of media styles includes media styles that adjust respective values of one or more visual parameters of a respective media item by less than a threshold amount. In some embodiments, the second category of media styles includes media styles that adjust the respective values of the one or more visual parameters of a respective media item by more than a threshold amount. In some embodiments, the first category of media styles includes media styles that are subtler than media styles of the second category of media styles. In some embodiments, the first category of media styles includes media styles that shift a first amount of colors. In some embodiments, the second category of media styles includes media styles that shift a second amount of colors, where the second amount of colors includes more colors than the first amount of colors. In some embodiments, the magnitude and/or amount of shift of respective colors for media styles of the second category of media styles is greater and/or larger than the magnitude and/or amount of shift of respective colors applied by media styles of the first category of media styles. In some embodiments, a range of values corresponding to respective visual parameters for media styles of the first category of media styles are smaller (e.g., the range of values available for the media styles of the first category is less than the range of values available for media styles of the second category) than the range of values corresponding to respective visual parameters for media styles of the second category of media styles. In some embodiments, media styles of the first category are configured to be permanently set and/or used as a default style for capturing new media items. In some embodiments, media styles of the second category are not configured to be permanently set and/or used as a default style for capturing new media items. In some embodiments, media styles of the second category are only available for temporary use and/or media styles of the second category are selected each time a new media item is captured in order to apply the media style. In some embodiments, when a media style of the second category is applied to a new media item, computer system 600 reverts back to a default media style that is different from the media style of the second category after capturing the new media item. In some embodiments, media styles of the second category change an appearance of skin tones more than media styles of the first category. In some embodiments, media styles of the first category preserve an appearance of skin tones more than media styles of the second category.

Graphical representation 616 is a two dimensional grid and/or chart that is defined by first axis 616a and second axis 616b. As set forth below, first axis 616a represents values of tone and second axis 616b represents values of color (e.g., saturation). Graphical representation 616 also includes indicator 616c that represents a currently selected value of tone and color for the respective style. In other words, a position of indicator 616c relative to first axis 616a indicates a current value of tone and a position of indicator 616c relative to second axis 616b indicates a current value of color for the respective style. While the discussion of FIGS. 17A-17AP describes tone and color (e.g., saturation) as the parameters represented by graphical representation 616, in some embodiments, graphical representation 616 represents other parameters, such as color temperature, contrast, brightness, and/or warmth. As set forth below, computer system 600 is configured to modify a style and/or values of default parameters of a style in response to one or more user inputs corresponding to graphical representation 616.

At FIG. 17B, styles user interface 1702 includes graphical indicator 1702c that also provides a visual indication of the current values of the respective parameters controlled by graphical representation 616. For instance, at FIG. 17B, graphical indicator 1702c includes point 1702d that is displayed at a position within graphical indicator 1702c that is based on the position of indicator 616c relative to graphical representation 616. As set forth below, in some embodiments, computer system 600 updates graphical indicator 1702c and/or point 1702d based on user input corresponding to graphical representation 616. In some embodiments, computer system 600 moves and/or displays point 1702d at a location that is based on movement of indicator 616c caused by user input corresponding to graphical representation 616.

At FIG. 17B, style selection indicator 1704c is currently selected, and thus, computer system 600 is configured to apply the respective style corresponding to style selection indicator 1704c to an image and/or video that is captured via the camera of computer system 600. At FIG. 17B, computer system 600 applies the respective style to field of view representation 608a (e.g., display field of view representation 608a with a respective tone, color, and/or color palette corresponding to the selected style) so that the user of computer system 600 can preview the style and determine whether to apply the style to images and/or videos captured via the camera of computer system 600 (e.g., or to select a different style).

As set forth above, in some embodiments, the respective media style corresponding to style selection indicator 1704c includes a standard media style that includes no adjustments to one or more visual parameters of a media item and/or adjustments to the one or more visual parameters of the media item that are below a threshold amount. In some embodiments, computer system 600 displays graphical representation 616, which enables computer system 600 to change and/or adjust one or more visual parameters of the standard media style. However, computer system 600 forgoes display of a slider user interface object (e.g., 617) that enables computer system 600 to adjust a color palette of the standard media style. As set forth below with reference to FIG. 17D, computer system 600 displays slider user interface object (e.g. 617) when computer system 600 applies a media style of the first category and/or a media style of the second category.

At FIG. 17B, computer system 600 detects user input 1750b (e.g., a swipe input and/or a touch input) corresponding to styles user interface 1702. In response to detecting user input 1750b, computer system 600 initiates a process for transitioning from applying the respective style corresponding to style selection indicator 1704c to applying the respective style corresponding to style selection indicator 1704b, as shown at FIG. 17C. In some embodiments, computer system 600 detects user input 1750c (e.g., a swipe input and/or a touch input) corresponding to styles user interface 1702. In some embodiments, in response to detecting user input 1750c, computer system 600 initiates a process for transitioning from applying the respective style corresponding to style selection indicator 1704c to applying the respective style corresponding to style selection indicator 1704d. As set forth above, media styles that are to the left of style selection indicator 1704c correspond to media styles of a first category and media styles that are to the right of style selection indicator 1704c correspond to media styles of a second category. As such, computer system 600 is configured to transition from applying the style corresponding to style selection indicator 1704c to applying a style corresponding to the first category or the second category based on a direction of user input corresponding to styles user interface 1702 (e.g., while style selection indicator 1704c is currently selected).

At FIG. 17C, computer system 600 displays a frame 1710 of a transition animation of styles user interface 1702 in response to detecting user input 1750b (and, optionally, while continuing to detect user input 1750b). Frame 1710 of the transition animation includes field of view representation 608a, first style portion 1710a, and second style portion 1710b. First style portion 1710a includes computer system 600 applying the media style corresponding to style selection indicator 1704c to field of view representation 608a. Second style portion 1710b includes computer system 600 applying the media style corresponding to style selection indicator 1704b to field of view representation 608a. As shown at FIG. 17C, first style portion 1710a and second style portion 1710b are applied concurrently to field of view representation 608a (e.g., an image displayed in field of view representation 608a). Therefore, computer system 600 is configured to display a comparison between respective styles while transitioning between the respective styles.

At FIG. 17C, computer system 600 continues to display graphical representation 616, capture user interface object 1702a, and back user interface object 1702b while displaying frame 1710 (e.g., continues to display graphical representation 616, capture user interface object 1702a, and back user interface object 1702b at the same locations in styles user interface 1702 as shown at FIG. 17B). When the transition animation is completed (and, optionally, in response to detecting an end of user input 1750b), computer system 600 displays styles user interface 1702, as shown at FIG. 17D.

At FIG. 17D, computer system 600 displays styles user interface 1702 with a second media style applied to field of view representation 608a, where the second media style is different from the first media style applied at FIG. 17B (e.g., as represented by different hatching to field of view representation 608a). At FIG. 17D, computer system 600 displays style selection indicator 1704b with an appearance that is different from style selection indicators 1704a and 1704c-1704e to provide visual feedback that the currently applied style and/or currently selected style corresponds to style selection indicator 1704b. In addition, at FIG. 17D, computer system 600 displays style indicator 1706 (e.g., “Neutral”) indicating a name, description, and/or summary of the respective media style corresponding to style selection indicator 1704b. At FIG. 17D, the media style corresponding to style selection indicator 1704b is of the first category of style indicators, as indicated by category indicator 1711 (e.g., “CATEGORY 1”). In some embodiments, the first category of media styles includes changes to the one or more visual parameters of a respective media item and/or field of view representation 608a by an amount that is less than a threshold value. In some embodiments, media styles of the first category include more subtle changes and/or changes having a reduced intensity when compared to media styles of the second category.

At FIG. 17D, graphical representation 616 includes indicator 616c at a different location when compared to indicator 616c shown at FIG. 17B. In some embodiments, respective media styles include different default positions of indicator 616c relative to an area of graphical representation 616 and/or different default values for one or more visual parameters controlled by graphical representation 616. At FIG. 17D, computer system 600 updates graphical indicator 1702c so that point 1702d is at a position within graphical indicator 1702c that is based on the position of indicator 616c within graphical representation 616. Computer system 600 also displays styles user interface 1702 with updated values for first parameter indicator 1708a and second parameter indicator 1708b that correspond to the second media style. As set forth above, the respective values of first parameter indicator 1708a and second parameter indicator 1708b correspond to a location of indicator 616c within graphical representation 616.

At FIG. 17D, computer system 600 displays slider user interface object 617. As set forth below with reference to FIGS. 17E and 17F, computer system 600 is configured to adjust a color palette of a selected media style in response to detecting user input corresponding to slider user interface object 617. While displaying slider user interface object 617, computer system 600 displays third parameter indicator 1708c indicating a current position of slider user interface object 617. As set forth above, in some embodiments, computer system 600 forgoes displaying slider user interface object 617 when applying a standard media style because the standard media style does not include an adjustable color palette.

Computer system 600 is configured to adjust and/or change respective values of one or more visual parameters corresponding to a selected media style in response to user input corresponding to graphical representation 616. For instance, at FIG. 17D, computer system 600 detects user input 1750d (e.g., a swipe gesture and/or a touch and drag gesture) corresponding to graphical representation 616. In response to detecting user input 1750d, computer system 600 adjusts respective values of the one or more visual parameters for the selected media style, as shown at FIG. 17E.

At FIG. 17E, computer system 600 displays styles user interface 1702 with indicator 616c having an updated position within graphical representation 616 that is based on (e.g., a magnitude and/or a direction of) user input 1750d. In addition, FIG. 17E illustrates field of view representation 608a having a different hatching (e.g., as compared to FIG. 17D) to represent the change in the respective values of the one or more visual parameters caused by user input 1750d.

At FIG. 17D, user input 1750d includes a movement component that is substantially parallel to second axis 616b of graphical representation 616. Accordingly, at FIG. 17E, the position of indicator 616c moves in a direction that is parallel to second axis 616b, such that computer system 600 adjusts a value of a color parameter of the selected media style without changing a value of a tone parameter of the selected media style. For instance, movement of indicator 616c along second axis 616b causes computer system 600 to adjust the respective value of color for the selected media style (e.g., the media style corresponding to style selection indicator 1704b). Movement of indicator 616c along first axis 616a causes computer system 600 to adjust the respective value of tone for the selected media style. Because user input 1750d includes movement along second axis 616b, but does not include movement along first axis 616a, computer system 600 adjusts the value of color for the selected media style and does not adjust the value of tone for the selected media style. Thus, at FIG. 17E, computer system 600 updates second parameter indicator 1708b, but does not change the value of first parameter indicator 1708a when compared to FIG. 17D.

While FIGS. 17D and 17E illustrate computer system 600 adjusting color for the selected media style, in some embodiments, computer system 600 concurrently adjusts both tone and color for the selected media style in response to user input that includes movement in a first direction that is along first axis 616a and movement in a second direction that is along second axis 616b. At FIG. 17E, computer system 600 displays default indicator 616d corresponding to a default position and/or default values for the one or more visual parameters of the selected media style. Default indicator 616d is displayed within graphical representation 616 and provides the user with a visual indication of how interaction with graphical representation 616 changes an appearance of a respective media item and/or field of view representation 608a.

At FIG. 17E, computer system 600 detects user input 1750e (e.g., a swipe gesture, a touch gesture, a tap gesture, and/or a touch and drag gesture) corresponding to slider user interface object 617. In response to detecting user input 617, computer system 600 updates a color palette of the respective media style corresponding to style selection indicator 1704b, as shown at FIG. 17F.

At FIG. 17F, computer system 600 displays styles user interface 1700 with slider user interface object 617 having an updated position that is based on user input 1750e. For instance, a position of thumb 617a of slider user interface object 617 is at a different position at FIG. 17F when compared to the position of thumb 617a shown at FIG. 17E. Based on detecting user input 1750e, computer system 600 applies a change to a color palette of the selected media style, as indicated by updated hatching at FIG. 17F to field of view representation 608a and/or an updated value of third parameter indicator 1708c. As set forth below, computer system 600 shifts colors for a respective media style differently based on a category of the media style and/or an amount of adjustment to slider user interface object 617 (e.g., which is based on a magnitude and/or direction of user input 1750e). At FIG. 17F, computer system 600 maintains the values of the one or more visual parameters controlled by graphical representation 616 in response to detecting user input 1750e. In other words, computer system 600 forgoes changing and/or adjusting values of tone and/or color of a selected media style in response to detecting user input corresponding to slider user interface object 617. In some embodiments, computer system 600 adjusts and/or changes the respective values of tone and/or color based on user input corresponding to slider user interface object 617.

At FIG. 17F, computer system 600 detects user input 1750f (e.g., a swipe gesture, a tap gesture, a touch gesture, and/or a touch and drag gesture) corresponding to styles user interface 1702. In response to detecting user input 1750f, computer system 600 transitions between applying the media style corresponding to style selection indicator 1704b to applying (e.g., re-applying) the media style corresponding to style selection indicator 1704c, as shown at FIG. 17G.

At FIG. 17G, computer system 600 displays styles user interface 1702 and updates graphical representation 616 to represent the respective values for the media style corresponding to style selection indicator 1704c. For instance, at FIG. 17G, computer system 600 displays indicator 616c at a position within graphical representation 616 that corresponds to respective values of tone and color for the selected media style. In addition, at FIG. 17G, computer system 600 updates graphical indicator 1702c to reflect the change in the media style applied to field of view representation 608a. For instance, point 1702d is at a position within graphical indicator 1702c that is based on a position of indicator 616c within graphical representation 616.

At FIG. 17G, computer system 600 detects user input 1750g (e.g., a swipe gesture, a tap gesture, a touch gesture, and/or a touch and drag gesture) corresponding to styles user interface 1702. In response to detecting user input 1750g, computer system 600 transitions from applying the media style corresponding to style selection indicator 1704c to applying a media style corresponding to style selection indicator 1704d, as shown at FIG. 17H. In addition or in lieu of detecting user input 1750g, computer system 600 detects user input 1750h (e.g., a tap gesture or a touch gesture) corresponding to capture user interface object 1702a. In response to detecting user input 1750h, computer system 600 captures a media item that is within a field of view of a camera of computer system 600 (e.g., and represented by field of view representation 608a), as shown at FIG. 17J.

At FIG. 17H, computer system 600 displays style selection indicator 1704d with an appearance that is different from style selection indicators 1704a-1704c and 1704e to indicate that style selection indicator 1704d is currently selected. In addition, computer system 600 applies the media style corresponding to style selection indicator 1704d to filed field of view representation 608a, as indicated by the hatching of field of view representation 608a shown at FIG. 17H. At FIG. 17H, styles user interface 1702 includes style indicator 1706 (e.g., “Vibrant”) indicating a name, description, and/or summary of the respective media style that is currently selected. As set forth above, the media style corresponding to media style indicator 1704d is of the second category of media styles (e.g., because media style indicator 1704d is positioned to the right of media style indicator 1704c). Styles user interface 1702 also includes category indicator 1711, which includes an indication that the media style corresponding to style selection indicator 1704d is of the second category of media styles. In some embodiments, the second category of media styles includes changes to the one or more visual parameters of a respective media item and/or field of view representation 608a by an amount that is greater than a threshold value. In some embodiments, media styles of the second category include more drastic changes and/or changes having a greater intensity when compared to media styles of the first category.

At FIG. 17H, computer system 600 displays graphical representation 616 with indicator 616c at an updated position within an area of graphical representation 616 (e.g., a different position relative to first axis 616a and second axis 616b) when compared to indicator 616c shown at FIGS. 17B-17G. Computer system 600 also updates graphical indicator 1702c so that point 1702d is at a position within graphical indicator 1702c that is based on the position of indicator 616c within graphical representation 616. In some embodiments, the respective positions of indicator 616c and point 1702d correspond to default values for the currently selected media style. As set forth above, computer system 600 is configured to adjust the default values of the currently selected media style in response to detecting input corresponding to graphical representation 616 and/or slider user interface object 617. Further, computer system 600 displays first parameter indicator 1708a, second parameter indicator 1708b, and third parameter indicator 1708c with updated values corresponding to the selected media style.

At FIG. 17H, computer system 600 detects user input 1750i (e.g., a swipe gesture, a tap gesture, a touch gesture, and/or a touch and drag gesture) corresponding to styles user interface 1702. In response to detecting user input 1750i, computer system 600 transitions from applying the media style corresponding to style selection indicator 1704d to applying a media style corresponding to style selection indicator 1704e, as shown at FIG. 17I.

At FIG. 17I, computer system 600 displays style selection indicator 1704e with an appearance that is different from style selection indicators 1704a-1704d to indicate that style selection indicator 1704e is currently selected. In addition, computer system 600 applies the media style corresponding to style selection indicator 1704e to field of view representation 608a, as indicated by the hatching of field of view representation 608a shown at FIG. 17I. At FIG. 17I, styles user interface 1702 includes style indicator 1706 (e.g., “Luminous”) indicating a name, description, and/or summary of the respective media style that is currently selected. As set forth above, the media style corresponding to media style indicator 1704e is of the second category of media styles (e.g., because media style indicator 1704e is positioned to the right of media style indicator 1704c). Styles user interface 1702 also includes category indicator 1711, which includes an indication that the media style corresponding to style selection indicator 1704d is of the second category of media styles. In some embodiments, the second category of media styles includes changes to the one or more visual parameters of a respective media item and/or field of view representation 608a by an amount that is greater than a threshold value. In some embodiments, media styles of the second category include more drastic changes and/or changes having a greater intensity when compared to media styles of the first category.

At FIG. 17I, computer system 600 displays graphical representation 616 with indicator 616c at an updated position within an area of graphical representation 616 (e.g., a different position relative to first axis 616a and second axis 616b) when compared to indicator 616c shown at FIG. 17H. Computer system 600 also updates graphical indicator 1702c so that point 1702d is at a position within graphical indicator 1702c that is based on the position of indicator 616c within graphical representation 616. In some embodiments, the respective positions of indicator 616c and point 1702d correspond to default values for the currently selected media style. As set forth above, computer system 600 is configured to adjust the default values of the currently selected media style in response to detecting input corresponding to graphical representation 616 and/or slider user interface object 617. Further, computer system 600 displays first parameter indicator 1708a, second parameter indicator 1708b, and third parameter indicator 1708c with updated values corresponding to the selected media style.

At FIG. 17I, computer system 600 detects user input 1750j (e.g., a swipe gesture and/or a tap gesture) corresponding to a request to display a user interface of a photos application of computer system 600 (e.g., a request to transition from displaying styles user interface 1702 of a camera application to displaying editing user interface 1714 of a photos application). In response to detecting user input 1750j, computer system 600 displays editing user interface 1714 of a photos application of computer system 600, as shown at FIG. 17J.

At FIG. 17J, editing user interface 1714 corresponds to a user interface for editing a style of a media item of media item representation 1716, which corresponds to a media item captured by computer system 600 in response to detecting user input 1750h. In some embodiments, the media item corresponding to photo representation 1716 is stored in a media library associated with an account of the user and accessible via the photos application of computer system 600. At FIG. 17J, computer system 600 displays editing user interface 1714 with style indicators 1718a-1718g, which correspond to respective styles that can be applied to the media item of photo representation 1716 by computer system 600. In some embodiments, style indicators 1718a-1718g correspond to the same styles as style selection indicators 1704a-1704e of styles user interface 1702. Thus, in some embodiments, computer system 600 provides the user of computer system 600 with the same styles that are available via and/or have been customized and/or edited by the user in styles user interface 1702.

Style indicators 1718a-1718g correspond to respective styles that can be applied to images and/or videos (e.g., media items) of a media library of computer system 600. For instance, style indicator 1718d corresponds to a standard style that includes a first tone (e.g., a default tone), a first color (e.g., a default color and/or a default saturation), and/or a first color palette (e.g., a default color palette). Style indicator 1718d is displayed with frame 1719 to indicate that style indicator 1718d corresponds to the standard style and/or a default style. At FIG. 17J, style indicator 1718d is currently selected, as indicated by style selection indicator 1718d being displayed at a center position relative to media item representation 1716. At FIG. 17J, editing user interface 1714 includes style indicator 1720 (e.g., “Standard”) indicating a name, description, and/or summary of the respective media style that is currently selected. Editing user interface 1714 also includes style user interface object 627a, live user interface object 627b, adjust user interface object 627c, crop user interface object 627d, and cleanup user interface object 627e, which correspond to respective editing user interfaces for adjusting visual parameters of a respective media item.

Styles corresponding to style indicators 1718a-1718g that are positioned and/or displayed on a first side (e.g., a left side) of style indicator 1718d correspond to media styles (e.g., photographic styles) of the first category. Styles corresponding to style indicators 1718a-1718g that are positioned and/or displayed on a second side (e.g., a right side and/or an opposite side of the first side) of style indicator 1718d correspond to media styles of the second category that is different from the first category. In some embodiments, style indicator 1718d corresponds to a standard style that includes no adjustments to one or more visual parameters of a media item and/or adjustments to the one or more visual parameters of the media item that are less than a threshold amount. In some embodiments, style indicator 1718d is selected by default when computer system 600 displays editing user interface 1714. In some embodiments, style indicator 1718d corresponds to a media style of a third category that is different from both the first category and the second category.

At FIG. 17J, style indicators 1718a-1718g include thumbnails of media item representation 1716 having respective appearances corresponding to the style of style indicators 1718a-1718g. In addition, at FIG. 17J, the currently selected style indicator (e.g., style indicator 1718d) includes graphical representation 612 of the respective style corresponding to style indicator 1718d. Graphical representation 612 is a two dimensional grid and/or chart that is defined by first axis 612a and second axis 612b. Similar to graphical representation 616, first axis 612a represents values of tone and second axis 612b represents values of color for the respective style. Graphical representation 612 also includes indicator 612c that represents a currently selected value of tone and color for the respective style. In other words, a position of indicator 612c relative to first axis 612a indicates a current value of tone and a position of indicator 612c relative to second axis 612b indicates a current value of color for the respective style. While the discussion of FIGS. 17J-17R describes tone and color as the parameters represented by graphical representation 612, in some embodiments, graphical representation 612 represents other parameters, such as color temperature, contrast, brightness, and/or warmth.

At FIG. 17J, computer system 600 displays graphical representation 612 for style indicator 1718d, but does not display a graphical representation for style indicators 1718a-1718c and 1718e-1718g. In some embodiments, computer system 600 displays graphical representation 612 for the currently selected style indicator 1718a-1718g, but does not display graphical representation 612 for unselected style indicators 1718a-1718g. In some embodiments, computer system 600 displays graphical representation 612 for each of style indicators 1718a-1718g, where graphical representation 612 is different for each of style indicators 1718a-1718g (e.g., indicator 612c is displayed at different locations for each of style indicators 1718a-1718g). In some embodiments, the styles corresponding to style user indicators 1718a-1718g are defined by computer system 600 (e.g., the styles are pre-set and/or default styles of computer system 600). In some embodiments, the styles corresponding to style indicators 1718a-1718g are user defined. In some embodiments, the styles corresponding to style user indicators 1718a-1718g include a combination of styles defined by computer system 600 and user-defined styles. As set forth below, computer system 600 is configured to modify a style corresponding to a respective style indicator 1718a-1718g in response to one or more user inputs.

At FIG. 17J, style indicator 1718d is currently selected, and thus, computer system 600 applies the respective style to media item representation 1716 so that the user of computer system 600 can preview the style and determine whether to apply the style media item representation 1716 (e.g., or to select a different style).

At FIG. 17J, computer system 600 detects user input 1750k (e.g., a swipe input and/or a touch input) corresponding to editing user interface 1714 (e.g., style indicators 1718a-1718g). In response to detecting user input 1750k, computer system 600 initiates a process for transitioning from applying the respective style corresponding to style indicator 1718d to applying the respective style corresponding to style indicator 1718e, as shown at FIG. 17K. In some embodiments, computer system 600 detects user input 1750l (e.g., a swipe input and/or a touch input) corresponding to editing user interface 1714 (e.g., style indicators 1718a-1718g). In some embodiments, in response to detecting user input 1750l, computer system 600 initiates a process for transitioning from applying the respective style corresponding to style indicator 1718d to applying the respective style corresponding to style indicator 1718c. As set forth above, media styles that are to the left of style indicator 1718d correspond to media styles of a first category and media styles that are to the right of style indicator 1718d correspond to media styles of a second category. As such, computer system 600 is configured to transition from applying the style corresponding to style indicator 1718d to applying a style corresponding to the first category or the second category based on a direction of user input corresponding to editing user interface 1714 (e.g., while style indicator 1718d is currently selected).

At FIG. 17K, computer system 600 displays media item representation 1716 with an appearance that is different from the appearance of media item representation 1716 shown at FIG. 17J. For instance, at FIG. 17K, computer system 600 displays media item representation 1716 with hatching, whereas computer system 600 displayed media item representation 1716 with no hatching at FIG. 17J. At FIG. 17K, computer system 600 displays style indicator 1718e at the center position (e.g., the position of style indicator 1718d shown at FIG. 17J) indicating that the media style corresponding to style indicator 1718e is currently selected and applied to media item representation 1716. In addition, at FIG. 17K, computer system 600 displays style indicator 1720 (e.g., “Vibrant”) indicating a name, description, and/or summary of the respective media style corresponding to style indicator 1718e. At FIG. 17K, the media style corresponding to style indicator 1718e is of the second category of styles, as indicated by category indicator 1722 (e.g., “CATEGORY 2”). In some embodiments, the second category of media styles includes changes to the one or more visual parameters of a respective media item and/or field of view representation 608a by an amount that is greater than or equal to a threshold value. In some embodiments, media styles of the second category include more drastic changes and/or changes having a greater intensity when compared to media styles of the first category.

At FIG. 17K, graphical representation 612 includes indicator 612c at a different location when compared to indicator 612c shown at FIG. 17J. In some embodiments, respective media styles include different default positions of indicator 612c relative to an area of graphical representation 612. At FIG. 17K, computer system detects user input 1750m (e.g., a tap gesture and/or a touch gesture) corresponding to style indicator 1718e. In response to detecting user input 1750m, computer system 600 displays style editing user interface 1724, as shown at FIG. 17L.

At FIG. 17L, computer system 600 displays style editing user interface 1724, which includes graphical representation 616, style selection indicators 1704a-1704e, style indicator 1706, first parameter indicator 1708a, second parameter indicator 1708b, third parameter indicator 1708c, category indicator 1722, and slider user interface object 617. Therefore, in some embodiments, style editing user interface 1724 of the photos application of computer system 600 includes similar visual elements and/or the same visual elements as styles user interface 1702 of the camera application of computer system 600.

At FIG. 17L, computer system 600 displays media item representation 1716 with hatching indicating that the media style corresponding to style indicator 1718e is applied to media item representation 1716. At FIG. 17L, computer system 600 displays style selection indicator 1704d with a different appearance from style selection indicators 1704a-1704c and 1704e (e.g., a different shape and/or size) indicating that the style corresponding to style indicator 1718e and/or style selection indicator 1704d is currently applied to media item representation 1716. In addition, at FIG. 17L, computer system 600 displays style indicator 1720 (e.g., “Vibrant”) indicating a name, description, and/or summary of the respective media style corresponding to style indicator 1718e and/or style selection indicator 1704d. At FIG. 17L, the media style corresponding to style indicator 1718e and/or style selection indicator 1704d is of the second category of styles, as indicated by category indicator 1722 (e.g., “CATEGORY 2”).

At FIG. 17L, graphical representation 616 includes indicator 616c at a location that corresponds to current values of one or more visual parameters of the respective style. In some embodiments, respective media styles include different default positions of indicator 616c relative to an area of graphical representation 616.

At FIG. 17L, computer system 600 displays slider user interface object 617. As set forth below with reference to FIGS. 17M and 17N, computer system 600 adjusts a color palette of a selected media style in response to detecting user input corresponding to slider user interface object 617. In some embodiments, computer system 600 forgoes displaying slider user interface object 617 when applying a standard media style and/or when style indicator 1718d is currently selected because a color palette of the standard media style is not adjustable.

Computer system 600 is configured to adjust and/or change respective values of one or more visual parameters corresponding to a selected media style in response to user input corresponding to graphical representation 616. For instance, at FIG. 17L, computer system 600 detects user input 1750n (e.g., a swipe gesture and/or a touch and drag gesture) corresponding to graphical representation 616. In response to detecting user input 1750n, computer system 600 adjusts respective values of the one or more visual parameters for the selected media style, as shown at FIG. 17M.

At FIG. 17M, computer system 600 displays styles editing user interface 1724 with indicator 616c having an updated position within graphical representation 616 that is based on (e.g., a magnitude and/or a direction of) user input 1750n. In addition, FIG. 17M illustrates media item representation 1716 having a different hatching when compared to FIG. 17L to represent the change in the respective values of the one or more visual parameters based on user input 1750n.

At FIG. 17L, user input 1750n includes a movement component that is substantially parallel to second axis 616b of graphical representation 616. Accordingly, at FIG. 17M, the position of indicator 616c moves in a direction that is parallel to second axis 616b, such that computer system 600 adjusts a value of a color parameter of the selected media style without changing a value of a tone parameter of the selected media style. For instance, movement of indicator 616c along second axis 616b causes computer system 600 to adjust the respective value of color for the selected media style (e.g., the media style corresponding to style selection indicator 1704d). Movement of indicator 616c along first axis 616a causes computer system 600 to adjust the respective value of tone for the selected media style. Because user input 1750n includes movement along second axis 616b, but does not include movement along first axis 616a, computer system 600 adjusts the value of color for the selected media style and does not adjust the value of tone for the selected media style. Thus, at FIG. 17M, computer system 600 updates second parameter indicator 1708b, but does not change the value of first parameter indicator 1708a when compared to FIG. 17L.

While FIGS. 17L and 17M illustrate computer system 600 adjusting color for the selected media style, in some embodiments, computer system 600 concurrently adjusts both tone and color for the selected media style in response to user input that includes movement in a first direction that is along first axis 616a and movement in a second direction that is along second axis 616b. At FIG. 17M, computer system 600 displays default indicator 616d corresponding to a default position and/or default values for the one or more visual parameters of the selected media style. Default indicator 616d is displayed within graphical representation 616 and provides the user with a visual indication of how interaction with graphical representation 616 changes an appearance of media item representation 1716.

At FIG. 17M, computer system 600 detects user input 1750o (e.g., a swipe gesture, a touch gesture, a tap gesture, and/or a touch and drag gesture) corresponding to slider user interface object 617. In response to detecting user input 617, computer system 600 updates a color palette of the respective media style corresponding to style selection indicator 1704d, as shown at FIG. 17N.

At FIG. 17N, computer system 600 displays styles editing user interface 1724 with slider user interface object 617 having an updated position that is based on user input 1750o. For instance, a position of thumb 617a of slider user interface object 617 is at a different position at FIG. 17N when compared to the position of thumb 617a shown at FIG. 17M. Based on detecting user input 1750o, computer system 600 applies a change to a color palette of the selected media style, as indicated by updated hatching at FIG. 17N and/or an updated value indicated by third parameter indicator 1708c. As set forth below, computer system 600 shifts colors for a respective media style differently based on a category of the media style and/or an amount of adjustment to slider user interface object 617 (e.g., which is based on a magnitude and/or direction of user input 1750o). At FIG. 17N, computer system 600 maintains the values of the one or more visual parameters controlled by graphical representation 616 in response to detecting user input 1750o. In other words, computer system 600 forgoes changing and/or adjusting values of tone and/or color of a selected media style in response to detecting user input corresponding to slider user interface object 617. In some embodiments, computer system 600 adjusts and/or changes the respective values of tone and/or color based on user input corresponding to slider user interface object 617.

At FIG. 17N, computer system 600 detects user input 1750p (e.g., a tap gesture and/or a touch gesture) corresponding to exit user interface object 1724a of styles editing user interface 1724. In response to detecting user input 1750p, computer system 600 displays editing user interface 1714, as shown at FIG. 17O.

At FIG. 17O, editing user interface 1714 includes media item representation 1716 with the same appearance as FIG. 17N, thereby indicating that computer system 600 applied and/or saved the changes to the respective style (e.g., the style corresponding to style indicator 1718e and/or style selection indicator 1704d). In addition, at FIG. 17O, computer system 600 updates graphical representation 612 so that indicator 612c is at a position within graphical representation 612 that corresponds to the position of indicator 616c of graphical representation 616 shown at FIG. 17N. As such, computer system 600 provides further visual confirmation to the user of computer system 600 that adjustments were made to the style corresponding to style indicator 1718e.

At FIG. 17O, computer system 600 detects user input 1750q (e.g., a swipe gesture, a tap gesture, a touch gesture, and/or a touch and drag gesture) corresponding to editing user interface 1714. In response to detecting user input 1750q, computer system 600 transitions between applying the media style corresponding to style indicator 1718e to applying (e.g., re-applying) the media style corresponding to style indicator 1718d, as shown at FIG. 17P.

At FIG. 17P, computer system 600 displays editing user interface 1714 and updates an appearance of media item representation 1716 based on the respective style corresponding to style indicator 1718d. In addition, computer system 600 displays graphical representation 612 to represent the respective values for the media style corresponding to style indicator 1718d. For instance, at FIG. 17P, computer system 600 displays indicator 612c at a position within graphical representation 612 that corresponds to respective values of tone and color for the selected media style.

At FIG. 17P, computer system 600 detects user input 1750r (e.g., a swipe gesture, a tap gesture, a touch gesture, and/or a touch and drag gesture) corresponding to editing user interface 1714 (e.g., style indicators 1718a-1718g). In response to detecting user input 1750r, computer system 600 transitions from applying the media style corresponding to style indicator 1718d to applying a media style corresponding to style indicator 1718c, as shown at FIG. 17Q.

At FIG. 17Q, computer system 600 displays style indicator 1718c at a center position relative to media item representation 1716 to indicate that style indicator 1718c is currently selected. Computer system 600 also displays style indicator 1718c with graphical representation 612 that includes indicator 612c at a respective location within graphical representation 612 that indicates the current values of one or more visual parameters of the media style corresponding to style indicator 1718c. For instance, the position of indicator 612c at FIG. 17Q is at a different location within graphical representation 612 when compared to the position of indicator 612c within graphical representation 612 shown at FIG. 17P. In some embodiments, computer system 600 is configured to display styles editing user interface 1724 in response to detecting user input corresponding to style indicator 1718c. As set forth above, styles editing user interface 1724 allows the user of computer system 600 to adjust the default values of the currently selected media style based on input corresponding to graphical representation 616 and/or slider user interface object 617.

At FIG. 17Q, computer system 600 applies the media style corresponding to style indicator 1718c to media item representation 1716, as indicated by the hatching of media item representation 1716 shown at FIG. 17Q. At FIG. 17Q, editing user interface 1714 includes style indicator 1720 (e.g., “Neutral”) indicating a name, description, and/or summary of the respective media style that is currently selected. As set forth above, the media style corresponding to media style indicator 1718c is of the first category of media styles (e.g., because style indicator 1718c is positioned to the left of style indicator 1718d). Editing user interface 1714 also includes category indicator 1722, which includes an indication that the media style corresponding to style indicator 1718c is of the first category of media styles. In some embodiments, the first category of media styles includes changes to the one or more visual parameters of a respective media item and/or field of view representation 608a by an amount that is less than a threshold value. In some embodiments, media styles of the first category include more subtle changes and/or changes having a reduced intensity when compared to media styles of the second category.

At FIG. 17Q, computer system 600 detects user input 1750s (e.g., a swipe gesture, a tap gesture, a touch gesture, and/or a touch and drag gesture) corresponding to editing user interface 1714 (e.g., style indicators 1718a-1718g). In response to detecting user input 1750s, computer system 600 transitions from applying the media style corresponding to style indicator 1718c to applying a media style corresponding to style selection indicator 1718b, as shown at FIG. 17R.

At FIG. 17R, computer system 600 displays style indicator 1718b at a center position relative to media item representation 1716 to indicate that style indicator 1718b is currently selected. Computer system 600 also displays style indicator 1718b with graphical representation 612 that includes indicator 612c at a respective location within graphical representation 612 indicating the current values of one or more visual parameters of the media style corresponding to style indicator 1718b. For instance, the position of indicator 612c at FIG. 17R is at a different location within graphical representation 612 when compared to the position of indicator 612c within graphical representation 612 shown at FIG. 17Q. In some embodiments, computer system 600 is configured to display styles editing user interface 1724 in response to detecting user input corresponding to style indicator 1718b. As set forth above, styles editing user interface 1724 allows the user of computer system 600 to adjust the default values of the currently selected media style based on input corresponding to graphical representation 616 and/or slider user interface object 617.

At FIG. 17R, computer system 600 applies the media style corresponding to style indicator 1718b to media item representation 1716, as indicated by the hatching of media item representation 1716 shown at FIG. 17R. At FIG. 17R, editing user interface 1714 includes style indicator 1720 (e.g., “Amber”) indicating a name, description, and/or summary of the respective media style that is currently selected. As set forth above, the media style corresponding to media style indicator 1718b is of the first category of media styles (e.g., because style indicator 1718b is positioned to the left of style indicator 1718d). Editing user interface 1714 also includes category indicator 1722, which includes an indication that the media style corresponding to style indicator 1718b is of the first category of media styles. In some embodiments, the first category of media styles includes changes to the one or more visual parameters of a respective media item and/or field of view representation 608a by an amount that is less than a threshold value. In some embodiments, media styles of the first category include more subtle changes and/or changes having a reduced intensity when compared to media styles of the second category.

Turning now to FIG. 17S, computer system 600 displays settings user interface 1726, which includes one or more selectable options corresponding to respective settings of computer system 600. At FIG. 17S, settings user interface 1726 includes camera style user interface object 1726a corresponding to a media style that is configured to be applied to media items captured via a camera of computer system 600. In other words, camera style user interface object 1726a allows a user to select a respective media style that computer system 600 applies to captured media items as a default media style (e.g., without requiring user input requesting to select and/or apply the respective media style). At FIG. 17S, camera style user interface object 1726a includes indicator 1726b indicating that a standard media style is currently applied to media items captured by computer system 600.

At FIG. 17S, computer system 600 detects user input 1750t (e.g., a tap gesture and/or a touch gesture) corresponding to camera style user interface object 1726a. In response to detecting user input 1750t, computer system 600 displays style setup user interface 1728, as shown at FIG. 17T. In some embodiments, computer system 600 displays style setup user interface 1728 as part of a setup process of computer system 600. In some embodiments, computer system 600 displays style setup user interface 1728 without detecting user input corresponding to camera style user interface object 1726a.

At FIG. 17T, style setup user interface 1728 includes prompt 1728a that provides an introduction and/or guidance to the user of computer system 600 about selecting and/or setting a default style for capturing media items via computer system 600. For instance, at FIG. 17T, prompt 1728a includes the text “First select four of your favorite photos shot on phone,” which indicates that the user of computer system 600 is to select multiple (e.g., two, four, or nine) photos that were captured via computer system 600 and/or are included in a media library corresponding to an account of the user. At FIG. 17T, computer system 600 detects user input 1750u (e.g., a tap gesture and/or a touch gesture) corresponding to start user interface object 1728b. In response to detecting user input 1750u, computer system 600 displays media item user interface 1730, as shown at FIG. 17U.

At FIG. 17U, media item user interface 1730 includes prompt 1730a, photos option 1730b, albums option 1730c, search bar 1730d, and media items 1732a-1732o. Prompt 1730a includes the text “Select 4 photos,” which prompts the user to select four media items for previewing a respective media style. While prompt 1730a includes the text that guides the user to select four media items, in some embodiments, prompt 1730a includes text that prompts the user of computer system 600 to select a different number of media items (e.g., two media items, four media items, or nine media items).

In some embodiments, computer system 600 displays all media items of a media library corresponding to an account of the user of computer system 600 in response to detecting user input corresponding to photos option 1730b. In some embodiments, computer system 600 displays photo media items of the media library corresponding to the account of the user of computer system 600 that satisfy a set of criteria in response to detecting user input corresponding to photos option 1730b. For instance, in some embodiments, computer system 600 is configured to apply media styles to media items that satisfy the set of criteria, but computer system 600 is not configured to apply media styles to media items that do not satisfy the set of criteria. In some embodiments, the set of criteria include a first criterion that is met when a respective media item is captured via a respective type of camera. In some embodiments, the set of criteria include a second criterion that is met when a respective media item includes and/or is associated with a respective type of data, such as metadata.

In some embodiments, computer system 600 displays album options of the media library corresponding to the account of the user of computer system 600 in response to detecting user input corresponding to albums option 1730c. In some embodiments, computer system 600 displays album options of the media library that include at least one media item that satisfies the set of criteria. In some embodiments, computer system 600 displays all albums options of the media library regardless of whether a respective album includes a media item that satisfies the set of criteria. In some embodiments, computer system 600 displays album options with different appearances based on whether a respective album includes at least one media item that satisfies the set of criteria.

In some embodiments, computer system 600 is configured to filter media items 1732a-1732o in response to detecting one or more user inputs corresponding to search bar 1730d. For instance, in some embodiments, computer system 600 receives one or more inputs corresponding to search bar 1730d requesting to filter media items 1732a-1732o based on a second set of criteria (e.g., media items from a respective time range, media items including respective people, media items captured at a respective location, and/or media items including a respective object). In some embodiments, computer system 600 displays media items that satisfy the set of criteria and the second set of criteria in response to detecting the one or more user inputs corresponding to search bar 1730d.

At FIG. 17U, media items 1732a-1732o are displayed in media item user interface 1730. As set forth above, in some embodiments, computer system 600 filters media items of a media library corresponding to the account of the user of computer system 600 based on a set of criteria. In some embodiments, media items 1732a-1732o satisfy the set of criteria. In some embodiments, computer system 600 does not display media items of the media library corresponding to the account of the user that do not satisfy the set of criteria in media item user interface 1730. For instance, in some embodiments, computer system 600 only displays media items of the media library corresponding to the user that satisfy the set of criteria in media item user interface 1730.

At FIG. 17U, media item user interface 1730 includes 15 different media items (e.g., media items 1732a-1732o). In some embodiments, computer system 600 is configured to display additional media items in media item user interface 1730 (e.g., additional media items that satisfy the set of criteria) in response to detecting user input. For instance, at FIG. 17U, computer system 600 detects user input 1750v (e.g., a swipe gesture) corresponding to media item user interface 1730. In some embodiments, computer system 600 scrolls, translates, and/or moves media items 1732a-1732o in response to detecting user input 1750v, such that computer system 600 displays additional media items from the media library corresponding to the user and/or additional media items that satisfy the set of criteria. In some embodiments, computer system 600 moves one or more of media items 1732a-1732o outside of a display area of display 602 in response to detecting user input 1750v, such that one or more of media items 1732a-1732o cease to be displayed.

At FIG. 17U, computer system 600 detects user inputs 1750w (e.g., tap gestures and/or touch gestures) corresponding to media items 1732b, 1732e, 1732f, and 1732g. In response to detecting user inputs 1750w, computer system 600 displays media items user interface 1730, as shown at FIG. 17V.

At FIG. 17V, computer system 600 displays selection indicators 1734 and/or outlines (e.g., bold outlines) on media items 1732b, 1732e, 1732f, and 1732g to indicate that media items 1732b, 1732e, 1732f, and 1732g are currently selected. Selection indicators 1734 also provide visual confirmation to the user of computer system 600 that user inputs 1750w were received. In some embodiments, computer system 600 removes and/or ceases display of a respective selection indicator 1734 in response to detecting user input corresponding to another media item 1732a-1732o (e.g., while four selection indicators 1734 are currently displayed). For instance, in some embodiments, computer system 600 displays four selection indicators 1734 corresponding to four selected media items 1732a-1732o. In some embodiments, computer system 600 does not display more than four selection indicators 1734. In some embodiments, computer system 600 displays up to the same number of selection indicators 1734 as a number of media items indicated by prompt 1730a.

At FIG. 17V, computer system 600 detects user input 1750x (e.g., a tap gesture and/or a touch gesture) corresponding to continue user interface object 1730e of media item user interface 1730. In response to detecting user input 1750x, computer system 600 displays introduction user interface 1736, as shown at FIG. 17W.

At FIG. 17W, introduction user interface 1736 includes media items 1732b and 1732e-1732g arranged in a grid. Computer system 600 displays media items 1732b and 1732e-1732g in the grid to enable a user to concurrently preview and view respective styles as applied to multiple different media items. Introduction user interface 1736 includes prompt 1736a that provides guidance about to how to select, modify, and/or preview different media styles. Introduction user interface 1736 also includes style indicators 1738a-1738i corresponding to respective media styles that are configured to be set as a default style for computer system 600.

At FIG. 17W, computer system 600 detects user input 1750y (e.g., a swipe gesture, a tap gesture, a touch gesture, and/or a touch and drag gesture) corresponding to introduction user interface 1736. In response to detecting user input 1750y, computer system 600 displays style selection user interface 1740, as shown at FIG. 17X.

At FIG. 17X, style selection user interface 1740 includes media items 1732b and 1732e-1732g arranged in the grid, as well as style indicators 1738a-1738i. At FIG. 17X, style indicator 1738a is currently selected, as indicated by style indicator 1738a having a different appearance from style indicators 1738b-1738i (e.g., a different size and/or a different shape). Style selection user interface 1740 includes selected style indicator 1740a (e.g., “Standard”), selected style description 1740b, and continue user interface object 1740c. At FIG. 17X, style indicator 1738a corresponds to a standard media style. In some embodiments, the standard media style does not include adjustments to one or more visual parameters of a respective media item. In some embodiments, the standard media style includes adjustments to one or more visual parameters of a respective media item by less than a threshold amount.

At FIG. 17X, computer system 600 displays media items 1732b and 1732e-1732g with a first appearance that is based on the respective media style corresponding to style indicator 1738a. For instance, at FIG. 17X, media items 1732b and 1732e-1732g do not include hatching. At FIG. 17X, computer system 600 detects user input 1750z (e.g., a swipe gesture, a tap gesture, a touch gesture, and/or a touch and drag gesture) corresponding to style selection user interface 1740. In response to detecting user input 1750z, computer system 600 transitions from applying the media style corresponding to style indicator 1738a to applying the media style corresponding to style indicator 1738b, as shown at FIG. 17Y. As such, user input 1750z corresponds to a request to change the media style and/or preview another media style.

At FIG. 17Y, computer system 600 displays style selection user interface 1740 that includes media items 1732b and 1732e-1732g with a second appearance that is based on the media style corresponding to style indicator 1738b. At FIG. 17Y, media items 1732b and 1732e-1732g include first hatching to represent the change in appearance that is based on computer system 600 applying the media style corresponding to style indicator 1738b. In addition, media items 1732b and 1732e-1732g include different line styles to indicate that, in some embodiments, computer system 600 applies changes to one or more visual parameters differently to different media items. For instance, in some embodiments, computer system 600 applies changes to tone curves of media items differently based on whether a respective media item includes a person. In some embodiments, computer system 600 applies changes to color of media items differently based on the colors included in a respective media item. Therefore, in some embodiments, the appearances of media items 1732b and 1732e-1732f are each based on the media style corresponding to style indicator 1738b, but an amount of change applied to each media item is different based on the respective media item.

At FIG. 17Y, style indicator 1738b is currently selected, as indicated by style indicator 1738b having a different appearance from style indicators 1738a and 1738c-1738i (e.g., a different size and/or a different shape). Style selection user interface 1740 includes selected style indicator 1740a (e.g., “Style 1”), selected style description 1740b, and continue user interface object 1740c. At FIG. 17Y, style indicator 1738b corresponds to a style that is not a standard media style. In some embodiments, the media style corresponding to style indicator 1738b includes applying adjustments to one or more visual parameters of a respective media item by more than a threshold amount.

At FIG. 17Y, style selection user interface 1740 includes slider user interface object 617. As set forth above, slider user interface object 617 controls an intensity of a color palette corresponding to a respective media style. In some embodiments, computer system 600 adjusts the intensity of the color palette of the media style corresponding to style indicator 1738b in response to detecting user input corresponding to slider user interface object 617. In some embodiments, computer system 600 does not display slider user interface object 617 for the standard media style and displays slider user interface object 617 for non-standard media styles (e.g., media styles of the first category or media styles of the second category). In some embodiments, the standard media style does not an adjustable color palette. In some embodiments, computer system 600 does not display slider user interface object 617 in style selection user interface 1740 when the standard media style is applied (e.g., the media style corresponding to style indicator 1738a) because computer system 600 is not configured to adjust a color palette of the standard media style.

At FIG. 17Y, computer system 600 detects user input 1750aa (e.g., a swipe gesture, a tap gesture, a touch gesture, and/or a touch and drag gesture) corresponding to style selection user interface 1740. In response to detecting user input 1750aa, computer system 600 initiates a process for transitioning between applying the media style corresponding to style indicator 1738b to applying the media style corresponding to style indicator 1738c, as shown at FIG. 17Z.

At FIG. 17Z, computer system 600 displays frame 1742 of a transition animation of style selection user interface 1740 while detecting user input 1750aa. For instance, at FIG. 17Z, computer system 600 displays style selection user interface 1740 and media items 1732b and 1732e-1732g. Frame 1742 includes first style portion 1742a and second style portion 1742b. At FIG. 17Z, first style portion 1742a includes a portion of media items 1732b and 1732e-1732g in which computer system 600 applies the media style corresponding to style indicator 1738b (e.g., “Style 1”). Second style portion 1742b includes a portion of media items 1732b and 1732e-1732g in which computer system 600 applies the media style corresponding to style indicator 1738c (e.g., “Style 2”). Thus, the user of computer system 600 is able to view different media styles applied to media items 1732b and 1732e-1732g at the same time. In some embodiments, computer system 600 is configured to continue displaying frame 1742 while user input 1750aa is maintained (e.g., a touch portion of user input 1750aa is maintained at a particular location for a respective amount of time).

At FIG. 17Z, computer system 600 moves, scrolls, and/or translates selected style indicator 1740a (e.g., “Style 1”) and selected style description 1740b in response to detecting user input 1750aa. Displaying the movement of selected style indicator 1740a and selected style description 1740b provides visual confirmation that computer system 600 is transitioning between media styles. At FIG. 17Z, computer system 600 does not move, scroll, and/or translate continue user interface object 1740c and/or slider user interface object 617 because style selection user interface 1740 includes display of continue user interface object 1740c and slider user interface object 617 while style indicator 1738c is selected. In some embodiments, computer system moves, scrolls, and/or translates continue user interface object 1740c and/or slider user interface object 617 in response to detecting user input 1750aa.

At FIG. 17AA, computer system 600 displays style selection user interface 1740 while style indicator 1738c is selected. In some embodiments, computer system 600 displays style selection user interface 1740, as shown at FIG. 17AA, in response to detecting an end of user input 1740aa and/or after an end of the transition animation displayed in response to detecting user input 1750aa. At FIG. 17AA, computer system 600 displays style selection user interface 1740 that includes media items 1732b and 1732e-1732g with a third appearance that is based on the media style corresponding to style indicator 1738c. At FIG. 17AA, media items 1732b and 1732e-1732g include second hatching to represent the change in appearance that is based on computer system 600 applying the media style corresponding to style indicator 1738c. In addition, media items 1732b and 1732e-1732g include different line styles to indicate that, in some embodiments, computer system 600 applies changes to one or more visual parameters differently to different media items for the same respective media style. At FIG. 17AA, style indicator 1738c is currently selected, as indicated by style indicator 1738c having a different appearance from style indicators 1738a, 1738b, and 1738d-1738i (e.g., a different size and/or a different shape). Style selection user interface 1740 includes selected style indicator 1740a (e.g., “Style 2”), selected style description 1740b, and continue user interface object 1740c. At FIG. 17AA, style indicator 1738c corresponds to a style that is not a standard media style. In some embodiments, the media style corresponding to style indicator 1738b includes applying adjustments to one or more visual parameters of a respective media item by more than a threshold amount.

At FIG. 17AA, style selection user interface 1740 includes slider user interface object 617. As set forth above, slider user interface object 617 controls an intensity of an application of a color palette corresponding to a respective media style. In some embodiments, computer system 600 adjusts the intensity of the color palette of the media style corresponding to style indicator 1738c in response to detecting user input corresponding to slider user interface object 617. At FIG. 17AA, computer system 600 detects user input 1750ab (e.g., a tap gesture and/or a touch gesture) corresponding to media item 1732b. In response to detecting user input 1750ab, computer system 600 displays style selection user interface 1740, as shown at FIG. 17AB.

At FIG. 17AB, computer system 600 displays style selection user interface 1740 with media item 1732b and without displaying media items 1732e-1732g. At FIG. 17AB, computer system 600 displays media item 1732b at a size that is larger than the size of media item 1732b shown at FIG. 17AA. As such, computer system 600 is configured to enlarge one or more media items while displaying style selection user interface 1740, so that the user of computer system 600 can preview a respective media style as applied to a single media item. At FIG. 17AB, computer system 600 displays media item 1732b with the third appearance that is based on the media style corresponding to style indicator 1738c. At FIG. 17AB, media item 1732b includes second hatching to represent that the appearance of media item 1732b is based on the media style corresponding to style indicator 1738c.

At FIG. 17AB, style selection user interface 1740 includes grid user interface object 1740d and photo user interface object 1740e. At FIG. 17AB, style selection user interface 1740 includes media item 1732b and does not include display of media items 1732e-1732g. In some embodiments, in response to detecting user input corresponding to grid user interface object 1740d, computer system 600 displays media items 1732b and 1732e-1732g arranged in the grid, as shown at FIG. 17AA. In some embodiments, in response to detecting user input corresponding to photo user interface object 1740e, computer system 600 displays a user interface (e.g., media item user interface 1730) that enables the user of computer system 600 to select a different media item to preview with a respective media style. At FIG. 17AB, computer system 600 detects user input 1750ac (e.g., a swipe gesture, a tap gesture, a touch gesture, and/or a touch and drag gesture) corresponding to style selection user interface 1740. In response to detecting user input 1750ac, computer system 600 initiates a process for transitioning from applying the media style corresponding to style indicator 1738c to applying a media style corresponding to style indicator 1738d to media item 1732b, as shown at FIG. 17AC.

At FIG. 17AC, computer system 600 displays frame 1744 of a transition animation of style selection user interface 1740 while detecting user input 1750ac. For instance, at FIG. 17AC, computer system 600 displays style selection user interface 1740 and media item 1732b. Frame 1744 includes first style portion 1744a and second style portion 1744b. At FIG. 17AC, first style portion 1744a includes a portion of media item 1732b in which computer system 600 applies the media style corresponding to style indicator 1738c (e.g., “Style 2”). Second style portion 1744b includes a portion of media item 1732b in which computer system 600 applies the media style corresponding to style indicator 1738d (e.g., “Style 3”). Thus, the user of computer system 600 is able to view different media styles applied to media item 1732b at the same time. In some embodiments, computer system 600 is configured to continue displaying frame 1744 while user input 1750ac is maintained (e.g., a touch portion of user input 1750ac is maintained at a particular location for a respective amount of time).

At FIG. 17AC, computer system 600 moves, scrolls, and/or translates selected style indicator 1740a (e.g., “Style 2”), selected style description 1740b, and slider user interface object 617 corresponding to style indicator 1738c in response to detecting user input 1750ac. In addition, computer system 600 displays a portion of style indicator 1740a (e.g., “Style 3”), a portion of selected style description 1740b, and/or a portion of slider user interface object 617 corresponding to style indicator 1738d in response to detecting user input 1750ac. Displaying the movement of selected style indicator 1740a, selected style description 1740b, and/or slider user interface object 617 provides visual confirmation that computer system 600 is transitioning between media styles. At FIG. 17AC, computer system 600 does not move, scroll, and/or translate continue user interface object 1740c because style selection user interface 1740 includes display of continue user interface object 1740c while style indicator 1738d is selected. In some embodiments, computer system moves, scrolls, and/or translates continue user interface object 1740c in response to detecting user input 1750ac.

At FIG. 17AD, computer system 600 displays style selection user interface 1740 while style indicator 1738d is selected. In some embodiments, computer system 600 displays style selection user interface 1740, as shown at FIG. 17AD, in response to detecting an end of user input 1740ac and/or after an end of the transition animation displayed in response to detecting user input 1750ac. At FIG. 17AD, computer system 600 displays style selection user interface 1740 that includes media item 1732b with a fourth appearance that is based on the media style corresponding to style indicator 1738d. At FIG. 17AC, media item 1732b includes third hatching to represent the change in appearance that is based on computer system 600 applying the media style corresponding to style indicator 1738d.

At FIG. 17AD, style indicator 1738d is currently selected, as indicated by style indicator 1738d having a different appearance from style indicators 1738a-1738c and 1738e-1738i (e.g., a different size and/or a different shape). Style selection user interface 1740 includes selected style indicator 1740a (e.g., “Style 3”), selected style description 1740b, and continue user interface object 1740c. At FIG. 17AD, style indicator 1738d corresponds to a style that is not a standard media style. In some embodiments, the media style corresponding to style indicator 1738d includes applying adjustments to one or more visual parameters of a respective media item by more than a threshold amount. At FIG. 17AD, style selection user interface 1740 includes slider user interface object 617. As set forth above, slider user interface object 617 controls an intensity of an application of a color palette corresponding to a respective media style. In some embodiments, computer system 600 adjusts the intensity of the color palette of the media style corresponding to style indicator 1738d in response to detecting user input corresponding to slider user interface object 617. At FIG. 17AD, computer system 600 detects user input 1750ad (e.g., a tap gesture and/or a touch gesture) corresponding to continue user interface object 1740c. In response to detecting user input 1750ad, computer system 600 displays style editing user interface 1746, as shown at FIG. 17AE.

At FIG. 17AE, style editing user interface 1746 includes media item 1732b with the fourth appearance that is based on the media style corresponding to style indicator 1738d. For instance, at FIG. 17AE, media item 1732b includes third hatching to represent that the appearance of media item 1732b is based on the media style corresponding to style indicator 1738d. Style editing user interface 1746 also includes style indicators 1738a-1738i. At FIG. 17AE, style indicator 1738d is currently selected, as indicated by the different appearance of style indicator 1738d as compared to style indicators 1738a-1738c and 1738e-1738i. Style editing user interface 1746 further includes selected style indicator 1740a (e.g., “Style 3”) providing a name and/or brief description of the media style corresponding to style indicator 1738d.

At FIG. 17AE, style editing user interface 1746 includes graphical representation 616 and slider user interface object 617. Graphical representation includes indicator 616c at a location that corresponds to current values of one or more visual parameters of the respective media style. In some embodiments, respective media styles include different default positions of indicator 616c relative to an area of graphical representation 616. At FIG. 17AE, computer system 600 displays slider user interface object 617. As set forth above, computer system 600 is configured to adjust a color palette of a selected media style in response to detecting user input corresponding to slider user interface object 617. Computer system 600 is configured to adjust and/or change respective values of one or more visual parameters corresponding to a selected media style in response to user input corresponding to graphical representation 616 and/or slider user interface object 617. In some embodiments, while displaying style editing user interface 1746 and/or in response to detecting user input 1750ad, computer system 600 displays an animation of automated adjustments to graphical representation 616 and/or slider user interface object 617. In some embodiments, the animation of graphical representation 616 and/or slider user interface object 617 provides guidance to the user of computer system 600 about how to use graphical representation 616 and/or slider user interface object 617 to change one or more values of one or more visual parameters for a respective media style. At FIG. 17AE, computer system 600 detects user input 1750ae (e.g., a double tap gesture, a de-pinch gesture, a tap gesture, and/or a touch gesture) corresponding to media item 1732b. In response to detecting user input 1750ae, computer system 600 adjusts a zoom level of media item 1732b, as shown at FIG. 17AF.

At FIG. 17AF, computer system 600 displays style editing user interface 1746 with media item 1732b at an increased zoom level as compared to FIG. 17AE. For instance, at FIG. 17AE, computer system 600 has zoomed into media item 1732b and/or enlarged a portion of media item 1732b (e.g., the face of the person in media item 1732b is larger in FIG. 17AF than in FIG. 17AE). As such, the user of computer system 600 is able to preview and/or view how a respective style is applied to different portions of media items and/or to media items at different zoom levels. At FIG. 17AF, computer system 600 detects user input 1750af (e.g., a tap gesture and/or a touch gesture) corresponding to grid user interface object 1740d. In response to detecting user input 1750af, computer system 600 displays style editing user interface 1746, as shown at FIG. 17AG.

At FIG. 17AG, style editing user interface 1746 includes media items 1732b and 1732e-1732g arranged in the grid. Thus, computer system 600 is configured to transition between displaying individual media items and displaying multiple media items in style editing user interface 1746. In addition, at FIG. 17AG, computer system 600 displays media item 1732b at a default zoom level instead of the increased zoom level shown at FIG. 17AG. Thus, computer system 600 resets and/or changes a zoom level of a respective media item to a default zoom level when transitioning from displaying a single media item to displaying multiple media items. In some embodiments, computer system 600 maintains the zoom level of a respective media item when transitioning from displaying a single media item to displaying multiple media items. At FIG. 17AG, computer system 600 detects user input 1750ag (e.g., a swipe gesture and/or a touch and drag gesture) corresponding to graphical representation 616. In response to detecting user input 1750ag, computer system 600 adjusts respective values of the one or more visual parameters for the selected media style, as shown at FIG. 17AH. In addition, computer system 600 detects user input 1750ah (e.g., a swipe gesture and/or a touch and drag gesture) corresponding to slider user interface object 617. In response to detecting user input 1750ah, computer system 600 adjusts an intensity of a color palette of the selected media style, as shown at FIG. 17AI.

At FIG. 17AH, computer system 600 displays styles editing user interface 1746 while continuing to detect user input 1750ag. At FIG. 17AH, indicator 616c is displayed at an updated position within graphical representation 616 that is based on (e.g., a magnitude and/or a direction of) user input 1750ag. In addition, FIG. 17AH illustrates media item 1732b having a different hatching when compared to FIG. 17AG to represent the change in the respective values of the one or more visual parameters caused by user input 1750ag. At FIG. 17AH, computer system 600 adjusts and/or changes an appearance of one or more elements of graphical representation 616 while detecting user input 1750ag. For instance, at FIG. 17AH, computer system 600 displays first axis 616a and second axis 616b of graphical representation 616 with a different appearance when compared to graphical representation at FIG. 17AG. At FIG. 17AH, first axis 616a and second axis 616b include a different type of line style when compared to first axis 616a and second axis 616b shown at FIG. 17AG. In some embodiments, computer system 600 reduces a brightness, clarity, and/or opaqueness of first axis 616a and/or second axis 616b while detecting user input 1750ag. In addition, at FIG. 17AH, indicator 616c includes a larger size when compared to indicator 616c shown at FIG. 17AG. In some embodiments, computer system 600 increases the size of indicator 616c while detecting user input 1750ag so that the user of computer system 600 can still see and/or view indicator 616c while a finger of the user that is providing user input 1750ag at least partially covers graphical representation 616. At FIG. 17AH, computer system 600 moves indicator 616c to an updated position while detecting user input 1750ag, such that default indicator 616d is displayed. As set forth above, default indicator 616d visually indicates a default position of indicator 616c for a respective media style and/or one or more default values corresponding to the one or more visual parameters for the respective media style. At FIG. 17AH, computer system 600 adjusts and/or changes an appearance of default indicator 616d (e.g., as compared to default indicator 616d shown at FIG. 17AI) while detecting user input 1750ag. At FIG. 17AH, computer system 600 also changes the appearance of center point 616e of graphical representation 616 while detecting user input 1750ag. In some embodiments, computer system 600 reduces a brightness, reduces a size, changes a color, reduces an opaqueness, and/or changes a shape of default indicator 616d and/or center point 616e while detecting user input 1750ag.

At FIG. 17AI, computer system 600 detects an end (e.g., lift off of contact) of user input 1750ag. In response to detecting the end of user input 1750ag, computer system 600 updates one or more values corresponding to one or more visual parameters of the selected media style. For instance, computer system 600 displays styles editing user interface 1746 with indicator 616c having an updated position within graphical representation 616 that is based on (e.g., a magnitude and/or a direction of) user input 1750ag. In addition, FIG. 17AI illustrates media items 1732b and 1732e-1732g having a different hatching when compared to FIG. 17AG to represent the change in the respective values of the one or more visual parameters caused by user input 1750ag.

At FIG. 17AG, user input 1750ag includes a movement component that is substantially parallel to second axis 616b of graphical representation 616. Accordingly, at FIG. 17AI, the position of indicator 616c moves in a direction that is parallel to second axis 616b, such that computer system 600 adjusts a value of a color parameter of the selected media style without changing a value of a tone parameter of the selected media style. For instance, movement of indicator 616c along second axis 616b causes computer system 600 to adjust the respective value of color for the selected media style (e.g., the media style corresponding to style selection indicator 1738d). Movement of indicator 616c along first axis 616a causes computer system 600 to adjust the respective value of tone for the selected media style. Because user input 1750ag includes movement along second axis 616b, but does not include movement along first axis 616a, computer system 600 adjusts the value of color for the selected media style and does not adjust the value of tone for the selected media style.

While FIGS. 17AG-17AI illustrate computer system 600 adjusting color for the selected media style, in some embodiments, computer system 600 concurrently adjusts both tone and color for the selected media style in response to user input that includes movement in a first direction that is along first axis 616a and movement in a second direction that is along second axis 616b. At FIG. 17AI, computer system 600 displays default indicator 616d corresponding to a default position and/or default values for the one or more visual parameters of the selected media style. Default indicator 616d is displayed within graphical representation 616 and provides the user with a visual indication of how interaction with graphical representation 616 changes an appearance media items 1732b and 1732e-1732g. As set forth above, default indicator 616d includes an appearance at FIG. 17AI that is different from the appearance of default indicator 616d shown at FIG. 17AH.

At FIG. 17AI, computer system 600 displays styles editing user interface 1746 with slider user interface object 617 having an updated position that is based on user input 1750ah. For instance, a position of thumb 617a of slider user interface object 617 is at a different position at FIG. 17AI when compared to the position of thumb 617a shown at FIG. 17AG. Based on detecting user input 1750ah, computer system 600 applies a change to a color palette of the selected media style, as indicated by updated hatching at FIG. 17AI (e.g., as compared to hatching at FIG. 17AG). As set forth below, computer system 600 shifts colors of a color palette for a respective media style differently based on a category of the media style and/or an amount of adjustment to slider user interface object 617 (e.g., which is based on a magnitude and/or direction of user input 1750ah). At FIG. 17AI, computer system 600 updates selected style indicator 1740a (e.g., “Style 3 Custom”) to indicate the changes made to the respective style based on user input 1750ag and user input 1750ah. At FIG. 17AI, computer system 600 detects user input 1750ai (e.g., a tap gesture and/or a touch gesture) corresponding to continue user interface object 1746a of styles editing user interface 1746. In response to detecting user input 1750ai, computer system 600 displays confirmation user interface 1748, as shown at FIG. 17AJ.

At FIG. 17AJ, computer system 600 displays confirmation user interface 1748 to enable a user to preview media items 1732b and 1732e-1732g with the selected and/or customized media style applied. In some embodiments, computer system 600 displays (e.g., re-displays) style editing user interface 1746 in response to user input corresponding to selection of selected style indicator 1740a so that the user can go back and make additional changes and/or select another style. At FIG. 17AJ, computer system 600 detects user input 1750aj (e.g., a tap gesture and/or a touch gesture) corresponding to confirmation user interface object 1748a. In response to detecting user input 1750aj, computer system 600 displays settings user interface 1726, as shown at FIG. 17AK.

At FIG. 17AK, settings user interface 1726 includes camera style user interface object 1726a with an updated appearance based on the media style selected and/or confirmed based on user input 1750aj. For instance, indicator 1726b includes the text “Style 3 Custom,” which provides visual feedback and/or confirmation about the selected media style. In some embodiments, computer system 600 forgoes displaying settings user interface 1726 in response to detecting user input 1750aj. For instance, in some embodiments, computer system 600 displays the user interfaces shown at FIGS. 17T-17AJ during a setup process of computer system 600. In some embodiments, computer system 600 displays a user interface corresponding to a next step of the setup process in response to detecting user input 1750aj.

FIGS. 17AL-17AP are graphical representations and/or illustrations of adjustments to visual parameters of a media style based on user interaction with graphical representation 616 and/or slider user interface object 617.

FIG. 17AL illustrates graphical representations of adjustments to tone curves of different categories of media styles based on user interaction with graphical representation 616 (described in greater detail above with reference to FIGS. 6A-6AG and 17A-17AK). A tone curve maps input tone to output tone, so a straight diagonal line indicates that tone has not been adjusted while a curved line indicates that input tone has been mapped to a different output tone, where the amount of difference of the curve from a diagonal line indicates the amount of change of the input tone values relative to the output tone values. FIG. 17AL includes first row 1752a, which includes graphical representation 616, first media style category graph 1754, and second media style category graph 1756. At FIG. 17AL, indicator 616c of graphical representation 616 in first row 1752a is at a first location relative to an area of graphical representation 616. In some embodiments, the location of indicator 616c of graphical representation 616 in first row 1752a represents a maximum value of tone that can be applied for a respective media style, as indicated by indicator 616c being positioned at a top portion of first axis 616a. In some embodiments, the maximum value of tone for media styles of the second category is larger and/or greater than the maximum value of tone for media styles of the first category. As shown at FIG. 17AL, computer system 600 is configured to adjust a tone curve of a respective media style differently based on the media item including a person and/or based on a category of the respective media style. At FIG. 17AL, first media style category graph 1754 includes a first tone curve 1754a corresponding to a tone curve applied to a background portion of a media item when a respective media style of the first category is applied and the position of indicator 616c is at the location shown in graphical representation 616 of first row 1752a. In addition, first media style category graph 1754 includes a second tone curve 1754b corresponding to a tone curve applied to a person of a media item when a respective media style of the first category is applied and the position of indicator 616c is at the location shown in graphical representation 616 of first row 1752a.

Second media style category graph 1756 includes a first tone curve 1756a corresponding to a tone curve applied to a background portion of a media item when a respective media style of the second category is applied and the position of indicator 616c is at the location shown in graphical representation 616 of first row 1752a. In addition, second media style category graph 1756 includes a second tone curve 1756b corresponding to a tone curve applied to a person of a media item when a respective media style of the second category is applied and the position of indicator 616c is at the location shown in graphical representation 616 of first row 1752a.

At FIG. 17AL, first tone curve 1756a for the second category of media styles includes a greater and/or larger slope when compared to first tone curve 1754a for the first category of media styles. As such, computer system 600 adjusts the tone curve applied to a background portion of a respective media item more when the respective media style is of the second category as compared to the first category. Similarly, second tone curve 1756b for the second category of media styles includes a greater and/or larger slope when compared to second tone curve 1754b for the first category of media styles. Thus, computer system 600 adjusts the tone curve applied to a person of a respective media item more when the respective media style is of the second category as compared to the first category. As shown at FIG. 17AL, computer system 600 adjusts the tone curve for background by a greater amount as compared to the tone curve for a person for a media style of a respective category. Therefore, differences in tone are greater for background portions of media items when compared to people included in media items.

FIG. 17AL further includes second row 1752b, which includes graphical representation 616, first media style category graph 1758, and second media style category graph 1760. At FIG. 17AL, indicator 616c of graphical representation 616 in second row 1752b is at a second location relative to an area of graphical representation 616. In some embodiments, the location of indicator 616c of graphical representation 616 in second row 1752b represents an increased value of tone that is less than a maximum value of tone that can be applied for a respective media style. At FIG. 17AL, first media style category graph 1758 includes a first tone curve 1758a corresponding to a tone curve applied to a background portion of a media item when a respective media style of the first category is applied and the position of indicator 616c is at the location shown in graphical representation 616 of second row 1752b. In addition, first media style category graph 1758 includes a second tone curve 1758b corresponding to a tone curve applied to a person of a media item when a respective media style of the first category is applied and the position of indicator 616c is at the location shown in graphical representation 616 of second row 1752b.

Second media style category graph 1760 includes a first tone curve 1760a corresponding to a tone curve applied to a background portion of a media item when a respective media style of the second category is applied and the position of indicator 616c is at the location shown in graphical representation 616 of second row 1752b. In addition, second media style category graph 1760 includes a second tone curve 1760b corresponding to a tone curve applied to a person of a media item when a respective media style of the second category is applied and the position of indicator 616c is at the location shown in graphical representation 616 of second row 1752b. Similar to first row 1752a, computer system 600 is configured to adjust the tone curve applied to a respective media item by a larger amount for media styles of the second category when compared to media styles of the first category (e.g., for both background and people). In addition, computer system 600 is configured to adjust the tone curve applied to background portions of media items more than tone curves applied to people included in media items.

FIG. 17AL includes third row 1752c, which includes graphical representation 616, first media style category graph 1762, and second media style category graph 1764. At FIG. 17AL, indicator 616c of graphical representation 616 in third row 1752c is at a third location relative to an area of graphical representation 616. In some embodiments, the location of indicator 616c of graphical representation 616 in third row 1752c represents a reduced value of tone that is greater than a minimum value of tone that can be applied for a respective media style. At FIG. 17AL, first media style category graph 1762 includes a first tone curve 1762a corresponding to a tone curve applied to a background portion of a media item when a respective media style of the first category is applied and the position of indicator 616c is at the location shown in graphical representation 616 of third row 1752c. In addition, first media style category graph 1762 includes a second tone curve 1762b corresponding to a tone curve applied to a person of a media item when a respective media style of the first category is applied and the position of indicator 616c is at the location shown in graphical representation 616 of third row 1752c.

Second media style category graph 1764 includes a first tone curve 1764a corresponding to a tone curve applied to a background portion of a media item when a respective media style of the second category is applied and the position of indicator 616c is at the location shown in graphical representation 616 of third row 1752c. In addition, second media style category graph 1764 includes a second tone curve 1764b corresponding to a tone curve applied to a person of a media item when a respective media style of the second category is applied and the position of indicator 616c is at the location shown in graphical representation 616 of third row 1752c. Similar to first row 1752a and second row 1752b, computer system 600 is configured to adjust the tone curve applied to a respective media item by a larger amount for media styles of the second category when compared to media styles of the first category (e.g., for both background and people). In addition, computer system 600 is configured to adjust the tone curve applied to background portions of media items more than tone curves applied to people included in media items.

FIG. 17AL includes fourth row 1752d, which includes graphical representation 616, first media style category graph 1766, and second media style category graph 1768. At FIG. 17AL, indicator 616c of graphical representation 616 in fourth row 1752d is at a fourth location relative to an area of graphical representation 616. In some embodiments, the location of indicator 616c of graphical representation 616 in fourth row 1752d represents a minimum value of tone that can be applied for a respective media style. In some embodiments, the minimum value for media styles of the second category is less than a minimum value for media styles of the first category. At FIG. 17AL, first media style category graph 1766 includes a first tone curve 1766a corresponding to a tone curve applied to a background portion of a media item when a respective media style of the first category is applied and the position of indicator 616c is at the location shown in graphical representation 616 of fourth row 1752d. In addition, first media style category graph 1766 includes a second tone curve 1766b corresponding to a tone curve applied to a person of a media item when a respective media style of the first category is applied and the position of indicator 616c is at the location shown in graphical representation 616 of fourth row 1752d.

Second media style category graph 1768 includes a first tone curve 1768a corresponding to a tone curve applied to a background portion of a media item when a respective media style of the second category is applied and the position of indicator 616c is at the location shown in graphical representation 616 of fourth row 1752d. In addition, second media style category graph 1768 includes a second tone curve 1768b corresponding to a tone curve applied to a person of a media item when a respective media style of the second category is applied and the position of indicator 616c is at the location shown in graphical representation 616 of fourth row 1752d. Similar to first row 1752a, second row 1752b, and third row 1752c, computer system 600 is configured to adjust the tone curve applied to a respective media item by a larger amount for media styles of the second category when compared to media styles of the first category (e.g., for both background and people). In addition, computer system 600 is configured to adjust the tone curve applied to background portions of media items more than tone curves applied to people included in media items.

FIG. 17AM illustrates graphical representations of adjustments to one or more colors of different categories of media styles based on user interaction with graphical representation 616. FIG. 17AM includes first row 1770a, which includes graphical representation 616, first media style category graph 1772a, and second media style category graph 1774a. At FIG. 17AM, first media style category graph 1772a and second media style category graph 1774a each include a plurality of points corresponding to respective colors that are configured to be shifted and/or adjusted based on user interaction with graphical representation 616. At FIG. 17AM, the points corresponding to respective colors are unevenly distributed to represent that different colors include different peak and/or maximum saturation points. In some embodiments, computer system 600 adjusts the shift of respective colors differently based on the peak saturation points of respective colors to avoid color clipping (e.g., colors appearing dull and/or less vibrant as displayed on display 602). The shift and/or adjustment to a respective color (e.g., as represented by a respective point) is illustrated by arrows in first media style category graph 1772a and second media style category graph 1774a. At FIG. 17AM, the x-axis (e.g., labeled “P” at FIG. 17AM) corresponds to red/green colors in a perceptual space. In addition, at FIG. 17AM, the y-axis (e.g., labeled “T” at FIG. 17AM) corresponds to yellow/blue colors in the perceptual space.

At FIG. 17AM, indicator 616c of graphical representation 616 in first row 1770a is at a first location relative to an area of graphical representation 616. In some embodiments, the location of indicator 616c of graphical representation 616 in first row 1770a represents a maximum value of color that can be applied for a respective media style, as indicated by indicator 616c being positioned at a rightmost portion of second axis 616b. In some embodiments, the maximum value of color that can be applied for a media style of the second category is greater than the maximum value of color than can be applied for a media style of the first category. As shown at FIG. 17AM, computer system 600 is configured to adjust one or more colors of a respective media style differently based on a category of the respective media style. At FIG. 17AM, first media style category graph 1772a includes a first magnitude and a first direction of shift of the one or more colors for a respective media style of the first category. At FIG. 17AM, second media style category graph 1774a includes a second magnitude and a second direction of shift of the one or more colors for a respective media style of the second category. As shown at FIG. 17AM, the respective directions of the color shifts for the first category of media items and the second category media items are the same. In some embodiments, the respective directions of the color shifts for the first category of media items and the second category of media items are different. At FIG. 17AM, the magnitude of the color shifts for media styles of the second category is larger than the magnitude of the color shifts for media items of the first category. Therefore, computer system 600 adjusts (e.g., shifts) colors of media styles of the second category more than colors of media styles of the first category.

At FIG. 17AM, indicator 616c of graphical representation 616 in second row 1770b is at a second location relative to an area of graphical representation 616. In some embodiments, the location of indicator 616c of graphical representation 616 in second row 1770b represents an increase in color that is less than a maximum value of color that can be applied for a respective media style, as indicated by indicator 616c being positioned on a right side portion of second axis 616b. At FIG. 17AM, first media style category graph 1772b includes a first magnitude and a first direction of shift of the one or more colors for a respective media style of the first category. At FIG. 17AM, second media style category graph 1774b includes a second magnitude and a second direction of shift of the one or more colors for a respective media style of the second category. Similar to first row 1770a, computer system 600 is configured to adjust colors of media styles of the second category by a greater magnitude than media styles of the first category.

At FIG. 17AM, indicator 616c of graphical representation 616 in third row 1770c is at a third location relative to an area of graphical representation 616. In some embodiments, the location of indicator 616c of graphical representation 616 in third row 1770c represents a reduction and/or decrease in color that is less than a minimum value of color that can be applied for a respective media style, as indicated by indicator 616c being positioned on a left side portion of second axis 616b. At FIG. 17AM, first media style category graph 1772c includes a first magnitude and a first direction of shift of the one or more colors for a respective media style of the first category. At FIG. 17AM, second media style category graph 1774c includes a second magnitude and a second direction of shift of the one or more colors for a respective media style of the second category. Similar to first row 1770a and second row 1770b, computer system 600 is configured to adjust colors of media styles of the second category by a greater magnitude than media styles of the first category.

At FIG. 17AM, indicator 616c of graphical representation 616 in fourth row 1770d is at a fourth location relative to an area of graphical representation 616. In some embodiments, the location of indicator 616c of graphical representation 616 in fourth row 1770d represents a reduction and/or decrease in color corresponding to a minimum value of color that can be applied for a respective media style, as indicated by indicator 616c being positioned on a leftmost side of second axis 616b. In some embodiments, the minimum value of color for a media style of the second category is less than a minimum value of color for a media style of the first category. At FIG. 17AM, first media style category graph 1772d includes a first magnitude and a first direction of shift of the one or more colors for a respective media style of the first category. At FIG. 17AM, second media style category graph 1774d includes a second magnitude and a second direction of shift of the one or more colors for a respective media style of the second category. Similar to first row 1770a, second row 1770b, and third row 1770c, computer system 600 is configured to adjust colors of media styles of the second category by a greater magnitude than media styles of the first category.

While FIG. 17AM illustrates the direction of shift of the one or more colors for both the first category of media styles and the second category of media styles changing when the value of color is reduced as compared to when the value of color is increased, in some embodiments, computer system 600 maintains the same direction of shift for both an increase and a reduction in the value of color.

FIGS. 17AN-17AP illustrate graphical representations of adjustments to respective color palettes of different media styles of different categories. FIGS. 17AN-17AP include graphs illustrating shifts of various colors of a respective color palette based on user interface with slider user interface object 617 (described in greater detail above with reference to FIGS. 6A-6AG and 17A-17AK). At FIGS. 17AN-17AP, the x-axis (labeled “P”) of the graphs corresponds to red/green colors in a perceptual space. In addition, at FIGS. 17AN-17AP, the y-axis (labeled “T”) of the graphs corresponds to yellow/blue colors in the perceptual space. The graphs of FIGS. 17AN-17AP include a plurality of points corresponding to respective colors of a color palette for a respective media style. At FIGS. 17AN-17AP, the points corresponding to respective colors are unevenly distributed to represent that different colors include different peak and/or maximum saturation points. In some embodiments, computer system 600 adjusts the shift of respective colors differently based on the peak saturation points of respective colors to avoid color clipping (e.g., colors appearing dull and/or less vibrant as displayed on display 602). FIGS. 17AN-17AP illustrate shifts to respective colors using arrows 1782a-1782c. As set forth below, arrows 1782a correspond to shifts of a respective color that is present in (e.g., determined, based on analysis of a media item, to be part of the media item that represents) skin, arrows 1782b correspond to shifts of the respective color that is present in (e.g., determined, based on an analysis of a media item, to be a part of the media item that represents) a representation of person (e.g., clothes, hair, and/or accessories but not skin), and arrows 1782c correspond to shifts of the respective color that is present in (e.g., determined, based on an analysis of a media item, to be part of the media item that represents) a background (e.g., a portion and/or part of a media item that represents something other than a person and/or skin). At FIGS. 17AN-17AP, some points on the graphs include all three arrows 1782a-1782c, thereby indicating that computer system 600 adjusts the respective color (e.g., the same color) corresponding to the point differently based on whether the color is present in (e.g., determined, based on an analysis of a media item, to be a portion and/or part of the media item that represents) skin, a person, or background. At FIGS. 17AN-17AP some of the points on the graphs include two arrows. In some embodiments, the two arrows correspond to arrows 1782b and 1782c. In some embodiments, the longest arrows for any respective point illustrated in the graphs shown at FIGS. 17AN-17AP represent shifts in color for background. In some embodiments, when a respective point includes a single arrow, the single arrow represents a shift in color for background.

FIG. 17AN illustrates graphical representations of adjustments to a color palette of a first media style based on user interaction with slider user interface object 617. FIG. 17AN includes first row 1776a, which includes slider user interface object 617 and color palette graph 1778a. At FIG. 17AN, color palette graph 1778a includes a plurality of points corresponding to respective colors that are configured to be shifted and/or adjusted based on user interaction with slider user interface object 617. The shift and/or adjustment to a respective color (e.g., as represented by a respective point) is illustrated by arrows in color palette graph 1778a.

At FIG. 17AN, thumb 617a of slider user interface object 617 in first row 1776a is at a first location relative to a length of slider user interface object 617. In some embodiments, the location of thumb 617a of slider user interface object 617 in first row 1776a represents a maximum value of a color palette and/or color palette shift that can be applied for the first media style, as indicated by thumb 617a being positioned at a rightmost portion of slider user interface object 617. At FIG. 17AN, color palette graph 1778a includes shifting respective colors in different directions and/or by different magnitudes. As shown at FIG. 17AN, area 1780 of color palette graph 1778a represents colors that correspond to skin tones. As shown at FIG. 17AN, the magnitude of a color shift for respective colors differs based on whether the color is present as skin, a person, or a background of a media item. For instance, arrows 1782a represent color shifts for skin, arrows 1782b represent color shifts for people, and arrows 1782c represent color shifts for background. In some embodiments, computer system 600 shifts colors that are included in skin by less than colors that are included in people and background. In some embodiments, computer system 600 shifts colors that are included in people by less than colors that are included in background. In some embodiments, computer system 600 shifts colors that are included in background by more than colors that are included in skin and by more than colors that are included in people.

At FIG. 17AN, thumb 617a of slider user interface object 617 in second row 1776b is at a second location relative to a length of slider user interface object 617. In some embodiments, the location of thumb 617a of slider user interface object 617 in second row 1776b represents a decrease in the value of the color palette when compared to the position of thumb 617a in first row 1776a. In some embodiments, the location of thumb 617a of slider user interface object 617 in second row 1776b represents an increase in a value of a color palette and/or color palette shift that is less than a maximum value and that can be applied for the first media style. At FIG. 17AN, color palette graph 1778b includes a second magnitude and a second direction of a shift of the one or more colors for the first media style. In some embodiments, the second direction of shift is the same as the first direction of shift for the respective colors. At FIG. 17AN, the second magnitude of the shift of the respective colors is less than the first magnitude of the shift of the respective colors shown in first row 1776a (e.g., the second magnitude of the shift of the respective color is less than the first magnitude of the shift of the respective color when the respective color is determined to be part of skin (represented by arrow 1782a), a person (represented by arrow 1782b), and/or background (represented by arrow 1782c) in the media item).

At FIG. 17AN, thumb 617a of slider user interface object 617 in third row 1776c is at a third location relative to a length of slider user interface object 617. In some embodiments, the location of thumb 617a of slider user interface object 617 in third row 1776c represents a decrease in the value of the color palette when compared to the position of thumb 617a in first row 1776a and second row 1776b. In some embodiments, the location of thumb 617a of slider user interface object 617 in third row 1776c represents an increase in a value of a color palette and/or color palette shift that is less than a maximum value and that can be applied for the first media style. At FIG. 17AN, color palette graph 1778c includes a third magnitude and a third direction of a shift of the one or more colors for the first media style. In some embodiments, the third direction of shift is the same as the first direction of shift and/or the second direction of shift for the respective colors. At FIG. 17AN, the third magnitude of the shift of the respective colors is less than the first magnitude of the shift of the respective colors shown in first row 1776a (e.g., the third magnitude of the shift of the respective color is less than the first magnitude of the shift of the respective color when the respective color is determined to be part of skin (represented by arrow 1782a), a person (represented by arrow 1782b), and/or background (represented by arrow 1782c) in the media item) and less than the second magnitude of the shift of the respective colors shown in second row 1776b (e.g., the third magnitude of the shift of the respective color is less than the second magnitude of the shift of the respective color when the respective color is determined to be part of skin (represented by arrow 1782a), a person (represented by arrow 1782b), and/or background (represented by arrow 1782c) in the media item).

FIG. 17AO illustrates graphical representations of adjustments to a color palette of a second media style based on user interaction with slider user interface object 617. FIG. 17AO includes first row 1784a, which includes slider user interface object 617 and color palette graph 1786a. At FIG. 17AO, color palette graph 1786a includes a plurality of points corresponding to respective colors that are configured to be shifted and/or adjusted based on user interaction with slider user interface object 617. The shift and/or adjustment to a respective color (e.g., as represented by a respective point) is illustrated by arrows in color palette graph 1786a. As shown at FIG. 17AO, color palette graphs 1786a-1786c include one or more points that are different from the one or more points in color palette graphs 1778a-1778c, thereby representing different colors that are included and/or changed in different media styles. In some embodiments, color palette graphs 1786a-1786c include the same points as color palette graphs 1778a-1778c.

At FIG. 17AO, thumb 617a of slider user interface object 617 in first row 1784a is at a first location relative to a length of slider user interface object 617. In some embodiments, the location of thumb 617a of slider user interface object 617 in first row 1784a represents a maximum value of a color palette and/or color palette shift that can be applied for the second media style, as indicated by thumb 617a being positioned at a rightmost portion of slider user interface object 617. At FIG. 17AO, color palette graph 1786a includes shifting respective colors in different directions and/or by different magnitudes. As shown at FIG. 17AO, area 1780 of color palette graph 1786a represents colors that correspond to skin tones. As shown at FIG. 17AO, the magnitude of a color shift for respective colors differs based on whether the color is present as skin, a person, or a background of a media item. For instance, arrows 1782a represent color shifts for skin, arrows 1782b represent color shifts for people, and arrows 1782c represent color shifts for background. In some embodiments, computer system 600 shifts colors that are included in skin by less than colors that are included in people and background. In some embodiments, computer system 600 shifts colors that are included in people by less than colors that are included in background. In some embodiments, computer system 600 shifts colors that are included in background by more than colors that are included in skin and by more than colors that are included in people.

At FIG. 17AO, thumb 617a of slider user interface object 617 in second row 1784b is at a second location relative to a length of slider user interface object 617. In some embodiments, the location of thumb 617a of slider user interface object 617 in second row 1784b represents a decrease in the value of the color palette when compared to the position of thumb 617a in first row 1784a. In some embodiments, the location of thumb 617a of slider user interface object 617 in second row 1784b represents an increase in a value of a color palette and/or color palette shift that is less than a maximum value and that can be applied for the second media style. At FIG. 17AO, color palette graph 1786b includes a second magnitude and a second direction of a shift of the one or more colors for the second media style. In some embodiments, the second direction of shift is the same as the first direction of shift for the respective colors. At FIG. 17AO, the second magnitude of the shift of the respective colors is less than the first magnitude of the shift of the respective colors shown in first row 1784a (e.g., the second magnitude of the shift of the respective color is less than the first magnitude of the shift of the respective color when the respective color is determined to be part of skin (represented by arrow 1782a), a person (represented by arrow 1782b), and/or background (represented by arrow 1782c) in the media item).

At FIG. 17AO, thumb 617a of slider user interface object 617 in third row 1784c is at a third location relative to a length of slider user interface object 617. In some embodiments, the location of thumb 617a of slider user interface object 617 in third row 1784c represents a decrease in the value of the color palette when compared to the position of thumb 617a in first row 1784a and second row 1784b. In some embodiments, the location of thumb 617a of slider user interface object 617 in third row 1784c represents an increase in a value of a color palette and/or color palette shift that is less than a maximum value and that can be applied for the second media style. At FIG. 17AO, color palette graph 1786c includes a third magnitude and a third direction of a shift of the one or more colors for the second media style. In some embodiments, the third direction of shift is the same as the first direction of shift and/or the second direction of shift for the respective colors. At FIG. 17AO, the third magnitude of the shift of the respective colors is less than the first magnitude of the shift of the respective colors shown in first row 1784a (e.g., the third magnitude of the shift of the respective color is less than the first magnitude of the shift of the respective color when the respective color is determined to be part of skin (represented by arrow 1782a), a person (represented by arrow 1782b), and/or background (represented by arrow 1782c) in the media item) and less than the second magnitude of the shift of the respective colors shown in second row 1784b (e.g., the third magnitude of the shift of the respective color is less than the second magnitude of the shift of the respective color when the respective color is determined to be part of skin (represented by arrow 1782a), a person (represented by arrow 1782b), and/or background (represented by arrow 1782c) in the media item).

FIG. 17AP illustrates graphical representations of adjustments to a color palette of a third media style based on user interaction with slider user interface object 617. FIG. 17AP includes first row 1788a, which includes slider user interface object 617 and color palette graph 1790a. At FIG. 17AO, color palette graph 1790a includes a plurality of points corresponding to respective colors that are configured to be shifted and/or adjusted based on user interaction with slider user interface object 617. The shift and/or adjustment to a respective color (e.g., as represented by a respective point) is illustrated by arrows in color palette graph 1790a. As shown at FIG. 17AO, color palette graphs 1790a-1790c include one or more points that are different from the one or more points in color palette graphs 1778a-1778c and/or color palette graphs 1786a-1786c, thereby representing different colors that are included and/or changed in different media styles. In some embodiments, color palette graphs 1790a-1790c include the same points as color palette graphs 1778a-1778c and/or color palette graphs 1786a-1786c.

At FIG. 17AP, thumb 617a of slider user interface object 617 in first row 1788a is at a first location relative to a length of slider user interface object 617. In some embodiments, the location of thumb 617a of slider user interface object 617 in first row 1788a represents a maximum value of a color palette and/or color palette shift that can be applied for the third media style, as indicated by thumb 617a being positioned at a rightmost portion of slider user interface object 617. At FIG. 17AP, color palette graph 1790a includes shifting respective colors in different directions and/or by different magnitudes. As shown at FIG. 17AP, area 1780 of color palette graph 1790a represents colors that correspond to skin tones. As shown at FIG. 17AP, the magnitude of a color shift for respective colors differs based on whether the color is present as skin, a person, or a background of a media item. For instance, arrows 1782a represent color shifts for skin, arrows 1782b represent color shifts for people, and arrows 1782c represent color shifts for background. In some embodiments, computer system 600 shifts colors that are included in skin by less than colors that are included in people and background. In some embodiments, computer system 600 shifts colors that are included in people by less than colors that are included in background. In some embodiments, computer system 600 shifts colors that are included in background by more than colors that are included in skin and by more than colors that are included in people.

At FIG. 17AP, thumb 617a of slider user interface object 617 in second row 1788b is at a second location relative to a length of slider user interface object 617. In some embodiments, the location of thumb 617a of slider user interface object 617 in second row 1788b represents a decrease in the value of the color palette when compared to the position of thumb 617a in first row 1788a. In some embodiments, the location of thumb 617a of slider user interface object 617 in second row 1788b represents an increase in a value of a color palette and/or color palette shift that is less than a maximum value and that can be applied for the third media style. At FIG. 17AP, color palette graph 1790b includes a second magnitude and a second direction of a shift of the one or more colors for the third media style. In some embodiments, the second direction of shift is the same as the first direction of shift for the respective colors. At FIG. 17AP, the second magnitude of the shift of the respective colors is less than the first magnitude of the shift of the respective colors shown in first row 1788a (e.g., the second magnitude of the shift of the respective color is less than the first magnitude of the shift of the respective color when the respective color is determined to be part of skin (represented by arrow 1782a), a person (represented by arrow 1782b), and/or background (represented by arrow 1782c) in the media item).

At FIG. 17AP, thumb 617a of slider user interface object 617 in third row 1788c is at a third location relative to a length of slider user interface object 617. In some embodiments, the location of thumb 617a of slider user interface object 617 in third row 1788c represents a decrease in the value of the color palette when compared to the position of thumb 617a in first row 1788a and second row 1788b. In some embodiments, the location of thumb 617a of slider user interface object 617 in third row 1788c represents an increase in a value of a color palette and/or color palette shift that is less than a maximum value and that can be applied for the third media style. At FIG. 17AP, color palette graph 1790c includes a third magnitude and a third direction of a shift of the one or more colors for the third media style. In some embodiments, the third direction of shift is the same as the first direction of shift and/or the second direction of shift for the respective colors. At FIG. 17AP, the third magnitude of the shift of the respective colors is less than the first magnitude of the shift of the respective colors shown in first row 1788a (e.g., the third magnitude of the shift of the respective color is less than the first magnitude of the shift of the respective color when the respective color is determined to be part of skin (represented by arrow 1782a), a person (represented by arrow 1782b), and/or background (represented by arrow 1782c) in the media item) and less than the second magnitude of the shift of the respective colors shown in second row 1788b (e.g., the third magnitude of the shift of the respective color is less than the second magnitude of the shift of the respective color when the respective color is determined to be part of skin (represented by arrow 1782a), a person (represented by arrow 1782b), and/or background (represented by arrow 1782c) in the media item).

FIG. 18 is a flow diagram illustrating a method for selecting media styles using a computer system in accordance with some embodiments. Method 1800 is performed at a computer system (e.g., 100, 300, 500, and/or 600) (e.g., a smart phone, a smart watch, a tablet computer, a laptop computer, a desktop computer, a wearable device, and/or head-mounted device) that is in communication with (e.g., includes and/or is connected to) one or more display generation components (e.g., 602) (e.g., one or more displays, touch-screen displays, monitors, holographic display systems, and/or head-mounted display systems) and one or more input devices (e.g., 600a and/or 602) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 1800 are, optionally, combined, the orders of some operations are, optionally, changed, and some operations are, optionally, omitted.

As described below, method 1800 provides an intuitive way for selecting media styles. The method reduces the cognitive burden on a user for selecting media styles, thereby creating a more efficient human-machine interface. For battery-operated computing devices, enabling a user to manage photographic styles faster and more efficiently conserves power and increases the time between battery charges.

While displaying, via the one or more display generation components (e.g., 602), a media user interface (e.g., 608, 626, 632, 1702, and/or 1714) (e.g., a user interface that includes display of one or more media items, one or more control user interface objects for editing, adjusting, modifying, and/or changing one or more visual aspects of a respective media item, one or more user interface objects for adding, removing, repositioning, sharing, bookmarking, deleting, and/or providing a designation to the one or more media items, and/or one or more control user interface objects for editing, adjusting, modifying, and/or changing audio parameters of a respective media item and/or a playback speed of the respective media item, a media editing user interface, and/or a user interface that includes a representation of a field of view of one or more cameras that are in communication with the computer system) including a media item (e.g., 604a, 608a, 614a, 622a, 622d, and/or 1716) (e.g., an image, a photo, a video, a screenshot, a representation of a field of view of one or more cameras in communication with the computer system), computer system (e.g., 100, 300, 500, and/or 600) detects (1802), via the one or more input devices (e.g., 600a and/or 602), one or more user inputs (e.g., 650d, 650e, 650z, 650ad, 1750b, 1750c, 1750f, 1750g, 1750i, 1750k, 1750l, 1750q, 1750r, and/or 1750s) (e.g., tap gestures, swipe gestures, air gestures, and/or voice commands) corresponding to a request to apply a respective media style (e.g., one or more user inputs requesting to adjust, modify, change, and/or maintain one or more values of respective parameters corresponding to an appearance of the media item, such as a saturation value, a tone value, a color temperature value, a brightness value, an opaqueness value, and/or a contrast value, and/or adjust, modify, change, and/or maintain a color palette of colors displayed and/or included in the media item) to the media item (e.g., 604a, 608a, 614a, 622a, 622d, and/or 1716) (e.g., a request to transition from applying a first media style to the media item to applying a second media style to the media item that is different from the first media style).

In response to detecting the one or more user inputs (e.g., 650d, 650e, 650z, 650ad, 1750b, 1750c, 1750f, 1750g, 1750i, 1750k, 1750l, 1750q, 1750r, and/or 1750s) corresponding to the request to apply the respective media style to the media item (1804) (e.g., 604a, 608a, 614a, 622a, 622d, and/or 1716) and in accordance with a determination that the one or more user inputs (e.g., 650d, 650e, 650z, 650ad, 1750b, 1750c, 1750f, 1750g, 1750i, 1750k, 1750l, 1750q, 1750r, and/or 1750s) include a first input (e.g., a first tap gesture, swipe gesture, air gesture, and/or voice command) in a first direction (e.g., the first input of the one or more user inputs includes a direction, such as a direction of a swipe gesture, a direction of a tap input relative to a currently selected object and/or icon, and/or a direction of an air gesture, that is detected to be in the first direction), computer system (e.g., 100, 300, 500, and/or 600) applies (1806) a first media style to the media item (e.g., 604a, 608a, 614a, 622a, 622d, and/or 1716) (e.g., adjusting, modifying, changing, and/or maintaining one or more values of respective parameters corresponding to an appearance of the media item, such as a saturation value, a tone value, a color temperature value, a brightness value, an opaqueness value, and/or a contrast value, and/or adjusting, modifying, changing, and/or maintaining a color palette of colors displayed and/or included in the media item), wherein the first media style corresponds to a first category of media styles (e.g., the first category illustrated in FIGS. 17AL and 17AM) (e.g., a first set of one or more media styles that cause a value of a respective parameter corresponding to an appearance of the media item to change from an original value to an updated value, where the difference between the original value and the updated value is below a threshold amount, a first set of one or more media styles that cause skin tones of the media item to be preserved and/or displayed at an original color, a first set of one or more media styles that are configured to be applied to a media item captured by one or more cameras that are in communication with the computer system without additional user input).

In response to detecting the one or more user inputs (e.g., 650d, 650e, 650z, 650ad, 1750b, 1750c, 1750f, 1750g, 1750i, 1750k, 1750l, 1750q, 1750r, and/or 1750s) corresponding to the request to apply the respective media style to the media item (1804) (e.g., 604a, 608a, 614a, 622a, 622d, and/or 1716) and in accordance with a determination that the one or more inputs (e.g., 650d, 650e, 650z, 650ad, 1750b, 1750c, 1750f, 1750g, 1750i, 1750k, 1750l, 1750q, 1750r, and/or 1750s) include a second input (e.g., a second tap gesture, swipe gesture, air gesture, and/or voice command) in a second direction (e.g., the second input of the one or more user inputs includes a direction, such as a direction of a swipe gesture, a direction of a tap input relative to a currently selected object and/or icon, and/or a direction of an air gesture, that is detected to be in the second direction) that is different from the first direction, computer system (e.g., 100, 300, 500, and/or 600) applies (1808) a second media style to the media item (e.g., 604a, 608a, 614a, 622a, 622d, and/or 1716) (e.g., adjusting, modifying, changing, and/or maintaining one or more values of respective parameters corresponding to an appearance of the media item, such as a saturation value, a tone value, a color temperature value, a brightness value, an opaqueness value, and/or a contrast value, and/or adjusting, modifying, changing, and/or maintaining a color palette of colors displayed and/or included in the media item), wherein the second media style is different from the first media style, and wherein the second media style corresponds to a second category of media styles (e.g., the second media style described with reference to FIGS. 17AL and 17AM) (e.g., a second set of one or more media styles that cause a value of a respective parameter corresponding to an appearance of the media item to change from an original value to an updated value, where the difference between the original value and the updated value is above a threshold amount, a second set of one or more media styles corresponding to photography styles, such as vivid color styles and/or black-and-white styles, a second set of one or more media styles that are configured to be applied to a media item captured by one or more cameras that are in communication with the computer system in response to detecting additional user input) that is different from the first category of media styles. In some embodiments, a media style includes values for multiple visual parameters (e.g., saturation, tone, color temperature, brightness, contrast, and/or other visual parameters) and different media styles included different sets of values for the same visual parameters. In some embodiments, different media styles in the first category of media styles include different values for the visual parameters that are within a first set of threshold ranges for the visual parameters and different media styles in the second category of media styles include different values for the visual parameters that are outside of the first set of threshold ranges for the visual parameters (e.g., and within a second set of threshold ranges for the visual parameters, where the second set of threshold ranges are larger than the first set of threshold ranges).

In some embodiments, the computer system (e.g., 100, 300, 500, and/or 600) is configured to adjust media styles of the first category of media styles and media styles of the second category of media styles in response to adjustments to one or more adjustable controls (e.g., 616 and/or 617) (e.g., one or more adjustable controls displayed on the media user interface (e.g., 608, 626, 632, 1702, and/or 1714) and/or another user interface that enables adjustment to one or more parameters of a respective media style). In some embodiments, the computer system adjusts a tone curve (e.g., a slope and/or a growth rate of a tone curve) for media styles of the second category of media styles by a larger amount than media styles of the first category of media styles (e.g., as described with reference to FIG. 17AL). In some embodiments, the computer system adjusts a color (e.g., a saturation) of media items of the second category by a larger amount (e.g., a larger magnitude of shift) than media items of the first category (e.g., as described with reference to FIG. 17AM). In some embodiments, the computer system (e.g., 100, 300, 500, and/or 600) shifts an intensity of a color palette of media items of the second category by a larger amount than media styles of the first category (e.g., as described with reference to FIGS. 17AN-17AP).

Applying a first media style of a first category or a second media style of a second category to the media item based on a direction of user input allows a user to quickly select a respective media style of a particular category without having to provide additional user inputs to scroll through all media styles of a respective category before viewing media styles of the particular category, thereby reducing the number of inputs needed to perform an operation.

In some embodiments, in response to detecting the one or more user inputs (e.g., 650d, 650e, 650z, 650ad, 1750b, 1750c, 1750f, 1750g, 1750i, 1750k, 1750l, 1750q, 1750r, and/or 1750s) corresponding to the request to apply the respective media style to the media item (e.g., 604a, 608a, 614a, 622a, 622d, and/or 1716): in accordance with a determination that the one or more user inputs (e.g., 650d, 650e, 650z, 650ad, 1750b, 1750c, 1750f, 1750g, 1750i, 1750k, 1750l, 1750q, 1750r, and/or 1750s) include the first input in the first direction and a further input (e.g., a third tap gesture, swipe gesture, air gesture, and/or voice command) in the first direction (e.g., the further input is a continuation of the first input or an additional input that is in addition to the first input), computer system (e.g., 100, 300, 500, and/or 600) applies a third media style to the media item (e.g., 604a, 608a, 614a, 622a, 622d, and/or 1716) (e.g., adjusting, modifying, changing, and/or maintaining one or more values of respective parameters corresponding to an appearance of the media item, such as a saturation value, a tone value, a color temperature value, a brightness value, an opaqueness value, and/or a contrast value, and/or adjusting, modifying, changing, and/or maintaining a color palette of colors displayed and/or included in the media item), wherein: the third media style is different from the first media style, and the third media style corresponds to the first category of media styles (e.g., the third media style is a style in the first category of media styles). Applying a third media style of the first category when the one or more user inputs include the first input in the first direction and a further input the first direction allows a user to quickly view different media styles of the same category without requiring the user to navigate to another user interface and/or provide additional input, thereby reducing the number of inputs needed to perform an operation.

In some embodiments, in response to detecting the one or more user inputs (e.g., 650d, 650e, 650z, 650ad, 1750b, 1750c, 1750f, 1750g, 1750i, 1750k, 1750l, 1750q, 1750r, and/or 1750s) corresponding to the request to apply the respective media style to the media item (e.g., 604a, 608a, 614a, 622a, 622d, and/or 1716): in accordance with a determination that the one or more user inputs (e.g., 650d, 650e, 650z, 650ad, 1750b, 1750c, 1750f, 1750g, 1750i, 1750k, 1750l, 1750q, 1750r, and/or 1750s) include the second input in the second direction and a further input (e.g., a fourth tap gesture, swipe gesture, air gesture, and/or voice command) in the second direction (e.g., the further input is a continuation of the second input or an additional input that is in addition to the second input), computer system (e.g., 100, 300, 500, and/or 600) applies a fourth media style to the media item (e.g., 604a, 608a, 614a, 622a, 622d, and/or 1716), wherein: the fourth media style is different from the second media style (e.g., adjusting, modifying, changing, and/or maintaining one or more values of respective parameters corresponding to an appearance of the media item, such as a saturation value, a tone value, a color temperature value, a brightness value, an opaqueness value, and/or a contrast value, and/or adjusting, modifying, changing, and/or maintaining a color palette of colors displayed and/or included in the media item), and the fourth media style corresponds to the second category of media styles (e.g., the fourth media style is a style in the second category of media styles). Applying a fourth media style of the first category when the one or more user inputs include the second input in the second direction and a further input the second direction allows a user to quickly view different media styles of the same category without requiring the user to navigate to another user interface and/or provide additional input, thereby reducing the number of inputs needed to perform an operation.

In some embodiments, the first category of media styles includes changing one or more visual parameters (e.g., changing a saturation value, a tone value, a color temperature value, a brightness value, an opaqueness value, and/or a contrast value from an original value to an updated value) of the media item (e.g., 604a, 608a, 614a, 622a, 622d, and/or 1716) by less than a threshold amount (e.g., adjusting tone curves and/or color saturation as shown at FIGS. 17AL and 17AM) (e.g., a difference between an original value of a respective visual parameter and an updated value of the respective visual parameter is less than a threshold value), and the second category of media styles includes changing one or more visual parameters (e.g., changing a saturation value, a tone value, a color temperature value, a brightness value, an opaqueness value, and/or a contrast value from an original value to an updated value) of the media item (e.g., 604a, 608a, 614a, 622a, 622d, and/or 1716) by more than the threshold amount (e.g., adjusting tone curves and/or color saturation as shown at FIGS. 17AL and 17AM) (e.g., a difference between an original value of a respective visual parameter and an updated value of the respective visual parameter exceeds a threshold value). Grouping media styles based on an amount of change applied to one or more visual parameters allows a user to quickly view different media styles of the same category without requiring the user to navigate to another user interface and/or provide additional input, thereby reducing the number of inputs needed to perform an operation.

In some embodiments, the first category of media styles includes changing (e.g., shifting and/or modifying, such as shifting and/or modifying a respective hue) a first set of one or more colors (e.g., shifting a first set of colors as shown at FIG. 17AM) (e.g., one or more colors that are included within content of) of the media item (e.g., 604a, 608a, 614a, 622a, 622d, and/or 1716), and the second category of media styles includes changing (e.g., shifting and/or modifying, such as shifting and/or modifying a respective hue) a second set of one or more colors (e.g., shifting a second set of color as shown at FIG. 17AM) (e.g., one or more colors that are included within content of) of the media item (e.g., 604a, 608a, 614a, 622a, 622d, and/or 1716), wherein the second set of one or more colors includes more colors than the first set of one or more colors (e.g., the second category of media styles changes and/or shifts more colors than the first category of media styles). Grouping media styles based on an amount of colors of a media item that are changed allows a user to quickly view different media styles of the same category without requiring the user to navigate to another user interface and/or provide additional input, thereby reducing the number of inputs needed to perform an operation.

In some embodiments, the first category of media styles includes changing (e.g., shifting and/or modifying, such as shifting and/or modifying a respective hue) one or more first colors (e.g., one or more colors that are included within content of) of the media item (e.g., 604a, 608a, 614a, 622a, 622d, and/or 1716) by less than a threshold amount (e.g., an amount of color shift shown at FIG. 17AM) (e.g., a difference between an original value of a respective color and an updated value of the respective color is less than a threshold value), and the second category of media styles includes changing (e.g., shifting and/or modifying, such as shifting and/or modifying a respective hue) one or more second colors (e.g., one or more colors that are included within content of) of the media item (e.g., 604a, 608a, 614a, 622a, 622d, and/or 1716) by more than the threshold amount (e.g., an amount of color shift shown at FIG. 17AM) (e.g., a difference between an original value of a respective color and an updated value of the respective color exceeds a threshold value). Grouping media styles based on an amount of change applied to one or more colors allows a user to quickly view different media styles of the same category without requiring the user to navigate to another user interface and/or provide additional input, thereby reducing the number of inputs needed to perform an operation.

In some embodiments, a first range of values (e.g., a set of values from a minimum value to a maximum value) corresponding to a respective visual parameter (e.g., a saturation value, a tone value, a color temperature value, a brightness value, an opaqueness value, and/or a contrast value) for the first category of media styles includes a first maximum value (e.g., a maximum adjustment to a tone curve as shown at FIG. 17AL and/or a maximum color shift as shown at FIG. 17AM) (e.g., a largest value that the respective parameter can be adjusted to and/or set at) and a first minimum value (e.g., a minimum adjustment to a tone curve as shown at FIG. 17AL and/or a minimum color shift as shown at FIG. 17AM) (e.g., a smallest value that the respective parameter can be adjusted to and/or set at), a second range of values (e.g., a set of values from a minimum value to a maximum value) corresponding to a respective visual parameter (e.g., a saturation value, a tone value, a color temperature value, a brightness value, an opaqueness value, and/or a contrast value) for the second category of media styles includes a second maximum value (e.g., a maximum adjustment to a tone curve as shown at FIG. 17AL and/or a maximum color shift as shown at FIG. 17AM) (e.g., a largest value that the respective parameter can be adjusted to and/or set at) that is greater than the first maximum value and a second minimum value (e.g., a minimum adjustment to a tone curve as shown at FIG. 17AL and/or a minim color shift as shown at FIG. 17AM) (e.g., a smallest value that the respective parameter can be adjusted to and/or set at) that is less than the first minimum value (e.g., the second range of values includes more values than the first range of values, the second range of values is larger than the first range of values, and/or the maximum range of values for the second category of media styles is larger than the maximum range of values for the first category of media styles). Grouping media styles based on an amount of change that can applied to one or more visual parameters allows a user to quickly view different media styles of the same category without requiring the user to navigate to another user interface and/or provide additional input, thereby reducing the number of inputs needed to perform an operation.

In some embodiments, after detecting the one or more user inputs (e.g., 650d, 650e, 650z, 650ad, 1750b, 1750c, 1750f, 1750g, 1750i, 1750k, 1750l, 1750q, 1750r, and/or 1750s) corresponding to the request to apply the respective media style to the media item (e.g., 604a, 608a, 614a, 622a, 622d, and/or 1716), computer system (e.g., 100, 300, 500, and/or 600) detects, via the one or more input devices (e.g., 600a and/or 602), one or more user inputs (e.g., 1750h) (e.g., a tap gesture corresponding to a capture user interface object, a touch gesture corresponding to a capture user interface object, a button press of a physical hardware input device and/or button, a click of a mouse and/or trackpad while a cursor is displayed over a capture user interface object, tap gestures, swipe gestures, air gestures, and/or voice commands) corresponding to a request to capture a new media item (e.g., 604a, 608a, 614a, 622a, 622d, and/or 1716) (e.g., the one or more user inputs correspond to selection of a shutter button that, when selected, causes the computer system to capture a media item via one or more cameras that are in communication with the computer system); in response to detecting the one or more user inputs (e.g., 1750h) corresponding to the request to capture the new media item (e.g., 604a, 608a, 614a, 622a, 622d, and/or 1716): in accordance with a determination that the respective media style is of the first category of media styles (e.g., the respective media style configured to be and/or selected to be applied to the new media item while detecting the one or more user inputs corresponding to the request to capture the new media item), computer system (e.g., 100, 300, 500, and/or 600) applies the respective media style of the first category of media styles to the new media item (e.g., 604a, 608a, 614a, 622a, 622d, and/or 1716) (e.g., media styles of the first category of media styles are configured to be applied to new media items captured by the computer system even after navigating away from the media user interface, after a camera session ends, and/or after a time threshold is met); and in accordance with a determination that the respective media style is of the second category of media styles (e.g., the respective media style configured to be and/or selected to be applied to the new media item while detecting the one or more user inputs corresponding to the request to capture the new media item), computer system (e.g., 100, 300, 500, and/or 600) applies a default media style (e.g., a system defined media style or a user defined media style) to the new media item (e.g., 604a, 608a, 614a, 622a, 622d, and/or 1716) (e.g., media styles of the second category of media styles are not configured to be applied to new media items captured by the computer system after navigating away from the media user interface, after a camera session ends, and/or after a time threshold is met), wherein the default media style is different from the respective media style of the second category of media styles. Applying the respective media style of the first category or a default media style based on the currently selected media style being the first category or the second category allows a user to permanently apply media styles of the first category without providing additional input to select a respective media style of the first category, thereby reducing the number of inputs needed to perform an operation.

In some embodiments, the first category of media styles adjust one or more visual parameters of the media item (e.g., 604a, 608a, 614a, 622a, 622d, and/or 1716) that cause skin tones of the media item (e.g., 604a, 608a, 614a, 622a, 622d, and/or 1716) (e.g., content of the media item includes one or more persons with exposed skin) to change by a first amount (e.g., an amount shown in region 1780 at FIGS. 17AN-17AP) (e.g., a value of the one or more visual parameters changes by a first amount, such that the appearance of skin included in the media item changes by a first amount), and the second category of media styles adjust one or more visual parameters of the media item (e.g., 604a, 608a, 614a, 622a, 622d, and/or 1716) that cause skin tones of the media item (e.g., 604a, 608a, 614a, 622a, 622d, and/or 1716) to change by a second amount (e.g., an amount shown in region 1780 at FIGS. 17AN-17AP) (e.g., a value of the one or more visual parameters changes by a second amount, such that the appearance of skin included in the media item changes by a second amount) that is greater than the first amount (e.g., media styles of the second category cause skin tone changes more than media styles of the first category and/or media styles of the first category preserve skin tones more than media styles of the second category). Providing different categories of media styles that change skin tones included in the media item by different amounts allows a user to quickly navigate to and select a media style that changes the skin tones by a desired amount, thereby reducing the number of inputs needed to perform an operation.

In some embodiments, in response to detecting the one or more user inputs (e.g., 650d, 650e, 650z, 650ad, 1750b, 1750c, 1750f, 1750g, 1750i, 1750k, 1750l, 1750q, 1750r, and/or 1750s) corresponding to the request to apply the respective media style to the media item (e.g., 604a, 608a, 614a, 622a, 622d, and/or 1716): computer system (e.g., 100, 300, 500, and/or 600) selects the respective media style (e.g., emphasizing a user interface object corresponding to the respective media style, applying the respective media style to the media item, displaying the media item with the respective media style, and/or updating an appearance of the media item based on the respective media style); and computer system (e.g., 100, 300, 500, and/or 600) displays, via the display generation component (e.g., 602), a first category indicator (e.g., 1711 and/or 1722) (e.g., text, an image, an icon, and/or a visual element that identifies a category of the respective media style, such as the first category of media styles or the second category of media styles) corresponding to the respective media style. In some embodiments, displaying the first category indicator (e.g., 1711 and/or 1722) corresponding to the respective media style includes: in accordance with a determination that the respective media style is of the first category of media styles, displaying the first category indicator (e.g., 1711 and/or 1722) with a first appearance; and in accordance with a determination that the respective media style is of the second category of media styles, displaying the first category indicator (e.g., 1711 and/or 1722) with a second appearance that is different from the first appearance. In some embodiments, the first appearance includes text, images, icons, and/or user interface elements describing and/or identifying the first category of media styles. In some embodiments, the second appearance includes text, images, icons, and/or user interface elements describing and/or identifying the second category of media styles. Displaying the first category indicator in response to detecting the one or more user inputs corresponding to the request to apply the respective media style to the media item provides a user with feedback about which category the respective media style corresponds, thereby providing improved visual feedback to the user.

In some embodiments, while displaying the first category indicator (e.g., 1711 and/or 1722) corresponding to the respective media style, computer system (e.g., 100, 300, 500, and/or 600) detects, via the one or more input devices, one or more user inputs (e.g., 650d, 650e, 650z, 650ad, 1750b, 1750c, 1750f, 1750g, 1750i, 1750k, 1750l, 1750q, 1750r, and/or 1750s) (e.g., a swipe gesture corresponding to a user interface that includes display of the one or more media items, a swipe gesture corresponding to the one or more media items, a swipe gesture corresponding to a plurality of media style indicators, a tap gesture on a respective media style indicator of a plurality of media style indicators, a click of a mouse and/or trackpad while a cursor is displayed on a respective media style indicator of a plurality of media style indicators, tap gestures, swipe gestures, air gestures, and/or voice commands) corresponding to a request to apply a new media style to the media item (e.g., 604a, 608a, 614a, 622a, 622d, and/or 1716) (e.g., a media style that is different from the respective media style); and in response to detecting the one or more user inputs (e.g., 650d, 650e, 650z, 650ad, 1750b, 1750c, 1750f, 1750g, 1750i, 1750k, 1750l, 1750q, 1750r, and/or 1750s) corresponding to the request to apply the new media style to the media item (e.g., 604a, 608a, 614a, 622a, 622d, and/or 1716): in accordance with a determination that the new media style is of the same category as the respective media style (e.g., the new media style and the respective media style both correspond to the same category of media styles, such as the first category of media styles or the second category of media styles), computer system (e.g., 100, 300, 500, and/or 600) displays (e.g., maintaining display and/or re-displaying), via the one or more display generation components (e.g., 602), the first category indicator (e.g., 1711 and/or 1722); and in accordance with a determination that the new media style is a different category from the respective media style (e.g., the new media style and the respective media style do not correspond to the same category of media styles, such as the new media style corresponding to the first category of media styles and the respective media style corresponding to the second category of media styles, or vice versa), computer system (e.g., 100, 300, 500, and/or 600) displays, via the one or more display generation components (e.g., 602), a second category indicator (e.g., 1711 and/or 1722) (e.g., text, an image, an icon, and/or a visual element that identifies a category of the respective media style, such as the first category of media styles or the second category of media styles) corresponding to the new media style (e.g., the first category indicator and the second category indicator are different, such as include different information and/or include different appearances). Displaying the first category indicator or the second category indicator based on which media style category the new media style corresponds provides a user with feedback about which category the respective media style corresponds, thereby providing improved visual feedback to the user.

In some embodiments, while a respective media style of the first category of media styles is applied to the media item (e.g., 604a, 608a, 614a, 622a, 622d, and/or 1716) (e.g., while the respective media style of the first category of media styles is selected and/or while the computer system displays the media item with an appearance that is based on the respective media style of the first category of media styles), computer system (e.g., 100, 300, 500, and/or 600) displays, via the one or more display generation components (e.g., 602), a first set of style control options (e.g., 616 and/or 617) (e.g., buttons, affordances, graphical user interface elements, two-dimensional regions, scrubbers, sliders, and/or a selectable icons that adjust and/or change one or more values of respective visual parameters corresponding to the respective media style of the first category of media styles); while displaying the first set of style control options (e.g., 616 and/or 617), computer system (e.g., 100, 300, 500, and/or 600) detects, via the one or more input devices (e.g., 600a and/or 602), one or more user inputs (e.g., 1750d, 1750e, 1750n, and/or 1750o) (e.g., a touch and drag input corresponding to a parameter index point of the respective style control element, a swipe gesture corresponding to the parameter index point of the respective style control element, a tap gesture corresponding to a two-dimensional region of the respective style control element, and/or an input directed to a mouse and/or trackpad while a cursor is displayed over a two-dimensional region of the respective style control element, one or more tap gestures, swipe gestures, touch gestures, air gestures, button presses, and/or voice commands) corresponding to a respective style control option (e.g., 616 and/or 617) of the first set of style control options (e.g., 616 and/or 617) (e.g., the respective style control option of the first set of style control options corresponds to a respective visual parameter of the respective media style of the first category of media styles), wherein the one or more user inputs (e.g., 1750d, 1750e, 1750n, and/or 1750o) include a request to adjust a current value of a respective parameter of the respective media style of the first category of media styles (e.g., the one or more user inputs correspond to the respective style control option of the first style control options and include a request to change a current value of a respective visual parameter of the respective media style of the first category of media styles); and in response to detecting the one or more user inputs (e.g., 1750d, 1750e, 1750n, and/or 1750o) corresponding to the respective style control option (e.g., 616 and/or 617) of the first set of style control options (e.g., 616 and/or 617), computer system (e.g., 100, 300, 500, and/or 600) adjusts (e.g., changing, updating, and/or modifying) the current value (e.g., a currently applied value of the respective parameter of the respective media style of the first category of media styles, such as a default value or a user-defined value) of the respective parameter of the respective media style to an updated value (e.g., as represented by adjustments to 616 shown at FIGS. 17AL-17AP) (e.g., a value of the respective parameter that is based on, such as based on a magnitude and/or direction of, the one or more user inputs corresponding to the respective style control option of the first set of style control options). In some embodiments, the respective style control option (e.g., 616 and/or 617) includes a two-dimensional region (e.g., 616) and/or grid having a first axis (e.g., 616a) and a second axis (e.g., 616b), where the first axis (e.g., 616a) and the second axis (e.g., 616b) are perpendicular to one another. In some embodiments, the one or more user inputs (e.g., 1750d, 1750e, 1750n, and/or 1750o) corresponding to the respective style control option (e.g., 616 and/or 617) include a user input (e.g., 1750d, 1750e, 1750n, and/or 1750o) that includes a change in position of a parameter index point (e.g., 616c) of the two-dimensional region (e.g., 616) and/or grid. In some embodiments, the computer system (e.g., 100, 300, 500, and/or 600) is configured to adjust a first parameter (e.g., tone and/or a tone curve) of a respective media style in response to a change in the position of the parameter index point (e.g., 616c) relative to the first axis (e.g., 616a). In some embodiments, the computer system (e.g., 100, 300, 500, and/or 600) is configured to adjust a second parameter (e.g., color and/or color saturation) of a respective media style in response to a change in the position of the parameter index point (e.g., 616c) relative to the second axis (e.g., 616b). In some embodiments, the respective style control option (e.g., 616 and/or 617) includes a slider (e.g., 617). In some embodiments, the computer system (e.g., 100, 300, 500, and/or 600) is configured to adjust an intensity and/or a magnitude of a color palette of the respective media style in response to user input corresponding to the slider (e.g., 617) (e.g., as shown at FIGS. 17AN-17AP). In some embodiments, respective media styles of the first category of media styles include one or more parameters that are configured to be adjusted based on selected values of the one or more parameters. In some embodiments, the values of the one or more parameters are selected in response to user input corresponding to one or more style control options corresponding to the respective media style. Adjusting the current value of the respective parameter of the respective media style to the updated value in response to detecting the one or more user inputs corresponding to the respective style control option allows a user of the computer system to customize a respective media style without requiring the user to navigate to another user interface, thereby reducing the number of inputs needed to perform an operation.

In some embodiments, while a third media style (e.g., a media style corresponding to style selection indicator 1704c and/or style indicator 1718d) that corresponds to a standard category of media styles (e.g., a category of media styles that includes original visual parameters of a media item and/or a category of media styles that adjusts and/or modifies visual parameters of the media item by less than a threshold amount) is applied to the media item (e.g., 604a, 608a, 614a, 622a, 622d, and/or 1716) (e.g., the third media style is selected and/or the computer system displays the media item with an appearance that is based on the third media style), computer system (e.g., 100, 300, 500, and/or 600) displays, via the one or more display generation components (e.g., 602), a second set of style control options (e.g., 616) (e.g., buttons, affordances, graphical user interface elements, two-dimensional regions, scrubbers, sliders, and/or a selectable icons that adjust and/or change one or more values of respective visual parameters corresponding to the third media style of the standard category of media styles), wherein the second set of style control options (e.g., 616) include less options than the first set of style control options (e.g., the second set of style control options does not include 617) (e.g., the third media style that corresponds to the standard category of media styles includes fewer options for adjusting visual parameters of the media item when compared to the respective media style of the first category of media styles). In some embodiments, the third media style that corresponds to the standard category of media styles includes fewer adjustments to visual parameters of the media item (e.g., 604a, 608a, 614a, 622a, 622d, and/or 1716) as compared to respective media styles of the first category of media styles (and, optionally, respective media styles of the second category of media styles). In some embodiments, the third media style that corresponds to the standard category of media styles includes fewer options for customizing an appearance of the media item (e.g., 604a, 608a, 614a, 622a, 622d, and/or 1716) as compared to respective media styles of the first category of media styles (and, optionally, respective media styles of the second category of media styles). In some embodiments, the third media style that corresponds to the standard category of media styles does not adjust and/or change original colors of the media item (e.g., 604a, 608a, 614a, 622a, 622d, and/or 1716), such that the computer system (e.g., 100, 300, 500, and/or 600) does not display a color adjustment slider (e.g., 617) while the third media style is applied to the media item (e.g., 604a, 608a, 614a, 622a, 622d, and/or 1716). Displaying fewer controls while the third media style corresponding to the standard category of media styles is applied to the media item provides feedback about the available customization options for the respective media style, thereby providing improved visual feedback to the user.

In some embodiments, while a selected media style (e.g., a respective media style of a respective category of media styles is currently selected based on one or more detected user inputs) is applied to the media item (e.g., 604a, 608a, 614a, 622a, 622d, and/or 1716) (e.g., the selected media style is selected and/or the computer system displays the media item with an appearance that is based on the selected media style), computer system (e.g., 100, 300, 500, and/or 600) detects, via the one or more input devices (e.g., 600a and/or 602), one or more user inputs (e.g., 650d, 650e, 650z, 650ad, 1750b, 1750c, 1750f, 1750g, 1750i, 1750k, 1750l, 1750q, 1750r, and/or 1750s) (e.g., a tap gesture corresponding to a style indicator, a touch gesture corresponding to a style indicator, a click of a mouse and/or trackpad while a cursor is displayed over a style indicator, one or more tap gestures, swipe gestures, touch gestures, air gestures, button presses, and/or voice commands) corresponding to selection of a style indicator (e.g., 1704a-1704e and/or 1718a-1718j) (e.g., a button, an affordance, a graphical user interface element, and/or a selectable icon corresponding to the selected media style) of the media editing user interface (e.g., 608, 626, 632, 1702, and/or 1714) (e.g., the style indicator is displayed on the media editing user interface), wherein the style indicator (e.g., 1704a-1704e and/or 1718a-1718j) corresponds to the selected media style (e.g., the style indicator is displayed with an emphasis, such as highlighting, an increased size, an outline, an increased brightness, and/or displayed at a particular location, while the selected media style is selected to visually indicate that the style indicator corresponds to the selected media style); and in response to detecting the one or more user inputs (e.g., 650d, 650e, 650z, 650ad, 1750b, 1750c, 1750f, 1750g, 1750i, 1750k, 1750l, 1750q, 1750r, and/or 1750s) corresponding to selection of the style indicator (e.g., 1704a-1704e and/or 1718a-1718j), computer system (e.g., 100, 300, 500, and/or 600) displays, via the one or more display generation components (e.g., 602), a respective set of style control options (e.g., 616 and/or 617) (e.g., buttons, affordances, graphical user interface elements, two-dimensional regions, scrubbers, sliders, and/or a selectable icons that adjust and/or change one or more values of respective visual parameters corresponding to the respective media style of the first category of media styles). In some embodiments, the computer system (e.g., 100, 300, 500, and/or 600) forgoes display of a respective set of style control options (e.g., 616 and/or 617) while displaying the media editing user interface (e.g., 608, 626, 632, 1702, and/or 1714) and while the selected media style is applied to the media item (e.g., 604a, 608a, 614a, 622a, 622d, and/or 1716). Displaying a respective set of style control options in response to detecting one or more user input corresponding to selection of the style indicator allows a user to access various controls for modifying a respective media style without requiring the user to navigate to another user interface, thereby reducing the number of inputs needed to perform an operation.

In some embodiments, the first set of style control options (e.g., 616 and/or 617) includes a media editing control user interface object (e.g., 616) (e.g., a button, an affordance, a graphical user interface element, a user selectable icon, and/or a region of the media editing control user interface that is configured to adjust one or more visual parameters and/or visual aspects of one or more media items), and the media editing control user interface object (e.g., 616) includes a two-dimensional region (e.g., 616) (e.g., a region of the media editing user interface, such as a visibly distinct region of the media editing user interface that is separate from one or more media items of the media editing user interface, that includes a first axis and a second axis that are perpendicular to one another to form a two-dimensional shape, such as a square, a rectangle, a rhombus, a diamond, a circle, and/or a two-dimensional polygon) that is configured to concurrently (e.g., at the same time and/or separately) adjust (e.g., adjust values of parameters of a respective media style as shown at FIGS. 17AL and 17AM) one or more current values of a first parameter of the media item (e.g., tone, saturation, color temperature, brightness, opaqueness, and/or contrast) and one or more current values of a second parameter of the media item (e.g., tone, saturation, color temperature, brightness, opaqueness, and/or contrast). In some embodiments, the first parameter and the second parameter are different from one another. In some embodiments, the media editing control user interface object (e.g., 616) includes a two-dimensional region (e.g., 616) and/or grid having a first axis (e.g., 616a) and a second axis (e.g., 616b), where the first axis (e.g., 616a) and the second axis (e.g., 616b) are perpendicular to one another. In some embodiments, the computer system (e.g., 100, 300, 500, and/or 600) is configured to adjust a first parameter (e.g., tone and/or a tone curve) of a respective media style in response to a change in position of a parameter index point (e.g., 616c) of the media editing control user interface object (e.g., 616) relative to the first axis (e.g., 616a). In some embodiments, the computer system (e.g., 100, 300, 500, and/or 600) is configured to adjust a second parameter (e.g., color and/or color saturation) of a respective media style in response to a change in the position of the parameter index point (e.g., 616c) of the media editing control user interface object (e.g., 616) relative to the second axis (e.g., 616b). Displaying a media editing control user interface object having a two-dimension region that is configured to concurrently adjust a first parameter and a second parameter of the media item enables the computer system to adjust one or both of the first parameter and the second parameter in response to detecting user input corresponding to the media editing control user interface object without requiring the user to provide additional user inputs and/or without requiring the computer system to display additional control options, thereby reducing the number of inputs needed to perform an operation and/or providing additional control options without cluttering the user interface with additional displayed controls.

In some embodiments, the first parameter of the media item (e.g., 604a, 608a, 614a, 622a, 622d, and/or 1716) includes saturation, and the one or more current values of the saturation of the media item (e.g., 604a, 608a, 614a, 622a, 622d, and/or 1716) are adjusted (e.g., adjusted as shown in FIG. 17AL and/or FIG. 17AM) (e.g., changed, modified, and/or altered) based on user input (e.g., 1750d, 1750e, 1750n, and/or 1750o) (e.g., a tap gesture, a swipe gesture, an air gesture, a touch input, a voice command, and/or a button press) that includes a change in position of a parameter index point (e.g., 616c) (e.g., based on movement of the input such as movement of a current value indicator that indicates a location of the parameter index point from a first location to a second location, or an input selecting a location that is different from a current location of the current value, such as a location that is different from a current value indicator that indicates a location of the parameter index point) relative to a first axis (e.g., 616a and/or 616b) (e.g., a first one-dimensional axis extending in a first direction) of the two-dimensional region (e.g., 616). In some embodiments, the parameter index point (e.g., 616c) is a system-defined and/or user-selected location and/or point within the two-dimension region (e.g., 616). In some embodiments, the two-dimensional region (e.g., 616) includes a current value indicator (e.g., 616c) that visually indicates a current location of the parameter index point (e.g., 616c). In some embodiments, the current value indicator (e.g., 616c) includes an object, an icon, and/or a graphical user interface element within the two-dimensional region (e.g., 616) that indicates the current value of the first parameter and/or the current value of the second parameter. In some embodiments, the first parameter of the media item (e.g., 604a, 608a, 614a, 622a, 622d, and/or 1716) is not adjusted based on user input that causes a change in position of the parameter index point (e.g., 616c) relative to the second axis (e.g., 616a and/or 616b). In some embodiments, the computer system (e.g., 100, 300, 500, and/or 600) shifts and/or adjusts the one or more current values of the saturation by shifting one or more colors of the respective media style by a magnitude and/or direction that is based on the user input (e.g., as shown at FIG. 17AM). In some embodiments, the direction of shift of the one or more colors of the respective media style is in a first direction when the user input corresponds to a request to increase the one or more values of the saturation. In some embodiments, the direction of shift of the one or more colors of the respective media style is in a second direction, opposite the first direction, when the user input corresponds to a request to decrease the one or more values of the saturation. Adjusting the one or more current values of the saturation of the media item based on user input including a change in position of a parameter index point relative to a first axis of the two-dimension region enables the computer system to adjust one or both of the first parameter and the second parameter in response to detecting user input corresponding to the media editing control user interface object without requiring the user to provide additional user inputs and/or without requiring the computer system to display additional control options, thereby reducing the number of inputs needed to perform an operation and/or providing additional control options without cluttering the user interface with additional displayed controls.

In some embodiments, the second parameter of the media item (e.g., 604a, 608a, 614a, 622a, 622d, and/or 1716) includes tone, the one or more current values of the tone of the media item include respective tone curves, and a respective tone curve of the media item is adjusted (e.g., adjusted as shown at FIG. 17AL) (e.g., changed, modified, and/or altered from a first tone curve to a second tone curve) based on user input (e.g., a tap gesture, a swipe gesture, an air gesture, a touch input, a voice command, and/or a button press) that includes a change in position of a parameter index point (e.g., 616c) (e.g., based on movement of the input such as movement of a current value indicator that indicates a location of the parameter index point from a first location to a second location, or an input selecting a location that is different from a current location of the current value, such as a location that is different from a current value indicator that indicates a location of the parameter index point) relative to a second axis (e.g., 616a and/or 616b) (e.g., a second one-dimensional axis extending in a second direction, different from the first direction) of the two-dimensional region (e.g., 616) (e.g., the second axis is different from the first axis and/or the first axis extends in a first direction and the second axis extends in a second direction that is different from the first direction and a point of intersection between the first axis and the second axis forms a right angle, such as a 90 degree angle, between the first axis and the second axis). In some embodiments, the second parameter of the media item is not adjusted based on user input that causes a change in position of the parameter index point (e.g., 616c) relative to the first axis (e.g., 616a and/or 616b). In some embodiments, the computer system (e.g., 100, 300, 500, and/or 600) adjusts a respective tone curve of the media item based on the user input (e.g., a magnitude and/or direction of the user input). In some embodiments, the computer system (e.g., 100, 300, 500, and/or 600) increases a growth factor of the respective tone curve when the user input includes a change in position of the parameter index point (e.g., 616c) in a first direction along the first axis (e.g., 616a and/or 616b). In some embodiments, the computer system (e.g., 100, 300, 500, and/or 600) increases a decay factor of the respective tone curve when the user input includes a change in position of the parameter index point (e.g., 616c) in a second direction, opposite the first direction, along the first axis (e.g., 616a and/or 616b). In some embodiments, the computer system (e.g., 100, 300, 500, and/or 600) adjusts the respective tone curve differently based on whether a portion of the media item (e.g., 604a, 608a, 614a, 622a, 622d, and/or 1716) includes a person. In some embodiments, the computer system (e.g., 100, 300, 500, and/or 600) applies more of a change to the respective tone curve (e.g., a larger change to the growth factor or the decay factor of the respective tone curve) for portions of the media item (e.g., 604a, 608a, 614a, 622a, 622d, and/or 1716) corresponding to background when compared to portions of the media item (e.g., 604a, 608a, 614a, 622a, 622d, and/or 1716) corresponding to a person. Adjusting the respective tone curve of the media item based on user input including a change in position of a parameter index point relative to a second axis of the two-dimension region enables the computer system to adjust one or both of the first parameter and the second parameter in response to detecting user input corresponding to the media editing control user interface object without requiring the user to provide additional user inputs and/or without requiring the computer system to display additional control options, thereby reducing the number of inputs needed to perform an operation and/or providing additional control options without cluttering the user interface with additional displayed controls.

In some embodiments, prior to (e.g., before) detecting the one or more user inputs corresponding to the respective style control option (e.g., 616 and/or 617) of the first set of style control options (e.g., 616 and/or 617), computer system (e.g., 100, 300, 500, and/or 600) displays, via the one or more display generation components (e.g., 602), a graphical user interface element (e.g., 1702d and/or 1702d) (e.g., a glyph, an icon, an image, and/or a visual element, such as a representation of a two-dimensional region) that includes a visual indication (e.g., 1702c and/or 1702d) (e.g., a dot, a point, a square, and/or an “X” positioned at a respective location within the graphical user interface element that corresponds to the current value of the respective parameter) of the current value of the respective parameter; computer system (e.g., 100, 300, 500, and/or 600) detects, via the one or more input devices (e.g., 600a and/or 602), one or more inputs (e.g., 1750c, 1750d, 1750n, and/or 1750o) (e.g., a touch and drag input corresponding to a parameter index point of the respective style control element, a swipe gesture corresponding to the parameter index point of the respective style control element, a tap gesture corresponding to a two-dimensional region of the respective style control element, and/or an input directed to a mouse and/or trackpad while a cursor is displayed over a two-dimensional region of the respective style control element) directed to the respective style control option (e.g., 616 and/or 617) of the first set of style control options (e.g., 616 and/or 617); and in response to detecting the one or more inputs (e.g., 1750c, 1750d, 1750n, and/or 1750o) directed to the respective style control option (e.g., 616 and/or 617) of the first set of style control options (e.g., 616 and/or 617), computer system (e.g., 100, 300, 500, and/or 600) updates (e.g., changing, modifying, and/or re-displaying) the graphical user interface element (e.g., 1702c and/or 1702d) to include a visual indication (e.g., 1702c and/or 1702d) (e.g., a dot, a point, a square, and/or an “X” positioned at a respective location within the graphical user interface element that corresponds to the updated value of the respective parameter) of the updated value of the respective parameter. Displaying the graphical user interface element that includes a visual indication of a current value and/or an updated value of the respective parameter allows a user to confirm that user input causes the value of the respective parameter to change, thereby providing improved visual feedback to the user.

In some embodiments, prior to (e.g., before) detecting the one or more user inputs (e.g., 1750c, 1750d, 1750n, and/or 1750o) corresponding to the respective style control option (e.g., 616 and/or 617) of the first set of style control options (e.g., 616 and/or 617), computer system (e.g., 100, 300, 500, and/or 600) displays, via the one or more display generation components (e.g., 602), a visual indication (e.g., 1708a-1708c) (e.g., text, numbers, an icon, an image, and/or a graphical user interface object) of the current value of the respective parameter, wherein the visual indication (e.g., 1708a-1708c) of the current value of the respective parameter is displayed proximate to (e.g., within a threshold distance of a position of the media item relative to a display area of the one or more display generation components) a position of the media item (e.g., 604a, 608a, 614a, 622a, 622d, and/or 1716) (e.g., a displayed position of the media item on the one or more display generation components) relative to the one or more display generation components (e.g., 602); computer system (e.g., 100, 300, 500, and/or 600) detects, via the one or more input devices (e.g., 600a and/or 602), one or more inputs (e.g., 1750c, 1750d, 1750n, and/or 1750o) (e.g., a touch and drag input corresponding to a parameter index point of the respective style control element, a swipe gesture corresponding to the parameter index point of the respective style control element, a tap gesture corresponding to a two-dimensional region of the respective style control element, and/or an input directed to a mouse and/or trackpad while a cursor is displayed over a two-dimensional region of the respective style control element) directed to the respective style control option (e.g., 616 and/or 617) of the first set of style control options (e.g., 616 and/or 617); and in response to detecting the one or more user inputs (e.g., 1750c, 1750d, 1750n, and/or 1750o) corresponding to the respective style control option (e.g., 616 and/or 617) of the first set of style control options (e.g., 616 and/or 617), computer system (e.g., 100, 300, 500, and/or 600) displays, via the one or more display generation components (e.g., 602), a visual indication (e.g., 1708a-1708c) (e.g., text, numbers, an icon, an image, and/or a graphical user interface object) of the updated value of the respective parameter, wherein the visual indication (e.g., 1708a-1708c) of the updated value of the respective parameter is displayed proximate to (e.g., within a threshold distance of a position of the media item relative to a display area of the one or more display generation components) the position of the media item (e.g., 604a, 608a, 614a, 622a, 622d, and/or 1716) (e.g., a displayed position of the media item on the one or more display generation components) relative to the one or more display generation components (e.g., 602). Displaying the visual indication of a current value and/or updated value of the respective parameter allows a user to confirm that user input causes the value of the respective parameter to change, thereby providing improved visual feedback to the user.

In some embodiments, the first set of style control options (e.g., 616 and/or 617) includes a slider user interface object (e.g., 617) (e.g., an interactive graphical user interface element that includes a point that is configured to move in at least two directions along the slider user interface object based on user input corresponding to the slider user interface object, where movement of the point along the slider user interface object causes adjustment of a value and/or magnitude of a respective parameter of a selected media style and/or a respective parameter of the media item). The first set of style control options including a slider user interface object allows a user to have finer control over adjustments to one or more parameters of a media style and/or the media item without requiring the user to navigate to another user interface, thereby reducing the number of inputs needed to perform an operation.

In some embodiments, a magnitude (e.g., a degree of change, such as an increase or a decrease) of a shift (e.g., an adjustment and/or a change to one or more vectors corresponding to respective colors) of one or more colors (e.g., a color palette and/or a set of colors that correspond to a currently selected media style) of the media item (e.g., 604a, 608a, 614a, 622a, 622d, and/or 1716) is adjusted (e.g., adjusted as shown at FIGS. 17AN-17AP) based on user input (e.g., 1750d and/or 1750o) (e.g., a tap gesture, a swipe gesture, an air gesture, a touch input, a voice command, and/or a button press) that includes a change in position of a point (e.g., 617a) (e.g., system-defined or user-selected location and/or point along a length of the slider user interface object) of the slider user interface object (e.g., 617). Adjusting a magnitude of a shift of one or more colors of the media item based on user input that changes a position of a point of the slider user interface object allows a user to have finer control over adjustments to colors of a media style and/or the media item without requiring the user to navigate to another user interface, thereby reducing the number of inputs needed to perform an operation.

In some embodiments, the shift of the one or more colors of the media item (e.g., 604a, 608a, 614a, 622a, 622d, and/or 1716) (e.g., the respective colors that are shifted, the direction in which the one or more colors are shifted, the magnitude and/or relative magnitude at which the one or more colors are shifted, and/or a maximum degree of color shifting) is based on a selected media style (e.g., as shown at FIGS. 17AN-17AP) (e.g., the adjustment to the magnitude of the shift of the one or more colors of the media item is different for different media styles and/or the adjustment to the magnitude of the shift of the one or more colors of the media item is based on the media item that is currently selected and/or applied to the media item). In some embodiments, while the first media style is applied to the media item (e.g., 604a, 608a, 614a, 622a, 622d, and/or 1716), the computer system (e.g., 100, 300, 500, and/or 600) detects one or more user inputs (e.g., 1750d and/or 1750o) corresponding to the slider user interface object (e.g., 617); and in response to detecting the one or more user inputs (e.g., 1750d and/or 1750o) corresponding to the slider user interface object (e.g., 617), the computer system (e.g., 100, 300, 500, and/or 600) adjusts a magnitude of a shift of one or more colors of the media item by a first amount (e.g., as illustrated at FIGS. 17AN-17AP). In some embodiments, while the second media style is applied to the media item, the computer system (e.g., 100, 300, 500, and/or 600) detects one or more user inputs (e.g., 1750d and/or 1750o) corresponding to the slider user interface object (e.g., 617); and in response to detecting the one or more user inputs (e.g., 1750d and/or 1750o) corresponding to the slider user interface object (e.g., 617), the computer system (e.g., 100, 300, 500, and/or 600) adjusts a magnitude of a shift of one or more colors of the media item by a second amount that is different from the first amount (e.g., as illustrated at FIGS. 17AN-17AP). The shift of the one or more colors of the media item being based on a selected media style allows a user to have finer control over adjustments to colors of the media item without requiring the user to navigate to another user interface, thereby reducing the number of inputs needed to perform an operation.

In some embodiments, the first media style of the first category media styles corresponds to one or more visual parameters (e.g., a saturation, tone, color temperature, brightness, opaqueness, and/or contrast) having a first set of respective values (e.g., default values indicated by 616d) (e.g., a first set of default and/or system-defined values corresponding to the one or more visual parameters that characterize the first media style of the first category of media styles before the computer system detects user input requesting to change a value of a respective visual parameter for the first media style of the first category of media styles); and the second media style of the second category of media styles corresponds to the one or visual parameters having a second set of respective values (e.g., default values indicated by 616d) (e.g., a second set of default and/or system-defined values corresponding to the one or more visual parameters that characterize the second media style of the second category of media styles before the computer system detects user input requesting to change a value of a respective visual parameter for the second media style of the second category of media styles) that are different from the first set of respective values. The first media style and the second media style corresponding to one or more visual parameters that have different sets of respective values allows a user to apply different values of the one or more visual parameters to the media item without having to navigate to another user interface, thereby reducing the number of inputs needed to perform an operation.

In some embodiments, the media user interface (e.g., 608, 626, 632, 1702, and/or 1714) includes one or more style control user interface objects (e.g., 616 and/or 617) (e.g., a two-dimensional region and/or a slider) that are configured to adjust the one or more visual parameters of the respective media style, and wherein the one or more style control user interface objects (e.g., 616 and/or 617) include a visual indication (e.g., 616d) (e.g., one or more dots displayed at location on the two-dimensional region and/or slider corresponding to a default value, an icon, an image, text, and/or a visual element) of a default value (e.g., a system-defined value of a respective parameter) of a respective parameter of the one or more visual parameters for the respective media style. In some embodiments, the computer system (e.g., 100, 300, 500, and/or 600) displays the visual indication (e.g., 616d) of the default value of the respective parameter of the one or more visual parameters of the respective media style in a two-dimensional region (e.g., 616) that controls respective values of the one or more visual parameters of the one or more visual parameters of the respective media style. In some embodiments, in accordance with a determination that the respective media style is a first media style (e.g., a media style of the first category of media styles or a media style of the second category of media styles), the computer system (e.g., 100, 300, 500, and/or 600) displays the visual indication (e.g., 616d) of the default value of the respective parameter of the one or more visual parameters at a first location relative to the two-dimensional region (e.g., 616). In some embodiments, in accordance with a determination that the respective media style is a second media style (e.g., a media style of the first category of media styles or a media style of the second category of media styles), the computer system (e.g., 100, 300, 500, and/or 600) displays the visual indication (e.g., 616d) of the default value of the respective parameter of the one or more visual parameters at a second location relative to the two-dimensional region (e.g., 616), where the second location is different from the first location. Displaying the visual indication of the default value of a respective parameter allows a user to view a current value of the respective parameter in relation to the default value and/or view how a change in the respective parameter from the default value changes an appearance of the media item, thereby providing improved visual feedback to the user.

In some embodiments, the visual indication (e.g., 616d) of the default value of the respective parameter of the one or more visual parameters for the respective media style is displayed at a first location (e.g., a first location relative to the one or more style control user interface objects, such as a first location relative to a two-dimensional region), and the one or more style control user interface objects (e.g., 616 and/or 617) include a visual indication (e.g., 616c) (e.g., one or more dots displayed at location on the two-dimensional region and/or slider corresponding to a current value, an icon, an image, text, and/or a visual element) of a current value (e.g., a user-defined value based on detected user input corresponding to the one or more style control user interface objects) of the respective parameter of the one or more visual parameters for the respective media style that is displayed at a second location (e.g., a second location relative to the one or more style control user interface objects, such as a second location relative to a two-dimensional region) different from the first location. Displaying the visual indication of the default value of a respective parameter and displaying the visual indication of the current value of the respective parameter allows a user to view a current value of the respective parameter in relation to the default value and/or view how a change in the respective parameter from the default value changes an appearance of the media item, thereby providing improved visual feedback to the user.

Note that details of the processes described above with respect to method 1800 (e.g., FIG. 18) are also applicable in an analogous manner to the methods described above/below. For example, methods 900, 1100, 1300, 1500, 1600, 1900, and/or 2100 optionally include one or more of the characteristics of the various methods described above with reference to method 1800. For example, the computer system of method 700 can be used to edit media styles that are selected using the computer system of method 1800. For example, the computer system of method 900 can be used to further edit video media items that include media styles applied using the computer system of method 1800. As another example, the computer system of method 1100 can be used to selectively apply edits made to a media item using the computer system of method 1800 from one media item to another media item. Further still, the computer system of method 1300 can be used to make additional edits to a media item that includes a media style applied using the computer system of method 1800. The computer system of method 1500 can be used to adjust and/or edit a playback speed of a media item that includes a media style applied using the computer system of method 1800. The computer system of method 1600 can be used to edit audio for a media item that includes a media style applied using the computer system of method 1800. The computer system of method 1900 can be used to select media items that include a media style applied using the computer system of method 1800 to preview a media style. The computer system of method 2100 can be used to make additional edits to a media item that includes a media style applied using the computer system of method 1800. For brevity, these details are not repeated below.

FIG. 19 is a flow diagram illustrating a method for previewing a media style using a computer system in accordance with some embodiments. Method 1900 is performed at a computer system (e.g., 100, 300, 500, and/or 600) (e.g., a smart phone, a smart watch, a tablet computer, a laptop computer, a desktop computer, a wearable device, and/or head-mounted device) that is in communication with (e.g., includes and/or is connected to) one or more input devices (e.g., 600a and/or 602) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). In some embodiments, the computer system is in communication with one or more display generation components (e.g., one or more displays, touch-screen displays, monitors, holographic display systems, and/or head-mounted display systems). Some operations in method 1900 are, optionally, combined, the orders of some operations are, optionally, changed, and some operations are, optionally, omitted.

As described below, method 1900 provides an intuitive way for previewing a media style. The method reduces the cognitive burden on a user for previewing a media style, thereby creating a more efficient human-machine interface. For battery-operated computing devices, enabling a user to manage photographic styles faster and more efficiently conserves power and increases the time between battery charges.

Computer system (e.g., 100, 300, 500, and/or 600) detects (1902), via the one or more input devices (e.g., 600a and/or 602), one or more user inputs (e.g., 1750t and/or 1750u) (e.g., tap gestures, swipe gestures, air gestures, and/or voice commands) corresponding to a request to configure (e.g., set, apply, select, and/or modify a media style that the computer system applies to media items captured via one or more cameras that are in communication with the computer system without requiring additional user input) a media style (e.g., one or more values of respective parameters corresponding to an appearance of the media item, such as a saturation value, a tone value, a color temperature value, a brightness value, an opaqueness value, and/or a contrast value, and/or a color palette of colors displayed and/or included in the media item) for a camera (e.g., optical sensors, depth sensors, and/or an imaging module that is configured to capture one or more images and/or videos) that is in communication with the computer system (e.g., 100, 300, 500, and/or 600) (e.g., media items, such as photos, images, sequences of images, and/or videos, captured via the camera include the media style and/or the computer system applies the media style to media items captured via the camera).

In response to detecting the one or more user inputs (e.g., 1750t and/or 1750u) corresponding to the request to configure the media style for the camera that is in communication with the computer system (e.g., 100, 300, 500, and/or 600), computer system (e.g., 100, 300, 500, and/or 600) prompts (1904) (e.g., 1728a and/or 1730a) (e.g., instructing and/or guiding by outputting (e.g., displaying text, an image, an icon, and/or a user interface object via a display generation component that is in communication with the computer system, outputting audio via a speaker that is in communication with the computer system, and/or outputting tactile feedback via a tactile generator that is in communication with the computer system) an indication (e.g., displayed text, audio, and/or tactile feedback)) a user to select one or more media items (e.g., 1732a-1732o) (e.g., one or more images, photos, videos, and/or screenshots) to preview (e.g., the computer system displays a respective media item of the one or more media items with a respective media style before applying the media style to media items captured via the camera that is in communication with the computer system) the media style, wherein the one or more media items (e.g., 1732a-1732o) correspond to an account of the user (e.g., the one or more media items were captured via the camera that is in communication with the computer system and/or captured via a camera that is in communication with another computer system that is different from the computer system). In some embodiments, the one or more media items (e.g., 1732a-1732o) that correspond to the account of the user include media items (e.g., 1732a-1732o) from a media library of the account of the user, such as one or more media items (e.g., 1732a-1732o) of a personal photo library and/or a personal video library of the user. Prompting the user to select one or more media items to preview a media style allows a user to view the change in appearance to the one or more media items when the media style is applied and determine whether to use and/or apply the media style for other media items, thereby providing improved visual feedback to the user.

In some embodiments, prompting (e.g., 1728a and/or 1730a) the user to select one or more media items (e.g., 1732a-1732o) to preview the media style includes prompting (e.g., 1728a and/or 1730a) the user to select two or more (e.g., 2, 4, or 9) media items (e.g., 1732a-1732o) to preview the media style (e.g., two or more media items that were captured via the camera that is in communication with the computer system, captured via a camera that is in communication with another computer system that is different from the computer system, and/or included in a media library associated with an account of the user of the computer system). Prompting the user to select two or more media items to preview a media style allows a user to view the change in appearance to multiple media items when the media style is applied and determine whether to use and/or apply the media style for other media items, thereby providing improved visual feedback to the user.

In some embodiments, the one or more media items (e.g., 1732a-1732o) are selected from a subset (e.g., a quantity of media items selected from a set of media items, where the quantity is less than a total quantity of the set of media items) of a set of media items (e.g., 1732a-1732o) (e.g., a set of media items of a media library corresponding to the account of the user) corresponding to the account of the user that satisfy a set of one or more criteria (e.g., media items captured via a respective type of camera and/or media items that include respective information, such as particular types of metadata and/or particular color information for the media item). The one or more media items including a subset of a set of media items corresponding to the account of the user that satisfy a set of one or more criteria allows a user to select media items that are configured to be displayed with an appearance that is based on the media style without requiring the user to determine which media items can be displayed with the appearance that is based on the media style, thereby reducing the number of inputs needed to perform an operation.

In some embodiments, after prompting (e.g., 1728a and/or 1730a) the user to select the one or more media items (e.g., 1732a-1732o) to preview the media style, computer system (e.g., 100, 300, 500, and/or 600) displays, via one or more display generation components (e.g., 602) that are in communication with the computer system (e.g., 100, 300, 500, and/or 600), the one or more media items (e.g., 1732b and 1732e-1732g) in a grid (e.g., arrangement of media items 1732b and 1732e-1732g shown at FIG. 17W) (e.g., a matrix and/or display framework that includes the one or more media items being displayed in respective rows and columns, where the number of rows and/or columns are optionally based on the number of the one or more media items). Displaying the one or more media items in a grid allows a user to view the change in appearance to multiple media items when the media style is applied and determine whether to use and/or apply the media style for other media items, thereby providing improved visual feedback to the user.

In some embodiments, after prompting (e.g., 1728a and/or 1730a) the user to select the one or more media items (e.g., 1732a-1732o) to preview the media style, computer system (e.g., 100, 300, 500, and/or 600) detects, via the one or more input devices (e.g., 600a and/or 602), one or more user inputs (e.g., 1750w and/or 1750x) (e.g., tapping on one or more media items and/or clicking a mouse and/or trackpad while a cursor is displayed over one or more media items, one or more tap gestures, swipe gestures, touch gestures, air gestures, button presses, and/or voice commands) corresponding to selection of the one or more media items (e.g., 1732a-1732o) (e.g., the one or more media items are selected from a plurality of media items via the one or more user inputs); and in response to detecting the one or more user inputs (e.g., 1750w and/or 1750x) corresponding to selection of the one or more media items (e.g., 1732a-1732o), computer system (e.g., 100, 300, 500, and/or 600) selects (e.g., as indicated by 1734) (e.g., emphasizing, such as highlighting, outlining, displaying a selection indicator on, increasing a size of, and/or increasing a brightness of, the one or more media items relative to one or more non-selected media items and/or displaying the one or more media items with an appearance that is based on the media style) the one or more media items (e.g., 1732a-1732o) to preview the media style. Selecting the one or more media items to preview the media style in response to detecting the one or more user inputs corresponding to selection of the one or more media items allows a user to view the change in appearance to the one or more media items when the media style is applied and determine whether to use and/or apply the media style for other media items, thereby providing improved visual feedback to the user.

In some embodiments, while the one or more media items (e.g., 1732b and 1732e-1732g) are selected (e.g., as indicated by 1734) (e.g., while the one or more media items are displayed without displaying one or more non-selected media items and/or while the one or more media items are displayed with an appearance that corresponds to the media style), computer system (e.g., 100, 300, 500, and/or 600) detects, via the one or more input devices (e.g., 600a and/or 602), one or more user inputs (e.g., 1750z, 1750aa, and/or 1750ac) (e.g., a swipe gesture corresponding to a user interface that includes display of the one or more media items, a swipe gesture corresponding to the one or more media items, a swipe gesture corresponding to a plurality of media style indicators, a tap gesture on a respective media style indicator of a plurality of media style indicators, a click of a mouse and/or trackpad while a cursor is displayed on a respective media style indicator of a plurality of media style indicators, one or more tap gestures, swipe gestures, touch gestures, air gestures, button presses, and/or voice commands) corresponding to a request to change the media style (e.g., change, transition, and/or switch the media style from a first media style to a second media style and/or adjust, modify, and/or change one or more parameters of a respective media style from a first set of parameters to a second set of parameters); and in response to detecting the one or more inputs (e.g., 1750z, 1750aa, and/or 1750ac) corresponding to the request to change the media style, computer system (e.g., 100, 300, 500, and/or 600) adjusts (e.g., changing, updating, and/or modifying) an appearance (e.g., one or more visual parameters) of the one or more media items (e.g., 1732b and 1732e-1732f) based on the change in the media style (e.g., changing the appearance of the one or more media items from a first appearance corresponding to a first media style and/or a first set of parameters for a respective media style to a second appearance corresponding to a second media style and/or a second set of parameters for the respective media style). Adjusting the appearance of the one or more media items based on a change in media style allows a user to view the change in appearance to the one or more media items when the media style is adjusted and determine whether to use and/or apply the adjusted media style for other media items, thereby providing improved visual feedback to the user.

In some embodiments, the one or more media items (e.g., 1732a-1732o) include a first media item (e.g., 1732b and/or 1732e-1732g) (e.g., a first image, photo, video, and/or screenshot) and a second media item (e.g., 1732b and/or 1732e-1732g) (e.g., a second image, photo, video, and/or screenshot), and adjusting the appearance of the one or more media items (e.g., 1732b and/or 1732e-1732g) based on the change in the media style includes concurrently (e.g., at the same time or separately) adjusting (e.g., adjusting one or more visual parameters of the one or more media items as illustrated at FIGS. 17AL-17AP) (e.g., changing, updating, and/or modifying) an appearance of the first media item (e.g., 1732b and/or 1732e-1732g) (e.g., one or more visual parameters of the first media item) and an appearance of the second media item (e.g., 1732b and/or 1732e-1732g) (e.g., one or more visual parameters of the second media item) based on the change in the media style. In some embodiments, adjusting the respective appearances of the first media item (e.g., 1732b and/or 1732e-1732g) and the second media item (e.g., 1732b and/or 1732e-1732g) based on the change in the media style includes adjusting a tone curve (e.g., as illustrated at FIG. 17AL) applied to one or more portions of the first media item (e.g., 1732b and/or 1732e-1732g) and/or the second media item (e.g., 1732b and/or 1732e-1732g), adjusting a value of saturation (e.g., as illustrated at FIG. 17AM) by shifting one or more colors included in the first media item (e.g., 1732b and/or 1732e-1732g) and/or the second media item (e.g., 1732b and/or 1732e-1732g), and/or applying a different color palette (e.g., as illustrated at FIGS. 17AN-17AP) to the first media item (e.g., 1732b and/or 1732e-1732g) and/or the second media item (e.g., 1732b and/or 1732e-1732g). Concurrently adjusting the appearance of the first media item and the appearance of the second media item based on a change in media style allows a user to view the change in appearance to multiple media items when the media style is adjusted and determine whether to use and/or apply the adjusted media style for other media items, thereby providing improved visual feedback to the user.

In some embodiments, after prompting (e.g., 1728a and/or 1730a) the user to select the one or more media items (e.g., 1732a-1732o) to preview the media style, computer system (e.g., 100, 300, 500, and/or 600) detects, via the one or more input devices (e.g., 600a and/or 602), one or more user inputs (e.g., 1750ab, 1750ae, and/or 1750af) (e.g., a double tap gesture corresponding to the one or more media items, a pinch gesture or de-pinch gesture corresponding to the one or more media items, a touch and drag gesture corresponding to the one or more media items, a double click of a mouse and/or trackpad while a cursor is displayed over the one or more media items, one or more tap gestures, pinch gestures, drag gestures, swipe gestures, touch gestures, air gestures, button presses, and/or voice commands) corresponding to a request to adjust a visual arrangement of the one or more media items (e.g., 1732b and/or 1732e-1732g) (e.g., a request to zoom into or out of a respective media item of the one or more media items, a request to zoom into or out of the one or more media items, a request to pan a respective media item of the one or more media items, or a request to pan from a first media item of the one or more media items to a second media item of the one or more media items); and in response to detecting the one or more user inputs (e.g., 1750ab, 1750ae, and/or 1750af) corresponding to the request to adjust the visual arrangement of the one or more media items (e.g., 1732b and/or 1732e-1732g), computer system (e.g., 100, 300, 500, and/or 600) adjusts (e.g., zooming, panning, transitioning between) the visual arrangement of a respective media item (e.g., 1732b and/or 1732e-1732g) (and, optionally, all of the media items of the one or more media items) of the one or more media items (e.g., 1732b and/or 1732e-1732g) from a first visual arrangement (e.g., an arrangement shown at FIG. 17AA) to a second visual arrangement (e.g., an arrangement shown at FIG. 17AB) that is different from the first visual arrangement (e.g., adjust from a first zoom level to a second zoom level, adjust from a first display location to a second display location, or adjust from a first media item to a second media item). Adjusting the visual arrangement of a respective media item of the one or more media items in response to detecting the one or more user inputs corresponding to the request to adjust the visual arrangement of the one or more media items allows a user to view different zoom levels, different portions, and/or different media items with the media style applied, thereby providing improved visual feedback to the user.

In some embodiments, while displaying the respective media item (e.g., 1732b and/or 1732e-1732g) of the one or more media items (e.g., 1732a-1732o) in the second visual arrangement (e.g., an arrangement shown at FIG. 17AB) (e.g., a display orientation that is based on the one or more user inputs corresponding to the request to adjust the display orientation of the one or more media items), computer system (e.g., 100, 300, 500, and/or 600) detects, via the one or more input devices (e.g., 600a and/or 602), one or more user inputs (e.g., 1750ac) (e.g., a swipe gesture corresponding to a user interface that includes display of the one or more media items, a swipe gesture corresponding to the one or more media items, a swipe gesture corresponding to a plurality of media style indicators, a tap gesture on a respective media style indicator of a plurality of media style indicators, a click of a mouse and/or trackpad while a cursor is displayed on a respective media style indicator of a plurality of media style indicators, one or more tap gestures, pinch gestures, drag gestures, swipe gestures, touch gestures, air gestures, button presses, and/or voice commands) corresponding to a request to change the media style (e.g., transition from a first media style that is applied to the one or more media items to a second media style that is applied to the one or more media items and/or adjusting one or more parameters of a respective media style); and in response to detecting the one or more user inputs (e.g., 1750ac) corresponding to the request to change the media style, computer system (e.g., 100, 300, 500, and/or 600) adjusts (e.g., changing, updating, and/or modifying) an appearance of the respective media item (e.g., an appearance of 1732b shown at FIG. 17AB compared to an appearance of 1732b shown at FIG. 17AD) (e.g., one or more visual parameters of the respective media item while the respective media item is displayed at the second display orientation) of the one or more media items (e.g., 1732b and/or 1732e-1732g) while maintaining display of the respective media item (e.g., 1732b and/or 1732e-1732g) of the one or more media items (e.g., 1732a-1732o) at the second visual arrangement (e.g., the computer system maintains the display orientation of the one or more media items while adjusting a media style and/or transitioning between media styles). Adjusting the appearance of the respective media item while maintaining display of the respective media item at the second visual arrangement in response to detecting the one or more user inputs corresponding to the request to change the media style allows a user to view different zoom levels, different portions, and/or different media items with different media styles applied, thereby providing improved visual feedback to the user.

In some embodiments, while displaying the respective media item (e.g., 1732b and/or 1732e-1732g) of the one or more media items (e.g., 1732a-1732o) in the second visual arrangement (e.g., an arrangement shown at FIG. 17AF) (e.g., a display orientation that is based on the one or more user inputs corresponding to the request to adjust the display orientation of the one or more media items) and with a first appearance (e.g., an appearance shown at FIG. 17AF) that corresponds to the media style (e.g., an appearance of the media item that is based on a currently selected media style that is applied to the respective media item), computer system (e.g., 100, 300, 500, and/or 600) detects, via the one or more input devices (e.g., 600a and/or 602), one or more user inputs (e.g., 1750af) (e.g., a double tap gesture corresponding to the one or more media items, a pinch gesture or de-pinch gesture corresponding to the one or more media items, a touch and drag gesture corresponding to the one or more media items, a double click of a mouse and/or trackpad while a cursor is displayed over the one or more media items, one or more tap gestures, pinch gestures, drag gestures, swipe gestures, touch gestures, air gestures, button presses, and/or voice commands) corresponding to a request to adjust the visual arrangement of the one or more media items (e.g., 1732b and/or 1732e-1732g) (e.g., a request to zoom into or out of a respective media item of the one or more media items, a request to zoom into or out of the one or more media items, a request to pan a respective media item of the one or more media items, or a request to pan from a first media item of the one or more media items to a second media item of the one or more media items); and in response to detecting the one or more user inputs (e.g., 1750af) corresponding to the request to adjust the visual arrangement of the one or more media items (e.g., 1732b and/or 1732e-1732g), computer system (e.g., 100, 300, 500, and/or 600) displays, via one or more display generation components (e.g., 602) that are in communication with the computer system (e.g., 100, 300, 500, and/or 600), the respective media item (e.g., 1732b and/or 1732e-1732g) of the one or more media items in a third visual arrangement (e.g., a visual arrangement shown at FIG. 17AG) (e.g., adjust from a first zoom level to a second zoom level, adjust from a first display location to a second display location of the same media item, or adjust from a first media item to a second media item) and with a second appearance (e.g., an appearance shown at FIG. 17AG) that corresponds to the media style (e.g., the computer system applies the same media style to the respective media item displayed at the third display orientation and/or the computer system maintains the same media style that is applied to the one or more media items in response to detecting a request to adjust and/or change a display orientation of the one or more media items). Displaying the respective media item in the third visual arrangement with a second appearance that corresponds to the media style in response to detecting the one or more user inputs corresponding to the request to adjust the visual arrangement of the one or more media items allows a user to view different zoom levels, different portions, and/or different media items without having to provide additional user input to re-apply a respective media style, thereby reducing the number of inputs needed to perform an operation.

In some embodiments, after prompting (e.g., 1728a and/or 1730a) the user to select one or more media items (e.g., 1732a-1732o) to preview the media style, computer system (e.g., 100, 300, 500, and/or 600) detects, via the one or more input devices (e.g., 600a and/or 602), one or more user inputs (e.g., 1750ad) (e.g., a tap gesture corresponding to a confirmation user interface object, a touch gesture corresponding to a confirmation user interface object, a click of a mouse and/or trackpad while a cursor is displayed over a confirmation user interface object, one or more tap gestures, pinch gestures, drag gestures, swipe gestures, touch gestures, air gestures, button presses, and/or voice commands) corresponding to a request to confirm the media style (e.g., select a respective media style to apply to the one or more media items, to apply to media items captured via one or more cameras in communication with the computer system, and/or to apply to media items already captured and/or included in a media library corresponding to the account of the user); and after detecting the one or more user inputs (e.g., 1750ad) corresponding to the request to confirm the media style, computer system (e.g., 100, 300, 500, and/or 600) displays, via one or more display generation components (e.g., 602) that are in communication with the computer system (e.g., 100, 300, 500, and/or 600), a style editing user interface object (e.g., 616 and/or 617) (e.g., a two-dimensional region and/or a slider) that is configured to cause an adjustment to one or more parameters of the media style (e.g., change, modify, and/or update one or more parameters corresponding to the media style). In some embodiments, the style editing user interface object (e.g., 616 and/or 617) includes a two-dimensional region (e.g., 616) (e.g., a region of the media editing user interface, such as a visibly distinct region of the media editing user interface that is separate from one or more media items of the media editing user interface, that includes a first axis and a second axis that are perpendicular to one another to form a two-dimensional shape, such as a square, a rectangle, a rhombus, a diamond, a circle, and/or a two-dimensional polygon) that is configured to concurrently (e.g., at the same time and/or separately) adjust one or more current values of a first parameter of the media item (e.g., tone, saturation, color temperature, brightness, opaqueness, and/or contrast) and one or more current values of a second parameter of the media item (e.g., tone, saturation, color temperature, brightness, opaqueness, and/or contrast) (in some embodiments, the first parameter and the second parameter are different from one another). Displaying the style editing user interface object after detecting the one or more user inputs corresponding to the request to confirm the media style allows a user to customize the media style without the user having to navigate to another user interface, thereby reducing the number of inputs needed to perform an operation.

In some embodiments, while displaying the style editing user interface object (e.g., 616 and/or 617) that is configured to cause the adjustment to one or more parameters of the media style, computer system (e.g., 100, 300, 500, and/or 600) displays, via the one or more display generation components (e.g., 602) that are in communication with the computer system (e.g., 100, 300, 500, and/or 600), a tutorial animation (e.g., an animation on user interface 1746) (e.g., a series of images and/or a video that includes guidance to a user about how to interact with the style editing user interface object to customize and/or change one or more parameters of the media style) prompting the user to provide one or more user inputs (e.g., 1750ag and/or 1750ah) (e.g., one or more tap gestures, pinch gestures, drag gestures, swipe gestures, touch gestures, air gestures, button presses, and/or voice commands) corresponding to the style editing user interface object (e.g., 616 and/or 617) (e.g., prompting the user to test an interaction with the style editing user interface object to learn how to use the style editing user interface object to change and/or adjust the media style). Displaying the tutorial animation prompting the user to provide one or more user inputs corresponding to the style editing user interface object provides a user with guidance about how to use the style editing user interface object without requiring the user to provide additional user input to determine how the style editing user interface object adjusts the media style, thereby providing improved visual feedback to the user and/or reducing the number of inputs needed to perform an operation.

In some embodiments, while displaying the style editing user interface object (e.g., 616 and/or 617) that is configured to cause the adjustment to one or more parameters (e.g., a saturation, tone, color temperature, brightness, opaqueness, and/or contrast) of the media style, computer system (e.g., 100, 300, 500, and/or 600) detects, via the one or more input devices (e.g., 600a and/or 602), one or more user inputs (e.g., 1750ag and/or 1750ah) (e.g., a touch and drag input corresponding to a parameter index point of the respective style control element, a swipe gesture corresponding to the parameter index point of the respective style control element, a tap gesture corresponding to a two-dimensional region of the respective style control element, and/or an input directed to a mouse and/or trackpad while a cursor is displayed over a two-dimensional region of the respective style control element, one or more tap gestures, pinch gestures, drag gestures, swipe gestures, touch gestures, air gestures, button presses, and/or voice commands) corresponding to the style editing user interface object (e.g., 616 and/or 617) (e.g., the one or more user inputs correspond to a request to adjust a respective parameter of one or more parameters of the media style to adjust, change, and/or modify the media style); and in response to detecting the one or more user inputs (e.g., 1750ag and/or 1750ah) corresponding to the style editing user interface object (e.g., 616 and/or 617), computer system (e.g., 100, 300, 500, and/or 600) adjusts (e.g., adjusts as illustrated at FIGS. 17AL-17AP) (e.g., changing, updating, and/or modifying) a current value (e.g., a system-defined or user-defined value that is currently set for a first parameter of the media style) for a first parameter (e.g., a saturation, tone, color temperature, brightness, opaqueness, and/or contrast) of the one or more parameters of the media style to an updated value (e.g., a system-defined or user-defined value that is requested to be set for the first parameter of the media style via the one or more user inputs corresponding to the style editing user interface object) for the first parameter of the one or more parameters of the media style. In some embodiments, adjusting the current value for the first parameter of the one or more parameters of the media style to an updated value for the first parameter of the one or more parameters of the media style includes adjusting a tone curve of the media style (e.g., as shown at FIG. 17AL), adjusting a value of saturation by shifting one or more colors corresponding to the media style (e.g., as shown at FIG. 17AM), and/or adjusting an intensity of a color palette corresponding to the media style (e.g., as shown at FIGS. 17AN-17AP). Adjusting a current value for a first parameter of the one or more parameters of the media style to an updated value for the first parameter of the one or more parameters of the media style in response to detecting the one or more user inputs corresponding to the style editing user interface object allows a user to view real-time changes to the appearance of the media item that are based on changes to the media style, thereby providing improved visual feedback to the user.

In some embodiments, after adjusting the current value for the first parameter of the one or more parameters of the media style to the updated value for the first parameter of the one or more parameters of the media style (and, optionally, after or in response to detecting confirmation of the adjustment to the first parameter of the one or more parameters of the media style), computer system (e.g., 100, 300, 500, and/or 600) displays, via the one or more display generation components (e.g., 602) that are in communication with the computer system (e.g., 100, 300, 500, and/or 600), a second style editing user interface object (e.g., 616 and/or 617) (e.g., a two-dimensional region and/or a slider) that is configured to cause an adjustment to a second parameter (e.g., a saturation, tone, color temperature, brightness, opaqueness, degree of color shift, and/or contrast) of the one or more parameters of the media style, wherein the second parameter of the one or more parameters of the media style is different from the first parameter of the one or more parameters of the media style. Displaying a second style editing user interface object that is configured to cause an adjustment to a second parameter of the one or more parameters of the media style after adjusting the first parameter of the media style allows a user to adjust multiple different parameters of the media style without requiring the user to navigate to a different user interface, thereby reducing the number of inputs needed to perform an operation.

In some embodiments, prior to (e.g., before) detecting the one or more user inputs (e.g., 1750ag and/or 1750ah) corresponding to the style editing user interface object (e.g., 616 and/or 617) (e.g., and without detecting additional user input corresponding to the style editing user interface object), computer system (e.g., 100, 300, 500, and/or 600) displays, via the one or more display generation components (e.g., 602) that are in communication with the computer system (e.g., 100, 300, 500, and/or 600), one or more portions (e.g., 616a, 616b, 616c, 616d, and/or 616e) (e.g., lines representing one or more axes of the style editing user interface object, dots and/or indicators displayed within the style editing user interface object and representing one or more default values and/or current values of the media style, lines representing a grid of a two-dimensional region of the style editing user interface object, and/or an interior portion of a two-dimensional region of the style editing user interface object) of the style editing user interface object (e.g., 616 and/or 617) with a first level of visual prominence (e.g., a first brightness, clarity, opaqueness, line weight, color intensity, and/or size), wherein the one or more portions (e.g., 616a, 616b, 616c, 616d, and/or 616e) of the style editing user interface object (e.g., 616 and/or 617) indicate different possible values (e.g., default and/or system-defined values corresponding to the media style and/or user-defined values that are based on one or more user inputs corresponding to the style editing user interface object) of the one or more parameters of the media style; and while adjusting the current value for the first parameter of the one or more parameters of the media style to the updated value for the first parameter of the one or more parameters of the media style, computer system (e.g., 100, 300, 500, and/or 600) displays, via the one or more display generation components (e.g., 602) that are in communication with the computer system (e.g., 100, 300, 500, and/or 600), the one or more portions (e.g., 616a, 616b, 616c, 616d, and/or 616e) of the style editing user interface object (e.g., 616 and/or 617) with a second level of visual prominence (e.g., a second brightness, clarity, opaqueness, line weight, color intensity, and/or size), wherein the second level of visual prominence is less than the first level of visual prominence (e.g., the one or more portions of the style editing user interface object are less clear and/or less prominent when the computer system adjusts the value of a respective parameter of the media style as compared to the appearance of the one or more portions of the style editing user interface object when the computer system is not adjusting the value of a respective parameter of the media style). Displaying one or more portions of the style editing user interface object with different levels of visual prominence based on whether the computer system is currently adjusting a value of a respective parameter of a media style allows a user to confirm whether or not the computer system is currently adjusting a respective parameter for the media style, thereby providing improved visual feedback to the user.

In some embodiments, the one or more portions (e.g., 616a, 616b, 616c, 616d, and/or 616e) of the style editing user interface object (e.g., 616 and/or 617) include grid indicators (e.g., 616a and/or 616b) (e.g., one or more lines that define one or more axes and/or a gird within a two-dimensional region) of a two-dimensional region (e.g., 616) (e.g., a region, such as a visibly distinct region of the, that includes a first axis and a second axis that are perpendicular to one another to form a two-dimensional shape, such as a square, a rectangle, a rhombus, a diamond, a circle, and/or a two-dimensional polygon) having a first axis (e.g., 616a and/or 616b) (e.g., a first one-dimensional axis extending in a first direction) and a second axis (e.g., 616a and/or 616b) (e.g., a second one-dimensional axis extending in a second direction, different from the first direction). The one or more portions of the style editing user interface object including grid indicators of a two-dimensional region having a first axis and a second axis allows a user to confirm whether or not the computer system is currently adjusting a respective parameter for the media style, thereby providing improved visual feedback to the user.

In some embodiments, the one or more portions (e.g., 616a, 616b, 616c, 616d, and/or 616e) of the style editing user interface object (e.g., 616 and/or 617) include a visual indication (e.g., 616e) (e.g., a dot and/or indicator that is displayed at a respective location within a region, such as a two-dimensional region, of the style editing user interface object to represent respective values of one or more parameters of the media style) of a neutral value of the one or more parameters (e.g., a value that corresponds to the computer system not making an adjustment of the one or more parameters from original values of the one or more parameters of the media item as captured). The one or more portions of the style editing user interface object including a visual indication of a neutral value of the one or more parameters allows a user to confirm whether or not the computer system is currently adjusting a respective parameter for the media style, thereby providing improved visual feedback to the user.

In some embodiments, the one or more portions (e.g., 616a, 616b, 616c, 616d, and/or 616e) of the style editing user interface object (e.g., 616 and/or 617) include a visual indication (e.g., 616d) (e.g., a dot and/or indicator that is displayed at a respective location within a region, such as a two-dimensional region, of the style editing user interface object to represent respective values of one or more parameters of the media style) of a default value of the one or more parameters for the media style (e.g., a system-defined value that corresponds to the media style without the computer system detecting user inputs requesting to change the one or more parameters of the media style). In some embodiments, in accordance with a determination that the media style is a first media style, the visual indication of the default value of the one or more parameters is displayed at a first location relative to a two-dimensional region and/or includes a first appearance. In some embodiments, in accordance with a determination that the media style is a second media style that is different from the first media style, the visual indication of default value of the one or more parameters is displayed at a second location relative to the two-dimensional region that is different from the first location and/or includes a second appearance that is different from the first appearance. The one or more portions of the style editing user interface object including a visual indication of a default value of the one or more parameters allows a user to confirm whether or not the computer system is currently adjusting a respective parameter for the media style, thereby providing improved visual feedback to the user.

Note that details of the processes described above with respect to method 1900 (e.g., FIG. 19) are also applicable in an analogous manner to the methods described above/below. For example, methods 900, 1100, 1300, 1500, 1600, 1800, and/or 2100 optionally include one or more of the characteristics of the various methods described above with reference to method 1900. For example, the computer system of method 700 can be used to edit a media style that is previewed using the computer system of method 1900. For example, the computer system of method 900 can be used to edit video media items that include media styles previewed using the computer system of method 1900. As another example, the computer system of method 1100 can be used to selectively apply edits made to a media item using the computer system of method 1900 from one media item to another media item. Further still, the computer system of method 1300 can be used to make additional edits to a media item that includes a media style previewed using the computer system of method 1900. The computer system of method 1500 can be used to adjust and/or edit a playback speed of a media item that includes a media style previewed using the computer system of method 1900. The computer system of method 1600 can be used to edit audio for a media item that includes a media style previewed using the computer system of method 1900. The computer system of method 1800 can be used to select a media style that can be previewed using the computer system of method 1900. The computer system of method 2100 can be used to make additional edits to a media item that includes a media style previewed using the computer system of method 1900. For brevity, these details are not repeated below.

FIGS. 20A-20W illustrate exemplary user interfaces for editing a media item, in accordance with some embodiments. The user interfaces in these figures are used to illustrate the processes described below, including the processes in FIG. 21.

In some embodiments, any of the inputs described herein (e.g., input 2050a, 2050b, 2050c, 2050d, 2050e, 2050f, 2050g, 2050h, 2050i, 2050j, 2050k, 2050l, 2050m, 2050n, 2050o, 2050p, 2050q, 2050r, 2050s, 2050t, and/or 2050u) is or includes a touch input (e.g., a tap gesture and/or a swipe gesture). In some embodiments, any of the inputs described herein (e.g., input 2050a, 2050b, 2050c, 2050d, 2050e, 2050f, 2050g, 2050h, 2050i, 2050j, 2050k, 2050l, 2050m, 2050n, 2050o, 2050p, 2050q, 2050r, 2050s, 2050t, and/or 2050u) is or includes a voice input (e.g., a voice command to select a user interface element or to activate a feature or perform a function, such as a feature or function associated with a user interface element). In some embodiments, any of the inputs described herein (e.g., input 2050a, 2050b, 2050c, 2050d, 2050e, 2050f, 2050g, 2050h, 2050i, 2050j, 2050k, 2050l, 2050m, 2050n, 2050o, 2050p, 2050q, 2050r, 2050s, 2050t, and/or 2050u) is or includes an air gesture (e.g., an air gesture to select a user interface element or to activate a feature or perform a function, such as a feature or function associated with a user interface element). In some embodiments, any of the inputs described herein (e.g., input 2050a, 2050b, 2050c, 2050d, 2050e, 2050f, 2050g, 2050h, 2050i, 2050j, 2050k, 2050l, 2050m, 2050n, 2050o, 2050p, 2050q, 2050r, 2050s, 2050t, and/or 2050u) is or includes activation (e.g., a press, a rotation, and/or a movement) of a hardware device (e.g., a button, a rotatable input mechanism, a rotatable and depressible input mechanism, a mouse, a mouse button, a trackpad, a trackpad button, a button of a remote control, and/or a joystick). In some embodiments, any of the inputs described herein (e.g., input 2050a, 2050b, 2050c, 2050d, 2050e, 2050f, 2050g, 2050h, 2050i, 2050j, 2050k, 2050l, 2050m, 2050n, 2050o, 2050p, 2050q, 2050r, 2050s, 2050t, and/or 2050u) as a touch and drag gesture includes an air gesture (e.g., an air gesture including a pinch and/or movement) and/or a click and drag gesture (e.g., a click of a mouse button and/or a trackpad and/or movement while holding a press of a mouse button and/or trackpad) of a mouse and/or trackpad. In some embodiments, any of the user interface elements described as being selected herein (e.g., an icon, affordance, button, and/or selectable option) is selected by activating a hardware device while the user interface element is in focus (e.g., highlighted, bolded, outlined, visually distinguished from other user interface elements, and/or located at or near a cursor).

At FIG. 20A, computer system 600 displays media item user interface 804. Media item user interface 804 includes media item representation 2000. In some embodiments, the media item that corresponds to media item representation 2000 is included in a media library that corresponds to an account of a user of computer system. Media item user interface 804 includes media item information 804b, settings user interface object 804d, and exit user interface object 804e. At FIG. 20A, media item information 804b includes information (e.g., metadata) about a location where media item was captured, a time at which the media item was captured, and/or a date at which the media item was captured. In some embodiments, in response to detecting user input corresponding to settings user interface object 804d, computer system 600 displays a settings menu for the media item corresponding to media item representation 2000. In some embodiments, in response to detecting user input corresponding to exit user interface object 804e, computer system 600 displays media library user interface 800, as shown at FIG. 8A.

At FIG. 20A, media item user interface 804 includes media item region 806, which includes media item representations 806j-806p corresponding to media items of the media library of computer system 600. Media item user interface 804 also includes share user interface object 804f, favorite user interface object 804g, information user interface object 804h, delete user interface object 804i, and edit user interface object 804j, as described above with reference to FIG. 8B.

At FIG. 20A, computer system 600 detects user input 2050a (e.g., a tap gesture and/or a touch gesture) corresponding to edit user interface object 804j. In response to detecting user input 2050a, computer system 600 displays first editing user interface 2002, as shown at FIG. 20B.

At FIG. 20B, first editing user interface 2002 corresponds to an adjustment feature for one or more visual parameters of the media item corresponding to media item representation 2000. First editing user interface 2002 includes editing options 2002a-2002e corresponding to respective editing features. At FIG. 20B, editing option 2002b is currently selected, as indicated by selection indicator 2004. In some embodiments, computer system 600 displays first editing user interface 2002 as a default user interface in response to detecting user input 2050a. In some embodiments, computer system 600 displays a user interface corresponding to a respective editing option 2002a-2002e based on which editing feature was last used and/or which user interface was last displayed while computer system 600 was in an editing mode. At FIG. 20B, computer system 600 detects user input 2050b (e.g., a tap gesture and/or a touch gesture) corresponding to selection of editing option 2002e. In response to detecting user input 2050b, computer system 600 displays second editing user interface 2006, as shown at FIG. 20C.

Editing option 2002e corresponds to an editing mode that allows computer system 600 to edit media item representation 2000 based on a location of an input, based on content of media item representation 2000, and/or based on automated process (e.g., a machine learning algorithm and/or artificial intelligence). As described in greater detail herein, while editing option 2002e is selected, computer system 600 optionally edits media item representation 2000 differently based on a context of the media item representation 2000. In some embodiments, while editing option 2002e is selected and/or in response to selection of editing option 2002e, computer system 600 scans, analyzes, evaluates, and/or determines what is included in media item representation 2000 using a machine learning algorithm (e.g., generative artificial intelligence).

At FIG. 20C, second editing user interface 2006 includes editing mode indicator 2006a (e.g., “Cleanup”), media item representation 2000, and editing options 2002a-2002e. At FIG. 20C, editing option 2002e is currently selected, as indicated by selection indicator 2004. Second editing user interface 2006 includes information region 2006b, which includes a visual indication of a status of the editing mode of computer system 600 and/or prompts about how to edit media item representation 2000. For instance, at FIG. 20C, information region 2006b includes the text “Scanning” indicating that computer system 600 is processing, evaluating, and/or analyzing the content of media item representation 2000. As set forth above, in some embodiments, computer system 600 determines what is included in media item representation 2000 (e.g., the content of media item representation 2000) using a machine learning algorithm and/or generative artificial intelligence.

In some embodiments, computer system 600 evaluates the content of media item representation 2000 using one or more automated approaches that generate or simulate a semantic understanding of the content of media item representation 2000. For example, a machine learning model or artificial intelligence model that has been trained with a semantically labeled data set can produce a simulated semantic understanding of content of media item representation 2000 by using a weighted model that compares media item representation 2000 (or a portion of media item representation 2000) to reference content or a machine learning model that has been trained on reference content. In some embodiments, a machine learning model is trained on reference content that was semantically identified as including problematic content (e.g., nudity, violence, graphic material, faces, and/or other content that is identified as problematic). In some embodiments, computer system 600 is configured to determine whether a respective media item (e.g., media item representations 2000, 2008, and/or 2010) includes problematic content automatically (e.g., via an automated process as described above with reference to paragraphs [0229]-[0231]). In some embodiments, computer system 600 automatically determines that a respective media item includes problematic content based on a comparison between content of the respective media item and training data, rules, and/or reference content (e.g., the training data, rules, and/or reference content includes problematic content that enables computer system to identify and/or determine problematic content in a respective media item). In some embodiments, computer system compares a requested edit to media item representation 2000 to an evaluation of (e.g., a semantic understanding of) a portion of content of media item representation 2000 toward which the request to edit media item representation 2000 is directed (e.g., based on verbal inputs, or pointer inputs such as touch or mouse inputs selecting the portion of the media item).

After computer system 600 evaluates the content of (e.g., what is included in) media item representation 2000, computer system 600 displays second editing user interface 2006, as shown at FIG. 20D. At FIG. 20D, computer system 600 displays information region 2006b of second editing user interface 2006 with the text “Tap, brush or circle what you want to remove.” As such, information region 2006b indicates that computer system 600 has evaluated the content of media item representation 2000 and/or provides guidance to the user of computer system 600 about the function of second editing user interface 2006 (e.g., removing visual elements from media item representation 2000).

At FIG. 20D, media item representation 2000 includes man 2000a, woman 2000b, child 2000c, and background 2000d. As set forth below, computer system 600 is configured to replace respective portions of content of media item representation 2000 based on user input detected while displaying second editing user interface 2006. For instance, in some embodiments, a user of computer system 600 is not satisfied with an appearance of media item representation 2000 and wants to edit media item representation 2000 so that it is more visually appealing to the user. In some embodiments, the media item corresponding to media item representation 2000 is captured with unintended people and/or objects that are ultimately included in media item representation 2000. In some embodiments, the user of computer system 600 wishes to remove unintended people and/or objects from media item representation 2000.

In some embodiments, computer system 600 replaces content of media item representation 2000 differently based on the evaluation of the content of media item representation 2000 and/or based on a portion of the content of media item representation 2000 in which user input is directed. For instance, as set forth below, in some embodiments, computer system 600 replaces a portion of content of media item representation 2000 (e.g., a visual element) with blended content, which causes the portion of content of media item representation 2000 to be perceived as being removed from media item representation 2000. In some embodiments, computer system 600 replaces the portion of content of media item representation 2000 with the blended content based on a determination that the content of media item representation 2000 and/or the portion of the content of media item representation 2000 satisfies a set of criteria. In some embodiments, the set of criteria is based on the evaluation of media item representation 2000. As set forth above, in some embodiments, computer system 600 evaluates the content of media item representation 2000 based on a semantic understanding process (e.g., an automated process) and/or a simulated semantic understanding process (e.g., an automated process). In some embodiments, the set of criteria includes a first criterion that is satisfied when the content of media item representation 2000 does not include inappropriate content, such as nudity, violent and/or graphic material, and/or other content that is determined to be problematic. In some embodiments, the set of criteria includes a second criterion that is satisfied when the portion of content of media item representation 2000 that is requested to be removed (e.g., via one or more user inputs) would not result in media item representation 2000 including inappropriate content (e.g., nudity, violent and/or graphical material, and/or other content that is determined to be problematic). In some embodiments, the set of criteria includes a third criterion that is satisfied when the portion of content of media item representation 2000 that is requested to be removed is not a face (e.g., an entire face and/or more than a threshold amount of a face) of a person included in media item representation 2000.

In some embodiments, computer system 600 replaces the portion of content of media item representation 2000 with a redaction of the portion of the content of media item representation 2000. In some embodiments, computer system 600 replaces the portion of the content of media item representation 2000 with the redaction when the set of criteria is not satisfied. For instance, in some embodiments, computer system 600 replaces the portion of content of media item representation 2000 with the redaction when computer system 600 determines (e.g., based on the evaluation of media item representation 2000) that media item representation 2000 includes inappropriate content (e.g., nudity, violent and/or graphic material, and/or other content that is determined to be problematic). In some embodiments, computer system 600 replaces the portion of content of media item representation 2000 with the redaction when computer system 600 determines (e.g., based on the evaluation of media item representation) that the portion of content of media item representation 2000 that is requested to be removed (e.g., via one or more user inputs) would result in media item representation 2000 including inappropriate content (e.g., nudity, violent and/or graphic material, and/or other content that is determined to be problematic). In some embodiments, computer system 600 replaces the portion of content of media item representation 2000 with the redaction when computer system 600 determines (e.g., based on the evaluation of media item representation 2000) that the portion of content of media item representation 2000 that is requested to be removed is a face (e.g., an entire face and/or more than a threshold amount of a face) of a person included in media item representation 2000.

In some embodiments, redaction of the portion of the content of media item representation 2000 includes a blurred version of the portion of content, a pixelated version of the portion of content, a non-photorealistic version of the portion of content, a lower resolution version of the portion of content, and/or a lower visual fidelity version of the portion of content. In some embodiments, the redaction of the portion of the content of media item representation 2000 is based on the portion of the content of media item representation 2000. For instance, in some embodiments, the redaction of the portion of the content of media item representation 2000 includes an appearance that is based on the appearance of the portion of the content of media item representation. In some embodiments, computer system 600 replaces the portion of the content of media item representation 2000 with the redaction by adjusting one or more visual parameters (e.g., an amount of blur, pixelation clarity, resolution, and/or visual fidelity) of the portion of the content of media item representation 2000. In some embodiments, computer system 600 replaces the portion of the content of media item representation 2000 with the redaction by overlaying the redaction on top of the portion of the content of media item representation 2000.

At FIG. 20D, computer system 600 detects user input 2050c (e.g., a tap input, a touch input, and/or a touch and drag input) corresponding to portion 2000e of media item representation 2000. In response to detecting user input 2050c, computer system 600 displays second editing user interface 2006, as shown at FIG. 20E.

At FIG. 20E, computer system 600 replaces portion 2000e of media item representation 2000 with portion 2000f (e.g., blended content) based on user input 2050c. At FIG. 20D, portion 2000e of media item representation 2000 corresponds to a sleeve of a swimsuit worn by woman 2000b. More specifically, the sleeve of the swimsuit worn by woman 2000b is positioned over an arm of woman 2000b. As set forth above, computer system 600 evaluates the content of media item representation 2000 to determine how to edit media item representation 2000. In some embodiments, computer system 600 evaluates the content of media item representation 2000 prior to detecting user input 2050c. In some embodiments, computer system 600 evaluates the content of media item representation 2000 in response to and/or after detecting user input 2050c.

At FIGS. 20D and 20E, computer system 600 determines that media item representation 2000 does not include inappropriate content, such as nudity, violent and/or graphic material, and/or other content that is determined to be problematic. In some embodiments, computer system 600 determines that media item representation 2000 does not include inappropriate content based on the evaluation of media item representation 2000 that is based on automated processes that generate or simulate a semantic understanding of the content of media item representation 2000. In addition, computer system 600 determines that removal of portion 2000e of media item representation 2000 would not result in media item representation 2000 including inappropriate content. For instance, at FIG. 20D, the sleeve of the swimsuit worn by woman 2000b is covering her arm. Removal of the sleeve of the swimsuit worn by woman 2000b would not result in media item representation 2000 including nudity, violent and/or graphic material, and/or other content that is determined to be problematic. Instead, removal of the sleeve of the swimsuit worn by woman 2000b would simply result in display of the arm of woman 2000b (e.g., as shown at FIG. 20E).

At FIG. 20E, computer system 600 replaces portion 2000e of media item representation 2000 with portion 2000f so that the sleeve of the swimsuit worn by woman 2000b is perceived to be removed from media item representation 2000 (e.g., portion 2000f is blended content). In some embodiments, computer system 600 automatically generates portion 2000f using a machine learning algorithm and/or artificial intelligence (e.g., as described above with reference to paragraphs [0229]-[0231]). For instance, in some embodiments, portion 2000f is automatically-generated infill content that includes an appearance that is based on portions of the content of media item representation 2000 that are proximate to (e.g., within a threshold distance of) portion 2000e. In some embodiments, portion 2000f includes photorealistic content, such that the user of computer system 600 perceives portion 2000f as part of the original media item corresponding to media item representation 2000.

At FIG. 20E, computer system 600 updates and/or displays information region 2006b with the text “Clean up successful” to provide visual confirmation that computer system 600 replaces portion 2000e of media item representation 2000 with portion 2000f. As set forth below, in some embodiments, computer system 600 updates and/or displays an indication in information region 2006b when a respective portion of content of media item representation 2000 is replaced with a redaction of the respective portion of content of media item representation 2000. At FIG. 20E, computer system 600 detects user input 2050d (e.g., a tap gesture, a touch gesture, and/or a touch and drag gesture) corresponding to portion 2000g of media item representation 2000. In response to detecting user input 2050d, computer system 600 displays second editing user interface 2006, as shown at FIG. 20F-1.

At FIG. 20F-1, computer system 600 replaces portion 2000g of media item representation 2000 with portion 2000h (e.g., a redaction) based on user input 2050d. At FIG. 20E, portion 2000g of media item representation 2000 corresponds to a piece of swimsuit worn by woman 2000b that covers the chest area of woman 2000b. As set forth above, computer system 600 evaluates the content of media item representation 2000 to determine how to edit media item representation 2000. In some embodiments, computer system 600 evaluates the content of media item representation 2000 prior to detecting user input 2050d. In some embodiments, computer system 600 evaluates the content of media item representation 2000 in response to and/or after detecting user input 2050d.

At FIGS. 20E and 20F-1, computer system 600 determines that media item representation 2000 does not include inappropriate content, such as nudity, violent and/or graphic material, and/or other content that is determined to be problematic. At FIGS. 20E and 20F-1, computer system 600 determines that removal of portion 2000g of media item representation 2000 would result in media item representation 2000 including inappropriate content. For instance, at FIG. 20E, the piece of the swimsuit worn by woman 2000b is covering her chest. Removal of the piece of the swimsuit covering the chest of woman 2000b would result in media item representation 2000 including nudity.

At FIG. 20F-1, computer system 600 replaces portion 2000g of media item representation 2000 with portion 2000h, where portion 2000h is a redaction of portion 2000g of media item representation 2000. At FIG. 20F-1, portion 2000h includes different line styles (e.g., dashed lines instead of solid lines) when compared to FIGS. 20A-20E to indicate that portion 2000h includes a different appearance from portion 2000g. As shown at FIG. 20F-2, portion 2000h includes an increased amount of blur when compared to portion 2000g. In some embodiments, portion 2000h includes an increased amount of pixelation (e.g., as shown at FIG. 20F-3), a lower visual fidelity (e.g., as shown at FIGS. 20F-2 and 20F-3), and/or a lower resolution when compared to portion 2000g (e.g., as shown at FIGS. 20F-2 and 20F-3). At FIG. 20F-4, portion 2000h includes a redaction box that replaces (e.g., is overlayed on) portion 2000g. In some embodiments, the redaction box shown at FIG. 20F-4 includes an appearance (e.g., a size, shape, color, and/or pattern) that is based on an appearance of portion 2000g. In some embodiments, computer system 600 replaces portion 2000g with any one of and/or any combination of portions 2000h, shown at FIGS. 20F-1 through 20F-4. In some embodiments, portion 2000h includes a non-photorealistic version of portion 2000g. In some embodiments, computer system 600 replaces portion 2000g of media item representation 2000 with portion 2000h by adjusting one or more visual parameters (e.g., blur as shown at FIG. 20F-2, clarity as shown at FIGS. 20F-1 through 20F-4, visual fidelity as shown at FIGS. 20F-1 through 20F-4, pixelation as shown at FIG. 20F-3, and/or resolution as shown at FIGS. 20F-1 through 20F-4) of portion 2000g of media item representation 2000. At FIGS. 20F-1 through 20F-4, portion 2000h includes an appearance that is based on an appearance of portion 2000g. For example, portion 2000h includes a shape, color, pattern, and/or size that corresponds to the shape, color, pattern, and/or size of the piece of the swimsuit covering the chest of woman 2000b.

At FIGS. 20F-1 through 20F-4, computer system 600 updates and/or displays information region 2006b with the text “Safety filter applied” to provide a visual indication to the user that computer system 600 replaced portion 2000g of media item representation 2000 with portion 2000h and/or a redaction of portion 2000g. Accordingly, the user of computer system 600 is notified that computer system 600 did not edit media item representation 2000 in a way that portion 2000g is perceived as being removed. At FIGS. 20F-1 through 20F-4, computer system 600 detects user input 2050e (e.g., a de-pinch gesture and/or a double tap gesture) corresponding to media item representation 2000. In response to detecting user input 2050e, computer system 600 adjusts a zoom level of media item representation 2000, as shown at FIG. 20G.

Computer system 600 is configured to edit and/or replace portions of content of media item representation 2000 differently based on the zoom level of media item representation. For instance, in some embodiments, while media item representation 2000 is displayed with a relatively high zoom level (e.g., more zoomed in), computer system 600 is configured to edit and/or replace portions of content of media item representation with finer precision as compared to when media item representation 2000 is displayed with a relatively low zoom level (e.g., more zoomed out). At FIG. 20G, computer system 600 displays second editing user interface 2006 with media item representation 2000 being displayed at an increased zoom level as compared to FIGS. 20F-1 through 20F-4. As shown at FIG. 20G, media item representation 2000 has been zoomed into the face of woman 2000b of media item representation 2000.

At FIG. 20G, computer system 600 detects user input 2050f (e.g., a tap gesture, a touch gesture, and/or a touch and drag gesture) corresponding to portion 2000i of media item representation 2000 (e.g., an earpiece of glasses worn by woman 2000b). In response to detecting user input 2050f, computer system 600 displays second editing user interface 2006, as shown at FIG. 20H.

At FIG. 20H, computer system 600 replaces portion 2000i of media item representation 2000 with portion 2000j based on user input 2050f. At FIG. 20G, portion 2000i of media item representation 2000 corresponds to an earpiece of glasses worn on the head of woman 2000b. As set forth above, computer system 600 evaluates the content of media item representation 2000 to determine how to edit media item representation 2000. In some embodiments, computer system 600 evaluates the content of media item representation 2000 prior to detecting user input 2050f. In some embodiments, computer system 600 evaluates the content of media item representation 2000 in response to and/or after detecting user input 2050f.

At FIGS. 20G and 20H, computer system 600 determines that media item representation 2000 does not include inappropriate content, such as nudity, violent and/or graphic material, and/or other content that is determined to be problematic. In addition, computer system 600 determines that removal of portion 2000i of media item representation 2000 would not result in media item representation 2000 including inappropriate content. For instance, at FIG. 20G, the earpiece of the glasses worn on the head of woman 2000b is covering her head and/or hair. Removal of the earpiece of the glasses worn by woman 2000b would not result in media item representation 2000 including nudity, violent and/or graphic material, and/or other content that is determined to be problematic. Instead, removal of the earpiece of the glasses worn by woman 2000b would result in display of the head and/or hair of woman 2000b (e.g., as shown at FIG. 20H).

At FIG. 20H, computer system 600 replaces portion 2000i of media item representation 2000 with portion 2000j (e.g., blended content) so that the earpiece of the glasses worn by woman 2000b is perceived to be removed from media item representation 2000. In some embodiments, computer system 600 automatically generates portion 2000j using a machine learning algorithm and/or artificial intelligence. For instance, in some embodiments, portion 2000j is automatically-generated infill content (e.g., content generated using an automatically generated process as described above with reference to paragraphs [0229]-[0231]) that includes an appearance that is based on portions of the content of media item representation 2000 that are proximate to (e.g., within a threshold distance of) portion 2000i. In some embodiments, portion 2000j includes photorealistic content, such that the user of computer system 600 perceives portion 2000j as part of the original media item corresponding to media item representation 2000.

At FIG. 20H, computer system 600 updates and/or displays information region 2006b with the text “Clean up successful” to provide visual confirmation that computer system 600 replaces portion 2000i of media item representation 2000 with portion 2000j. At FIG. 20H, computer system 600 detects user input 2050g (e.g., a pinch gesture and/or double tap gesture) corresponding to media item representation 2000. In response to detecting user input 2050g, computer system 600 adjusts the zoom level of media item representation 2000, as shown at FIG. 20I.

At FIG. 20I, computer system 600 displays second editing user interface 2006 with media item representation 2000 being displayed at a reduced and/or original zoom level. As shown at FIG. 20I, media item representation 2000 has been zoomed back out so that man 2000a and child are 2000c are displayed on display 602. As set forth above, computer system 600 is configured to edit and/or replace portions of content of media item representation 2000 differently based on the zoom level of media item representation. For instance, in some embodiments, while media item representation 2000 is displayed with a relatively high zoom level (e.g., more zoomed in), computer system 600 is configured to edit and/or replace portions of content of media item representation 2000 with finer precision as compared to when media item representation 2000 is displayed with a relatively low zoom level (e.g., more zoomed out).

At FIGS. 20G and 20H, computer system 600 displayed media item representation 2000 at a relatively high zoom level, such that portion 2000i of media item representation 2000 corresponding to the earpiece of the glasses worn by woman 2000b was replaced with portion 2000j. At FIG. 20I, computer system 600 displays media item representation 2000 at a lower zoom level when compared to FIGS. 20G and 20H. At FIG. 20I, computer system 600 detects user input 2050h (e.g., a tap gesture, a touch gesture, and/or a touch and drag gesture) corresponding to portion 2000k of media item representation 2000. In response to detecting user input 2050h, computer system 600 displays second editing user interface 2006, as shown at FIG. 20J.

At FIG. 20J, computer system 600 replaces portion 2000k of media item representation 2000 with portion 2000l based on user input 2050h. At FIG. 20I, portion 2000k of media item representation 2000 corresponds to the glasses worn on the head of woman 2000b. As set forth above, computer system 600 evaluates the content of media item representation 2000 to determine how to edit media item representation 2000. In some embodiments, computer system 600 evaluates the content of media item representation 2000 prior to detecting user input 2050h. In some embodiments, computer system 600 evaluates the content of media item representation 2000 in response to and/or after detecting user input 2050h.

At FIGS. 20I and 20J, computer system 600 determines that media item representation 2000 does not include inappropriate content, such as nudity, violent and/or graphic material, and/or other content that is determined to be problematic. In addition, computer system 600 determines that removal of portion 2000k of media item representation 2000 would not result in media item representation 2000 including inappropriate content. For instance, at FIG. 20I, the glasses worn on the head of woman 2000b are covering her head and/or hair. Removal of the glasses worn by woman 2000b would not result in media item representation 2000 including nudity, violent and/or graphic material, and/or other content that is determined to be problematic. Instead, removal of the glasses worn by woman 2000b would result in display of the head and/or hair of woman 2000b (e.g., as shown at FIG. 20J).

At FIG. 20J, computer system 600 replaces portion 2000k of media item representation 2000 with portion 2000l so that the glasses worn by woman 2000b are perceived to be removed from media item representation 2000. In some embodiments, computer system 600 automatically generates portion 2000l using a machine learning algorithm and/or artificial intelligence. For instance, in some embodiments, portion 2000l is automatically-generated infill content that includes an appearance that is based on portions of the content of media item representation 2000 that are proximate to (e.g., within a threshold distance of) portion 2000k. In some embodiments, portion 2000l includes photorealistic content, such that the user of computer system 600 perceives portion 2000l as part of the original media item corresponding to media item representation 2000.

As compared to FIGS. 20G and 20H, FIGS. 201 and 20J show computer system 600 removing the entire pair of glasses worn by woman 2000b instead of a portion (e.g., an earpiece) of the glasses worn by woman 2000b. As set forth above, computer system 600 displays media item representation 2000 at an increased zoom level at FIGS. 20G and 20H when compared to media item representation 2000 shown at FIGS. 201 and 20J. Therefore, computer system 600 is configured to edit media item representation 2000 with finer precision (e.g., remove a portion of an object instead of the entire object) while media item representation 2000 is displayed at an increased zoom level. In addition, computer system 600 is configured to edit different portions of media item representation 2000 based on a size and/or area corresponding to user input directed to media item representation 2000. For instance, in some embodiments, user input corresponding to media item representation 2000 includes a touch gesture covering an area of display 602 and/or media item representation 2000 corresponding to a size of a finger of a user. In some embodiments, user input corresponding to media item representation 2000 includes a touch gesture followed by movement relative to display 602 and/or media item representation 2000, which corresponds to an area of display 602 and/or media item representation 2000 that is larger than a size of the finger of the user. In some embodiments, the portion of content of media item representation 2000 that is replaced by computer system 600 is based on the size and/or area covered by user input directed to media item representation 2000. In some embodiments, computer system 600 automatically identifies a portion of content of media item representation 2000 to replace based on a location of the user input and using a machine learning algorithm and/or artificial intelligence.

At FIG. 20J, computer system 600 updates and/or displays information region 2006b with the text “Clean up successful” to provide visual confirmation that computer system 600 replaces portion 2000k of media item representation 2000 with portion 2000l. At FIG. 20J, computer system 600 detects user input 2050i (e.g., a tap gesture and/or touch gesture) corresponding to done user interface object 2006c of second editing user interface 2006. In response to detecting user input 2050i, computer system 600 displays media item user interface 804, as shown at FIG. 20K.

At FIG. 20K, computer system 600 transitions from an editing mode corresponding to second editing user interface 2006 to a non-editing mode (e.g., a mode where computer system 600 does not adjust visual parameters of media item representation 2000 in response to user input corresponding to media item representation 2000). Media item user interface 804 includes media item representation 2000 with the same appearance as media item representation 2000 shown at FIG. 20J. As such, computer system 600 saves, stores, and/or otherwise applies the changes made to media item representation 2000 while displaying second editing user interface 2006 and displays media item representation 2000 in media item user interface 804 with the applied changes. At FIG. 20K, computer system 600 detects user input 2050j (e.g., a swipe gesture, a tap gesture, a touch gesture, and/or a touch and drag gesture) corresponding to media item representation 2000 and/or media item user interface 804. In response to detecting user input 2050j, computer system 600 displays media item user interface 804 with media item representation 2008, as shown at FIG. 20L.

At FIG. 20L, computer system 600 displays media item user interface 804 with media item representation 2008. In some embodiments, the media item that corresponds to media item representation 2008 is included in a media library that corresponds to an account of a user of computer system. Media item user interface 804 includes media item information 804b, settings user interface object 804d, and exit user interface object 804e. At FIG. 20L, computer system 600 detects user input 2050k (e.g., a tap gesture and/or a touch gesture) corresponding to edit user interface object 804j. After (e.g., in response to) detecting user input 2050k, computer system 600 displays second editing user interface 2006, as shown at FIG. 20M.

At FIG. 20M, computer system 600 displays second editing user interface 2006. In some embodiments, computer system 600 displays first editing user interface 2002 in response to detecting user input 2050k and displays second editing user interface 2006 based on detecting user input corresponding to editing option 2002e. In some embodiments, computer system 600 displays second editing user interface 2006 in response to detecting user input 2050k because the editing feature corresponding to second editing user interface 2006 was last used and/or second editing user interface 2006 was last displayed while computer system 600 was in an editing mode.

At FIG. 20M, computer system 600 displays information region 2006b of second editing user interface 2006 with the text “Tap, brush or circle what you want to remove.” As such, information region 2006b provides guidance to the user of computer system 600 about the function of second editing user interface 2006 (e.g., removing visual elements from media item representation 2000).

At FIG. 20M, media item representation 2008 includes first person 2008a, first sign 2008b, second person 2008c, second sign 2008d, third person 2008e, third sign 2008f, fourth sign 2008g, and background 2008h. As set forth below, computer system 600 is configured to replace respective content from media item representation 2000 with replacement content based on user input detected while displaying second editing user interface 2006. For instance, in some embodiments, a user of computer system 600 wants to remove and/or redact unintended people and/or objects from media item representation 2008 and/or to remove and/or redact people to protect their identity.

At FIG. 20M, computer system 600 detects user input 2050l (e.g., a tap input, a touch input, and/or a touch and drag input) corresponding to second sign 2008d of media item representation 2008. In response to detecting user input 2050l, computer system 600 displays second editing user interface 2006, as shown at FIG. 20N.

At FIG. 20N, computer system 600 replaces second sign 2008d (e.g., a portion) of media item representation 2008 with portion 2008i based on user input 2050l. As set forth above, computer system 600 evaluates the content of media item representation 2008 to determine how to edit media item representation 2008. In some embodiments, computer system 600 evaluates the content of media item representation 2008 prior to detecting user input 2050l. In some embodiments, computer system 600 evaluates the content of media item representation 2008 in response to and/or after detecting user input 2050l.

At FIGS. 20M and 20N, computer system 600 determines that media item representation 2008 does not include inappropriate content, such as nudity, violent and/or graphic material, and/or other content that is determined to be problematic. In some embodiments, computer system 600 determines that media item representation 2008 does not include inappropriate content based on the evaluation of media item representation 2008 that is based on automated processes that generate or simulate a semantic understanding of the content of media item representation 2008. In addition, computer system 600 determines that removal of second sign 2008d of media item representation 2008 would not result in media item representation 2008 including inappropriate content. For instance, at FIG. 20M, second sign 2008d is positioned in front of background 2008h. Removal of second sign 2008d would not result in media item representation 2008 including nudity, violent and/or graphic material, and/or other content that is determined to be problematic. Instead, removal of second sign 2008d would result in display of an additional portion of background 2008h (e.g., as shown at FIG. 20N).

At FIG. 20N, computer system 600 replaces second sign 2008d of media item representation 2008 with portion 2008i so that second sign 2008d is perceived to be removed from media item representation 2008. In some embodiments, computer system 600 automatically generates portion 2008i using a machine learning algorithm and/or artificial intelligence. For instance, in some embodiments, portion 2008i is automatically-generated infill content that includes an appearance that is based on portions of the content of media item representation 2008 that are proximate to (e.g., within a threshold distance of) second sign 2008d. In some embodiments, portion 2008i includes photorealistic content, such that the user of computer system 600 perceives portion 2008i as part of the original media item corresponding to media item representation 2008.

At FIG. 20N, computer system 600 updates and/or displays information region 2006b with the text “Clean up successful” to provide visual confirmation that computer system 600 replaces second sign 2008d of media item representation 2008 with portion 2008i. At FIG. 20N, computer system 600 detects user input 2050m (e.g., a de-pinch gesture and/or a double tap gesture) corresponding to media item representation 2008. In response to detecting user input 2050m, computer system 600 adjusts a zoom level of media item representation 2008, as shown at FIG. 20O.

At FIG. 20O, computer system 600 displays second editing user interface 2006 with media item representation 2008 being displayed at an increased zoom level as compared to FIG. 20N. As shown at FIG. 20O, media item representation 2008 has been zoomed into the face of third person 2008e of media item representation 2008.

At FIG. 20O, computer system 600 detects user input 2050n (e.g., a tap gesture, a touch gesture, and/or a touch and drag gesture) corresponding to portion 2008j of media item representation 2008 (e.g., mark and/or blemish on the face of third person 2008e). In response to detecting user input 2050n, computer system 600 displays second editing user interface 2006, as shown at FIG. 20P.

At FIG. 20P, computer system 600 replaces portion 2008j of media item representation 2008 with portion 2008k based on user input 2050n. At FIG. 20O, portion 2008j of media item representation 2008 corresponds to a mark and/or blemish on a face of third person 2008e. As set forth above, computer system 600 evaluates the content of media item representation 2008 to determine how to edit media item representation 2008. In some embodiments, computer system 600 evaluates the content of media item representation 2008 prior to detecting user input 2050n. In some embodiments, computer system 600 evaluates the content of media item representation 2008 in response to and/or after detecting user input 2050n.

At FIGS. 20O and 20P, computer system 600 determines that media item representation 2008 does not include inappropriate content, such as nudity, violent and/or graphic material, and/or other content that is determined to be problematic. In addition, computer system 600 determines that removal of portion 2008j of media item representation 2008 would not result in media item representation 2008 including inappropriate content. For instance, removal of the mark and/or blemish of the face of third person 2008e would not result in media item representation 2008 including nudity, violent and/or graphic material, and/or other content that is determined to be problematic.

At FIGS. 20O and 20P, user input 2050n corresponds to a portion of the face of third person 2008e and does not correspond to more than a threshold amount of the face of third person 2008e. As set forth below with reference to FIGS. 20Q and 20R, when computer system 600 determines that a request to edit a respective media item representation includes an area and/or portion of the respective media item representation corresponding to more than a threshold amount a face of a person, computer system 600 replaces the face of the person with a redaction (e.g., instead of replacing the face of the person with blended content).

At FIG. 20P, computer system 600 replaces portion 2008j of media item representation 2008 with portion 2000k so that the mark and/or blemish on the face of third person 2008e is perceived to be removed from media item representation 2008. In some embodiments, computer system 600 automatically generates portion 2008k using a machine learning algorithm and/or artificial intelligence. For instance, in some embodiments, portion 2008l is automatically-generated infill content that includes an appearance that is based on portions of the content of media item representation 2008 that are proximate to (e.g., within a threshold distance of) portion 2008j. In some embodiments, portion 2008k includes photorealistic content, such that the user of computer system 600 perceives portion 2008k as part of the original media item corresponding to media item representation 2008.

At FIG. 20P, computer system 600 updates and/or displays information region 2006b with the text “Clean up successful” to provide visual confirmation that computer system 600 replaces portion 2008j of media item representation 2008 with portion 2008k. At FIG. 20P, computer system 600 detects user input 2050o (e.g., a pinch gesture and/or double tap gesture) corresponding to media item representation 2008. In response to detecting user input 2050o, computer system 600 adjusts the zoom level of media item representation 2008, as shown at FIG. 20Q.

At FIG. 20Q, computer system 600 displays second editing user interface 2006 with media item representation 2008 being displayed at a reduced and/or original zoom level. As shown at FIG. 20Q, media item representation 2008 has been zoomed back out so that first person 2008a and second person 2008c (e.g., in addition to third person 2008e) are displayed on display 602. At FIG. 20Q, computer system 600 detects user input 2050p (e.g., a tap gesture, a touch gesture, and/or a touch and drag gesture) corresponding to portion 2008l of media item representation 2008. In response to detecting user input 2050p, computer system 600 displays second editing user interface 2006, as shown at FIG. 20R.

At FIG. 20R, computer system 600 replaces portion 2008l of media item representation 2008 with portion 2008m based on user input 2050p. At FIG. 20Q, portion 2008l of media item representation 2008 corresponds to a face of third person 2008e and user input 2050p corresponds to an area of media item representation 2000 that is greater than a threshold amount (e.g., more than 25%, 50%, 75%, or 90%) of the face of third person 2008e. As set forth above, computer system 600 evaluates the content of media item representation 2008 and/or user input corresponding to media item representation 2008 to determine how to edit media item representation 2008. At FIGS. 20Q and 20R, computer system 600 determines that media item representation 2008 does not include inappropriate content, such as nudity, violent and/or graphic material, and/or other content that is determined to be problematic. At FIGS. 20Q and 20R, computer system 600 determines that removal of portion 2008l of media item representation 2008 would not result in media item representation 2008 including inappropriate content. For instance, at FIG. 20Q, removal of the face of third person 2008e would not result in media item representation 2008 including nudity, violent and/or graphic material, and/or other content that is determined to be problematic. At FIG. 20Q, user input 2050p corresponds to a portion of a face of third person 2008e that is greater than a threshold amount. In some embodiments, based on a determination that user input 2050p corresponds to a portion of a face of a person that is greater than the threshold amount, computer system 600 replaces the face with a redaction.

At FIG. 20R, computer system 600 replaces portion 2008l of media item representation 2008 with portion 2008m, where portion 2008m is a redaction of portion 2008l of media item representation 2008. At FIG. FIG. 20R, portion 2008m includes different line styles (e.g., dashed lines instead of solid lines) when compared to FIGS. 20L-20Q to indicate that portion 2008m includes a different appearance from portion 2008l. As set forth above with reference to FIGS. 20F-1 through 20F-4, in some embodiments, portion 2008m includes an increased amount of blur when compared to portion 2008l (e.g., as shown at FIG. 20F-2). In some embodiments, portion 2008m includes an increased amount of pixelation (e.g., as shown at FIG. 20F-3), a lower visual fidelity (e.g., as shown at FIGS. 20F-2 and 20F-3), and/or a lower resolution (e.g., as shown at FIGS. 20F-2 and 20F-3) when compared to portion 2008l. In some embodiments, computer system 600 replaces portion 2008l with portion 2008m having an appearance of any one of and/or any combination of portions 2000h, shown at FIGS. 20F-1 through 20F-4. In some embodiments, portion 2008m includes a non-photorealistic version of portion 2008l. In some embodiments, computer system 600 replaces portion 2008l of media item representation 2008 with portion 2008m by adjusting one or more visual parameters (e.g., blur as shown at FIG. 20F-2, clarity as shown at FIGS. 20F-1 through 20F-4, visual fidelity as shown at FIGS. 20F-1 through 20F-4, pixelation as shown at FIG. 20F-3, and/or resolution as shown at FIGS. 20F-1 through 20F-4) of portion 2008l of media item representation 2008. At FIG. 20R, portion 2008m includes an appearance that is based on an appearance of portion 2008l. For example, portion 2008m includes a shape, color, pattern, and/or size that corresponds to the shape, color, pattern, and/or size of the face of third person 2008e.

At FIG. 20R, computer system 600 updates and/or displays information region 2006b with the text “Safety filter applied” to provide a visual indication to the user that computer system 600 replaced portion 2008l of media item representation 2008 with portion 2008m and/or a redaction of portion 2008l. Accordingly, the user of computer system 600 is notified that computer system 600 did not edit media item representation 2008 in a way that portion 2008l is perceived as being removed. At FIG. 20R, computer system 600 detects user input 2050q (e.g., a tap gesture and/or a touch gesture) corresponding to done user interface object 2006c of second editing user interface 2006. In response to detecting user input 2050q, computer system 600 displays media item user interface 804, as shown at FIG. 20S.

At FIG. 20S, computer system 600 transitions from an editing mode corresponding to second editing user interface 2006 to a non-editing mode (e.g., a mode where computer system 600 does not adjust visual parameters of media item representation 2008 in response to user input corresponding to media item representation 2008). Media item user interface 804 includes media item representation 2008 with the same appearance as media item representation 2008 shown at FIG. 20R. As such, computer system 600 saves, stores, and/or otherwise applies the changes made to media item representation 2008 while displaying second editing user interface 2006 and displays media item representation 2008 in media item user interface 804 with the saved and/or applied changes. At FIG. 20S, computer system 600 detects user input 2050r (e.g., a swipe gesture, a tap gesture, a touch gesture, and/or a touch and drag gesture) corresponding to media item representation 2008 and/or media item user interface 804. In response to detecting user input 2050r, computer system 600 displays media item user interface 804 with media item representation 2010, as shown at FIG. 20T.

At FIG. 20T, computer system 600 displays media item user interface 804 with media item representation 2010. In some embodiments, the media item that corresponds to media item representation 2010 is included in a media library that corresponds to an account of a user of computer system. Media item user interface 804 includes media item information 804b, settings user interface object 804d, and exit user interface object 804e. At FIG. 20T, media item information 804b includes information (e.g., metadata) about a location where media item was captured, a time at which the media item was captured, and/or a date at which the media item was captured. At FIG. 20T, computer system 600 detects user input 2050s (e.g., a tap gesture and/or a touch gesture) corresponding to edit user interface object 804j. After (e.g., in response to) detecting user input 2050s, computer system 600 displays second editing user interface 2006, as shown at FIG. 20U.

At FIG. 20U, computer system 600 displays second editing user interface 2006. In some embodiments, computer system 600 displays first editing user interface 2002 in response to detecting user input 2050s and displays second editing user interface 2006 based on detecting user input corresponding to editing option 2002e. In some embodiments, computer system 600 displays second editing user interface 2006 in response to detecting user input 2050s because the editing feature corresponding to second editing user interface 2006 was last used and/or second editing user interface 2006 was last displayed while computer system 600 was in an editing mode.

At FIG. 20U, media item representation 2010 includes first person 2010a, bird 2010b, second person 2010c, object 2010d, and background 2010e. At FIG. 20U, second person 2010c is illustrated as a stick figure and/or a generic humanoid figure to indicate that second person 2010c is nude and/or otherwise exposing an inappropriate body part. In addition, object 2010d being held by second person 2010c includes a weapon, a violent object, and/or a graphic object that also satisfies the criteria for inappropriate content. Thus, both second person 2010c and object 2010d of media item representation 2010 include and/or represent inappropriate content.

At FIG. 20U, computer system 600 evaluates media item representation 2010 and determines that media item representation 2010 includes inappropriate content (e.g., nudity, violent and/or graphic material, and/or other content that is determined to be problematic). As set forth above, second person 2010c and/or object 2010d of media item representation 2010 are representative of inappropriate content. Based on the evaluation of media item representation 2010 and/or determining that media item representation 2010 includes inappropriate content, computer system 600 displays information region 2006b of second editing user interface 2006 with the text “Safety filter applied.” At FIG. 20U, information region 2006b indicates that the safety filter has been applied without computer system 600 receiving user input corresponding to a request to edit media item representation 2010. Therefore, information region 2006b provides an indication that computer system 600 is configured to replace respective portions of media item representation 2010 with a redaction (e.g., and not a blended portion) in response to detecting user input corresponding to media item representation 2010 (e.g., regardless of whether the portion of media item representation 2010 selected includes inappropriate content or not).

At FIG. 20U, computer system 600 detects user input 2050t (e.g., a tap gesture, a touch gesture, and/or a touch and drag gesture) corresponding to bird 2010b of media item representation 2010. In response to detecting user input 2050t, computer system 600 displays second editing user interface 2006, as shown at FIG. 20V.

At FIG. 20V, computer system 600 replaces bird 2010b of media item representation 2010 with portion 2010f, where portion 2010f is a redaction of bird 2010b. As set forth above, computer system 600 determines that media item representation 2010 includes inappropriate content (e.g., based on an evaluation of media item representation 2010). Even though bird 2010b is not considered inappropriate content and/or removal of bird 2010b would not cause media item representation 2010 to include additional inappropriate content, computer system 600 replaces bird 2010b with a redaction (e.g., portion 2010f). Thus, when computer system 600 determines that a respective media item representation includes inappropriate content (e.g., before editing and/or before detecting a request to edit the respective media item representation), computer system 600 replaces any portion of the respective media item with a redaction instead of replacing appropriate portions of content of the respective media item with blended portions.

At FIG. 20V, portion 2010f includes different line styles (e.g., dashed lines instead of solid lines) when compared to FIGS. 20T and 20U to indicate that portion 2010f includes a different appearance from bird 2010b. As set forth above with reference to FIGS. 20F-1 through 20F-4, in some embodiments, portion 2010f includes an increased amount of blur when compared to bird 2010b (e.g., as shown at FIG. 20F-2). In some embodiments, portion 2010f includes an increased amount of pixelation (e.g., as shown at FIG. 20F-3), a lower visual fidelity (e.g., as shown at FIGS. 20F-2 and 20F-3), and/or a lower resolution (e.g., as shown at FIGS. 20F-2 and 20F-3) when compared to bird 2010b. In some embodiments, computer system 600 replaces bird 2010b with portion 2010f having an appearance of any one of and/or any combination of portions 2000h, shown at FIGS. 20F-1 through 20F-4. In some embodiments, portion 2010f includes a non-photorealistic version of bird 2010b. In some embodiments, computer system 600 replaces bird 2010b of media item representation 2010 with portion 2010f by adjusting one or more visual parameters (e.g., blur as shown at FIG. 20F-2, clarity as shown at FIGS. 20F-1 through 20F-4, visual fidelity as shown at FIGS. 20F-1 through 20F-4, pixelation as shown at FIG. 20F-3, and/or resolution as shown at FIGS. 20F-1 through 20F-4) of bird 2010b of media item representation 2010. At FIG. 20V, portion 2010f includes an appearance that is based on an appearance of bird 2010b. For example, portion 2010f includes a shape, color, pattern, and/or size that corresponds to the shape, color, pattern, and/or size of bird 2010b.

At FIG. 20V, computer system 600 maintains display of and/or continues to display information region 2006b with the text “Safety filter applied.” Accordingly, computer system 600 continues to indicate that editing actions performed and/or editing actions configured to be performed on media item representation 2010 include replacement of portions of content of media item representation 2010 with redacted portions (e.g., and not blended portions). At FIG. 20V, computer system 600 detects user input 2050u (e.g., a tap gesture, a touch gesture, and/or a touch and drag gesture) corresponding to second person 2010c (and, optionally, object 2010d). In response to detecting user input 2050u, computer system 600 displays second editing user interface 2006, as shown at FIG. 20W.

At FIG. 20W, computer system 600 replaces second person 2010c and object 2010d of media item representation 2010 with portion 2010g, where portion 2010g is a redaction of second person 2010c and object 2010d. In some embodiments, computer system 600 replaces both second person 2010c and object 2010d with portion 2010g because computer system 600 determines that both second person 2010c and object 2010d constitute inappropriate content. In some embodiments, computer system 600 replaces both second person 2010c and object 2010d with portion 2010g based on a size and/or area of user input 2050u relative to media item representation 2010. As set forth above, computer system 600 determines that media item representation 2010 includes inappropriate content. While second person 2010c and object 2010d are representative of inappropriate content, computer system 600 replaces any portion of content of media item representation 2010 with a redacted portion because media item representation 2010 (e.g., original media item representation 2010 without editing) includes inappropriate content.

At FIG. 20W, portion 2010g includes different line styles (e.g., dashed lines instead of solid lines) when compared to FIGS. 20T-20V to indicate that portion 2010g includes a different appearance from second person 2010c and/or object 2010d. As set forth above with reference to FIGS. 20F-1 through 20F-4, in some embodiments, portion 2010g includes an increased amount of blur (e.g., as shown at FIG. 20F-2) when compared to second person 2010c and object 2010d. In some embodiments, portion 2010g includes an increased amount of pixelation (e.g., as shown at FIG. 20F-3), a lower visual fidelity (e.g., as shown at FIGS. 20F-2 and 20F-3), and/or a lower resolution (e.g., as shown at FIGS. 20F-2 and 20F-3) when compared to second person 2010c and object 2010d. In some embodiments, computer system 600 replaces second person 2010c and/or object 2010d with portion 2010g having an appearance of any one of and/or any combination of portions 2000h, shown at FIGS. 20F-1 through 20F-4. In some embodiments, portion 2010g includes a non-photorealistic version of second person 2010c and object 2010d. In some embodiments, computer system 600 replaces second person 2010c and/or object 2010d of media item representation 2010 with portion 2010g by adjusting one or more visual parameters (e.g., blur as shown at FIG. 20F-2, clarity as shown at FIGS. 20F-1 through 20F-4, visual fidelity as shown at FIGS. 20F-1 through 20F-4, pixelation as shown at FIG. 20F-3, and/or resolution as shown at FIGS. 20F-1 through 20F-4) of second person 2010c and/or object 2010d of media item representation 2010. At FIG. 20W, portion 2010g includes an appearance that is based on an appearance of second person 2010c and/or object 2010d. For example, portion 2010g includes a shape, color, pattern, and/or size that corresponds to the shape, color, pattern, and/or size of second person 2010c and/or object 2010d.

At FIG. 20W, computer system 600 maintains display of and/or continues to display information region 2006b with the text “Safety filter applied.” Accordingly, computer system 600 continues to indicate that editing actions performed and/or editing actions configured to be performed on media item representation 2010 include replacement of portions of content of media item representation 2010 with redacted portions (e.g., and not blended portions).

FIG. 21 is a flow diagram illustrating a method for editing a media item using a computer system in accordance with some embodiments. Method 2100 is performed at a computer system (e.g., 100, 300, 500, and/or 600) (e.g., a smart phone, a smart watch, a tablet computer, a laptop computer, a desktop computer, a wearable device, and/or head-mounted device) that is in communication with (e.g., includes and/or is connected to) one or more display generation components (e.g., 602) (e.g., one or more displays, touch-screen displays, monitors, holographic display systems, and/or head-mounted display systems) and one or more input devices (e.g., 600a and/or 602) (e.g., a touch-sensitive surface (e.g., a touch-sensitive display); a mouse; a keyboard; a remote control; a visual input device (e.g., one or more cameras such as, e.g., an infrared camera, a depth camera, a visible light camera, and/or a gaze tracking camera); an audio input device (e.g., a microphone); a biometric sensor (e.g., a fingerprint sensor, a face identification sensor, a gaze tracking sensor, and/or an iris identification sensor); and/or one or more mechanical input devices (e.g., a depressible input mechanism; a button; a rotatable input mechanism; a crown; and/or a dial)). Some operations in method 2100 are, optionally, combined, the orders of some operations are, optionally, changed, and some operations are, optionally, omitted.

As described below, method 2100 provides an intuitive way for editing a media item. The method reduces the cognitive burden on a user for editing a media item, thereby creating a more efficient human-machine interface. For battery-operated computing devices, enabling a user to manage photographic styles faster and more efficiently conserves power and increases the time between battery charges.

While displaying, via the one or more display generation components, a media user interface (e.g., 804 and/or 2006) (e.g., a user interface that includes display of one or more media items, one or more control user interface objects for editing, adjusting, modifying, and/or changing one or more visual aspects of a respective media item, one or more user interface objects for adding, removing, repositioning, sharing, bookmarking, deleting, and/or providing a designation to the one or more media items, and/or one or more control user interface objects for editing, adjusting, modifying, and/or changing audio parameters of a respective media item and/or a playback speed of the respective media item, a media editing user interface, and/or a user interface that includes a representation of a field of view of one or more cameras that are in communication with the computer system) including a media item (e.g., 2000, 2008, and/or 2010) (e.g., an image, a photo, a video, a screenshot, a representation of a field of view of one or more cameras in communication with the computer system), computer system (e.g., 100, 300, 500, and/or 600) detects (2102), via the one or more input devices (e.g., 600a and/or 602), one or more user inputs (e.g., 2050c, 2050d, 2050f, 2050h, 2050l, 2050n, 2050p, 2050t, and/or 2050u) (e.g., tap gestures, swipe gestures, air gestures, and/or voice commands) corresponding to a request to edit content of the media item (e.g., 2000, 2008, and/or 2010) (e.g., a request to remove, delete, modify and/or change an appearance of, and/or blend at least a portion of a visual element of the media item).

In response to detecting the one or more user inputs (e.g., 2050c, 2050d, 2050f, 2050h, 2050l, 2050n, 2050p, 2050t, and/or 2050u) corresponding to the request to edit the content of the media item (2104) (e.g., 2000, 2008, and/or 2010) and in accordance with a determination that the request to edit the content of the media item (e.g., 2000, 2008, and/or 2010) satisfies a first set of content-based criteria (e.g., the request to edit the content of the media item includes a request to remove a portion of the media item that would not result in nudity, remove a portion of the media item that would not result in violent and/or graphic material, remove a portion of the media item that would not result in redacting a portion of a face of a person included in the content of the media item, and/or the media item does include nudity, violence, and/or other content that is determined to be problematic), wherein the first set of content-based criteria is based on an evaluation of (e.g., based on a semantic understanding or simulated semantic understanding) content of the media item (e.g., 2000, 2008, and/or 2010), computer system (e.g., 100, 300, 500, and/or 600) replaces (2106) (e.g., ceasing display of a respective portion of the content of the media item with content of a first type, displaying and/or overlaying the content of the first type on the respective portion of the content of the media item, and/or blending the content of the first type with the media item) a respective portion (e.g., 2000e, 2000g, 2000i, 2000k, 2008d, 2008j, 2008l, 2010b, 2010c, and/or 2010d) (e.g., a portion of the content of the media item that corresponds to the request to edit the content of the media item, such as a portion of the content of the media item that corresponds to a location of the one or more user inputs) of the content of the media item (e.g., 2000, 2008, and/or 2010) with content of a first type (e.g., 2000f, 2000j, 2000l, 2008i, and/or 2008k) (e.g., automatically-generated content that is based on one or more visual characteristics of the respective portion of the media item and/or other portions of the media item). In some embodiments, evaluation of content of the media item (e.g., 2000, 2008, and/or 2010) includes an automated process evaluating the media item (e.g., 2000, 2008, and/or 2010) using one or more automated approaches that generate or simulate a semantic understanding of the content of the media item (e.g., 2000, 2008, and/or 2010). For example, a machine learning model or artificial intelligence model that has been trained with a semantically labeled data set can produce a simulated semantic understanding of content of a media item (e.g., 2000, 2008, and/or 2010) by using a weighted model that compares a representation of the media item (e.g., 2000, 2008, and/or 2010) (or a representation of a portion of the media item) to reference content or a machine learning model that has been trained on reference content, such as being trained on reference content that was semantically identified as including problematic content such as nudity, violence, graphic material, faces, and/or other content that is identified as problematic. In some embodiments, the first set of content-based criteria is based on a comparison between a requested edit and an evaluation of (e.g., a semantic understanding of) a portion of content of the media item (e.g., 2000, 2008, and/or 2010) toward which the request to edit the media item (e.g., 2000, 2008, and/or 2010) is directed (e.g., based on verbal inputs, or pointer inputs such as touch or mouse inputs selecting the portion of the media item).

In response to detecting the one or more user inputs (e.g., 2050c, 2050d, 2050f, 2050h, 2050l, 2050n, 2050p, 2050t, and/or 2050u) corresponding to the request to edit the content of the media item (2104) (e.g., 2000, 2008, and/or 2010) and in accordance with a determination that the request to edit the content of the media item (e.g., 2000, 2008, and/or 2010) does not satisfy the first set of content-based criteria (e.g., the request to edit the content of the media item includes a request to remove a portion of the media item that would result in nudity, remove a portion of the media item that would result in violent and/or graphic material, remove a portion of the media item that would result in redacting a portion of a face of a person included in the content of the media item, edit and/or otherwise change the media item to include a redacted portion of the media item, and/or the media item does include nudity, violence, and/or other content that is determined to be problematic), computer system (e.g., 100, 300, 500, and/or 600) replaces (2108) (e.g., ceasing display of a respective portion of the content of the media item with content of a second type, displaying and/or overlaying the content of the second type on the respective portion of the content of the media item, and/or blending the content of the second type with the media item) the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) with content of a second type (e.g., 2000h, 2008m, 2010f, and/or 2010g) (e.g., a redacted version of the respective portion of the content, such as a low fidelity version of the respective portion of the content, pixelation, and/or blur) that is different from the content of the first type. In some embodiments, the first set of content-based criteria includes a content replacement criterion that is based on (e.g., that is determined to be satisfied or not satisfied based on) a respective portion (e.g., a portion of the content of the media item that corresponds to the request to edit the content of the media item, such as a portion of the content of the media item that corresponds to a location of the one or more user inputs) of the content of the media item (e.g., 2000, 2008, and/or 2010) (e.g., whether content and/or information corresponding to the respective portion includes nudity, violent and/or graphic material, and/or a face). Replacing a respective portion of content of a media item with content of a first type or content of a second type based on whether a request to edit the content of the media satisfies a first set of content-based criteria allows the computer system to perform an editing action that is based on the request without displaying problematic content and/or without requiring the user to identify media items and/or portions of media items as including problematic content, thereby providing improved visual feedback to the user, performing an operation when a set of conditions has been met without requiring further user input, and/or reducing the number of inputs needed to perform an operation.

In some embodiments, the content of the first type (e.g., 2000f, 2000j, 2000l, 2008i, and/or 2008k) includes automatically-generated infill content (e.g., computer generated content and/or content generated using a machine learning algorithm and/or artificial intelligence). In some embodiments, the automatically-generated infill content is generated by an AI process (e.g., a generative AI model such as a simulated semantic understanding model, a diffusion model, or a large language model based visual content generation model) that generates content that is consistent with content of the media item that is proximate to and/or nearby the respective portion of the content of the media item (e.g., as described in detail above with reference to paragraphs [0229]-[0231]). Replacing the respective portion of the content of the media item with automatically-generated infill content allows the computer system to automatically replace the respective portion of the content of the media item with content that is relative to a context of the media item without requiring further user input, thereby performing an operation when a set of conditions has been met without requiring further user input and/or reducing the number of inputs needed to perform an operation.

In some embodiments, the automatically-generated infill content (e.g., 2000f, 2000j, 2000l, 2008i, and/or 2008k) is generated (e.g., computer-generated and/or system-generated) using a generative process (e.g., a generative AI model, such as a simulated semantic understanding model, a diffusion model, or a large language model based visual content generation model, and/or a generative machine learning model) that is based on the content of the media item (e.g., 2000, 2008, and/or 2010) (e.g., the automatically-generated infill content is based on the respective portion of the content of the media item, portions of the content of the media item that are proximate to and/or within a threshold distance of the respective portion of the content of the media item, and/or the entire content of the media item). The automatically-generated infill content being generated by a generative process that is based on the content of the media item allows the computer system to automatically replace the respective portion of the content of the media item with content that is relative to a context of the media item without requiring further user input, thereby performing an operation when a set of conditions has been met without requiring further user input and/or reducing the number of inputs needed to perform an operation.

In some embodiments, the content of the second type (e.g., 2000h, 2008m, 2010f, and/or 2010g) includes a redaction (e.g., a pixelated version of the respective portion, a blurred version of the respective portion, an overlaid image and/or object displayed on and/or over the respective portion) of the respective portion (e.g., 2000e, 2000g, 2000i, 2000k, 2008d, 2008j, 2008l, 2010b, 2010c, and/or 2010d) of the content of the media item (e.g., 2000, 2008, and/or 2010). In some embodiments, the respective portion of the content of the media item is removed. The content of the second type including a redaction of the respective portion of the content of the media item allows the computer system to perform an editing action that is based on the request without displaying problematic content and/or without requiring the user to identify media items and/or portions of media items as including problematic content, thereby providing improved visual feedback to the user, performing an operation when a set of conditions has been met without requiring further user input, and/or reducing the number of inputs needed to perform an operation.

In some embodiments, the redaction (e.g., 2000h, 2008m, 2010f, and/or 2010g) of the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) is based on an appearance (e.g., a shape, color, and/or pattern) of the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) (e.g., an appearance of the respective portion of the content before replacing the respective portion of the content with the redaction of the respective portion of the content). In some embodiments, the redaction (e.g., 2000h, 2008m, 2010f, and/or 2010g) of the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) includes a shape, color, and/or pattern that is based on the respective portion (e.g., 2000e, 2000g, 2000i, 2000k, 2008d, 2008j, 2008l, 2010b, 2010c, and/or 2010d) of the content of the media item (e.g., 2000, 2008, and/or 2010). In some embodiments, the redaction (e.g., 2000h, 2008m, 2010f, and/or 2010g) of the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) is overlaid on the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) and the redaction (e.g., 2000h, 2008m, 2010f, and/or 2010g) of the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) includes an appearance that is based on an appearance of content underlying the redaction (e.g., 2000h, 2008m, 2010f, and/or 2010g). The redaction of the respective portion of the content of the media item being based on an appearance of the respective portion of the content of the media item allows the computer system to perform an editing action that is based on the request without displaying problematic content and/or without requiring the user to identify media items and/or portions of media items as including problematic content, thereby providing improved visual feedback to the user, performing an operation when a set of conditions has been met without requiring further user input, and/or reducing the number of inputs needed to perform an operation.

In some embodiments, the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) includes a first visual fidelity (e.g., a first brightness, clarity, opaqueness, line weight, color intensity, and/or size), and the redaction (e.g., 2000h, 2008m, 2010f, and/or 2010g) of the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) includes a second visual fidelity (e.g., a second brightness, clarity, opaqueness, line weight, color intensity, and/or size) that is less than (e.g., less clear, more pixelated, and/or more blurred) the first visual fidelity. The redaction of the respective portion of the content of the media item including a visual fidelity that is lower than the respective portion of the content of the media item allows the computer system to perform an editing action that is based on the request without displaying problematic content and/or without requiring the user to identify media items and/or portions of media items as including problematic content, thereby providing improved visual feedback to the user, performing an operation when a set of conditions has been met without requiring further user input, and/or reducing the number of inputs needed to perform an operation.

In some embodiments, the content of the first type (e.g., 2000f, 2000j, 2000l, 2008i, and/or 2008k) includes a first resolution (e.g., a first number of pixels, a first amount of clarity, and/or a first amount of blur), and the content of the second type (e.g., 2000h, 2008m, 2010f, and/or 2010g) includes a second resolution (e.g., a second number of pixels, a second amount of clarity, and/or a second amount of blur) that is less than (e.g., less clear, more pixelated, and/or more blurred) the first resolution. Conditionally replacing the respective portion of the content of the media item with content having different resolutions based on whether a request to edit the content of the media satisfies a first set of content-based criteria allows the computer system to perform an editing action that is based on the request without displaying problematic content and/or without requiring the user to identify media items and/or portions of media items as including problematic content, thereby providing improved visual feedback to the user, performing an operation when a set of conditions has been met without requiring further user input, and/or reducing the number of inputs needed to perform an operation.

In some embodiments, the content of the first type (e.g., 2000f, 2000j, 2000l, 2008i, and/or 2008k) includes photo-realistic content (e.g., generative content that includes a visual fidelity and/or resolution value that is less than a threshold value of a visual fidelity and/or resolution value of the media item), and the content of the second type (e.g., 2000h, 2008m, 2010f, and/or 2010g) does not include photo-realistic content (e.g., the content of the second type includes content having a visual fidelity and/or resolution value that is greater than a threshold value of a visual fidelity and/or resolution of the media item). Conditionally replacing the respective portion of the content of the media item with photo-realistic content based on whether a request to edit the content of the media satisfies a first set of content-based criteria allows the computer system to perform an editing action that is based on the request without displaying problematic content and/or without requiring the user to identify media items and/or portions of media items as including problematic content, thereby providing improved visual feedback to the user, performing an operation when a set of conditions has been met without requiring further user input, and/or reducing the number of inputs needed to perform an operation.

In some embodiments the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) is automatically identified (e.g., identified via the computer system based on a context of the content of the media item and/or based on the request to edit the content of the media item). The respective portion of the content of the media item being automatically identified allows the computer system to perform an editing action based on the request to edit the content of the media item without requiring additional user input, thereby performing an operation when a set of conditions has been met without requiring further user input, and/or reducing the number of inputs needed to perform an operation.

In some embodiments, the first set of content-based criteria is based on an evaluation of one or more portions of the media item (e.g., 2000, 2008, and/or 2010) outside of the respective portion (e.g., 2000e, 2000g, 2000i, 2000k, 2008d, 2008j, 2008l, 2010b, 2010c, and/or 2010d) (e.g., the computer system evaluates the media item as a whole using an automated process that generates or simulates a semantic understanding of the content of the media item). Evaluating one or more portions of the content of the media item outside of the respective portion allows the computer system to determine whether to replace the respective portion of the content with the content of the first type or the content of the second type without requiring additional user input, thereby performing an operation when a set of conditions has been met without requiring further user input and/or reducing the number of inputs needed to perform an operation.

In some embodiments, the first set of content-based criteria is not satisfied when the evaluation of the content of the media item (e.g., 2000, 2008, and/or 2010) (e.g., an evaluation of an entire portion of the content of the media item and/or an evaluation of a second portion of the content of the media item that is different from the respective portion of the content of the media item) indicates that the media item (e.g., 2000, 2008, and/or 2010) is a high risk media item (e.g., the content of the media item is determined to include violence, nudity, and/or other content that is determined to be potentially problematic, such as determined using a generative AI model and/or a generative machine learning model). Replacing the respective portion of the content of the media item with the content of the second type when the evaluation of the entire portion of the content of the media item indicates that the media item is a high risk media item allows the computer system to determine whether to replace the respective portion of the content with the content of the first type or the content of the second type without requiring additional user input, thereby performing an operation when a set of conditions has been met without requiring further user input and/or reducing the number of inputs needed to perform an operation.

In some embodiments, the first set of content-based criteria is based on an evaluation of a change (e.g., a requested change that is based on the one or more user inputs corresponding to the request to edit the content of the media item) to the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) (e.g., the computer system evaluates the respective portion of the content of the media item, evaluates the requested change to the respective portion of the media item, and/or evaluates the media item with the requested change using an automated process that generates or simulates a semantic understanding of the content of the media item). Evaluating a change to the respective portion of the content of the media item allows the computer system to determine whether to replace the respective portion of the content with the content of the first type or the content of the second type without requiring additional user input, thereby performing an operation when a set of conditions has been met without requiring further user input and/or reducing the number of inputs needed to perform an operation.

In some embodiments, the change to the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) includes removal of a face (e.g., a face of third person 2008e) (e.g., a request to remove a face such as a human face that is included in the content of the media item). The change to the respective portion of the content of the media item including removal of a face allows the computer system to determine whether to replace the respective portion of the content with the content of the first type or the content of the second type without requiring additional user input, thereby performing an operation when a set of conditions has been met without requiring further user input and/or reducing the number of inputs needed to perform an operation.

In some embodiments, the change to the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) includes removal of an item of clothing (e.g., the swimsuit worn by woman 2000b) (e.g., a request to remove an item and/or article of clothing that is being worn by a person that is included in the content of the media item). The change to the respective portion of the content of the media item including removal of an item of clothing allows the computer system to determine whether to replace the respective portion of the content with the content of the first type or the content of the second type without requiring additional user input, thereby performing an operation when a set of conditions has been met without requiring further user input and/or reducing the number of inputs needed to perform an operation.

In some embodiments, the first set of content-based criteria is based on a magnitude (e.g., relative size as compared to other portions of the media item and/or an entire portion of the media item) of a target portion (e.g., 2000e, 2000g, 2000i, 2000k, 2008d, 2008j, 2008l, 2010b, 2010c, and/or 2010d) of the media item (e.g., 2000, 2008, and/or 2010) to which the one or more user inputs (e.g., 2050c, 2050d, 2050f, 2050h, 2050l, 2050n, 2050p, 2050t, and/or 2050u) are directed (e.g., the one or more user inputs being directed to a portion of a face included in the content of the media item or an entire face included in the content of the media item and/or the one or more user inputs being directed to a portion of an article of clothing included in the content of the media item or an entire portion of an article of clothing included in the content of the media item). In some embodiments, the first set of content-based criteria includes a criterion that is satisfied when a magnitude of the target portion (e.g., 2000e, 2000g, 2000i, 2000k, 2008d, 2008j, 2008l, 2010b, 2010c, and/or 2010d) of the media item (e.g., 2000, 2008, and/or 2010) to which the one or more user inputs (e.g., 2050c, 2050d, 2050f, 2050h, 2050l, 2050n, 2050p, 2050t, and/or 2050u) are directed is less than a threshold magnitude. In some embodiments, the first set of content-based criteria is not satisfied when the magnitude of the target portion (e.g., 2000e, 2000g, 2000i, 2000k, 2008d, 2008j, 2008l, 2010b, 2010c, and/or 2010d) of the media item (e.g., 2000, 2008, and/or 2010) to which the one or more user inputs (e.g., 2050c, 2050d, 2050f, 2050h, 2050l, 2050n, 2050p, 2050t, and/or 2050u) are directed is greater than or equal to a threshold magnitude. In some embodiments, the threshold magnitude is 50%, 60%, or 75% of an area of a respective element of a media item (e.g., 2000, 2008, and/or 2010) as displayed on the one or more display generation components (e.g., 602). In some embodiments, the respective element of the media item (e.g., 2000, 2008, and/or 2010) includes a face (e.g., the face of third person 2008e) of a person included in the media item (e.g., 2000, 2008, and/or 2010). In some embodiments, a criterion of the first set of content-based criteria is satisfied when the one or more user inputs (e.g., 2050c, 2050d, 2050f, 2050h, 2050l, 2050n, 2050p, 2050t, and/or 2050u) are directed to less than 50% of a face of a person included in the media item (e.g., 2000, 2008, and/or 2010). In some embodiments, the first set of content-based criteria is not satisfied when the one or more user inputs (e.g., 2050c, 2050d, 2050f, 2050h, 2050l, 2050n, 2050p, 2050t, and/or 2050u) are directed to 50% or more of a face of a person included in the media item (e.g., 2000, 2008, and/or 2010). In some embodiments, the respective element of the media item (e.g., 2000, 2008, and/or 2010) includes an article of clothing (e.g., the swimsuit worn by woman 2000b). In some embodiments, a criterion of the first set of content-based criteria is satisfied when the one or more user inputs (e.g., 2050c, 2050d, 2050f, 2050h, 2050l, 2050n, 2050p, 2050t, and/or 2050u) are directed to less than 50% of an article of clothing included in the media item (e.g., 2000, 2008, and/or 2010) (or are not directed to a critical portion of the article of clothing such as a portion covering an area of the body that is culturally sensitive when clothing is removed from it). In some embodiments, the first set of content-based criteria is not satisfied when the one or more user inputs (e.g., 2050c, 2050d, 2050f, 2050h, 2050l, 2050n, 2050p, 2050t, and/or 2050u) are directed to 50% or more of the article of clothing included in the media item (e.g., 2000, 2008, and/or 2010) (or are directed to a critical portion of the article of clothing such as a portion covering an area of the body that is culturally sensitive when clothing is removed from it). The first set of content-based criteria being based on a magnitude of a target portion of the media item to which the one or more user inputs are directed allows the computer system to determine whether to replace the respective portion of the content with the content of the first type or the content of the second type without requiring additional user input, thereby performing an operation when a set of conditions has been met without requiring further user input and/or reducing the number of inputs needed to perform an operation.

In some embodiments, the magnitude of the target portion (e.g., 2000e, 2000g, 2000i, 2000k, 2008d, 2008j, 2008l, 2010b, 2010c, and/or 2010d) of the media item (e.g., 2000, 2008, and/or 2010) to which the one or more user inputs (e.g., 2050c, 2050d, 2050f, 2050h, 2050l, 2050n, 2050p, 2050t, and/or 2050u) are directed is based on a zoom level of the media item (e.g., 2000, 2008, and/or 2010) when the request to edit the content of the media item (e.g., 2000, 2008, and/or 2010) is detected (e.g., a current zoom level of the media item at a time when the one or more user inputs corresponding to the request to edit the media item are detected). The magnitude of the respective portion of the media item to which the one or more user inputs are directed being based on a zoom level of the media item allows the computer system to more accurately determine whether to replace the respective portion of the content with the content of the first type or the content of the second type without requiring additional user input, thereby performing an operation when a set of conditions has been met without requiring further user input and/or reducing the number of inputs needed to perform an operation.

In some embodiments, the magnitude of the target portion (e.g., 2000e, 2000g, 2000i, 2000k, 2008d, 2008j, 2008l, 2010b, 2010c, and/or 2010d) of the media item (e.g., 2000, 2008, and/or 2010) to which the one or more user inputs (e.g., 2050c, 2050d, 2050f, 2050h, 2050l, 2050n, 2050p, 2050t, and/or 2050u) are directed is based on the one or more user inputs (e.g., 2050c, 2050d, 2050f, 2050h, 2050l, 2050n, 2050p, 2050t, and/or 2050u) corresponding to the request to edit the content of the media item (e.g., 2000, 2008, and/or 2010) (e.g., a size of the target portion of the media item to which the one or more user inputs are directed and/or a size of a geometric region formed by the one or more user inputs, such as a size of a circle, outline, and/or other region that was formed, indicated, and/or painted via the one or more user inputs). The magnitude of the respective portion of the media item to which the one or more user inputs are directed being based on the one or more user inputs corresponding to the request to edit the media item allows the computer system to more accurately determine whether to replace the respective portion of the content with the content of the first type or the content of the second type without requiring additional user input, thereby performing an operation when a set of conditions has been met without requiring further user input and/or reducing the number of inputs needed to perform an operation.

In some embodiments, the one or more user inputs (e.g., 2050c, 2050d, 2050f, 2050h, 2050l, 2050n, 2050p, 2050t, and/or 2050u) corresponding to the request to edit the content of the media item (e.g., 2000, 2008, and/or 2010) include a first user input (e.g., 2050c, 2050d, 2050f, 2050h, 2050l, 2050n, 2050p, 2050t, and/or 2050u) corresponding to a request to remove (e.g., cause a portion of content of the media item to no longer be included in the content of the media item, such as by blending other portions of the content of the media item, by replacing the portion of content of the media item with automatically-generated content, and/or by redaction) a selected portion (e.g., 2000e, 2000g, 2000i, 2000k, 2008d, 2008j, 2008l, 2010b, 2010c, and/or 2010d) (e.g., a portion of the content of the media item that is based on a size, magnitude, and/or location of the one or more user inputs corresponding to the request to edit the media item) of the content of the media item (e.g., 2000, 2008, and/or 2010). The one or more user inputs corresponding to the request to edit the media item including a first user input corresponding to a request to remove a selected portion of the content of the media item allows the computer system to replace the respective portion of the content with the content of the first type or the content of the second type without requiring additional user input, thereby performing an operation when a set of conditions has been met without requiring further user input and/or reducing the number of inputs needed to perform an operation.

In some embodiments, replacing the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) with the content of the first type (e.g., 2000f, 2000j, 2000l, 2008i, and/or 2008k) includes replacing the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) with replacement content (e.g., 2000f, 2000j, 2000l, 2008i, and/or 2008k) (e.g., content that is displayed instead of, overlaid on, and/or covering the respective portion of the content of the media item) that is based on (e.g., based on an appearance and/or similar to an appearance, such as a size, shape, pattern, and/or color) surrounding content of the media item (e.g., 2000, 2008, and/or 2010) (e.g., content that is nearby and/or within a threshold distance of the respective portion of the content of the media item) that is proximate to (e.g., nearby and/or within a threshold distance of) the respective portion (e.g., 2000e, 2000g, 2000i, 2000k, 2008d, 2008j, 2008l, 2010b, 2010c, and/or 2010d) of the content of the media item (e.g., 2000, 2008, and/or 2010). In some embodiments, the replacement content (e.g., 2000f, 2000j, 2000l, 2008i, and/or 2008k) is generated using an AI process (e.g., a generative AI model such as a simulated semantic understanding model, a diffusion model, or a large language model based visual content generation model) that generates content that is consistent with the surrounding content. Replacing the respective portion of the content of the media item with replacement content that is based on surrounding content of the media item that is proximate to the respective portion of the content of the media item allows the computer system to perform an editing action to the media item that causes the media item to be perceived by a viewer as unedited and/or original, thereby providing improved editing functions for the computer system.

In some embodiments, computer system (e.g., 100, 300, 500, and/or 600) concurrently (e.g., at the same time as or separately) displays, via the one or more display generation components (e.g., 602): the media editing user interface (e.g., 804 and/or 2006) that includes the media item (e.g., 2000, 2008, and/or 2010); and a visual indicator (e.g., 2006b) (e.g., text, an image, an icon, and/or a visual element) indicating whether the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) is configured to be replaced by the content of the first type (e.g., 2000f, 2000j, 2000l, 2008i, and/or 2008k) or the content of the second type (e.g., 2000h, 2008m, 2010f, and/or 2010g) (e.g., the visual indicator indicates whether the first set of content-based criteria have been met or not). In some embodiments, while displaying the media editing user interface (e.g., 804 and/or 2006) including the media item (e.g., 2000, 2008, and/or 2010): in accordance with a determination that a second set of content-based criteria is met (e.g., the content of the media item includes does not include nudity, violence, and/or other content that is determined to be problematic), displaying, via the one or more display generation components (e.g., 602) and concurrently (e.g., at the same time as or separately) with the media item (e.g., 2000, 2008, and/or 2010), a first visual indicator (e.g., 2006b as shown at FIG. 20E) (e.g., text, an image, an icon, and/or a visual element) indicating that the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) is configured to be replaced by the content of the first type (e.g., 2000f, 2000j, 2000l, 2008i, and/or 2008k) (e.g., that the first set of content-based criteria have been satisfied); and in accordance with a determination that the second set of content-based criteria is not met (e.g., the content of the media item includes does include nudity, violence, and/or other content that is determined to be problematic), displaying, via the one or more display generation components (e.g., 602) and concurrently (e.g., at the same time as or separately) with the media item (e.g., 2000, 2008, and/or 2010), a second visual indicator (e.g., 2006b at FIG. 20U) (e.g., text, an image, an icon, and/or a visual element) indicating that the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) is configured to be replaced by the content of the second type (e.g., 2000h, 2008m, 2010f, and/or 2010g) (e.g., that the first set of content-based criteria have not been satisfied). Displaying the visual indication indicating whether the respective portion of the content of the media item is configured to be replaced by the content of the first type or the content of the second type allows a user to understand how a media item will be edited, thereby providing improved visual feedback to the user.

In some embodiments, the visual indicator (e.g., 2006b) indicating whether the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) is configured to be replaced by the content of the first type (e.g., 2000f, 2000j, 2000l, 2008i, and/or 2008k) or the content of the second type (e.g., 2000h, 2008m, 2010f, and/or 2010g) is displayed prior to (e.g., before) detecting the one or more user inputs (e.g., 2050c, 2050d, 2050f, 2050h, 2050l, 2050n, 2050p, 2050t, and/or 2050u) corresponding to the request to edit the media item (e.g., 2000, 2008, and/or 2010). Displaying the visual indication indicating whether the respective portion of the content of the media item is configured to be replaced by the content of the first type or the content of the second type prior to detecting the one or more user inputs corresponding to the request to edit the media item allows a user to understand how a media item will be edited, thereby providing improved visual feedback to the user.

In some embodiments, the visual indicator (e.g., 2006b) indicating whether the respective portion (e.g., 2000e, 2000g, 2000i, 2000k, 2008d, 2008j, 2008l, 2010b, 2010c, and/or 2010d) of the content of the media item (e.g., 2000, 2008, and/or 2010) is configured to be replaced by the content of the first type (e.g., 2000f, 2000j, 2000l, 2008i, and/or 2008k) or the content of the second type (e.g., 2000h, 2008m, 2010f, and/or 2010g) is displayed after detecting the one or more user inputs (e.g., 2050c, 2050d, 2050f, 2050h, 2050l, 2050n, 2050p, 2050t, and/or 2050u) corresponding to the request to edit the media item (e.g., 2000, 2008, and/or 2010) (e.g., after and/or at the same time as replacing the respective portion of the content of the media item with the content of the first type or the content of the second type). Displaying the visual indication indicating whether the respective portion of the content of the media item is configured to be replaced by the content of the first type or the content of the second type after detecting the one or more user inputs corresponding to the request to edit the media item allows a user to understand how a media item will be edited, thereby providing improved visual feedback to the user.

In some embodiments, the one or more user inputs (e.g., 2050c, 2050d, 2050f, 2050h, 2050l, 2050n, 2050p, 2050t, and/or 2050u) corresponding to the request to edit the media item (e.g., 2000, 2008, and/or 2010) include a request to edit the media item (e.g., 2000, 2008, and/or 2010) using a respective visual media editing option (e.g., an editing option corresponding to 2002e) (e.g., a single visual media editing option and/or the same visual media editing option regardless of whether the first set of content-based criteria are met or not). The one or more user inputs corresponding to the request to edit the media item including a request to edit the media item using a respective visual media editing option allows the computer system to edit media items in different ways using the same editing feature and/or control, thereby performing an operation when a set of conditions has been met without requiring further user input and/or reducing the number of inputs needed to perform an operation.

Note that details of the processes described above with respect to method 2100 (e.g., FIG. 21) are also applicable in an analogous manner to the methods described above. For example, methods 900, 1100, 1300, 1500, 1600, 1800, and/or 1900 optionally include one or more of the characteristics of the various methods described above with reference to method 2100. For example, the computer system of method 700 can be used to edit a media style of a media item that is edited using the computer system of method 2100. For example, the computer system of method 900 can be used to edit video media items that are edited using the computer system of method 2100. As another example, the computer system of method 1100 can be used to selectively apply edits made to a media item using the computer system of method 2100 from one media item to another media item. Further still, the computer system of method 1300 can be used to make additional edits to a media item that is edited using the computer system of method 2100. The computer system of method 1500 can be used to adjust and/or edit a playback speed of a media item that is edited using the computer system of method 2100. The computer system of method 1600 can be used to edit audio for a media item that is edited using the computer system of method 2100. The computer system of method 1800 can be used to select a media style for applying to a media item that is edited using the computer system of method 2100. The computer system of method 1900 can be used to preview a media style applied to a media item that is edited using the computer system of method 2100.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve media editing. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve media editing. Accordingly, use of such personal information data enables users to have calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of media editing, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, edits made to media inferring preferences based on non-personal information data or a bare minimum amount of personal information, such as the content being requested by the device associated with a user, other non-personal information available to the media editing services, or publicly available information.

What is claimed is:

1. A computer system configured to communicate with one or more display generation components and one or more input devices, comprising:
one or more processors; and
memory storing one or more programs configured to be executed by the one or more processors, the one or more programs including instructions for:
while displaying, via the one or more display generation components, a media item including a foreground element and a first background element, detecting, via the one or more input devices, an input corresponding to a request to modify the media item, including:
detecting at least a portion of the input is directed to a location of the foreground element and a location of the first background element; and
in response to detecting the input corresponding to the request to modify the media item:
in accordance with a determination that an initial location of the input is directed to the location of the first background element, modifying the media item, that is displayed via the one or more display generation components, by modifying at least a portion of the first background element without modifying the foreground element to which the input was directed.

2. The computer system of claim 1, wherein the one or more programs further include instructions for:
in response to detecting the input corresponding to the request to modify the media item:
in accordance with a determination that the initial location of the input is directed to the location of the foreground element, modifying the media item by modifying at least a portion of the foreground element without modifying the first background element to which the input was directed.

3. The computer system of claim 1, wherein detecting the input corresponding to the request to modify the media item includes:
detecting at least a portion of the input is directed to a location of the foreground element at a first time;
detecting at least a portion of the input is directed to a location that does not correspond to a location of the foreground element at a second time, after the first time; and
detecting at least a portion of the input is directed to a location of the foreground element at a third time, after the second time.

4. The computer system of claim 1, wherein detecting the input corresponding to the request to modify the media item includes:
detecting at least a portion of the input is directed to a location of a second background element, different from the first background element.

5. The computer system of claim 1, wherein modifying at least the portion of the first background element includes:
replacing at least the portion of the first background element with automatically-generated visual content that is based on content of the media item that is near the first background element.

6. The computer system of claim 1, wherein the foreground element and the first background element are distinguished from each other automatically based on information associated with the media item.

7. The computer system of claim 1, wherein the one or more programs further include instructions for:
prior to detecting the input corresponding to the request to modify the media item, detecting a request to display a media editing user interface; and
in response to detecting the request to display the media editing user interface, displaying, via the one or more display generation components, a visual effect emphasizing a first type of element of the media item relative to a second type of element of the media item, different from the first type of element.

8. The computer system of claim 7, wherein emphasizing the first type of element includes decreasing the visual effect that emphasizes of the first type of element relative to the second type of element over a period of time.

9. The computer system of claim 7, wherein emphasizing the first type of element relative to the second type of element includes displaying a visual indication having a brightness level that includes a degree of brightness that exceeds a standard dynamic range of brightness for the one or more display generation components.

10. The computer system of claim 1, wherein modifying the first background element includes modifying a respective portion of the first background element, wherein the input is not directed to the respective portion of the first background element.

11. The computer system of claim 10, wherein detecting the input corresponding to the request to modify the media item includes detecting a movement component of the input directed to one or more locations of the first background element.

12. The computer system of claim 11, wherein the one or more programs further include instructions for:
in response to detecting the input corresponding to the request to modify the media item:
displaying, via the one or more display generation components, a first indication at one or more locations corresponding to one or more locations of the movement component; and
gradually reducing a visual emphasis of the first indication over time.

13. The computer system of claim 12, wherein the first indication includes a first visual characteristic, and wherein the one or more programs further include instructions for:
in response to detecting the input corresponding to the request to modify the media item and in accordance with a determination that an initial location of the input is directed to the location of the first background element:
displaying, via the one or more display generation components, an indication at one or more locations of the first background element, wherein the indication at one or more locations of the first background element includes the first visual characteristic.

14. The computer system of claim 12, wherein the first indication is displayed with a brightness level that includes a degree of brightness that exceeds a standard dynamic range of brightness for the one or more display generation components.

15. The computer system of claim 11, wherein the one or more programs further include instructions for:
in response to detecting the input corresponding to the request to modify the media item, wherein the input corresponding to the request to modify the media item traverses a path:
in accordance with a determination that the path crosses one or more detected visual elements of the media item, displaying a first type of indication; and
in accordance with a determination that the path does not cross one or more detected visual elements of the media item, displaying a second type of indication, different from the first type of indication.

16. The computer system of claim 1, wherein the media item includes a first element that is automatically detected by the computer system, and wherein the one or more programs further include instructions for:
while displaying the media item including the first element, detecting, via the one or more input devices, a respective input directed to a location of the first element and without detecting a movement component of the respective input; and
in response to detecting the respective input directed to the location of the first element and without detecting the movement component of the respective input, selecting the first element of the media item.

17. The computer system of claim 1, wherein the one or more programs further include instructions for:
in response to detecting the input corresponding to the request to modify the media item and in accordance with the determination that the initial location of the input is directed to the location of the first background element:
displaying, via the one or more display generation components, a visual indication that visually distinguishes the first background element from content in the media item.

18. The computer system of claim 17, wherein the one or more programs further include instructions for:
in response to detecting the input corresponding to the request to modify the media item and in accordance with the determination that the initial location of the input is directed to the location of the first background element:
ceasing display, via the one or more display generation components, of a visual indication that visually distinguishes a second element from content of the media item.

19. The computer system of claim 1, wherein modifying at least a portion of the first background element without modifying the foreground element to which the input was directed includes:
in accordance with a determination that the media item is displayed at a first zoom level, modifying at least the portion of the first background element using a respective dimension for modifying the media item in response to detecting an input; and
in accordance with a determination that the media item is displayed at a second zoom level, different from the first zoom level, modifying at least the portion of the first background element using the respective dimension for modifying the media item in response to detecting the input.

20. The computer system of claim 1, wherein modifying at least a portion of the first background element without modifying the foreground element to which the input was directed includes:
in accordance with a determination that a setting for a dimension for modifying the media item in response to detecting a respective input is set at a first value, modifying at least the portion of the first background element using a first dimension for the respective input; and
in accordance with a determination that the setting for the dimension for modifying the media item in response to detecting the respective input is set at a second value that is different from the first value, modifying at least the portion of the first background element using a second dimension for the respective input that is different from the first dimension.

21. The computer system of claim 1, wherein:
modifying at least the portion of the first background element includes displaying, via the one or more display generation components, an animation of gradually ceasing to display the portion of the first background element, including:
in accordance with a determination that the portion of the first background element has a first color, a respective color of the animation is based on the first color; and
in accordance with a determination that the portion of the first background element has a second color, different from the first color, the respective color of the animation is based on the second color.

22. The computer system of claim 21, wherein the animation of gradually ceasing display of the portion of the first background element includes moving a graphical element having the respective color away from the portion of the first background element.

23. The computer system of claim 1, wherein the one or more programs further include instructions for:
detecting, via the one or more input devices, an undo input directed to an undo selectable object;
in response to detecting the undo input directed to the undo selectable object, undoing a first modification that is a most recently performed modification;
subsequent to detecting the undo input, detecting, via the one or more input devices, a redo input directed to a redo selectable object; and
in response to detecting the redo input, redoing the first modification.

24. The computer system of claim 1, wherein the one or more programs further include instructions for:
prior detecting the request to modify the media item, displaying, via the one or more display generation components t, a first media editing user interface that includes a first selectable object that corresponds to a first category of one or more editing tools;
detecting, via one or more input devices, an input directed to the first selectable object; and
in response to detecting the input directed to the first selectable object, displaying, via the one or more display generation components, a second media editing user interface that includes a first set of editing selectable objects that, when selected, modifies the media item via one or more machine learning algorithms, wherein the second media editing user interface is displayed when the request to modify the media item is detected, and wherein at least the portion of first background element is modified via the one or more machine learning algorithms.

25. The computer system of claim 24, wherein the first media editing user interface includes:
a second selectable object, different from the first selectable object, that corresponds to a second category of one or more editing tools, wherein the second selectable object is concurrently displayed with the first selectable object;
the one or more programs further include instructions for:
after detecting the input directed to the first selectable object, detecting, via one or more input devices, an input directed to the second selectable object; and
in response to detecting the input directed to the second selectable object:
displaying, via the one or more generation components, the second category of one or more editing tools without displaying first category of one or more editing tools, wherein the second category of one or more editing tools includes:
an editable selectable object for adjusting a first editable parameter of the media item; and
an editable selectable object for adjusting a second editable parameter of the media item that is different from the first editable parameter.

26. The computer system of claim 24, wherein the second media editing user interface includes an indication of one or more input criteria that needs to be satisfied in order to modify the media item via the one or more machine learning algorithms.

27. A non-transitory computer-readable storage medium storing one or more programs configured to be executed by one or more processors of a computer system that is in communication with one or more display generation components and one or more input devices, the one or more programs including instructions for:
while displaying, via the one or more display generation components, a media item including a foreground element and a first background element, detecting, via the one or more input devices, an input corresponding to a request to modify the media item, including:
detecting at least a portion of the input is directed to a location of the foreground element and a location of the first background element; and
in response to detecting the input corresponding to the request to modify the media item:
in accordance with a determination that an initial location of the input is directed to the location of the first background element, modifying the media item, that is displayed via the one or more display generation components, by modifying at least a portion of the first background element without modifying the foreground element to which the input was directed.

28. A method, comprising:
at a computer system that is in communication with one or more display generation components and one or more input devices:
while displaying, via the one or more display generation components, a media item including a foreground element and a first background element, detecting, via the one or more input devices, an input corresponding to a request to modify the media item, including:
detecting at least a portion of the input is directed to a location of the foreground element and a location of the first background element; and
in response to detecting the input corresponding to the request to modify the media item:
in accordance with a determination that an initial location of the input is directed to the location of the first background element, modifying the media item, that is displayed via the one or more display generation components, by modifying at least a portion of the first background element without modifying the foreground element to which the input was directed.
